(19) United States
(12) Patent Application Publication
(10) Pub. No.: US 2007/0059769 A1
(43) Pub. Date: Mar. 15, 2007

(54) High throughput glycan microarrays

(76) Inventors: Ola Blixt, La Jolla, CA (US); Steve Head, San Diego, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/516,014

(22) Filed: Sep. 5, 2006

Related U.S. Application Data
(63) Continuation of application No. PCT/US05/07370, filed on Mar. 7, 2005.
(60) Provisional application No. 60/550,667, filed on Mar. 5, 2004.
(60) Provisional application No. 60/558,598, filed on Mar. 31, 2004.
(60) Provisional application No. 60/629,833, filed on Nov. 19, 2004.

(51) Int. Cl. C40B 30/06; C40B 40/04

(52) U.S. Cl. 435/7.1

(57) ABSTRACT

The invention provides arrays of glycans for detecting entities that bind to glycans. In some embodiments, the arrays can be used to detect disease, blood types, antibodies, bacterial or viral infection, cancer, and the like. The invention also provides methods and kits for such detection. In another embodiment, the invention provides methods of preventing or treating disease in a mammal by administering to the mammal a composition that includes at least glycan.

This application is a continuation under 35 U.S.C. 111(a) of International Application No. PCT/US2005/007370 filed Mar. 7, 2005 and published as WO 2005/088310 on Sep. 22, 2005, which claims benefit of the filing dates of U.S. Provisional Ser. No. 60/550,667, filed Mar. 5, 2004, U.S. Provisional Ser. No. 60/558,598, filed Mar. 31, 2004, and U.S. Provisional Ser. No. 60/629,833, filed Nov. 19, 2004, the contents of which applications and publication are incorporated herein by reference.

### GOVERNMENT FUNDING

The invention described herein was made with United States Government support under Grant Number U54GM62116 awarded by the National Institutes of Health. The United States Government has certain rights in this invention.

### FIELD OF THE INVENTION

The invention relates to glycan libraries, glycan arrays and methods for high throughput identification of the molecules that bind to various types of glycans. The arrays and methods provided herein can be used for epitope identification, for detecting antibodies, for detecting disease, for drug discovery and as analytical tools. In another embodiment, the invention provides glycan compositions useful for treating and prevention diseases associated with the production of those antibodies. These glycan compositions can be used to generate an immune response against cancer cell epitopes, bacterial infections, viral infections and the like.

### BACKGROUND OF THE INVENTION

Glycans are typically the first and potentially the most important interface between cells and their environment. As vital constituents of all living systems, glycans are involved in recognition, adherence, motility and signaling processes. There are at least three reasons why glycans should be studied: (1) all cells in living organisms, and viruses, are coated with diverse types of glycans; (2) glycosylation is a form of post- or co-translational modification occurring in all living organisms; and (3) altered glycosylation is an indication of an early and possibly critical point in development of human pathologies. Jun Hirabayashi, Oligosaccharide microarrays for glycomics; 2003, Trends in Biotechnology.21 (4): 141-143; Sen-Itiroh Hakomori, Tumor-associated carbohydrate antigens defining tumor malignancy: Basis for development of and-cancer vaccines; in The Molecular Immunology of Complex Carbohydrates-2 (Albert M Wu, ed., Kluwer Academic/Plenum, 2001). These cell-identifying glycosylated molecules include glycoproteins and glycolipids and are specifically recognized by various glycan-recognition proteins, called ‘lectins.’ However, the enormous complexity of these interactions, and the lack of well-defined glycan libraries and analytical methods have been major obstacles in the development of glycomics.

The development of nucleotide and protein microarrays has revolutionized genomic, gene expression and proteomic research. While the pace of innovation of these arrays has been explosive, the development of glycan microarrays has been relatively slow. One reason for this is that it has been difficult to reliably immobilize populations of chemically and structurally diverse glycans. Moreover, glycans are not readily amenable to analysis by many of the currently available molecular techniques (such as rapid sequencing and in vitro synthesis) that are routinely applied to nucleic acids and proteins. However, the use of glycan arrays could expedite screening procedures, making detection of antibodies, disease, infection, transplant tissue rejection and cancer-related glycan epitopes simple and inexpensive.

Thus, new tools and procedures to expedite analysis of carbohydrate interactions, to facilitate identification of antibodies and the epitopes they recognize, to permit early detection of disease and provide new methods for discovering effective therapeutic agents.

### SUMMARY OF THE INVENTION

The invention provides glycan libraries, glycan arrays (or microarrays) and methods for using such arrays to identify and analyze the interactions that various types of glycans have with other molecules. These glycan libraries, glycan arrays and screening methods are useful for identifying which protein, receptor, antibody, nucleic acid or other molecule or substance will bind to which glycan. The present glycan arrays permit many small samples of fluids or solutions to be screened simultaneously. The glycan arrays of the invention are reusable after stripping with acidic, basic aqueous or organic washing steps. Thus, the glycan libraries and glycan arrays of the invention can be used for receptor ligand characterization, anti-glycan antibody detection, diagnosis of disease, identification of carbohydrates on cell membranes and within subcellular components, antibody epitope identification, enzyme characterization and phage display library screening.

Thus, one aspect of the invention involves a library of glycans. The libraries of the invention include two or more glycans. Each glycan has at least one sugar unit, typically at least two sugar units. The glycans of the invention include straight chain and branched oligosaccharides as well as naturally occurring and synthetic glycans. Any type of sugar unit can be present in the glycans of the invention, including allose, altrose, arabinose, glucose, galactose, gulose, fucose, fructose, idose, lyxose, mannose, ribose, talose, xylose, neuraminic acid or other sugar units. Such sugar units can have a variety of substituents. For example, substituents that can be present instead of, or in addition to, the substituents typically present on the sugar units include N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl. Fatty acids, lipids, amino acids, peptides and proteins can also be attached to the glycans of the invention. The libraries of the invention generally have many separate glycans, for example, at least about 35 glycans, at least about 50 glycans, or at least about 225 glycans.

In another embodiment, the invention provides an array of glycan molecules comprising a solid support and a library of glycan molecules, wherein each glycan molecule is covalently attached to the solid support via amide linkage. In many embodiments, the array is a microarray. Arrays and microarrays of the invention include a solid support and a multitude of defined glycan probe locations on the solid support, each glycan probe location defining a region of the solid support that has multiple copies of one type of glycan molecule attached thereto. These microarrays can have, for example, between about 2 to about 100,000 different glycan probe locations, or between about 2 to about 10,000 different glycan probe locations. The libraries of the invention can therefore be attached to a solid support to form an array or a microarray.

In another embodiment, the invention provides a method of identifying whether a test molecule or test substance can bind to a glycan present in a library or on an array of the invention. The method involves contacting the library or the array with the test molecule or test substance and observing whether the test molecule or test substance binds to a glycan in the library or on the array.

In another embodiment, the invention provides a method of identifying to which glycan a test molecule or test substance can bind, wherein the glycan is present in a library or on an array of the invention. The method involves contacting the library or the array with the test molecule or test substance and observing to which glycan in the library or on the array the test molecule or test substance can bind.

In another embodiment, the invention provides a method making the arrays of the invention that involves derivatizing the solid support surface of the array with a trialkoxysilane bearing reactive moieties such as N-hydroxysuccinimide (NHS), amino (—NH₂), isothiocyanate (—NCS) or hydroxyl (—OH) to generate at least one derivatized glycan probe location on the array, and contacting the derivatized probe location with a glycan solution containing a glycan with a linking moiety that can react with the reactive moieties on the derivatized surface to thereby provide the array. This density of glycans at each glycan probe location can be modulated by varying the concentration of the glycan solution applied to the derivatized glycan probe location.

Another aspect of the invention is a composition comprising a carrier and an effective amount of at least one glycan molecule, wherein each glycan molecule in the composition binds an antibody found in a patient with a disease, and wherein serum from a patient without the disease has substantially no antibodies that bind any of the glycan molecules in the composition. Examples of diseases that can be treated with the compositions of the invention include bacterial infections, viral infections, inflammations, cancers, transplant rejection, autoimmune diseases or combinations thereof. These compositions can be formulated for immunization of a mammal. Alternatively, these compositions can be formulated in a food supplement. The compositions of the invention are useful for treating and preventing diseases such as cancer, bacterial infection, viral infection, inflammation, transplant rejection, autoimmune diseases and the like.

Another aspect of the invention is a method of detecting antibodies in bodily fluids of a patient. The method involves contacting a test sample obtained from the patient with a glycan library or glycan array of the invention, and observing whether antibodies in the test sample bind to glycans in the library or the array. According to one aspect of the invention, the type of glycan bound by such antibodies is indicative of the presence of a distinctive disease, or the propensity to develop a distinctive disease in the patient. The binding pattern of test samples can be compared to the binding of control samples from healthy patients that do not suffer from the disease in question. The test and control samples can, for example, be blood, serum, tissue, urine, saliva, milk or other samples. One convenient sample type for use in the invention is serum.

For example, patients with breast cancer have circulating antibodies that react with glycans such as ceruloplasmin, Neu5Acα2-6GalNAcα, certain T-antigens carrying various modifications, LNT-2 (a known ligand for tumor-promoting Galectin-4; see Huflejt & Leffler (2004). Glycoconjugate J., 20: 247-255), Globo-H—, and GM1-antigens. GM1 is a glycan that includes the following carbohydrate structure: Gal-beta3-GalNAc-beta4-[Neu5Ac-alpha3]-Gal-beta4-Glc-beta. Sulfo-T is a T-antigen with sulfate residues, for example, Sulfo-T can include a carbohydrate of the following structure: Galβ3GalNAc. Globo-H is a glycan that includes the following carbohydrate structure: Fucose-alpha2-Gal-beta3-GalNAc-beta3-Gal-alpha4-Gal-beta4-Glc. LNT-2 is a glycan that includes the following carbohydrate structure: GlcNAc-beta3-Gal-beta4-Glc-beta. The presence of cancer can therefore be detected with the present glycan arrays by detecting antibodies that bind to these glycans. Moreover, cancer can be treated or prevented by administering compositions of these cancer-specific antigens to boost an immune response against cancerous tissues.

In another example, neutralizing antibodies known to be specific for HIV were found by use of the arrays and methods of the invention to be reactive with mannose-containing glycans, in particular Man8 glycans. Hence, HIV infection may be detected by detecting whether a patient has circulating antibodies that bind to Man8 glycans. Moreover, HIV infection can be treated or inhibited by administering Man8 glycans to a subject.

Another aspect of the invention is a method of detecting transplant tissue rejection in a transplant recipient comprising contacting a test sample from the transplant recipient with an array of glycans and observing whether one or more glycans are bound by antibodies in the test sample. The method can also be used to detect xenotransplant tissue rejection. Glycans specific for the transplanted or xenotranplanted tissue are used in glycan arrays to observe whether one or more glycans are bound by antibodies in the test sample. Examples of glycans that can be used in an array for detecting transplant reject include any one of Gal-alpha3-Gal-beta (structure 33 of FIG. 7), Gal-alpha3-Gal-beta4-GlcNAc[alpha3-Fucose]-beta (structure 34 of FIG. 7), Gal-alpha3-Gal-beta4-Glc-beta (structure 35 of FIG. 7), Gal-alpha3-Gal[alpha2-Fucose]-beta4-GlcNAc-beta (structure 36 of FIG. 7), Gal-alpha3-Gal-beta4-GalAc-beta (structure 37 of FIG. 7), Gal-alpha3-GalAc-alpha (structure 38 of FIG. 7), Gal-alpha3-Gal-beta (structure 39 of FIG. 7), or Gal-beta4-GlcNAc[alpha3-Fucose]-beta (structure 65 in FIG. 7) or a combination thereof.

The glycans used on the arrays of the invention can therefore include glycans that react with antibodies associated with particular disease or condition. For example, antibodies that are produced in response to cancer, bacterial infection, viral infection, inflammation, transplant rejection, autoimmune diseases and the like can be detected using the glycan arrays of the invention.

Another aspect of the invention is an array or a microarray for detecting breast cancer that includes a solid support and a multitude of defined glycan probe locations on the solid support, each glycan probe location defining a region of the solid support that has multiple copies of one type of glycan molecule attached thereto and wherein the glycans are attached to the microarray by a cleavable linker. These microarrays can have, for example, between about 2 to about 100,000 different glycan probe locations, or between about 2 to about 10,000 different glycan probe locations. Glycans selected for use in the arrays or microarrays include those that react with antibodies associated with neoplasia in sera of mammals with benign or pre-malignant tumors. Glycans such as ceruloplasmin, Neu5Acα2-6GalNAcα, certain T-antigens, LNT-2, Globo-H—, and GM1 can be used in these types of arrays.

Another aspect of the invention is a kit comprising any of the arrays of the invention and instructions for using the array. In another embodiment, the invention provides a kit comprising the library of glycans and instructions for making an array from the library of glycans.

In another embodiment, the invention provides a method of identifying whether a patient or a mammal has a disease that includes contacting an array or library of the invention with a test sample and observing whether antibodies in the test sample bind to glycans that react with antibodies associated with the disease. For example, diseases that can be detected include cancer, bacterial infection, viral infection, inflammation, transplant rejection, autoimmune diseases and the like.

In another embodiment, the invention provides a method of treating or preventing a disease or condition in a mammal that comprises administering to the mammal a composition comprising an effective amount of at least one glycan molecule that binds antibodies associated with the disease or condition. For example, diseases and conditions that can be treated include cancer, bacterial infection, viral infection, inflammation, transplant rejection, autoimmune diseases and the like.

### DESCRIPTION OF THE FIGURES

FIG. 1 illustrates covalent printing of a diverse glycan library onto an amino-reactive glass surface and image analysis using the microarray techniques described herein. In some embodiments, an amino-functionalized glycan library is printed onto an N-hydroxysuccinimide (NHS) derivatized glass surface to form a microarray of glycans where each glycan type is printed onto a known glycan probe location.

FIG. 2 provides representative glycan structures that can be part of a library or used on an array of the invention. Many of these glycan structures bind glycan binding proteins. The circular, square and triangular symbols employed represent different sugar units; the meaning of these symbols is defined below the glycan listing. The following abbreviations are used: Gal=galactose; Glc=glucose; Man=mannose; GalNAc=N-acetylgalactosamine; GlcNAc=N-Acetylglucosamine; Fuc=fucose; NeuAc=N-Acetylneuraminic acid; NeuGc=N-Glycolylneuraminic acid; KDN=2-Keto-3-deoxynananic acid; S═SO₃; SP1=(CH₂)₂—NH—; SP2=(CH₂)₃—NH—; SP3=(CH₂)₃—NH—; SP4=NH—(CO)(CH₂)₂—NH—; SP5=(CH₂)₄—NH—. Further information on the symbol nomenclature can be found at the website of the Consortium for Functional Glycomics (http://www.functionalglycomics.org). Other tables provided herein describe further glycan structures that can be used in the glycan libraries and arrays of the invention. Further description of the types of saccharides, saccharide derivatives and saccharide linkages employed can be found in the tables and text provided herein.

FIG. 3A-C provides data illustrating printing optimization and the specificity of selected plant lectins. FIG. 3A provides a graph relating the glycan concentration and length of printing time to the relative fluorescence of the signal detected from binding Concanavalin A conjugated to fluorescinisothiocyanate (Con A-FITC). Optimized glycan concentrations and printing times were determined by printing selected mannose glycan structures and then detecting Con A binding thereto. A representative mannose glycan (136, see FIG. 7) was printed at various concentrations (4 μM-500 μM) in replicates of eight at six different time points. FIG. 3B illustrates the binding specificity of Con A-FITC on the complete array of glycans whose structures are provided in FIG. 7. As shown, Con A binds to mannose-containing glycans that can end with N-acetylglucosamine. FIG. 3C illustrates the binding specificity of FITC-labeled Erythrina cristagalli (ECA-FITC) on the array of glycans whose structures are provided in FIG. 7 and in Table 3 (glycans 1-200). As shown, Erythrina cristagalli binds to galactose-β4-N-acetylglucosamine-containing glycans that can end with fucose. The symbols employed for the depicted glycan structures are the same as those described in FIG. 2.

FIG. 4A-D illustrate the specificity of mammalian glycan binding proteins on a glycan array of the invention. FIG. 4A illustrates binding by the C-type lectin, dendritic cell-specific ICAM-grabbing nonintegrin (DC-SIGN) to the glycan array whose structures are shown in FIG. 7. The DC-SIGN was conjugated to a human Fc antibody fragment to permit detection with a labeled anti-human IgG antibody preparation. In particular, the DC-SIGN-Fc chimera (30 μg/mL) was detected by secondary goat anti-human-IgG-Alexa-488 antibody (10 μg/mL). As shown, DC-SIGN bound selectively to α1-2- and/or α1-3/4-fucosylated glycans as well as to Manα1-2-glycans. FIG. 4B illustrates binding by CD22, a member of the sialic acid-containing immunoglobulin superfamily of lectins (Siglec). CD22-Fc chimera (10 μg/mL) pre-complexed with secondary goat anti-human-IgG-Alexa-488 (5 μg/mL) and tertiary rabbit anti-goat-IgG-FITC (2.5 μg/mL) antibodies bound exclusively to Neu5Acα2-6Gal-glycans. FIG. 4C illustrates human galectin-4 binding to the array of glycans. Human Galectin-4-Alexa488 (10 μg/mL) evaluated with glycans printed at 100 μM (100 μM) and at 10 μM (10 μM) bound preferentially to blood group glycans.

FIG. 5A-C illustrate the specificity of various anti-carbohydrate antibodies on the glycan arrays of the invention. FIG. 5A shows the specificity of an anti-CD15 antibody preparation for Lewis^{X} glycans that contain N-acetylglucosamine-[α3(fucose)] [β4(galactose)]. Mouse anti-CD15-FITC monoclonal antibody (BD Biosciences Clone H198, 100 tests) bound exclusively to Lewis^{X} glycans. FIG. 5B shows the specificity of a human anti-HIV 2G12 monoclonal antibody for mannose-8 and mannose-9 glycans. The anti-HIV 2G12 antibodies (30 μg/mL) were pre-complexed with goat anti-human-IgG-FITC (15 μg/mL). As shown these antibodies bound to specific Manα1-2-glycans including the Man8 and Man9 N-glycans. FIG. 5C shows the binding specificity of human serum for a few glycan types. Human serum from ten healthy individuals (1:25 dilution) were individually bound to glycan arrays and detected by subsequent overlay with monoclonal mouse anti-human-IgG-IgM-IgA-Biotin antibody (10 μg/mL) and Streptavidin-FITC (10 μg/mL) respectively. Results represent the mean and standard deviation for binding in all ten experiments. Anti-carbohydrate antibodies present in the human serum bound to various blood group antigens as well as mannans and bacterial fragments.

FIG. 6A-C illustrate the specificity of various bacterial and viral glycan binding proteins for certain glycans in the arrays of the invention. FIG. 6A shows the glycans bound by Cyanovirin-N, a bacterial glycan binding protein. Cyanovirin-N (30 μg/mL) binding was detected with secondary polyclonal rabbit anti-Cyanovirin-N (10 μg/mL) and tertiary anti-rabbit-IgG-FITC (10 μg/mL) antibodies. Cyanovirin-N bound various α1-2 mannosides. FIG. 6B illustrates the types of glycans bound by Influenza H3 hemagglutinin. Pure recombinant hemagglutinin (150 μg/mL) that was derived from Duck/Ukraine/1/63 (H3/N7), was pre-complexed with mouse anti-HisTag-IgG-Alexa-488 (75 μg/mL) and anti-mouse-IgG-Alexa-488 (35 μg/mL). Incubation on the glycan array, led to binding of the hemagglutinin exclusively to Neu5Acα2-3Gal-terminating glycans. FIG. 6C shows that Influenza virus binds to the same type of glycans as purified hemagglutinin. Intact influenza virus A/Puerto Rico/8/34 (H1N1) was applied to the glycan array at a concentration of 100 μg/ml in the presence of 10 μM of the neuraminidase inhibitor oseltamivir carboxylate. The virus bound a wide spectrum of sialosides with both NeuAcα2-3Gal and NeuAcα2-6Gal sequences.

FIG. 7A-C provides a schematic diagram of glycan structures used in some of the libraries and glycan arrays of the invention. The symbols employed for the depicted glycan structures are the same as those described in FIG. 2, with a few additional symbols for sugar units defined in the lower right hand corner of FIG. 7C. Glycans 1-200 shown in FIG. 7 correspond to glycans 1-200 provided in Table 3, where a chemical name for each glycan is provided.

FIG. 8 provides a bar graph illustrating which glycans react with anti-carbohydrate antibodies found in sera of metastatic breast cancer patients. The types of glycans to which the antibodies bound are defined by numbers on the x-axis, as follows: background (# 1, a negative control), ceruloplasmin (#2), Neu5Gc(2-6)GalNAc (#3), Neu5Ac(2-6)GalNAc (#4), GMI (#5), Sulfo-T (#6), Globo-H (#7), LNT-2 (#8) and Rhamnose (#10, a positive control). Each bar clustered above the glycan identified on the x-axis represents the relative fluorescence intensity of a given anti-glycan antibody in an individual patient. Red bars (bars 1-9 in each cluster) represent the intensities observed for reaction of metastatic breast cancer patient sera with the glycans identified on the x-axis. Orange bars, which are the tenth bar in each cluster of bars, represent the average values for metastatic cancer patients 1-9. Yellow bars, which are the eleventh bars in each cluster or bars, represent the average values for non-metastatic breast cancer patients. Blue bars, which are the twelfth through twenty-first bars, represent the average values of “healthy” individuals. Dark blue bars, which are twenty-second bars in each cluster of bars, represent the average values for healthy individuals.

FIG. 9 provides a bar graph illustrating the additive relative fluorescence levels of selected cancer-associated anti-glycan antibodies in cancer (N=9) and non-cancer patients (N=10). The types of glycans that react with these antibodies are shown with the number of patients whose sera react with the indicated glycan type. The x-axis identifies whether the serum was take from cancer patients or non-cancer patients. The inset provides a combined relative fluorescence levels for a group of known cancer-associated T-antigens carrying various modifications in metastatic breast cancer patients (1) and in “healthy” individuals (2).

FIG. 10 provides a bar graph illustrating the combined levels of fluorescence (from FIG. 9) observed for the tumor associated anti-glycan antibodies in individual patient sera. The bars labeled “Cancer” represent the combined signals observed for each individual metastatic cancer patient. The bars labeled “Non-Cancer” represent the combined signal observed for each individual non-cancer patient.

FIG. 11A provides a structure for alpha-Gal, a glycan structure that is found in several of the glycans that bind to antibodies from patients who received transplanted porcine fetal pancreas islet-like cell clusters (the symbols used for this structure are defined herein, for example, in FIG. 2 or 7).

FIG. 11B provides a structure for the LeX glycan (compound 65 in FIG. 7), which is the glycan corresponding to compound 8 in the bar graph of FIG. 11D.

FIG. 11C provides a structure for the alpha-Gal-LeX glycan (compound 34 in FIG. 7), which is the glycan corresponding to compound 9 in the bar graph of FIG. 11D.

FIG. 11D provides a bar graph illustrating that certain circulating antibodies, which are reactive with glycans, are present in diabetic patients who received transplanted porcine fetal pancreas islet-like cell clusters. Serum was taken from these patients before transplantation and at 1 month after (t=1), 6 months after (t=2) and 12 months after (t=3) transplantation. The bars represent the reactivity of serum antibodies with glycans 33-39 (structures shown in FIG. 7) that are identified as glycans 1-7, respectively, on the x-axis. The lighter bars (blue in the original) represent the reactivity of the identified glycan for antibodies in the patient's serum before transplantation. The darker bars (green in the original) represent the combined reactivities of the identified glycan for antibodies in the patient's serum at t=1-3 after transplantation. Hence, an immune response directed against transplanted tissue can be detected using the glycan arrays of the invention.

FIG. 12 illustrates that human saliva contains antibodies that bind discrete types of glycans.

### DETAILED DESCRIPTION OF THE INVENTION

The invention provides libraries and arrays of glycans that can be used for identifying which types of proteins, receptors, antibodies, lipids, nucleic acids, carbohydrates and other molecules and substances can bind to a given glycan structure.

The inventive libraries, arrays and methods have several advantages. For example, the arrays and methods of the invention provide high reproducible results. Moreover, the libraries and arrays of the invention provide large numbers and varieties of glycans. For example, the libraries and arrays of the invention have at least two, at least three, at least ten, at least twenty, at least thirty five, at least fifty, at least one hundred, or at least two hundred glycans. In some embodiments, the libraries and arrays of the invention have about 2 to about 100,000, or about 2 to about 10,000, or about 2 to about 1,000, or about 2 to 500 different glycans per array. Such large numbers of glycans permit simultaneous assay of a multitude of glycan types.

As described herein, the present arrays have been used for successfully screening a variety of glycan binding proteins. Such experiments demonstrate that little degradation of the glycan occurs and only small amounts of glycan binding proteins are consumed during a screening assay. Hence, the arrays of the invention can be used for more than one assay. The arrays and methods of the invention provide high signal to noise ratios. The screening methods provided by the invention are fast and easy because they involve only one or a few steps. No surface modifications or blocking procedures are typically required during the assay procedures of the invention.

The composition of glycans on the arrays of the invention can be varied as needed by one of skill in the art. Many different glycoconjugates can be incorporated into the arrays of the invention including, for example, naturally occurring or synthetic glycans, glycoproteins, glycopeptides, glycolipids, bacterial and plant cell wall glycans and the like. Immobilization procedures for attaching different glycans to the arrays of the invention are readily controlled to easily permit array construction.

Definitions

The following abbreviations may be used: α₁-AGP means alpha-acid glycoprotein; AF488 means AlexaFluour-488; CFG means Consortium for Functional Glycomics; Con A means Concanavalin A; CVN means Cyanovirin-N; DC-SIGN means dendritic cell-specific ICAM-grabbing nonintegrin; ECA means Erythrina cristagalli; ELISA means enzyme-linked immunosorbent assay; FITC means Fluorescinisothiocyanate; GBP means Glycan Binding Protein; HIV means human immunodeficiency virus; HA means influenza hemagglutinin; NHS means N-hydroxysuccinimide; PBS means phosphate buffered saline; SDS means sodium dodecyl sulfate; SEM means standard error of mean; and Siglec means sialic acid immunoglobulin superfamily lectins.

A “defined glycan probe location” as used herein is a predefined region of a solid support to which a density of glycan molecules, all having similar glycan structures, is attached. The terms “glycan region,” or “selected region”, or simply “region” are used interchangeably herein for the term defined glycan probe location. The defined glycan probe location may have any convenient shape, for example, circular, rectangular, elliptical, wedge-shaped, and the like. In some embodiments, a defined glycan probe location and, therefore, the area upon which each distinct glycan type or a distinct group of structurally related glycans is attached is smaller than about 1 cm², or less than 1 mm², or less than 0.5 mm². In some embodiments the glycan probe locations have an area less than about 10,000 μm² or less than 100 μm². The glycan molecules attached within each defined glycan probe location are substantially identical. Additionally, multiple copies of each glycan type are present within each defined glycan probe location. The number of copies of each glycan types within each defined glycan probe location can be in the thousands to the millions.

As used herein, the arrays of the invention have defined glycan probe locations, each with “one type of glycan molecule.” The “one type of glycan molecule” employed can be a group of substantially structurally identical glycan molecules or a group of structurally similar glycan molecules. There is no need for every glycan molecule within a defined glycan probe location to have an identical structure. In some embodiments, the glycans within a single defined glycan probe location are structural isomers, have variable numbers of sugar units or are branched in somewhat different ways. However, in general, the glycans within a defined glycan probe location have substantially the same type of sugar units and/or approximately the same proportion of each type of sugar unit. The types of substituents on the sugar units of the glycans within a defined glycan probe location are also substantially the same.

The term lectin refers to a molecule that interacts with, binds, or crosslinks carbohydrates. The term galectin is an animal lectin. Galectins generally bind galactose-containing glycan.

As used herein a “patient” is a mammal or a bird. Such mammals and birds include domesticated animals, farm animals, animals used in experiments, zoo animals and the like. For example, the patient can be a dog, cat, monkey, horse, rat, mouse, rabbit, goat, ape or human mammal. In other embodiments, the animal is a bird such as a chicken, duck, goose or a turkey. In many embodiments, the patient is a human.

Some of the structural elements of the glycans described herein are referenced in abbreviated form. Many of the abbreviations used are provided in the Table 1. Moreover the glycans of the invention can have any of the sugar units, monosaccharides or core structures provided in Table 1.

TABLE 1

| | | Long | Short |
|---|---|---|---|
| Trivial Name | Monosaccharide/Core | Code | Code |
| D-Glcp | D-Glucopyranose | Glc | G |
| D-Galp | D-Galactopyranose | Gal | A |
| D-GlcpNAc | N-Acetylglucopyranose | GlcNAc | GN |
| D-GlcpN | D-Glucosamine | GlcN | GQ |
| D-GalpNAc | N-Acetylgalactopyranose | GalNAc | AN |
| D-GalpN | D-Galactosamine | GalN | AQ |
| D-Manp | D-Mannopyranose | Man | M |
| D-ManpNAc | D-NJ-Acetylmannopyranose | ManNAc | MN |
| D-Neup5Ac | N-Acetylneuraminic acid | NeuAc | NN |
| D-Neu5G | D-N-Glycolylneuraminic acid | NeuGc | NJ |
| D-Neup | Neuraminic acid | Neu | N |
| KDN* | 2-Keto-3-deoxynananic acid | KDN | K |
| Kdo | 3-deoxy-D-manno-2 | Kdo | W |
| | octulopyranosylono | | |
| D-GalpA | D-Galactoronic acid | GalA | L |
| D-Idop | D-Iodoronic acid | Ido | I |
| L-Rhap | L-Rhamnopyranose | Rha | H |
| L-Fucp | L-Fucopyranose | Fuc | F |
| D-Xylp | D-Xylopyranose | Xyl | X |
| D-Ribp | D-Ribopyranose | Rib | B |
| L-Araf | L-Arabinofuranose | Ara | R |
| D-GlcpA | D-Glucoronic acid | GlcA | U |
| D-Allp | D-Allopyranose | All | O |
| D-Apip | D-Apiopyranose | Api | P |
| D-Tagp | D-Tagopyranose | Tag | T |
| D-Abep | D-Abequopyranose | Abe | Q |
| D-Xulp | D-Xylulopyranose | Xul | D |
| D-Fruf | D-Fructofuranose | Fru | E |

*Another name for KDN is: 3-deoxy-D-glycero-K-galacto-nonulosonic acid.

The sugar units or other saccharide structures present in the glycans of the invention can be chemically modified in a variety of ways. A listing of some of the types of modifications and substituents that the sugar units in the glycans of the invention can possess, along with the abbreviations for these modifications/substituents is provided below in Table 2.

TABLE 2

| Modification type | Symbol | Modification type | Symbol |
|---|---|---|---|
| Acid | A | Acid | A |
| N-Methylcarbamoyl | ECO | deacetylated N-Acetyl | Q |
| | | (amine) | |
| pentyl | EE | Deoxy | Y |
| octyl | EH | Ethyl | ET |
| ethyl | ET | Hydroxyl | OH |
| inositol | IN | Inositol | IN |
| N-Glycolyl | J | Methyl | ME |
| methyl | ME | N-Acetyl | N |
| N-Acetyl | N | N-Glycolyl | J |
| hydroxyl | OH | N-Methylcarbamoyl | ECO |
| phosphate | P | N-Sulfate | QS |
| phosphocholine | PC | O-Acetyl | T |
| Phosphoethanolamine (2- | PE | Octyl | EH |
| aminoethylphosphate) | | | |
| Pyrovat acetal | PYR* | Pentyl | EE |
| Deacetylated N-Acetyl | Q | Phosphate | P |
| (amine) | | | |
| N-Sulfate | QS | Phosphocholine | PC |
| sulfate | S or Su | Phosphoethanolamine (2- | PE |
| | | aminoethylphosphate) | |
| O-Acetyl | T | Pyrovat acetal | PYR* |
| deoxy | Y | | |

*when 3 is present, it means 3,4, when 4 is present it means 4,6.

Bonds between sugar units are alpha (α) or beta (β) linkages, meaning that relative to the plane of the sugar ring, an alpha bond goes down whereas a beta bond goes up. In the shorthand notation sometimes used herein, the letter “a” is used to designate an alpha bond and the letter “b” is used to designate a beta bond.
Glycans

The invention provides compositions, libraries and arrays of glycans that are useful for analysis of glycan binding reactions, epitope identification, detecting, treating and preventing disease, as well as antibody preparation. These glycans include numerous different types of carbohydrates and oligosaccharides. In general, the major structural attributes and composition of the separate glycans have been identified. In some embodiments, the libraries, compositions and glycan arrays consist of separate, substantially pure pools of glycans, carbohydrates and/or oligosaccharides. In other embodiments, glycans are used whose source is defined but whose structures may not be known with certainty. In many embodiments, the glycans used in the invention are pure or substantially pure. However, some of the glycans may be a mixture of similarly structured glycans, or be a mixture of glycans from the same source. The glycans of the libraries described herein can be used to make the glycan arrays of the invention.

The glycans of the invention include straight chain and branched oligosaccharides as well as naturally occurring and synthetic glycans. For example, the glycan can be a glycoaminoacid, a glycopeptide, a glycolipid, a glycoaminoglycan (GAG), a glycoprotein, a whole cell, a cellular component, a glycoconjugate, a glycomimetic, a glycophospholipid anchor (GPI), glycosyl phosphatidylinositol (GPI)-linked glycoconjugates, bacterial lipopolysaccharides and endotoxins. The glycans can also include N-glycans, O-glycans, glycolipids and glycoproteins.

The glycans of the invention include 2 or more sugar units. Any type of sugar unit can be present in the glycans of the invention, including, for example, allose, altrose, arabinose, glucose, galactose, gulose, fucose, fructose, idose, lyxose, mannose, ribose, talose, xylose, or other sugar units. The tables provided herein list other examples of sugar units that can be used in the glycans of the invention. Such sugar units can have a variety of modifications and substituents. Some examples of the types of modifications and substituents contemplated are provided in the tables herein. For example, sugar units can have a variety of substituents in place of the hydrogen (H), hydroxy (—OH), carboxylate (—COO⁻), and methylenehydroxy (—CH₂—OH) substituents. Thus, lower alkyl moieties can replace any of the hydrogen atoms from the hydroxy (—OH), carboxylic acid (—COOH) and methylenehydroxy (—CH₂—OH) substituents of the sugar units in the glycans of the invention. For example, amino acetyl (—NH—CO—CH₃) can replace any of the hydrogen atoms from the hydroxy (—OH), carboxylic acid (—COOH) and methylenehydroxy (—CH₂—OH) substituents of the sugar units in the glycans of the invention. N-acetylneuraminic acid can replace any of the hydrogen atoms from the hydroxy (—OH), carboxylic acid (—COOH) and methylenehydroxy (—CH₂—OH) substituents of the sugar units in the glycans of the invention. Sialic acid can replace any of the hydrogen atoms from the hydroxy (—OH), carboxylic acid (—COOH) and methylenehydroxy (—CH₂—OH) substituents of the sugar units in the glycans of the invention. Amino or lower alkyl amino groups can replace any of the OH groups on the hydroxy (—OH), carboxylic acid (—COOH) and methylenehydroxy (—CH₂—OH) substituents of the sugar units in the glycans of the invention. Sulfate (—SO₄⁻) or phosphate (—PO₄⁻) can replace any of the OH groups on the hydroxy (—OH), carboxylic acid (—COOH) and methylenehydroxy (—CH₂—OH) substituents of the sugar units in the glycans of the invention. Hence, substituents that can be present instead of, or in addition to, the substituents typically present on the sugar units include N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl.

The following definitions are used, unless otherwise described: Alkyl, alkoxy, alkenyl, alkynyl, etc. denote both straight and branched groups; but reference to an individual radical such as propyl embraces only the straight chain radical, when a branched chain isomer such as isopropyl has been specifically referred to. Halo is fluoro, chloro, bromo, or iodo.

Specifically, lower alkyl refers to (C₁-C₆)alkyl, which can be methyl, ethyl, propyl, isopropyl, butyl, iso-butyl, sec-butyl, pentyl, 3-pentyl, or hexyl; (C₃-C₆)cycloalkyl can be cyclopropyl, cyclobutyl, cyclopentyl, or cyclohexyl; (C₃-C₆)cycloalkyl(C₁-C₆)alkyl can be cyclopropylmethyl, cyclobutylmethyl, cyclopentylmethyl, cyclohexylmethyl, 2-cyclopropylethyl, 2-cyclobutylethyl, 2-cyclopentylethyl, or 2-cyclohexylethyl; (C₁-C₆)alkoxy can be methoxy, ethoxy, propoxy, isopropoxy, butoxy, iso-butoxy, sec-butoxy, pentoxy, 3-pentoxy, or hexyloxy.

It will be appreciated by those skilled in the art that the glycans of the invention having one or more chiral centers may exist in and be isolated in optically active and racemic forms. Some compounds may exhibit polymorphism. It is to be understood that the present invention encompasses any racemic, optically-active, polymorphic, or stereoisomeric form, or mixtures thereof, of a glycan of the invention. Procedures available in the art can be used to prepare optically active forms (for example, by resolution of the racemic form by recrystallization techniques, by synthesis from optically-active starting materials, by chiral synthesis, or by chromatographic separation using a chiral stationary phase).

Specific and preferred values listed below for substituents and ranges, are for illustration only; they do not exclude other defined values or other values within defined ranges or for the substituents.

The libraries, arrays and compositions of the invention are particularly useful because diverse glycan structures are difficult to make and substantially pure solutions of a single glycan type are hard to generate. For example, because the sugar units typically present in glycans have several hydroxyl (—OH) groups and each of those hydroxyl groups is substantially of equal chemical reactivity, manipulation of a single selected hydroxyl group is difficult. Blocking one hydroxyl group and leaving one free is not trivial and requires a carefully designed series of reactions to obtain the desired regioselectivity and stereoselectivity. Moreover, the number of manipulations required increases with the size of the oligosaccharide. Hence, while synthesis of a disaccharide may require 5 to 12 steps, as many as 40 chemical steps can be involved in synthesis of a typical tetrasaccharide. In the past, chemical synthesis of oligosaccharides was therefore fraught with purification problems, low yields and high costs. However the invention has solved these problems by providing libraries and arrays of numerous structurally distinct glycans.

The glycans of the invention have been obtained by a variety of procedures. For example, some of the chemical approaches developed to prepare N-acetyllactosamines by glycosylation between derivatives of galactose and N-acetylglucosamine are described in Aly, M. R. E.; Ibrahim, E. -S. I.; El-Ashry, E. -S. H. E. and Schmidt, R. R., Carbohydr. Res. 1999, 316, 121-132; Ding, Y.; Fukuda, M. and Hindsgaul, O., Bioorg. Med. Chem. Lett. 1998, 8, 1903-1908; Kretzschmar, G. and Stahl, W., Tetrahedr. 1998, 54, 6341-6358. These procedures can be used to make the glycans of the present invention, but because there are multiple tedious protection/deprotection steps involved in such chemical syntheses, the amounts of products obtained in these methods can be low, for example, in milligram quantities.

One way to avoid protection-deprotection steps typically required during glycan synthesis is to mimic nature's way of synthesizing oligosaccharides by using regiospecific and stereospecific enzymes, called glycosyltransferases, for coupling reactions between the monosaccharides. These enzymes catalyze the transfer of a monosaccharide from a glycosyl donor (usually a sugar nucleotide) to a glycosyl acceptor with high efficiency. Most enzymes operate at room temperature in aqueous solutions (pH 6-8), which makes it possible to combine several enzymes in one pot for multi-step reactions. The high regioselectivity, stereoselectivity and catalytic efficiency make enzymes especially useful for practical synthesis of oligosaccharides and glycoconjugates. See Koeller, K. M. and Wong, C.-H., Nature 2001, 409, 232-240; Wymer, N. and Toone, E. J., Curr. Opin. Chem. Biol. 2000, 4, 110-119; Gijsen, H. J. M.; Qiao, L.; Fitz, W. and Wong, C.-H., Chem. Rev. 1996, 96, 443-473.

Recent advances in isolating and cloning glycosyltransferases from mammalian and non-mammalian sources such as bacteria facilitate production of various oligosaccharides. DeAngelis, P. L., Glycobiol. 2002, 12, 9R-16R; Endo, T. and Koizumi, S., Curr. Opin. Struct. Biol. 2000, 10, 536-541; Johnson, K. F., Glycoconj. J. 1999, 16, 141-146. In general, bacterial glycosyltransferases are more relaxed regarding donor and acceptor specificities than mammalian glycosyltransferases. Moreover, bacterial enzymes are well expressed in bacterial expression systems such as E. coli that can easily be scaled up for over expression of the enzymes. Bacterial expression systems lack the post-translational modification machinery that is required for correct folding and activity of the mammalian enzymes whereas the enzymes from the bacterial sources are compatible with this system. Thus, in many embodiments, bacterial enzymes are used as synthetic tools for generating glycans, rather than enzymes from the mammalian sources.

For example, the repeating Galβ(1-4)GlcNAc-unit can be enzymatically synthesized by the concerted action of β4-galactosyltransferase (β4GalT) and β3-N-acetyllactosamninyltransferase (β3GlcNAcT). Fukuda, M., Biochim. Biophys. Acta. 1984, 780:2, 119-150; Van den Eijnden, D. H.; Koenderman, A. H. L. and Schiphorst, W. E. C. M., J. Biol. Chem. 1988, 263, 12461-12471. The inventors have previously cloned and characterized the bacterial N. meningitides enzymes β4GalT-GalE and β3GlcNAcT and demonstrated their utility in preparative synthesis of various galactosides. Blixt, O.; Brown, J.; Schur, M.; Wakarchuk, W. and Paulson, J. C., J. Org. Chem. 2001, 66, 2442-2448; Blixt, O.; van Die, I.; Norberg, T. and van den Eijnden, D. H., Glycobiol. 1999, 9, 1061-1071. β4GalT-GalE is a fusion protein constructed from β4GalT and the uridine-5′-diphospho-galactose-4′-epimerase (GalE) for in situ conversion of inexpensive UDP-glucose to UDP-galactose providing a cost efficient strategy. Further examples of procedures used to generate the glycans, libraries and arrays of the invention are provided in the Examples.

In most cases, the structures of the glycans used in the compositions, libraries and arrays of the invention are described herein. However, in some cases a source of the glycan, rather than the precise structure of the glycan is given. Hence, a glycan from any available natural source can be used in the arrays and libraries of the invention. For example, known glycoproteins are a useful source of glycans. The glycans from such glycoproteins can be isolated using available procedures or, for example, procedures provided herein. Such glycan preparations can then be used in the compositions, libraries and arrays of the invention.

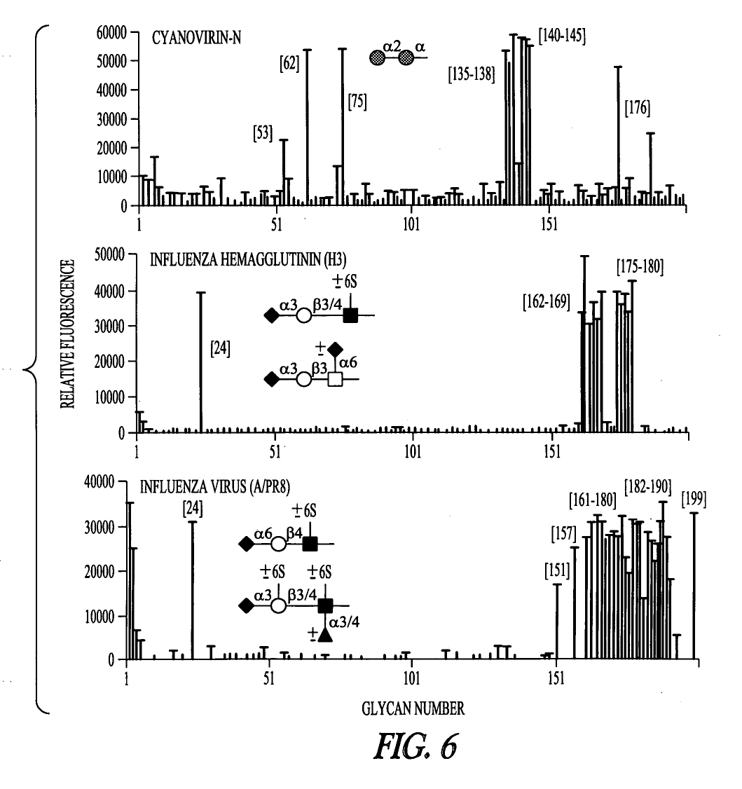

Examples of glycans provided in the libraries and on the arrays of the invention are provided in Table 3. Glycans 1-200 in Table 3 correspond to glycans 1-200 shown in FIG. 7.

TABLE 3

| | |
|---|---|
| 1 | AGP (acid glycoprotein) mixture of bi and tri- and tetra-antenary N- |
| | glyclans |
| 2 | AGP-A (acid glycoprotein A) mixture of bi and tri-antenary N-glycans |
| 3 | AGP-B (acid glycoprotein B) mixture of bi and tri-antenary N-glycans |
| 4 | Ceruloplasmine mixture of bi and tri- and tetra-antenary N-glycans |
| 5 | Fibrinogen mixture of biantenary-N-glycans |
| 6 | Transferrin mixture of bi and tri- and tetra-antenary N-glycans |
| 7 | Galβ1-4(Fuc1-3)GlcNAcβ1-4Galβ1-4(Fuc1-3)GlcNAcβSp |
| 8 | Galβ1-4(Fucα1-3)GlcNAcβ1-4Galβ1-4(Fucα1-3)GlcNAcβ1-4Galβ1- |
| | 4(Fucα1-3)GlcNAcfβSp |
| 9 | Galfβ1-4GlcNAcβ1-4Galβ1-4GlcNAcβ1-4Galβ1-4GlcNAcβSp |
| 10 | Gal[3S]βSp |
| 11 | Gal[3S]β1-3GalNAcαSp |
| 12 | Gal[3S]β1-3GlcNAcβSp |
| 13 | Gal[3S]β1-4Glc[6S]βSp |
| 14 | Gal[3S]β1-4Glc[6S]βSp |
| 15 | Gal[3S]β1-4GlcβSp |
| 16 | Gal[3S]β1-4GlcNAcβSp |
| 17 | Gal[4S]β1-4GlcNAcβSp |
| 18 | Man[6P]αSp |
| 19 | Gal[6S]β1-4Glc[6S]βSp |
| 20 | Gal[6S]β1-4GlcβSp |
| 21 | Gal[6S]β1-4GlcβSp |
| 22 | GlcNAc[6S]βSp |
| 23 | (GlcNAcβ1-3(GlcNAcβ1-6)GlcNAcβ1-4)GalNAcaSp |
| 24 | NeuAcα2-3Galβ1-3(NeuAcα2-3Galβ1-4)GlcNAcβSp |
| 25 | Gal[3S]β1-3(Fucα1-4)GlcNAcβSp |
| 26 | Gal[3S]β1-4(Fucα1-3)GlcNAcβSp |
| 27 | 9[NAc]NeuAcαSp |
| 28 | 9[NAc]NeuAcα2-6Galβ1-4GlcNAcβSp |
| 29 | GalαSp |
| 30 | Galα1-2Galβ-Sp |
| 31 | Galα1-3(Galα1-4)Galβ1-4GlcNAcβSp |
| 32 | Galα1-3(Fucα1-2)Galβ-Sp |
| 33 | Galα1-3GalβSp |
| 34 | Galα1-3Galβ1-4(Fucα1-3)GlcNAcβSp |
| 35 | Galα1-3Galβ1-4GlcβSp |
| 36 | Galα1-3(Fucα1-2)Galβ1-4GlcNAcβSp |
| 37 | Galα1-3Galβ1-4GlcNAcβSp |
| 38 | Galα1-3GalNAcαSp |
| 39 | Galα1-3GalNAcβSp |
| 40 | Galα1-4(Fucα1-2)Galβ1-4GlcNAcβSp |
| 41 | Galα1-4Galβ1-4GlcβSp |
| 42 | Galα1-4Galβ1-4GlcNAcβSp |
| 43 | Galα1-4Galβ1-4GlcNAcβSp |
| 44 | Galα1-4GlcNAcβSp |
| 45 | Galα1-6GlcβSp |
| 46 | GalβSp |
| 47 | Galβ1-3(NeuAcα2-6)GalNAcαSp |
| 48 | Galβ1-2GalβSp |
| 49 | Galβ1-3(Galβ1-4GlcNAcβ1-6)GalNAcαSp |
| 50 | Galβ1-3(Fucα1-4)GlcNAcβSp |
| 51 | Galβ1-3(Fucα1-4)GlcNAcβSp |
| 52 | Galβ1-3(GlcNAcβ1-6)GalNAcαSp |
| 53 | Galβ1-3(NeuAcα2-6)GlcNAcβ1-4Galβ1-4GlcβSp |
| 54 | Galβ1-3(NeuAcβ2-6)GalNAcαSp |
| 55 | Galβ1-3GalβSp |
| 56 | Galβ1-3GalNAcαSp |
| 57 | Galβ1-3GlcNAcβSp |
| 58 | Galβ1-3GalNAcβ1-4(NeuAcα2-3)Galβ1-4GlcβSp |
| 59 | Galβ1-3GalNAcβ1-4Galβ1-4GlcβSp |
| 60 | Galβ1-3GlcNAcαSp |
| 61 | Galβ1-3GlcNAcβSp |
| 62 | Galβ1-3GlcNAcβ1-3Galβ1-4GlcβSp |
| 63 | Galβ1-4Glc[6S]βSp |
| 64 | Galβ1-4Glc[6S]βSp |
| 65 | Galβ1-4(Fucα1-3)GlcNAcβSp |
| 66 | Galβ1-4(Fucα1-3)GlcNAcβSp |
| 67 | Galβ1-4GalNAcα1-3(Fucα1-2)Galβ1-4GlcNAcβSp |
| 68 | Galβ1-4GlcβSp |
| 69 | Galβ1-4GlcβSp |
| 70 | Galβ1-4GlcNAcβSp |
| 71 | Galβ1-4GlcNAcβSp |
| 72 | Galβ1-4GlcNAcβ1-3(Galβ1-4GlcNAcβ1-6)GalNAcαSp |
| 73 | Galβ1-4GlcNAcβ1-3Galβ1-4(Fucα1-3)GlcNAcβ1-3Galβ1-4 |
| | (Fucα1-3)GlcNAcβSp |
| 74 | Galβ1-4GlcNAcβ1-3Galβ1-4GlcβSp |
| 75 | Galβ1-4GlcNAcβ1-3Galβ1-4GlcβSp |
| 76 | Galβ1-4GlcNAcβ1-3Galβ1-4GlcNAcβSp |
| 77 | Galβ1-4GlcNAcβ1-3GalNAcαSp |
| 78 | Galβ1-4GlcNAcβ1-3GalNAcαSp |
| 79 | Galβ1-4GlcNAcβ1-6GalNAcαSp |
| 80 | GalNAcαSp |
| 81 | GalNAcα1-3(Fucα1-2)GalβSp |
| 82 | GalNAcα1-3GalββSp |
| 83 | GalNAcα1-3(Fuca1-2)Galβ1-4GlcNAcβSp |
| 84 | GalNAcα1-3GalNAcβSp |
| 85 | GalNAcα1-4(Fucα1-2)Galβ1-4GlcNAcβSp |
| 86 | GalNAcβSp |
| 87 | GalNAcβ1-3(Fucα1-2)GalβSp |
| 88 | GalNAcβ1-3GalNAcαSp |
| 89 | GalNAcβ1-4GlcNAcβSp |
| 90 | GalNAcβ1-4GlcNAcβSp |
| 91 | FucαSp |
| 92 | FucαSp |
| 93 | Fucα1-2GalβSp |
| 94 | Fucα1-2Galβ1-3(Fucα1-4)GlcNAcβ-Sp |
| 95 | Fucα1-2Galβ1-3GalNAcβ-Sp |
| 96 | Fucα1-2Galβ1-3GalNAcβ1-3GalαSp |
| 97 | Fucα1-2Galβ1-3GalNAcβ1-3Galβ1-4Galβ1-4GlcβSp |
| 98 | Fucα1-2Galβ1-3GalNAcβ1-4(NeuAcα2-3)Galβ1-4GlcβSp |
| 99 | Fucα1-2Galβ1-3GlcNAcβSp |
| 100 | Fucα1-2Galβ1-3GlcNAcβSp |
| 101 | Fucα1-2Galβ1-4(Fucα1-3)GlcNAcβSp |
| 102 | Fucα1-2Galβ1-4(Fucα1-3)GlcNAcβSp |
| 103 | Fucα1-2Galβ1-4GlcβSp |
| 104 | Fucα1-2Galβ1-4GlcNAcβSp |
| 105 | Fucα1-2Galβ1-4GlcNAcβSp |
| 106 | Fucα1-2Galβ1-4GlcNAcβ1-3Galβ1-4GlcNAcβSp |
| 107 | Fucα1-2Galβ1-4GlcNAcβ1-3Galβ1-4GlcNAcβ1-3Galβ1-4GlcNAcβSp |
| 108 | Fucα1-2GlcNAcβSp |
| 109 | Fucα1-3GlcNAcβSp |
| 110 | Fucα1-3GlcNAcβSp |
| 111 | Fucα1-2Galβ1-3GalNAcβ1-4(NeuAcα1-3)Galβ1-4GlcβSp |
| 112 | GlcαSp |
| 113 | Glcβ1-4GlcβSp |
| 114 | GlcβSp |
| 115 | Glcβ1-4GlcβSp |
| 116 | Glcβ1-6GlcβSp |
| 117 | GlcNAcβSp |
| 118 | GlcNAcβSp |
| 119 | GlcNAcβ1-2Galβ1-3GalNAcαSp |
| 120 | GlcNAcβ1-3(GlcNAcβ1-6)GalNAcαSp |
| 121 | GlcNAcβ1-3GalβSp |
| 122 | GlcNAcβ1-3Galβ1-3GalNAcαSp |
| 123 | GlcNAcβ1-3Galβ1-4GlcβSp |
| 124 | GlcNAcβ1-3Galβ1-4GlcNAcβSp |
| 125 | GlcNAcβ1-4(GlcNAcβ1-6)GalNAcαSp |
| 126 | GlcNAcβ1-4GlcNAcβ1-4GlcNAcβSp |
| 127 | GlcNAcβ1-4Mur-L-Ala-D-GlnβSp |
| 128 | GlcNAcβ1-6GalNAcαSp |
| 129 | Glc-ol-amine |
| 130 | GlcAαSp |
| 131 | GlcAβSp |
| 132 | KDNα2-3Galβ1-3GlcNAcβSp |
| 133 | KDNα2-3Galβ1-4GlcNAcβSp |
| 134 | ManαSp |
| 135 | Manα1-2Manα1-2Manα1-3ManαSp |
| 136 | Manα1-2Manα1-3(Manα1-2Manα1-6)ManαSp |
| 137 | Manα1-2Manα1-3ManαSp |
| 138 | Manα1-3(Manα1-2Manα1-2Manα1-6)ManαSp |
| 139 | Manα1-3(Manα1-6)ManαSp |
| 140 | Manα1-3Manα1-6(Manα1-2Manα1-3)Manβ1-4GlcNAcβ1-4GlcNAcβSp |
| 141 | Man5-Man9βSp-mixture(mixture is of glycans 140, 142-145) |
| 142 | Manα1-6(Manα1-3)Manα1-6(Manα1-2Manα1-3)Manβ1-4GlcNAcβ1-4GlcNAcβSp |
| 143 | Manα1-6(Manα1-2Manα1-3)Manα1-6(Manα1-2Manα1-3)Manβ1- |
| | 4GlcNAcβ1-4GlcNAcβSp |
| 144 | Manα1-2Manα1-6(Manα1-3)Manα1-6(Manα1-2Manα1-3)Manβ1-4GlcNAcβ1- |
| | 4GlcNAcβSp |
| 145 | Manα1-2Manα1-2Manα1-3(Manα1-2Manα1-3(Manα1-2Manα1- |
| | 6)Manα1-6)Manβ1-4GlcNAcβ1-4GlcNAcβSp |
| 146 | NeuAcα2-8NeuAcαSp |
| 147 | NeuAcα2-8NeuAcα2-8NeuAcαSp |
| 148 | NeuGcαSp |
| 149 | NeuGcα2-3Galβ1-3(Fucα1-4)GlcNAcβSp |
| 150 | NeuGcα2-3Galβ1-3GlcNAcβSp |
| 151 | NeuGcα2-3Galβ1-4(Fucα1-3)GlcNAcβSp |
| 152 | NeuGcα2-3Galβ1-4GlcβSp |
| 153 | NeuGcα2-3Galβ1-4GlcNAcβSp |
| 154 | NeuGcα2-6Galβ1-4GlcNAcαSp |
| 155 | NeuGcα2-6GalNAcαSp |
| 156 | NeuAcαSp |
| 157 | NeuAcα2-3(6S)Galβ1-4GlcNAcβSp |
| 158 | NeuAcα2-3(GalNAcβ1-4)Galβ1-4GlcβSp |
| 159 | NeuAcα2-3(Galβ1-3GalNAcβ1-4)Galβ1-4GlcNAcβSp |
| 160 | NeuAcα2-3(GalNAcβ1-4)Galβ1-4GlcNAcβSp |
| 161 | NeuAcα2-3Galβ1-4(Fucα1-3)GlcNAcβ1-4Galβ1-4(Fucα1-3)GlcNAcβ1- |
| | 4Galβ1-4(Fucα1-3)GlcNAcβSp |
| 162 | NeuAcα2-3GalβSp |
| 163 | NeuAcα2-3Galβ1-3GalNAc[6S]αSp |
| 164 | NeuAcα2-3(GalNAcβ1-4)Galβ1-4GlcβSp |
| 165 | NeuAcα2-3Galβ1-3(NeuAcα2-6)GalNAcαSp |
| 166 | NeuAcα2-3Galβ1-3GalNAcαSp |
| 167 | NeuAcα2-3Galβ1-4GlcNAc[6S]βSp |
| 168 | NeuAcα2-3Galβ1-4(Fucα1-3)GlcNAc[6S]βSp |
| 169 | NeuAcα2-3Galβ1-4GlcNAc[6S]βSp |
| 170 | NeuAcα2-3Galβ1-4(Fucα1-3)GlcNAc[6S]βSp |
| 171 | NeuAcα2-3Galβ1-4(Fucα1-3)GlcNAcβSp |
| 172 | NeuAcα2-3Galβ1-4(Fucα1-3)GlcNAcβSp |
| 173 | NeuAcα2-3Galβ1-4(Fucα1-3)GlcNAcβ1-3GalβSp |
| 174 | NeuAcα2-3Galβ1-4(Fucα1-3)GlcNAcβ1-3Galβ1-4GlcNAcβSp |
| 175 | NeuAcα2-3Galβ1-4GlcβSp |
| 176 | NeuAcα2-3Galβ1-4GlcβSp |
| 177 | NeuAcα2-3Galβ1-4GlcNAcβSp |
| 178 | NeuAcα2-3Galβ1-4GlcNAcβSp |
| 179 | NeuAcα2-3Galβ1-4GlcNAcβ1-3Galβ1-4GlcNAcβSp |
| 180 | NeuAcα2-3Galβ1-4GlcNAcβ1-3Galβ1-4GlcNAcβ1-3Galβ1- |
| | 4GlcNAcβSp |
| 181 | NeuAcα2-6GalNAcαSp |
| 182 | NeuAcα2-6GalβSp |
| 183 | NeuAcα2-6Galβ1-4GlcNAc[6S]βSp |
| 184 | NeuAcα2-6Galβ1-4GlcβSp |
| 185 | NeuAcα2-6Galβ1-4GlcβSp |
| 186 | NeuGcα2-6Galβ1-4GlcNAcαSp |
| 187 | NeuGcα2-6Galβ1-4GlcNAcαSp |
| 188 | NeuAcα2-6Galβ1-4GlcNAcβ1-3Galβ1-4(Fucα1-3)GlcNAcβ1-3Galβ1- |
| | 4(Fucα1-3)GlcNAcβSp |
| 189 | NeuAcα2-6Galβ1-4GlcNAcβ1-3Galβ1-4GlcNAcβSp |
| 190 | NeuAcβ2-6GalNAcαSp |
| 191 | NeuAcα2-8NeuAcα2-3(GalNAcβ1-4)Galβ1-4GlcβSp |
| 192 | NeuAcα2-8NeuAcα2-3Galβ1-4GlcβSp |
| 193 | NeuAcα2-8NeuAcα2-8NeuAcα2-3(GalNAcβ1-4)Galβ1-4GlcβSp |
| 194 | NeuAcα2-8NeuAcα8NeuAcα2-3Galβ1-4GlcβSp |
| 195 | NeuAcα2-3(NeuAcα2-6)GalNAcαSp |
| 196 | NeuAcβSp |
| 197 | NeuAcβ2-6Galβ1-4GlcNAcβSp |
| 198 | NeuAcβ2-6GalNAcαSp |
| 199 | NeuAcα2-6Galβ1-4GlcNAcβ1-2Manα1-3(NeuAcα2-6Galβ1- |
| | 4GlcNAcβ1-2Manα1-6)Manβ1-4GlcNAcβ1-4GlcNAcβSp |
| 200 | RhaαSp |
| 201 | ManβSp |
| 202 | ±(NeuAcα2-6)Galβ1-4GlcNAcα1-2Manα1-6(±(NeuAcα2-6)Galβ1-4GlcNAcα1- |
| | 2Manα1-3)Manβ1-4 |
| | GlcNAcβ1-4GlcNAcβSp |
| 203 | GalNAc[3S]βSp |
| 204 | GalNAc[6S]βSp |
| 205 | Galβ1-4GlcNAcβ1-2Manα1-3(Galβ1-4GlcNAcβ1-2Manα1-6)Manβ1- |
| | 4GlcNAcβ1-4GlcNAcβSp |
| 206 | Fucα1-2Galβ1-3GlcNAcβ1-3Galβ1-4GlcβSp |
| 207 | Fucα1-2Galβ1-4(Fucα1-3)GlcNAcβ1-4Galβ1-4(Fucα1-3)GlcNAcβSp |
| 208 | Fucα1-4GlcNAcβSp |
| 209 | Galα1-3(Fucα1-2)Galβ1-4GlcβSp |
| 210 | GalNAcα1-3(Fucα1-2)Galβ1-4GlcβSp |
| 211 | GalNAcβ1-4(Fucα1-2)GlcNAcβ1-4Manα1-3(GalNAcβ1-4(Fucα1- |
| | 2)GlcNAcβ1-4Manα1-6)Manβ1-4 |
| | GlcNAcβ1-4(Fucα1-2)GlcNAcβSp |
| 212 | GalNAcβ1-4(Fucα1-3)GlcNAcβSp |
| 213 | GalNAcβ1-4GlcNAcβ1-4Manα1-6(GalNAcβ1-4GlcNAcβ1-4Manα1- |
| | 3)Manβ1-4GlcNAcβ1-4GlcNAcβSp |
| 214 | Galα1-4(Fucα1-2)Galβ1-4GlcNAcβSp |
| 215 | Galβ1-3(Galβ1-3Galβ1-4GlcNAcβ1-6)GalNAcαSp |
| 216 | Galβ1-3(Galβ1-4(Fucα1-3)GlcNAcβ1-6)GalNAcαSp |
| 217 | Galβ1-3(NeuAcα2-3Galβ1-4(Fucα1-3)GlcNAcβ1-6)GalNAcαSp |
| 218 | Galβ1-3(NeuAcα2-3Galβ1-4GlcNAcβ1-6)GalNAcαSp |
| 219 | Galβ1-4GlcNAc[6S]βSp |
| 220 | Galβ1-4(Fucα1-3)GlcNAcβ1-4Manα1-6(Galβ1-4(Fucα1-3)GlcNAcβ1- |
| | 4Manα1-6)Manβ1-4GlcNAcβ1-4 |
| | GlcNAcβSp |
| 221 | Galβ1-4GlcNAcβ1-3Galβ1-4GlcNAcβ1-3Galβ1-4GlcNAcβSp |
| 222 | Galβ1-4GlcNAcβ1-4Manα1-3(Galβ1-4GlcNAcβ1-4Manα1-6)Manβ1- |
| | 4GlcNAcβ1-4GlcNAcβSp |
| 223 | Galβ1-4GlcNAcβ1-6(Galβ1-3)GalNAcαSp |
| 224 | GlcNAcβ1-2Manα1-3(GlcNAcβ1-2Manα1-6)Manβ1-4GlcNAcβ1- |
| | 4(Fucα1-6)GlcNAcβSp |
| 225 | GlcNAcβ1-3GalNAcαSp |
| 226 | GlcNAcβ1-4GlcNAcβ1-4GlcNAcβ1-4GlcNAcβSp |
| 227 | GlcNAcβ1-4GlcNAcβSp |
| 228 | GlcNAcβ1-4GlcNAcβSp |
| 229 | GlcNAcβ1-6(Galβ1-3)GalNAcαSp |
| 230 | Manα1-2Manα1-3(Mancα1-6)Manβ1-4GlcNAcβ1-4(Fucα1- |
| | 3)GlcNAβSp |
| 231 | Manα1-3(Xylβ1-2)(Manα1-6)Manβ1-4GlcNAcβ1-4GlcNAcβSp |
| 232 | Manα1-2Manα1-6(Manα1-3)Manα1-6(Manα2Manα2Manα1-3)Manβ1- |
| | 4GlcNAcβ1-4GlcNAcβSp |
| 233 | Manα1-3(Manα1-6)Manβ1-4GlcNAcβ1-4GlcNAcβSp |
| 234 | Manα1-6(Manα1-3)Manα1-6(GlcNAcβ1-4)(GlcNAcβ1-2Manα1- |
| | 3)Manβ1-4GlcNAcβ1-4GlcNAcβSp |
| 235 | Manα1-6(Manα1-3)Manβ1-4GlcNAcβ1-4(Fucα1-2)GlcNAcβSp |
| 236 | Manα1-6(Manα1-3)Manα1-6(Manα1-3)Manβ1-4GlcNAcβ1-4 |
| | GlcNAcβSp |
| 237 | Manα1-6Manα1-3(Manα1-6Manα1-3)Manβ1-4GlcNAcβ1-4GlcNAcβSp |
| 238 | mixed biantennary glycansβSp |
| 239 | mixed N-glycansβSp |
| 240 | NeuAcα2-3(Galβ1-3GlcNAcβ1-4)Galβ1-4GlcβSp |
| 241 | NeuAcα2-3Galβ1-3(Galβ1-3Galβ1-4GlcNAcβ1-6)GalNAcαSp |
| 242 | NeuAcα2-3Galβ1-3(Galβ1-4GlcNAcβ1-6)GalNAcαSp |
| 243 | NeuAcα2-3Galβ1-3(GlcNAcβ1-6)GalNAcαSp |
| 244 | NeuAcα2-3Gal[6S]β1-4(Fucα1-3)GlcNAcβSp |
| 245 | NeuAcα2-3(GalNAcβ1-4)Galβ1-4GlcβSp |
| 246 | NeuAcα2-3GalNAcαSp |
| 247 | NeuAcα2-3Galβ1-3(Galβ1-4(Fucα1-3)GlcNAcβ1-6)GalNAcαSp |
| 248 | NeuAcα2-3Galβ1-3(NeuAcα2-3Galβ1-4)GlcNAcβSp |
| 249 | NeuAcα2-3Galβ1-3(NeuAcα2-3Galβ1-4(Fucα1-3)GlcNAcβ1- |
| | 6)GalNAcαSp |
| 250 | NeuAcα2-3Galβ1-3(NeuAcα2-3Galβ1-4GlcNAcβ1-6)GalNAcαSp |
| 251 | NeuAcα2-3Galβ1-4(Fucα1-3)GlcNAcβ1-3Galβ1-4(Fucα1-3)GlcNAcβ1- |
| | 3Galβ1-4(Fucα1-3)GlcNAcβSp |
| 252 | NeuAcα2-3Galβ1-4GlcNAcβ1-3Galβ1-4GlcNAcβSp |
| 253 | NeuAcα2-3Galβ1-4GlcNAcβSp |
| 254 | NeuAcα2-6(Galβ1-3)GalNAcαSp |
| 255 | NeuAcα2-6Galβ1-4GlcNAcβ1-2Manα1-6((NeuAcα2-6Galβ1- |
| | 4GlcNAcβ1-2Manα1-6)Manβ1-4GlcNAcβ1-4 |
| | GlcNAcβSp |
| 256 | NeuAcα2-6Galβ1-4GlcNAcβ1-4Galβ1-4GlcNAcβSp |
| 257 | NeuAcα2-8NeuAcα2-3Galβ1-4GlcβSp |
| 258 | NeuAcα2-8NeuAcα2-8NeuAcαSp |
| 259 | NeuAcβ2-6(Galβ1-3)GalNAcβSp |
| 260 | NeuGcα2-3Galβ1-3(Fucα1-4)GlcNAcβSp |
| 261 | NeuGcα2-3Galβ1-3GlcNAcβSp |
| 262 | NeuGcα2-3Galβ1-4(Fucα1-3)GlcNAcβSp |
| 263 | NeuGcβSp |
| 264 | NeuAcα2-6Galβ1-4GlcNAcβ1-2Manα1-3(Galβ1-4GlcNAcβ1-2Manα1- |
| | 6)Manβ1-4GlcNAcβ1-4(Fucα1-6) |
| | GlcNAcβSp |
| 265 | NeuAcα2-6Galβ1-4GlcNAcβ1-2Manα1-3(NeuAcα2-6Galβ1- |
| | 4GlcNAcβ1-2Manα1-6)Manβ1-4GlcNAcβ1-4 |
| | (Fuc1α1-6)GlcNAcβSp |
| 266 | NeuAcα2-8NeuAcα2-(3-6)Galβ1-4GlcNAcβ1-2Manα1-3(NeuAcα2- |
| | 6Galβ1-4GlcNAcβ1-2Manα1-6)Manβ1-4GlcNAcβ1-4(Fucα1-6) |
| | GlcNAcβSp |
| 267 | NeuAcα2-8NeuAcα2-8NeuAcα2-(3-6)Galβ1-4GlcNAcβ1-2Manα1- |
| | 3(NeuAcα2-6Galβ1-4GlcNAcβ1-2Manα1-6)Manβ1-4GlcNAcβ1- |
| | 4(Fucα1-6)GlcNAcβSp |
| 269 | GlcNAcβ1-3(GlcNAcβ1-4)Galβ1-4GlcNAcβSp |
| 270 | GlcNAcβ1-3Galβ1-4GlcNAcβSp |
| 271 | GlcAβ1-3GalβSp |
| 272 | GlcNAcβ1-4GlcNAcβ1-4GlcNAcβ1-4GlcANAcβ1-4GlcNAcβSp |
| 273 | GlcNAcβ1-6Galβ1-4GlcNAcβSp |
| 274 | Glcα1-4Glc1-4αSp |
| 275 | Glcα1-6Glc,6αGlcαSp |
| 276 | GlcNAcβ1-4Galβ1-4GlcNAcβSp |
| 277 | Galβ1-4GlcNAc[6S]βSp |
| 278 | GlcNAcβ1-4GlcNAcβ1-4GlcNAcβ1-4GlcNAcβ1-4GlcANAcβ1- |
| | 4GlcNAcβSp |
| 279 | GlcNGcβSp |
| 280 | Manβ1-4GlcNAcβSp |
| 281 | Gal[6S]β1-4GlcNAcβSp |
| 282 | Galβ1-4GlcNAcβ1-2Manα1-3(Galβ1-4GlcNAcβ1-2Manα1-6)Manβ1- |
| | 4GlcNAcβ1-4GlcNAcβSp |
| 283 | GlcNAcβ1-2Manα1-3(GlcNAcβ1-2Manα1-6)Manβ1-4GlcNAcβ1- |
| | 4GlcNAcβSp |
| 284 | Manα1,3(Manα1-6)Manβ1-4GlcNAcβ1-4GlcNAcβSp |
| 285 | Galα1-3(Fucα1-2)Galβ1-3GlcNAcβSp |
| 286 | GalNAcα1-3(Fucα1-2)Galβ1-3GlcNAcβSp |
| 287 | GalNAcα1-3(Fucα1-2)Galβ1-4(Fucα1-3)GlcNAcβSp |
| 288 | Galα1-3(Fucα1-2)Galβ1-4(Fucα1-3)GlcNAcβSp |
| 289 | Fucα1-2Galβ1-4(Fucα1-3)GlcNAcβ1-3Galβ1-4(Fucα1-3)GlcNAcβ1- |
| | 3Galβ1-4(Fucα1-3)GlcNAcβSp |
| 290 | GalNAcα1-3(Fucα1-2)Galβ1-4GlcβSp |
| 291 | Galα1-3(Fucα1-2)Galβ1-4GlcβSp |
| 292 | NeuAcα2-3Galβ1-3GlcNAcβ1-3Galβ1-4GlcNAcβSp |
| 293 | NeuAcα2-6Galβ1-3GlcNAcβ1-3Galβ1-4GlcNAcβSp |
| 294 | GalNAcβ1-4(Fucα1-3)GlcNAcβSp |
| 295 | Galβ1-3GlcNAcβ1-3Galβ1-4GlcβSp |
| 296 | GalNAcβ1-3Galα1-4Galβ1-4GlcβSp |
| 297 | Galβ1-3GalNAcβ1-3Galα1-4Galβ1-4GlcβSp |
| 298 | NeuAcα2-3Galβ1-3GalNAcβ1-3Galα1-4Galβ1-4GlcβSp |
| 299 | Fucα1-2Galβ1-3GalNAcβ1-3Galα1-4Galβ1-4GlcβSp |
| 300 | Fucα1-2Galβ1-3(Fucα1-4)GlcNAcβ1-3Galβ1-4(Fucα1-3)GlcNAcβSp |
| 301 | NeuAcα2-3Galβ1-3(Fucα1-4)GlcNAcβ1-3Galβ1-4GlcNAcβSp |
| 302 | NeuAcα2-3Galβ1-3(Fucα1-4)GlcNAcβ1-3Galβ1-4(Fucα1- |
| | 3)GlcNAcβSp |
| 203 | NeuAcα2-8NeuAcα2-3(Galβ1-3GalNAcβ1-4)Galβ1-4GlcβSp |
| 304 | NeuAcα2-8NeuAcα2-3(NeuAcα2-3Galβ1-3GalNAcβ1-4)Galβ1- |
| | 4GlcβSp |
| 305 | NeuAcα2-3(Galβ1-3GalNAcβ1-4)Galβ1-4GlcβSp |
| 306 | NeuAcα2-3(NeuAcα2-3Galβ1-3GalNAcβ1-4)Galβ1-4GlcβSp |
| 307 | NeuAcα2-8NeuAcα2-8-NeuAcα2-3(Galβ1-3GalNAcβ1-4)Galβ1- |
| | 4GlcβSp |
| 308 | NeuAcα2-8NeuAcα2-8-NeuAcα2-3(NeuAcα2-3Galβ1-3GalNAcβ1- |
| | 4)Galβ1-4GlcβSp |
| 309 | NeuAcα2-8NeuAcα2-8NeuAcα2-8-NeuAcα2-3(Galβ1-3GalNAcβ1- |
| | 4)Galβ1-4GlcβSp |
| 310 | NeuAcα2-8NeuAcα2-8NeuAcα2-8NeuAcα1-3(NeuAcα2-3Galβ1- |
| | 3GalNAcβ1-4)Galβ1-4GlcβSp |
| 311 | NeuAcα2-8NeuAcα2-8NeuAcα2-8-NeuAcα2-3(GalNAcβ1-4)Galβ1- |
| | 4GlcβSp |
| 312 | Galβ1-4GlcNAcβ1-2(Galβ1-4GlcNAcβ1-4)Manα1-3[Galβ1-4GlcNAc |
| | β1-3(Galβ1-4GlcNAcβ1-6)Manα1-6]Manβ1-4GlcNAcβ1-4GlcNAcβSp |

Many of the abbreviations employed in the table are defined herein or at the website functionalglycomics.org. In particular, the following abbreviations were used: Sp means “spacer.”

The glycans of the invention can have spacers, linkers, labels, linking moieties and/or other moieties attached to them. These spacers, linkers, labels, linking moieties and/or other moieties can be used to attach the glycans to a solid support, detect particular glycans in an assay, purify or otherwise manipulate the glycans. For example, the glycans of the invention can have amino moieties provided by attached alkylamine groups, amino acids, peptides, or proteins. In some embodiments, the glycans have alkylamine moieties such as —OCH₂CH₂NH₂ (called Sp1), or —OCH₂CH₂CH₂NH₂ (called Sp2 or Sp3), or NH—(CO)(CH₂)₂—NH—(called Sp4), or CH₂)₄—NH (called Sp5) that have useful as linking moieties (the amine) and act as spacers or linkers.

Glycan Arrays

The arrays of the invention employ a library of characterized and defined glycan structures. The array has been validated with a diverse set of carbohydrate binding proteins such as plant lectins and C-type lectins, Siglecs, Galectins, Influenza Hemagglutinins and anti-carbohydrate antibodies (from crude sera, purified serum fractions and purified monoclonal antibody preparations).

The inventive libraries, arrays and methods have several advantages. One particular advantage of the invention is that the arrays and methods of the invention provide highly reproducible results.

Another advantage is that the libraries and arrays of the invention permit screening of multiple glycans in one reaction. Thus, the libraries and arrays of the invention provide large numbers and varieties of glycans. For example, the libraries and arrays of the invention have at least two glycans, at least three glycans, at least ten glycans, at least 30 glycans, at least 40 glycans, at least 50 glycans, at least 100 glycans, at least 150 glycans, at least 175 glycans, at least 200 glycans, at least 250 glycans or at least 500 glycans. In some embodiments, the libraries and arrays of the invention have more than two glycans, more than three glycans, more than ten glycans, more than 40 glycans, more than 50 glycans, more than 100 glycans, more than 150 glycans, more than 175 glycans, more than 200 glycans, more than 250 glycans or more than 500 glycans. In other embodiments, the libraries and arrays of the invention have about 2 to about 100,000, or about 2 to about 10,000, or about 2 to about 7500, or about 2 to about 1,000, or about 2 to about 500, or about 2 to about 200, or about 2 to 100 different glycans per library or array. In other embodiments, the libraries and arrays of the invention have about 50 to about 100,000, or about 50 to about 10,000, or about 50 to about 7500, or about 50 to about 1,000, or about 50 to about 500, or about 50 to about 200 different glycans per library or array. Such large numbers of glycans permit simultaneous assay of a multitude of glycan types.

Moreover, as described herein, the present arrays have been used for successfully screening a variety of glycan binding proteins. The glycan arrays of the invention are reusable after stripping with acidic, basic aqueous or organic washing steps. Experiments demonstrate that little degradation of the glyean occurs and only small amounts of glycan binding proteins are consumed during a screening assay. Hence, the arrays of the invention can be used for more than one assay.

The arrays and methods of the invention provide high signal to noise ratios. The screening methods provided by the invention are fast and easy because they involve only one or a few steps. No surface modifications or blocking procedures are typically required during the assay procedures of the invention.

The composition of glycans on the arrays of the invention can be varied as needed by one of skill in the art. Many different glycoconjugates can be incorporated into the arrays of the invention including, for example, purified glycans, naturally occurring or synthetic glycans, glycoproteins, glycopeptides, glycolipids, bacterial and plant cell wall glycans and the like. Immobilization procedures for attaching different glycans to the arrays of the invention are readily controlled to easily permit array construction.

Spacer molecules or groups can be used to link the glycans to the arrays. Such spacer molecules or groups include fairly stable (e.g. substantially chemically inert) chains or polymers. For example, the spacer molecules or groups can be alkylene groups. One example of an alkylene group is —(CH₂)n-, where n is an integer of from 1 to 20. In some embodiments, n is an integer of from 1 to 10.

Unique libraries of different glycans are attached to defined regions on the solid support of the array surface by any available procedure. In general, the arrays are made by obtaining a library of glycan molecules, attaching spacer molecules with linking moieties to the glycans in the library, obtaining a solid support that has a surface derivatized to react with the specific linking moieties present on the glycans of the library and attaching the glycan molecules to the solid support by forming a covalent linkage between the linking moieties and the derivatized surface of the solid support.

The derivatization reagent can be attached to the solid substrate via carbon-carbon bonds using, or example, substrates having (poly)trifluorochloroethylene surfaces, or more preferably, by siloxane bonds (using, for example, glass or silicon oxide as the solid substrate). Siloxane bonds with the surface of the substrate are formed in one embodiment via reactions of derivatization reagents bearing trichlorosilyl or trialkoxysilyl groups.

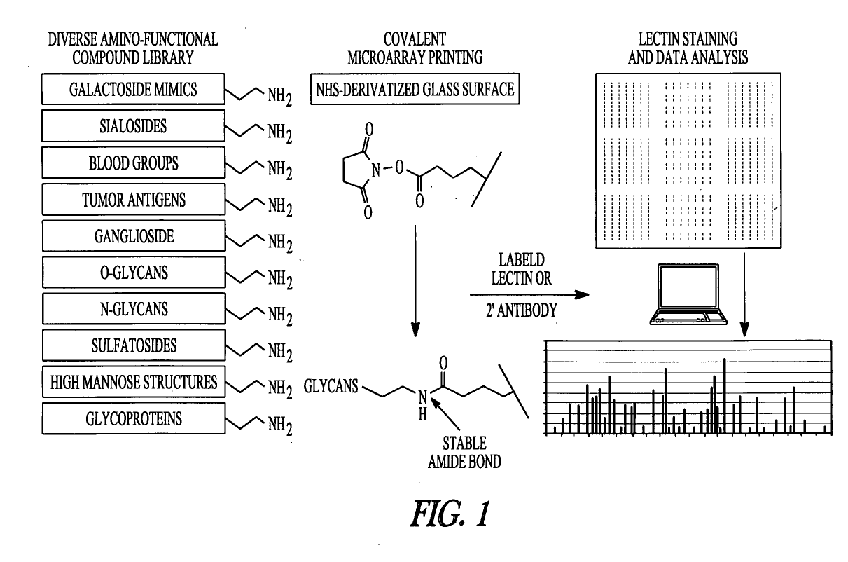

For example, a glycan library can be employed that has been modified to contain primary amino groups. Thus, in some embodiments, the glycans of the invention can have amino moieties provided by attached alkylamine groups, amino acids, peptides, or proteins. For example, the glycans can have alkylamine groups such as the —OCH₂CH₂NH₂ (called Sp1) or —OCH₂CH₂CH₂NH₂ (called Sp2 or Sp3), or NH—(CO)(CH₂)₂—NH— (called Sp4), or CH₂)₄—NH (called Sp5) groups attached that provide the primary amino group. The primary amino groups on the glycans can react with an N-hydroxy succinimide (NHS)-derivatized surface of the solid support. Such NHS-derivatized solid supports are commercially available. For example, NHS-activated glass slides are available from Accelr8 Technology Corporation, Denver, Colo. (now Schott Nexterion, Germany). After attachment of all the desired glycans, slides can further be incubated with ethanolamine buffer to deactivate remaining NHS functional groups on the solid support. The array can be used without any further modification of the surface. No blocking procedures to prevent unspecific binding are typically needed. FIG. 1 provides a schematic diagram of such a method for making arrays of glycan molecules.

Each type of glycan is contacted or printed onto to the solid support at a defined glycan probe location. Suitable printing methods include piezo or pin printing techniques. A microarray gene printer can be used for applying the various glycans to defined glycan probe locations. The printing process is shown diagrammatically in FIG. 1. Printing in the X direction gives rise “columns” of glycans and printing in the direction orthogonal to the X direction gives rise to “rows.” During printing, the inkjet is generally stationary, and a stepping stage moves the glass slide or other solid surface over the head in the X direction. As the wafer passes over the head, it prints the appropriate glycan to each glycan probe location. Several nozzles simultaneously dispense a selected amount of glycan solution.

For example, about 0.1 nL to about 10 nL, or about 0.5 nL of glycan solution can be applied per defined glycan probe location. Various concentrations of the glycan solutions can be contacted or printed onto the solid support. For example, a glycan solution of about 0.1 to about 1000 μM glycan or about 1.0 to about 500 μM glycan or about 10 to about 100 μM glycan can be employed. In general, it may be advisable to apply each concentration to a replicate of several (for example, three to six) defined glycan probe locations. Such replicates provide internal controls that confirm whether or not a binding reaction between a glycan and a test molecule is an actual binding interaction.

Methods of Detecting Glycan Binding

It is contemplated that the arrays of this invention will be useful for screening chemical and molecular biological libraries for new therapeutic agents, for identifying ligands for known biological receptors and new receptors for known ligands, for identifying epitopes, characterizing antibodies, genotyping human populations for diagnostic and therapeutic purposes, and many other uses. Any such ligands, receptors, lectins galectins, antibodies, proteins and like can be potential glycan binding entities that can be detected using the arrays and methods provided herein.

The arrays of the invention are intended for use in a molecular recognition-based assay, in which a sample that may contain a glycan binding entity is brought into contact with an array of glycans of known source or structure, that are located at predetermined spatial positions (glycan probe locations) on the support surface of the array. Binding is recognized by detection of a label at a specific glycan probe location on the array, where the label is directly or indirectly associated with a glycan binding entity. Binding of a glycan binding entity is of sufficiently high affinity to permit the entity to be retained by the glycan array during washing and until detection of the associated label has been accomplished.

In using an array of the invention, the identity of a lectin, antibody, protein, molecule, or chemical moiety bound to a glycan at any particular location in the array can be determined by detecting the location of the label associated with the bound entity and linking this with the array's tagged file. The tagged file is a file of information wherein the identity and position of each glycan in the array pertaining to the file is stored. There are various methods of linking this tagged file with the physical array. For example, the tagged file can be physically encoded on the array or its housing by means of a silicon chip, magnetic strip or bar code. Alternatively, the information identifying the array to a particular tagged file might be included on an array or its housing, with the actual file stored in the data analysis device or in a computer in communication with the device. The linking of the tagged file with the physical array would take place at the time of data analysis. Yet another way of doing this would be to store the tagged file in a device such as a disc or card that could be inserted into the data analysis device by the array user at the time the array was used in the assay.

The label can be directly associated with the glycan binding entity, for example, by covalent linkage between the label and a purified glycan binding entity. Alternatively, the label can be indirectly associated with the glycan binding entity. For example, the label can be covalently attached to a secondary antibody that binds to a known glycan binding entity.

The bound label can be observed using any available detection method. For example, an array scanner can be employed to detect fluorescently labeled molecules that are bound to array. In experiments illustrated herein a ScanArray 5000 (GSI Lumonics, Watertown, Mass.) confocal scanner was used. The data from such an array scanner can be analyzed by methods available in the art, for example, by using ImaGene image analysis software (BioDiscovery Inc., El Segundo, Calif.).

Methods of Detecting Disease

According to the invention, antibodies from bodily fluids of patients can be detected using the glycan arrays of the invention. The particular glycan epitopes recognized by those antibodies are indicative of a particular disease type. Healthy persons who do not have the disease in question have much lower levels of such antibodies, or substantially no antibodies that react with those glycans. Antibodies associated with diseases such as cancer, bacterial infection, viral infection, inflammation, transplant rejection, autoimmune diseases and the like can be detected using the glycan arrays of the invention.

For detecting disease, a test sample is obtained from a patient. The patient may or may not have a disease. Thus, the methods of the invention are used to diagnose or detect whether the patient has a disease or has a propensity for developing a disease. Alternatively, the methods of the invention can be used with patients that are known to have an identified disease. In this case, the prognosis of the disease can be monitored.

The test sample obtained from the patient can be any tissue, bodily fluid sample or pathology sample. For example, the test sample can be a blood sample, a serum sample, a plasma sample, a urine sample, a breast milk sample, an ascites fluid sample or a tissue sample. In many embodiments, the sample is a serum sample. The test sample may or may not contain a glycan binding entity —the methods provided herein permit detection of whether such a glycan binding entity is present in the test sample.

In some embodiments, the presence of a particular glycan binding entity is indicative of a particular disease, condition or disease state. Hence, for example, as illustrated herein, detection of increased glycan binding by antibodies in a patient's serum is an indicator that the patient may have disease. Comparison of the levels of glycan binding over time provides an indication of whether the disease is progressing or whether the patient is recovering from the disease or the disease is in remission. Hence, the invention provides methods for detecting disease as well as monitoring the progression of disease in a patient.

A few examples of methods for detecting specific diseases or the potential to develop disease are provided for illustrative purposes.

Breast Cancer: Breast cancer usually begins in the cells lining a breast duct and in the terminal ductal lobular unit, with the first stage thought to be excessive proliferation of individual cell(s) leading to “ductal hyperplasia.” Some of the hyperplastic cells may then become atypical, with a significant risk of the atypical hyperplastic cells becoming neoplastic or cancerous. Initially, the cancerous cells remain in the breast ducts, and the condition is referred to as ductal carcinoma in situ (DCIS). After a time, however, these breast cancer cells are able to invade tissues outside of the ductal environment, presenting the risk of metastases which can be fatal to the patient. Breast cancer proceeds through discrete premalignant and malignant cellular stages: normal ductal epithelium, atypical ductal hyperplasia, ductal carcinoma in situ (DCIS), and finally invasive ductal carcinoma. The first three stages are confined within the ductal system and, therefore, if diagnosed and treated, lead to the greatest probability of cure.

While breast cancer through the DCIS phase is in theory quite treatable, effective treatment requires both early diagnosis and an effective treatment modality. At present, mammography is the state-of-the-art diagnostic tool for detecting breast cancer. Often, however, mammography is only able to detect tumors that have reached a size in the range from 0.1 cm to 1 cm. Such a tumor mass may be reached as long as from 8 to 10 years following initiation of the disease process. Detection of breast cancer at such a late stage is often too late to permit effective treatment.

Thus, in one embodiment, the invention provides fast, reliable and non-invasive methods for detecting and diagnosing breast cancer in a patient. The method involves contacting a test sample from a patient with a library or array of glycans and observing whether antibodies in the test sample bind to selected glycans. The test sample can be any bodily fluid or tissue test sample, however, serum is readily obtained and contains antibodies that can easily be detected using the present methods. Glycans to which antibodies in a serum test sample may bind include ceruloplasmin, Neu5Gc(2-6)GalNAc, GM1, Sulfo-T, Globo-H, and LNT-2. As a control, the pattern of glycans bound by antibodies from breast cancer patients can be compared to the pattern of glycans bound by antibodies in serum samples from healthy, non-cancerous patients.

Viral Detection: As illustrated herein, and as further described in U.S. Provisional Application Ser. No. 60/550,667 (filed Mar. 5, 2004), an anti-HIV neutralizing antibody (2G12) binds preferentially to Man8 glycans. Of all the natural high mannose type structures tested, 2G12 antibodies showed a surprising and unexpectedly strong preference for binding only the Man8 glycan. This glycan has been reported to be present in HIV gp120 to the extent of 20% of the total N-linked glycans (Scanlan et al. (2002) J. Virol. 76, 7306-7321). In comparison, the Man9 glycan previously studied in the crystallographic work was relatively weakly bound by 2G12, and the Man5, Man6 and Man7 glycans did not support binding at all.

The glycosylation of viral proteins is generally performed by host cell, rather than viral, enzymes. Given that many viral genomes are so mutable, the glycosylation of viral proteins by host enzymes likely gives rise to antigenic epitopes that are more stable than the epitopes generated by translation of easily mutated viral nucleic acids. Hence, virally-associated glycans may form the basis of improved compositions, including vaccines, for inhibiting and treating viral infection.

Also as shown herein, influenza virus hemagglutinin binds to Neu5Acα2-3-linked to galactosides (24, 162-169, 176-180, see FIG. 7), but not to any Neu5Acα2-6- or Neu5Acα2-8-linked sialosides. Intact influenza viruses, such as A/Puerto Rico/8/34 (H1N1), were also strongly bound to the array. The overall affinities are consistent with previous findings and show specificity for both α2-3 and α2-6 sialosides. Rogers, G. N. & Paulson, J. C. (1983) Virol. 127, 361-73. Influenza viruses also bound to Neu5Acα2-3- and Neu5Acα2-6-linked to galactosides (24, 151, 157, 161-180, 182-190, 199, see FIG. 7), as well as certain O-linked sialosides.

Hence, the invention provides methods of detecting viral infection, for example, HIV or influenza infection. The method involves contacting a test sample from a patient with a library or array of glycans and observing whether antibodies reactive with the virus, viral antigens or the virus itself are present in the test sample. The presence of such antibodies, viral antigens and viral particles can be detected by detecting their binding to glycans that have been determined to previously bind those antibodies, viral antigens and viral particles. Hence, the glycans to which the antibodies, viral antigens or viruses bind indicate whether an infection is present. Such glycans can be viral-specific glycan epitopes or viral binding sites that are present on host cells. For example, one type of viral-specific glycan epitope is the Man8 glycan(s) to which the anti-HIV 2G12 antibodies bind. Detection of antibodies that bind Man8 glycans is one indicator or HIV infection or of progression towards development of AIDS. One of skill in the art can readily prepare glycan arrays for screening for viral infection using the teachings provided herein.

Detection of Glycosylation Levels: The glycan arrays of the invention can also be used to detect whether various glycoproteins are appropriately glycosylated. Various diseases are characterized by inappropriate levels (e.g. lack of glycosylation) or inappropriate types of glycosylation. For example, carbohydrate-deficient glycoprotein syndromes (CDGS) are related to under glycosylation of proteins. The most common initial test for CDGS is to analyze the glycosylation pattern on the glycoprotein transferrin using isoelectric focusing. According to the invention, glycans can be isolated from transferrin samples of patients, printed on the solid surfaces described herein and quantified. Quantification can be performed using antibodies or lectins that bind to specific glycans. Alcoholism can also be diagnosed through glycosylation changes of transferrin.

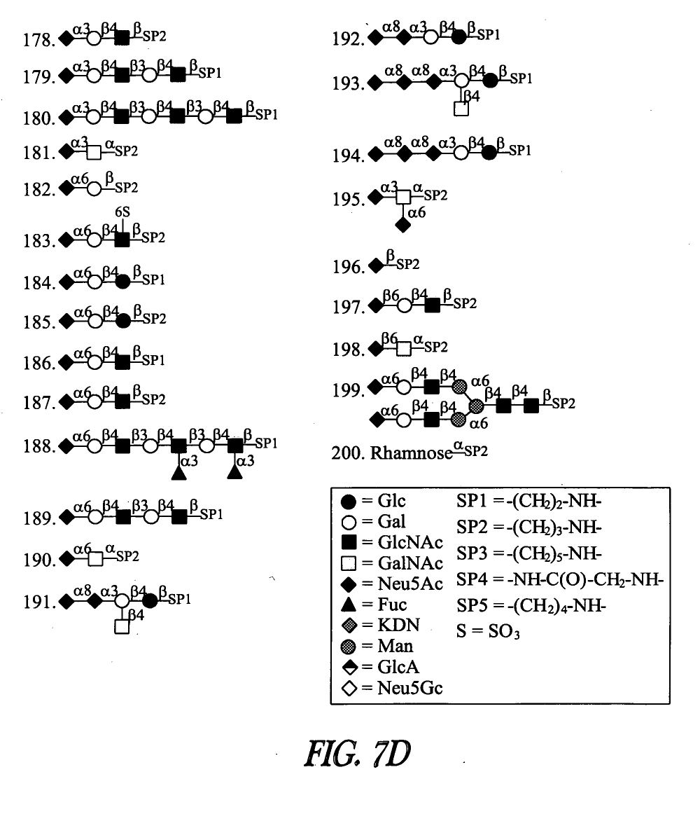

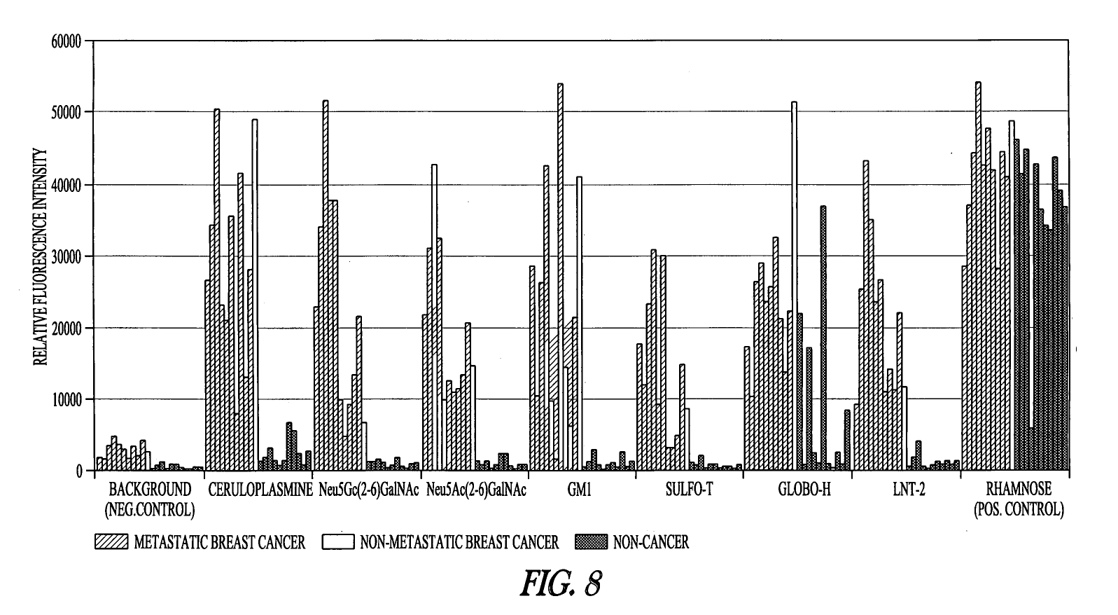

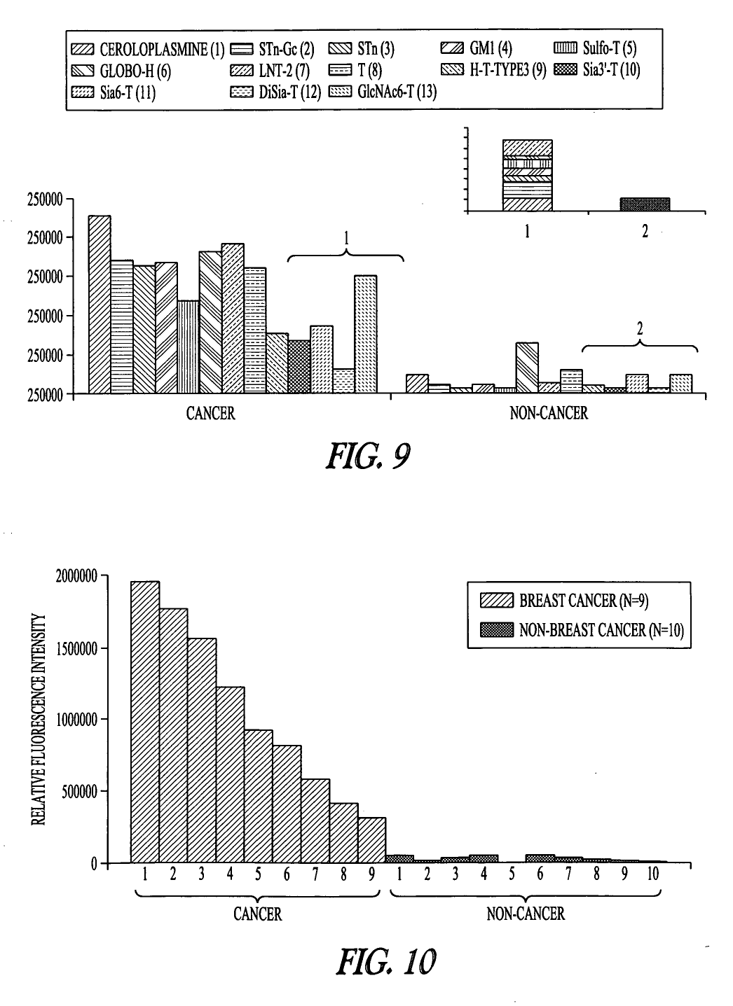

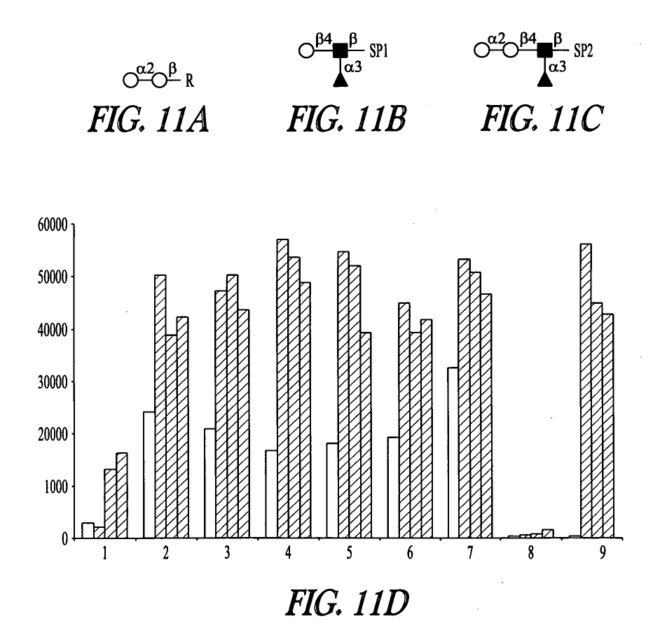

Detection of Transplant Rejection: As illustrated herein, immune responses directed against transplanted tissues were detected using the arrays and methods of the invention. In particular, several diabetic patients received transplanted porcine fetal pancreas islet-like cell clusters. Serum was taken from these patients before transplantation and at 1 month after (t=1), 6 months after (t=2) and 12 months after (t=3) transplantation. As described and illustrated herein, significantly greater amounts of antibodies reactive with alpha-Gal-3 glycan epitopes were detected after transplantation (see FIG. 11). For example, antibodies in transplant recipients bound to the following glycan epitopes: Gal-alpha3-Gal-beta (structure 33), Gal-alpha3-Gal-beta4-GlcNAc[alpha3-Fucose]-beta (structure 34), Gal-alpha3-Gal-beta4-Glc-beta (structure 35), Gal-alpha3-Gal[alpha2-Fucose]-beta4-GlcNAc-beta (structure 36), Gal-alpha3-Gal-beta4-GalAc-beta (structure 37), Gal-alpha3-GalAc-alpha (structure 38), and Gal-alpha3-Gal-beta (structure 39).

In particular, antibodies were detected that bound to alpha-Gal-LeX (structure 34 in FIG. 7, also shown in FIG. 11C). This alpha-Gal-LeX glycan is not found in humans, but has been reported to be present on porcine kidney cells. See Bouhors D. et al., Gala1-3-LeX expressed on iso-neolacto ceramides in porcine kidney GLYCOCONJ. J. (10) 1001-16 (1998). However, patients who received transplantation of porcine fetal pancreas islet-like cell clusters clearly exhibited an immune response (antibody production) against the alpha-Gal-LeX glycan epitopes.

Thus, the arrays and methods of the invention are useful for detecting, monitoring, evaluating and treating graft rejection after transplantation and/or xenotransplantation.

Methods of Treating Disease

The invention also provides glycan compositions that can be used as immunogens and dietary supplements for treating and preventing disease. Thus, for example, the compositions of the invention can be used to treat diseases such as cancer, bacterial infection, viral infection, inflammation, transplant rejection, autoimmune diseases and the like. In some embodiments, the glycans selected for inclusion in a composition of the invention are antigenic and can give rise to an immune response against a bacterial species, a viral species, cancer cell type and the like. In other embodiments, the glycans selected for inclusion in a composition of the invention are not necessarily antigenic. Instead the glycans may bind or compete for binding to antibodies, receptors, and the like that contribute to the prognosis of a disease. Hence, for example, a non-antigenic glycan may be administered in order to bind antibodies that would otherwise cause tissue destruction during inflammation or transplant rejection. In other embodiments, glycans are administered to treat or prevent autoimmune responses.

Such compositions include one or more glycans that are typically recognized by circulating antibodies associated with a disease, infection or immune condition. For example, to treat or prevent breast cancer, compositions are prepared that contain glycans that are typically recognized by circulating antibodies of patients with metastatic breast cancer. Examples of glycans that can be included in compositions for treating and preventing breast cancer therefore include: ceruloplasmin, Neu5Gc(2-6)GalNAc, GM1, Sulfo-T, Globo-H, and LNT-2. In some embodiments, the type and amount of glycan is effective to provoke an anticancer cell immune response in the patient.

Similarly, compositions for preventing or treating viral infections include viral-specific glycan epitopes. For example, one type of viral-specific glycan epitope is the Man8 glycan(s) to which the anti-HIV 2G12 antibodies bind. One of skill in the art can readily prepare compositions of Man8 glycans, or other viral-specific glycan epitopes for treatment and prevention of many types of viral infections using the teachings provided herein.

In a like manner, compositions of the invention for treating or preventing bacterial infections include bacteria-specific glycan epitopes.

The compositions of the invention may be administered directly into the patient, into an affected organ or systemically, or applied ex vivo to cells derived from the patient or a human cell line which are subsequently administered to the patient, or used in vitro to select a subpopulation from immune cells derived from the patient, which are then re-administered to the patient. The composition can be administered with an adjuvant or with immune-stimulating cytokines, such as interleukin-2. An example of an immune-stimulating adjuvant is Detox. The glycans may also be conjugated to a suitable carrier such as keyhole limpet haemocyanin (KLH) or mannan (see WO 95/18145 and Longenecker et al (1993) Ann. NY Acad. Sci. 690, 276-291). The glycans can be administered to the patient orally, intramuscularly or intradermally or subcutaneously.

In some embodiments, the compositions of the invention are administered in a manner that produces a humoral response. Thus, production of antibodies directed against the glycan(s) is one measure of whether a successful immune response has been achieved.

In other embodiments, the compositions of the invention are administered in a manner that produces a cellular immune response, resulting in tumor cell killing by NK cells or cytotoxic T cells (CTLs). Strategies of administration that activate T helper cells are particularly useful. As described above, it may also be useful to stimulate a humoral response. It may be useful to co-administer certain cytokines to promote such a response, for example interleukin-2, interleukin-12, interleukin-6, or interleukin-10.

It may also be useful to target the immune compositions to specific cell populations, for example, antigen presenting cells, either by the site of injection, by use delivery systems, or by selective purification of such a cell population from the patient and ex vivo administration of the glycan(s) to such antigen presenting cells. For example, dendritic cells may be sorted as described in Zhou et al (1995) Blood 86, 3295-3301; Roth et al (1996) Scand. J. Immunology 43, 646-651.

A further aspect of the invention therefore provides a vaccine effective against a disease comprising an effective amount of glycans that are bound by circulating antibodies of patients with the disease.

Antibodies of the Invention

The invention provides antibodies that bind to glycans that react with circulating antibodies present in patients with a variety of diseases. Such antibodies are useful for the diagnosis and treatment of the disease. For example, as is illustrated herein, different patients may have produced different amounts and somewhat different types of antibodies against breast-cancer associated glycan epitopes. Hence, administration of antibodies that are known to have good affinity for the breast-cancer associated glycan epitopes of the invention will be beneficial even though the patient has begun to produce some antibodies reactive with breast cancer epitopes. Similarly, as illustrated herein, certain glycan molecules are excellent antigenic epitopes that are recognized by anti-HIV neutralizing antibodies. Antibodies that have slightly different (e.g., improved) affinities for known HIV epitopes are useful for treating and detecting HIV. Thus, the invention provides antibody preparations that can bind any of the glycan epitopes described herein.

Antibodies can be prepared using a selected glycan, class of glycans or mixture of glycans as the immunizing antigen. The glycan or glycan mixture can be coupled to a carrier protein, if desired. Such commonly used carrier proteins which are chemically coupled to epitopes include keyhole limpet hemocyanin (KLH), thyroglobulin, bovine serum albumin (BSA), and tetanus toxin. A coupled protein can be used to immunize the animal (e.g., a mouse, a rat, or a rabbit).

If desired, polyclonal or monoclonal antibodies can be further purified, for example, by binding to and elution from a matrix to which the glycan or mixture of glycans to which the antibodies were raised is bound. Those of skill in the art will know of various techniques common in the immunology arts for purification and/or concentration of polyclonal antibodies, as well as monoclonal antibodies (Coligan, et al., Unit 9, Current Protocols in Immunology, Wiley Interscience, 1991, incorporated by reference).

It is also possible to use the anti-idiotype technology to produce monoclonal antibodies which mimic an epitope. For example, an anti-idiotypic monoclonal antibody made to a first monoclonal antibody will have a binding domain in the hypervariable region which is the “image” of the epitope bound by the first monoclonal antibody.

An antibody suitable for binding to a glycan is specific for at least one portion or region of the glycan. For example, one of skill in the art can use a whole glycan or fragment of glycan to generate appropriate antibodies of the invention. Antibodies of the invention include polyclonal antibodies, monoclonal antibodies, and fragments of polyclonal and monoclonal antibodies.

The preparation of polyclonal antibodies is well-known to those skilled in the art (Green et al., Production of Polyclonal Antisera, in Immunochemical Protocols (Manson, ed.), pages 1-5 (Humana Press 1992); Coligan et al., Production of Polyclonal Antisera in Rabbits, Rats, Mice and Hamsters, in Current Protocols in Immunology, section 2.4.1 (1992), which are hereby incorporated by reference). For example, a glycan or glycan mixture is injected into an animal host, preferably according to a predetermined schedule incorporating one or more booster immunizations, and the animal is bled periodically. Polyclonal antibodies specific for a glycan or glycan fragment may then be purified from such antisera by, for example, affinity chromatography using the glycan coupled to a suitable solid support.

The preparation of monoclonal antibodies likewise is conventional (Kohler & Milstein, Nature, 256:495 (1975); Coligan et al., sections 2.5.1-2.6.7; and Harlow et al., Antibodies: A Laboratory Manual, page 726 (Cold Spring Harbor Pub. 1988)), which are hereby incorporated by reference. Briefly, monoclonal antibodies can be obtained by injecting mice with a composition comprising an antigen (glycan), verifying the presence of antibody production by removing a serum sample, removing the spleen to obtain B lymphocytes, fusing the B lymphocytes with myeloma cells to produce hybridomas, cloning the hybridomas, selecting positive clones that produce antibodies to the antigen, and isolating the antibodies from the hybridoma cultures. Monoclonal antibodies can be isolated and purified from hybridoma cultures by a variety of well-established techniques. Such isolation techniques include affinity chromatography with Protein-A Sepharose, size-exclusion chromatography, and ion-exchange chromatography (Coligan et al., sections 2.7.1-2.7.12 and sections 2.9.1-2.9.3; Barnes et al., Purification of Immunoglobulin G (IgG), in Methods in Molecular Biology, Vol. 10, pages 79-104 (Humana Press 1992)). Methods of in vitro and in vivo multiplication of monoclonal antibodies are available to those skilled in the art. Multiplication in vitro may be carried out in suitable culture media such as Dulbecco's Modified Eagle Medium or RPMI 1640 medium, optionally replenished by a mammalian serum such as fetal calf serum or trace elements and growth-sustaining supplements such as normal mouse peritoneal exudate cells, spleen cells, bone marrow macrophages. Production in vitro provides relatively pure antibody preparations and allows scale-up to yield large amounts of the desired antibodies. Large scale hybridoma cultivation can be carried out by homogenous suspension culture in an air reactor, in a continuous stirrer reactor, or immobilized or entrapped cell culture. Multiplication in vivo may be carried out by injecting cell clones into mammals histocompatible with the parent cells, e.g., osyngeneic mice, to cause growth of antibody-producing tumors. Optionally, the animals are primed with a hydrocarbon, especially oils such as pristine tetramethylpentadecane prior to injection. After one to three weeks, the desired monoclonal antibody is recovered from the body fluid of the animal.

Antibodies can also be prepared through use of phage display techniques. In one example, an organism is immunized with an antigen, such as a glycan or mixture of glycans of the invention. Lymphocytes are isolated from the spleen of the immunized organism. Total RNA is isolated from the splenocytes and mRNA contained within the total RNA is reverse transcribed into complementary deoxyribonucleic acid (cDNA). The cDNA encoding the variable regions of the light and heavy chains of the immunoglobulin is amplified by polymerase chain reaction (PCR). To generate a single chain fragment variable (scFv) antibody, the light and heavy chain amplification products may be linked by splice overlap extension PCR to generate a complete sequence and ligated into a suitable vector. E. coli are then transformed with the vector encoding the scFv, and are infected with helper phage, to produce phage particles that display the antibody on their surface. Alternatively, to generate a complete antigen binding fragment (Fab), the heavy chain amplification product can be fused with a nucleic acid sequence encoding a phage coat protein, and the light chain amplification product can be cloned into a suitable vector. E. coli expressing the heavy chain fused to a phage coat protein are transformed with the vector encoding the light chain amplification product. The disulfide linkage between the light and heavy chains is established in the periplasm of E. coli. The result of this procedure is to produce an antibody library with up to 10⁹ clones. The size of the library can be increased to 10¹⁸ phage by later addition of the immune responses of additional immunized organisms that may be from the same or different hosts. Antibodies that recognize a specific antigen can be selected through panning. Briefly, an entire antibody library can be exposed to an immobilized antigen against which antibodies are desired. Phage that do not express an antibody that binds to the antigen are washed away. Phage that express the desired antibodies are immobilized on the antigen. These phage are then eluted and again amplified in E. coli. This process can be repeated to enrich the population of phage that express antibodies that specifically bind to the antigen. After phage are isolated that express an antibody that binds to an antigen, a vector containing the coding sequences for the antibody can be isolated from the phage particles and the coding sequences can be recloned into a suitable vector to produce an antibody in soluble form. In another example, a human phage library can be used to select for antibodies, such as monoclonal antibodies, that bind to specific glycan epitopes. Briefly, splenocytes may be isolated from a human that has a disease (e.g. cancer, bacterial infection, viral infection, inflammation, transplant rejection, autoimmune diseases and the like) and used to create a human phage library according to methods described herein and available in the art. These methods may be used to obtain human monoclonal antibodies that bind to specific glycan epitopes. Phage display methods to isolate antigens and antibodies are known in the art and have been described (Gram et al., Proc. Natl. Acad. Sci., 89:3576 (1992); Kay et al., Phage display of peptides and proteins: A laboratory manual. San Diego: Academic Press (1996); Kermani et al., Hybrid, 14:323 (1995); Schmitz et al., Placenta, 21 Suppl. A:S106 (2000); Sanna et al., Proc. Natl. Acad. Sci., 92:6439 (1995)).

An antibody of the invention may be derived from a “humanized” monoclonal antibody. Humanized monoclonal antibodies are produced by transferring mouse complementarity determining regions from heavy and light variable chains of the mouse immunoglobulin into a human variable domain, and then substituting human residues in the framework regions of the murine counterparts. The use of antibody components derived from humanized monoclonal antibodies obviates potential problems associated with the immunogenicity of murine constant regions. General techniques for cloning murine immunoglobulin variable domains are described (Orlandi et al., Proc. Nat'l Acad. Sci. USA, 86:3833 (1989) which is hereby incorporated in its entirety by reference). Techniques for producing humanized monoclonal antibodies are described (Jones et al., Nature, 321:522 (1986); Riechmann et al., Nature, 332:323 (1988); Verhoeyen et al, Science, 239:1534 (1988); Carter et al., Proc. Nat'l Acad. Sci. USA, 89:4285 (1992); Sandhu, Crit. Rev. Biotech., 12:437 (1992); and Singer et al., J. Immunol., 150:2844 (1993), which are hereby incorporated by reference).

In addition, antibodies of the present invention may be derived from a human monoclonal antibody. Such antibodies are obtained from transgenic mice that have been “engineered” to produce specific human antibodies in response to antigenic challenge. In this technique, elements of the human heavy and light chain loci are introduced into strains of mice derived from embryonic stem cell lines that contain targeted disruptions of the endogenous heavy and light chain loci. The transgenic mice can synthesize human antibodies specific for human antigens (e.g. the glycans described herein), and the mice can be used to produce human antibody-secreting hybridomas. Methods for obtaining human antibodies from transgenic mice are described (Green et al., Nature Genet., 7:13 (1994); Lonberg et al., Nature, 368:856 (1994); and Taylor et al., Int. Immunol., 6:579 (1994), which are hereby incorporated by reference).

Antibody fragments of the invention can be prepared by proteolytic hydrolysis of the antibody or by expression in E. coli of DNA encoding the fragment. Antibody fragments can be obtained by pepsin or papain digestion of whole antibodies by conventional methods. For example, antibody fragments can be produced by enzymatic cleavage of antibodies with pepsin to provide a 5S fragment denoted F(ab′)₂. This fragment can be further cleaved using a thiol reducing agent, and optionally a blocking group for the sulfhydryl groups resulting from cleavage of disulfide linkages, to produce 3.5S Fab′ monovalent fragments. Alternatively, an enzymatic cleavage using pepsin produces two monovalent Fab′ fragments and an Fc fragment directly. These methods are described (U.S. Pat. Nos. 4,036,945; 4,331,647; and 6,342,221, and references contained therein; Porter, Biochem. J., 73:119 (1959); Edelman et al., Methods in Enzymology, Vol. 1, page 422 (Academic Press 1967); and Coligan et al. at sections 2.8.1-2.8.10 and 2.10.1-2.10.4).

Other methods of cleaving antibodies, such as separation of heavy chains to form monovalent light-heavy chain fragments, further cleavage of fragments, or other enzymatic, chemical, or genetic techniques may also be used, so long as the fragments bind to the antigen that is recognized by the intact antibody.

For example, Fv fragments include an association of V_{H} and V_{L} chains. This association may be noncovalent (Inbar et al., Proc. Nat'l Acad. Sci. USA, 69:2659 (1972)). Alternatively, the variable chains can be linked by an intermolecular disulfide bond or cross-linked by chemicals such as glutaraldehyde (Sandhu, Crit. Rev. Biotech., 12:437 (1992)). Preferably, the Fv fragments comprise V_{H} and V_{L} chains connected by a peptide linker. These single-chain antigen binding proteins (sFv) are prepared by constructing a structural gene comprising DNA sequences encoding the V_{H} and V_{L} domains connected by an oligonucleotide. The structural gene is inserted into an expression vector, which is subsequently introduced into a host cell such as E. coli. The recombinant host cells synthesize a single polypeptide chain with a linker peptide bridging the two V domains. Methods for producing sFvs are described (Whitlow et al., Methods: A Companion to Methods in Enzymology, Vol. 2, page 97 (1991); Bird et al., Science, 242:423 (1988), Ladner et al., U.S. Pat. No. 4,946,778; Pack et al., Bio/Technology, 11:1271 (1993); and Sandhu, Crit. Rev. Biotech., 12:437 (1992)).

Another form of an antibody fragment is a peptide that forms a single complementarity-determining region (CDR). CDR peptides (“minimal recognition units”) can be obtained by constructing genes encoding the CDR of an antibody of interest. Such genes are prepared, for example, by using the polymerase chain reaction to synthesize the variable region from RNA of antibody-producing cells (Larrick et al., Methods: A Companion to Methods in Enzymology, Vol. 2, page 106 (1991)).

An antibody of the invention may be coupled to a toxin. Such antibodies may be used to treat animals, including humans that suffer from diseases such as cancer, bacterial infection, viral infection, and the like. For example, an antibody that binds to a glycan that is etiologically linked to development of breast cancer may be coupled to a tetanus toxin and administered to a patient suffering from breast cancer. Similarly, an antibody that binds to a viral-specific glycan epitope may be coupled to a tetanus toxin and administered to a patient suffering from viral infection. The toxin-coupled antibody can bind to a breast cancer cell or virus and kill it.

An antibody of the invention may be coupled to a detectable tag. Such antibodies may be used within diagnostic assays to determine if an animal, such as a human, has a disease or infection. Examples of detectable tags include, fluorescent proteins (i.e., green fluorescent protein, red fluorescent protein, yellow fluorescent protein), fluorescent markers (i.e., fluorescein isothiocyanate, rhodamine, texas red), radiolabels (i.e., ³H, ³²P, ¹²⁵I), enzymes (i.e., β-galactosidase, horseradish peroxidase, β-glucuronidase, alkaline phosphatase), or an affinity tag (i.e., avidin, biotin, streptavidin). Methods to couple antibodies to a detectable tag are known in the art. Harlow et al., Antibodies: A Laboratory Manual, page 319 (Cold Spring Harbor Pub. 1988).

Dosages, Formulations and Routes of Administration

The compositions of the invention are administered to treat or prevent disease. In some embodiments, the compositions of the invention are administered so as to achieve an immune response against the glycans in the composition. In some embodiments, the compositions of the invention are administered so as to achieve a reduction in at least one symptom associated with a disease such as cancer, bacterial infection, viral infection, inflammation, transplant rejection, autoimmune diseases and the like.

To achieve the desired effect(s), the glycan or a combination thereof, may be administered as single or divided dosages, for example, of at least about 0.01 mg/kg to about 500 to 750 mg/kg, of at least about 0.01 mg/kg to about 300 to 500 mg/kg, at least about 0.1 mg/kg to about 100 to 300 mg/kg or at least about 1 mg/kg to about 50 to 100 mg/kg of body weight, although other dosages may provide beneficial results. The amount administered will vary depending on various factors including, but not limited to, what types of glycans are administered, the route of administration, the progression or lack of progression of the disease, the weight, the physical condition, the health, the age of the patient, whether prevention or treatment is to be achieved, and if the glycan is chemically modified. Such factors can be readily determined by the clinician employing animal models or other test systems that are available in the art.

Administration of the therapeutic agents (glycans) in accordance with the present invention may be in a single dose, in multiple doses, in a continuous or intermittent manner, depending, for example, upon the recipient's physiological condition, whether the purpose of the administration is therapeutic or prophylactic, and other factors known to skilled practitioners. The administration of the glycans or combinations thereof may be essentially continuous over a preselected period of time or may be in a series of spaced doses. Both local and systemic administration is contemplated.

To prepare the composition, the glycans or antibodies or combinations thereof are synthesized or otherwise obtained, and purified as necessary or desired. These therapeutic agents can then be lyophilized or stabilized, their concentrations can be adjusted to an appropriate amount, and the therapeutic agents can optionally be combined with other agents. The absolute weight of a given glycan, binding entity, antibody or combination thereof that is included in a unit dose can vary widely. For example, about 0.01 to about 2 g, or about 0.1 to about 500 mg, of at least one glycan, binding entity, or antibody specific for a particular glycan can be administered. Alternatively, the unit dosage can vary from about 0.01 g to about 50 g, from about 0.01 g to about 35 g, from about 0.1 g to about 25 g, from about 0.5 g to about 12 g, from about 0.5 g to about 8 g, from about 0.5 g to about 4 g, or from about 0.5 g to about 2 g.

Daily doses of the glycan(s), binding entities, antibodies or combinations thereof can vary as well. Such daily doses can range, for example, from about 0.1 g/day to about 50 g/day, from about 0.1 g/day to about 25 g/day, from about 0.1 g/day to about 12 g/day, from about 0.5 g/day to about 8 g/day, from about 0.5 g/day to about 4 g/day, and from about 0.5 g/day to about 2 g/day.

Thus, one or more suitable unit dosage forms comprising the therapeutic agents of the invention can be administered by a variety of routes including oral, parenteral (including subcutaneous, intravenous, intramuscular and intraperitoneal), rectal, dermal, transdermal, intrathoracic, intrapulmonary and intranasal (respiratory) routes. The therapeutic agents may also be formulated for sustained release (for example, using microencapsulation, see WO 94/07529, and U.S. Pat. No. 4,962,091). The formulations may, where appropriate, be conveniently presented in discrete unit dosage forms and may be prepared by any of the methods well known to the pharmaceutical arts. Such methods may include the step of mixing the therapeutic agent with liquid carriers, solid matrices, semi-solid carriers, finely divided solid carriers or combinations thereof, and then, if necessary, introducing or shaping the product into the desired delivery system.

When the therapeutic agents of the invention are prepared for oral administration, they are generally combined with a pharmaceutically acceptable carrier, diluent or excipient to form a pharmaceutical formulation, or unit dosage form. For oral administration, the therapeutic agents may be present as a powder, a granular formulation, a solution, a suspension, an emulsion or in a natural or synthetic polymer or resin for ingestion of the active ingredients from a chewing gum. The therapeutic agents may also be presented as a bolus, electuary or paste. Orally administered therapeutic agents of the invention can also be formulated for sustained release. For example, the therapeutic agents can be coated, micro-encapsulated, or otherwise placed within a sustained delivery device. The total active ingredients in such formulations comprise from 0.1 to 99.9% by weight of the formulation.

By “pharmaceutically acceptable” it is meant a carrier, diluent, excipient, and/or salt that is compatible with the other ingredients of the formulation, and not deleterious to the recipient thereof.

Pharmaceutical formulations containing the therapeutic agents of the invention can be prepared by procedures known in the art using well-known and readily available ingredients. For example, the therapeutic agent can be formulated with common excipients, diluents, or carriers, and formed into tablets, capsules, solutions, suspensions, powders, aerosols and the like. Examples of excipients, diluents, and carriers that are suitable for such formulations include buffers, as well as fillers and extenders such as starch, cellulose, sugars, mannitol, and silicic derivatives. Binding agents can also be included such as carboxymethyl cellulose, hydroxymethylcellulose, hydroxypropyl methylcellulose and other cellulose derivatives, alginates, gelatin, and polyvinyl-pyrrolidone. Moisturizing agents can be included such as glycerol, disintegrating agents such as calcium carbonate and sodium bicarbonate. Agents for retarding dissolution can also be included such as paraffin. Resorption accelerators such as quaternary ammonium compounds can also be included. Surface active agents such as cetyl alcohol and glycerol monostearate can be included. Adsorptive carriers such as kaolin and bentonite can be added. Lubricants such as talc, calcium and magnesium stearate, and solid polyethylene glycols can also be included. Preservatives may also be added. The compositions of the invention can also contain thickening agents such as cellulose and/or cellulose derivatives. They may also contain gums such as xanthan, guar or carbo gum or gum arabic, or alternatively polyethylene glycols, bentones and montmorillonites, and the like.

For example, tablets or caplets containing the therapeutic agents of the invention can include buffering agents such as calcium carbonate, magnesium oxide and magnesium carbonate. Caplets and tablets can also include inactive ingredients such as cellulose, pre-gelatinized starch, silicon dioxide, hydroxy propyl methyl cellulose, magnesium stearate, microcrystalline cellulose, starch, talc, titanium dioxide, benzoic acid, citric acid, corn starch, mineral oil, polypropylene glycol, sodium phosphate, zinc stearate, and the like. Hard or soft gelatin capsules containing at least one therapeutic agent of the invention can contain inactive ingredients such as gelatin, microcrystalline cellulose, sodium lauryl sulfate, starch, talc, and titanium dioxide, and the like, as well as liquid vehicles such as polyethylene glycols (PEGs) and vegetable oil. Moreover, enteric-coated caplets or tablets containing one or more of the therapeutic agents of the invention are designed to resist disintegration in the stomach and dissolve in the more neutral to alkaline environment of the duodenum.

The therapeutic agents of the invention can also be formulated as elixirs or solutions for convenient oral administration or as solutions appropriate for parenteral administration, for instance by intramuscular, subcutaneous, intraperitoneal or intravenous routes. The pharmaceutical formulations of the therapeutic agents of the invention can also take the form of an aqueous or anhydrous solution or dispersion, or alternatively the form of an emulsion or suspension or salve.

Thus, the therapeutic agents may be formulated for parenteral administration (e.g., by injection, for example, bolus injection or continuous infusion) and may be presented in unit dose form in ampoules, pre-filled syringes, small volume infusion containers or in multi-dose containers. As noted above, preservatives can be added to help maintain the shelve life of the dosage form. The active agents and other ingredients may form suspensions, solutions, or emulsions in oily or aqueous vehicles, and may contain formulatory agents such as suspending, stabilizing and/or dispersing agents. Alternatively, the therapeutic agents and other ingredients may be in powder form, obtained by aseptic isolation of sterile solid or by lyophilization from solution, for constitution with a suitable vehicle, e.g., sterile, pyrogen-free water, before use.

These formulations can contain pharmaceutically acceptable carriers, vehicles and adjuvants that are well known in the art. It is possible, for example, to prepare solutions using one or more organic solvent(s) that is/are acceptable from the physiological standpoint, chosen, in addition to water, from solvents such as acetone, ethanol, isopropyl alcohol, glycol ethers such as the products sold under the name “Dowanol,” polyglycols and polyethylene glycols, C₁-C₄ alkyl esters of short-chain acids, ethyl or isopropyl lactate, fatty acid triglycerides such as the products marketed under the name “Miglyol,” isopropyl myristate, animal, mineral and vegetable oils and polysiloxanes.

It is possible to add, if necessary, an adjuvant chosen from antioxidants, surfactants, other preservatives, film-forming, keratolytic or comedolytic agents, perfumes, flavorings and colorings. Antioxidants such as t-butylhydroquinone, butylated hydroxyanisole, butylated hydroxytoluene and α-tocopherol and its derivatives can be added.

Additionally, the therapeutic agents are well suited to formulation as sustained release dosage forms and the like. The formulations can be so constituted that they release the active agent, for example, in a particular part of the vascular system or respiratory tract, possibly over a period of time. Coatings, envelopes, and protective matrices may be made, for example, from polymeric substances, such as polylactide-glycolates, liposomes, microemulsions, microparticles, nanoparticles, or waxes. These coatings, envelopes, and protective matrices are useful to coat indwelling devices, e.g., stents, catheters, peritoneal dialysis tubing, draining devices and the like.

For topical administration, the therapeutic agents may be formulated as is known in the art for direct application to a target area. Forms chiefly conditioned for topical application take the form, for example, of creams, milks, gels, dispersion or microemulsions, lotions thickened to a greater or lesser extent, impregnated pads, ointments or sticks, aerosol formulations (e.g., sprays or foams), soaps, detergents, lotions or cakes of soap. Other conventional forms for this purpose include wound dressings, coated bandages or other polymer coverings, ointments, creams, lotions, pastes, jellies, sprays, and aerosols. Thus, the therapeutic agents of the invention can be delivered via patches or bandages for dermal administration. Alternatively, the therapeutic agents can be formulated to be part of an adhesive polymer, such as polyacrylate or acrylate/vinyl acetate copolymer. For long-term applications it might be desirable to use microporous and/or breathable backing laminates, so hydration or maceration of the skin can be minimized. The backing layer can be any appropriate thickness that will provide the desired protective and support functions. A suitable thickness will generally be from about 10 to about 200 microns.

Ointments and creams may, for example, be formulated with an aqueous or oily base with the addition of suitable thickening and/or gelling agents. Lotions may be formulated with an aqueous or oily base and will in general also contain one or more emulsifying agents, stabilizing agents, dispersing agents, suspending agents, thickening agents, or coloring agents. The active ingredients can also be delivered via iontophoresis, e.g., as disclosed in U.S. Pat. Nos. 4,140,122; 4,383,529; or 4,051,842. The percent by weight of a therapeutic agent of the invention present in a topical formulation will depend on various factors, but generally will be from 0.01% to 95% of the total weight of the formulation, and typically 0.1-85% by weight.

Drops, such as eye drops or nose drops, may be formulated with one or more of the therapeutic agents in an aqueous or non-aqueous base also comprising one or more dispersing agents, solubilizing agents or suspending agents. Liquid sprays are conveniently delivered from pressurized packs. Drops can be delivered via a simple eye dropper-capped bottle, or via a plastic bottle adapted to deliver liquid contents dropwise, via a specially shaped closure.

The therapeutic agent may further be formulated for topical administration in the mouth or throat. For example, the active ingredients may be formulated as a lozenge further comprising a flavored base, usually sucrose and acacia or tragacanth; pastilles comprising the composition in an inert base such as gelatin and glycerin or sucrose and acacia; and mouthwashes comprising the composition of the present invention in a suitable liquid carrier.

The pharmaceutical formulations of the present invention may include, as optional ingredients, pharmaceutically acceptable carriers, diluents, solubilizing or emulsifying agents, and salts of the type that are available in the art. Examples of such substances include normal saline solutions such as physiologically buffered saline solutions and water. Specific non-limiting examples of the carriers and/or diluents that are useful in the pharmaceutical formulations of the present invention include water and physiologically acceptable buffered saline solutions such as phosphate buffered saline solutions pH 7.0-8.0.

The active ingredients of the invention can also be administered to the respiratory tract. Thus, the present invention also provides aerosol pharmaceutical formulations and dosage forms for use in the methods of the invention.

In general, such dosage forms comprise an amount of at least one of the agents of the invention effective to treat or prevent the clinical symptoms of a disease. Diseases contemplated by the invention include, for example, cancer, bacterial infection, viral infection, inflammation, transplant rejection, autoimmune diseases and the like. Any statistically significant attenuation of one or more symptoms of a disease is considered to be a treatment of the disease.

Alternatively, for administration by inhalation or insufflation, the composition may take the form of a dry powder, for example, a powder mix of the therapeutic agent and a suitable powder base such as lactose or starch. The powder composition may be presented in unit dosage form in, for example, capsules or cartridges, or, e.g., gelatin or blister packs from which the powder may be administered with the aid of an inhalator, insufflator, or a metered-dose inhaler (see, for example, the pressurized metered dose inhaler (MDI) and the dry powder inhaler disclosed in Newman, S. P. in Aerosols and the Lung, Clarke, S. W. and Davia, D. eds., pp. 197-224, Butterworths, London, England, 1984).

Therapeutic agents of the present invention can also be administered in an aqueous solution when administered in an aerosol or inhaled form. Thus, other aerosol pharmaceutical formulations may comprise, for example, a physiologically acceptable buffered saline solution containing between about 0.1 mg/ml and about 100 mg/ml of one or more of the therapeutic agents of the present invention specific for the indication or disease to be treated. Dry aerosol in the form of finely divided solid therapeutic agent that are not dissolved or suspended in a liquid are also useful in the practice of the present invention. Therapeutic agents of the present invention may be formulated as dusting powders and comprise finely divided particles having an average particle size of between about 1 and 5 μm, alternatively between 2 and 3 μm. Finely divided particles may be prepared by pulverization and screen filtration using techniques well known in the art. The particles may be administered by inhaling a predetermined quantity of the finely divided material, which can be in the form of a powder. It will be appreciated that the unit content of active ingredient or ingredients contained in an individual aerosol dose of each dosage form need not in itself constitute an effective amount for treating the particular immune response, vascular condition or disease since the necessary effective amount can be reached by administration of a plurality of dosage units. Moreover, the effective amount may be achieved using less than the dose in the dosage form, either individually, or in a series of administrations.

For administration to the upper (nasal) or lower respiratory tract by inhalation, the therapeutic agents of the invention are conveniently delivered from a nebulizer or a pressurized pack or other convenient means of delivering an aerosol spray. Pressurized packs may comprise a suitable propellant such as dichlorodifluoromethane, trichlorofluoromethane, dichlorotetrafluoroethane, carbon dioxide or other suitable gas. In the case of a pressurized aerosol, the dosage unit may be determined by providing a valve to deliver a metered amount. Nebulizers include, but are not limited to, those described in U.S. Pat. Nos. 4,624,251; 3,703,173; 3,561,444; and 4,635,627. Aerosol delivery systems of the type disclosed herein are available from numerous commercial sources including Fisons Corporation (Bedford, Mass.), Schering Corp. (Kenilworth, N.J.) and American Pharmoseal Co., (Valencia, Calif.). For intra-nasal administration, the therapeutic agent may also be administered via nose drops, a liquid spray, such as via a plastic bottle atomizer or metered-dose inhaler. Typical of atomizers are the Mistometer (Wintrop) and the Medihaler (Riker).

Furthermore, the active ingredients may also be used in combination with other therapeutic agents, for example, pain relievers, anti-inflammatory agents, other anti-cancer agents and the like, whether for the conditions described or some other condition.

Kits

The present invention further pertains to a packaged pharmaceutical composition such as a kit or other container for detecting, controlling, preventing or treating a disease. The kits of the invention can be designed for detecting, controlling, preventing or treating diseases such as cancer, bacterial infection, viral infection, inflammation, transplant rejection, autoimmune diseases and the like. In one embodiment, the kit or container holds an array or library of glycans for detecting disease and instructions for using the array or library of glycans for detecting the disease. The array includes at least one glycan that is bound by antibodies present in serum samples of persons with the disease.

In another embodiment, the kit or container holds a therapeutically effective amount of a pharmaceutical composition for treating, preventing or controlling a disease and instructions for using the pharmaceutical composition for control of the disease. The pharmaceutical composition includes at least one glycan of the present invention, in a therapeutically effective amount such that the disease is controlled, prevented or treated.

In a further embodiment, the kit comprises a container containing an antibody that specifically binds to a glycan that is associated with a disease. The antibody can have a directly attached or indirectly associated therapeutic agent. The antibody can also be provided in liquid form, powder form or other form permitting ready administration to a patient.

The kits of the invention can also comprise containers with tools useful for administering the compositions of the invention. Such tools include syringes, swabs, catheters, antiseptic solutions and the like.

The following examples are for illustration of certain aspects of the invention and is not intended to be limiting thereof.

### EXAMPLE 1

### Enzymatic Synthesis of Glycans

The inventors have previously cloned and characterized the bacterial N. meningitides enzymes β4GalT-GalE and β3GlcNAcT. Blixt, O.; Brown, J.; Schur, M.; Wakarchuk, W. and Paulson, J. C., J. Org. Chem. 2001, 66, 2442-2448; Blixt, O.; van Die, I.; Norberg, T. and van den Eijnden, D. H., Glycobiol. 1999, 9, 1061-1071. β4GalT-GalE is a fusion protein constructed from β4GalT and the uridine-5′-diphospho-galactose-4′-epimerase (GalE) for in situ conversion of inexpensive UDP-glucose to UDP-galactose providing a cost efficient strategy.

Both enzymes, β4GalT-GalE and β3GlcNAcT, were over expressed in E. coli AD202 in a large-scale fermentor (100 L). Bacteria were cultured in 2YT medium and induced with iso-propyl-thiogalactopyranoside (IPTG) to ultimately produce 8-10 g of bacterial cell paste/L cell media. The enzymes were then released from the cells by a microfluidizer and were solubilized in Tris buffer (25 mM, pH 7.5) containing manganese chloride (10 mM) and Triton X (0.25%) to reach enzymatic activities of about 50 U/L and 115 U/L of cell culture β4GalT-GalE and β3GlcNAcT, respectively.

Specificity studies of the β3GlcNAcT (Table 4) revealed that lactose (4) is the better acceptor substrate (100%) while the enzyme shows just about 7-8% activity with N-acetyllactosamine (6). The structures of these disaccharides are provided below.

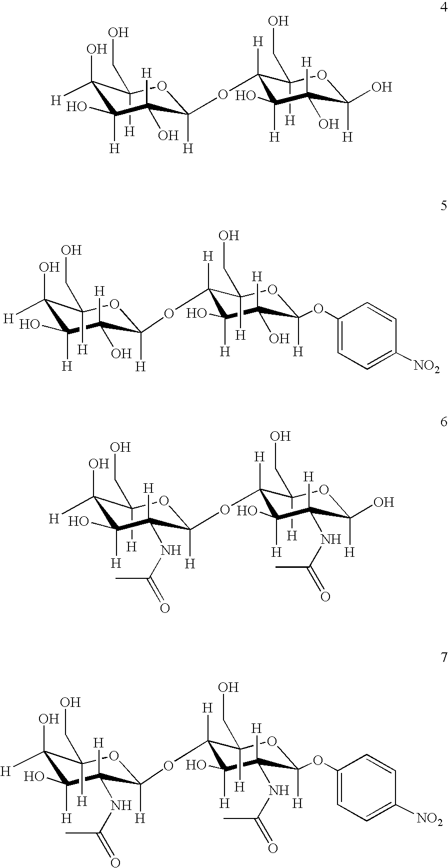

Adding the hydrophobic para-nitrophenyl ring as an aglycon to the reducing end of the acceptors enhanced the activity of the enzyme up to 10 fold (compare 4 with 5 and 6 with 7). The increase in the enzyme activity by adding a hydrophobic aglycon to the acceptor sugar, though to the lesser extent, has also been shown for β4GalT (compare 12 with 13, 14). The relaxed substrate specificity of these enzymes makes them very useful for preparative synthesis of various carbohydrate structures, including poly-N-acetyllactosamines.

TABLE 4
Selected β4GalT-GalE and β3GlcNAcT Specificity Data

| Acceptor | Relative enzyme activity (%) |
|---|---|
| | β(1-3)GlcNAcT-activity^{#} |
| 1 Gal | 5 |
| 2 Galα-OpNP | 102 |
| 3 Galβ-OpNP | 16 |
| 4 Galβ(1-4)Glc | 100 |
| 5 Galβ(1-4)Glcβ-OpNP | 945 |
| 6 Galβ(1-4)GlcNAc | 7 |
| 7 Galβ(1-4)GlcNAcβ-OpNP | 74 |
| 8 Galβ(1-3)GlcNAc | 5 |
| | β(1-4)GalT-GalE-activity* |
| 9 Glc | 80 |
| 10 Glcβ-OpNP | 60 |
| 11 GlcNH₂ | 30 |
| 12 GlcNAc | 100 |
| 13 GlcNAcβ-OpNP | 120 |
| 14 GlcNAcβ-Osp₆ | 360 |
| 15 GlcNAllocβ-sp₇ | 550 |

Abbreviations:
pNP, para-nitrophenyl;
sp₆, 2-azidoethyl;
sp₇, 5-azido-3-oxapentyl,
Alloc, allyloxycarbonyl

Poly-N-acetyllactosamine is a unique carbohydrate structure composed of N-acetyllactosamine repeats that provides the backbone structure for additional modifications, such as sialylation and/or fucosylation. These extended oligosaccharides have been shown to be involved in various biological functions by interacting as a specific ligand to selectins or galectins. Ujita, M.; McAuliffe, J.; Hindsgaul, O.; Sasaki, K.; Fukuda, M. N. and Fukuda, M., J. Biol. Chem. 1999, 274, 16717-16726; Appelmelk, B. J.; Shiberu, B.; Trinks, C.; Tapsi, N.; Zheng, P. Y.; Verboom, T.; Maaskant, J.; Hokke, C. H.; Schiphorst, W. E. C. M.; Blanchard, D.; SimoonsSmit, I. M.; vandenEijnden, D. H. and Vandenbroucke Grauls, C. M. J. E., Infect. Immun. 1998, 66, 70-76; Leppaenen, A.; Penttilae, L.; Renkonen, O.; McEver, R. P. and Cummings, R. D., J. Biol. Chem. 2002, 277, 39749-39759; Renkonen, O., Cell. Mol Life Sci. 2000, 57, 1423-1439; Baldus, S. E.; Zirbes, T. K.; Weingarten, M.; Fromm, S.; Glossmann, J.; Hanisch, F. G.; Monig, S. P.; Schroder, W.; Flucke, U.; Thiele, J.; Holscher, A. H. and Dienes, H. P., Tumor Biology. 2000, 21, 258-266; Cho, M. and Cummings, R. D., TIGG. 1997, 9, 47-56, 171-178.

Based on the specificity data in Table 4, enzymatic synthesis of galactosides and polylactosamines can be performed in multi-gram quantities. This method employed various fucosyltransferases (FUTs). Several fucosyltransferases (FUTs) have been characterized in terms of substrate specificities and biological functions in different laboratories. Murray, B. W.; Takayama, S.; Schultz, J. and Wong, C. H., Biochem. 1996, 35, 11183-11195; Weston, B. W.; Nair, R. P.; Larsen, R. D. and Lowe, J. B., J. Biol. Chem. 1992, 267, 4152-4160; Kimura, H.; Shinya, N.; Nishihara, S.; Kaneko, M.; Irimura, T. and Narimatsu, H., Biochem. Biophys. Res. Comm. 1997, 237, 131-137; Chandrasekaran, E. V.; Jain, R. K.; Larsen, R. D.; Wlasichuk, K. and Matta, K. L., Biochem. 1996, 35, 8914-8924; Devries, T.; Vandeneijnden, D. H.; Schultz, J. and Oneill, R., FEBS Lett. 1993, 330, 243-248; Devries, T. and van den Eijnden, D. H., Biochem. 1994, 33, 9937-9944

The available specificity data in combination with large scale production of recombinant FUTs made it possible to synthesize various precious fucosides in multigram quantities. Scheme I illustrates the general procedure employed for elongating the poly-LacNAc backbone and selected fucosylated structures using different FUTs and GDP-fucose.

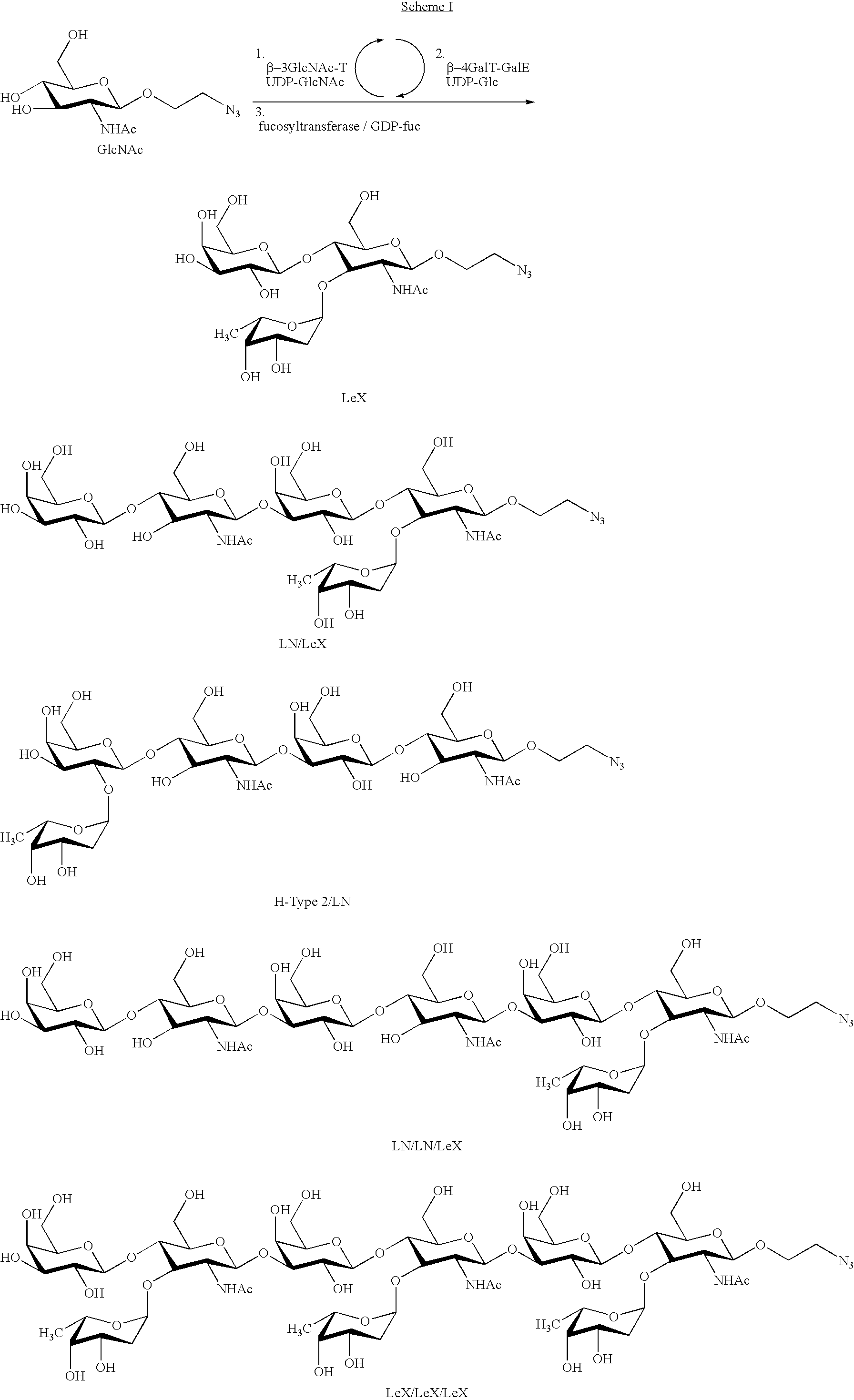

A systematic gram-scale synthesis of different fucosylated lactosamine derivatives was initiated using the Scheme I and the following recombinant fucosyltransferases, FUT-II, FUT-III, FUT-IV, FUT-V, and FUT-VI. All the above fucosyltransferases, except for FUT-V, were produced in the insect cell expression system and either partially purified on a GDP-sepharose affinity column or concentrated in a Tangential Flow Filtrator (TFF-MWCO 10k) as a crude enzyme mixture. The FUT-V enzyme was expressed in A. niger as described in Murray, B. W.; Takayama, S.; Schultz, J. and Wong, C. H., Biochem. 1996, 35, 11183-11195.

The yields for different stages of production of the fucosylated lactosamine derivatives were 75-90% for LeX (2 enzymatic steps), 45-50% for dimeric LacNAc structures (4 enzymatic steps) and 30-35% for trimeric lacNAc structures (6 enzymatic steps).

### EXAMPLE 2

### Synthesis of Sialic-acid-containing Oligosaccharides

Sialic acid is a generic designation used for 2-keto-3-deoxy-nonulosonic acids. The most commonly occurring derivatives of this series of monosaccharides are those derived from N-acetylneuraminic acid (Neu5Ac), N-glycolylneuraminic acid (Neu5Gc) and the non-aminated 3-deoxy-D-glycero-D-galacto-2-nonulosonic acid (KDN). Sialic-acid-containing oligosaccharides are an important category of carbohydrates that are involved in different biological regulations and functions. Sialic acids are shown to be involved in adsorption of toxins/viruses, and diverse cellular communications through interactions with carbohydrate binding proteins (CBPs). Selectins and Siglecs (sialic acid-binding immunoglobulin-superfamily lectins) are among those well-characterized CBPs that function biologically through sialic acid interactions.

Synthesis of oligosaccharides containing sialic acids is not trivial. Unfortunately, the chemical approaches have several hampering factors in common. For example, stereo selective glycosylation with sialic acid generally gives an isomeric product, and as a result, purification problems and lower yields. Its complicated nature, also require extensive protecting group manipulations and careful design of both acceptor and donor substrates and substantial amounts of efforts are needed to prepare these building blocks.

For a fast and efficient way to sialylate carbohydrate structures, the method of choice is through catalysis by sialyltransferases. Enzymatic sialylation generating Neu5Ac-containing oligosaccharides is way to generate sialylate carbohydrates for both analytical and preparative purposes. Koeller, K. M. and Wong, C.-H., Nature 2001, 409, 232-240; Gilbert, M.; Bayer, R.; Cunningham, A.-M.; DeFrees, S.; Gao, Y.; Watson, D. C.; Young, N. M. and Wakarchuk, W. W., Nature Biotechnol. 1998, 16, 769-772; Ichikawa, Y.; Look, G. C. and Wong, C. H., Anal. Biochem. 1992, 202, 215-238. However, efficient methods for preparation of oligosaccharides having the Neu5Gc or KDN structures have not previously been explored to the same extent because of the scarcity of these sialoside derivatives.

A simple way to obtain different sialoside derivatives was devised using a modification of a method, originally developed by Wong and co-workers. Crocker, P. R., Curr. Opin. Struct. Biol. 2002, 12, 609-615. This method employed recombinant sialyltransferases along with a commercial Neu5Ac aldolase, ST3-CMP-Neu5Ac synthetase. Gilbert, M.; Bayer, R.; Cunningham, A.-M.; DeFrees, S.; Gao, Y.; Watson, D. C.; Young, N. M. and Wakarchuk, W. W., Nature Biotechnol. 1998, 16, 769-772.

The preferred route to generate Neu5Ac-oligosaccharides was to use a one-pot procedure described in Scheme II (B and C).

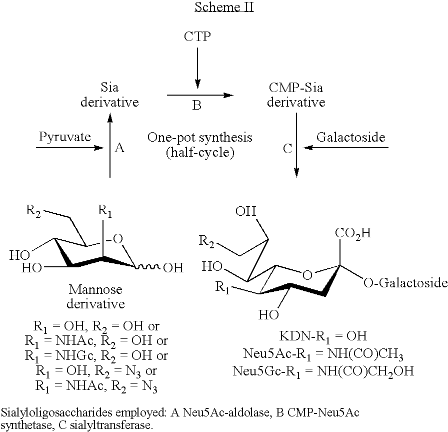

Briefly, ST3-CMP-Neu5Ac synthetase catalyzed the formation of CMP-Neu5Ac quantitatively from 1 equivalent of Neu5Ac and 1 equivalent of CTP. After removal of the fusion protein by membrane filtration (MW cut-off 10k) a selected galactoside and a recombinant sialyltransferase as described in Table 5 was introduced to produce the desired Neu5Ac-sialoside.

TABLE 5
Recombinant Sialyltransferases Produced for Synthesis

| | | Produced |
|---|---|---|
| Sialyltransferase | Source of Production | Activity* |
| hST6Gal-I | Baculovirus (19) | 20 |
| pST3Gal-I | Baculovirus (45) | 20 |
| rST3Gal-III | A. Niger^{#} | 50 |
| chST6Gal-I | Baculovirus (46) | 10 |
| ST3Gal-Fusion | E. coli (42) | 6000 |
| ST8 (Cst-II) | E. coli (70) | 140 |

*Units/L cell culture

This synthetic scheme produced multi-gram quantities of product typically with a yield of 70-90% recovery of sialylated products.

To synthesize Neu5Gc and KDN derivatives the one-pot system would include another enzymatic reaction in addition to routes B and C (Scheme II). In this respect, mannose derivatives, pyruvate (3 eqv.) and commercial microorganism Neu5Ac aldolase (Toyobo) were introduced into the one-pot half-cycle (Scheme II, A). The enzymes in Table 5 were able to generate various N- and O-linked oligosaccharides with α(2-3)-, α(2-6)- or α(2-8)-linked sialic acid derivatives of Neu5Gc, KDN and some of the 9-azido-9deoxy-Neu5Ac-analogs in acceptable yields (45-90%). O-linked sialyl-oligosaccharides are another class of desired compounds for the biomedical community. These structures are frequently found in various cancer tissues and lymphoma and are highly expressed in many types of human malignancies including colon, breast, pancreas, ovary, stomach, and lung adenocarcinomas. Dabelsteen, E., J. Pathol. 1996, 179, 358-369; Itzkowitz, S. H.; Yuan, M.; Montgomery, C. K.; Kjeldsen, T.; Takahashi, H. K. and Bigbee, W. L., Cancer Res. 1989, 49, 197-204.

The inventors have previously reported the cloning, expression, and characterization of chicken ST6GalNAc-I and its use in preparative synthesis of the O-linked sialoside antigens, STn-, α(2-6)SiaT-, α(2-3)SiaT- and Di-SiaT-antigen. Blixt, O.; Allin, K.; Pereira, L.; Datta, A. and Paulson, J. C., J. Am. Chem. Soc. 2002, 124, 5739-5746. Briefly, the recombinant enzyme was expressed in insect cells and purified by CDP-sepharose affinity chromatography to generate approximately 10 U/L of cell culture. The enzymatic activity was evaluated on a set of small acceptor molecules (Table 6), and it was found that an absolute requirement for enzymatic activity is that the anomeric position on GalNAc is α-linked to threonine.

TABLE 6
chST6GalNAc-I Activity of α-D-Galacto Derivatives

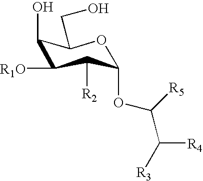

| Compound | R₁ | R₂ | R₃ | R₄ | R₅ | cpm | nmol/mg × min⁻¹ |
|---|---|---|---|---|---|---|---|
| D-GalNAc | H | NHAc | | | | 0 | 0.00 |
| 1 | H | NHAc | N₃ | H | H | 65 | 0.06 |
| 2 | H | NHAc | NHAc | H | H | 121 | 0.11 |
| 3c | H | NHAc | NHAc | COOCH₃ | CH₃ | 9133 | 8.60 |
| 4 | H | N₃ | NHAc | COOCH₃ | CH₃ | 3043 | 2.90 |
| 5 | H | NH₂ | NHAc | COOCH₃ | CH₃ | 1421 | 1.30 |
| 6 | H | NHAc | NHF_{moc} | COOCH₃ | CH₃ | 13277 | 12.50* |
| 7c | Galβ1,3 | NHAc | NHAc | COOCH₃ | CH₃ | 12760 | 12.00 |

NOTE:
*Product was isolated by using Sep-Pak (C18) cartridges as described in Palcic, M. M.; Heerze, L. D.; Pierce, M. and Hindsgaul, O., Glycoconj. J. 1988, 5, 49-63.

Thus, O-linked sialosides terminating with a protected threonine could successfully be synthesized on gram-scale reactions using Scheme IV. To be able to attach these compounds to other functional groups, the N-acetyl protecting group on threonine could be substituted with a removable 9-fluorenyl (F-moc) derivative before enzymatic extension with chST6GalNAc-I. Blixt, O.; Collins, B. E.; Van Den Nieuwenhof, I. M.; Crocker, P. R. and Paulson, J. C., (2003 J. Biol. Chem. 15: 278). As seen in Table 6, the enzyme was not sensitive to bulky groups at this position (compound 6).

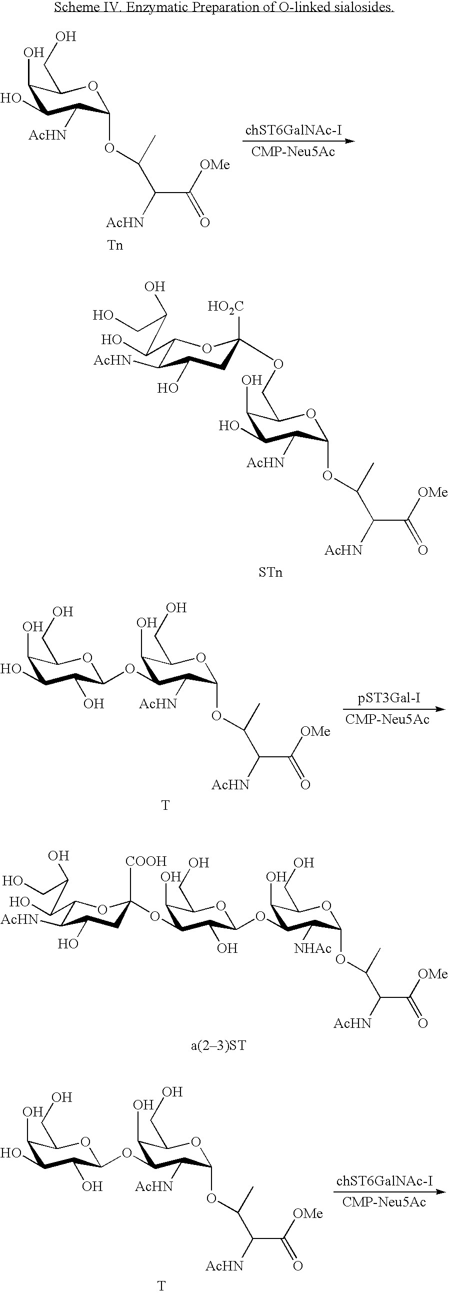

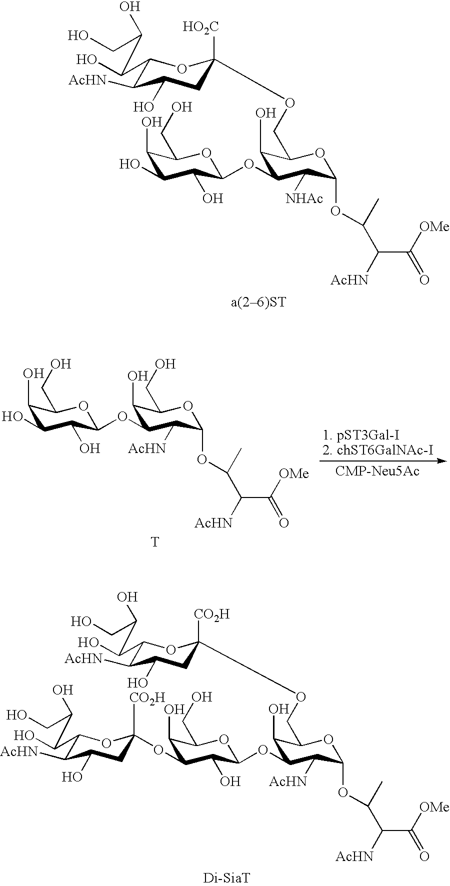

### EXAMPLE 3

### Synthesis of Ganglioside Mimics

Gangliosides are glycolipids that comprise a structurally diverse set of sialylated molecules. They are attached and enriched in nervous tissues and they have been found to act as receptors for growth factors, toxins and viruses and to facilitate the attachment of human melanoma and neuroblastoma cells. Kiso, M., Nippon Nogei Kagaku Kaishi. 2002, 76, 1158-1167; Gagnon, M. and Saragovi, H. U., Expert Opinion on Therapeutic Patents. 2002, 12, 1215-1223; Svennerholm, L., Adv. Gen. 2001, 44, 33-41; Schnaar, R. L., Carbohydr. Chem. Biol. 2000, 4, 1013-1027; Ravindranath, M. H.; Gonzales, A. M.; Nishimoto, K.; Tam, W.-Y.; Soh, D. and Morton, D. L., Ind. J. Exp. Biol. 2000, 38, 301-312; Rampersaud, A. A.; Oblinger, J. L.; Ponnappan, R. K.; Burry, R. W. and Yates, A. J., Biochem. Soc. Trans. 1999, 27, 415-422; Nohara, K., Seikagaku. 1999, 71, 337-341.

Despite the importance of these sialylated ganglioside structures, methods for their efficient preparation have been limiting. The introduction of sialic acid to a glycolipid core structure have shown to be a daunting task, needed complicated engineering with well executed synthetic strategies.

Recently, several glycosyltransferase genes from Campylobacter jejuni (OH4384) have been identified to be involved in producing various ganglioside-related lipoligosaccharides (LOS) expressed by this pathogenic bacteria. Gilbert, M.; Brisson, J.-R.; Karwaski, M.-F.; Michniewicz, J.; Cunningham, A.-M.; Wu, Y.; Young, N. M. and Wakarchuk, W. W., J. Biol. Chem. 2000, 275, 3896-3906. Among these genes, cst-II, coding for a bifunctional α(2-3/8) sialyltransferase, has been demonstrated to catalyze transfers of Neu5Ac α(2-3) and α(2-8) to lactose and sialyllactose, respectively. Another gene, cgtA, coding for a β(1-4)-N-acetylgalactosaminyltransferase (β4GalNAcT) that is reported to transfer GalNAc β(1-4) to Neu5Acα(2-3)lactose acceptors generating the GM2 (Neu5Acα(2-3)[GalNAcβ(1-4)]Galβ(1-4)Glc-) epitope.

The gene products of the two glycosyltransferase genes (cst-II and cgtA) were successfully over expressed in large scale (100 L E. coli fermentation) and used in the preparative synthesis of various ganglioside mimics. For synthetic purposes an extensive specificity study of these enzymes was also conducted using neutral and sialylated structures to further specify the synthetic utility of these enzymes.

For a cost-efficient synthesis of GalNAc-containing oligosaccharides, expensive uridine-5′-diphosphate-N-acetylgalactosamine (UDP-GalNAc) was produced in situ from inexpensive UDP-GlcNAc by the UDP-GlcNAc-4′-epimerase (GalNAc-E). GalNAc-E was cloned from rat liver into the E. coli expression vector (pCWori) and expressed in E. coli AD202 cells. Briefly, a lactose derivative was elongated with sialic acid repeats using α(2-8)-sialyltransferase and crude CMP-Neu5Ac. Several products (GM3, GD3, GT3) were isolated from this mixture. Increasing CDP-Neu5Ac from 2.5 to 4 equivalents favors the formation of GT3, and minor amounts of GD3 were isolated. Typical yields range from 40-50% of the major compound and 15-20% for the minor compound. Isolated compounds were further furbished with the action of GM2-synthetase (CgtA) and GalE to give the corresponding GM2, GD2, and GT2 structures in quantitative yields (Scheme V).

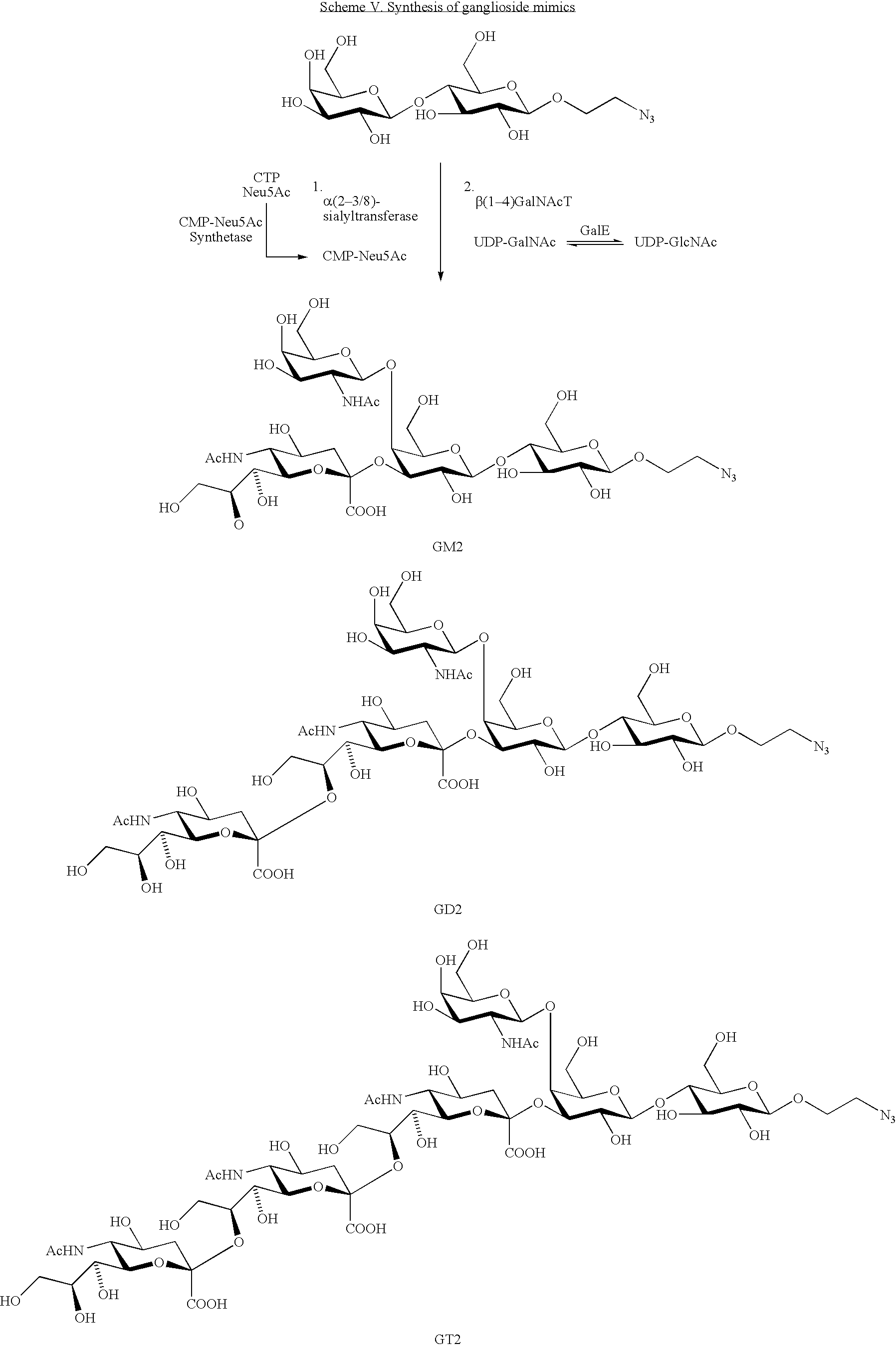

Therefore, methodologies were developed for generating diverse series of glycans, such as poly-N-acetyllactosamine and its corresponding fucosylated and/or sialylated compounds, various sialoside derivatives of N- and O-linked glycans, and ganglioside mimic structures. Furthermore, a simple route to produce the scarce sialic acid derivatives was described. This work demonstrates that chemoenzymatic synthesis of complicated carbohydrate structures can reach a facile and practical level by employing a functional toolbox of different glycosyltransferases. Detailed information of the specificity of these enzymes is needed for developing a library of glycan compounds with an extensive structural assortment. The invention provides such a library of carbohydrates and methods for using the library in high throughput studies of carbohydrate-protein, as well as, carbohydrate-carbohydrate interactions.

### EXAMPLE 4

### Isolating Glycans from Natural Sources

The Example illustrates how certain type of mannose-containing glycans can be isolated from bovine pancreatic ribonuclease B.

Pronase Digestion of Bovine Pancreatic Ribonuclease B: Bovine pancreatic ribonuclease B (Sigma Lot 060K7650) was dissolved in buffer (0.1M Tris+1 mM MgCl₂+1 mM CaCl₂ pH 8.0) and pronase (Calbiochem Lot B 50874) was added to give a ratio by weight of five parts glycoprotein to one part pronase. It was incubated at 60° C. for 3 hours. Mannose-containing glycans in the digested sample were affinity purified using a freshly prepared Con A in buffer (0.1M Tris, 1 mM MgCl₂, 1 mM CaCl₂, pH 8.0), washed and eluted with 200 mls 0.1M methyl-a-D-mannopyranoside (Calbiochem Lot B37526). The Con A eluted sample was purified on Carbograph solid-phase extraction column (Alltech 1000 mg, 15 ml) and eluted with 30% acetonitrile +0.06% TFA. It was dried and reconstituted in 1 ml water. Mass analysis was done by MALDI and glycan quantification by phenol sulfuric acid assay.

The pronase digested ribonuclease b was diluted with 5 mls 0.1M Tris pH 8.0 loaded onto 15 mls Con A column in 0.1M Tris, 1 mM MgCl₂, 1 mM CaCl₂, pH 8.0, washed and eluted with 50 mls 0.1M methyl-α-D mannopyranoside. It was then purified on Carbograph solid-phase extraction column (Alltech 1000 mg, 15 ml) eluted with 80% acetonitrile, containing 0.1% TFA, dried and reconstituted in 2 ml water. Mass analysis and glycan quantification were performed using a Voyager Elite MALDI-TOF (Perseptive BioSystems) in negative mode.

Separation of Fractions on Dionex: Pronase digested ribonuclease b was injected on the DIONEX using a PA-100 column and eluted with the following gradient: Solution A=0.1M NaOH, B=0.5M NaOAc in 0.1M NaOH; 0% B for 3 mins, then a linear gradient from 0% B to 6.7% B in 34 mins. The individual peak fractions were collected and purified on Carbograph solid-phase columns (Alltech 150 mg, 4 ml) by eluting with 80% acetonitrile containing 0.1% TFA. They were dried and reconstituted in water. Final Mass analysis and glycan quantification were performed.

### EXAMPLE 5

### Preparation and Use of Glycan Arrays

Materials. Natural glycoproteins, alphal-acid glycoprotein (α₁-AGP), α₁-AGP glycoform A and B were prepared as described in Shiyan, S. D. & Bovin, N. V. (1997) Glycoconj. J. 14, 631-8. Ceruloplasmin, fibrinogen, and apo-transferrin were obtained from Sigma-Aldrich Chemical Company, MO. Synthetic glycan ligands 7-134, 146-200 (structures shown in FIG. 7) were from The Consortium for Functional Glycomics or prepared as described in Pazynina et al. (2003) Mendeleev Commun. 13, 245-248; Pazynina et al. (2002) Mendeleev Commun. 12, 183-184; Pazynina et al. (2002) Tet. Lett. 43, 8011-8013; Nifant'ev et al. (1996) J. Carbohydr. Chem. 15, 939-953; Zemlyanukhina et al. (1995) Carbohydr. Lett. 1, 277-284. Ligands 111, 135-139 (shown in FIG. 7) were obtained through one-pot chemical synthesis as described in Lee et al. (2004) Angew. Chem. Int. Ed. 43, 1000-1003. Ligands 140-145 (shown in FIG. 7) were isolated from ribonuclease as described herein.

NHS-activated glass slides (Slide-H) were employed that were from Schott Nexterion (Germany). These slides are coated with a hydrogel, which is composed of a multi-component coating matrix (thickness: 10-60 nm), which is cross-linked with the microarray glass substrate allowing stringent washing steps. Long, hydrophilic polymer spacers tether the functional groups (amine-reactive N-hydroxysuccinimide-esters) to the coating matrix, thereby ensuring that immobilized probes are highly accessible in a flexible, solution-like environment. The robotic printing arrayer employed was custom made by Robotic Labware Designs (Carlsbad, Calif.). Arrays were printed using CMP4B microarray spotting pins (TeleChem International, Inc).

Several glycan binding proteins (GBPs) were obtained from commercial sources (Con A and ECA from EY-laboratories Inc., San Mateo, Calif.; anti-CD15 from BD Biosciences, San Jose, Calif.). Other types of glycan binding proteins were obtained from various investigators including DC-SIGN (van Die et al. (2003) Glycobiology 13, 471-478), Influenza virus, A/Puerto Rico/8/34 (H1N1) (Gamblin et al. (2004) Science 303, 1838-42), 2G12 (Calarese et al. (2003) Science 300, 2065-71), Cyanovirin-N (Scanlan et al. (2002) J. Virol. 76, 7306-21), H3 HA (Stevens, Blixt and Wilson; manuscript in preparation).

Human serum was obtained from healthy volunteers at The General Clinical Research Center, Scripps Hospital, La Jolla. Human saliva was similarly obtained from a healthy volunteer. The samples were centrifuged for 30 mins at 3000 rpm and heat inactivated at 56° C. for 25 minutes. CD22 was expressed and purified as described in Blixt et al. (2003) J. Biol. Chem. 278, 31007-19. Recombinant human Galectin-4 was also prepared as described for rat Galectin-4 by Huflejt et al. (1997) J. Biol. Chem. 272, 14294-303. Galectin-4-AlexaFluor488 was made with AlexaFluor488 protein labeling Kit from Molecular Probes according to the manufacturer's instructions. Rabbit anti-CVN was obtained as described in Scanlan et al. (2002) J. Virol. 76, 7306-21. Monoclonal mouse anti-human-IgG-IgM-IgA-Biotin antibody and Streptavidin-FITC were from Pierce, Rockford, Ill. Rabbit anti-goat-IgG-FITC, goat anti-human-IgG-FITC, mouse anti-HisTag-IgG-Alexafluor-488 and anti-mouse-IgG-Alexafluor-488 were purchased from Vector Labs (Burlingame, Calif.). Rabbit anti-Influenza virus A/PR/8/34 was from the World Influenza Centre, Mill Hill, London, UK. Other reagents and consumables were from commercial sources with highest possible quality.

Pronase Digestion of Bovine Pancreatic Ribonuclease B. 540 mg of bovine pancreatic ribonuclease b (Sigma Lot 060K7650) was dissolved in 5 mls of 0.1M Tris+1 mM MgCl₂+1 mM CaCl₂ pH 8.0. 108 mg of pronase (Calbiochem Lot B 50874) was added to give a ratio by weight of five parts glycoprotein to one part pronase. This mixture was incubated at 60° C. for 3 hours. A second dose of 108 mg pronase was added and incubated at 37° C. for another 3 hours, after which it was boiled for 30 minutes, cooled and centrifuged. The sample was loaded onto 20 ml of freshly prepared ConA in 0.1M Tris, 1 mM MgCl₂, 1 mM CaCl₂, pH 8.0, washed and eluted with 200 ml 0.1M methyl-α-D-mannopyranoside (Calbiochem Lot B37526). The Con A eluted sample was purified on Carbograph solid-phase extraction column (Alltech 1000 mg, 15 ml) and eluted with 30% acetonitrile+0.06% TFA. The eluate was dried and reconstituted in lml water. Mass analysis was done by MALDI and glycan quantification by phenol sulfuric acid assay.

Carbohydrates obtained from bovine pancreatic ribonuclease B were separated by DIONEX chromatography. 20 ul of the pronase digested ribonuclease b was injected on the DIONEX using a PA-100 column and eluted with the following gradient (solution A=0.1M NaOH, solution B=0.5M NaOAc in 0.1M NaOH): 0% B for 3 min, then a linear gradient from 0% B to 6.7% B for 34 min. The individual peak fractions were collected and purified on Carbograph solid-phase columns (Alltech 150 mg, 4 ml) by elution with 80% acetonitrile containing 0.1% TFA. The peak fractions were then dried and reconstituted in water. Final Mass analysis and glycan quantification were performed.

Glycan array fabrication. Microarrays were printed by robotic pin deposition of ˜0.6 nL of various concentrations (10-100 μM) of amine-containing glycans in print buffer (300 mM phosphate, pH 8.5 containing 0.005% Tween-20) onto NHS-activated glass slides. Each compound was printed at two concentrations (100 μM and 10 μM) and each concentration in a replicate of six. Printed slides were allowed to react in an atmosphere of 80% humidity for 30 mins followed by desiccation over night. Remaining NHS-groups were blocked by immersion in buffer (50 mM ethanolamine in 50 mM borate buffer, pH 9.2) for 1 hr. Slides were rinsed with water, dried and stored in desiccators at room temperature prior to use.

Glycan Binding Protein binding assay. Printed slides were analyzed without any further modification of the surface. Slides were incubated in either a one step procedure with labeled proteins, or a sandwich procedure in which the slide was first incubated with a sample that might contain a glycan binding protein (GBP) and then was overlaid with labeled secondary antibodies or GBP's pre-complexed with labeled antibodies. GBP's were added at a concentration of 5-50 μg/mL in buffer (usually PBS containing 0.005-0.5% Tween-20). Secondary antibodies (10 μg/mL in PBS) were overlaid on bound GBP. GBP-antibody pre-complexes were prepared in a molar ratio of 1:0.5:0.25 (5-50 μg/mL) for GBP: 2° antibody: 3° antibody, respectively (15 mins on ice). The samples (50-100 μL) were applied either directly onto the surface of a single slide and covered with a microscope cover slip, or applied between two parallel slides separated by thin tape and pressed together by paper clips (see Ting et al. (2003) BioTechniques 35, 808-810) and then incubated in a humidified chamber for 30-60 minutes. Slides were subsequently washed by successive rinses in (i) PBS-Tween (0.05%), (ii) PBS and (iii) de-ionized water, then immediately subjected to imaging. Serum samples were typically used at dilutions of 1:25 and 0.4-0.8 mL applied directly onto the slide surface without any cover glass. Saliva samples were similarly handled. The slides were gently rocked at room temperature for 90 min followed by detection with secondary antibodies (Table 7). Whole virus was applied (0.8 mL) at a concentration of 100 μg/mL in buffer (PBS containing 0.05% Tween-20) containing the neuraminidase inhibitor oseltamivir carboxylate (10 μM). The slides were gently rocked at room temperature for 90 min followed by detection with secondary antibodies also in presence of the neuraminidase inhibitor (Table 7).

TABLE 7
Valencies of Glycan Binding Proteins

| | | | Secondary | Tertiary | |
|---|---|---|---|---|---|
| Category | GBP | Valency | Antibody | Antibody^{a} | Final |
| Plant | Con A-FITC | 4 | | | 4 |
| Lectin | ECA-FITC | 2 | | | 2 |
| Plant | | | | | |
| Lectin | | | | | |
| Human C | DC-SIGN-Fc^{b} | 2 | | | 2 |
| Type | | | | | |
| Human | CD22-Fc | 2 | α-hlgG-F^{a} | α-glgG-F^{a} | 8 |
| Siglec | | | | | |
| Human | Galectin-4- | 2 | | | 2 |
| Galectin | AF488 | | | | |
| Human | Anti-CD15- | 2 | | | 2 |
| IgG | FITC | | | | |
| Human | 2G12 | 2 | α-hlgG-F^{d} | | 4 |
| IgG | | | | | |
| Human | Serum^{c} | 2 | | | 2 |
| IgG/A/M | | | | | |
| Bacterial | Cyanovirin^{d} | 2 | | | 2 |
| GBP | | | | | |
| Viral GBP | Influenza HA | 3 | α-HA-HF^{a} | α-migG- | 12 |
| | (H3) | | | AF^{a} | |
| Intact | Influenza | 500 | A-PR8 | α-rlgG- | 500 |
| Virus | (PR8)^{e} | | | AF^{a} | |

^{a}Abbreviations used: Ab = antibody; F = FITC; AF = AF488.
^{b}After binding of DC-SIGN, binding was detected by overlay with anti-human IgG-AF488.
^{c}After binding of serum diluted 1:25 with PBS, binding was detected by overlay with goat anti-human IgG/M/A-Biotin (1:100) (Pierce) followed by Streptavidin-FITC (1:100).
^{d}After binding of CVN, binding was detected by overlay with polyclonal rabbit anti-CVN IgG-AF488 followed by anti-rabbit IgG-FITC.
^{e}After binding of virus, binding was detected by overlay with rabbit anti-PR8 followed by goat anti-rabbit IgG-AF-488.

Image acquisition and signal processing. Fluorescence intensities were detected using a ScanArray 5000 (Perkin Elmer, Boston, Mass.) confocal scanner and image analyses were carried out using ImaGene image analysis software (BioDiscovery Inc, El Segundo, Calif.). Signal to background was typically greater than 50:1 and no background subtractions were performed. Data were plotted using MS Excel software.

Results

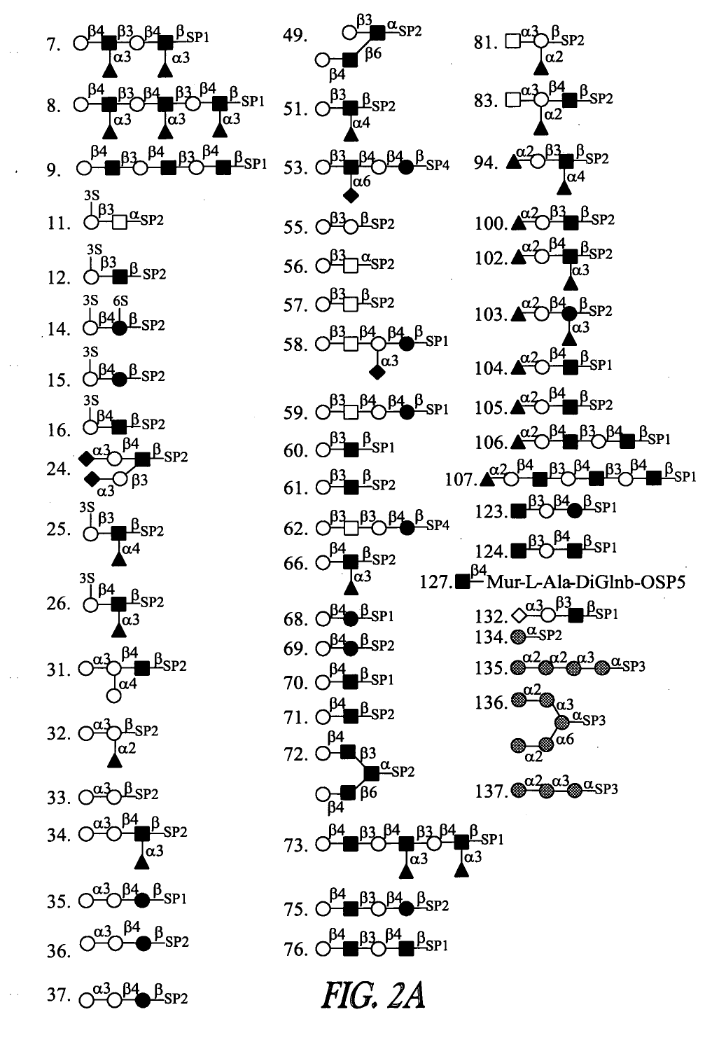

Glycan array design. The strategy adopted for covalently attaching a defined glycan library to micro-glass slides employed standard microarray printing technology as illustrated in FIG. 1. The use of an amino-reactive NHS-activated micro-glass surface allows covalent attachment of glycans containing a terminal amine by forming an amide bond under aqueous conditions at room temperature. The compound library of 200 glycoconjugates comprises diverse and biologically relevant structures representing terminal sequences of glycoprotein and glycolipid glycans. Glycan structures detected by glycan binding proteins are listed in FIG. 2 and a more complete glycan listing is provided in FIG. 7, Table 3 and Table 9. In addition, exemplary symbol structures summarizing the principal specificities of each glycan binding protein are depicted in each Figure.

Optimization of glycan printing. Length of time of the printing process was a concern because the moisture sensitive NHS-slides would be exposed to air during the procedure. Binding of fluorescein-labeled concanavalin A (con A) was used as a measure of ligand coupling. Maximal binding of con A to high mannose glycans, 134-138 (structures provided in FIG. 7 and Table 3), was obtained at concentrations >50 μM, with less than 10% variation in maximal binding observed with printing times up to 5 hours, as was observed for compound 136 (structure provided in FIG. 7). For the complete array, standard printing concentrations of 100 μM and 10 μM of each glycan were selected to represent saturating and sub-saturating levels, respectively, of the printed glycan. All samples were printed in replicates of six to generate an array of >2400 spotted ligands per glass slide, including controls.

General approach for profiling GBP specificity. In general, GBPs have low affinity for their ligands, and would not be expected to bind with sufficient avidity to withstand washing steps to remove unbound protein. For this reason, the approach routinely used was to create multivalency as necessary to mimic the multivalent interactions that occur in nature. Some of the glycan binding proteins evaluated in these experiments and the degree of multivalency used to achieve robust binding are summarized in Table 7. The valency required for binding ranged from 2 to 12. In several cases monovalent glycan binding proteins were evaluated as divalent recombinant Ig-Fc chimeras, and in other cases, higher valencies were achieved through the use of secondary antibodies. Binding was detected by including a fluorescent label either on the glycan binding protein or secondary antibody.

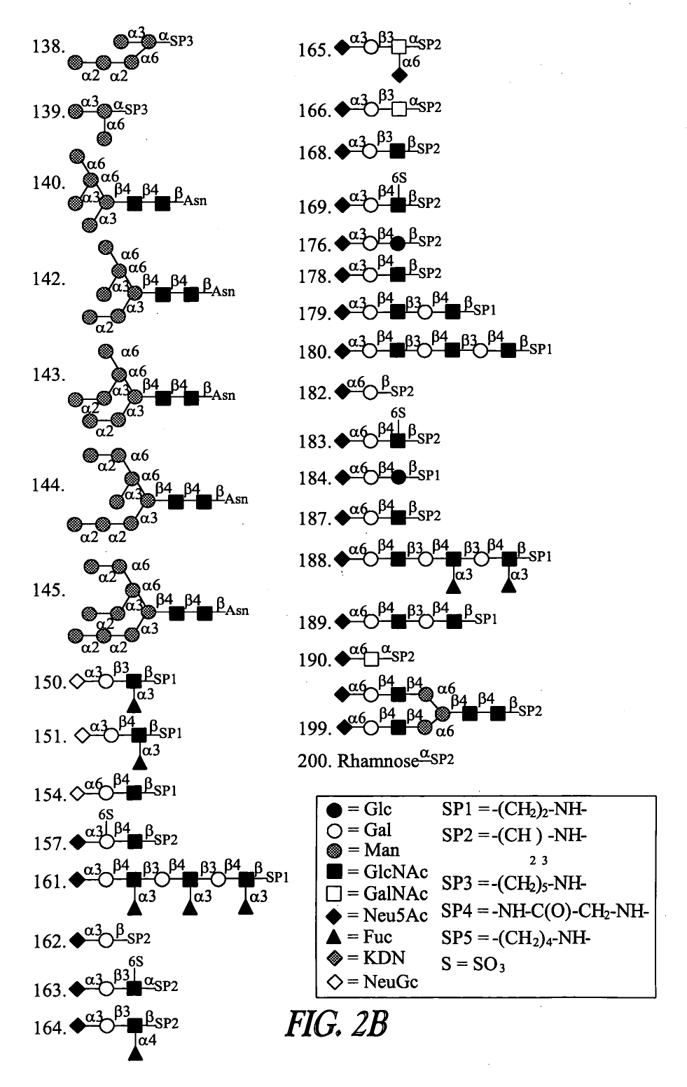

Specificity of plant lectins. As shown in FIG. 3, two lectins, Con A and Erythrina cristagalli lectin (ECA) exhibited binding to different subsets of glycans on the array, consistent with their reported specificities. Con A bound selectively to synthetic ligands consisting of one or more α-D-mannose (Manα1) residues as well as to isolated high-mannose N-glycans, and a bi-antennary N-linked glycan (134-145, 199, see FIG. 7). ECA bound exclusively to various terminal N-acetyllactosamine (LacNAc) structures, poly-LacNAc (9, 73, 76, see FIG. 7) and branched O-glycans (49, 72, see FIG. 7). ECA also tolerated terminal Fucα1-2Gal substitution (105-107, see FIG. 7). These specificities are consistent with those previously observed using other methodologies. See, e.g., Gupta et al. (1996) Eur. J. Biochem. 242, 320-326; Brewer et al. (1985) Biochem. Biophys. Res. Commun. 127, 1066-71; Lis et al. (1987) Meth. Enzymol. 138, 544-551; Iglesias et al. (1982) Eur. J. Biochem. 123, 247-252.

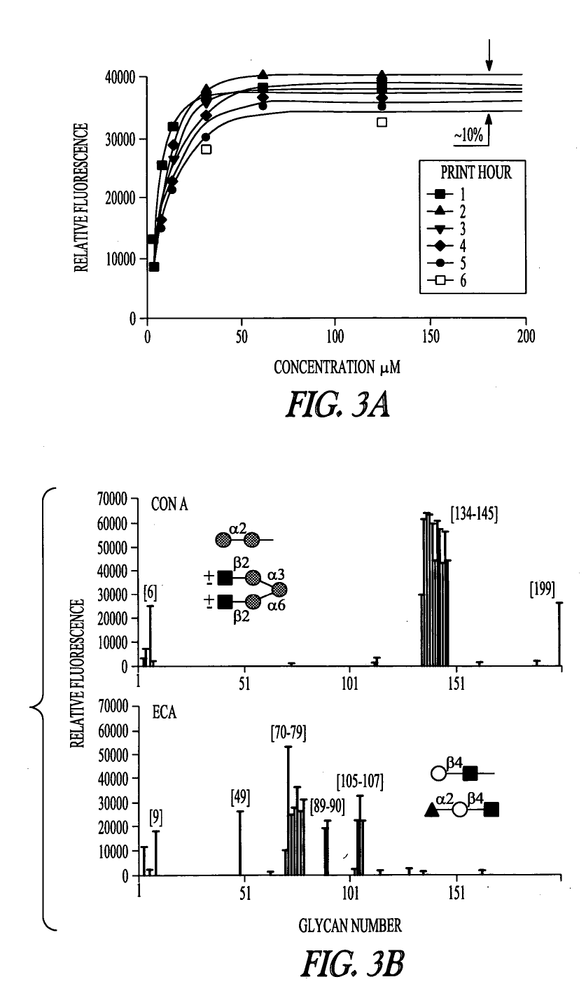

Analysis of specificities of human GBPs. Three major families of mammalian glycan binding proteins (GBPs) are involved in cell surface biology through recognition of glycan ligands—C-type lectins, siglecs and galectins. One exemplary member from each class was selected for analysis (FIG. 4).

DC-SIGN, a member of the group 2 subfamily of the C-type lectin family, is a dendritic cell protein implicated in innate immunity and the pathogenicity of human immunodeficiency virus-1 (HIV-1) (Kooyk, Y. & Geijtenbeek, T. B. (2002) Immunol. Rev. 186, 47-56). As shown in FIG. 4, a recombinant DC-SIGN-Fc recognized two classes of glycans, various fucosylated oligosaccharides with the Fucα1-3 GlcNAc and Fucα1-4GlcNAc oligosaccharides found as terminal sequences on N-and O-linked oligosaccharides (7, 8, 51, 66, 94, 102, see FIG. 7), and mannose containing oligosaccharides terminated with Manα1-2-residues (135-138, 144, 145, see FIG. 7), consistent with specificities found by other groups, for example, as described in Guo et al. (2004) Nat. Struct. Mol Biol. 11, 591-8; van Die et al. (2003) Glycobiology 13, 471-478; and Adams et al. (2004) Chem.l Biol. 11, 875-81.

CD22, a member of the immunoglobulin superfamily lectins (Siglecs), is a well-known negative regulator of B cell signaling and binds selectively to glycans with Siaα2-6Gal-sequences. Blixt et al. (2003) J. Biol. Chem. 278, 31007-19; Engel et al. (1993) J. Immunol. 150, 4719-4732; Kelm et al. (1994) Curr. Biol. 4, 965-72; Powell et al. (1993) J. Biol. Chem. 268, 7019-7027. As shown in FIG. 4B, CD22 bound exclusively to the seven structures containing the terminal Siaα2-6Galβ1-4GlcNAc-sequence including a bi-antennary N-linked glycan (154, 187-189 and 199, see FIG. 7). An additional 6-O-GlcNAc-sulfation (Neu5Acα2-6Galβ1-4[6Su]GlcNAc-183, see FIG. 7) appeared to enhance binding relative to the corresponding non-sulfated glycan, suggesting that this glycan could be a preferred ligand for human CD22.

Galectins are a family of β-galactoside binding lectins that bind terminal and internal galactose residues. See, Hirabayashi et al. (2002) Biochim. Biophys. Acta 1572, 232-54. Galectin-4 has been identified as a possible intracellular mediator with anti-apoptotic activity. Huflejt et al. (1997) J. Biol. Chem. 272, 14294-303; Huflejt, M. E. & Leffler, H. (2004) Glycoconjugate J. 20, 247-55. By comparing Galectin-4 binding to saturated glycans (printed at 100 μM concentration) with binding to sub-saturated glycans (printed at 10 μM concentration), preferred binding specificities were revealed. In particular, as shown in FIG. 4C, Galα1-3-linked to lactose (35-37), Fucα1-2-linked to lac(NAc) (100, 103, 105-107), or GlcNAcβ1-3-linked to lactose (123), as well as 3′-sulfation (11-16) substantially enhanced the affinity. This specificity profile is similar to that reported for a rat ortholog of Galectin-4. See Wu et al. (2004) Biochimie 86, 317-26; Oda et al. (1993) J. of Biol. Chem. 268, 5929-5939.

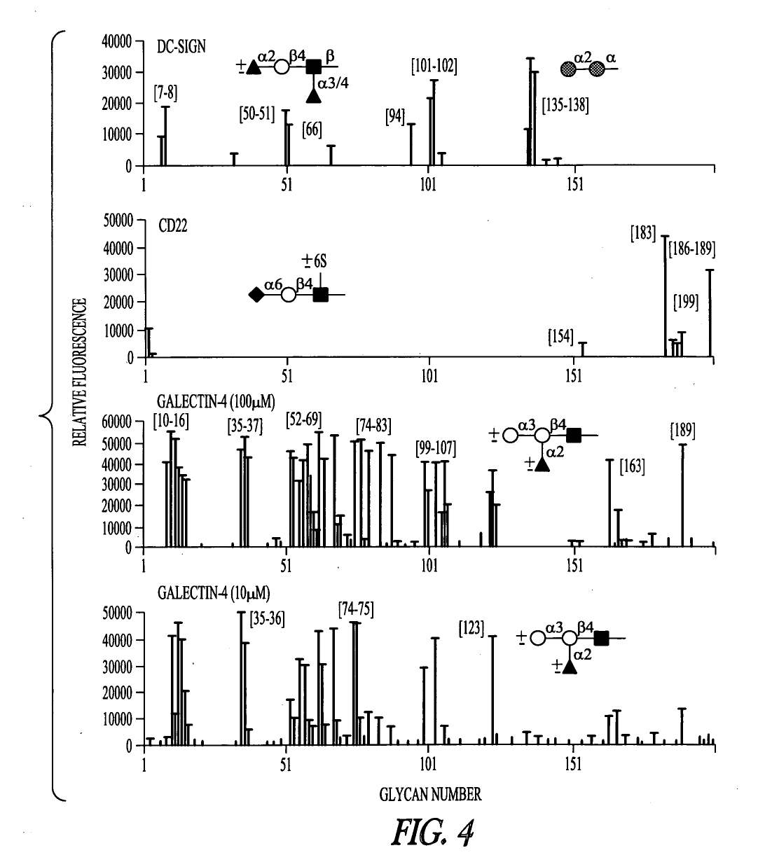

Glycan specific antibodies. Monoclonal and polyclonal anti-glycan antibodies from three different sources were also analyzed (FIG. 5). The commercial leukocyte differentiation antigen CD-15 has been documented to recognize a carbohydrate antigen, Lewis^{x} (Galβ1-4[Fucα1-3]GlcNAc). When evaluated on the array described herein this antibody was highly specific for Lewis^{x} structures (7, 8, 66, see FIG. 7), and did not recognize the same structure modified by additional sialylation (161), sulfation (26), fucosylation (102) or LacNAc extension (73)(see FIG. 7 for structures). FIG. 5A shows the specificity of an anti-CD15 antibody preparation for Lewis^{X} glycans.

One of the most studied human anti-HIV monoclonal antibodies is 2G12, which neutralizes a broad spectrum of natural HIV isolates via recognition of high mannose type N-linked glycans on the major envelope glycoprotein, gp120. Lee et al. (2004) Angew. Chem. Int. Ed. 43, 1000-1003; Calarese et al.(2003) Science 300, 2065-71; Scanlan et al., (2002) J. Virol. 76, 7306-21; Sanders (2002) J. Virol. 76, 7293-305; Trkola et al. (1996) J. Virol. 70, 1100-8. The glycan array contains a variety of synthetic mannose fragments with the natural series of high mannose N-glycans (Man5-Man9) isolated from ribonuclease B.

As shown in FIG. 5B, recombinant 2G12 exhibited strong binding of synthetic Manα1-2-terminal mannose oligosaccharides (135, 136, 138). See also Bryan et al. (2004) J. Am. Chem. Soc. 126, 8640-41; Lee et al. (2004) Angew. Chem. Int. Ed. 43, 1000-1003; Adams et al. (2004) Chem.l Biol. 11, 875-81. In addition, of the series of natural high mannose type N-glycans, 2G12 exhibited preferred binding to Man8 glycans (144) relative to Man5, Man6, Man7 or Man9 glycans (140, 142, 143, 145) (see FIG. 7 for these structures).

In particular, the glycans to which the 2G12 antibodies bound had any the following Man-8 N-glycan structures, or were a combination thereof:

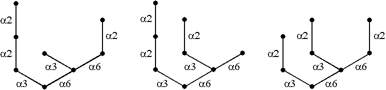

wherein each filled circle (•) represents a mannose residue.

A smaller level of binding was observed between the 2G12 antibodies and Man-9-N-glycans. As shown in Table 8, simpler synthetic glycans bind 2G12 as well as the Man8 glycans. However, the simpler compounds are more likely to elicit an immune response that will generate antibodies to the immunogen, but not the high mannose glycans of the gp120. The natural structure is also less likely to produce an unwanted immune response. Indeed, yeast mannan is a polymer of mannose and is a potent immunogen in humans, representing a major barrier to production of recombinant therapeutic glycoproteins in yeast.

TABLE 8
Summary of the binding of 2G12 to mannose containing glycans in the
glycan array shown in FIG. 7. Samples 1-6 are glycoproteins, samples
134-139 are synthetic high mannose glycans, samples 140-145 are
natural high mannose glycopeptides isolated from bovine ribonuclease,
and sample 199 is a bi-antennary complex type glycan terminated in
sialic acid.

| No. | Mannose containing ligands | Rel. spec. |
|---|---|---|
| 1 | Alpha1-acid glycoprotein | − |
| 2 | Alpha1-acid glycoprotein A | − |
| 3 | Alpha1-acid glycoprotein B | − |
| 4 | Ceruloplasmin | − |
| 5 | Transferrin | − |
| 6 | Fibrinogen | − |
| 134 | Ma#sp3 | − |
| 135 | Ma2Ma2Ma3Ma#sp3 | +++ |
| 136 | Ma2Ma3[Ma2Ma6]Ma#sp3 | +++ |
| 137 | Ma2Ma3Ma#sp3 | − |
| 138 | Ma3[Ma2Ma2Ma6]Ma#sp3 | +++ |
| 139 | Ma3[Ma6]Ma#sp3 | − |
| 140 | Man-5#aa | − |
| 142 | Man-6#aa | − |
| 143 | Man-7#aa | − |
| 144 | Man-8#aa | +++ |
| 145 | Man-9#aa | + |
| 199 | OS-11 | − |

Relative binding activity:
− = <1000;
+ = 1000-6000;
++ 6000-25,000; and
+++ >25,000.

These results indicate that glycans with eight mannose residues are superior antigens for binding the 2G12 anti-HIV neutralizing antibodies.

To test the array against more complex samples, anti-glycan antibodies present in human serum and saliva were investigated. Following incubation with serum or saliva, bound IgG, IgA and IgM were detected on the glycan array using labeled anti-human IgG/A/M antibody.

A surprising diversity of antibody specificities was observed in both serum and saliva. The binding results observed for serum samples from ten individuals are shown in FIG. 5C. This profile of human anti-glycan antibodies detects the ABO blood group fragments (variously represented in different individuals) (32, 81, 83), mannose fragments (135-139), α-Gal-(31-37) and ganglioside-epitopes (55-59, 132, 168), as well as fragments of the gram negative bacterial cell wall peptidoglycan (127) and rhamnose (200)(see FIG. 7 for these structures). Notably, glycans containing the Galβ1-3GlcNAc sub-structure were consistently detected (12, 61, 62, 132, 150, 168) except when fucosylated (25, 51, 94, 100) thus generating the human blood group antigens H, Lewis^{a} or Lewis^{b} (see FIG. 7 for structures). All of these structures can be identified as either blood group antigens or fragments of microorganisms (e.g. bacteria, yeast etc.) to which humans are exposed.

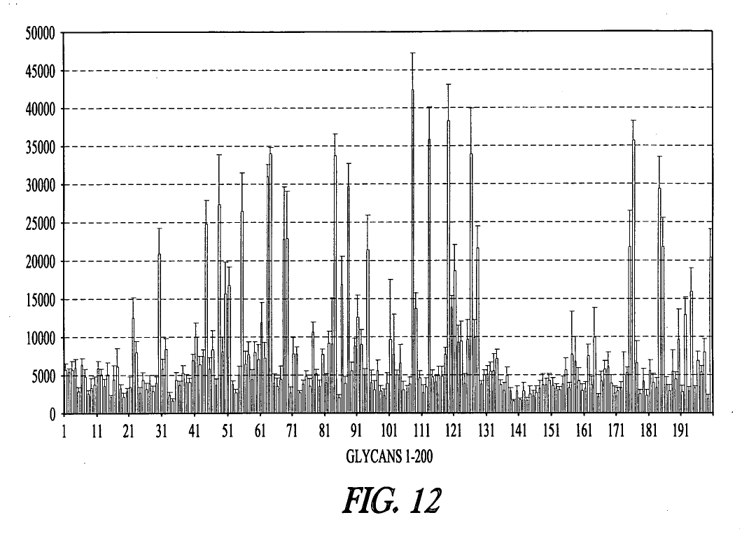

A variety of glycan binding proteins are also detected in saliva, as shown in FIG. 12.

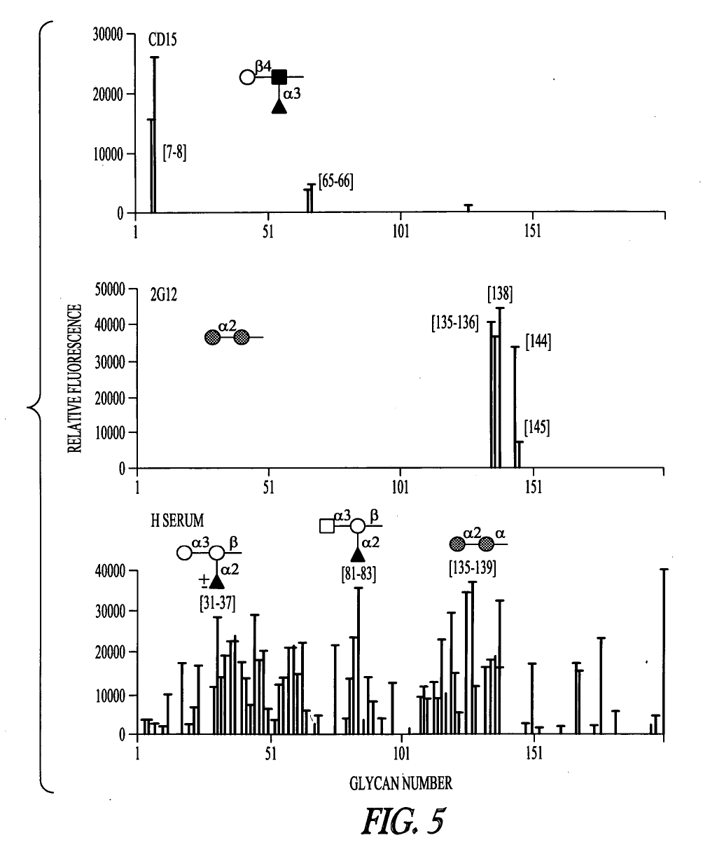

Analysis of bacterial and viral GBPs. Cyanovirin-N (CVN) is a cyanobacterial protein that can block the initial step of HIV-1 infection by binding to high mannose groups on the envelope glycoprotein gp120. Adams et al. (2004) Chem. Biol. 11, 875-81; Bewely, C. A. & Otero-Quintero, S. (2001) J. Am. Chem. Soc. 123, 3892-3902. On the array, CVN specifically recognized the synthetic fragments bearing terminal Manα1-2-residues (135-138), as well as high mannose glycans with one or more Manα1-2-termini (140-145), in keeping with its reported specificity (FIG. 6 and 7). In addition, CVN bound to several lacto- and neolacto-structures (53, 62, 75, 176, see FIG. 6 and 7).

Influenza viruses exhibit specificity in their ability to recognize sialosides as cell surface receptor determinants through the viral binding protein, the hemagglutinin. Depending on the species of origin, the hemagglutinin has specificity for sialosides with sialic acid in the NeuAcα2-3Gal or NeuAcα2-6Gal linkage. Connor et al. (1994) Virol. 205, 17-23; Rogers, G. N. & D'Souza, B. L. (1989) Virol. 173, 317-22; Rogers et al. (1983) Nature 304, 76-8. While the intrinsic affinity of sialosides for the hemagglutinin is weak (Kd≈2 mM), binding is strengthened through polyvalent interactions at the cell surface. Sauter et al. (1989) Biochem. 28, 8388-96.

Results shown in FIG. 6B reveal the binding of a recombinant avian H3 hemagglutinin (Duck/Ukraine/1/63) bound to Neu5Acα2-3-linked to galactosides (24, 162-169, 176-180, see FIG. 7), but not to any Neu5Acα2-6- or Neu5Acα2-8-linked sialosides. Intact influenza viruses, such as A/Puerto Rico/8/34 (H1N1), were also strongly bound to the array (FIG. 6C). The overall affinities are consistent with previous findings and show specificity for both α2-3 and α2-6 sialosides. Rogers, G. N. & Paulson, J. C. (1983) Virol. 127, 361-73.

Detailed fine specificities were also revealed such as binding to Neu5Acα2-3- and Neu5Acα2-6-linked to galactosides (24, 151, 157, 161-180, 182-190, 199, see FIG. 7), as well as certain O-linked sialosides.

Thus, the glycan microarrays described herein can be used to detect a variety of glycan binding entities. The microarrays can be made by robotic printing, and binding to the microarrays can be detected by scanning and image analysis software used for DNA microarrays. The combination of using amine-functionalized glycans with the NHS-activated glass surface results in robust and reproducible covalent attachment of glycans with no modifications of standard DNA printing protocols. The array can be used with no further preparation of the surface for assessing the specificity of a wide variety of glycan binding proteins, yielding uniformly low backgrounds regardless of the labeled protein used for detection. Moreover, only 0.1-2 μg of glycan binding protein is needed for optimal signal, over 100-fold less than required for an ELISA based array that uses predominately the same glycan library. Fazio et al. (2002) J. Am. Chem. Soc. 124, 14397-14402. The arrays performed well for a wide variety of glycan binding proteins, confirming primary specificities documented by other means, and revealing novel aspects of fine specificity that had not previously been recognized.

### EXAMPLE 6

### Diagnosis of Neoplasia using Glycan Arrays

This Example illustrates that antibodies present in breast cancer patients can be detected using the glycan arrays of the invention. Only a small sample volume of human serum was needed for detecting antibodies that bound to specific types of glycans. Thus, the invention provides non-invasive screening procedures for detecting breast neoplasia.

Materials and Methods:

Individual (not pooled) sera were collected from 9 patients who were diagnosed with metastatic breast cancer (MBC). Blood samples were collected before treatment, so that therapeutic intervention would not interfere with patient immune responses. One patient with breast cancer but with good prognosis (IDC, Stage 1) was also included in the study. As control, or “healthy” sera, sera from ten healthy individuals, 5 female and 5 male, with no known malignancies was collected.

Sera were diluted 1:25 with PBS containing 3% BSA, and placed on the glycan array slide in humidified chamber at room temperature for 90 min. The glycan array slide was then rinsed gently with PBS/0.05% Tween, incubated with biotinylated goat antibody against human IgG, IgM and IgA, rinsed in PBS/0.05% Tween, and incubated with streptavidin-Alexa488 fluorescent dye. Following rinses in PBS/0.05% Tween and H₂O, glycan array slides were dried and scanned using the commercial DNA array scanner. The images were analyzed and intensity of fluorescence in spots corresponding to the antibodies bound to the individual glycans was quantified using a ScanArray 5000 (Perkin Elmer, Boston, Mass.) confocal scanner and image analyses were carried out using ImaGene image analysis software (BioDiscovery Inc, El Segundo, Calif.). Signal to background was typically greater 50:1 and no background subtractions were performed. Data were plotted using MS Excel software.

Results

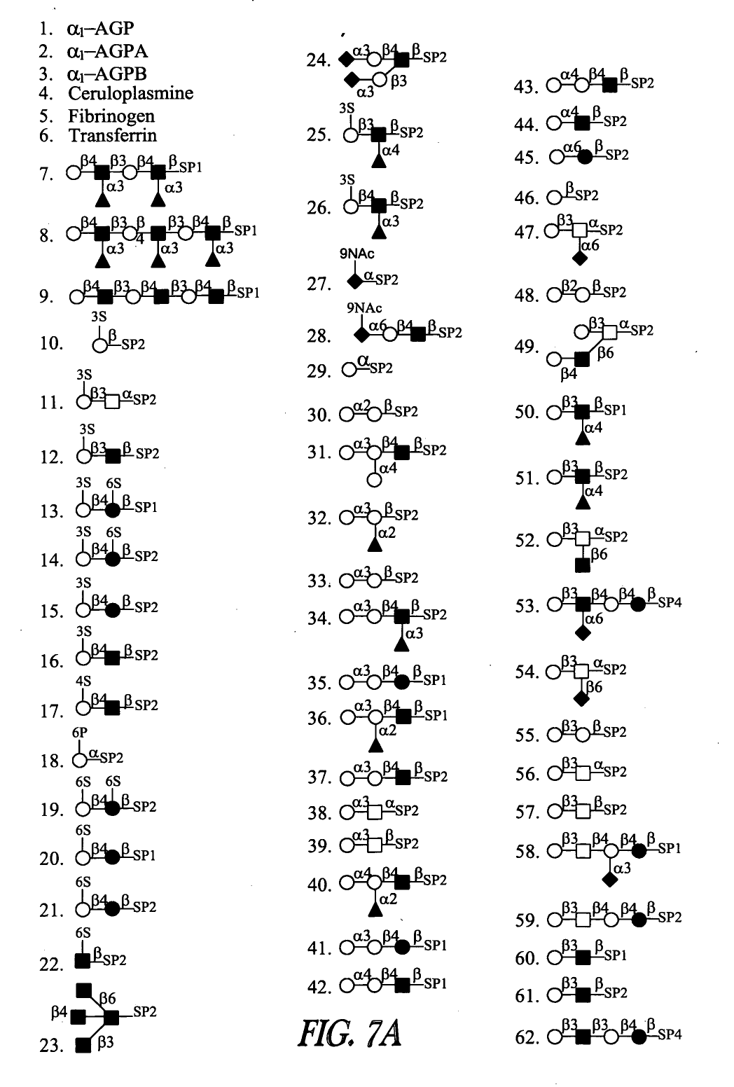

The results of these experiments are provided in FIGS. 8-10. A profile of the relative fluorescence intensity of labeled antibodies bound to specific glycans on the array is provided in FIG. 8. As illustrated in FIG. 8, there are significant differences between the reactivity of sera from controls and from patients with metastatic breast cancer. In particular, the levels of certain anti-carbohydrate antibodies are much higher in patients with metastatic breast cancer. Glycans to which sera from metastatic cancer patients bind include ceruloplasmin, Neu5Gc(2-6)GalNAc, GM1, Sulfo-T, Globo-H, and LNT-2.

GM1 has the following structure: Gal-beta3-GalNAc-beta4-[Neu5Ac-alpha3]-Gal-beta4-Glc-beta.

The sulfo-T antigens are T-antigens with sulfate residues. In general, T antigens have the structure Galβ3GalNAc and can have various modifications. LNT-2 is a ligand for tumor-promoting Galectin-4. See Huflejt & Leffler (2004) Glycoconjugate J., 20: 247-255). The structure of LNT-2 includes the following glycan: GlcNAc-beta3-Gal-beta4-Glc-beta.

Globo-H has the following structure: Fucose-alpha2-Gal-beta3-GalNAc-beta3-Gal-alpha4-Gal-beta4-Glc.

The antibodies that bind to these glycans therefore react with a series of glycan types. The clusters of glycans reactive with these antibodies define the neoplasia status more precisely then would detection of an individual antibody alone. Moreover, the levels of the antibodies reactive with individual glycan clusters can be quantified and converted into score values used for mathematical and statistical serum sample analysis that would allow diagnostic assignment of the neoplasia risk for the individual patient, when compared with the value range characteristic of the individuals with no known neoplasia.

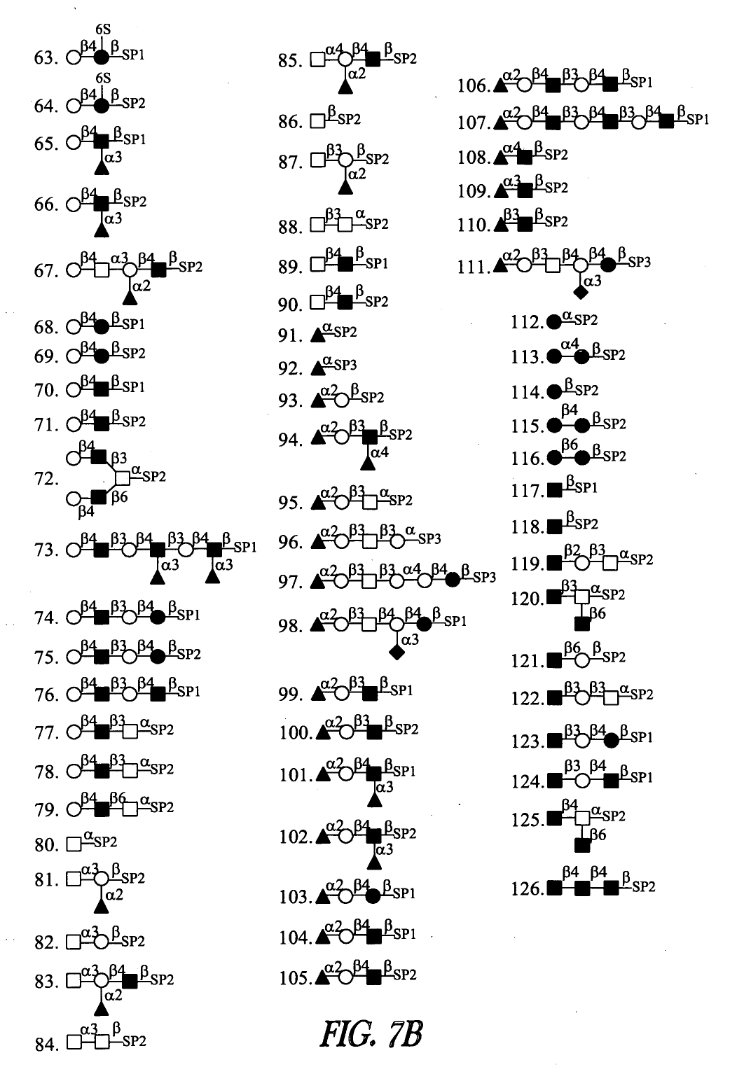

Specifically, antibodies against ceruloplasmin (FIG. 8, compound no. 2) and against cancer specific carbohydrate antigen Neu5Acα2-6GalNAcα-(STn-, FIG. 8, compound no. 3 and 4) appear at significantly higher levels in all MBC patients as compared to “healthy” individuals. There are also antibodies against other specific glycans that are present in metastatic breast cancer patients at the levels higher than in the healthy individuals. These specific glycan categories include: a group of T-antigens carrying various modifications (see FIG. 9, compounds no. 5, 8-13), LNT-2 (a known ligand for tumor-promoting Galectin-4, Huflejt and Leffler, 2004), Globo-H—, and GM1-antigens.

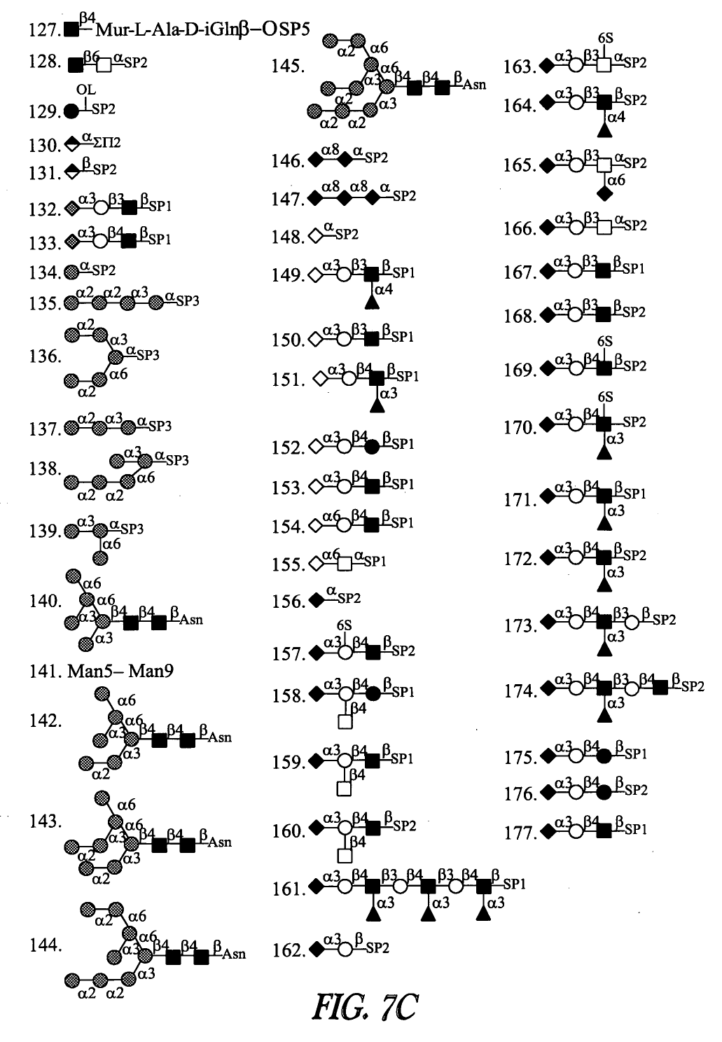

As shown in FIG. 10, combining the relative fluorescence intensities corresponding to the levels of serum antibodies listed in FIG. 9 for each patient allows generation of the antibody signal range that provides a clear distinction between cancer and non-cancer population. There fore, this test can provide an additional tool for appropriate correlation between specific glycoprotein profiles and various stages of disease to allow for identification of appropriate therapeutic targets.

These findings suggest that more than one glycan is present as a naturally occurring epitope during malignant transformation in breast cancer patients and these epitopes elicit immune response in each of the so far examined (breast) cancer patients. Moreover, these results indicate that clusters of different antibodies reactive against tumor-associated glycans can be detected simultaneously in the individual patient sera. Such detection of several antibody types provides much better diagnostic information than information about the presence of a single type of antibody reactive with a single type of glycan.

These combined tumor-associated glycans will be the preferred immunogen for a vaccine composition to elicit an immune response that results in production of antibodies neutralizing antibodies activities of tumor-promoting glycans. Such compositions will likely include multivalent glycans to mimic the clustered N-linked glycan epitopes on cellular surfaces of cancer, stromal, and endothelial cells.

### EXAMPLE 7

### Antibodies Against Alpha-Gal-3 Glycan Epitopes Were Detected in Sera of Patients Receiving Xenotransplants

This Example illustrates that several here-to-fore unidentified glycan structures contribute to acute organ rejection after transplantation of pig tissues into humans.

As is generally known by one of skill in the art, humans exhibit an immune response to alpha-Gal-3 glycan epitopes because these glycans are abundant on pig cell surfaces. Hence, an immune response against these alpha-Gal-3 epitopes has been a major problem that must be overcome to permit xenotransplantation of tissues. However, as illustrated in this Example other glycan structures contribute to acute organ rejection. These transplant-associated glycan structures are identified and described in this Example.

Materials and Methods

In 1991-1994, several diabetic (I) patients received transplantation of porcine fetal pancreas islet-like cell clusters (ICC). See, Groth, C. G. et al. Transplantation of porcine fetal pancreas to diabetic patients, The Lancet 344: 1402-4 (1994). The inventor analyzed serum from three of these patients before transplant (t=0), 1 months after (t=1), 6 months after (t=2) and 12 months after (t=3) transplant.

Sera were diluted as needed with PBS containing 3% BSA, and placed on the glycan array slide in humidified chamber at room temperature for 90 min. The glycan array slide was then rinsed gently with PBS/0.05% Tween, incubated with biotinylated goat antibody against human IgG, IgM and IgA, rinsed in PBS/0.05% Tween, and incubated with streptavidin-Alexa488 fluorescent dye. Following rinses in PBS/0.05% Tween and H₂O, glycan array slides were dried and scanned using the commercial DNA array scanner. The images were analyzed and intensity of fluorescence in spots corresponding to the antibodies bound to the individual glycans was quantified using a ScanArray 5000 (Perkin Elmer, Boston, Mass.) confocal scanner and image analyses were carried out using ImaGene image analysis software (BioDiscovery Inc, El Segundo, Calif.). Signal to background was typically greater 50:1 and no background subtractions were performed. Data were plotted using MS Excel software.

Results

FIG. 11 provides representative results from one patient. Similar results were seen for all patients analyzed. Glycans 33-39 (structures shown in FIG. 7) are identified as glycans 1-7 in FIG. 11D. While glycans 33-39 do not have identical structures, each of them terminate with alpha-Gal. Compared with the reactivity of serum taken at t=0 (lighter, blue bars), serum taken at 1 month after (t=1), 6 months after (t=2) and 12 months after (t=3) transplantation have significantly greater amounts of anti-glycan antibodies. Compound 8 is LeX (Gal-beta4-GlcNAc[alpha3-Fucose]-beta, structure 65 in FIG. 7) and humans do not have antibodies to this glycan structure because it is on human cells. The last structure 9, is alpha-Gal-LeX (Gal-alpha3-Gal-beta4-GlcNAc[alpha3-Fucose]-beta (structure 34 in FIG. 7), also shown in FIG. 11C), is not found in humans, but has been reported to be present on porcine kidney cells. See Bouhors D. et al., Gala1-3-LeX expressed on iso-neolacto ceramides in porcine kidney GLYCOCONJ. J. (10) 1001-16 (1998). However, patients who received transplantation of porcine fetal pancreas islet-like cell clusters clearly exhibit an immune response (antibody production) against structure 9 (alpha-Gal-LeX).

Thus, as shown in FIG. 11, the glycan arrays and methods of the invention for testing whether antibodies were present in serum of transplant recipients, illustrate that distinct differences exist in antibody responses before and after receiving tissue transplantation. The arrays and methods of the invention are therefore useful for monitoring and evaluating graft rejection after transplantation and/or xenotransplantation.

Further examples of glycans that can be used in the compositions, libraries, arrays and methods of the invention are provided in Table 9. Note that a spacer or linker can be attached to the glycan either as an alpha or beta linkage. In some cases, the spacer or linker is attached to the reducing end of the glycan.

TABLE 9
IUPAC

| | |
|---|---|
| Xylb | Fuca |
| Rhaa | Galb |
| Glcb | Mana |
| Alt | Manb |
| Gala | Glca |
| GlcAa | GlcNAcb |
| GlcNAca | GalNAca |
| GalNAcb | Man[6P]a |
| Man[6P]b | Gal[3S]b |
| GlcNAca[1P] | GalNAc[3S]b |
| GalNAc[6S]a | GlcNAc[6S]b |
| NeuAca | NeuAcb |
| Xylb1-2Manb | Galb1-4Xylb |
| Xyla1-3Glcb | NeuGca |
| NeuGcb | Glcb1-3Fuca |
| Fuca1-2Galb | Glcb1-3Fuca |
| Fuca1-2Galb | Gala1-4Galb |
| Gala1-6Glcb | Mana1-2Mana |
| Mana1-2Man | Glca1-6Mana |
| Mana1-6Mana | Galb1-4Glcb |
| Glcb1-4Glcb | Glcb1-6Glcb |
| Mana1-3Man | Galb1-6Glcb |
| Galb1-4Glcb | Galb1-3Glcb |
| Glca1-4Glcb | Galb1-3Gal |
| Mana1-6Mana | Galb1-4Galb |
| Galb1-4Gala | Gala1-4Galb |
| Galb1-4Glcb | Galb1-4Glcb |
| Galb1-3Galb | Galb1-2Galb |
| Gala1-3Galb | Gala1-2Galb |
| Mana1-2Mana | Mana1-6Mana |
| Mana1-2Man | Galb1-4Gala |
| Glcb1-2Galb | Galb1-4Glcb |
| Mana1-2Mana | Glca1-6Mana |
| Galb1-4Glcb | Glca1-4Glcb |
| Gala1-2Man | Mana1-6Man |
| Glca1-4Glcb | Glca1-4Glcb |
| Glca1-2Gal | Mana1-2Mana |
| Galb1-4Glcb | Fuca1-6GlcNAcb |
| Fuca1-4GlcNAcb | Fuca1-3GlcNAcb |
| Fucb1-6GalNAc | GalNAca1-3Fuc |
| Fuca1-6GlcNAc | GlcNAcb1-2Man |
| Galb1-3GalNAc | GlcNAcb1-2Man |
| Galb1-3GalNAca | GalNAcb1-4Glcb |
| Gala1-3GalNAc | Galb1-4GlcNAca |
| Galb1-4GlcNAc | Galb1-3GalNAca |
| Galb1-3GalNAca | Galb1-3GlcNAc |
| Galb1-4GlcNAc | Galb1-4GlcNAcb |
| Galb1-3GlcNAcb | Galb1-3GalNAca |
| GalNAca1-3Galb | Galb1-3GalNAca |
| Galb1-6GalNAc | Gala1-4GlcNAc |
| Galb1-4GlcNAcb | Galb1-3GalNAc |
| Galb1-4GlcNAca | Galb1-4GlcNAcb |
| Gala1-3GalNAca | Gala1-3GalNAca |
| GlcNAcb1-4Man | Galb1-3GalNAca |
| Galb1-3GalNAcb | Galb1-3GalNAcb |
| Galb1-3GlcNAcb | Gala1-3GalNAcb |
| GlcNAcb1-6Mana1-6 | Manb1-4GlcNAc |
| Galb1-3GalNAca | Galb1-3GlcNAcb |
| Galb1-4GlcNAcb | Galb1-4GlcNAcb |
| Galb1-3GlcNAca | Galb1-4GlcNAca |
| Galb1-3GalNAcb | Galb1-3GalNAcb |
| Galb1-3GlcNAcb | Galb1-4Xyl[2P]b |
| Man[6P]a1-2Man | Gal[6S]b1-4Glcb |
| Gal[2S]b1-4Glcb | Gal[2S]b1-4Glcb |
| Gal[3S]b1-4Glcb | Galb1-4Glc[6S]b |
| Gal[6S]b1-4Glc | Gal[6S]b1-4Glcb |
| Gal[3S]b1-4Glcb | GlcNAcb1-3GalNAc |
| GalNAca1-3GalNAc | GlcNAcb1-4GlcNAc |
| GalNAca1-6GalNAc | GlcNAcb1-6GalNAc |
| GlcNAcb1-4GlcNAcb | GalNAcb1-4GlcNAcb |
| GalNAcb1-4GalNAca | GalNAca1-3GalNAca |
| GlcNAcb1-4GlcNAcb | GalNAcb1-4GlcNAcb |
| GlcNAcb1-6GalNAca | GalNAcb1-4GlcNAcb |
| GalNAcb1-4GlcNAc | GalNAcb1-3GalNAc |
| GalNAcb1-4GlcNAc | GlcNAcb1-4GlcNAcb |
| Xyla1-3Xyla1-3Glcb | Xyla1-3Xyla1-3Glcb |
| Xyla1-3Xyla1-3Glca | Gal[3S]b1-3GalNAcb |
| Galb1-4GlcNAc[6S]b | GlcNAc[6S]b1-3Gal |
| Gal[3S]b1-3GalNAca | Gal[6S]b1-3GalNAc |
| Galb1-4GlcNAc[6S] | Gal[3S]b1-4GlcNAc |
| NeuAca2-3Galb | NeuAca2-6Glcb |
| NeuAca2-6Galb | Kdna1-6GaNAca |
| NeuAca2-3Gal | NeuAca2-6Gal |
| NeuAca2-3Gal | NeuAca2-6Galb |
| NeuAca2-6Gal | NeuAca2-6Galb |
| NeuAca2-3Gala | Mana1-3(Xylb1-2)Manb |
| Galb1-3Galb1-4Xylb | Mana1-6(Xylb1-2)Manb |
| GlcAb1-4GlcNAc[6S] | NeuGca2-6Gal |
| NeuGca2-3Galb | NeuGca2-3Gal |
| Gala1-3(Fuca1-2)Galb | Rhaa1-3Mana1-2Man |
| Galb1-4(Fuca1-3)Glc | Fuca1-2Galb1-4Glc |
| Gala1-3(Fuca1-2)Galb | Fuca1-2Galb1-4Glcb |
| Gala1-3(Fuca1-2)Galb | Fuca1-2Galb1-4Glcb |
| Gala1-3(Fuca1-2)Galb | Gal[3S]b1-4Glc[6S]b |
| GalNAc[4S]b1-4GlcNAc | Glca1-6Glcb1-6Glcb |
| Glca1-6Glcb1-6Glca | Mana1-2(Mana1-6)Mana |
| Gala1-4Galb1-4Glc | Gala1-4Galb1-4Glcb |
| Galb1-6Galb1-6Glcb | Glca1-4Glca1-4Glcb |
| Glcb1-6Glcb1-6Glc | Gala1-2Mana1-2Man |
| Mana1-2(Mana1-4)Mana | Manb1-2Manb1-2Man |
| Glca1-3(Mana1-2)Man | Mana1-3(Mana1-6)Mana |
| Mana1-3(Mana1-6)Mana | Mana1-2(Mana1-6)Mana |
| Mana1-2Mana1-2Mana | Gala1-4Galb1-4Glcb |
| Glca1-6Glcb1-6Glcb | Gala1-3Galb1-4Glcb |
| Gala1-3(Mana1-2)Man | Glcb1-6(Glca1-6)Glca |
| Gala1-6Gala1-6Glcb | Mana1-6Mana1-6Man |
| Manb1-4Manb1-4Man | Mana1-2Mana1-2Mana |
| Mana1-3(Mana1-6)Mana | Gala1-4Galb1-4Glcb |
| Gala1-3Galb1-4Glcb | Mana1-3(Mana1-6)Man |
| Mana1-2Mana1-2Man | NeuAca2-6GalNAc |
| NeuAca2-6GlcNAcb | NeuAca2-3GalNAca |
| Fuca1-3(Fuca1-6)GlcNAcb | Ara'b1-3GlcNAcb1-2Man |
| NeuGca2-6GalNAca | NeuGca2-6GalNAc |
| Fuca1-2Galb1-3GalNAc | Fuca1-2Galb1-3GlcNAc |
| Fuca1-2Galb1-4GlcNAc | Galb1-4(Fuca1-3)GlcNAcb |
| Galb1-4(Fuca1-3)GlcNAc | GalNAca1-3(Fuca1-2)Galb |
| Galb1-4(Fuca1-6)GlcNAcb | Fuca1-2Galb1-4GlcNAcb |
| Fuca1-3GlcNAcb1-2Man | Galb1-3(Fuca1-4)GlcNAc |
| Galb1-3(Fuca1-4)GlcNAcb | GalNAca1-3(Fuca1-2)Gal |
| GalNAca1-3(Fuca1-2)Galb | Galb1-4(Fuca1-3)GlcNAcb |
| Fuca1-2Galb1-4GlcNAcb | Galb1-3(Fuca1-4)GlcNAcb |
| Fuca1-2Galb1-3GalNAcb | Fuca1-2Galb1-3GalNAca |
| Glcb1-4(Fuca1-6)GlcNAcb | Galb1-4(Fuca1-3)GlcNAcb |
| Fuca1-2Galb1-3GalNAca | Fuca1-2Galb1-4GlcNAcb |
| Fuca1-2Galb1-3GlcNAcb | Fuca1-2Galb1-4GlcNAcb |
| Galb1-4(Fuca1-3)GlcNAc | Fuca1-2Galb1-3GlcNAcb |
| Fuca1-2Galb1-3GlcNAcb | Fuca1-2Galb1-3GlcNAcb |
| Fuca1-2Galb1-3GlcNAcb | GalNAca1-3(Fuca1-2)Galb |
| Galb1-3(Fuca1-4)GlcNAcb | Galb1-3(Fuca1-4)GlcNAcb |
| GlcNAcb1-6(GlcNb1-2)Mana | Gala1-3Galb1-4GlcNAcb |
| GlcNAcb1-3Galb1-4Glc | Galb1-3(Galb1-6)GalNAc |
| GlcNAcb1-3Galb1-4Glcb | Mana1-3Manb1-4GlcNAc |
| Galb1-4Galb1-3GalNAc | Gala1-3Galb1-3GlcNAcb |
| GlcNAcb1-2Mana1-3Manb | GlcNAcb1-3Galb1-4Glcb |
| Gala1-4Galb1-4GlcNAcb | Gala1-3Galb1-3GlcNAcb |
| Gala1-4Galb1-4GlcNAcb | Galb1-4(GlcNAcb1-2)Man |
| Galb1-4GlcNAcb1-6Man | Gala1-3Galb1-4GlcNAc |
| GlcNAcb1-3Galb1-4Glcb | Galb1-3Galb1-3GalNAc |
| GlcNAcb1-6Mana1-6Man | Mana1-6Manb1-4GlcNAc |
| Gala1-3Galb1-4GalNAc | Galb1-3(Galb1-6)GlcNAc |
| Gala1-3Galb1-4GlcNAc | Mana1-3Manb1-4GlcNAc |
| Galb1-3GlcNAcb1-3Gal | GlcNAcb1-6Mana1-6Manb |
| Galb1-4GlcNAcb1-3Gal | Galb1-4Galb1-3GalNAca |
| Galb1-4GlcNAcb1-2Mana | Galb1-4(Galb1-6)GlcNAc |
| Galb1-4GlcNAcb1-2Man | NeuAc[8S]a1-6Glcb |
| Galb1-3Galb1-4Xyl[2P]a | Galb1-3(Neua1-6)GalNAc |
| GlcAb1-3Galb1-3GalNAc | Neua1-3Galb1-3GalNAc |
| GlcNAcb1-4(Fuca1-6)GlcNAc | GalNAcb1-4(Fuca1-3)GlcNAc |
| GalNAcb1-4(Fuca1-3)GlcNAcb | GlcNAcb1-4(Fuca1-3)GlcNAcb |
| GlcNAcb1-4(Fuca1-6)GlcNAcb | Man[6P]a1-6Mana1-6Man |
| Manb1-4GlcNAcb1-4GlcNAc | Galb1-3(GlcNAcb1-6)GalNAc |
| Manb1-4GlcNAcb1-4GlcNAcb | Galb1-4GlcNAcb1-3GalNAc |
| GlcNAcb1-3Galb1-3GalNAc | Galb1-3GlcNAcb1-3GalNAc |
| Galb1-4GlcNAcb1-6GalNAc | GlcNAcb1-3GalNAcb1-4Glcb |
| Manb1-4GlcNAcb1-4GlcNAc | Galb1-3(GlcNAcb1-6)GalNAca |
| Galb1-3(GlcNAcb1-6)GalNAca | Galb1-4GlcNAcb1-6GalNAca |
| GlcNAcb1-2(GlcNAcb1-6)Man | GlcNAcb1-3Galb1-4GlcNAcb |
| Galb1-3(GlcNAcb1-6)GalNAca | GlcNAcb1-2Galb1-3GalNAca |
| GlcNAcb1-3Galb1-4GlcNAcb | GlcNAcb1-3Galb1-4GlcNAcb |
| GlcNAcb1-3Galb1-4GlcNAcb | Galb1-4GlcNAcb1-3GalNAca |
| Galb1-3GlcNAcb1-6GalNAc | GlcNAcb1-2(GlcNAcb1-4)Man |
| Mana1-6GlcNAcb1-4GlcNAcb | Galb1-3(GlcNAcb1-6)GalNAca |
| GlcNAca1-4Galb1-3GalNAc | GalNAca1-4Galb1-3GalNAc |
| NeuAca2-3Galb1-4Xylb | Fuca1-4(Gal[3S]b1-3)GlcNAcb |
| Fuca1-3(Gal[3S]b1-4)GlcNAcb | Galb1-4GlcNAc[6S]b1-3Gal |
| Gal[3S]b1-4Galb1-3GalNAc | GalNAc[3S]b1-4Galb1-4Glcb |
| GlcNAcb1-3(GlcNAcb1-6)GalNAc | GlcNAcb1-4GlcNAcb1-4GlcNAcb |
| GlcNAcb1-6(GalNAcb1-3)GalNAc | GalNAcb1-4GlcNAcb1-3GalNAc |
| GlcNAcb1-3GalNAca1-6GalNAc | GlcNAcb1-3(GlcNAcb1-6)GalNAca |
| GlcNAcb1-3(GlcNAcb1-6)GalNAca | Kdna2-3Galb1-4GlcNAcb |
| NeuAca2-3Galb1-4Glcb | Kdna1-3Galb1-4GlcNAcb |
| Kdna1-3Galb1-3GlcNAcb | Kdna2-3Galb1-3GlcNAcb |
| NeuAca2-3Galb1-4Glcb | NeuAca2-6Galb1-4Glcb |
| Kdna1-3Galb1-4GlcNAcb | NeuAca2-6Galb1-4Glcb |
| NeuAca2-3Galb1-4Glcb | NeuAca2-6Galb1-4Glcb |
| NeuAca2-3Galb1-4Glcb | Kdna1-3Galb1-4GlcNAcb |
| NeuAca2-6Galb1-4Glc | NeuAca2-3Galb1-4Glc |
| Fuca1-2Galb1-3(Fuca1-2)Gal | Fuca1-2Galb1-4(Fuca1-3)Glc |
| Fuca1-2Galb1-4(Fuca1-2)Glcb | Mana1-3(Mana1-6)(Xylb1-2)Manb |
| NeuGca2-3Galb1-4Glcb | NeuGca2-3Galb1-4Glcb |
| NeuGca2-3Galb1-4Glcb | GlcAb1-3Galb1-3Galb1-4Xylb |
| Gala1-3(Fuca1-2)Galb1-4Glcb | Galb1-4(Fuca1-3)Glcb1-3Galb |
| Gala1-3(Fuca1-2)Galb1-4Glcb | Gala1-3(Fuca1-2)Galb1-4Glc |
| Rhaa1-4GlcAa1-2Mana1-2Man | GalNAc[4S]b1-4GlcNAcb1-2Man |
| GlcNAc[6S]b1-3Galb1-3GalNAc | Galb1-4GlcNAc[6S]b1-3GalNAc |
| Gal[3S]b1-4GlcNAcb1-6GalNAca | Gal[6S]b1-4GlcNAcb1-3GalNAc |
| Gal[6S]b1-3GlcNAcb1-3GalNAc | Galb1-3Gala1-4Galb1-4Glcb |
| Gala1-2Gala1-2Mana1-2Man | Mana1-3Mana1-2Mana1-2Mana |
| Glca1-2Glca1-3Glca1-3Man | Mana1-3Mana1-2Mana1-2Mana |
| Mana1-3Mana1-2Mana1-2Man | Mana1-3Mana1-3Mana1-2Mana |
| Glcb1-6Glcb1-6Glcb1-6Glc | Gala1-3Gala1-4Galb1-4Glcb |
| Gala1-2(Gala1-6)Gala1-4Man | Gala1-2Gala1-6Gala1-4Man |
| NeuAca2-3Galb1-4GlcNAcb | NeuAca2-3Galb1-3GalNAc |
| NeuAca2-3Galb1-3GalNAca | Galb1-3(NeuAca2-6)GalNAc |
| NeuAca2-3Galb1-3GalNAca | Galb1-3(NeuAca2-6)GalNAca |
| Galb1-3(NeuAca2-6)GalNAca | NeuAca2-3Galb1-3GlcNAc |
| NeuAca2-3Galb1-4GlcNAc | NeuAca2-3/6Galb1-3GalNAca |
| NeuAca2-3Galb1-3GalNAca | NeuAca2-6Galb1-4GlcNAcb |
| NeuAca2-3Galb1-3/4GlcNAc | NeuAca2-6Galb1-4GlcNAc |
| NeuAca2-6Manb1-4GlcNAc | NeuAca2-3Galb1-4GlcNAc |
| NeuAca2-3Galb1-3GalNAca | Galb1-3(NeuAca2-6)GlcNAc |
| Galb1-3(NeuAca2-6)GalNAc | NeuAca2-3Galb1-3GalNAc |
| Galb1-3(NeuAca2-6)GalNAca | Galb1-3(NeuAca2-6)GalNAca |
| NeuAca2-3Galb1-3GlcNAcb | NeuAca2-3Galb1-3GlcNAcb |
| NeuAca2-3Galb1-3GalNAca | NeuAca2-6Manb1-4GlcNAc |
| Galb1-3(NeuAca2-6)GalNAca | NeuAca2-3Gala1-4GlcNAcb |
| NeuAca2-6Galb1-3GalNAca6 | NeuAca2-3Galb1-3GlcNAcb |
| NeuAca2-3Galb1-4GalNAc | Galb1-3(NeuAca2-6)GalNAcb |
| NeuAca2-3Galb1-3GlcNAcb | NeuAca2-3Galb1-4GlcNAcb |
| NeuAca2-3Galb1-3GlcNAcb | NeuAca2-3Galb1-3GlcNAc |
| Galb1-3(NeuAca2-6)GalNAca | NeuAca2-3Gala1-3GlcNAcb |
| NeuAca2-3Galb1-4GlcNAcb | NeuAca2-3Galb1-3GalNAca |
| NeuAca2-3Galb1-3GalNAca | NeuAca2-3Galb1-3GalNAc |
| Galb1-3(NeuAcb2-6)GalNAca | NeuAca2-6Galb1-4GlcNAcb |
| NeuAca2-6Galb1-4GlcNAcb | NeuAca2-3Galb1-4GlcNAcb |
| NeuAca2-3Galb1-3GalNAca | Galb1-3(NeuAca2-6)GalNAca |
| NeuAca2-3Galb1-4GlcNAcb | NeuAca2-6Galb1-4GlcNAcb |
| NeuAca2-3Galb1-4GlcNAc | NeuAca2-3Galb1-3GalNAca |
| NeuAca2-6Galb1-3GalNAca | NeuAca2-6Galb1-4GlcNAcb |
| NeuAca2-6Galb1-3GalNAca | NeuAca2-3Galb1-3GalNAcb |
| Fuca1-2Galb1-4(Fuca1-3)GlcNAcb | Fuca1-2Galb1-4(Fuca1-3)GlcNAcb |
| Fuca1-2Galb1-3(Fuca1-4)GlcNAcb | Fuca1-2Galb1-4(Fuca1-3)GlcNAcb |
| Fuca1-2Galb1-3(Fuca1-2)GalNAc | Fuca1-2Galb1-4(Fuca1-3)GlcNAc |
| Fuca1-2Galb1-3(Fuca1-4)GlcNAc | NeuGca2-3Galb1-3GalNAc |
| Galb1-3(NeuGca2-6)GalNAc | NeuGca2-6Galb1-4GlcNAcb |
| NeuGca2-3Galb1-4GlcNAcb | NeuGca2-3Galb1-4GlcNAcb |
| NeuGca2-6Galb1-4GlcNAcb | NeuGca2-3Galb1-3GlcNAcb |
| NeuGca2-6Galb1-4GlcNAcb | NeuGca2-3Galb1-4GlcNAcb |
| NeuGca2-6Galb1-4GlcNAcb | NeuGca2-3Galb1-4GlcNAcb |
| Galb1-4(Fuca1-3)GlcNAcb1-2Man | Gala1-3(Fuca1-2)Galb1-4GlcNAcb |
| GalNAca1-3(Fuca1-2)Galb1-4Glcb | Gala1-3(Fuca1-2)Galb1-3GalNAca |
| Gala1-3(Fuca1-2)Galb1-4GlcNAcb | Gala1-3Galb1-4(Fuca1-2)GlcNAcb |
| Gala1-3Galb1-4(Fuca1-3)GlcNAcb | Gala1-3Galb1-3(Fuca1-2)GlcNAcb |
| GalNAca1-3(Fuca1-2)Galb1-4Glcb | Gala1-3Galb1-4(Fuca1-3)GlcNAcb |
| Gala1-3Galb1-4(Fuca1-3)GlcNAcb | Galb1-3Galb1-4(Fuca1-2)GlcNAcb |
| Gala1-3(Fuca1-2)Galb1-4GlcNAcb | Gala1-3(Fuca1-2)Galb1-3GalNAca |
| Gala1-3Galb1-3(Fuca1-2)GlcNAcb | Gala1-3Galb1-4(Fuca1-3)GlcNAc |
| Gala1-4(Fuca1-2)Galb1-3GalNAc | Fuca1-2Galb1-3(Galb1-6)GalNAc |
| GalNAca1-3(Fuca1-2)Galb1-4Glcb | Mana1-3(Mana1-6)Manb1-4GlcNAc |
| Mana1-2Mana1-3Manb1-4GlcNAc | Mana1-3Mana1-6Manb1-4GlcNAc |
| GalNAcb1-3Gala1-4Galb1-4Glc | GalNAcb1-4Gala1-4Galb1-4Glcb |
| Mana1-6Mana1-6Manb1-4GlcNAc | GlcNAcb1-3Gala1-4Galb1-4Glcb |
| Galb1-3GlcNAcb1-3Galb1-4Glcb | Galb1-4(Galb1-2Galb1-6)GlcNAc |
| Galb1-3(Galb1-2Galb1-6)GlcNAc | GalNAcb1-3Gala1-4Galb1-4Glcb |
| Galb1-3GlcNAcb1-3Galb1-4Glc | Mana1-3(Mana1-6)Manb1-4GlcNAc |
| Galb1-4GalNAcb1-4Galb1-4Glcb | Galb1-4GlcNAcb1-3Galb1-4Glcb |
| Mana1-3Mana1-6Manb1-4GlcNAc | GlcNAcb1-4(Mana1-3)(Mana1-6)Man |
| Galb1-4GlcNAcb1-3Galb1-4Glcb | Galb1-4GlcNAcb1-3Galb1-4Glcb |
| Mana1-3(Mana1-6)Talb1-4GlcNAc | Galb1-3GlcNAcb1-3Galb1-4Glcb |
| Mana1-6Mana1-6Manb1-4GlcNAc | Mana1-3(Mana1-6)Manb1-4GlcNAc |
| Galb1-3GlcNAcb1-3Galb1-4Glc | Galb1-3(Gala1-3Galb1-6)GalNAc |
| Galb1-4GlcNAcb1-3Galb1-4Glc | GlcNAcb1-3(NeuAca2-6)GalNAc |
| NeuAca2-3GalNAcb1-4GlcNAc | GalNAca1-3(NeuAca2-6)GalNAc |
| NeuAca2-3GalNAcb1-4GlcNAc | GalNAcb1-3(NeuAca2-6)GalNAc |
| NeuAca2-6GalNAcb1-4GlcNAc | GlcNAcb1-4(Fuca1-3)(Fuca1-6)GlcNAcb |
| Xylb1-2Manb1-4GlcNAcb1-4GlcNAc | Kdna1-3(Kdna1-6)GalNAca |
| GlcAb1-3Galb1-3Galb1-4Xyl[2P]b | GlcAb1-3Gal[4S]b1-3Galb1-4Xylb |
| GlcA[3S]b1-3Galb1-3Galb1-4Xyl | GalNAcb1-3(NeuGca2-6)GalNAc |
| GlcNAcb1-3(NeuGca2-6)GalNAc | GalNAca1-3(NeuGca2-6)GalNAc |
| Fuca1-2Galb1-3GalNAcb1-4GlcNAc | GalNAca1-3(Fuca1-2)Galb1-3GalNAca |
| GalNAca1-3Galb1-4(Fuca1-2)GlcNAcb | GalNAca1-3(Fuca1-2)Galb1-4GlcNAcb |
| Fuca1-2Galb1-4GlcNAcb1-3GalNAc | Fuca1-2Galb1-3(GlcNAcb1-6)GalNAc |
| GalNAca1-3(Fuca1-2)Galb1-3GalNAc | Manb1-4GlcNAcb1-4(Fuca1-3)GlcNAc |
| Galb1-4(Fuca1-3)GlcNAcb1-3GalNAc | GalNAca1-3Galb1-3(Fuca1-2)GlcNAcb |
| GalNAca1-3(Fuca1-2)Galb1-3GalNAca | GalNAca1-3(Fuca1-2)Galb1-4GlcNAcb |
| GalNAcb1-3Galb1-3(Fuca1-2)GlcNAcb | Fuca1-2Galb1-4GlcNAcb1-6GalNAc |
| GalNAcb1-3Galb1-4(Fuca1-2)GlcNAcb | GalNAca1-3(Fuca1-2)Galb1-4GlcNAcb |
| Manb1-4GlcNAcb1-4(Fuca1-3)GlcNAc | Fuca1-2Galb1-3GlcNAcb1-3GalNAc |
| Galb1-3(Fuca1-4GlcNAcb1-6)GalNAc | Manb1-4GlcNAcb1-4(Fuca1-6)GlcNAc |
| Manb1-4GlcNAcb1-4(Fuca1-6)GlcNAcb | Manb1-4GlcNAcb1-4(Fuca1-3)GlcNAcb |
| GlcNAca1-3GalNAca1-3(Fuca1-2)Gal | Mana1-6Manb1-4GlcNAcb1-4GlcNAc |
| GalNAca1-3GalNAcb1-3Gala1-4Glcb | Mana1-6Manb1-4GlcNAcb1-4GlcNAcb |
| Mana1-6Manb1-4GlcNAcb1-4GlcNAc | Mana1-3Manb1-4GlcNAcb1-4GlcNAc |
| Galb1-3(Galb1-4GlcNacb1-6)GalNac | GalNAca1-3GalNAcb1-3Gala1-4Galb |
| Manb1-3Manb1-4GlcNAcb1-4GlcNAc | Galb1-3(Galb1-3/4GlcNAcb1-6)GalNAc |
| Galb1-4GlcNAcb1-3Galb1-3GalNAc | GlcNAcb1-4Mana1-3Manb1-4GlcNAc |
| Galb1-4GlcNAcb1-6Galb1-3GalNAc | GlcNAcb1-2Mana1-6Manb1-4GlcNAc |
| GlcNAcb1-2Mana1-3Manb1-4GlcNAc | GalNAcb1-3Galb1-4Galb1-3GalNAc |
| GalNAcb1-3Galb1-4Galb1-3GalNAca | Galb1-3(Galb1-4GlcNAcb1-6)GalNAca |
| GlcNAcb1-4Mana1-6Manb1-4GlcNAc | Mana1-3Manb1-4GlcNAcb1-4GlcNAcb |
| Galb1-3(Galb1-4GlcNAcb1-6)GlcNAc | Galb1-4GlcNAcb1-3Galb1-4GlcNAcb |
| Galb1-4GlcNAcb1-3Galb1-4GlcNAcb | Mana1-3Manb1-4GlcNAcb1-4GlcNAc |
| Galb1-3(Galb1-4GlcNAcb1-6)GalNAca | Galb1-3(Galb1-4GlcNAcb1-6)GalNAca |
| GlcNAcb1-6Mana1-6Manb1-4GlcNAc | Galb1-3(Galb1-4GlcNAcb1-6)GalNAca |
| Galb1-4GlcNAcb1-3Galb1-4GlcNAcb | Galb1-3(Galb1-4GalNAcb1-6)GalNAc |
| Galb1-3GalNAca1-4Galb1-3GalNAc | Galb1-3Galb1-3(GlcNAcb1-6)GalNAc |
| Manb1-4GlcNAcb1-4Manb1-4GlcNAc | Galb1-4(GlcNAcb1-2)(GlcNAcb1-6)Man |
| Galb1-3(Galb1-4GlcNAcb1-6)GalNAc | Galb1-3(Galb1-3GlcNAcb1-6)GalNAc |
| Galb1-4GlcNAcb1-3Galb1-4GlcNAcb | NeuAca2-6(Gal[6S]b1-3)GalNAca |
| NeuAca2-3Galb1-3GalNAc[6S]a | GlcAb1-3Galb1-3(GlcNAcb1-6)GalNAc |
| NeuAca2-8NeuAca2-6Glcb | Fuca1-2(Gal[3S]b1-4)Galb1-3GalNAc |
| GalNAcb1-4(Fuca1-3)GlcNAcb1-3GalNAc | Fuca1-2Gala1-3(Kdna1-6)GalNAc |
| Gala1-3(Fuca1-4Kdna1-6)GalNAc | Man[6P]a1-6Mana1-6Manb1-4GlcNAc |
| GlcNAcb1-3/4Galb1-3(GlcNAcb1-6)GalNAc | GlcNAca1-4Galb1-3(GlcNAcb1-6)GalNAc |
| GlcNAcb1-3/4/2Galb1-6/3(GlcNAcb1-3/6)GalNAc | GalNAcb1-3GlcNAcb1-3Galb1-3GalNAc |
| GlcNAcb1-3Galb1-4GlcNAcb1-3GalNAc | GlcNAcb1-3(Galb1-4GlcNAcb1-6)GalNAc |
| GlcNAcb1-3(GlcNAcb1-6)Galb1-3GalNAca | GlcNAcb1-2(GlcNAcb1-4)(GlcNAcb1-6)Man |
| Galb1-3(GlcNAcb1-3GlcNAcb1-6)GalNAc | GlcNAcb1-3Galb1-3GlcNAcb1-3GalNAc |
| GlcNAca1-3Galb1-3GlcNAcb1-3GalNAc | GlcNAcb1-2(GlcNAcb1-4)(GlcNAcb1-6)Mana |
| GlcNAcb1-3(GlcNAcb1-6)Galb1-3GalNAc | GlcNAcb1-4Manb1-4GlcNAcb1-4GlcNAc |
| GlcNAcb1-3Galb1-4GlcNAcb1-6GalNAc | Gala1-4(Fuca1-2)Galb1-3(Fuca1-2)Gal |
| NeuAca2-3(NeuAca2-6)GalNAca | Rhaa1-2(Rhaa1-4)GlcAa1-2Mana1-2Man |
| Fuca1-2Galb1-3(GlcNAc[6S]b1-6)GalNAc | Fuca1-2Galb1-3(NeuAca2-6)GalNAc |
| NeuAca2-6Galb1-4GlcNAcb1-3Fuca | Fuca1-2Galb1-3(NeuAca2-6)GlcNAc |
| NeuAca2-3Galb1-4(Fuca1-3)GlcNAcb | NeuAca2-6Galb1-4GlcNAcb1-3Fuca |
| NeuAca2-3(Fuca1-4)Galb1-3GlcNAcb | NeuAca2-3Galb1-4(Fuca1-3)GlcNAcb |
| NeuAca2-3Galb1-4GlcNAcb1-3Fuca | NeuAca2-3Galb1-4(Fuca1-3)GlcNAc |
| NeuAca2-3Galb1-4(Fuca1-4)GlcNAcb | NeuAca2-3Galb1-4(Fuca1-3)GlcNAcb |
| Fuca1-2Galb1-3(NeuAca2-6)GalNAca | NeuAca2-6Galb1-4GlcNAcb1-3Fuc |
| NeuAca2-3Galb1-3(Fuca1-4)GlcNAcb | NeuAca2-3Galb1-4(Fuca1-3)GlcNAcb |
| Manb1-4GlcNAcb1-4GlcNAcaAll[P] | Galb1-3(Galb1-4GlcNAc[6S]b1-6)GalNAc |
| Gal[6S]b1-4GlcNAcb1-3Galb1-3GalNAc | Galb1-3(Gal[3S]b1-4GlcNAcb1-6)GalNAc |
| Galb1-4GlcNAc[6S]b1-3Galb1-3GalNAc | Mana1-3(Mana1-3(Mana1-6)Mana1-6)Man |
| Gala1-3Gala1-3Gala1-4Galb1-4Glcb | Glca1-4(Glca1-4Glca1-6)Glca1-4Glcb |
| Mana1-2Mana1-3(Mana1-2Mana1-6)Man | Mana1-3Mana1-3Mana1-2Mana1-2Mana |
| Mana1-2Mana1-3(Mana1-2Mana1-6)Mana | Galb1-4Glcb1-2(Galb1-4Glcb1-6)Man |
| GlcNAcb1-4GlcNAcb1-4GlcNAcb1-4GlcNAcb | NeuGca2-8NeuGca2-6GalNAc |
| Fuca1-2Galb1-3(NeuGca2-6)GalNAc | NeuGca2-3Galb1-4(Fuca1-3)GlcNAcb |
| NeuGca2-3Galb1-3(Fuca1-4)GlcNAcb | NeuAca2-3Galb1-4GlcNAcb1-2Mana |
| GalNAcb1-4(NeuAca2-3)Galb1-4Glcb | GlcNAcb1-4(NeuAca2-4)Galb1-4Glcb |
| GalNAcb1-4(NeuAca2-3)Galb1-4Glcb | GalNAcb1-4(NeuAca2-3)Galb1-4Glcb |
| GlcNAcb1-4(NeuAca2-3)Gala1-4Glcb | GalNAcb1-4(NeuAca2-3)Galb1-4Glcb |
| GalNAcb1-4(NeuAca2-3)Galb1-4Glcb | NeuAca2-6Galb1-6Galb1-3GlcNAcb |
| NeuAca2-3Galb1-4GlcNAcb1-4Man | NeuAca2-6Galb1-4GlcNAcb1-3Gal |
| NeuAca2-3Galb1-4GlcNAcb1-3Gal | NeuAca2-3Galb1-4GlcNAcb1-2Man |
| Fuca1-2Galb1-3(Fuca1-2)Galb1-3GalNAc | GalNAca1-3(Fuca1-2)Galb1-3(Fuca1-2)Gal |
| Galb1-3(Fuca1-2)Galb1-4(Fuca1-3)GlcNAcb | Gala1-3(Fuca1-2)Galb1-4(Fuca1-3)GlcNAcb |
| Mana1-3(Mana1-6)(Xylb1-2)Manb1-4GlcNAc | Mana1-3(Mana1-6)(Xylb1-2)Manb1-4ManNAc |
| Mana1-3(Mana1-6)(Xylb1-2)Manb1-4ManNAcb | Mana1-3(Mana1-6)(Xylb1-2)Manb1-4GlcNAcb |
| NeuAc[8S]a2-8NeuAca2-6Glcb | GalNAcb1-4(NeuGca2-3)Galb1-4Glcb |
| Galb1-4Galb1-3(NeuGca2-6)GalNAc | Fuca1-2Galb1-3GlcNAcb1-3Galb1-4Glcb |
| Galb1-3(Fuca1-4)GlcNAcb1-3Galb1-4Glc | Galb1-4(Fuca1-3)GlcNAcb1-3Galb1-4Glc |
| Xylb1-2Manb1-4GlcNAcb1-4(Fuca1-3)GlcNAcb | Xylb1-2Manb1-4GlcNAcb1-4(Fuca1-3)GlcNAc |
| Xylb1-2Manb1-4GlcNAcb1-4(Fuca1-3)GlcNAc | Galb1-3(GalNAc[4S]b1-4GlcNAcb1-6)GalNAca |
| Mana1-3(Mana1-6Mana1-6)Manb1-4GlcNAc | Mana1-3(Mana1-3Mana1-6)Manb1-4GlcNAc |
| Galb1-4GlcNAcb1-2Mana1-3Manb1-4Glcb | Gala1-3Galb1-4GlcNAcb1-3Galb1-4Glcb |
| Mana1-2Mana1-2Mana1-3Manb1-4GlcNAc | Mana1-3(Mana1-6)Mana1-6Manb1-4GlcNAc |
| Mana1-3(Mana1-6Mana1-6)Manb1-4GlcNAc | Mana1-3(Mana1-3Mana1-6)Manb1-4GlcNAc |
| Mana1-2Mana1-3(Mana1-6)Manb1-4GlcNAc | Mana1-3(Mana1-6)Mana1-6Manb1-4GlcNAc |
| Mana1-3(Mana1-3Manb1-6)Manb1-4GlcNAc | GalNAcb1-3Gala1-3Gala1-4Galb1-4Glcb |
| GalNAcb1-4(NeuAca2-3)Galb1-3GalNAc | GalNAca1-4Galb1-3(NeuAca2-6)GalNAc |
| GlcNAca1-4Galb1-3(NeuAca2-6)GalNAc | GlcNAcb1-3Galb1-3(NeuAca2-6)GalNAc |
| NeuAca2-3Galb1-3(GlcNAcb1-6)GalNAc | Galb1-3GlcNAcb1-3(NeuAca2-6)GalNAc |
| Galb1-4GlcNAcb1-3(NeuAca2-6)GalNAc | GalNAcb1-4(NeuAca2-3)Galb1-4GlcNAc |
| NeuAca2-3Galb1-3(GlcNAcb1-4)GalNAca | NeuAca2-3GalNAcb1-4GlcNAcb1-2Man |
| GlcNAcb1-3Galb1-3(NeuAca2-6)GalNAca | GalNAca1-4(NeuAca2-3)Galb1-3GalNAc |
| NeuAca2-3Galb1-3(GlcNAcb1-6)GalNAca | GalNAcb1-4(NeuAca2-3)Galb1-4GlcNAcb |
| NeuAca2-6Manb1-4GlcNAcb1-4GlcNAc | GlcNAcb1-4(NeuAca2-3)Galb1-4GlcNAcb |
| GalNAcb1-3(Fuca1-2)Galb1-4(Fuca1-3)GlcNAcb | GalNAca1-3(Fuca1-2)Galb1-4(Fuca1-3)GlcNAcb |
| Fuca1-2Galb1-4(Fuca1-3)GlcNAcb1-6GalNAc | Fuca1-3GalNAcb1-4(Fuca1-3)GlcNAcb1-4Glcb |
| Manb1-4GlcNAcb1-4(Fuca1-3)(Fuca1-6)GlcNAcb | Fuca1-2Galb1-4(Fuca1-3)GlcNAcb1-3GalNAc |
| Manb1-4GlcNAcb1-4(Fuca1-3)(Fuca1-6)GlcNAc | Mana1-6(Xylb1-2)Manb1-4GlcNAcb1-4GlcNAc |
| Mana1-6(Xylb1-2)Manb1-4GlcNAcb1-4GlcNAcb | NeuAca2-8NeuAca2-8NeuAca6 |
| Galb1-4GlcNAcb1-3(NeuGca2-6)GalNAc | GlcNAcb1-3Galb1-3(NeuGca2-6)GalNAc |
| Mana1-3Manb1-4GlcNAcb1-4(Fuca1-6)GlcNAc | Mana1-3/6Manb1-4GlcNAcb1-4(Fuca1-6)GlcNAcb |
| Mana1-6Manb1-4GlcNAcb1-4(Fuca1-3)GlcNAcb | Fuca1-3GalNAcb1-3Galb1-4Galb1-3GalNAc |
| Mana1-3Manb1-4GlcNAcb1-4(Fuca1-3)GlcNAcb | Mana1-6Manb1-4GlcNAcb1-4(Fuca1-6)GlcNAc |
| Mana1-6Manb1-4GlcNAcb1-4(Fuca1-6)GlcNAcb | Galb1-3(Fuca1-2)Galb1-3(GlcNAcb1-6)GalNAc |
| Gala1-4(Fuca1-2)Galb1-3(GlcNAcb1-6)GalNAc | Galb1-3(Fuca1-2)Galb1-3GlcNAcb1-6GalNAc |
| Fuca1-3GalNAcb1-3Galb1-4Galb1-3GalNAca | Mana1-6Manb1-4GlcNAcb1-4(Fuca1-3)GlcNAc |
| Mana1-6Manb1-4GlcNAcb1-4(Fuca1-3)GlcNAc | Galb1-3(Fuca1-2Galb1-4GlcNAcb1-6)GalNAc |
| Galb1-3(Fuca1-2Galb1-3GlcNAcb1-6)GalNAc | Gala1-4(Fuca1-2)Galb1-4GlcNAcb1-3GalNAc |
| Galb1-3(Fuca1-2Galb1-4GlcNAcb1-6)GalNAca | Galb1-3Fuca1-4GlcNAcb1-3Galb1-3GalNAc |
| Fuca1-2Galb1-3(Galb1-4GlcNAcb1-6)GalNAc | Fuca1-2Galb1-3/4GlcNAcb1-3Galb1-3GalNAc |
| Galb1-4(Fuca1-3)GlcNAcb1-3Galb1-3GalNAc | Galb1-3(Galb1-4(Fuca1-3)GlcNAcb1-6)GalNAc |
| Fuca1-2Galb1-4GlcNAcb1-3Galb1-4GlcNAc | Galb1-3(Galb1-4(Fuca1-3)GlcNAcb1-6)GalNAca |
| Fuca1-2Galb1-4GlcNAcb1-3Galb1-4GlcNAcb | Fuca1-2Galb1-4GlcNAcb1-3Galb1-3GalNAc |
| Fuca1-2Galb1-4GlcNAcb1-3Galb1-4GlcNAcb | Fuca1-2Galb1-4GlcNAcb1-3Galb1-3GalNAca |
| Fuca1-2Galb1-3GlcNAcb1-3Galb1-3GalNAc | Fuca1-2Galb1-3GalNAca1-4Galb1-3GalNAc |
| Mana1-3Manb1-4GlcNAcb1-4(Fuca1-3)GlcNAc | NeuAca2-3Galb1-4(Fuca1-3)GlcNAc[6S]b |
| Fuca1-3(NeuAca2-3Gal[6S]b1-4)GlcNAcb | GlcNAcb1-2Mana1-3(GlcNAcb1-2Mana1-6)Man |
| Mana1-6Mana1-6Manb1-4GlcNAcb1-4GlcNAcb | Mana1-3(Mana1-6)Manb1-4GlcNAcb1-4GlcNAcb |
| Mana1-3Mana1-6Manb1-4GlcNAcb1-4GlcNAc | Galb1-4GlcNAcb1-2(Galb1-4GlcNAcb1-3)Gal |
| Galb1-4GlcNAcb1-3(Galb1-4GlcNAcb1-4)Gal | GalNAca1-3GalNAcb1-4Gala1-4Galb1-4Glcb |
| Galb1-3(Gala1-3Galb1-4GlcNAcb1-6)GalNAca | GlcNAcb1-2Mana1-3(GlcNAcb1-2Mana1-6)Mana |
| Manb1-3(Manb1-6)Mana1-4GlcNAcb1-4GlcNAc | Mana1-3(Mana1-6)Mana1-4GlcNAcb1-4GlcNAcb |
| GlcNAcb1-4(Mana1-3)(Mana1-6)Manb1-4GlcNAc | Galb1-4GlcNAcb1-2(Galb1-4GlcNAcb1-6)Gal |
| Mana1-3(Mana1-6)Manb1-4GlcNAcb1-4GlcNAcb | GalNAca1-3GalNAcb1-3Gala1-4Galb1-4Glcb |
| Mana1-3(Mana1-6)Manb1-4GlcNAcb1-4GlcNAc | GalNAca1-3Galb1-3GlcNAcb1-3Galb1-4Glc |
| Galb1-4GlcNAcb1-2(Galb1-4GlcNAcb1-4)Gal | Galb1-4GlcNAcb1-3(Galb1-4GlcNAcb1-6)Gal |
| Mana1-3(Mana1-6)Manb1-4GlcNAcb1-4GlcNAc | Gala1-3Galb1-4GlcNAcb1-3Galb1-3GalNAc |
| Galb1-4GlcNAcb1-2(Galb1-4GlcNAcb1-6)Man | Galb1-3(Gala1-3Galb1-4GalNAcb1-6)GalNAc |
| Galb1-3Galb1-4GlcNAcb1-3Galb1-3GalNAc | Galb1-4GlcNAcb1-2(Galb1-4GlcNAcb1-4)Man |
| Mana1-2Mana1-3Manb1-4GlcNAcb1-4GlcNAc | Mana1-6Mana1-6Manb1-4GlcNAcb1-4GlcNAc |
| Mana1-3(GlcNAcb1-2Mana1-6)Manb1-4GlcNAc | Mana1-3Mana1-6Manb1-4GlcNAcb1-4GlcNAc |
| Mana1-3Mana1-6Manb1-4GlcNAcb1-4GlcNAcb | Galb1-4GlcNAcb1-2Mana1-6Manb1-4GlcNAc |
| Galb1-4GlcNAcb1-2Mana1-3Manb1-4GlcNAc | GalNAcb1-3GalNAcb1-3Gala1-4Galb1-4Glcb |
| Mana1-3(Mana1-6)Manb1-4GlcNAcb1-4GlcNAc | Galb1-3(Gala1-3Galb1-4GlcNAcb1-6)GalNAc |
| Mana1-2Mana1-3Manb1-4GlcNAcb1-4GlcNAcb | Galb1-3(Galb1-3Galb1-4GlcNAcb1-6)GalNAca |
| GlcNAcb1-2Mana1-3(Mana1-6)Manb1-4GlcNAc | NeuAca2-3Galb1-4GlcNAc[6S]b1-3Gal |
| NeuAca2-8NeuAca2-3Galb1-4Glcb | NeuAca2-8NeuAca2-3Galb1-4Glcb |
| NeuAca2-8NeuAca2-3Galb1-4G1c | NeuAca2-8NeuAca2-3Galb1-4Glcb |
| NeuAca2-8NeuAca2-3Galb1-4Glcb | Gala1-3(Fuca1-4(Fuca1-5)Kdna1-6)GalNAc |
| Fuca1-2Galb1-3(Fuca1-4Kdna1-6)GalNAc | Fuca1-2Gala1-3(Fuca1-4Kdna1-6)GalNAc |
| Fuca1-4(Fuca1-5)Kdna1-3Galb1-3GalNAc | NeuGca2-3Galb1-4GlcNAc[6S]b1-3Gal |
| GalNAca1-3(Fuca1-2)Galb1-3(GlcNAcb1-6)GalNAc | GlcNAca1-3GalNAca1-3(Fuca1-2)Galb1-3GalNAc |
| GlcNAcb1-3(Galb1-4(Fuca1-3)GlcNAcb1-6)GalNAc | GlcNAcb1-6Galb1-3(Fuca1-4GlcNAcb1-6)GalNAc |
| GlcNAcb1-3(Fuca1-2Galb1-4GlcNAcb1-6)GalNAc | GlcNAcb1-3Galb1-3(Fuca1-4GlcNAcb1-6)GalNAc |
| Galb1-3(GalNAcb1-4(Fuca1-3)GlcNAcb1-6)GalNAc | GlcNAca1-4(GlcNAca1-4GlcAa1-2)GlcAa1-2Gal |
| GlcA[3S]b1-4GlcA[3S]b1-4GlcA[3S]b1-4Glcb | GalNAcb1-4GalNAcb1-3Galb1-4Galb1-3GalNAc |
| Galb1-3GlcNAcb1-3(Galb1-4GlcNAcb1-6)GalNAc | GlcNAcb1-3Galb1-3(Galb1-4GlcNAcb1-6)GalNAc |
| Galb1-4GlcNAcb1-3Galb1-4GlcNAcb1-3GalNAc | Galb1-3GlcNAcb1-3Galb1-4GlcNAcb1-3GalNAc |
| GlcNAcb1-6Galb1-3(Galb1-4GlcNAcb1-6)GalNAc | Galb1-4GlcNAcb1-3(Galb1-4GlcNAcb1-6)GalNAc |
| GlcNAcb1-2Mana1-3(GlcNAc)Manb1-4GlcNAc | GlcNAcb1-2Mana1-3Manb1-4GlcNAcb1-4GlcNAcb |
| GlcNAcb1-4(Mana1-3)Manb1-4GlcNAcb1-4GlcNAc | GlcNAcb1-2Mana1-3Manb1-4GlcNAcb1-4GlcNAc |
| GlcNAcb1-3Galb1-4GlcNAcb1-3Galb1-4GlcNAcb | Galb1-3(GlcNAca1-4Galb1-4GlcNAcb1-6)GalNAc |
| Galb1-4GlcNAcb1-3(Galb1-4GlcNAcb1-6)GalNAca | GlcNAcb1-2(GlcNAcb1-6)Mana1-6Manb1-4GlcNAc |
| GlcNAcb1-2(GlcNAcb1-6)Manb1-6Manb1-4GlcNAc | GlcNAcb1-3Galb1-4GlcNAcb1-3Galb1-3GalNAc |
| Mana1-6Manb1-4GlcNAcb1-4GlcNAcb1-4GlcNAc | Manb1-4GlcNAcb1-4Manb1-4GlcNAcb1-4GlcNAc |
| GlcNAcb1-4(Mana1-6)Manb1-4GlcNAcb1-4GlcNAc | Galb1-4GlcNAcb1-3(Galb1-4GlcNAcb1-6)GalNAca |
| Galb1-3GlcNAcb1-3Galb1-3GlcNAcb1-3GalNAc | NeuGca2-6Glca2-8NeuGca2-6Glcb |
| NeuAca2-6Galb1-3(GlcNAc[6S]b1-6)GalNAca | NeuAca2-3Galb1-4GlcNAc[6S]b1-3GalNAc |
| NeuAca2-3Galb1-3(NeuAca2-6)GalNAca | NeuAca2-3Galb1-3(NeuAca2-6)GalNAca |
| NeuAca2-3Galb1-3(NeuAca2-6)GalNAca | NeuAca2-9NeuAca2-3Galb1-3GlcNAcb |
| NeuAca2-3Galb1-3(NeuAca2-6)GalNAc | NeuAca2-8NeuAca2-3Galb1-4GlcNAcb |
| GlcAb1-3Galb1-3(GlcNAcb1-3GlcNAcb1-6)GalNAc | NeuAca2-2Galb1-3(NeuAca2-6)GalNAc |
| NeuAca2-3(NeuAca2-6)Galb1-3GalNAc | NeuAca2-3Galb1-3(NeuAca2-6)GalNAca |
| NeuAca2-3Galb1-3(NeuAca2-6)GalNAc | NeuAca2-3(NeuAca2-6)Galb1-3GalNAc |
| NeuAca2-3Galb1-3(NeuAca2-6)GalNAc | NeuAca2-3Galb1-3(NeuAca2-6)GalNAca |
| NeuAca2-3Galb1-3(NeuAca2-6)GalNAca | NeuAca2-3Galb1-3(NeuAca2-6)GalNAca |
| NeuAca2-3Galb1-3(NeuAca2-6)GalNAc | GlcNAcb1-3(Fuca1-3Fuca1-4Kdna1-6)GalNAc |
| NeuGca2-3Galb1-4GlcNAc[6S]b1-3GalNAc | Fuca1-2Galb1-3(Gal[3S]b1-4GlcNAcb1-6)GalNAc |
| GalNAcb1-4(GalNAca1-2Fuca1-3)GlcNAcb1-3GalNAc | NeuAca2-3Galb1-3(NeuGca2-6)GalNAcb |
| NeuGca2-3Galb1-3(NeuAca2-6)GalNAcb | NeuAca2-3Galb1-3(NeuGca2-6)GalNAc |
| NeuGca2-3Galb1-3(NeuAca2-6)GalNAc | Galb1-4(Fuca1-3)GlcNAcb1-3(Kdna1-6)GalNAc |
| GlcNAc[6S]b1-3Gal[6S]b1-4GlcNAc[6S]b1-3Gal | Glca1-2Glca1-3Glca1-3Mana1-2Mana1-2Man |
| Gala1-3Gala1-3Gala1-3Gala1-4Galb1-4Glcb | NeuGca2-3Galb1-3(NeuGca2-6)GalNAc |
| Galb1-3(NeuGca2-8NeuGca2-6)GalNAc | NeuGca2-3Galb1-3(NeuGca2-6)GalNAca |
| NeuGca2-3Galb1-3(NeuGca2-6)GalNAca | NeuAca2-3Galb1-3GalNAcb1-4Galb1-4Glcb |
| NeuAca2-3Galb1-4GlcNAcb1-3Galb1-4Glc | Galb1-3(NeuAca2-6)GalNAcb1-4Galb1-4Glcb |
| Galb1-4GlcNAcb1-4(NeuAca2-3)Galb1-4Glcb | Glcb1-3GalNAcb1-4(NeuAca2-3)Galb1-4Glcb |
| NeuAca2-6Galb1-4GlcNAcb1-3Galb1-4Glc | Galb1-4GlcNAcb1-4(NeuAca2-3)Galb1-4Glcb |
| Galb1-3GalNAcb1-4(NeuAca2-3)Galb1-4Glcb | Galb1-3(NeuAca2-6)GlcNAcb1-3Galb1-4Glc |
| Fuca1-2GlcAb1-3Galb1-3(Fuca1-2)Galb1-3GalNAc | Galb1-3GalNAcb1-4(NeuGca2-3)Galb1-4Glcb |
| NeuGca2-3Galb1-3GalNAcb1-4Galb1-4Glcb | GalNAca1-3(Fuca1-2)Galb1-3(GlcNAc[6S]b1- |
| | 6)GalNAc |
| GalNAca1-3(Fuca1-2)Galb1-3Galb1-4Galb1-4Glcb | Gala1-3(Fuca1-2)Galb1-4GlcNAcb1-3Galb1-4Glcb |
| Gala1-3(Fuca1-2)Galb1-3GlcNAcb1-3Galb1-4Glcb | GalNAca1-3(Fuca1-2)Galb1-3(NeuAca2-6)GalNAc |
| Fuca1-2Galb1-3GlcNAcb1-3(NeuAca2-6)GalNAc | GlcNAcb1-3(Fuca1-2)Galb1-3(NeuAca2-6)GalNAc |
| NeuAca2-3Galb1-4(Fuca1-3)GlcNAcb1-3GalNAc | Galb1-4(Fuca1-3)GlcNAcb1-3(NeuAca2-6)GalNAc |
| Fuca1-2Galb1-4GlcNAcb1-3(NeuAca2-6)GalNAc | Mana1-6(Xylb1-2)Manb1-4GlcNAcb1-4(Fuca1- |
| | 3)GlcNAcb |
| Mana1-6(Xylb1-2)Manb1-4GlcNAcb1-4(Fuca1- | Mana1-6(Araa1-2)Manb1-4GlcNAcb1-4(Fuca1- |
| 3)GlcNAc | 3)GlcNAc |
| Mana1-6(Ara'a1-2)Manb1-4GlcNAcb1-4(Fuca1- | Gal[6S]b1-4GlcNAcb1-3Galb1-4GlcNAcb1-3GalNAc |
| 3)GlcNAc | |
| Galb1-3GalNAca1-4Galb1-3(GlcNAc[6S]b1- | Mana1-3(Mana1-3(Mana1-6)Mana1-6)Manb1- |
| 6)GalNAc | 4GlcNAc |
| Mana1-3(Mana1-2Mana1-3Mana1-6)Manb1- | Mana1-2Mana1-3(Mana1-3Mana1-6)Manb1- |
| 4GlcNAc | 4GlcNAc |
| Mana1-3(Mana1-3(Mana1-6)Mana1-6)Manb1- | Mana1-3(Mana1-3(Mana1-6)Mana1-6)Manb1- |
| 4GlcNAcb | 4GlcNAc |
| Mana1-2Mana1-2Mana1-3(Mana1-6)Manb1- | Mana1-3(Mana1-2Mana1-2Mana1-6)Manb1- |
| 4GlcNAc | 4GlcNAc |
| Mana1-2Mana1-2Mana1-3(Mana1-6)Manb1- | GalNAcb1-3Gala1-3Gala1-3Gala1-4Galb1-4Glcb |
| 4GlcNAc | |
| GalNAcb1-4GlcNAcb1-3(GalNAcb1-4GlcNAcb1- | GalNAca1-3(Fuca1-2)Galb1-3(NeuGca2-6)GalNAc |
| 6)GalNAc | |
| NeuAca2-3Galb1-3(Galb1-4GlcNAcb1-6)GalNAc | NeuAca2-3Galb1-3(Galb1-4GalNAcb1-6)GalNAc |
| Galb1-3GalNAca1-4Galb1-3(NeuAca2-6)GalNAc | NeuAca2-3Galb1-3GalNAca1-4Galb1-3GalNAc |
| GalNAcb1-3Galb1-4Galb1-3(NeuAca2-6)GalNAc | NeuAca2-3Galb1-4GlcNAcb1-3Galb1-4GlcNAcb |
| Fuca1-2Galb1-4GlcNAcb1-3(NeuGca2-6)GalNAc | NeuAca2-3Galb1-4GlcNAcb1-3Galb1-4GlcNAcb |
| NeuAca2-6Galb1-4GlcNAcb1-4Galb1-4GlcNAcb | NeuAca2-6Galb1-4GlcNAcb1-3Galb1-4GlcNAcb |
| NeuAca2-3Galb1-4GlcNAcb1-3Galb1-4GlcNAcb | NeuAca2-3Galb1-4GlcNAcb1-4Galb1-4GlcNAcb |
| Galb1-4GlcNAcb1-4(NeuAca2-3)Galb1-4GlcNAcb | NeuAca2-3Galb1-4GlcNAcb1-3Galb1-4GlcNAcb |
| NeuAca2-6Galb1-4GlcNAcb1-3Galb1-4GlcNAcb | NeuAca2-6Galb1-4GlcNAcb1-4Galb1-4GlcNAcb |
| NeuAca2-6Galb1-4GlcNAcb1-4Galb1-4GlcNAcb | NeuAca2-3Galb1-3(Galb1-4GlcNAcb1-6)GalNAca1 |
| NeuAca2-3Galb1-4GlcNAcb1-3Galb1-4GlcNAcb | Galb1-3(NeuAca2-3Galb1-4GlcNAcb1-6)GalNAca1 |
| NeuAca2-3Galb1-3(Galb1-4GlcNAcb1-6)GlcNAca | NeuAca2-3Galb1-4GlcNAcb1-3Galb1-3GalNAc |
| NeuAca2-3Galb1-3(Galb1-3/4GlcNAcb1-6)GalNAc | NeuAca2-3Galb1-3GlcNAcb1-3Galb1-3GalNAc |
| Galb1-3(NeuAca2-3Galb1-4GlcNAcb1-6)GalNAc | NeuAca2-6Galb1-4GlcNAcb1-3Galb1-3GalNAc |
| NeuAca2-6Galb1-4GlcNAcb1-3Galb1-4GlcNAcb | GalNAcb1-4(NeuAca2-3)Galb1-4GlcNAcb1-3Gal |
| Galb1-4GlcNAcb1-3Galb1-3(NeuAca2-6)GalNAc | Mana1-6Manb1-4GlcNAcb1-4(Fuca1-3)(Fuca1- |
| | 6)GlcNAcb |
| Fuca1-2Galb1-3(Galb1-4(Fuca1-3)GlcNAcb1- | Fuca1-2Galb1-3(Fuca1-2Galb1-4GlcNAcb1- |
| 6)GalNAc | 6)GalNAc |
| Fuca1-2Galb1-4(Fuca1-3)GlcNAcb1-3Galb1- | Galb1-4(Fuca1-3)GlcNAcb1-3Galb1-4(Fuca1- |
| 3GalNAc | 3)GlcNAc |
| Mana1-3Manb1-4GlcNAcb1-4(Fuca1-3)(Fuca1- | Fuca1-2Galb1-3(Fuca1-2)Galb1-3(GlcNAcb1- |
| 6)GlcNAcb | 6)GalNAc |
| Mana1-6Manb1-4GlcNAcb1-4(Fuca1-3)(Fuca1- | Fuca1-2Galb1-3(Fuca1-2Galb1-3GlcNAcb1- |
| 6)GlcNAc | 6)GalNAc |
| Galb1-4(Fuca1-3)GlcNAcb1-3Galb1-4(Fuca1- | Galb1-4(Fuca1-3)GlcNAcb1-3Galb1-4(Fuca1- |
| 3)GlcNAcb | 3)GlcNAcb |
| Mana1-3(Mana1-6)(Xylb1-2)Manb1-4GlcNAcb1- | Mana1-3(Mana1-6)(Xylb1-2)Manb1-4GlcNAcb1- |
| 4GlcNAc | 4GlcNAcb |
| NeuAca2-8NeuAca2-8NeuAca2-6Glcb | NeuGca2-3Galb1-4GlcNAcb1-3Galb1-3GalNAc |
| Galb1-4GlcNAcb1-3Galb1-3(NeuGca2-6)GalNAc | GalNAcb1-3Galb1-4Galb1-3(NeuGca2-6)GalNAc |
| GalNAca1-3(Fuca1-2)Galb1-3GlcNAcb1-3Galb1- | Mana1-3(Mana1-6)Manb1-4GlcNAcb1-4(Fuca1- |
| 4Glcb | 6)GlcNAcb |
| Mana1-3(Mana1-6)Manb1-4GlcNAcb1-4(Fuca1- | Mana1-3(Mana1-6)Manb1-4GlcNAcb1-4(Fuca1- |
| 6)GlcNAc | 3)GlcNAcb |
| Mana1-3(Mana1-6)Manb1-4GlcNAcb1-4(Fuca1- | GalNAca1-3(Fuca1-2)Galb1-4GlcNAcb1-3Galb1- |
| 3)GlcNAc | 4Glcb |
| GalNAca1-3(Fuca1-2)Galb1-3GlcNAcb1-3Galb1- | Galb1-4(Fuca1-3)GlcNAcb1-4Mana1-3Manb1- |
| 4Glc | 4GlcNAc |
| Galb1-4(Fuca1-3)GlcNAcb1-4Mana1-6Manb1- | Galb1-4(Fuca1-3)GlcNAcb1-2Mana1-6Manb1- |
| 4GlcNAc | 4GlcNAc |
| Galb1-4(Fuca1-3)GlcNAcb1-2Mana1-3Manb1- | Galb1-3(Gala1-3(Fuca1-2)Galb1-4GlcNAcb1- |
| 4GlcNAc | 6)GalNAc |
| Mana1-3Mana1-6Manb1-4GlcNAcb1-4(Fuca1- | Mana1-3(Mana1-2Mana1-6)Mana1-4GlcNAcb1- |
| 3)GlcNAc | 4GlcNAc |
| Mana1-3(Mana1-3Mana1-6)Manb1-4GlcNAcb1- | Mana1-2Mana1-2Mana1-3Manb1-4GlcNAcb1- |
| 4GlcNAcb | 4GlcNAc |
| Mana1-3(Mana1-3Mana1-6)Manb1-4GlcNAcb1- | Mana1-2Mana1-3(Mana1-6)Manb1-4GlcNAcb1- |
| 4GlcNAc | 4GlcNAcb |
| Mana1-3(Mana1-6)Mana1-6Manb1-4GlcNAcb1- | Galb1-4GlcNAcb1-3(Galb1-4GlcNAcb1-6)Mana1- |
| 4GlcNAcb | 2Man |
| Mana1-2Mana1-3(Mana1-6)Manb1-4GlcNAcb1- | Mana1-2Mana1-6Mana1-6Manb1-4GlcNAcb1- |
| 4GlcNAc | 4GlcNAc |
| Mana1-6Mana1-3(Mana1-6)Manb1-4GlcNAcb1- | Galb1-4(Galb1-4GlcNAcb1-3)(Galb1-4GlcNAcb1- |
| 4GlcNAc | 6)Glcb1-1 |
| Mana1-2Mana1-2Mana1-3Manb1-4GlcNAcb1- | Galb1-4GlcNAcb1-3(Galb1-4GlcNAcb1-6)Galb1-4Glc |
| 4GlcNAcb | |
| Galb1-6Galb1-4GlcNAcb1-2Mana1-6Manb1-4GlcNAc | GlcNAcb1-2Mana1-3(Galb1-4GlcNAcb1-2Mana1- |
| | 6)Manb1-4 |
| Galb1-2Mana1-3(Mana1-6)Manb1-4GlcNAcb1- | Mana1-3(Mana1-6Mana1-6)Manb1-4GlcNAcb1- |
| 4GlcNAcb | 4GlcNAc |
| Mana1-3(Mana1-6Mana1-6)Manb1-4GlcNAcb1- | Galb1-3GlcNAcb1-3Galb1-3GlcNAcb1-3Galb1-4Glcb |
| 4GlcNAcb | |
| Mana1-3(Mana1-6)Mana1-6Manb1-4GlcNAcb1- | Mana1-2Mana1-3Mana1-6Manb1-4GlcNAcb1- |
| 4GlcNAc | 4GlcNAc |
| Mana1-3(Galb1-4GlcNAcb1-2Mana1-6)Manb1- | Galb1-4GlcNAcb1-2Mana1-3(Mana1-6)Manb1- |
| 4GlcNAc | 4GlcNAc |
| Fuca1-2Galb1-3(Fuca1-2)(Gal[3S]b1-4)Galb1- | GlcNAcb1-3(NeuAca2-3Galb1-4GlcNAcb1-6)GalNAc |
| 3GalNAc | |
| Fuca1-4GlcNAcb1-3Galb1-3(Fuca1-4GlcNAcb1- | Fuca1-4GlcNAcb1-6Galb1-3(Fuca1-4GlcNAcb1- |
| 6)GalNAc | 6)GalNAc |
| GlcNAcb1-3(Fuca1-2Galb1-4(Fuca1-3)GlcNAcb1- | Neua1-3Galb1-4GlcNAcb1-2Mana1-3Manb1- |
| 6)GalNAc | 4GlcNAc |
| GalNAca1-4Galb1-3(Fuca1-2Galb1-4GlcNAcb1- | GlcNAcb1-4(Mana1-3)Manb1-4GlcNAcb1-4(Fuca1- |
| 6)GalNAca | 6)GlcNAc |
| GlcNAcb1-2Mana1-3Manb1-4GlcNAcb1-4(Fuca1- | Fuca1-2Galb1-3(GlcNAca1-4Galb1-4GlcNAcb1- |
| 6)GlcNAc | 6)GalNAc |
| GalNAca1-3(Fuca1-2)Galb1-3(Galb1-4GlcNAcb1- | Fuca1-2Galb1-3GlcNAcb1-3Galb1-3(GlcNAcb1- |
| 6GalNAc | 6)GalNAc |
| GalNAca1-3(Fuca1-2)Galb1-3GlcNAcb1-3Galb1- | GlcNAcb1-2Mana1-6Manb1-4GlcNAcb1-4(Fuca1- |
| 3GalNAc | 3)GlcNAc |
| Fuca1-4GlcNAcb1-3Galb1-3(Galb1-4GlcNAcb1- | GlcNAcb1-2Mana1-6Manb1-4GlcNAcb1-4(Fuca1- |
| 6)GalNAc | 6)GlcNAc |
| Fuca1-2Galb1-4GlcNAcb1-3(Galb1-4GlcNAcb1- | Galb1-4GlcNAcb1-3(Fuca1-2Galb1-4GlcNAcb1- |
| 6)GalNAc | 6)GalNAc |
| Fuca1-2Galb1-3GlcNAcb1-3(Galb1-4GlcNAcb1- | GlcNAca1-4Galb1-3(Fuca1-2Galb1-4GlcNAcb1- |
| 6)GalNAc | 6)GalNAc |
| Fuca1-2Galb1-3/4GlcNAcb1-3Galb1-3(GlcNAcb1- | Fuca1-4GlcNAcb1-6Galb1-3(Galb1-4GlcNAcb1- |
| 6)GalNAc | 6)GalNAc |
| Fuca1-3(Gal[3S]b1-4)GlcNAcb1-3(NeuAca2- | GlcAb1-3Galb1-3(GlcNAcb1-3(Fuca1-4)GlcNAcb1- |
| 6)GalNAc | 6)GalNAc |
| GlcNAcb1-2Mana1-3(Mana1-6)Manb1-4GlcNAcb1- | Galb1-3GalNAca1-4Galb1-3GalNAca1-4Galb1- |
| 4GlcNAc | 3GalNAc |
| Galb1-4GlcNAcb1-6Galb1-3(Galb1-4GlcNAcb1- | Galb1-3GlcNAcb1-3Galb1-3GlcNAcb1-3Galb1- |
| 6)GalNAc | 3GalNAc |
| Galb1-4GlcNAcb1-3Galb1-4GlcNAcb1-3Galb1- | Galb1-4GlcNAcb1-3Galb1-4GlcNAcb1-3Galb1- |
| 4GlcNAcb | 4GlcNAcb |
| Mana1-3(GlcNAcb1-2(GlcNAcb1-6)Mana1-6)Manb1- | Galb1-4GlcNAcb1-3(Galb1-4GlcNAcb1-6)Manb1- |
| 4GlcNAc | 4GlcNAc |
| GlcNAcb1-4(Mana1-3)(Mana1-6)Manb1-4GlcNAcb1- | GlcNAcb1-4(GlcNAcb1-2Mana1-3)(GlcNAcb1- |
| 4GlcNAc | 2Mana1-6)Man |
| Galb1-3GlcNAcb1-3(Galb1-4GlcNAcb1-6)Galb1- | Galb1-4GlcNAcb1-3Galb1-4GlcNAcb1-3Galb1- |
| 3GalNAc | 4GlcNAcb |
| Galb1-3GlcNAcb1-3Galb1-3(Galb1-4GlcNAcb1- | Galb1-4GlcNAcb1-3Galb1-4GlcNAcb1-3Galb1- |
| 6)GalNAc | 3GalNAc |
| GlcNAcb1-4Mana1-3(Mana1-6)Manb1-4GlcNAcb1- | Galb1-3(Galb1-4GlcNAcb1-3Galb1-4GlcNAcb1- |
| 4GlcNAc | 6)GalNAc |
| Galb1-4GlcNAcb1-3Galb1-3(Galb1-4GlcNAcb1- | GlcNAcb1-2Mana1-3(GlcNAcb1-2Mana1-6)Manb1- |
| 6)GalNAc | 4GlcNAc |
| Galb1-4GlcNAcb1-2Mana1-6Manb1-4GlcNAcb1- | Mana1-3(GlcNAcb1-2Mana1-6)Manb1-4GlcNAcb1- |
| 4GlcNAc | 4GlcNAc |
| GlcNAcb1-4(Mana1-3)(Mana1-6)Manb1-4GlcNAcb1- | Galb1-3(Galb1-3GlcNAcb1-3Galb1-4GlcNAcb1- |
| 4GlcNAcb | 6)GalNAc |
| Mana1-3(GlcNAcb1-6Mana1-6)Manb1-4GlcNAcb1- | NeuAca2-3Galb1-3(Galb1-4GlcNAc[6S]b1-6)GalNAc |
| 4GlcNAc | |
| Galb1-3(Fuca1-2)Galb1-3(Fuca1-3GlcNAc[3S]b1- | Galb1-3Galb1-3(NeuAca2-8NeuAca2-6)GalNAca |
| 6)GalNAc | |
| GalNAcb1-4(NeuAca2-8NeuAca2-3)Galb1-4Glcb | GalNAcb1-4(NeuAca2-8NeuAca2-3)Galb1-4Glc |
| GalNAcb1-4(NeuAca2-8NeuAca2-3)Galb1-4Glcb | GalNAcb1-4(NeuAca2-8NeuAca2-3)Galb1-4Glc |
| GalNAcb1-4(NeuAca2-8NeuAca2-3)Galb1-4Glc | Fuca1-2Galb1-4(Fuca1-3)GlcNAcb1-3(Kdna1- |
| | 6GalNAc |
| Galb1-3(Fuca1-2)Galb1-3(NeuAca2-6)(Fuca1- | Fuca1-2Galb1-3(Fuca1-2)Galb1-3(NeuAca2- |
| 2)GalNAc | 6)GalNAc |
| GalNAca1-3(Fuca1-2)Galb1-4GlcNAcb1- | GalNAca1-3(Fuca1-2)Galb1-3(GlcNAcb1- |
| 3(GlcNAcb1-6)GalNAc | 3GlcNAcb1-6)GalNAc |
| NeuAca2-3Galb1-4(Fuca1-3)GlcNAcb1-3Galb1-4Glc | Gala1-3Gala1-3Gala1-3Gala1-3Gala1-4Galb1-4Glcb |
| GlcNAcb1-2(GlcNAcb1-4)Mana1-3Manb1- | GlcNAca1-4Galb1-3(GlcNAca1-4Galb1-4GlcNAcb1- |
| 4GlcNAcb1-4GlcNAc | 6)GalNAc |
| Galb1-4GlcNAcb1-3(GlcNAcb1-6)Galb1-4GlcNAcb1- | GlcNAcb1-4Galb1-3(GlcNAca1-4Galb1-4GlcNAcb1- |
| 3GalNAc | 6)GalNAc |
| GalNAca1-4Galb1-3(GalNAca1-4Galb1-4GlcNAcb1- | GlcNAcb1-4(GlcNAcb1-2Mana1-3)Manb1- |
| 6)GalNAca | 4GlcNAcb1-4GlcNAc |
| GalNAcb1-4GlcNAcb1-2Mana1-3Manb1-4GlcNAcb1- | GlcNAcb1-3Galb1-3GlcNAcb1-3Galb1-3GlcNAcb1- |
| 4GlcNAc | 3GalNAc |
| Galb1-4Galb1-3(NeuGca2-8NeuGca2-6)GalNAc | Gala1-3(Fuca1-2)Galb1-4(Fuca1-3)GlcNAcb1- |
| | 3Galb1-4Glcb |
| NeuAca2-6Galb1-4GlcNAcb1-3(NeuAca2-6)GalNAc | GalNAcb1-4(NeuAca2-3)Galb1-3(NeuAca2- |
| | 6)GalNAc |
| NeuAca2-3Galb1-4GlcNAcb1-3(NeuAca2-6)GalNAc | Galb1-4(NeuAca2-6)GlcNAcb1-3(NeuAca2-6)GalNAc |
| GalNAca1-4(NeuAca2-3)Galb1-3(NeuAca2- | Fuca1-2Galb1-4(Fuca1-3)GlcNAcb1-3(NeuAca2- |
| 6)GalNAc | 6)GalNAc |
| GalNAcb1-4GlcNAcb1-3(GalNAcb1-4(Fuca1- | NeuAca2-3Galb1-3(Fuca1-2Galb1-4GlcNAcb1- |
| 3)GlcNAcb1-6)GalNAc | 6)GalNAc |
| Fuca1-2Galb1-4(Fuca1-3)GlcNAcb1-3(NeuGca2- | Kdna1-3Galb1-3(GalNAcb1-4(Fuca1-3)GlcNAcb1- |
| 6)GalNAc | 6)GalNAc |
| Fuca1-2Galb1-3GalNAca1-4Galb1-3(NeuAca2- | Fuca1-2Galb1-3GalNAca1-4(NeuAca2-3)Galb1- |
| 6)GalNAc | 3GalNAc |
| NeuAca2-3Galb1-3(Galb1-3(Fuca1-4)GlcNAcb1- | NeuAca2-3Galb1-3(Galb1-4(Fuca1-3)GlcNAcb1- |
| 6)GalNAc | 6)GalNAca |
| Galb1-3(NeuAca2-3Galb1-4(Fuca1-3)GlcNAcb1- | Galb1-3(NeuAca2-3Galb1-3(Fuca1-4)GlcNAcb1- |
| 6)GalNAca | 6)GalNAc |
| NeuAca2-3Galb1-4(Fuca1-3)GlcNAcb1-3Galb1- | NeuAca2-3Galb1-3(Fuca1-4)GlcNAcb1-3Galb1- |
| 4GlcNAcb | 3GalNAc |
| Fuca1-2Galb1-3(NeuAca2-3Galb1-4GlcNAcb1- | NeuAca2-6Galb1-4GlcNAcb1-3Galb1-4(Fuca1- |
| 6)GalNAc | 3)GlcNAc |
| Galb1-3(NeuAca2-3Galb1-4(Fuca1-3)GlcNAcb1- | Galb1-4(Fuca1-3)GlcNAcb1-3Galb1-3(NeuAca2- |
| 6)GalNAc | 6)GalNAc |
| NeuAca2-3Galb1-4(Fuca1-3)GlcNAcb1-3Galb1- | NeuAca2-3Galb1-3(Galb1-4(Fuca1-3)GlcNAcb1- |
| 3GalNAc | 6)GalNAc |
| Fuca1-2Galb1-3(Fuca1-2Galb1-4(Fuca1- | Fuca1-3Galb1-4(Fuca1-3)GlcNAcb1-3Galb1- |
| 3)GlcNAcb1-6)GalNAc | 4(Fuca1-3)GlcNAcb |
| Fuca1-2Galb1-4(Fuca1-3)GlcNAcb1-3Galb1- | Fuca1-2Galb1-4(Fuca1-3)GlcNAcb1-3Galb1- |
| 4(Fuca1-3)GlcNAcb | 4(Fuca1-3)GlcNAcb |
| Fuca1-2Galb1-4(Fuca1-3)GlcNAcb1-3Galb1- | GlcNAcb1-2Mana1-3(Man[6S]a1-6)Manb1- |
| 4(Fuca1-3)GlcNAcb | 4GlcNAcb1-4GlcNAc |
| Galb1-4GlcNAc[6S]b1-3Galb1-4GlcNAcb1-3Galb1- | Galb1-4GlcNAc[6S]b1-3Galb1-4GlcNAcb1-3Galb1- |
| 3GalNAc | 3GlcNAc |
| Mana1-3(Mana1-3(Mana1-2Mana1-6)Mana1- | Mana1-2Mana1-2Mana1-3(Mana1-3Mana1- |
| 6)Manb1-4GlcNAc | 6)Manb1-4GlcNAc |
| Mana1-2Mana1-3(Mana1-3(Mana1-6)Mana1- | Mana1-2Mana1-3(Mana1-2Mana1-3Mana1- |
| 6)Manb1-4GlcNAc | 6)Manb1-4GlcNAc |
| Mana1-3(Mana1-3(Mana1-6)Mana1-6)Manb1- | Mana1-3(Mana1-2Mana1-3(Mana1-6)Mana1- |
| 4GlcNAcb1-4Glc | 6)Manb1-4GlcNAc |
| Mana1-2Mana1-3(Mana1-2Mana1-2Mana1- | Mana1-3(Mana1-3(Mana1-6Mana1-6)Mana1- |
| 6)Manb1-4GlcNAc | 6)Manb1-4GlcNAc |
| Mana1-3(Mana1-3(Mana1-2Mana1-6)Manb1- | Mana1-3(Mana1-3(Mana1-6)Mana1-6)Manb1- |
| 6)Manb1-4GlcNAc | 4GlcNAcb1-4Glcb |
| Mana1-6Mana1-3(Mana1-3(Mana1-6)Mana1- | Glca1-3Mana1-3(Mana1-3(Mana1-6)Mana1- |
| 6)Manb1-4GlcNAc | 6)Manb1-4GlcNAc |
| NeuAca2-3Galb1-4GlcNAcb1-2Mana1-6Manb1- | NeuAca2-6Galb1-4GlcNAcb1-2Mana1-6Manb1- |
| 4GlcNAc | 4GlcNAc |
| NeuAca2-3Galb1-4GlcNAcb1-2Mana1-3Manb1- | NeuAca2-3Galb1-4GlcNAcb1-2(Galb1-4GlcNAcb1- |
| 4GlcNAc | 6)Man |
| NeuAca2-6Galb1-4GlcNAcb1-2Mana1-3Manb1- | NeuAca2-3Galb1-3(Gala1-3Galb1-4GlcNAcb1- |
| 4GlcNAc | 6)GalNAc |
| Galb1-4GlcNAcb1-2(NeuAca2-3Galb1-4GlcNAcb1- | NeuAca2-3Galb1-3GlcNAcb1-2Mana1-3Manb1- |
| 6)Man | 4GlcNAc |
| NeuAca2-3Galb1-3(Gala1-3Galb1-4GlcNAcb1- | |
| 6)GalNAca1-1 | |
| NeuAca2-3Galb1-3(Gala1-3Galb1-4GalNAcb1- | Fuca1-3GalNAcb1-3Galb1-4Galb1-3(NeuGca2- |
| 6)GalNAc | 6)GalNAc |
| Fuca1-3GlcNAcb1-2Mana1-3(Fuca1-3GlcNAcb1- | GalNAca1-3(Fuca1-2)Galb1-4(Fuca1-3)GlcNAcb1- |
| 2Mana1-6)Man | 3Galb1-4Glcb |
| Mana1-3Mana1-6Manb1-4GlcNAcb1-4(Fuca1- | GalNAca1-3(Fuca1-2)Galb1-3(Fuca1-4)GlcNAcb1- |
| 3)(Fuca1-6)GlcNAc | 3Galb1-4Glc |
| Mana1-3(Mana1-6)Manb1-4GlcNAcb1-4(Fuca1- | Mana1-3(Mana1-6)Manb1-4GlcNAcb1-4(Fuca1- |
| 3)(Fuca1-6)GlcNAcb | 3)(Fuca1-6)GlcNAc |
| GalNAca1-3(Fuca1-2)Galb1-3(Fuca1-4)GlcNAcb1- | Gala1-4(Fuca1-2)Galb1-3(Fuca1-2)Galb1- |
| 3Galb1-4Glcb | 3(GlcNAcb1-6)GalNAc |
| Mana1-3(Mana1-6)Manb1-4GlcNAcb1-4(Fuca1- | NeuAca2-8NeuAca2-8NeuAca2-3Galb1-4Glcb |
| 3)(Fuca1-6)GlcNAc | |
| NeuAca2-8NeuAca2-8NeuAca2-3Gala1-4Glcb | NeuAca2-8NeuAca2-8NeuAca2-3Galb1-4Glcb |
| NeuAca2-8NeuAca2-8NeuAca2-3Galb1-4Glcb | Mana1-3(Mana1-3Mana1-6)Manb1-4GlcNAcb1- |
| | 4(Fuca1-6)GlcNAc |
| Mana1-3Mana1-3(Mana1-6)Mana1-4GlcNAcb1- | Mana1-3(Mana1-6)Mana1-3Manb1-4GlcNAcb1- |
| 4(Fuca1-6)GlcNAc | 4(Fuca1-6)GlcNAc |
| Mana1-3(Mana1-3Mana1-6)Manb1-4GlcNAcb1- | Fuca1-2Galb1-4GlcNAcb1-2Mana1-3(Mana1- |
| 4(Fuca1-6)GlcNAcb | 6)Manb1-4GlcNAc |
| Galb1-3GlcNAcb1-3Galb1-3(Fuca1-4)GlcNAcb1- | Mana1-3(Mana1-6Mana1-6)Manb1-4GlcNAcb1- |
| 3Galb1-4Glcb | 4(Fuca1-6)GlcNAc |
| GalNAca1-3(Fuca1-2)Galb1-3GalNAcb1-3Gala1- | GlcNAcb1-3(NeuAca2-3Galb1-4(Fuca1-3)GlcNAcb1- |
| 4Galb1-4Glcb | 6)GalNAc |
| GalNAca1-3(Fuca1-2)Galb1-4GlcNAcb1-3(NeuAca2- | Mana1-2Mana1-2Mana1-3(Mana1-6)Manb1- |
| 6)GalNAc | 4GlcNAcb1-4GlcNAc |
| Mana1-3(Mana1-3(Mana1-6)Mana1-6)Manab1- | Mana1-3(Mana1-3(Mana1-6)Mana1-6)Manb1- |
| 4GlcNAcb1-4GlcNAc | 4GlcNAcb1-4GlcNAcb |
| Galb1-4GlcNAcb1-2Mana1-3(Mana1-3Mana1- | Mana1-2Mana1-3(Mana1-6Mana1-6)Manb1- |
| 6)Manb1-4GlcNAc | 4GlcNAcb1-4GlcNAc |
| Mana1-2Mana1-3(Mana1-3Mana1-6)Manab1- | Galb1-4GlcNAcb1-2Mana1-3(Galb1-4GlcNAcb1- |
| 4GlcNAcb1-4GlcNAc | 2Mana1-6)Man |
| Mana1-2Mana1-2Mana1-3(Mana1-6)Manab1- | Mana1-3(Mana1-3(Mana1-6)Mana1-6)Manb1- |
| 4GlcNAcb1-4GlcNAcb | 4GlcNAcb1-4GlcNAc |
| | Galb1-4Mana1-3(Galb1-4Mana1-6)Manb1- |
| | 4GlcNAcb1-4GlcNAcb |
| Mana1-3(Mana1-6)Mana1-3(Mana1-6)Manb1- | GlcNAcb1-4(Mana1-3)(Mana1-3(Mana1-6)Mana1- |
| 4GlcNAcb1-4GlcNAcb | 6)Manb1-4GlcNAc |
| Mana1-3(Mana1-6)Mana1-3(Mana1-6)Manb1- | Mana1-3(Mana1-3(Mana1-6)Mana1-6)Manb1- |
| 4GlcNAcb1-4GlcNAc | 4GlcNAcb1-4GlcNAcbb |
| Mana1-2(Mana1-3(Mana1-6)Mana1-6)Manb1- | Mana1-3(Mana1-3(Mana1-6)Mana1-6)Manb1- |
| 4GlcNAcb1-4GlcNAcb | 4GlcNAcb1-4GlcNAc |
| GlcNAcb1-3Mana1-3(Mana1-3(Mana1-6)Mana1- | GlcNAcb1-2Mana1-3(Mana1-3(Mana1-6)Mana1- |
| 6)Manb1-4GlcNAc | 6)Manb1-4GlcNAc |
| Mana1-2Mana1-3(Mana1-6Mana1-6)Manb1- | Mana1-3(Mana1-2Mana1-3Mana1-6)Manb1- |
| 4GlcNAcb1-4GlcNAcb | 4GlcNAcb1-4GlcNAc |
| Mana1-6Mana1-3Mana1-6Mana1-3Manb1- | Mana1-3Glca1-6(Mana1-2Mana1-3)Glcb1- |
| 4GlcNAcb1-4GlcNAc | 4GlcNAcb1-4GlcNAc |
| Glca1-3Mana1-2Mana1-2Mana1-3Manb1- | Mana1-3(Mana1-2Mana1-6Mana1-6)Manb1- |
| 4GlcNAcb1-4GlcNAc | 4GlcNAcb1-4GlcNAc |
| Mana1-2Mana1-3(Mana1-6)Mana1-6Manb1- | Mana1-3(Mana1-2Mana1-6)Mana1-6Manb1- |
| 4GlcNAcb1-4GlcNAc | 4GlcNAcb1-4GlcNAc |
| Mana1-2Mana1-3(Mana1-3Mana1-6)Manb1- | GalNAcb1-4(NeuAca2-3)GalNAcb1-4Galb1-4Galb1- |
| 4GlcNAcb1-4GlcNAcb | 3GalNAca |
| Galb1-3GlcNAcb1-3(NeuAca2-3Galb1-4GlcNAcb1- | Galb1-4GlcNAcb1-3Galb1-4GlcNAcb1-3(NeuAca2- |
| 6)GalNAc | 6)GalNAc |
| NeuAca2-3Galb1-4GlcNAcb1-3(Galb1-4GlcNAcb1- | Galb1-4GlcNAcb1-3(NeuAca2-3Galb1-4GlcNAcb1- |
| 6)GalNAc | 6)GalNAc |
| Galb1-3(GalNAcb1-4(NeuAca2-3)Galb1-4GlcNAcb1- | GalNAca1-3Galb1-3(NeuAca2-3Galb1-4GlcNAcb1- |
| 6)GalNAc | 6)GalNAc |
| Galb1-3(NeuAca2-3Galb1-4GlcNAcb1-6)GalNAca1- | GalNAcb1-4(NeuAca2-3)GalNAcb1-3Galb1-4Galb1- |
| 3GalNAc | 3GalNAc |
| GalNAca1-3(Fuca1-2)Galb1-4GlcNAcb1-3(NeuGca2- | GalNAcb1-4(NeuAca2-3)Galb1-3GalNAca1-4Galb1- |
| 6)GalNAc | 3GalNAc |
| Fuca1-2Galb1-4/3GlcNAcb1-3(Fuca1-2Galb1- | Fuca1-2Galb1-3(GalNAca1-3(Fuca1-2)Galb1- |
| 4/3GlcNAcb1-6)GalNAc | 4GlcNAcb1-6GalNAc |
| Fuca1-2Galb1-3(Fuca1-4)GlcNAcb1-3Galb1- | Fuca1-2Galb1-3/4GlcNAcb1-3(Fuca1-2Galb1- |
| 3(GlcNAcb1-6)GalNAc | 3/4GlcNAcb1-6)GalNAc |
| Galb1-4GlcNAcb1-3(Fuca1-2Galb1-4(Fuca1- | Fuca1-3GlcNAcb1-2Mana1-6Manb1-4GlcNAcb1- |
| 3)GlcNAcb1-6)GalNAc | 4(Fuca1-6)GlcNAcb |
| Fuca1-3GlcNAcb1-2Mana1-3Manb1-4GlcNAcb1- | Fuca1-2Galb1-3GlcNAcb1-3(Fuca1-2Galb1- |
| 4(Fuca1-6)GlcNAcb | 4GlcNAcb1-6)GalNAc |
| Neua1-6Galb1-4GlcNAcb1-2Mana1-3(Mana1- | NeuAca2-3Galb1-3(NeuAca2-8NeuAca2-6)GalNAca |
| 6)Manb1-4GlcNAc | |
| NeuAca2-8NeuAca2-3Galb1-3(NeuAca2-6)GalNAc | NeuAca2-3Galb1-3(NeuAca2-8NeuAca2-6)GalNAc |
| GalNAcb1-4(NeuGca2-3)GalNAcb1-3Galb1-4Galb1- | GalNAcb1-4(NeuGca2-3)GalNAcb1-4Galb1-3Galb1- |
| 3GalNAc | 3GalNAca |
| GlcNAcb1-2Mana1-3(Mana1-6)Manb1-4GlcNAcb1- | Galb1-4GlcNAcb1-2Mana1-3Manb1-4GlcNAcb1- |
| 4(Fuca1-6)GlcNAc | 4(Fuca1-6)GlcNAcb |
| Mana1-3(GlcNAcb1-2Mana1-6)Manb1-4GlcNAcb1- | Galb1-4GlcNAcb1-4Mana1-3Manb1-4GlcNAcb1- |
| 4(Fuca1-6)GlcNAcb | 4(Fuca1-6)GlcNAcb |
| Mana1-3(GlcNAcb1-6Mana1-6)Manb1-4GlcNAcb1- | Mana1-3(GlcNAcb1-2Mana1-6)Manb1-4GlcNAcb1- |
| 4(Fuca1-6)GlcNAcb | 4(Fuca1-6)GlcNAc |
| GlcNAcb1-2Mana1-3(Man[6PN]a1-6)Manb1- | GlcNAc[6PN]b1-2Mana1-3(Man[6PN]a1-6)Manb1- |
| 4GlcNAcb1-4(Fuca1-6)GlcNAc | 4GlcNAcb1-4(Fuca1-6)GlcNAc |
| GlcNAcb1-2Mana1-3(Mana1-6)Manb1-4GlcNAcb1- | Galb1-3(Fuca1-2Galb1-3GlcNAcb1-3Galb1- |
| 4(Fuca1-6)GlcNAcb | 4GlcNAcb1-6)GalNAc |
| Galb1-4GlcNAcb1-4Mana1-3Manb1-4GlcNAcb1- | Fuca1-2Galb1-3GlcNAcb1-3Galb1-3(Galb1- |
| 4(Fuca1-6)GlcNAc | 4GlcNAcb1-6)GalNAc |
| Galb1-4GlcNAcb1-6Mana1-6Manb1-4GlcNAcb1- | GlcNAcb1-4(Mana1-3)(Mana1-6)Manb1-4GlcNAcb1- |
| 4(Fuca1-6)GlcNAcb | 4(Fuca1-6)GlcNAc |
| Galb1-3(Galb1-3GlcNAcb1-3Galb1-4(Fuca1- | |
| 3)GlcNAcb1-6)GalNAc | |
| Galb1-4GlcNAcb1-4GlcNAcb1-2Mana1-6Manb1- | GlcNAcb1-4Mana1-3(Mana1-6)Manb1-4GlcNAcb1- |
| 4(Fuca1-6)GlcNAcb | 4(Fuca1-6)GlcNAc |
| Galb1-4(Fuca1-3)GlcNAcb1-3Galb1-3(Galb1- | GlcNAcb1-4Mana1-3(Mana1-6)Manab1-4GlcNAcb1- |
| 4GlcNAcb1-6)GalNAc | 4(Fuca1-6)GlcNAcb |
| Galb1-4GlcNAcb1-2Mana1-6Manb1-4GlcNAcb1- | GlcNAcb1-2(Mana1-3)(Mana1-6)Manb1-4GlcNAcb1- |
| 4(Fuca1-6)GlcNAcb | 4(Fuca1-6)GlcNAcb |
| GlcNAcb1-2Mana1-3(Mana1-6)Manb1-4GlcNAcb1- | GlcNAcb1-2Mana1-3(Mana1-6)Manb1-4GlcNAcb1- |
| 4(Fuca1-3)GlcNAc | 4(Fuca1-6)GlcNAc |
| GlcNAcb1-2Mana1-3(Mana1-6)Manb1-4GlcNAcb1- | GalNAca1-3(Fuca1-2)Galb1-3GlcNAcb1-3Galb1- |
| 4(Fuca1-6)GlcNAc | 3(Galb1-6)GalNAc |
| Galb1-4GlcNAcb1-2Mana1-6Manb1-4GlcNAcb1- | Mana1-3(GlcNAcb1-6Mana1-6)Manb1-4GlcNAcb1- |
| 4(Fuca1-6)GlcNAc | 4(Fuca1-6)GlcNAc |
| GlcNAcb1-2Mana1-2(Mana1-6)Manb1-4GlcNAcb1- | Fuca1-2Galb1-4GlcNAcb1-3Galb1-4GlcNAcb1- |
| 4(Fuca1-6)GlcNAc | 3Galb1-4GlcNAcb |
| Mana1-3(GlcNAcb1-2Mana1-6)Manb1-4GlcNAcb1- | Fuca1-2Galb1-4GlcNAcb1-3(Fuca1-3Fuca1-4Kdna1- |
| 4(Fuca1-6)GlcNAc | 6)GalNAc |
| Galb1-4GlcNAcb1-4Mana1-3(Mana1-6)Manb1- | Galb1-4GlcNAcb1-2Mana1-3(Mana1-6)Manb1- |
| 4GlcNAcb1-4GlcNAc | 4GlcNAcb1-4GlcNAc |
| Galb1-4GlcNAcb1-2(Galb1-4GlcNAcb1-4)Mana1- | Mana1-3(Galb1-4GlcNAcb1-6Mana1-6)Manb1- |
| 3Manb1-4GlcNAc | 4GlcNAcb1-4GlcNAcb |
| GlcNAcb1-2Mana1-3(Mana1-3Mana1-6)Manb1- | Galb1-4GlcNAcb1-2Mana1-3(Mana1-6)Manb1- |
| 4GlcNAcb1-4GlcNAcb | 4GlcNAcb1-4GlcNAcb |
| Mana1-3(Galb1-4GlcNAcb1-2Mana1-6)Manb1- | Galb1-4GlcNAcb1-2Mana1-3(Mana1-6)Manb1- |
| 4GlcNAcb1-4GlcNAcb | 4GlcNAcb1-4GlcNAc |
| Galb1-4GlcNAcb1-4Mana1-3(Mana1-6)Manb1- | Mana1-3(Galb1-4GlcNAcb1-4Mana1-6)Manb1- |
| 4GlcNAcb1-4GlcNAc | 4GlcNAcb1-4GlcNAc |
| Mana1-3(Galb1-4GlcNAcb1-2Mana1-6)Manb1- | GlcNAcb1-2Mana1-3(Mana1-3Mana1-6)Manb1- |
| 4GlcNAcb1-4GlcNAc | 4GlcNAcb1-4GlcNAc |
| Mana1-3(Galb1-4GlcNAcb1-2Mana1-6)Manb1- | Galb1-4GlcNAcb1-4Mana1-3(Mana1-6)Manb1- |
| 4GlcNAcb1-4GlcNAc | 4GlcNAcb1-4GlcNAcb |
| GlcNAcb1-2Mana1-3(Mana1-3/6Mana1-6)Manb1- | GlcNAcb1-2Mana1-3(Galb1-4GlcNAcb1-2Mana1- |
| 4GlcNAcb1-4GlcNAcb | 6)Manb1-4GlcNAc |
| | GalNAca1-3GalNAcb1-3(Galb1-3GalNAcb1-4)Gala1- |
| | 4Galb1-4Glcb |
| GlcNAcb1-2Mana1-3(Mana1-6Mana1-6)Manb1- | Galb1-3GlcNAcb1-4Mana1-3(Mana1-6)Manb1- |
| 4GlcNAcb1-4GlcNAcb | 4GlcNAcb1-4GlcNAc |
| GlcNAcb1-2Mana1-3(Mana1-2Mana1-6)Manb1- | GlcNAcb1-2Mana1-3(Mana1-6Mana1-6)Manb1- |
| 4GlcNAcb1-4GlcNAcb | 4GlcNAcb1-4GlcNAc |
| Galb1-3Galb1-4GlcNAcb1-3Galb1-4GlcNAcb1- | Galb1-3GlcNAcb1-2Mana1-3(Mana1-6)Manb1- |
| 3Galb1-3GalNAc | 4GlcNAcb1-4GlcNAc |
| GlcNAcb1-2Mana1-3(Mana1-3Mana1-6)Manb1- | Galb1-4GlcNAcb1-2Mana1-3(GlcNAcb1-2Mana1- |
| 4GlcNAcb1-4GlcNAc | 6)Manb1-4GlcNAc |
| Mana1-3(Galb1-4GlcNAcb1-4Mana1-6)Manb1- | Galb1-3GalNAcb1-4(NeuAca2-8NeuAca2-3)Galb1- |
| 4GlcNAcb1-4GlcNAcb | 4Glcb |
| NeuAca2-3Galb1-3GalNAcb1-4(NeuAca2-3)Galb1- | NeuAca2-4Galb1-3(NeuAca2-6)GlcNAcb1-3Galb1- |
| 4Glcb | 4Glc |
| NeuAca2-3Galb1-3(NeuAca2-6)GlcNAcb1-3Galb1- | NeuAca2-8NeuAca2-3Galb1-3GalNAcb1-4Galb1- |
| 4Glc | 4Glcb |
| Fuca1-4Kdna1-3Galb1-3(Fuca1-2Galb1-4GlcNAcb1- | Gala1-4(Fuca1-2)Galb1-4GlcNAcb1-3(Fuca1- |
| 6)GalNAc | 4Kdna1-6)GalNAc |
| Fuca1-4Kdna1-3Galb1-3(Fuca1-2Galb1-4GlcNAcb1- | GalNAca1-3(Fuca1-2)Galb1-4GlcNAca1-3Galb1- |
| 6)GlcNAcb | 4GlcNAcb1-3GalNAc |
| GalNAcb1-4GlcNAcb1-2Mana1-3Manb1-4GlcNAcb1- | GalNAca1-3(Fuca1-2)Galb1-4GlcNAcb1-3Galb1- |
| 4(Fuca1-6)GlcNAc | 4GlcNAcb1-3GalNAc |
| GlcNAcb1-4(GlcNAcb1-2Mana1-3)Manb1- | Galb1-3(NeuGca2-8NeuGca2-8NeuGca2-6)GalNAc |
| 4GlcNAcb1-4(Fuca1-6)GlcNAc | |
| NeuAca2-3Galb1-3GalNAcb1-4(NeuGca2-3)Galb1- | Galb1-3GalNAcb1-4(NeuAca2-8NeuGca2-3)Galb1- |
| 4Glcb | 4Glcb |
| NeuGca2-3Galb1-3GalNAcb1-4(NeuAca2-3)Galb1- | NeuAca2-3Galb1-4(Fuca1-3)GlcNAcb1-3(NeuAca2- |
| 4Glcb | 6)GalNAc |
| GalNAcb1-4(Fuca1-3)GlcNAcb1-3(Fuca1-2Fuca1- | GlcNAcb1-2Mana1-3(GlcNAcb1-2Mana1-6)Manb1- |
| 4Kdna1-6)GalNAc | 4GlcNAcb1-4GlcNAc |
| GlcNAcb1-2Mana1-3(GlcNAcb1-2Mana1-6)Manb1- | GlcNAcb1-2Mana1-3(GlcNAcb1-2Mana1-6)Manb1- |
| 4GlcNAcb1-4GlcNAc | 4GlcNAcb1-4GlcNAcb |
| | GlcNAcb1-4(Mana1-3)(GlcNAcb1-2Mana1-6)Manb1- |
| | 4GlcNAcb1-4GlcNAc |
| GlcNAcb1-4Mana1-3(GlcNAcb1-2(GlcNAcb1- | Galb1-4GlcNAcb1-3(GlcNAcb1-6)Galb1-4GlcNAcb1- |
| 6)Mana1-6)Manb1-4GlcNAc | 3Galb1-3GalNAc |
| GlcNAcb1-2Mana1-3(GlcNAcb1-2Mana1-6)Manb1- | GlcNAcb1-4Mana1-3(GlcNAcb1-4Mana1-6)Manb1- |
| 4GlcNAcb1-4GlcNAc | 4GlcNAcb1-4GlcNAcb |
| Mana1-3(GlcNAcb1-2(GlcNAcb1-6)Mana1-6)Manb1- | GlcNAcb1-2Mana1-3(GlcNAcb1-2(GlcNAcb1- |
| 4GlcNAcb1-4GlcNAc | 6)Mana1-6)Manb1-4GlcNAc |
| GlcNAcb1-2(GlcNAcb1-4)Mana1-3(Mana1-6)Manb1- | GlcNAcb1-2Mana1-3(GlcNAcb1-2Mana1-6)Manb1- |
| 4GlcNAcb1-4GlcNAc | 4GlcNAcb1-4GlcNAc |
| Galb1-4GlcNAcb1-3(Galb1-4GlcNAcb1-6)Galb1- | GlcNAcb1-4(GlcNAcb1-2Mana1-3)(Mana1-6)Manb1- |
| 4GlcNAcb1-3GalNAca | 4GlcNAcb1-4GlcNAcb |
| Galb1-3GlcNAcb1-3(Galb1-3GlcNAcb1-6)Galb1- | GlcNAcb1-4(GlcNAcb1-2Mana1-3)(GalNAcb1- |
| 4GlcNAcb1-3GalNAc | 4GlcNAcb1-2Mana1-6)Man |
| GlcNAcb1-4(GlcNAcb1-2Mana1-3)(GlcNAcb1- | GlcNAcb1-4Mana1-3(GlcNAcb1-2Mana1-6)Manb1- |
| 2Mana1-6)Manb1-4GlcNAc | 4GlcNAcb1-4GlcNAcb |
| GlcNAcb1-2Mana1-3(GlcNAcb1-6Mana1-6)Manb1- | GlcNAcb1-2(GlcNAcb1-4)Mana1-3(GlcNAcb1- |
| 4GlcNAcb1-4GlcNAc | 2Mana1-6)Manb1-4GlcNAc |
| GlcNAcb1-4Mana1-3(GlcNAcb1-6Mana1-6)Manb1- | GlcNAcb1-4Mana1-3(GlcNAcb1-2Mana1-6)Manb1- |
| 4GlcNAcb1-4GlcNAc | 4GlcNAcb1-4GlcNAc |
| GlcNAcb1-4(GlcNAcb1-2Mana1-3)(Mana1-6)Manb1- | GalNAcb1-4GlcNAcb1-2Mana1-3(Mana1-6)Manb1- |
| 4GlcNAcb1-4GlcNAc | 4GlcNAcb1-4GlcNAc |
| Galb1-4GlcNAcb1-3(Galb1-4GlcNAcb1-6)Galb1- | GlcNAcb1-2Mana1-3(GlcNAcb1-2(GlcNAcb1- |
| 4GlcNAcb1-3GalNAc | 4)Mana1-6)Manb1-4GlcNAc |
| GlcNAcb1-4(GlcNAcb1-2Mana1-3)(Mana1-6)Manb1- | GlcNAcb1-4(GlcNAcb1-2Mana1-3)(Mana1-6)Manb1- |
| 4GlcNAcb1-4GlcNAc | 4GlcNAcb1-4GlcNAc |
| GlcNAcb1-3/4Galb1-3(Galb1-4GlcNAcb1-3Galb1- | GlcNAca1-4(GlcNAca1-4(GlcNAca1-4GlcAa1- |
| 4GlcNAcb1-6)GalNAc | 2)GlcAa1-2)GlcAa1-2Gal |
| NeuGca2-3Galb1-3GalNAcb1-4(NeuGca2-3)Galb1- | Galb1-3GalNAcb1-4(NeuGca2-8NeuGca2-3)Galb1- |
| 4Glcb | 4Glcb |
| NeuAca2-6Galb1-4GlcNAcb1-2Mana1-3(Mana1- | GalNAcb1-4(Fuca1-3)GlcNAcb1-3(GalNAcb1- |
| 6)Manb1-4Glcb | 4(Fuca1-3)GlcNAcb1-6)GalNAc |
| NeuAca2-3Galb1-3(NeuAca2-3Galb1-4GlcNAcb1- | |
| 6)GalNAc | |
| NeuAca2-3Galb1-4GlcNAcb1-3Galb1-3(NeuAca2- | NeuAca2-3Galb1-3(NeuAca2-6Galb1-4GlcNAcb1- |
| 6)GalNAca | 6)GalNAc |
| NeuAca2-3Galb1-3(NeuAca2-3Galb1-4GlcNAcb1- | NeuAca2-3Galb1-3(NeuAca2-3Galb1-4GlcNAcb1- |
| 6)GlcNAca | 6)GalNAca |
| NeuAca2-3Galb1-3(NeuAca2-3Galb1-4GlcNAcb1- | NeuAca2-3Galb1-3(NeuAca2-3Galb1-4GlcNAcb1- |
| 6)GalNAca | 6)GalNAca |
| NeuAca2-3Galb1-4GlcNAcb1-3Galb1-3(NeuAca2- | NeuAca2-3Galb1-3(NeuAca2-3Galb1-4GlcNAcb1- |
| 6)GalNAca | 6)GalNAca |
| GalNAcb1-4Galb1-3Galb1-3(NeuAca2-8NeuAca2- | GalNAca1-3(Fuca1-2)Galb1-4(Fuca1-3)GlcNAcb1- |
| 6)GalNAca | 3(Kdna1-6)GalNAc |
| NeuAca2-3Galb1-4(Fuca1-3)GlcNAcb1-3Galb1- | Fuca1-2Galb1-3(NeuAca2-3Galb1-4(Fuca1- |
| 4(Fuca1-3)GalNAc | 3)GlcNAcb1-6)GalNAc |
| NeuAca2-3Galb1-3(Fuca1-4)GlcNAcb1-3Galb1- | NeuAca2-3Galb1-4(Fuca1-3)GlcNAcb1-3Galb1- |
| 4(Fuca1-3)GlcNAc | 4(Fuca1-3)GlcNAc |
| NeuAca2-3Galb1-3(Fuca1-2Galb1-4(Fuca1- | GalNAcb1-3(Fuca1-2)Galb1-4GlcNAcb1-3(Fuca1- |
| 3)GlcNAcb1-6)GalNAc | 4Kdna1-6)GalNAc |
| NeuAca2-3Galb1-4(Fuca1-3)GlcNAcb1-3Galb1- | NeuAca2-3Galb1-4(Fuca1-3)GlcNAcb1-3Galb1- |
| 4(Fuca1-3)GlcNAcb | 4(Fuca1-3)GlcNAc |
| Fuca1-3GalNAcb1-3Galb1-3GalNAcb1-4(NeuAca2- | Man[6P]a1-2Mana1-3(Mana1-6(Man[6P]a1- |
| 3)Galb1-4Glcb | 3)Mana1-6)Manb1-4GlcNAc |
| Man[6P]a1-2Mana1-3(Mana1-3(Man[6P]a1- | Mana1-2Mana1-3(Mana1-3(Mana1-2Mana1- |
| 6)Mana1-6)Manb1-4GlcNAc | 6)Mana1-6)Manb1-4GlcNAc |
| Mana1-2(Mana1-6)Mana1-3(Mana1-3(Mana1- | Mana1-2Mana1-2Mana1-3(Mana1-3(Mana1- |
| 6)Mana1-6)Manb1-4GlcNAc | 6)Mana1-6)Manb1-4GlcNAc |
| Mana1-2Mana1-2Mana1-3(Mana1-2Mana1-3Mana1- | Mana1-3(Mana1-2Mana1-3(Mana1-2Mana1- |
| 6)Manb1-4GlcNAc | 6)Mana1-6)Manb1-4GlcNAc |
| Mana1-2Mana1-2Mana1-3(Mana1-2Mana1-6Mana1- | Mana1-2Mana1-2Mana1-3(Mana1-3(Mana1- |
| 6)Manb1-4GlcNAc | 6)Mana1-6)Manb1-4GlcNAcb |
| Mana1-2Mana1-3(Mana1-3(Mana1-2Mana1- | Mana1-2Mana1-3(Mana1-3(Mana1-6Mana1- |
| 6)Mana1-6)Manb1-3GlcNAc | 6)Mana1-6)Manb1-4GlcNAc |
| Mana1-2Mana1-3(Mana1-2Mana1-3(Mana1- | GalNAca1-3Galb1-4GlcNAcb1-3(GlcNAcb1-6)Galb1- |
| 6)Mana1-6)Manb1-4GlcNAc | 4GlcNAcb1-3GalNAc |
| | GlcNAcb1-4(GalNAcb1-4GlcNAcb1-2Mana1- |
| | 3)Manb1-4GlcNAcb1-4GlcNAc |
| NeuAca2-6Galb1-4GlcNAcb1-2Mana1-3(Mana1- | NeuAca2-3Galb1-4GlcNAcb1-2Mana1-3(Mana1- |
| 6)Manb1-4GlcNAc | 6)Manb1-4GlcNAc |
| Mana1-3(NeuAca2-6Galb1-4GlcNAcb1-2Mana1- | Galb1-3(Fuca1-4)GlcNAcb1-3Galb1-3(Fuca1- |
| 6)Manb1-4GlcNAc | 4)GlcNAcb1-3Galb1-4Glcb |
| GlcNAcb1-3(NeuAca2-6)Galb1-4GlcNAcb1- | NeuAca2-3Galb1-4GlcNAcb1-6(NeuAca2- |
| 3(NeuAca2-6)GalNAc | 3GalNAcb1-3)GalNAca |
| NeuAca2-3Galb1-4GlcNAcb1-6(NeuAca2- | Galb1-3(Galb1-4(Fuca1-3)GlcNAcb1-6)GalNAcb1- |
| 3GalNAcb1-3)GalNAca | 3Gala1-4Galb1-4Glcb |
| Mana1-3(Mana1-3(Mana1-6)Mana1-6)Manb1- | Mana1-3(Mana1-3(Mana1-6)Mana1-6)Manb1- |
| 4GlcNAcb1-4(Fuca1-6)GlcNAcb | 4GlcNAcb1-4(Fuca1-6)GlcNAc |
| Mana1-3(Mana1-3(Mana1-6)Mana1-6)Mana1- | Gala1-3(Fuca1-2)Galb1-4GlcNAcb1-3Galb1- |
| 4GlcNAcb1-4(Fuca1-6)GlcNAcb | 4GlcNAcb1-3Galb1-4Glcb |
| GlcNAcb1-2Mana1-3(Man[6PE]a1-6)Manb1- | Fuca1-2Galb1-3GlcNAcb1-3(NeuAca2-3Galb1- |
| 4GlcNAcb1-4(Fuca1-6)GlcNAc | 4GlcNAcb1-6)GalNAc |
| Galb1-4GlcNAcb1-3(NeuAca2-3Galb1-4(Fuca1- | Fuca1-2Galb1-3(GalNAcb1-4(NeuAca2-3)Galb1- |
| 3)GlcNAcb1-6)GalNAc | 4GlcNAcb1-6)GalNAc |
| Fuca1-2Galb1-4GlcNAcb1-3(Fuca1-2Galb1-4(Fuca1- | Fuca1-2Galb1-4(Fuca1-3)GlcNAcb1-3(Fuca1- |
| 3)GlcNAcb1-6)GalNAc | 2Galb1-4GlcNAcb1-6)GalNAc |
| Fuca1-2Galb1-3GlcNAcb1-3(Fuca1-2Galb1-4(Fuca1- | GalNAc[4S]b1-4GlcNAcb1-2Mana1-3(Mana1- |
| 3)GlcNAcb1-6)GalNAc | 6)Manb1-4GlcNAcb1-4GlcNAc |
| GalNAc[4S]b1-4GlcNAcb1-2Mana1-3(Mana1- | |
| 6)Manb1-4GlcNAcb1-4GlcNAcb | |
| Mana1-2Mana1-3(Mana1-3(Mana1-6)Mana1- | Mana1-2Mana1-3(Mana1-3(Mana1-6)Mana1- |
| 6)Manb1-4GlcNAcb1-4GlcNAc | 6)Manb1-4GlcNAcb1-4GlcNAcb |
| Glca1-2Mana1-2Mana1-2Mana1-3(Mana1-6)Manb1- | Glca1-3Mana1-2Mana1-2Mana1-3(Mana1-6)Manb1- |
| 4GlcNAcb1-4GlcNAc | 4GlcNAcb1-4GlcNAc |
| Mana1-2Mana1-2(Mana1-6)Mana1-3(Mana1- | Mana1-3Mana1-2Mana1-2Mana1-3(Mana1- |
| 6)Manb1-4GlcNAcb1-4GlcNAc | 6)Manb1-4GlcNAcb1-4GlcNAc |
| Mana1-2Mana1-2Mana1-3(Mana1-3Mana1- | Mana1-3(Mana1-3(Mana1-2Mana1-6)Mana1- |
| 6)Manb1-4GlcNAcb1-4GlcNAc | 6)Manb1-4GlcNAcb1-4GlcNAc |
| Mana1-2Mana1-3(Mana1-6(Manb1-3)Mana1- | Mana1-2Mana1-3(Mana1-3(Mana1-6)Mana1- |
| 6)Manb1-4GlcNAcb1-4GlcNAcb | 6)Manb1-4GlcNAcb1-4GlcNAc |
| Mana1-3(Mana1-3(Mana1-2Mana1-6)Mana1- | Mana1-3(Mana1-2Mana1-3(Mana1-6)Mana1- |
| 6)Manb1-4GlcNAcb1-4GlcNAc | 6)Manb1-4GlcNAcb1-4GlcNAc |
| Mana1-2Mana1-2Mana1-3(Mana1-3Mana1- | Mana1-2Mana1-2Mana1-3(Mana1-6Mana1- |
| 6)Manb1-4GlcNAcb1-4GlcNAcb | 6)Manb1-4GlcNAcb1-4GlcNAc |
| Mana1-2Mana1-3(Mana1-2Mana1-6Mana1- | Mana1-2Mana1-3(Mana1-2Mana1-6)Mana1- |
| 6)Manb1-4GlcNAcb1-4GlcNAc | 6Manb1-4GlcNAcb1-4GlcNAc |
| Mana1-3(Mana1-3(Mana1-2Mana1-6)Mana1- | Mana1-3(Mana1-6)Mana1-3(Mana1-2Mana1- |
| 6)Manb1-4GlcNAcb1-4GlcNAcb | 6)Manb1-4GlcNAcb1-4GlcNAc |
| Galb1-4GlcNAcb1-2Mana1-3(Mana1-3(Mana1- | Mana1-3(Mana1-2Mana1-3(Mana1-6)Mana1- |
| 6)Mana1-6)Manb1-4GlcNAc | 6)Manb1-4GlcNAcb1-4GlcNAc |
| Mana1-3(Mana1-2Mana1-3(Mana1-6)Mana1- | Mana1-2Mana1-3(Mana1-3(Mana1-6)Mana1- |
| 6)Manb1-4GlcNAcb1-4GlcNAcb | 6)Manb1-4GlcNAcb1-4GlcNAc |
| Mana1-2Mana1-3(Mana1-6Mana1-3Mana1- | Mana1-2Mana1-3(Mana1-6Mana1-6Mana1- |
| 6)Manb1-4GlcNAcb1-4GlcNAc | 6)Manb1-4GlcNAcb1-4GlcNAcb |
| Mana1-2Mana1-6Mana1-3Mana1-6Mana1-3Manb1- | Mana1-2Mana1-3(Mana1-3(Mana1-6)Mana1- |
| 4GlcNAcb1-4GlcNAc | 6)Manb1-4GlcNAcb1-4GlcNAcbb |
| Galb1-4GlcNAcb1-2Mana1-3(Galb1-4GlcNAcb1- | Mana1-2Mana1-3(Mana1-3(Mana1-6)Mana1- |
| 2Mana1-6)Manb1-4Glcb | 6)Mana1-4GlcNAcb1-4GlcNAcb |
| Mana1-2Mana1-3(Mana1-3(Mana1-6)Mana1- | Glca1-3Mana1-2Mana1-2Mana1-3(Mana1-6)Manb1- |
| 6)Manb1-4GlcNAcb1-4GlcNAc | 4GlcNAcb1-4GlcNAcb |
| Mana1-2Mana1-3(Mana1-2Mana1-3Mana1- | Gala1-3Galb1-4GlcNAcb1-2Mana1-3(Mana1- |
| 6)Manb1-4GlcNAcb1-4GlcNAc | 6Mana1-6)Manb1-4GlcNAc |
| Gala1-3Galb1-4GlcNAcb1-2Mana1-3(Mana1- | NeuAca2-3Galb1-4GlcNAcb1-3Galb1-4GlcNAcb1- |
| 3Mana1-6)Manb1-4GlcNAc | 3Galb1-4GlcNAcb |
| NeuAca2-3Galb1-4GlcNAcb1-3Galb1-4GlcNAcb1- | NeuAca2-6Galb1-4GlcNAcb1-2Mana1-6Manb1- |
| 3Galb1-4GlcNAcb | 4GlcNAcb1-4GlcNAc |
| NeuAca2-3Galb1-4GlcNAcb1-3Galb1-4GlcNAcb1- | NeuAca2-3Galb1-4GlcNAcb1-3Galb1-4GlcNAcb1- |
| 3Galb1-4GlcNAcb | 3Galb1-4GlcNAcb |
| NeuAca2-3Galb1-4GlcNAcb1-3Galb1-4GlcNAcb1- | NeuAca2-3Galb1-3(Galb1-4GlcNAcb1-3Galb1- |
| 3Galb1-4GlcNAcb | 4GlcNAcb1-6)GalNAc |
| NeuAca2-3Galb1-3(Galb1-3GlcNAcb1-3Galb1- | |
| 4GlcNAcb1-6)GalNAc | |
| Galb1-4(Fuca1-3)GlcNAcb1-2Mana1-3Manb1- | Mana1-3(GlcNAcb1-2Mana1-6)Manb1-4GlcNAcb1- |
| 4GlcNAcb1-6(Fuca1-3)GlcNAcb | 4(Fuca1-3)(Fuca1-6)GlcNAc |
| GlcNAcb1-2Mana1-3(Mana1-6)Manb1-4GlcNAcb1- | Mana1-3(GlcNAcb1-2Mana1-6)Manb1-4GlcNAcb1- |
| 4(Fuca1-3)(Fuca1-6)GlcNAc | 4(Fuca1-3)(Fuca1-6)GlcNAcb |
| GlcNAcb1-2Mana1-3(Mana1-6)Manb1-4GlcNAcb1- | Galb1-4(Fuca1-3)GlcNAcb1-2Mana1-6Manb1- |
| 4(Fuca1-3)(Fuca1-6)GlcNAcb | 4GlcNAcb1-4(Fuca1-6)GlcNAcb |
| Fuca1-2Galb1-3(Fuca1-4)GlcNAcb1-3Galb1- | Fuca1-2Galb1-4GlcNAcb1-3(Fuca1-2Galb1- |
| 3(Galb1-4GlcNAcb1-6)GalNAc | 4GlcNAcb1-6)Galb1-3GalNAc |
| Fuca1-2Galb1-4GlcNAcb1-6Mana1-6Manb1- | Fuca1-6Galb1-4GlcNAcb1-2Mana1-6Manb1- |
| 4GlcNAcb1-4(Fuca1-6)GlcNAcb | 4GlcNAcb1-4(Fuca1-6)GlcNAcb |
| Galb1-4(Fuca1-3)GlcNAcb1-3Galb1-4(Fuca1- | Fuca1-2Galb1-4GlcNAcb1-2Mana1-3Manb1- |
| 3)GlcNAcb1-3Galb1-3GalNAc | 4GlcNAcb1-4(Fuca1-6)GlcNAcb |
| Fuca1-2Galb1-4GlcNAcb1-2Mana1-6Manb1- | Fuca1-2Galb1-4(Fuca1-3)GlcNAcb1-3(Galb1- |
| 4GlcNAcb1-4(Fuca1-6)GlcNAcb | 4GlcNAcb1-6)Galb1-3GalNAc |
| Galb1-4(Fuca1-3)GlcNAcb1-4Mana1-3Manb1- | Mana1-3(Fuca1-3GlcNAcb1-2Mana1-6)Manb1- |
| 4GlcNAcb1-4Fuca1-6)GlcNAcb | 4GlcNAcb1-4(Fuca1-6)GlcNAcb |
| Galb1-4(Fuca1-3)GlcNAcb1-2Mana1-3Manb1- | Fuca1-6Galb1-4GlcNAcb1-2Mana1-6Manb1- |
| 4GlcNAcb1-4(Fuca1-6)GlcNAcb | 4GlcNAcb1-4(Fuca1-3)GlcNAcb |
| Fuca1-2Galb1-3GlcNAcb1-3(Fuca1-2Galb1- | Fuca1-3Galb1-4GlcNAcb1-2Mana1-6Manb1- |
| 4GlcNAcb1-6)Galb1-3GalNAc | 4GlcNAcb1-4(Fuca1-6)GlcNAcb |
| Fuca1-2Galb1-4GlcNAcb1-4Mana1-3Manb1- | Fuca1-3GlcNAcb1-2Mana1-3(Mana1-6)Manb1- |
| 4GlcNAcb1-4(Fuca1-6)GlcNAcb | 4GlcNAcb1-4(Fuca1-6)GlcNAcb |
| Fuca1-2Galb1-3GlcNAcb1-3(Fuca1-2Galb1- | GalNAcb1-4(NeuAca2-8NeuAca2-8NeuAca2- |
| 3GlcNAcb1-6)Galb1-3GalNAc | 3)Galb1-4Glcb |
| Galb1-3Galb1-3(NeuAca2-8NeuAca2-8NeuAca2- | GalNAcb1-4(NeuAca2-8NeuAca2-8NeuAca2- |
| 6GalNAca | 3)Galb1-4Glcb |
| Galb1-4(Fuca1-3)GlcNAcb1-3(Fuca1-2(Fuca1- | GlcNAcb1-2Mana1-3(GlcNAcb1-2Mana1-6)Manb1- |
| 3)Fuca1-4Kdna1-6)GalNAc | 4GlcNAcb1-4(Fuca1-6)Glc |
| Mana1-3(Galb1-4GlcNAcb1-2Mana1-6)Manb1- | Galb1-4GlcNAcb1-2Mana1-3(Mana1-6)Manb1- |
| 4GlcNAcb1-4(Fuca1-6)GlcNAc | 4GlcNAcb1-4(Fuca1-6)GlcNAc |
| Galb1-4GlcNAcb1-2Mana1-3(Mana1-6)Manb1- | GalNAca1-3GalNAcb1-3(Fuca1-2Galb1-3GalNAcb1- |
| 4GlcNAcb1-4(Fuca1-6)GlcNAc | 4)Gala1-4Galb1-4Glcb |
| Galb1-4GlcNAcb1-2Mana1-3(Mana1-6)Manb1- | |
| 4GlcNAcb1-4(Fuca1-6)GlcNAc | |
| Mana1-3(Galb1-4GlcNAcb1-2Mana1-6)Manb1- | Galb1-3GlcNAcb1-2Mana1-3(Mana1-6)Manb1- |
| 4GlcNAcb1-4(Fuca1-6)GlcNAc | 4GlcNAcb1-4(Fuca1-6)GlcNAc |
| Mana1-3(Galb1-4GlcNAcb1-2Mana1-6)Manb1- | Galb1-4GlcNAcb1-4Mana1-3(Mana1-6)Manb1- |
| 4GlcNAcb1-4(Fuca1-6)GlcNAcb | 4GlcNAcb1-4(Fuca1-6)GlcNAcb |
| GlcNAcb1-2Mana1-3(Mana1-3Mana1-6)Manb1- | GalNAca1-3(Fuca1-2)Galb1-4GlcNAca1-3Galb1- |
| 4GlcNAcb1-4(Fuca1-6)GlcNAc | 4GlcNAcb1-3Galb1-4Glcb |
| Mana1-3(Galb1-4GlcNAcb1-6Mana1-6)Manb1- | Mana1-3(Galb1-4GlcNAcb1-6Mana1-6)Manb1- |
| 4GlcNAcb1-4(Fuca1-6)GlcNAc | 4GlcNAcb1-4(Fuca1-6)GlcNAcb |
| Galb1-4GlcNAcb1-2Mana1-3(Mana1-6)Manb1- | GalNAca1-3(Fuca1-2)Galb1-3GlcNAcb1-3Galb1- |
| 4GlcNAcb1-4(Fuca1-6)GlcNAcb | 3GlcNAcb1-3Galb1-4Glcb |
| Galb1-4(Fuca1-3)GlcNAcb1-2Mana1-3(Mana1- | Fuca1-4(Fuca1-5)Kdna1-3Galb1-3(Galb1-4(Fuca1- |
| 6)Manb1-4GlcNAcb1-4GlcNAc | 3)GlcNAcb1-6)GalNAc |
| Fuca1-4(Fuca1-5)Kdna1-3Galb1-3(Fuca1-2Galb1- | Fuca1-4(Fuca1-5)Kdna1-3Galb1-3(Fuca1-2Galb1- |
| 4GlcNAcb1-6)GalNAc | 4GlcNAcb1-6)GlcNAcb |
| Gala1-4(Fuca1-2)Galb1-4GlcNAcb1-3(Fuca1- | GlcNAcb1-2Mana1-6Mana1-3Mana1-6Mana1- |
| 3Fuca1-4Kdna1-6)GalNAc | 3Manb1-4GlcNAcb1-4GlcNAc |
| GlcNAca1-2Mana1-3(Mana1-3(Mana1-6)Mana1- | Galb1-4GlcNAcb1-2Mana1-3(Galb1-4GlcNAcb1- |
| 6)Manb1-4GlcNAcb1-4GlcNAc | 2Mana1-6)Manb1-4GlcNAc |
| GlcNAcb1-2Mana1-3(Mana1-3(Mana1-6)Mana1- | GlcNAcb1-2Mana1-3(Mana1-3(Mana1-6)Mana1- |
| 6)Manb1-4GlcNAcb1-4GlcNAcb | 6)Manb1-4GlcNAcb1-4GlcNAc |
| Galb1-4GlcNAcb1-2Mana1-3(Mana1-3Mana1- | GlcNAcb1-4(Galb1-4GlcNAcb1-2Mana1-3)(Galb1- |
| 6)Manb1-4GlcNAcb1-4GlcNAc | 4GlcNAcb1-2Mana1-6)Man |
| Galb1-4GlcNAcb1-4Mana1-3(Galb1-4GlcNAcb1- | Galb1-4GlcNAcb1-2Mana1-3(Mana1-2Mana1- |
| 2Mana1-6)Manb1-4GlcNAc | 6)Manb1-4GlcNAcb1-4GlcNAcb |
| Galb1-4GlcNAcb1-2Mana1-3(Mana1-3Mana1- | GlcNAcb1-2Mana1-3(Mana1-3(Mana1-6)Mana1- |
| 6)Manb1-4GlcNAcb1-4GlcNAcb | 6)Manb1-4GlcNAcb1-4GlcNAc |
| GlcNAca1-2Mana1-3(Mana1-3(Mana1-6)Mana1- | GlcNAcb1-4(GlcNAcb1-3Mana1-3)(Mana1-3(Mana1- |
| 6)Manb1-4GlcNAcb1-4GlcNAcb | 6)Mana1-6)Manb1-4GlcNAc |
| Galb1-4GlcNAcb1-2Glca1-3(Galb1-4GlcNAcb1- | GlcNAcb1-4(Mana1-3)(Mana1-3(Mana1-6)Mana1- |
| 2Glca1-6)Glcb1-4GlcNAc | 6)Manb1-4GlcNAcb1-4GlcNAc |
| Fuca1-2GlcAb1-3Galb1-3(Fuca1-2)Galb1-3(Fuca1- | Galb1-4GlcNAcb1-3(GlcNAcb1-6)Galb1-4GlcNAcb1- |
| 3GlcNAc[3S]b1-6)GalNAc | 3(NeuAca2-6)GalNAc |
| GalNAca1-3(Fuca1-2)Galb1-3(GalNAca1-3(Fuca1- | GlcNAca1-4(Fuca1-2)Galb1-3(GlcNAca1-4(Fuca1- |
| 2)Galb1-4GlcNAcb1-6)GalNAc | 2)Galb1-4GlcNAcb1-6)GalNAc |
| NeuAca2-3(NeuAca2-6)Galb1-3GalNAcb1-3Gala1- | GalNAcb1-4(Fuca1-3)GlcNAcb1-3(Fuca1-2(Fuca1- |
| 4Galb1-4Glcb | 3)Fuca1-4Kdna1-6)GalNAc |
| GlcNAcb1-2Mana1-3(GlcNAcb1-2Mana1-6)Manb1- | Mana1-3(GlcNAcb1-2(GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Mana1-3)(GlcNAcb1-2Mana1-6)Manb1- | GalNAcb1-4GlcNAcb1-2Mana1-3(Mana1-6)Manb1- |
| 4GlcNAcb1-4(Fuca1-6)GlcNAc | 4GlcNAcb1-4(Fuca1-6)GlcNAc |
| GlcNAcb1-4(Mana1-3)(GlcNAcb1-2Mana1-6)Manb1- | GlcNAcb1-4Mana1-3(GlcNAcb1-4Mana1-6)Manb1- |
| 4GlcNAcb1-4(Fuca1-6)GlcNAcb | 4GlcNAcb1-4(Fuca1-6)GlcNAcb |
| GlcNAcb1-2(GlcNAcb1-4)Mana1-3(Mana1-6)Manb1- | GlcNAcb1-4Mana1-3(GlcNAcb1-2Mana1-6)Manb1- |
| 4GlcNAcb1-4(Fuca1-6)GlcNAcb | 4GlcNAcb1-4(Fuca1-6)GlcNAc |
| GlcNAcb1-4(GlcNAcb1-2Mana1-3)(Mana1-6)Manb1- | GlcNAcb1-2Mana1-3(GlcNAcb1-2Mana1-6)Manb1- |
| 4GlcNAcb1-4(Fuca1-6)GlcNAc | 4GlcNAcb1-4(Fuca1-6)GlcNAcb |
| GlcNAcb1-2Mana1-3(GlcNAcb1-2Mana1-6)Manb1- | GlcNAcb1-4(GlcNAcb1-2Mana1-3)(Mana1-6)Manb1- |
| 4GlcNAcb1-4(Fuca1-3)GlcNAc | 4GlcNAcb1-4(Fuca1-6)GlcNAc |
| GlcNAcb1-4Mana1-3(GlcNAcb1-6Mana1-6)Manb1- | GlcNAcb1-2Mana1-3(GlcNAcb1-2Mana1-6)Manb1- |
| 4GlcNAcb1-4(Fuca1-6)GlcNAc | 4GlcNAcb1-4(Fuca1-3)GlcNAc |
| GlcNAcb1-2Mana1-3(GlcNAcb1-2Mana1-6)Manb1- | GlcNAcb1-4(Mana1-3)(GlcNAcb1-2Mana1-6)Manb1- |
| 4GlcNAcb1-4(Fuca1-6)GlcNAc | 4GlcNAcb1-4(Fuca1-6)GlcNAc |
| GlcNAcb1-2Mana1-3(GlcNAcb1-6Mana1-6)Manb1- | GlcNAcb1-4(GlcNAcb1-2Mana1-3)(Mana1-6)Manb1- |
| 4GlcNAcb1-4(Fuca1-6)GlcNAc | 4GlcNAcb1-4(Fuca1-6)GlcNAcb |
| GalNAcb1-4(Fuca1-3)GlcNAcb1-2Mana1-3(Mana1- | GalNAcb1-4(Fuca1-3)GlcNAcb1-2Mana1-3(Mana1- |
| 6)Manb1-4GlcNAcb1-4GlcNAc | 6)Manb1-4GlcNAcb1-4GlcNAcb |
| GalNAcb1-4(Fuca1-3)GlcNAcb1-2Mana1-3(Mana1- | GlcNAcb1-2Mana1-3(GlcNAcb1-2Man[6PN]a1- |
| 6)Manb1-4GlcNAcb1-4GlcNAc | 6)Manb1-4GlcNAcb1-4(Fuca1-6)GlcNAc |
| GlcNAc[6PN]b1-2Mana1-3(GlcNAcb1-2Man[6PN]a1- | GalNAcb1-4GlcNAcb1-2Mana1-3(Mana1-6)Manb1- |
| 6)Manb1-4GlcNAcb1-4(Fuca1-6)GlcNAc | 4GlcNAcb1-4(Fuca1-6)GlcNAcb |
| GalNAcb1-4GlcNAcb1-2Mana1-3(Mana1-6)Manb1- | GlcNAcb1-2Mana1-3(GlcNAcb1-2Mana1-6)Manb1- |
| 4GlcNAcb1-4(Fuca1-6)GlcNAc | 4GlcNAcb1-4(Fuca1-6)GlcNAc |
| Fuca1-2Galb1-4GlcNAca1-3Galb1-3/6(GlcNAcb1- | GlcNAcb1-3/4/2Galb1-6/3(Fuca1-2Galb1- |
| 4/2Galb1-4GlcNAcb1-6/3)GalNAc | 4GlcNAcb1-3Galb1-4GlcNAcb1-3/6)GalNAc |
| | Galb1-4Galb1-3(NeuGca2-8NeuGca2-8NeuGca2- |
| | 6)GalNAc |
| Fuca1-4(Fuca1-5)Kdna1-3Galb1-3(Fuca1-4(Fuca1- | Fuca1-4(Fuca1-5)Kdna1-3Galb1-3(Fuca1-4(Fuca1- |
| 5)Kdna1-6)GlcNAcb | 5)Kdna1-6)GalNAc |
| Glcb1-4Glcb1-4Glcb1-4Glcb1-4Glcb1-4Glcb1- | Fuca1-3GalNAcb1-4Galb1-3Galb1-3(NeuAca2- |
| 4Glcb1-4Glcb1-4Glcb | 8NeuAca2-6)GalNAca |
| NeuAca2-3Galb1-3(NeuAca2-3Galb1-4(Fuca1- | NeuAca2-3Galb1-3(NeuAca2-3Galb1-4(Fuca1- |
| 3)GlcNAcb1-6)GalNAc | 3)GlcNAcb1-6)GalNAca |
| NeuAca2-3Galb1-3(NeuAca2-3Galb1-4(Fuca1- | Fuca1-3Fuca1-4Kdna1-3Galb1-3(GalNAcb1- |
| 3)GlcNAcb1-6)GalNAca | 4(Fuca1-3)GlcNAcb1-6)GalNAc |
| GalNAcb1-3(Fuca1-2)Galb1-4GlcNAcb1-3(Fuca1- | Galb1-4GlcNAcb1-2Mana1-3(GlcNAcb1-2Mana1- |
| 3Fuca1-4Kdna1-6)GalNAc | 6)Manb1-4GlcNAcb1-4GlcNAc |
| Galb1-4GlcNAcb1-2Mana1-3(GlcNAcb1-2Mana1- | Galb1-4GlcNAcb1-2Mana1-3(GlcNAcb1-2Mana1- |
| 6)Manb1-4GlcNAcb1-4GlcNAcb | 6)Manb1-4GlcNAcb1-4GlcNAc |
| GlcNAcb1-2Mana1-3(Galb1-4GlcNAcb1-2Mana1- | Galb1-3GlcNAcb1-3(Galb1-4GlcNAcb1-6)Galb1- |
| 6)Manb1-4GlcNAcb1-4GlcNAcb | 3(Galb1-4GlcNAcb1-6)GalNAc |
| Galb1-3(Galb1-4GlcNAcb1-3Galb1-4GlcNAcb1- | Galb1-4GlcNAcb1-3(Galb1-4GlcNAcb1-6)Galb1- |
| 3Galb1-4GlcNAcb1-6)GalNAc | 3(Galb1-4GlcNAcb1-6)GalNAc |
| Galb1-4GlcNAcb1-4Mana1-3(GlcNAcb1-2Mana1- | GlcNAcb1-4Mana1-3(Galb1-4GlcNAcb1-2Mana1- |
| 6)Manb1-4GlcNAcb1-4GlcNAc | 6)Manb1-4GlcNAcb1-4GlcNAcb |
| GlcNAcb1-2Mana1-3(Galb1-4GlcNAcb1-2Mana1- | Galb1-4GlcNAcb1-4Mana1-3(GlcNAcb1-2Mana1- |
| 6)Manb1-4GlcNAcb1-4GlcNAc | 6)Manb1-4GlcNAcb1-4GlcNAcb |
| GlcNAcb1-4Mana1-3(Galb1-4GlcNAcb1-2Manb1- | GlcNAcb1-4(GlcNAcb1-2Mana1-3)(Galb1- |
| 6)Mana1-4GlcNAcb1-4GlcNAc | 4GlcNAcb1-2Mana1-6)Mana1-4GlcNAc |
| GlcNAcb1-4(Galb1-4GlcNAcb1-2Mana1- | GlcNAcb1-2Mana1-3(Galb1-4GlcNAcb1-2Mana1- |
| 3)(GlcNAcb1-2Mana1-6)Manb1-4GlcNAc | 6)Manb1-4GlcNAcb1-4GlcNAc |
| Galb1-4GlcNAcb1-3Galb1-4GlcNAcb1-3Galb1- | Galb1-3GalNAca1-4Galb1-3GalNAca1-4Galb1- |
| 4GlcNAcb1-3Galb1-3GalNAc | 3GalNAca1-4Galb1-3GalNAc |
| GlcNAcb1-2(GlcNAcb1-4)Mana1-3(Mana1-3Mana1- | GlcNAcb1-4(GlcNAcb1-2Mana1-3)(Mana1-3Mana1- |
| 6)Manb1-4GlcNAcb1-4GlcNAcb | 6)Manb1-4GlcNAcb1-4GlcNAcb |
| Galb1-4GlcNAcb1-3(Galb1-4GlcNAcb1-6)Galb1- | Galb1-3(Galb1-4GlcNAcb1-3Galb1-4GlcNAcb1- |
| 4GlcNAcb1-3Galb1-3GalNAc | 3Galb1-4GlcNAcb1-6)GalNAca |
| GlcNAcb1-4(Galb1-4GlcNAcb1-2Mana1-3)(Mana1- | |
| 6)Manb1-4GlcNAcb1-4GlcNAc | |
| Galb1-3GlcNAcb1-3(Galb1-4GlcNAcb1-6)Galb1- | GlcNAcb1-4(GlcNAcb1-2Mana1-3)(Mana1-3Mana1- |
| 3GlcNAcb1-3Galb1-3GalNAca | 6)Manb1-4GlcNAcb1-4GlcNAc |
| Galb1-3GlcNAcb1-2Mana1-3(GlcNAcb1-2Mana1- | GlcNAcb1-4(GlcNAcb1-2(GlcNAcb1-4)Mana1- |
| 6)Manb1-4GlcNAcb1-4GlcNAc | 3)(Mana1-3Mana1-6)Manb1-4GlcNAc |
| GlcNAcb1-4(Mana1-3)(Galb1-4GlcNAcb1-2Mana1- | Mana1-3(Galb1-4GlcNAcb1-2(GlcNAcb1-6)Mana1- |
| 6)Manb1-4GlcNAcb1-4GlcNAc | 6)Manb1-4GlcNAcb1-4GlcNAc |
| GlcNAcb1-4(Galb1-4GlcNAcb1-2Mana1-3)(Mana1- | GlcNAcb1-4(GlcNAcb1-2Mana1-3)(Mana1-3Mana1- |
| 6)Manb1-4GlcNAcb1-4GlcNAcb | 6)Manb1-4GlcNAcb1-4GlcNAc |
| Galb1-4GlcNAcb1-3(Galb1-4GlcNAcb1-6)Galb1- | GlcNAcb1-4(Galb1-4GlcNAcb1-2Mana1-3)(Mana1- |
| 4GlcNAcb1-3Galb1-4GlcNAc | 6)Manb1-4GlcNAcb1-4GlcNAc |
| NeuAca2-3Galb1-4GlcNAc[6S]b1-3Galb1- | NeuAca2-3Galb1-4GlcNAcb1-2(NeuAca2-3Galb1- |
| 4GlcNAcb1-3Galb1-3GalNAc | 4GlcNAcb1-6)Man |
| NeuGca2-3Galb1-4GlcNAc[6S]b1-3Galb1- | GlcNAcb1-4(GlcNAcb1-2(Fucb1-4GlcNAcb1- |
| 4GlcNAcb1-3Galb1-3GalNAc | 4)Mana1-3)Manb1-4GlcNAcb1-4GlcNAcb |
| GlcNAcb1-4(GalNAcb1-4GlcNAcb1-2Mana1- | GlcNAc[6PE]b1-2Mana1-3(Man[6PE]a1-6)Manb1- |
| 3)Manb1-4GlcNAcb1-4(Fuca1-6)GlcNAc | 4GlcNAcb1-4(Fuca1-6)GlcNAc |
| GlcNAc[6S]b1-3Gal[6S]b1-4GlcNAc[6S]b1- | Fuca1-3GalNAcb1-3Galb1-4Galb1-3(NeuGca2- |
| 3Gal[6S]b1-4GlcNAc[6S]b1-3Gal | 8NeuGca2-6)GalNAc |
| Man[6P]a1-2Mana1-3(Mana1-2Mana1- | Man[6P]a1-2Mana1-3(Mana1-3(Man[6P]a1- |
| 6(Man[6P]a1-3)Mana1-6)Manb1-4GlcNAc | 2Mana1-6)Mana1-6)Manb1-4GlcNAc |
| Mana1-2Mana1-2Mana1-3(Mana1-3(Mana1- | Mana1-2Mana1-2Mana1-3(Mana1-3(Mana1- |
| 6)Mana1-6)Manb1-4Glcb1-4GlcNAc | 2Mana1-6)Mana1-6)Manb1-4GlcNAcb |
| Mana1-2Mana1-2Mana1-3(Mana1-3(Mana1- | Mana1-2Mana1-2Mana1-3(Mana1-2Mana1- |
| 2Mana1-6)Mana1-6)Mana1-4GlcNAc | 3(Mana1-6)Mana1-6)Mana1-4GlcNAc |
| Mana1-2Mana1-2Mana1-3(Mana1-3(Mana1- | Mana1-2Mana1-2Mana1-3(Mana1-2Mana1- |
| 2Mana1-6)Mana1-6)Manb1-4GlcNAc | 3(Mana1-6)Mana1-6)Manb1-4GlcNAc |
| Glca1-3Mana1-2Mana1-2Mana1-3(Mana1-3(Mana1- | Mana1-2Mana1-2Mana1-3(Mana1-2Mana1- |
| 6)Mana1-6)Manb1-4GlcNAc | 3(Mana1-6)Mana1-6)Manb1-4GlcNAcb |
| Mana1-2Mana1-2Mana1-3(Mana1-3(Mana1- | Mana1-2Mana1-3(Mana1-2Mana1-3(Mana1- |
| 2Mana1-6)Mana1-6)Manb1-3GlcNAc | 2Mana1-6)Mana1-6)Manb1-4GlcNAc |
| Glca1-2Glca1-3Glca1-3Mana1-2Mana1-2Mana1- | |
| 3(Mana1-6)Manb1-4GlcNAc | |
| Mana1-2Mana1-3(Mana1-2Mana1-3(Mana1- | Mana1-2(Mana1-2Mana1-6)Mana1-3(Mana1- |
| 2Manb1-6)Mana1-6)Manb1-4GlcNAc | 3(Mana1-6)Mana1-6)Manb1-4GlcNAc |
| Glca1-2Glca1-3Glca1-3Mana1-3(Mana1-3(Mana1- | GlcNAcb1-2(GlcNAcb1-4)Mana1-3(GlcNAcb1- |
| 6)Mana1-6)Manb1-4GlcNAc | 2Mana1-6)Manb1-4GlcNAcb1-4GlcNAc |
| GlcNAcb1-4(GlcNAcb1-2(GlcNAcb1-4)Mana1- | GlcNAcb1-4(GlcNAcb1-2Mana1-3)(GlcNAcb1- |
| 3)(Mana1-6)Manb1-4GlcNAcb1-4GlcNAc | 2Mana1-6)Manb1-4GlcNAcb1-4GlcNAc |
| GlcNAcb1-4(GlcNAcb1-4Mana1-3)(GlcNAcb1- | GlcNAcb1-2Mana1-3(GlcNAcb1-2(GlcNAcb1- |
| 2Mana1-6)Manb1-4GlcNAcb1-4GlcNAcb | 4)Mana1-6)Manb1-4GlcNAcb1-4GlcNAcb |
| GlcNAcb1-4(GlcNAcb1-2Mana1-3)(GlcNAcb1- | GlcNAcb1-4(GlcNAcb1-2Mana1-3)(GlcNAcb1- |
| 2Mana1-6)Manb1-4GlcNAcb1-4GlcNAcb | 2Mana1-6)Mana1-4GlcNAcb1-4GlcNAc |
| GlcNAcb1-2(GlcNAcb1-4)Mana1-3(GlcNAcb1- | GalNAca1-6Galb1-3GlcNAcb1-3(Galb1-4GlcNAcb1- |
| 2Mana1-6)Manb1-4GlcNAcb1-4GlcNAc | 6)Galb1-4GlcNAcb1-3GalNAc |
| GalNAcb1-4GlcNAcb1-2Mana1-3(GlcNAcb1-2Mana1- | GlcNAcb1-4(GlcNAcb1-2Mana1-3)(GlcNAcb1- |
| 6)Manb1-4GlcNAcb1-4GlcNAc | 2Mana1-6)Manb1-4GlcNAcb1-4GlcNAc |
| GlcNAcb1-2Glca1-3(GalNAcb1-4GlcNAcb1-2Glca1- | GlcNAcb1-2(GlcNAcb1-4)Mana1-3(GlcNAcb1- |
| 6)Manb1-4GlcNAcb1-4GlcNAc | 2Mana1-6)Manb1-4GlcNAcb1-4GlcNAcb |
| GlcNAcb1-2Mana1-3(GlcNAcb1-2(GlcNAcb1- | GlcNAcb1-4(GlcNAcb1-2(GlcNAcb1-4)Mana1- |
| 6)Mana1-6)Manb1-4GlcNAcb1-4GlcNAcb | 3)(Mana1-6)Manb1-4GlcNAcb1-4GlcNAc |
| GlcNAcb1-4(GlcNAcb1-2(GlcNAcb1-4)Mana1- | GlcNAcb1-4Mana1-3(GlcNAcb1-2(GlcNAcb1- |
| 3)(GlcNAcb1-2Mana1-6)Manb1-4GlcNAc | 6)Mana1-6)Manb1-4GlcNAcb1-4GlcNAc |
| GlcNAcb1-2(GlcNAcb1-4)Mana1-3(GlcNAca1- | GlcNAcb1-4GlcNAcb1-3(Galb1-4GlcNAcb1-6)Galb1- |
| 6(GlcNAcb1-2)Mana1-6-)Manb1-4GlcNAc | 4GlcNAcb1-3Galb1-3GalNAc |
| GlcNAcb1-2Mana1-3(GlcNAcb1-2(GlcNAcb1- | GlcNAcb1-2Mana1-3(GlcNAcb1-2(GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(GlcNAcb1-2Mana1-3)(GlcNAcb1- | GlcNAcb1-4(GlcNAcb1-2Mana1-3)(GlcNAcb1- |
| 2(GlcNAcb1-6)Mana1-6)Manb1-4GlcNAc | 2Mana1-6)Manb1-4GlcNAcb1-4GlcNAc |
| GlcNAcb1-2(GlcNAcb1-4)Mana1-3(GlcNAcb1- | Galb1-4GlcNAcb1-2Mana1-3(NeuAca2-6Galb1- |
| 2(GlcNAcb1-6)Mana1-6)Manb1-4GlcNAc | 4GlcNAcb1-2Mana1-6)Man |
| NeuAca2-6Galb1-4GlcNAcb1-2Mana1-3(Galb1- | NeuAca2-3Galb1-4GlcNAcb1-2Mana1-3(Mana1- |
| 4GlcNAcb1-2Mana1-6)Man | 3Mana1-6)Manb1-4GlcNAc |
| Galb1-4(Fuca1-3)GlcNAcb1-2Mana1-3(Galb1- | GalNAcb1-4(NeuAca2-3)GalNAcb1-3Galb1-4Galb1- |
| 4(Fuca1-3)GlcNAcb1-2Mana1-6)Man | 3(NeuAca2-6)GalNAc |
| | NeuAca2-3Galb1-3GlcNAcb1-3(NeuAca2-3Galb1- |
| | 4GlcNAcb1-6)GalNAc |
| NeuAca2-3Galb1-4GlcNAcb1-3(NeuAca2-3Galb1- | Galb1-4GlcNAcb1-3(NeuAca2-6)Galb1-4GlcNAcb1- |
| 3GlcNAcb1-6)GalNAc | 3(NeuAca2-6)GalNAc |
| NeuAca2-3Galb1-4GlcNAcb1-3(NeuAca2-3Galb1- | Fuca1-2Galb1-4(Fuca1-3)GlcNAcb1-3(Fuca1- |
| 4GlcNAcb1-6)GalNAc | 2Galb1-4(Fuca1-3)GlcNAcb1-6)GalNAc |
| GalNAc[4S]b1-4GlcNAcb1-2Mana1-3(Mana1- | GalNAc[4S]b1-4GlcNAcb1-2Mana1-3(Mana1- |
| 6)Manb1-4GlcNAcb1-4(Fuca1-6)GlcNAcb | 6)Manb1-4GlcNAcb1-4(Fuca1-6)GlcNAc |
| GalNAc[4S]b1-4GlcNAcb1-2Mana1-3(Mana1- | Mana1-3(Mana1-3(Mana1-2Mana1-6)Mana1- |
| 6)Manb1-4GlcNAcb1-4(Fuca1-3/6)GlcNAcb | 6)Manb1-4GlcNAcb1-4(Fuca1-6)GlcNAc |
| Glca1-3Mana1-2Mana1-2Mana1-3(Mana1-6)Manb1- | NeuAca2-8NeuAca2-3Galb1-3(NeuAca2-8NeuAca2- |
| 4GlcNAcb1-4(Fuca1-6)GlcNAcb | 6)GalNAc |
| GalNAcb1-4(NeuAca2-3)GalNAcb1-3Galb1-4Galb1- | GalNAcb1-4(NeuGca2-3)GalNAcb1-3Galb1-4Galb1- |
| 3(NeuGca2-6)GalNAc | 3(NeuAca2-6)GalNAc |
| GalNAcb1-4(NeuGca2-3)GalNAcb1-4Galb1-3Galb1- | NeuAca2-3Galb1-3(Fuca1-2Galb1-3GlcNAcb1- |
| 3(NeuAca2-6)GalNAca | 3Galb1-4GlcNAcb1-6)GalNAc |
| NeuAca2-3Galb1-3(Galb1-3GlcNAcb1-3Galb1- | NeuAca2-3Galb1-3(Galb1-4GlcNAcb1-3Galb1- |
| 4(Fuca1-3)GlcNAcb1-6)GalNAc | 4(Fuca1-3)GlcNAcb1-6)GalNAc |
| Gala1-3(Fuca1-2)Galb1-3(GalNAcb1-4(NeuAca2- | NeuAca2-3Galb1-3(Fuca1-4)GlcNAcb1-3Galb1- |
| 3)Galb1-4GlcNAcb1-6)GalNAc | 4GlcNAcb1-3Galb1-3GalNAc |
| NeuAca2-3Galb1-3(Fuca1-4)GlcNAcb1-3Galb1- | NeuAca2-6Galb1-4GlcNAcb1-2Mana1-3Manb1- |
| 3GlcNAcb1-3Galb1-3GalNAca | 4GlcNAcb1-4(Fuca1-6)GlcNAcb |
| Galb1-4(Fuca1-3)GlcNAcb1-3Galb1-4(Fuca1- | Galb1-4(Fuca1-3)GlcNAcb1-3Galb1-4(Fuca1- |
| 3)GlcNAcb1-3Galb1-4(Fuca1-3)GlcNAcb | 3)GlcNAcb1-3Galb1-4(Fuca1-3)GlcNAcb |
| Galb1-4(Fuca1-3)GlcNAcb1-3Galb1-4(Fuca1- | Galb1-4(Fuca1-3)GlcNAcb1-4Galb1-4(Fuca1- |
| 3)GlcNAcb1-3Galb1-4(Fuca1-3)GlcNAcb | 3)GlcNAcb1-4Galb1-4(Fuca1-3)GlcNAcb |
| Galb1-4(Fuca1-3)GlcNAcb1-3Galb1-4(Fuca1- | Fuca1-2Galb1-3GlcNAcb1-3(Fuca1-2)Galb1- |
| 3)GlcNAcb1-3Galb1-4(Fuca1-3)GlcNAcb | 3(Fuca1-2Galb1-4GlcNAcb1-6)GalNAc |
| Fuca1-2Galb1-4(Fuca1-3)GlcNAcb1-3(Fuca1- | GalNAc[4S]b1-4GlcNAcb1-2Mana1-3(Mana1- |
| 2Galb1-4GlcNAcb1-6)Galb1-3GalNAc | 3Mana1-6)Manb1-4GlcNAcb1-4GlcNAcb |
| GalNAc[4S]b1-4GlcNAcb1-2Mana1-3(Mana1- | Mana1-2Mana1-3(Mana1-3(Mana1-2Mana1- |
| 6Mana1-6)Manb1-4GlcNAcb1-4GlcNAcb | 6)Mana1-6)Manb1-4GlcNAcb1-4GlcNAc |
| Mana1-2Mana1-2Mana1-3(Mana1-3(Mana1- | |
| 6)Mana1-6)Manb1-4GlcNAcb1-4GlcNAc | |
| Mana1-2Mana1-3(Mana1-3(Mana1-2Mana1- | Mana1-2Mana1-2Mana1-3(Mana1-3(Mana1- |
| 6)Mana1-6)Manb1-4GlcNAcb1-4GlcNAcb | 6)Mana1-6)Manb1-4GlcNAcb1-4GlcNAcb |
| Mana1-2Mana1-3(Mana1-3(Mana1-3Mana1- | Glca1-3Glca1-3Mana1-2Mana1-2Mana1-3(Mana1- |
| 6)Mana1-6)Manb1-4GlcNAcb1-4GlcNAc | 6)Mana1-4GlcNAcb1-4GlcNAc |
| Mana1-2Mana1-3(Mana1-3(Mana1-2Mana1- | Mana1-2Mana1-2Mana1-3(Mana1-2Mana1-3Mana1- |
| 6)Mana1-6)Manb1-4GlcNAcb1-4GlcNAc | 6)Manb1-4GlcNAcb1-4GlcNAc |
| Mana1-3(Mana1-2Mana1-3(Mana1-2Mana1- | Mana1-2Mana1-2Mana1-6Mana1-3Mana1-6Mana1- |
| 6)Mana1-6)Manb1-4GlcNAcb1-4GlcNAc | 3Manb1-4GlcNAcb1-4GlcNAc |
| Mana1-2Mana1-3(Mana1-2Mana1-6)Mana1- | Mana1-2Mana1-3(Mana1-2Mana1-3(Mana1- |
| 6(Manb1-3)Manb1-4GlcNAcb1-4GlcNAc | 6)Mana1-6)Manb1-4GlcNAcb1-4GlcNAc |
| Mana1-3(Mana1-2Mana1-6)Glca1-6(Mana1- | Mana1-6(Manb1-3)Glca1-6(Mana1-2Mana1- |
| 2Mana1-3)Manb1-4GlcNAcb1-4GlcNAc | 2Mana1-3)Manb1-4GlcNAcb1-4GlcNAc |
| Glca1-3Mana1-2Mana1-2Mana1-3(Mana1-3Mana1- | Mana1-2Mana1-2(Mana1-2Mana1-6)Mana1- |
| 6)Manb1-4GlcNAcb1-4GlcNAc | 3(Mana1-6)Manb1-4GlcNAcb1-4GlcNAc |
| Mana1-3Mana1-2Mana1-2(Mana1-6)Mana1- | Glca1-2Mana1-2Mana1-2Mana1-3(Mana1-6Mana1- |
| 3(Mana1-6)Manb1-4GlcNAcb1-4GlcNAc | 6)Manb1-4GlcNAcb1-4GlcNAc |
| Glca1-3Mana1-2Mana1-2Mana1-3(Mana1-3Mana1- | Mana1-2Mana1-2Mana1-3(Mana1-3(Mana1- |
| 6)Manb1-4GlcNAcb1-4GlcNAcb | 6)Mana1-6)Manb1-4GlcNAcb1-4GlcNAc |
| Mana1-3(Mana1-2Mana1-3(Mana1-2Mana1- | Mana1-3(Mana1-2Mana1-3(Mana1-2Mana1- |
| 6)Mana1-6)Manb1-4GlcNAcb1-4GlcNAcb | 6)Mana1-6)Manb1-4GlcNAcb1-4GlcNAc |
| Mana1-2Mana1-3(Mana1-2Mana1-3(Mana1- | Mana1-3(Mana1-2Mana1-2Mana1-3(Mana1- |
| 6)Mana1-6)Manb1-4GlcNAcb1-4GlcNAc | 6)Mana1-6)Manb1-4GlcNAcb1-4GlcNAc |
| Mana1-2Mana1-2Mana1-3(Mana1-2Mana1-3Mana1- | Glca1-2Glca1-3Glca1-2Mana1-2Mana1-2Mana1- |
| 6)Manb1-4GlcNAcb1-4GlcNAcb | 3Manb1-4GlcNAcb1-4GlcNAc |
| Mana1-2Mana1-3(Mana1-2Mana1-3(Mana1- | Glca1-3Glca1-3Mana1-2Mana1-2Mana1-3(Mana1- |
| 6)Mana1-6)Manb1-4GlcNAcb1-4GlcNAcbb | 6)Manb1-4GlcNAcb1-4GlcNAcb |
| Mana1-3(Mana1-2Mana1-6)Mana1-3(Mana1- | Mana1-2Mana1-3Mana1-3(Mana1-2Mana1-2Mana1- |
| 2Mana1-6)Manb1-4GlcNAcb1-4GlcNAc | 6)Manb1-4GlcNAcb1-4GlcNAc |
| Mana1-2Mana1-3(Mana1-2Mana1-3(Mana1- | Mana1-3(Mana1-6)Mana1-3(Mana1-2Mana1- |
| 6)Mana1-6)Manb1-4GlcNAcb1-4GlcNAcb | 2Mana1-6)Manb1-4GlcNAcb1-4GlcNAc |
| Gala1-3Galb1-4GlcNAcb1-2Mana1-3(Mana1- | Mana1-2Mana1-2Mana1-3(Mana1-2Mana1-6Mana1- |
| 3(Mana1-6)Mana1-6)Manb1-4GlcNAc | 6)Manb1-4GlcNAcb1-4GlcNAc |
| | Mana1-3(Mana1-3(Mana1-2Mana1-2Mana1- |
| | 6)Mana1-6)Manb1-4GlcNAcb1-4GlcNAc |
| GalNAcb1-4GlcNAcb1-2(GalNAcb1-4GlcNAcb1- | GalNAcb1-4(NeuGca2-3)GalNAcb1-3Galb1-4Galb1- |
| 4)Mana1-3Manb1-4GlcNAcb1-4GlcNAc | 3(NeuGca2-6)GalNAc |
| NeuAca2-6Galb1-4GlcNAcb1-2Mana1-3(Mana1- | Mana1-3(NeuAca2-6Galb1-4GlcNAcb1-2Mana1- |
| 6)Manb1-4GlcNAcb1-4GlcNAcb | 6)Manb1-4GlcNAcb1-4GlcNAcb |
| NeuAca2-6Galb1-4GlcNAcb1-2Mana1-3(Mana1- | GlcNAcb1-2Mana1-3(NeuAca2-6Galb1-4GlcNAcb1- |
| 6)Manb1-4GlcNAcb1-4GlcNAc | 2Mana1-6)Manb1-4GlcNAc |
| NeuAca2-3Galb1-4GlcNAcb1-2Mana1-3(Mana1- | NeuAca2-3Galb1-4GlcNAcb1-2Mana1-3(Mana1- |
| 6)Manb1-4GlcNAcb1-4GlcNAcb | 6)Manb1-4GlcNAcb1-4GlcNAc |
| Mana1-3(NeuAca2-6Galb1-4GlcNAcb1-2Mana1- | NeuAca2-6Galb1-4GlcNAcb1-2Mana1-3(GlcNAcb1- |
| 6)Manb1-4GlcNAcb1-4GlcNAc | 2Mana1-6)Manb1-4GlcNAc |
| NeuAca2-6Galb1-4GlcNAcb1-2Mana1-3(Mana1- | Mana1-3(NeuAca2-3Galb1-4GlcNAcb1-2Mana1- |
| 6)Manb1-4GlcNAcb1-4GlcNAc | 6)Manb1-4GlcNAcb1-4GlcNAc |
| NeuAca2-3/6Galb1-4GlcNAcb1-2Mana1-3(Mana1- | Galb1-4(Fuca1-3)GlcNAcb1-2Mana1-3(Mana1- |
| 6)Manb1-4GlcNAcb1-4GlcNAc | 6)Manb1-4GlcNAcb1-4(Fuca1-6)GlcNAc |
| Mana1-3(Galb1-4(Fuca1-3)GlcNAcb1-2Mana1- | Galb1-4(Fuca1-3)GlcNAcb1-2Mana1-3(Mana1- |
| 6)Manb1-4GlcNAcb1-4(Fuca1-6)GlcNAc | 6)Manb1-4GlcNAcb1-4(Fuca1-6)GlcNAcb |
| GalNAca1-3(Fuca1-2)Galb1-4(Fuca1-3)GlcNAcb1- | Fuca1-2Galb1-4GlcNAcb1-2Mana1-3(Mana1- |
| 3Galb1-4GlcNAcb1-3Galb1-4Glcb | 6)Manb1-4GlcNAcb1-4(Fuca1-6)GlcNAcb |
| Mana1-3(Fuca1-2Galb1-4GlcNAcb1-2Mana1- | NeuAca2-3Gal[6S]b1-3Galb1-3(NeuAca2-3Galb1- |
| 6)Manb1-4GlcNAcb1-4(Fuca1-6)GlcNAcb | 4GlcNAcb1-6)GalNAc |
| NeuAca2-3Galb1-3GalNAcb1-4(NeuAca2-8NeuAca2- | NeuAca2-8NeuAca2-3Galb1-3GalNAcb1-4(NeuAca2- |
| 3)Galb1-4Glcb | 3)Galb1-4Glcb |
| NeuGca2-3/6Galb1-4GlcNAcb1-2Mana1-3(Mana1- | Fuca1-4(Fuca1-5)Kdna1-3Galb1-3(Fuca1-2Galb1- |
| 6)Manb1-4GlcNAcb1-4GlcNAc | 4(Fuca1-3)GlcNAcb1-6)GalNAc |
| Fuca1-2(Fuca1-3)Fuca1-4Kdna1-3Galb1-3(Galb1- | Gala1-3Galb1-4GlcNAcb1-2Mana1-3(Mana1- |
| 4(Fuca1-3)GlcNAcb1-6)GalNAc | 6)Manb1-4GlcNAcb1-4(Fuca1-6)GlcNAcb |
| Galb1-4GlcNAcb1-2Mana1-3(Mana1-3Mana1- | GlcNAcb1-2Mana1-3(Mana1-3(Mana1-6)Mana1- |
| 6)Manb1-4GlcNAcb1-4(Fuca1-6)GlcNAc | 6)Manb1-4GlcNAcb1-4(Fuca1-3)GlcNAc |
| Galb1-4(Fuca1-3)GlcNAcb1-2Mana1-3(Mana1- | GlcNAcb1-2Mana1-3(Mana1-3(Mana1-6)Mana1- |
| 3Mana1-6)Manb1-4GlcNAcb1-4GlcNAc | 6)Manb1-4GlcNAcb1-4(Fuca1-6)GlcNAc |
| GlcNAcb1-2Mana1-3(Mana1-3(Mana1-6)Mana1- | |
| 6)Manb1-4GlcNAcb1-4(Fuca1-6)GlcNAcb | |
| Galb1-4GlcNAcb1-2Mana1-3(Mana1-3Mana1- | GlcNAcb1-2Mana1-3(GlcNAcb1-2Man[6PE]a1- |
| 6)Mana1-4GlcNAcb1-4(Fuca1-6)GlcNAc | 6)Manb1-4GlcNAcb1-4(Fuca1-6)GlcNAc |
| GalNAca1-3(Fuca1-2)Galb1-3(GalNAcb1- | GlcNAcb1-3(Fuca1-2Galb1-4(Fuca1-3)GlcNAcb1- |
| 4(NeuAca2-3)Galb1-4GlcNAcb1-6)GalNAc | 3(Fuca1-2)Galb1-4GlcNAcb1-6)GalNAca |
| GalNAc[4S]b1-4GlcNAcb1-2Mana1-3(GlcNAcb1- | GlcNAcb1-2Mana1-3(GalNAc[4S]b1-4GlcNAcb1- |
| 2Mana1-6)Manb1-4GlcNAcb1-4GlcNAcb | 2Mana1-6)Manb1-4GlcNAcb1-4GlcNAcb |
| Galb1-4GlcNAcb1-4Mana1-3(Galb1-4GlcNAcb1- | GlcNAcb1-4(Galb1-4GlcNAcb1-2Mana1-3)(Galb1- |
| 2(Galb1-4GlcNAcb1-6)Mana1-6)Man | 4GlcNAcb1-2Mana1-6)Manb1-4Glcb |
| GlcNAcb1-4(Mana1-2Mana1-3)(Mana1-3(Mana1- | Galb1-4GlcNAcb1-2Mana1-3(Mana1-3(Mana1- |
| 6)Mana1-6)Manb1-4GlcNAcb1-4GlcNAc | 6)Mana1-6)Manb1-4GlcNAcb1-4GlcNAc |
| Galb1-4GlcNAcb1-2Mana1-3(Mana1-2Mana1- | Galb1-4GlcNAcb1-2(Galb1-4GlcNAcb1-4)Mana1- |
| 3Mana1-6)Manb1-4GlcNAcb1-4GlcNAc | 3(Galb1-4GlcNAcb1-2Mana1-6)Man |
| Galb1-4GlcNAcb1-2Mana1-3(Mana1-3(Mana1- | Galb1-4GlcNAcb1-2Mana1-3(Galb1-4GlcNAcb1- |
| 6)Mana1-6)Manb1-4GlcNAcb1-4GlcNAcb | 2(Galb1-4GlcNAcb1-6)Mana1-6)Man |
| NeuAca2-6GalNAcb1-4GlcNAcb1-2Mana1-3(Mana1- | NeuAca2-6GalNAcb1-4GlcNAcb1-2Mana1-3(Mana1- |
| 6)Manb1-4GlcNAcb1-4GlcNAcb | 6)Manb1-4GlcNAcb1-4GlcNAc |
| GlcNAcb1-2Mana1-3(GlcNAcb1-2Mana1-6)Manb1- | Fuca1-2Galb1-3GlcNAcb1-3(Fuca1-2Galb1- |
| 4GlcNAcb1-4(Fuca1-3)(Fuca1-6)GlcNAcb | 3GlcNAcb1-6)Galb1-3(GlcNAcb1-6)GalNAc |
| GalNAcb1-4(Fuca1-3)GlcNAcb1-2Mana1-3(Mana1- | GalNAca1-3(Fuca1-2)Galb1-3(Galb1-3GlcNAca1- |
| 6)Manb1-4GlcNAcb1-4(Fuca1-6)GlcNAcb | 3(Fuca1-2)Galb1-4GlcNAcb1-6)GalNAc |
| GlcNAcb1-2Mana1-3(GlcNAcb1-2Mana1-6)Manb1- | GalNAcb1-4(Fuca1-3)GlcNAcb1-2Mana1-3(Mana1- |
| 4GlcNAcb1-4(Fuca1-3)(Fuca1-6)GlcNAc | 6)Manb1-4GlcNAcb1-4(Fuca1-6)GlcNAc |
| Fuca1-2Galb1-3GlcNAcb1-3(Fuca1-2Galb1- | GalNAcb1-4(Fuca1-3)GlcNAcb1-2Mana1-3(Mana1- |
| 4GlcNAcb1-6)Galb1-3(GlcNAcb1-6)GalNAc | 6)Manb1-4GlcNAcb1-4(Fuca1-3)GlcNAcb |
| GalNAcb1-4(Fuca1-3)GlcNAcb1-2Mana1-3(Mana1- | GalNAcb1-4(Fuca1-3)GlcNAcb1-2Mana1-3(Mana1- |
| 6)Manb1-4GlcNAcb1-4(Fuca1-6)GlcNAc | 6)Manb1-4GlcNAcb1-4(Fuca1-3)GlcNAc |
| GalNAcb1-4(Fuca1-3)GlcNAcb1-2Mana1-3(Mana1- | Galb1-3(NeuGca2-8NeuGca2-8NeuGca2-8NeuGca2- |
| 6)Manb1-4GlcNAcb1-4(Fuca1-3)GlcNAc | 6)GalNAc |
| Neua1-3Galb1-4GlcNAcb1-2Mana1-3(Mana1- | Neua1-3Galb1-4GlcNAcb1-2Mana1-3(Galb1- |
| 3Mana1-6)Manb1-4GlcNAcb1-4GlcNAc | 4GlcNAcb1-2Mana1-6)Manb1-4GlcNAc |
| GalNAcb1-4Galb1-3Galb1-3(NeuAca2-8NeuAca2- | Fuca1-2(Fuca1-3)Fuca1-4Kdna1-3Galb1- |
| 8NeuAca2-6)GalNAca | 3(GalNAcb1-4(Fuca1-3)GlcNAcb1-6)GalNAc |
| Galb1-4GlcNAcb1-2Mana1-3(GlcNAcb1-2Mana1- | GlcNAcb1-2Mana1-3(Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| Galb1-4GlcNAcb1-2Mana1-3(GlcNAcb1-2Mana1- | GlcNAcb1-2Mana1-3(Galb1-4GlcNAcb1-2Mana1- |
| 6)Manb1-4GlcNAcb1-4(Fuca1-6)GlcNAcb | 6)Manb1-4GlcNAcb1-4(Fuca1-6)GlcNAc |
| GalNAcb1-4GlcNAcb1-2Mana1-3(Mana1-3Mana1- | GlcNAcb1-4(Galb1-4GlcNAcb1-2Mana1-3)(Mana1- |
| 6)Manb1-4GlcNAcb1-4(Fuca1-6)GlcNAc | 6)Manb1-4GlcNAcb1-4(Fuca1-6)GlcNAc |
| GalNAcb1-4GlcNAcb1-2Mana1-3(GlcNAcb1-2Mana1- | GlcNAcb1-4(Galb1-4(Fuca1-3)GlcNAcb1-2Mana1- |
| 6)Manb1-4GlcNAcb1-4(Fuca1-6)Man | 3)(Mana1-6)Manb1-4GlcNAcb1-4GlcNAc |
| GlcNAcb1-2Glca1-3(Galb1-4GlcNAcb1-2Glca1- | GlcNAcb1-4(Mana1-3)(Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| Galb1-4(Fuca1-3)GlcNAcb1-2Mana1-3(GlcNAcb1- | GlcNAcb1-4(Galb1-4GlcNAcb1-2Mana1-3)(Mana1- |
| 2Mana1-6)Manb1-4GlcNAcb1-4GlcNAc | 6)Manb1-4GlcNAcb1-4(Fuca1-6)GlcNAcb |
| Galb1-3GlcNAcb1-2Mana1-3(GlcNAcb1-2Mana1- | GlcNAcb1-2Mana1-3(Gala1-4GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(Galb1-4GlcNAcb1-2Mana1-3)(Mana1- | GlcNAcb1-2Mana1-3(Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAcb |
| Galb1-4GlcNAcb1-2Mana1-3(GlcNAcb1-4Mana1- | Galb1-4GlcNAcb1-2Mana1-3(GlcNAcb1-2Mana1- |
| 6)Manb1-4GlcNAcb1-4(Fuca1-6)GlcNAcb | 6)Manb1-4GlcNAcb1-4(Fuca1-6)GlcNAc |
| Fuca1-2Galb1-4GlcNAcb1-2Mana1-3(GlcNAcb1- | Fuca1-2Galb1-3GlcNAcb1-3(Galb1-4GlcNAcb1- |
| 2Mana1-6)Manb1-4GlcNAcb1-4GlcNAcb | 6)Galb1-3(Galb1-4GlcNAcb1-6)GalNAc |
| Fuca1-2Galb1-4GlcNAcb1-2Mana1-3(GlcNAcb1- | GalNAcb1-4GlcNAcb1-2Mana1-3(Mana1-3Mana1- |
| 2Mana1-6)Manb1-4GlcNAcb1-4GlcNAc | 6)Manb1-4GlcNAcb1-4(Fuca1-6)GlcNAc |
| GlcNAcb1-2(Galb1-4GlcNAcb1-4)Mana1-3(Mana1- | Galb1-4GlcNAc[6S]b1-3Galb1-4GlcNAc[6S]b1- |
| 6)Manb1-4GlcNAcb1-4(Fuca1-6)GlcNAc | 3Galb1-4GlcNAcb1-3Galb1-3GalNAc |
| Glca1-2Glca1-3Glca1-3Mana1-2Mana1-2Mana1- | Fuca1-4(Fuca1-5)Kdna1-3Galb1-3(GalNAca1- |
| 3(Mana1-2Mana1-3Mana1-6)Man | 3(Fuca1-2)Galb1-4GlcNAcb1-6)GalNAc |
| Galb1-4GlcNAcb1-2Mana1-3(Galb1-4GlcNAcb1- | GlcNAcb1-4(Galb1-4GlcNAcb1-2Mana1-3)(Galb1- |
| 2Mana1-6)Manb1-4GlcNAcb1-4GlcNAc | 4GlcNAcb1-2Mana1-6)Manb1-4GlcNAc |
| GlcNAcb1-4(GlcNAcb1-2Mana1-3)(Mana1-3(Mana1- | Galb1-4GlcNAcb1-2Mana1-3(Galb1-4GlcNAcb1- |
| 6)Mana1-6)Manb1-4GlcNAcb1-4GlcNAcb | 2Mana1-6)Manb1-4GlcNAcb1-4GlcNAcb |
| GlcNAcb1-4(GlcNAcb1-2Mana1-3)(Mana1-3(Mana1- | Galb1-3GlcNAcb1-2Mana1-3(Galb1-3GlcNAcb1- |
| 6)Mana1-6)Manb1-4GlcNAcb1-4GlcNAc | 2Mana1-6)Manb1-4GlcNAcb1-4GlcNAc |
| Galb1-3GlcNAcb1-2Mana1-3(Galb1-4GlcNAcb1- | Galb1-4GlcNAcb1-4Mana1-3(Galb1-4GlcNAcb1- |
| 2Mana1-6)Manb1-4GlcNAcb1-4GlcNAc | 2Mana1-6)Manb1-4GlcNAcb1-4GlcNAc |
| Galb1-4GlcNAcb1-2(Galb1-4GlcNAcb1-4)Mana1- | Mana1-3(Galb1-4GlcNAcb1-2(Galb1-4GlcNAcb1- |
| 3(Mana1-6)Manb1-4GlcNAcb1-4GlcNAcb | 6)Mana1-6)Manb1-4GlcNAcb1-4GlcNAc |
| Mana1-3(Galb1-4GlcNAcb1-2(Galb1-4GlcNAcb1- | Galb1-4GlcNAcb1-2Mana1-3(Galb1-4GlcNAcb1- |
| 6)Mana1-6)Manb1-4GlcNAcb1-4GlcNAcb | 2Mana1-6)Manb1-4GlcNAcb1-3GlcNAcb |
| Galb1-4GlcNAcb1-2Mana1-3(Galb1-4GlcNAcb1- | Galb1-4GlcNAcb1-4Mana1-3(Galb1-4GlcNAcb1- |
| 2Mana1-6)Manb1-4GlcNAcb1-4GlcNAc | 6Mana1-6)Manb1-4GlcNAcb1-4GlcNAc |
| Galb1-4GlcNAcb1-2Mana1-3(Galb1-4GlcNAcb1- | Galb1-4GlcNAcb1-4Mana1-3(Galb1-4GlcNAcb1- |
| 6Mana1-6)Manb1-4GlcNAcb1-4GlcNAc | 2Mana1-6)Manb1-4GlcNAcb1-4GlcNAcb |
| Galb1-4GlcNAcb1-2(Galb1-4GlcNAcb1-4)Mana1- | Galb1-3GlcNAcb1-2Mana1-3(Galb1-4GlcNAcb1- |
| 3(Mana1-6)Manb1-4GlcNAcb1-4GlcNAc | 2Mana1-6)Manb1-4GlcNAcb1-4GlcNAcb |
| GlcNAcb1-4(GlcNAcb1-2Mana1-3)(Mana1-3(Mana1- | GlcNAcb1-4(GlcNAcb1-2Mana1-3)(Mana1-3(Mana1- |
| 6)Mana1-6)Manb1-4GlcNAcb1-4GlcNAc | 6)Mana1-6)Manb1-4GlcNAcb1-4GlcNAcb |
| Galb1-4GlcNAcb1-2Mana1-3(Galb1-4GlcNAcb1- | Galb1-4GlcNAcb1-4Mana1-3(Galb1-4GlcNAcb1- |
| 2Mana1-6)Mana1-4GlcNAcb1-4GlcNAcbb | 4Mana1-6)Manb1-4GlcNAcb1-4GlcNAcb |
| GlcNAcb1-2Mana1-3(GlcNAcb1-4(Mana1-3)(Mana1- | Glcb1-4GlcNAcb1-2Mana1-3(Glcb1-4GlcNAcb1- |
| 6)Mana1-6)Manb1-4GlcNAcb1-4GlcNAcb | 2Mana1-6)Manb1-4GlcNAcb1-4GlcNAc |
| GlcNAcb1-4(GlcNAcb1-3Mana1-3)(Mana1-3(Mana1- | GlcNAcb1-2Mana1-3(Gala1-3Galb1-4GlcNAcb1- |
| 6)Mana1-6)Manb1-4GlcNAcb1-4GlcNAc | 2Mana1-6)Manb1-4GlcNAcb1-4GlcNAc |
| GalNAcb1-4GlcNAcb1-2Mana1-3(Mana1-3(Mana1- | GalNAcb1-4GlcNAcb1-2Mana1-3(Mana1-2Mana1- |
| 6)Mana1-6)Manb1-4GlcNAcb1-4GlcNAc | 3Mana1-6)Manb1-4GlcNAcb1-4GlcNAc |
| GlcNAcb1-4(Mana1-3)(GlcNAcb1-2Mana1-3(Mana1- | GlcNAcb1-4(GlcNAcb1-2Mana1-3)(Mana1-3(Mana1- |
| 6)Mana1-6)Manb1-4GlcNAcb1-4GlcNAcb | 6)Mana1-6)Manb1-4GlcNAcb1-4GlcNAc |
| GalNAcb1-4GlcNAcb1-2Mana1-3(Mana1-3(Mana1- | Galb1-4GlcNAcb1-2Mana1-3(Galb1-4GlcNAcb1- |
| 6)Mana1-6)Manb1-4GlcNAcb1-4GlcNAc | 2Mana1-6)Manb1-4GlcNAcb1-4GlcNAc |
| GalNAca1-3(Fuca1-2)Galb1-3(GalNAca1-3(Fuca1- | GalNAcb1-4GlcNAcb1-2Mana1-3(GlcNAcb1-2Mana1- |
| 2)Galb1-4GlcNAcb1-3GlcNAcb1-6)GalNAc | 6)Manb1-4GlcNAcb1-4(Fuca1-6)GlcNAcb |
| GlcNAcb1-4(GlcNAcb1-2Mana1-3)(GlcNAcb1- | GlcNAcb1-4(GlcNAcb1-2Mana1-3)(GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| GlcNAcb1-2Mana1-3(GalNAcb1-4GlcNAcb1-2Mana1- | GalNAcb1-4GlcNAcb1-2Mana1-3(GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GalNAcb1-4(Fuca1-3)GlcNAcb1-2Mana1- | GlcNAcb1-2Mana1-3(GlcNAcb1-2(GlcNAcb1- |
| 3(GlcNAcb1-2Mana1-6)Manb1-4GlcNAcb1-4GlcNAc | 6)Mana1-6)Manb1-4GlcNAcb1-4(Fuca1-6)GlcNAc |
| GlcNAcb1-2(GlcNAcb1-4)Mana1-3(GlcNAcb1- | GlcNAcb1-2Mana1-3(GlcNAcb1-2(GlcNAcb1- |
| 2Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-2Mana1-3(GlcNAcb1-2(GlcNAcb1- | GlcNAcb1-4(GlcNAcb1-2Mana1-3)(GlcNAcb1- |
| 6)Mana1-6)Manb1-4GlcNAcb1-4(Fuca1-6)GlcNAcb | 2Mana1-6)Mana1-4GlcNAcb1-4(Fuca1-6)GlcNAc |
| GlcNAcb1-2(GlcNAcb1-4)Mana1-3(GlcNAcb1- | GlcNAcb1-2Mana1-3(GlcNAcb1-2Mana1- |
| 2Mana1-6)Manb1-4GlcNAcb1-4(Fuca1-6)GlcNAcb | 6)GlcNAcb1-4Manb1-4GlcNAcb1-4(Fuca1-6)GlcNAc |
| GlcNAcb1-4(GlcNAcb1-2(GlcNAcb1-4)Mana1- | GalNAcb1-4GlcNAcb1-2Mana1-3(GlcNAcb1-2Mana1- |
| 3)(Mana1-6)Manb1-4GlcNAcb1-4(Fuca1-6)GlcNAcb | 6)Manb1-4GlcNAcb1-4(Fuca1-6)GlcNAc |
| GlcNAcb1-2(GlcNAcb1-4)Mana1-3(GlcNAcb1- | GlcNAcb1-2(GlcNAcb1-6)Mana1-3(GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| GlcNAcb1-4(GlcNAcb1-2Mana1-3)(GlcNAcb1- | GalNAca1-3(Fuca1-2)Galb1-4GlcNAcb1-3Galb1- |
| 2Mana1-6)Manb1-4GlcNAcb1-4(Fuca1-6)GlcNAcb | 4GlcNAcb1-3Galb1-4GlcNAcb1-3GalNAc |
| GalNAc[4S]b1-4GlcNAcb1-2Mana1- | Mana1-2Mana1-2Mana1-3(Mana1-2Mana1- |
| 3(GalNAc[4S]b1-4GlcNAcb1-2Mana1-6)Manb1- | 3(Mana1-2Mana1-6)Mana1-6)Manb1-4GlcNAc |
| 4GlcNAc | |
| Mana1-2Mana1-2Mana1-3(Mana1-3(Mana1- | Mana1-3Mana1-2Mana1-2(Mana1-6)Mana1- |
| 2(Mana1-6)Mana1-6)Mana1-6)Manb1-4GlcNAc | 3(Mana1-3(Mana1-6)Mana1-6)Manb1-4GlcNAc |
| Mana1-3Mana1-2Mana1-2Mana1-3(Mana1- | Glcb1-3Mana1-2Mana1-2Mana1-3(Mana1-3(Mana1- |
| 3(Mana1-2Mana1-6)Mana1-6)Manb1-4GlcNAc | 2Mana1-6)Mana1-6)Manb1-4GlcNAc |
| Glca1-3Glca1-3Mana1-2Mana1-2Mana1-3(Mana1- | Mana1-2Mana1-3Mana1-3(Mana1-2Mana1- |
| 2Mana1-3Mana1-6)Manb1-4GlcNAc | 3(Mana1-2Mana1-6)Mana1-6)Manb1-4GlcNAc |
| Mana1-2Mana1-2Mana1-3(Mana1-2Mana1- | Mana1-2Mana1-2Mana1-3(Mana1-3(Mana1- |
| 3(Mana1-2Mana1-6)Mana1-6)Manb1-3GlcNAc | 2Mana1-6Mana1-6)Mana1-6)Manb1-4GlcNAc |
| Glca1-3Mana1-2Mana1-2Mana1-3(Mana1-3(Mana1- | Mana1-2Mana1-2(Mana1-6)Mana1-3(Mana1- |
| 2Mana1-6)Mana1-6)Manb1-4GlcNAc | 3(Mana1-2Mana1-6)Mana1-6)Manb1-4GlcNAc |
| Mana1-2Mana1-2(Mana1-2Mana1-6)Mana1- | Mana1-2Mana1-2Mana1-3(Mana1-2Mana1- |
| 3(Mana1-3(Mana1-6)Mana1-6)Manb1-4GlcNAc | 3(Mana1-2Mana1-6)Mana1-6)Mana1-4GlcNAc |
| Mana1-2Mana1-2Mana1-3(Mana1-2Mana1- | Mana1-2Mana1-2Mana1-3(Mana1-2Mana1- |
| 3(Mana1-2Mana1-6)Manb1-6)Manb1-4GlcNAc | 3(Mana1-2Mana1-6)Mana1-6)Manb1-4GlcNAcb |
| Mana1-2Mana1-2(Mana1-6)Mana1-3(Mana1- | GlcNAcb1-4(GlcNAcb1-2Mana1-3)(Galb1- |
| 3(Mana1-2Mana1-6)Mana1-6)Mana1-4GlcNAc | 4GlcNAcb1-2Mana1-6)Manb1-4GlcNAcb1-4GlcNAc |
| GlcNAcb1-4(Galb1-4GlcNAcb1-2Mana1- | GalNAcb1-4GlcNAcb1-2Mana1-3(Galb1-4GlcNAcb1- |
| 3)(GlcNAcb1-2Mana1-6)Manb1-4GlcNAcb1-4GlcNAc | 2Mana1-6)Manb1-4GlcNAcb1-4GlcNAc |
| Galb1-4GlcNAcb1-2(GlcNAcb1-4)Mana1- | Galb1-4GlcNAcb1-2(GlcNAcb1-4)Mana1- |
| 3(GlcNAcb1-2Mana1-6)Manb1-4GlcNAcb1-4GlcNAcb | 3(GlcNAcb1-2Mana1-6)Manb1-4GlcNAcb1-4GlcNAc |
| GlcNAcb1-2(GlcNAcb1-4)Mana1-3(GlcNAcb1- | Galb1-4GlcNAcb1-2Mana1-3(GalNAcb1-4GlcNAcb1- |
| 4(Mana1-3)Mana1-6)Manb1-4GlcNAcb1-4GlcNAcb | 2Mana1-6)Manb1-4GlcNAcb1-4GlcNAc |
| GlcNAcb1-4(GlcNAcb1-2(GlcNAcb1-4)Mana1- | GlcNAcb1-2(Galb1-3GlcNAcb1-4)Mana1- |
| 3)(Mana1-3Mana1-6)Manb1-4GlcNAcb1-4GlcNAc | 3(GlcNAcb1-2Mana1-6)Manb1-4GlcNAcb1-4GlcNAc |
| GlcNAcb1-2Mana1-3(Galb1-4GlcNAcb1-2(GlcNAcb1- | GlcNAcb1-2Mana1-3(GlcNAcb1-2(Galb1-4GlcNAcb1- |
| 6)Mana1-6)Manb1-4GlcNAcb1-4GlcNAc | 4)Mana1-6)Manb1-4GlcNAcb1-4GlcNAcb |
| GlcNAcb1-4(GlcNAcb1-2(Galb1-4GlcNAcb1- | GlcNAcb1-4(GlcNAcb1-2(GlcNAcb1-4)Mana1- |
| 4)Mana1-3)(Mana1-6)Manb1-4GlcNAcb1-4GlcNAc | 3)(Mana1-3Mana1-6)Manb1-4GlcNAcb1-4GlcNAcb |
| GlcNAcb1-4(GlcNAcb1-2(GlcNAcb1-4)Mana1- | |
| 3)(Mana1-3Mana1-6)Manb1-4GlcNAcb1-4GlcNAc | |
| GlcNAcb1-4(GalGalb1-4GlcNAcb1-2Mana1- | GlcNAcb1-4(GlcNAcb1-2Mana1-3)(Galb1- |
| 3)(GlcNAcb1-2Mana1-6)Manb1-4GlcNAcb1-4GlcNAc | 4GlcNAcb1-2Mana1-6)Manb1-4GlcNAcb1-4GlcNAc |
| GlcNAcb1-4(GlcNAcb1-2Mana1-3)(Galb1- | GlcNAcb1-4(Galb1-4GlcNAcb1-2Mana1- |
| 4GlcNAcb1-2Mana1-6)Manb1-4GlcNAcb1-4GlcNAcb | 3)(GlcNAcb1-2Mana1-6)Manb1-4GlcNAcb1- |
| | 4GlcNAcb |
| GlcNAcb1-2(GlcNAcb1-4)Mana1-3(Galb1- | GlcNAcb1-2(GlcNAcb1-4)Mana1-3(Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAcb |
| NeuAca2-3Galb1-4GlcNAcb1-2Mana1-3(Mana1- | NeuAca2-3Galb1-4GlcNAcb1-2Mana1-3(Galb1- |
| 3(Mana1-6)Mana1-6)Manb1-4GlcNAc | 4GlcNAcb1-2Mana1-6)Manb1-4Glcb |
| NeuAca2-3Galb1-3GlcNAcb1-3Galb1-3(NeuAca2- | NeuAca2-3Galb1-4GlcNAcb1-3Galb1-3(NeuAca2- |
| 3Galb1-4GlcNAcb1-6)GalNAc | 3Galb1-4GlcNAcb1-6)GalNAc |
| Fuca1-2Galb1-3(Fuca1-2Galb1-4(Fuca1- | GalNAc[4S]b1-4GlcNAcb1-2Mana1-3(Mana1- |
| 3)GlcNAcb1-3(Fuca1-2)Galb1-4GlcNAcb1- | 3Mana1-6)Manb1-4GlcNAcb1-4(Fuca1-6)GlcNAc |
| 6)GalNAca | |
| GalNAc[4S]b1-4GlcNAcb1-2Mana1-3(Mana1- | GalNAc[4S]b1-4GlcNAcb1-2Mana1-3(Mana1- |
| 3Mana1-6)Manb1-4GlcNAcb1-4(Fuca1-6)GlcNAcb | 6Mana1-6)Manb1-4GlcNAcb1-4(Fuca1-6)GlcNAcb |
| Mana1-3(Mana1-3(Mana1-2Mana1-2Mana1- | Mana1-3(Mana1-3(Glca1-3Mana1-2Mana1- |
| 6)Mana1-6)Manb1-4GlcNAcb1-4(Fuca1-6)GlcNAc | 6)Mana1-6)Manb1-4GlcNAcb1-4(Fuca1-6)GlcNAcb |
| Glca1-3Glca1-3Mana1-2Mana1-2Mana1-3(Mana1- | GalNAcb1-4GlcNAcb1-2(GalNAcb1-4GlcNAcb1- |
| 6)Manb1-4GlcNAcb1-4(Fuca1-6)GlcNAcb | 4)Mana1-3Manb1-4GlcNAcb1-4(Fuca1-6)GlcNAc |
| Galb1-3Galb1-3(NeuAca2-8NeuAca2-8NeuAca2- | NeuAca2-3Galb1-4GlcNAcb1-2Mana1-3(Mana1- |
| 8NeuAca2-6)GalNAca | 6)Manb1-4GlcNAcb1-4(Fuca1-6)GlcNAcb |
| NeuAca2-3Galb1-3GlcNAcb1-2Mana1-3(Mana1- | NeuAca2-3Galb1-4GlcNAcb1-2Mana1-3(Mana1- |
| 6)Manb1-4GlcNAcb1-4(Fuca1-6)GlcNAcb | 6)Manb1-4GlcNAcb1-4(Fuca1-6)GlcNAc |
| NeuAca2-6Galb1-4GlcNAcb1-2Mana1-3(Mana1- | NeuAca2-6Galb1-4GlcNAcb1-2Mana1-3(Mana1- |
| 6)Manb1-4GlcNAcb1-4Fuca1-6)GlcNAcb | 6)Manb1-4GlcNAcb1-4(Fuca1-6)GlcNAc |
| NeuAca2-3Galb1-3GlcNAcb1-2Mana1-3(Mana1- | Mana1-3(NeuAca2-3Galb1-3GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| | Mana1-3(NeuAca2-6Galb1-4GlcNAcb1-2Mana1- |
| | 6)Manb1-4GlcNAcb1-4(Fuca1-6)GlcNAcb |
| NeuAca2-3/6Galb1-4(Fuca1-3)GlcNAcb1-2Mana1- | Mana1-3(NeuAca2-3Galb1-4GlcNAcb1-2Mana1- |
| 3(Mana1-6)Manb1-4GlcNAcb1-4GlcNAc | 6)Manb1-4GlcNAcb1-4(Fuca1-6)GlcNAc |
| Fuca1-2Galb1-4(Fuca1-3)GlcNAcb1-2Mana1- | GalNAc[4S]b1-4GlcNAcb1-2Mana1-3(Mana1- |
| 3(Mana1-6)Manb1-4GlcNAcb1-4(Fuca1-6)GlcNAcb | 3(Mana1-6)Mana1-6)Manb1-4GlcNAcb1-4GlcNAc |
| GalNAc[4S]b1-4GlcNAcb1-2Mana1-3(Mana1- | GalNAc[3/4S]b1-4GlcNAcb1-2Mana1-3(Mana1- |
| 3(Mana1-6)Mana1-6)Manb1-4GlcNAcb1-4GlcNAcb | 3(Mana1-6)Mana1-6)Manb1-4GlcNAcb1-4GlcNAcb |
| Glca1-3Mana1-2Mana1-2Mana1-3(Mana1-3(Mana1- | Mana1-2Mana1-2Mana1-3(Mana1-2Mana1- |
| 6)Mana1-6)Manb1-4GlcNAcb1-4GlcNAc | 3(Mana1-6)Mana1-6)Manb1-4GlcNAcb1-4GlcNAc |
| Mana1-2Mana1-2Mana1-3(Mana1-2Mana1- | Mana1-2Mana1-3(Mana1-2Mana1-3(Mana1- |
| 3(Mana1-6)Mana1-6)Manb1-4GlcNAcb1-4GlcNAcb | 2Mana1-6)Mana1-6)Manb1-4GlcNAcb1-4GlcNAc |
| Mana1-2Mana1-3(Mana1-2Mana1-3(Mana1- | Mana1-2Mana1-2Mana1-3(Mana1-3(Mana1- |
| 2Mana1-6)Mana1-6)Manb1-4GlcNAcb1-4GlcNAcb | 2Mana1-6)Mana1-6)Manb1-4GlcNAcb1-4GlcNAcb |
| Mana1-2Mana1-2Mana1-3(Mana1-3(Mana1- | Glca1-2Glca1-3Glca1-3Mana1-2Mana1-2Mana1- |
| 2Mana1-6)Mana1-6)Manb1-4GlcNAcb1-4GlcNAc | 3(Mana1-6)Manb1-4GlcNAcb1-4GlcNAc |
| Glca1-3Mana1-2Mana1-2Mana1-3(Mana1-2Mana1- | Glca1-2Glca1-3Glca1-3Mana1-2Mana1-2Mana1- |
| 3Mana1-6)Manb1-4GlcNAcb1-4GlcNAc | 3(Mana1-6)Manb1-4GlcNAcb1-4GlcNAcb |
| Mana1-3(Mana1-2Mana1-6)Mana1-3(Mana1- | Mana1-2Mana1-2Mana1-3(Mana1-3(Mana1- |
| 2Mana1-2Mana1-6)Manb1-4GlcNAcb1-4GlcNAc | 2Mana1-6)Mana1-6)Mana1-4GlcNAcb1-4GlcNAc |
| Mana1-2Mana1-3(Mana1-2Mana1-3(Mana1- | Mana1-3(Mana1-3(Mana1-2Mana1-2Mana1- |
| 2Mana1-6)Mana1-6)Manb1-4GlcNAcb1-4GlcNAcbb | 2Mana1-6)Mana1-6)Manb1-4GlcNAcb1-4GlcNAc |
| Mana1-2Mana1-2Mana1-3(Mana1-2(Mana1- | Mana1-2Mana1-2Mana1-3(Mana1-2Mana1- |
| 6Mana1-6)Mana1-6)Manb1-4GlcNAcb1-4GlcNAc | 3(Mana1-6)Mana1-6)Manb1-4GlcNAcb1-4GlcNAc |
| Mana1-2Mana1-2Mana1-3(Mana1-3(Mana1- | Mana1-2Mana1-3(Mana1-2Mana1-3(Mana1- |
| 2Mana1-6)Mana1-6)Manb1-4GlcNAcb1-4GlcNAc | 2Mana1-6)Mana1-6)Manb1-4GlcNAcb1-4GlcNAc |
| Mana1-3(Mana1-2Mana1-2Mana1-2Mana1- | Glca1-2Glca1-3Glca1-3Glca1-2Mana1-2Mana1- |
| 3(Mana1-6)Mana1-6)Manb1-4GlcNAcb1-4GlcNAc | 3(Mana1-6)Manb1-4GlcNAcb1-4GlcNAc |
| | Mana1-4Mana1-4Mana1-3(Mana1-3(Mana1- |
| | 4Mana1-6)Mana1-6)Manb1-4GlcNAcb1-4GlcNAcb |
| Glca1-3Mana1-2Mana1-2Mana1-3(Mana1-2Mana1- | Glca1-3Mana1-2Mana1-2(Mana1-2Mana1-6)Mana1- |
| 6Mana1-6)Manb1-4GlcNAcb1-4GlcNAc | 3(Mana1-6)Manb1-4GlcNAcb1-4GlcNAc |
| Mana1-3Mana1-2Mana1-2(Mana1-2Mana1- | GlcNAcb1-2(GlcNAcb1-4)Mana1-3(GlcNAcb1- |
| 6)Mana1-3(Mana1-6)Manb1-4GlcNAcb1-4GlcNAc | 2(GlcNAcb1-6)Mana1-6)Manb1-4GlcNAcb1-4GlcNAc |
| GalNAcb1-4GlcNAcb1-2(GlcNAcb1-4)Mana1- | GalNAcb1-4GlcNAcb1-2Mana1-3(GlcNAcb1- |
| 3(GlcNAcb1-2Mana1-6)Manb1-4GlcNAcb1-4GlcNAc | 2(GlcNAcb1-6)Mana1-6)Manb1-4GlcNAcb1-4GlcNAc |
| GlcNAcb1-2(GlcNAcb1-4)Mana1-3(GlcNAcb1- | GlcNAcb1-4(GlcNAcb1-2(GlcNAcb1-4)Mana1- |
| 2(GlcNAcb1-6)Mana1-6)Manb1-4GlcNAcb1- | 3)(GlcNAcb1-2Mana1-6)Manb1-4GlcNAcb1-4GlcNAc |
| 4GlcNAcb | |
| GlcNAcb1-4(GlcNAcb1-2Mana1-3)(GlcNAcb1- | GlcNAcb1-4(GlcNAcb1-2(GlcNAcb1-4)Mana1- |
| 2(GlcNAcb1-4)Mana1-6)Manb1-4GlcNAcb1-4GlcNAc | 3)(GlcNAcb1-2Mana1-6)Manb1-4GlcNAcb1- |
| | 4GlcNAcb |
| GlcNAcb1-4(GlcNAcb1-4Mana1-3)(GlcNAcb1- | GalNAcb1-4GlcNAcb1-2Mana1-3(GalNAcb1- |
| 2(GlcNAcb1-4)Mana1-6)Manb1-4GlcNAcb1- | 4GlcNAcb1-2Mana1-6)Manb1-4GlcNAcb1-4GlcNAc |
| 4GlcNAcb | |
| GlcNAcb1-2(GlcNAcb1-4)Mana1-3(GlcNAcb1- | GalNAca1-3Galb1-4GlcNAcb1-3(GalNAca1-3Galb1- |
| 2(GlcNAcb1-6)Mana1-6)Manb1-4GlcNAcb1-4GlcNAc | 4GlcNAcb1-6)Galb1-4GlcNAcb1-3GalNAc |
| GlcNAcb1-2(GlcNAcb1-4)Mana1-3(GlcNAcb1- | GlcNAcb1-4(GlcNAcb1-2(GlcNAcb1-6)Mana1- |
| 2(GlcNAcb1-4)Mana1-6)Manb1-4GlcNAcb1-4GlcNAc | 3)(GlcNAcb1-2Mana1-6)Manb1-4GlcNAcb1- |
| | 4GlcNAcb |
| GlcNAcb1-4(GlcNAcb1-2(GlcNAcb1-4)Mana1- | GlcNAcb1-4(GlcNAcb1-2(GlcNAcb1-4)Mana1- |
| 3)(GlcNAcb1-2Mana1-6)Manb1-4GlcNAcb1-4GlcNAc | 3)(GlcNAcb1-2Mana1-6)Manb1-4GlcNAcb1-4GlcNAc |
| GalNAcb1-4GlcNAcb1-2Mana1-3(GalNAcb1- | GlcNAcb1-4(GlcNAcb1-2(GlcNAcb1-4)Mana1- |
| 4GlcNAcb1-2Mana1-6)Manb1-4GlcNAcb1-4GlcNAcb | 3)(GlcNAcb1-2Mana1-6)Manb1-4GlcNAcb1-4GlcNAc |
| GalNAcb1-4GlcNAcb1-2Mana1-3(GalNAcb1- | GlcNAcb1-4(GlcNAcb1-2(GlcNAcb1-4)Mana1- |
| 4GlcNAcb1-2Mana1-6)Mana1-4GlcNAcb1-4GlcNAcb | 3)(GlcNAcb1-4Mana1-6)Manb1-4GlcNAcb1-4GlcNAc |
| GalNAcb1-4GlcNAcb1-2Mana1-3(GalNAcb1- | GalNAcb1-4GlcNAcb1-2Mana1-3(GalNAcb1- |
| 4GlcNAcb1-2Mana1-6)Manb1-4GlcNAcb1- | 4GlcNAcb1-2Mana1-6)Manb1-4GlcNAcb1-4GlcNAc |
| 4GlcNAcbb | |
| NeuAca2-3Galb1-4GlcNAcb1-2Mana1-3(Mana1- | Galb1-4GlcNAcb1-2Manb1-3(NeuAca2-6Galb1- |
| 3Mana1-6)Manb1-4GlcNAcb1-4GlcNAc | 4GlcNAcb1-2Manb1-6)Manb1-4GlcNAc |
| NeuAca2-6Galb1-4GlcNAcb1-2Mana1-3(Galb1- | Galb1-4GlcNAcb1-2Mana1-3(NeuAca2-3Galb1- |
| 4GlcNAcb1-2Mana1-6)Manb1-4GlcNAc | 4GlcNAcb1-2Mana1-6)Manb1-4GlcNAc |
| Galb1-4GlcNAcb1-2Mana1-3(NeuAca2-6Galb1- | NeuAca2-3Galb1-4GlcNAcb1-2Mana1-3(Galb1- |
| 4GlcNAcb1-2Mana1-6)Manb1-4GlcNAc | 4GlcNAcb1-2Mana1-6)Manb1-4GlcNAc |
| NeuAca2-3Galb1-4GlcNAcb1-2Mana1-3(Mana1- | Fuca1-2Galb1-4GlcNAcb1-2Mana1-6(Fuca1-2Galb1- |
| 3Mana1-6)Manb1-4GlcNAcb1-4GlcNAcb | 4GlcNAcb1-2Manb1-3)Manb1-4GlcNAc |
| Galb1-4(Fuca1-3)GlcNAcb1-2Mana1-3(Galb1- | Fuca1-2Galb1-4GlcNAcb1-2Mana1-3(Fuca1-2Galb1- |
| 4(Fuca1-3)GlcNAcb1-2Mana1-6)Manb1-4GlcNAc | 4GlcNAcb1-2Mana1-6)Manb1-4GlcNAc |
| Galb1-4(Fuca1-3)GlcNAcb1-2Mana1-3(Mana1- | GalNAcb1-4(GalNAca1-2Fuca1-3)GlcNAcb1- |
| 3Mana1-6)Manb1-4GlcNAcb1-4(Fuca1-6)GlcNAc | 3(GalNAcb1-4(GalNAca1-2Fuca1-3)GlcNAcb1- |
| | 6)GalNAc |
| NeuGca2-3/6Galb1-4GlcNAcb1-2Mana1-3(Mana1- | GalNAc[4S]b1-4GlcNAcb1-2Mana1-3(GlcNAcb1- |
| 3Mana1-6)Manb1-4GlcNAcb1-4GlcNAc | 2Mana1-6)Manb1-4GlcNAcb1-4(Fuca1-6)GlcNAcb |
| GalNAc[4S]b1-4GlcNAcb1-2Mana1-3(GlcNAcb1- | Galb1-4GlcNAcb1-2Mana1-3(Mana1-3(Mana1- |
| 2Mana1-6)Manb1-4GlcNAcb1-4(Fuca1-6)GlcNAc | 6)Mana1-6)Manb1-4GlcNAcb1-4(Fuca1-6)GlcNAc |
| Galb1-4GlcNAcb1-2Mana1-3(Mana1-2(Mana1- | Galb1-4GlcNAcb1-2Mana1-3(Mana1-3(Mana1- |
| 6)Mana1-6)Manb1-4GlcNAcb1-3(Fuca1-6)GlcNAc | 6)Mana1-6)Manb1-4GlcNAcb1-4(Fuca1-6)GlcNAcb |
| Galb1-4GlcNAcb1-2Mana1-3(Mana1-2Mana1- | Galb1-4GlcNAcb1-2Mana1-3(Galb1-4GlcNAcb1- |
| 3Mana1-6)Manb1-4GlcNAcb1-4(Fuca1-6)GlcNAc | 2Mana1-6)Manb1-4GlcNAcb1-4(Fuca1-6)Glc |
| Galb1-4(Fuca1-3)GlcNAcb1-2Mana1-3(Mana1- | NeuAca2-6GalNAcb1-4GlcNAcb1-2Mana1-3(Mana1- |
| 3(Mana1-6)Mana1-6)Manb1-4GlcNAcb1-4GlcNAc | 6)Manb1-4GlcNAcb1-4(Fuca1-6)GlcNAcb |
| GalNAcb1-4(Fuca1-3)GlcNAcb1-2Mana1-3(Mana1- | GalNAcb1-4(Fuca1-3)GlcNAcb1-2Mana1-3(Mana1- |
| 6)Manb1-4GlcNAcb1-4(Fuca1-3)(Fuca1-6)GlcNAc | 6)Manb1-4GlcNAcb1-4(Fuca1-3)(Fuca1-6)GlcNAc |
| GalNAcb1-4(Fuca1-3)GlcNAcb1-2Mana1-3(Mana1- | |
| 6)Manb1-4GlcNAcb1-4(Fuca1-3)(Fuca1-6)GlcNAcb | |
| | Mana1-2Mana1-2Mana1-3(Man[6P]a1-2Mana1- |
| | 3(Mana1-2Mana1-6)Mana1-6)Manb1-4GlcNAc |
| Mana1-2Man[6P]a1-2Mana1-3(Mana1-2Mana1- | GalNAc[3S]b1-4GlcNAcb1-2Mana1-3(Galb1- |
| 3(Mana1-2Mana1-6)Mana1-6)Manb1-4GlcNAc | 4GlcNAcb1-2Mana1-6)Manb1-4GlcNAcb1-4GlcNAc |
| GalNAc[4S]b1-4GlcNAcb1-2Mana1-3(Galb1- | GalNAc[4S]b1-4GlcNAcb1-2Mana1-3(Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAcb |
| Galb1-4GlcNAcb1-2Mana1-3(Galb1-4GlcNAcb1- | Galb1-4GlcNAcb1-2(Galb1-4GlcNAcb1-4)Mana1- |
| 2(Galb1-4GlcNAcb1-6)Mana1-6)Manb1-4Glcb | 3(Galb1-4GlcNAcb1-2Mana1-6)Manb1-4Glcb |
| Mana1-2Mana1-3(Mana1-3(Mana1-2Mana1- | Gala1-3Galb1-4GlcNAcb1-2Mana1-3(Mana1- |
| 6)Mana1-6)Manb1-4GlcNAcb1-4GlcNAcb1-4GlcNAcb | 3(Mana1-6)Mana1-6)Manb1-4GlcNAcb1-4GlcNAc |
| Mana1-2Mana1-2Mana1-2Mana1-3(Galb1- | Galb1-4GlcNAcb1-2(Galb1-4GlcNAcb1-4)Mana1- |
| 4GlcNAcb1-2Mana1-6)Manb1-4GlcNAcb1-4GlcNAc | 3(Mana1-3(Mana1-6)Mana1-6)Manb1-4GlcNAc |
| GlcNAcb1-4(GalNAcb1-4GlcNAcb1-2(GalNAcb1- | Fuca1-3GalNAcb1-4Galb1-3Galb1-3(NeuAca2- |
| 4GlcNAcb1-4)Mana1-3)Manb1-4GlcNAcb1-4GlcNAc | 8NeuAca2-8NeuAca2-6)GalNAca |
| NeuAca2-6Galb1-4GlcNAcb1-2Mana1-3(GlcNAcb1- | NeuAca2-6Galb1-4GlcNAcb1-2Mana1-3(GlcNAcb1- |
| 2Mana1-6)Manb1-4GlcNAcb1-4GlcNAc | 2Mana1-6)Manb1-4GlcNAcb1-4GlcNAc |
| GlcNAcb1-2Mana1-3(NeuAca2-6Galb1-4GlcNAcb1- | GlcNAcb1-2Mana1-3(NeuAca2-6Galb1-4GlcNAcb1- |
| 2Mana1-6)Manb1-4GlcNAcb1-4GlcNAc | 2Mana1-6)Manb1-4GlcNAcb1-4GlcNAcb |
| NeuAca2-3Galb1-3(Galb1-3GlcNAcb1-3(Galb1- | GlcNAcb1-4(Galb1-4(Fuca1-3)GlcNAcb1-2Mana1- |
| 4GlcNAcb1-6)Galb1-4GlcNAcb1-6)GalNAc | 3)(Mana1-6)Manb1-4GlcNAcb1-4(Fuca1-6)GlcNAc |
| GlcNAcb1-4(Mana1-3)(Galb1-4(Fuca1-3)GlcNAcb1- | Fuca1-2Galb1-3GlcNAcb1-3(Fuca1-2Galb1- |
| 2Mana1-6)Manb1-4GlcNAcb1-4(Fuca1-6)GlcNAc | 3GlcNAcb1-6)Galb1-3GlcNAcb1-3Galb1-3GalNAc |
| Galb1-4(Fuca1-3)GlcNAcb1-2Mana1-3(GlcNAcb1- | Fuca1-2Galb1-3GlcNAcb1-3(Fuca1-2Galb1- |
| 2Mana1-6)Manb1-4GlcNAcb1-4(Fuca1-6)GlcNAcb | 3GlcNAcb1-6)Galb1-3(Galb1-4GlcNAcb1-6)GalNAc |
| GalNAca1-3(Fuca1-2)Galb1-3GlcNAcb1-3(Fuca1- | Fuca1-2Galb1-4GlcNAcb1-3Galb1-4GlcNAcb1- |
| 2Galb1-3GlcNAcb1-6)Galb1-3(Galb1-6)GalNAc | 2Mana1-6Manb1-4GlcNAcb1-4(Fuca1-6)GlcNAcb |
| | Galb1-4(Fuca1-3)GlcNAcb1-2Mana1-3(GlcNAcb1- |
| | 2Mana1-6)Manb1-4GlcNAcb1-4(Fuca1-6)GlcNAc |
| Fuca1-2Galb1-3/4GlcNAcb1-3/6(Fuca1-2Galb1- | Galb1-4(Fuca1-3)GlcNAcb1-3Galb1-4GlcNAcb1- |
| 3/4GlcNAcb1-6/3)Galb1-3(Galb1-4GlcNAcb1- | 2Mana1-6 Manb1-4GlcNAcb1-4(Fuca1-6)GlcNAcb |
| 6)GalNAc | |
| Galb1-4Galb1-3(NeuGca2-8NeuGca2-8NeuGca2- | NeuAca2-3Gal[6S]b1-4GlcNAcb1-3Galb1- |
| 8NeuGca2-6)GalNAc | 3(NeuAca2-3Galb1-4GlcNAcb1-6)GalNAc |
| Neua1-3Galb1-4GlcNAcb1-2Mana1-3(Mana1- | NeuGca2-3/6Galb1-4GlcNAcb1-2Mana1- |
| 3(Mana1-6)Mana1-6)Manb1-4GlcNAcb1-4GlcNAc | 3(GlcNAcb1-2Mana1-6)Manb1-4GlcNAcb1-4GlcNAc |
| Galb1-4GlcNAcb1-2Mana1-3(Galb1-4GlcNAcb1- | Galb1-4GlcNAcb1-2Mana1-3(Galb1-4GlcNAcb1- |
| 2Mana1-6)Manb1-4GlcNAcb1-4(Fuca1-6)GlcNAcb | 6Mana1-6)Manb1-4GlcNAcb1-4(Fuca1-6)GlcNAc |
| GlcNAcb1-4(GlcNAcb1-2Mana1-3)(Mana1-3(Mana1- | Mana1-3(Galb1-4GlcNAcb1-2(Galb1-4GlcNAcb1- |
| 6)Mana1-6)Manb1-4GlcNAcb1-4(Fuca1-6)GlcNAcb | 6)Mana1-6)Manb1-4GlcNAcb1-4(Fuca1-6)GlcNAc |
| Galb1-4GlcNAcb1-4Mana1-3(Galb1-4GlcNAcb1- | Galb1-4GlcNAcb1-2Mana1-3(Galb1-4GlcNAcb1- |
| 4Mana1-6)Manb1-4GlcNAcb1-4(Fuca1-6)GlcNAcb | 2Mana1-6)Manb1-4GlcNAcb1-4(Fuca1-6)GlcNAc |
| GlcNAcb1-4(Galb1-4(Fuca1-3)GlcNAcb1-2Mana1- | Galb1-4GlcNAcb1-2(Galb1-4GlcNAcb1-4)Mana1- |
| 3)(Mana1-3Mana1-6)Manb1-4GlcNAcb1-4GlcNAc | 3 Mana1-6 Manb1-4GlcNAcb1-4 Fuca1-6 GlcNAc |
| GalNAcb1-4GlcNAcb1-2Mana1-3(Mana1-3(Mana1- | GlcNAcb1-4(GlcNAcb1-2Mana1-3)(Mana1-3(Mana1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| Galb1-4GlcNAcb1-2Mana1-3(Galb1-4GlcNAcb1- | Mana1-3(GlcNAcb1-2(Gala1-3Galb1-4GlcNAcb1- |
| 2Mana1-6)Manb1-4GlcNAcb1-4(Fuca1-6)GlcNAc | 6)Mana1-6)Manb1-4GlcNAcb1-4(Fuca1-6)GlcNAc |
| Galb1-4GlcNAcb1-2Mana1-3(Galb1-4GlcNAcb1- | GlcNAcb1-2Mana1-3(Gala1-3Galb1-4GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| GalNAcb1-4GlcNAcb1-2Mana1-3(Mana1-3(Mana1- | Mana1-3(Galb1-4GlcNAcb1-2(Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| Galb1-3GlcNAcb1-2Mana1-3(Galb1-4GlcNAcb1- | |
| 2Mana1-6)Manb1-4GlcNAcb1-4(Fuca1-6)GlcNAc | |
| | GalNAcb1-4GlcNAcb1-2Mana1-3(Mana1-2Mana1- |
| | 3Mana1-6)Manb1-4GlcNAcb1-4(Fuca1-6)GlcNAc |
| Galb1-3GlcNAcb1-2Mana1-3(Galb1-3GlcNAcb1- | Galb1-4GlcNAcb1-2Mana1-3(Galb1-4GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAcbb |
| GlcNAcb1-2Mana1-3(Gala1-3Galb1-4GlcNAcb1- | Gala1-3Galb1-4GlcNAcb1-2Mana1-3(GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAcb |
| Mana1-3(Galb1-4GlcNAcb1-2(Galb1-4GlcNAcb1- | Galb1-4GlcNAcb1-2(Galb1-4GlcNAcb1-4)Mana1- |
| 6)Mana1-6)Manb1-4GlcNAcb1-4(Fuca1-6)GlcNAcb | 3(Mana1-6)Manb1-4GlcNAcb1-4(Fuca1-6)GlcNAcb |
| Galb1-4GlcNAcb1-2Mana1-3(Galb1-4GlcNAcb1- | Fuca1-2Galb1-4GlcNAcb1-2Mana1-3(Galb1- |
| 2Mana1-6)Manb1-4GlcNAcb1-3(Fuca1-6)GlcNAcb | 4GlcNAcb1-2Mana1-6)Manb1-4GlcNAcb1-4GlcNAcb |
| Galb1-4GlcNAcb1-2(Galb1-4GlcNAcb1-4)Mana1- | Galb1-4GlcNAcb1-4Mana1-3(Galb1-4GlcNAcb1- |
| 3(Mana1-6)Manb1-4GlcNAcb1-4(Fuca1-6)GlcNAc | 2Mana1-6)Manb1-4GlcNAcb1-4(Fuca1-6)GlcNAc |
| Fuca1-2Galb1-4GlcNAcb1-2Mana1-3(Galb1- | Galb1-4GlcNAcb1-4Mana1-3(Galb1-4GlcNAcb1- |
| 4GlcNAcb1-2Mana1-6)Manb1-4GlcNAcb1-4GlcNAc | 2Mana1-6)Manb1-4GlcNAcb1-4(Fuca1-6)GlcNAcb |
| Galb1-4GlcNAcb1-4Mana1-3(Galb1-4GlcNAcb1- | Galb1-4(Fuca1-3)GlcNAcb1-2Mana1-3(Galb1- |
| 6Mana1-6)Manb1-4GlcNAcb1-4(Fuca1-6)GlcNAc | 4GlcNAcb1-2Mana1-6)Manb1-4GlcNAcb1-4GlcNAc |
| Galb1-4GlcNAcb1-2Mana1-3(Galb1-4(Fuca1- | Neua1-3Galb1-4GlcNAcb1-2Mana1-3(Neua1- |
| 3)GlcNAcb1-2Mana1-6)Manb1-4GlcNAcb1-4GlcNAc | 3Galb1-4GlcNAcb1-2Mana1-6)Manb1-4GlcNAc |
| Neua1-3Galb1-4GlcNAcb1-2Glca1-3(Neua1-6Galb1- | NeuAca2-6Galb1-4GlcNAc[6S]b1-2Mana1-3(Mana1- |
| 4GlcNAcb1-2Glca1-6)Manb1-4GlcNAc | 6)Manb1-4GlcNAcb1-4(Fuca1-6)GlcNAcb |
| GalNAcb1-4GlcNAcb1-2Mana1-3(GalNAc[4S]b1- | GalNAc[4S]b1-4GlcNAcb1-2Mana1-3(GalNAcb1- |
| 4GlcNAcb1-2Mana1-6)Manb1-4GlcNAcb1-4GlcNAcb | 4GlcNAcb1-2Mana1-6)Manb1-4GlcNAcb1-4GlcNAcb |
| Galb1-3Galb1-4GlcNAcb1-3(Galb1-3Galb1- | GlcNAcb1-4(GlcNAcb1-2Mana1-3)(Mana1-3(Mana1- |
| 4GlcNAcb1-6)Galb1-4GlcNAcb1-3Galb1-3GalNAc | 2Mana1-6)Mana1-6)Manb1-4GlcNAcb1-4GlcNAcb |
| Galb1-4GlcNAcb1-2Mana1-3(Gala1-3Galb1- | GlcNAcb1-4(Galb1-4GlcNAcb1-2Mana1-3)(Mana1- |
| 4GlcNAcb1-2Mana1-6)Manb1-4GlcNAcb1-4GlcNAc | 3(Mana1-6)Mana1-6)Manb1-4GlcNAcb1-4GlcNAc |
| Galb1-4GlcNAcb1-4Mana1-3(Galb1-4GlcNAcb1- | GlcNAcb1-4(Galb1-4GlcNAcb1-2Mana1-3)(Mana1- |
| 2(Galb1-4GlcNAcb1-6)Mana1-6)Manb1-4GlcNAc | 3(Mana1-6)Mana1-6)Manb1-4GlcNAcb1-4GlcNAcb |
| GlcNAcb1-2(Galb1-4GlcNAcb1-4)Mana1-3(Mana1- | Gala1-3Galb1-4GlcNAcb1-2Mana1-3(Galb1- |
| 3(Mana1-6)Mana1-6)Manb1-4GlcNAcb1-4GlcNAc | 4GlcNAcb1-2Mana1-6)Manb1-4GlcNAcb1-4GlcNAc |
| Galb1-4GlcNAcb1-2Mana1-3(Gala1-3Galb1- | Galb1-4GlcNAcb1-2(Galb1-4GlcNAcb1-4)Mana1- |
| 4GlcNAcb1-2Mana1-6)Manb1-4GlcNAcb1-4GlcNAc | 3(Galb1-4GlcNAcb1-2Mana1-6)Manb1-4GlcNAc |
| Galb1-4GlcNAcb1-2Mana1-3(Galb1-4GlcNAcb1- | Galb1-4GlcNAcb1-3Galb1-4GlcNAcb1-2Mana1- |
| 3Galb1-4GlcNAcb1-2Mana1-6)Manb1-4GlcNAc | 3(Galb1-4GlcNAcb1-2Mana1-6)Manb1-4GlcNAc |
| Galb1-4GlcNAcb1-2Mana1-3(Galb1-4GlcNAcb1- | Galb1-4GlcNAcb1-2Mana1-3(Galb1-3Galb1- |
| 2(Gatb1-4GlcNAcb1-6)Mana1-6)Manb1-4GlcNAc | 4GlcNAcb1-2Mana1-6)Manb1-4GlcNAcb1-4GlcNAc |
| GlcNAcb1-2cGalb1-4GlcNAcb1-4)Mana1-3(Mana1- | GalNAcb1-4(Fuca1-3)GlcNAcb1-2Mana1- |
| 3(Mana1-6)Mana1-6)Manb1-4GlcNAcb1-4GlcNAcb | 3(GlcNAcb1-2Mana1-6)Manb1-4GlcNAcb1-4(Fuca1- |
| | 6)GlcNAc |
| NeuAca2-6Galb1-4GlcNAcb1-2Mana1-3(NeuAca2- | NeuAca2-6Galb1-3GlcNAcb1-3(NeuAca2-6)Galb1- |
| 6Galb1-4GlcNAcb1-2Mana1-6)Man | 4GlcNAcb1-3(NeuAca2-6)GalNAc |
| GlcNAcb1-4(GlcNAcb1-2Mana1-3)(Galb1- | GlcNAcb1-4(Galb1-4GlcNAcb1-2Mana1- |
| 4GlcNAcb1-2Mana1-6)Manb1-4GlcNAcb1-4(Fuca1- | 3)(GlcNAcb1-2Mana1-6)Manb1-4GlcNAcb1- |
| 6)GlcNAc | 4(Fuca1-6)GlcNAc |
| GlcNAcb1-2Mana1-3(GlcNAcb1-2(Galb1-3GlcNAcb1- | GalNAcb1-4GlcNAcb1-2Mana1-3(Galb1-4GlcNAcb1- |
| 4)Mana1-6)Manb1-4GlcNAcb1-4(Fuca1-6)GlcNAc | 2Mana1-6)Manb1-4GlcNAcb1-4(Fuca1-6)GlcNAcb |
| GlcNAcb1-4(Galb1-4GlcNAcb1-2Mana1- | GlcNAcb1-4(GlcNAcb1-2Mana1-3)(Galb1- |
| 3)(GlcNAcb1-2Mana1-6)Manb1-4GlcNAcb1- | 4GlcNAcb1-2Mana1-6)Manb1-4GlcNAcb1-4(Fuca1- |
| 4(Fuca1-6)GlcNAcb | 6)GlcNAc |
| GlcNAcb1-4(Galb1-4GlcNAcb1-2Mana1- | GalNAcb1-4GlcNAcb1-2Mana1-3(Galb1-4GlcNAcb1- |
| 3)(GlcNAcb1-2Mana1-6)Manb1-4GlcNAcb1- | 2Mana1-6)Manb1-4GlcNAcb1-4(Fuca1-6)GlcNAc |
| 4(Fuca1-6)GlcNAc | |
| GlcNAcb1-4(GlcNAcb1-2Mana1-3)(Galb1- | Galb1-4(Fuca1-3)GlcNAcb1-2Mana1-3(GalNAcb1- |
| 4GlcNAcb1-2Mana1-6)Manb1-4GlcNAcb1-4(Fuca1- | 4GlcNAcb1-2Mana1-6)Manb1-4GlcNAcb1-4GlcNAc |
| 6)GlcNAcb | |
| Galb1-4GlcNAcb1-2(GlcNAcb1-4)Mana1- | GlcNAcb1-2(GlcNAcb1-4)Mana1-3(Galb1- |
| 3(GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| Galb1-4GlcNAcb1-2Mana1-3(GalNAcb1-4GlcNAcb1- | GlcNAcb1-2Mana1-3(Galb1-4GlcNAcb1-2(GlcNAcb1- |
| 2Mana1-6)Manb1-4GlcNAcb1-4(Fuca1-6)GlcNAc | 6)Mana1-6)Manb1-4GlcNAcb1-4(Fuca1-6)GlcNAc |
| GalNAcb1-4GlcNAcb1-2Mana1-3(GalNAcb1- | GalNAcb1-4GlcNAcb1-2Mana1-3(Galb1-4GalNAcb1- |
| 4GlcNAcb1-2Mana1-6)Manb1-4GlcNAcb1-4(Fuca1- | 2Mana1-6)Manb1-4GlcNAcb1-4(Fuca1-6)GlcNAc |
| 6)Man | |
| GlcNAcb1-4(Galb1-4(Fuca1-3)GlcNAcb1-2Mana1- | GlcNAcb1-2(GlcNAcb1-4)Mana1-3(Galb1- |
| 3)(GlcNAcb1-2Mana1-6)Manb1-4GlcNAcb1-4GlcNAc | 4GlcNAcb1-2Mana1-6)Manb1-4GlcNAcb1-4(Fuca1- |
| | 6)GlcNAc |
| GlcNAcb1-2(Galb1-3GlcNAcb1-4)Mana1- | Galb1-4GlcNAcb1-2(GlcNAcb1-4)Mana1- |
| 3(GlcNAcb1-2Mana1-6)Manb1-4GlcNAcb1-4(Fuca1- | 3(GlcNAcb1-2Mana1-6)Manb1-4GlcNAcb1-4(Fuca1- |
| 6)GlcNAc | 6)GlcNAc |
| GalNAcb1-4(NeuGca2-3)GalNAcb1-4Galb1-3Galb1- | Glca1-3Mana1-2Mana1-2Mana1-3(Mana1-2Mana1- |
| 3(NeuAca2-8NeuAca2-6)GalNAca | 3(Mana1-2Mana1-6)Mana1-6)Manb1-4GlcNAc |
| Glca1-3Glca1-3Mana1-2Mana1-2Mana1-3(Mana1- | Glca1-2Glca1-3Glca1-3Mana1-2Mana1-2Mana1- |
| 3(Mana1-2Mana1-6)Mana1-6)Manb1-4GlcNAc | 3(Mana1-3(Mana1-6)Mana1-6)Manb1-4GlcNAc |
| Glcb1-3Mana1-2Mana1-2Mana1-3(Mana1-2Mana1- | Mana1-2Mana1-2(Mana1-6Mana1-6)Mana1- |
| 3(Mana1-2Mana1-6)Mana1-6)Manb1-4GlcNAc | 3(Mana1-3(Mana1-2Mana1-6)Mana1-6)Manb1- |
| | 4GlcNAc |
| Mana1-2Mana1-2(Mana1-6)Mana1-3(Mana1- | Mana1-2Mana1-2(Mana1-6)Mana1-3(Mana1- |
| 3(Mana1-2Mana1-2Mana1-6)Mana1-6)Manb1- | 2Mana1-3(Mana1-2Mana1-6)Mana1-6)Manb1- |
| 4GlcNAc | 4GlcNAc |
| Mana1-3Mana1-2Mana1-2(Mana1-2Mana1- | Mana1-2Mana1-2Mana1-3(Mana1-3(Mana1- |
| 6)Mana1-3(Mana1-3(Mana1-6)Mana1-6)Manb1- | 2(Mana1-2Mana1-6)Mana1-6)Mana1-6)Manb1- |
| 4GlcNAc | 4GlcNAc |
| Mana1-2Mana1-2Mana1-3(Mana1-2Mana1- | |
| 3(Mana1-2(Mana1-6)Mana1-6)Mana1-6)Manb1- | |
| 4GlcNAc | |
| Mana1-2Mana1-2(Mana1-2Mana1-6)Mana1- | Glca1-2Glca1-3Glca1-3Mana1-2Mana1-2Mana1- |
| 3(Mana1-3(Mana1-2Mana1-6)Mana1-6)Manb1- | 3(Mana1-2Mana1-3Mana1-6)Manb1-4GlcNAc |
| 4GlcNAc | |
| Glcb1-2Glcb1-2Glcb1-2Mana1-2Mana1-2Mana1- | Glca1-3Mana1-2Mana1-2Mana1-3(Mana1-2Mana1- |
| 3(Mana1-3(Mana1-6)Mana1-6)Manb1-4GlcNAc | 3(Mana1-2Mana1-6)Mana1-6)Manb1-3GlcNAc |
| Glca1-3Mana1-2Mana1-2Mana1-3(Mana1-3Mana1- | NeuAca2-3Galb1-3(NeuAca2-3Galb1-4(Fuca1- |
| 3(Mana1-3Mana1-6)Mana1-6)Manb1-4GlcNAc | 3)GlcNAcb1-3Galb1-4GlcNAcb1-6)GalNAc |
| NeuAca2-3Galb1-3(NeuAca2-3Galb1-3(Fuca1- | NeuAca2-3Galb1-4(Fuca1-3)GlcNAcb1-3Galb1- |
| 4)GlcNAcb1-3Galb1-4GlcNAcb1-6)GalNAc | 4(Fuca1-3)GlcNAcb1-3Galb1-4(Fuca1-3)GlcNAcb |
| NeuAca2-3Galb1-4(Fuca1-3)GlcNAcb1-3Galb1- | NeuAca2-3Galb1-4(Fuca1-3)GlcNAcb1-3Galb1- |
| 4(Fuca1-3)GlcNAcb1-3Galb1-4(Fuca1-3)GlcNAcb | 4(Fuca1-3)GlcNAcb1-3Galb1-4(Fuca1-3)GlcNAcb |
| NeuAca2-3Galb1-4(Fuca1-3)GlcNAcb1-3Galb1- | Galb1-4GlcNAcb1-3(Galb1-4GlcNAcb1-6)Galb1- |
| 4(Fuca1-3)GlcNAcb1-3Galb1-4(Fuca1-3)GlcNAcb | 4GlcNAcb1-3(Galb1-4GlcNAcb1-6)Galb1-4GlcNAc |
| GlcNAcb1-2(Galb1-4GlcNAcb1-4)Mana1-3(Galb1- | GlcNAcb1-4(GlcNAcb1-2(GlcNAcb1-4)Mana1- |
| 4GlcNAcb1-2Mana1-6)Manb1-4GlcNAcb1-4GlcNAc | 3)(Mana1-3(Mana1-6)Mana1-6)Manb1-4GlcNAcb1- |
| | 4GlcNAc |
| GlcNAcb1-4(GlcNAcb1-2(Galb1-4GlcNAcb1- | GlcNAcb1-4(Galb1-4GlcNAcb1-2Mana1-3)(Galb1- |
| 4)Mana1-3)(Mana1-3Mana1-6)Manb1-4GlcNAcb1- | 4GlcNAcb1-2Mana1-6)Manb1-4GlcNAcb1-4GlcNAc |
| 4GlcNAc | |
| Galb1-4GlcNAcb1-2(GlcNAcb1-4)Mana1-3(Galb1- | GlcNAcb1-4(GlcNAcb1-2(Galb1-4GlcNAcb1- |
| 4GlcNAcb1-2Mana1-6)Manb1-4GlcNAcb1-4GlcNAcb | 4)Mana1-3)(Mana1-3Mana1-6)Manb1-4GlcNAcb1- |
| | 4GlcNAcb |
| GlcNAcb1-2Mana1-3(Galb1-4GlcNAcb1-2(Galb1- | GlcNAcb1-4(Galb1-4GlcNAcb1-2Mana1-3)(Galb1- |
| 4GlcNAcb1-6)Mana1-6)Manb1-4GlcNAcb1-4GlcNAc | 4GlcNAcb1-2Mana1-6)Manb1-4GlcNAcb1-4GlcNAcb |
| GlcNAcb1-4(GlcNAcb1-2(GlcNAcb1-4)Mana1- | Galb1-4GlcNAcb1-2(Galb1-4GlcNAcb1-4)Mana1- |
| 3)(Mana1-3(Mana1-6)Mana1-6)Manb1-4GlcNAcb1- | 3(GlcNAcb1-2Mana1-6)Manb1-4GlcNAcb1-4GlcNAcb |
| 4GlcNAcb | |
| Galb1-4GlcNAcb1-2(GlcNAcb1-4)Mana1-3(Galb1- | |
| 4GlcNAcb1-2Mana1-6)Manb1-4GlcNAcb1-4GlcNAc | |
| | GlcNAcb1-4(GlcNAcb1-2(GlcNAcb1-4)Mana1- |
| | 3)(Mana1-3(Mana1-6)Mana1-6)Manb1-4GlcNAcb1- |
| | 4GlcNAc |
| GlcNAcb1-4(GlcNAcb1-2(Galb1-4GlcNAcb1- | Galb1-4GlcNAcb1-2(Galb1-4GlcNAcb1-4)Mana1- |
| 4)Mana1-3)(Mana1-3Mana1-6)Manb1-4GlcNAcb1- | 3(GlcNAcb1-2Mana1-6)Manb1-4GlcNAcb1-4GlcNAc |
| 4GlcNAc | |
| Galb1-3(Galb1-4GlcNAcb1-3Galb1-4GlcNAcb1- | GlcNAcb1-4(Galb1-4GlcNAcb1-2Mana1-3)(Galb1- |
| 3Galb1-4GlcNAcb1-3Galb1-4GlcNAcb1-6)GalNAc | 4GlcNAcb1-2Mana1-6)Manb1-4GlcNAcb1-4GlcNAc |
| Galb1-4GlcNAcb1-3Galb1-4GlcNAcb1-3Galb1- | Gal[3ME]b1-6Gal[3ME]b1-3(Gal[3ME]b1- |
| 4GlcNAcb1-3Galb1-4GlcNAcb1-3Galb1-3GalNAc | 6)GlcNAcb1-4GlcNAcb1-2Mana1-3(Mana1- |
| | 6)Manb1-4GlcNAcb1-4GlcNAc |
| Gal[3ME]b1-6Gal[3ME]b1-3(Gal[3ME]b1- | NeuAca2-6Galb1-4GlcNAcb1-2(NeuAca2-6Galb1- |
| 6)GalNAcb1-4GlcNAcb1-2Mana1-3(Mana1- | 4GlcNAcb1-4)Mana1-3Manb1-4GlcNAc |
| 6)Manb1-4GlcNAcb1-4GlcNAc | |
| NeuAca2-6Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3Manb1-4GlcNAc | 4GlcNAcb1-4)Manb1-3Manb1-4GlcNAc |
| GalNAc[4S]b1-4GlcNAcb1-2Mana1-3(Mana1- | GalNAc[4S]b1-4GlcNAcb1-2Mana1-3(Mana1- |
| 3(Mana1-6)Mana1-6)Manb1-4GlcNAcb1-4(Fuca1- | 6Mana1-3Mana1-6)Manb1-4GlcNAcb1-4(Fuca1- |
| 6)GlcNAcb | 6)GlcNAc |
| Mana1-3(Mana1-3(Mana1-2Mana1-2Mana1- | GalNAcb1-4(Fuca1-3)GlcNAcb1-2Mana1- |
| 3Mana1-6)Mana1-6)Manb1-4GlcNAcb1-4(Fuca1- | 3(GalNAcb1-4GlcNAcb1-2Mana1-6)Manb1- |
| 6)GlcNAc | 4GlcNAcb1-4GlcNAc |
| GlcNAcb1-2(GlcNAcb1-4)Mana1-3(GlcNAcb1- | GlcNAcb1-4(GalNAcb1-4(Fuca1-3)GlcNAcb1- |
| 2(GlcNAcb1-6)Mana1-6)Manb1-4GlcNAcb1- | 2Mana1-3)(GlcNAcb1-2Mana1-6)Manb1- |
| 4(Fuca1-6)GlcNAc | 4GlcNAcb1-4GlcNAc |
| GalNAcb1-4GlcNAcb1-2Mana1-3(GalNAcb1- | GalNAcb1-4GlcNAcb1-2Mana1-3(GalNAcb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAc |
| GlcNAcb1-4(GlcNAcb1-2(GlcNAcb1-4)Mana1- | GalNAcb1-4GlcNAcb1-2Mana1-3(GalNAcb1- |
| 3)(GlcNAcb1-2Mana1-6)Manb1-4GlcNAcb1- | 4GlcNAcb1-2Mana1-6)Manb1-4GlcNAcb1-4(Fuca1- |
| 4(Fuca1-6)GlcNAc | 6)GlcNAc |
| GlcNAcb1-2(GlcNAcb1-4)Mana1-3(GlcNAcb1- | GlcNAcb1-2(GlcNAcb1-4)Mana1-3(GlcNAcb1- |
| 2(GlcNAcb1-6)Mana1-6)Manb1-4GlcNAcb1- | 2(GlcNAcb1-6)Mana1-6)Manb1-4GlcNAcb1- |
| 4(Fuca1-6)GlcNAc | 4(Fuca1-6)GlcNAcb |
| | GalNAcb1-4GlcNAcb1-2Mana1-3(GlcNAcb1- |
| | 2(GlcNAcb1-6)Mana1-6)Manb1-4GlcNAcb1- |
| | 4(Fuca1-6)GlcNAc |
| GalNAca1-3(Fuca1-2)Galb1-4GlcNAcb1- | GalNAcb1-4GlcNAcb1-2(GlcNAcb1-4)Mana1- |
| 3(GalNAca1-3Galb1-4GlcNAcb1-6)Galb1- | 3(GlcNAcb1-2Mana1-6)Manb1-4GlcNAcb1- |
| 4GlcNAcb1-3GalNAc | 4(Fuca1-6)GlcNAc |
| Mana1-3(GalNAcb1-4GlcNAcb1-2(GalNAcb1- | GlcNAcb1-4(GlcNAcb1-2(GlcNAcb1-4)Mana1- |
| 4GlcNAcb1-6)Mana1-6)Manb1-4GlcNAcb1-4(Fuca1- | 3)(GlcNAcb1-2Mana1-6)Manb1-4GlcNAcb1- |
| 6)GlcNAcb | 4(Fuca1-6)GlcNAcb |
| NeuAca2-8NeuAca2-3Galb1-3GalNAcb1-4(NeuAca2- | NeuAca2-3Galb1-3GalNAcb1-4(NeuAca2-8NeuAca2- |
| 8NeuAca2-3)Galb1-4Glcb | 8NeuAca2-3)Galb1-4Glcb |
| GalNAcb1-4(NeuGca2-3)GalNAcb1-3Galb1-4Galb1- | NeuAca2-8NeuGca2-3/6Galb1-4GlcNAcb1-2Mana1- |
| 3(NeuGca2-8NeuGca2-6)GalNAc | 3(Mana1-6)Manb1-4GlcNAcb1-4GlcNAc |
| GalNAc[4S]b1-4GlcNAcb1-2Mana1- | GalNAc[3S]b1-4GlcNAcb1-2Mana1- |
| 3(GalNAc[4S]b1-4GlcNAcb1-2Mana1-6)Manb1- | 3(GalNAc[3S]b1-4GlcNAcb1-2Mana1-6)Manb1- |
| 4GlcNAcb1-4GlcNAcb | 4GlcNAcb1-4GlcNAc |
| Mana1-2Mana1-2Mana1-3(Mana1-2Mana1- | GlcNAcb1-4(Mana1-2Mana1-2Mana1-3)(Mana1- |
| 3(Mana1-2Mana1-6)Mana1-6)Manb1-4GlcNAcb1- | 2Mana1-3(Mana1-2Mana1-6)Mana1-6)Manb1- |
| 4GlcNAcb | 4GlcNAc |
| Mana1-2Mana1-2Mana1-3(Mana1-2Mana1- | Mana1-2Mana1-2Mana1-3(Mana1-2Mana1- |
| 3(Mana1-2Mana1-6)Mana1-6)Mana1-4GlcNAcb1- | 3(Mana1-2Mana1-6)Mana1-6)Manb1-4GlcNAcb1- |
| 4GlcNAc | 4GlcNAcbb |
| Mana1-2Mana1-2Mana1-3(Mana1-2Mana1- | Glca1-3Mana1-2Mana1-2Mana1-3(Mana1-3(Mana1- |
| 3(Mana1-2Mana1-6)Mana1-6)Manb1-4GlcNAcb1- | 2Mana1-6)Mana1-6)Manb1-4GlcNAcb1-4GlcNAc |
| 4GlcNAc | |
| Glca1-2Glca1-3Glca1-3Mana1-2Mana1-2Mana1- | Glca1-3Mana1-2Mana1-2Mana1-3(Mana1-2Mana1- |
| 3(Mana1-3Mana1-6)Manb1-4GlcNAcb1-4GlcNAc | 3(Mana1-6)Mana1-6)Manb1-4GlcNAcb1-4GlcNAc |
| Mana1-2Mana1-2Mana1-3(Mana1-2Mana1- | Glca1-3Mana1-2Mana1-3(Mana1-2Mana1-3(Mana1- |
| 3(Mana1-2Mana1-6)Mana1-6)Manb1-4GlcNAcb1- | 2Mana1-6)Mana1-6)Manb1-4GlcNAcb1-4GlcNAcb |
| 4GlcNAc | |
| Mana1-3(Mana1-2Mana1-2Mana1-2Mana1-2Mana1- | |
| 3(Mana1-6)Mana1-6)Manb1-4GlcNAcb1-4GlcNAc | |
| | Glca1-3Mana1-2Mana1-2(Mana1-3Mana1-2Mana1- |
| | 6)Mana1-3(Mana1-6)Manb1-4GlcNAcb1-4GlcNAc |
| Mana1-3Mana1-2Mana1-2(Mana1-3Mana1-2Mana1- | Mana1-3Mana1-2Mana1-2Mana1-3(Mana1- |
| 6)Mana1-3(Mana1-6)Manb1-4GlcNAcb1-4GlcNAc | 3(Mana1-2Mana1-6)Mana1-6)Manb1-4GlcNAcb1- |
| | 4GlcNAc |
| Mana1-2Mana1-2(Mana1-6)Mana1-3(Mana1- | Glca1-3Glca1-3Mana1-2Mana1-2(Mana1-2Mana1- |
| 3(Mana1-2Mana1-6)Mana1-6)Manb1-4GlcNAcb1- | 6)Mana1-3(Mana1-6)Manb1-4GlcNAcb1-4GlcNAc |
| 4GlcNAcb | |
| GalNAca1-3(Fuca1-2)Galb1-3GlcNAcb1-3(NeuAca2- | GlcNAcb1-4(Galb1-4GlcNAcb1-2Mana1- |
| 6)Galb1-4GlcNAcb1-3(NeuAca2-6)GalNAc | 3)(GalNAcb1-4GlcNAcb1-2Mana1-6)Manb1- |
| | 4GlcNAcb1-4GlcNAc |
| GlcNAcb1-2(Galb1-3GlcNAcb1-4)Mana1- | Galb1-4GlcNAcb1-2(GlcNAcb1-4)Mana1- |
| 3(GlcNAcb1-2(GlcNAcb1-6)Mana1-6)Manb1- | 3(GlcNAcb1-2(GlcNAcb1-6)Mana1-6)Manb1- |
| 4GlcNAcb1-4GlcNAc | 4GlcNAcb1-4GlcNAc |
| GlcNAcb1-2(GlcNAcb1-4)Mana1-3(Galb1- | GlcNAcb1-4(GlcNAcb1-2(Galb1-4GlcNAcb1- |
| 4GlcNAcb1-2(GlcNAcb1-6)Mana1-6)Manb1- | 4)Mana1-3)(GlcNAcb1-2Mana1-6)Manb1- |
| 4GlcNAcb1-4GlcNAc | 4GlcNAcb1-4GlcNAc |
| GlcNAcb1-4(GlcNAcb1-2(Galb1-4GlcNAcb1- | GlcNAcb1-4(GlcNAcb1-2(Galb1-4GlcNAcb1- |
| 4)Mana1-3)(GlcNAcb1-2Mana1-6)Manb1- | 4)Mana1-3)(GlcNAcb1-2Mana1-6)Manb1- |
| 4GlcNAcb1-4GlcNAcb | 4GlcNAcb1-4GlcNAc |
| GalNAcb1-4GlcNAcb1-2(Galb1-4GlcNAcb1- | GlcNAcb1-4(GlcNAcb1-2(GlcNAcb1-4)Mana1- |
| 4)Mana1-3(GlcNAcb1-2Mana1-6)Manb1- | 3)(Galb1-4GlcNAcb1-2Mana1-6)Manb1-4GlcNAcb1- |
| 4GlcNAcb1-4GlcNAc | 4GlcNAc |
| GlcNAcb1-4(GlcNAcb1-2Mana1-3)(GlcNAcb1- | GlcNAcb1-4(GlcNAcb1-2(GlcNAcb1-4)Mana1- |
| 2(Galb1-4GlcNAcb1-4)Mana1-6)Manb1-4GlcNAcb1- | 3)(GlcNAcb1-2(Mana1-6)Mana1-6)Manb1- |
| 4GlcNAc | 4GlcNAcb1-4GlcNAc |
| Galb1-4GlcNAcb1-2Mana1-3(NeuAca2-6Galb1- | NeuAca2-3Galb1-4GlcNAcb1-2Mana1-3(Mana1- |
| 4GlcNb1-2Mana1-6)Manb1-4GlcNAcb1-4GlcNAc | 3(Mana1-6)Mana1-6)Manb1-4GlcNAcb1-4GlcNAcb |
| NeuAca2-6Galb1-4GlcNAcb1-2Mana1-3(Mana1- | |
| 3(Mana1-6)Mana1-6)Manb1-4GlcNAcb1-4GlcNAc | |
| NeuAca2-3Galb1-4GlcNAcb1-2Mana1-3(Mana1- | |
| 3(Mana1-6)Mana1-6)Manb1-4GlcNAcb1-4GlcNAc | |
| Mana1-3(Mana1-3(NeuAca2-3Galb1-4GlcNAcb1- | NeuAca2-6Galb1-4GlcNAcb1-2Mana1-3(Mana1- |
| 6Mana1-6)Mana1-6)Manb1-4GlcNAcb1-4GlcNAcb | 3(Mana1-6)Mana1-6)Manb1-4GlcNAcb1-4GlcNAcb |
| NeuAca2-6Galb1-4GlcNAcb1-2Mana1-3(Mana1- | Galb1-4(Fuca1-3)GlcNAcb1-2Mana1-3(Mana1- |
| 2Mana1-3Mana1-6)Manb1-4GlcNAcb1-4GlcNAc | 3(Mana1-6)Mana1-6)Manb1-4GlcNAcb1-4(Fuca1- |
| | 6)GlcNAc |
| Galb1-4(Fuca1-3)GlcNAcb1-2Mana1-3(Mana1- | NeuAca2-6GlcNAcb1-2Mana1-3(NeuAca2- |
| 3(Mana1-6)Mana1-6)Manb1-4GlcNAcb1-4(Fuca1- | 6GlcNAcb1-2Mana1-6)Manb1-4GlcNAcb1-4GlcNAc |
| 6)GlcNAcb | |
| GalNAc[3S]b1-4GlcNAcb1-2Mana1-3(Galb1- | GalNAc[4S]b1-4GlcNAcb1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAcb |
| Gala1-3Galb1-4GlcNAcb1-2Mana1-3(Mana1- | GlcNAcb1-4(GalNAcb1-4GlcNAcb1-2(GalNAcb1- |
| 3(Mana1-6)Mana1-6)Manb1-4GlcNAcb1-4(Fuca1- | 4GlcNAcb1-4)Mana1-3)Manb1-4GlcNAcb1-4(Fuca1- |
| 6)GlcNAc | 6)GlcNAc |
| GalNAcb1-4Galb1-3Galb1-3(NeuAca2-8NeuAca2- | NeuAca2-6Galb1-4GlcNAcb1-2Mana1-3(GlcNAcb1- |
| 8NeuAca2-8NeuAca2-6)GalNAca | 2Mana1-6)Manb1-4GlcNAcb1-4(Fuca1-6)GlcNAcb |
| NeuAca2-3Galb1-3GlcNAcb1-2Mana1-3(GlcNAcb1- | GlcNAcb1-2Mana1-3(NeuAca2-6Galb1-4GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAcb |
| NeuAca2-3Galb1-4GlcNAcb1-2Mana1-3(GlcNAcb1- | NeuAca2-6Galb1-4GlcNAcb1-2Mana1-3(GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| NeuAca2-6Galb1-4GlcNAcb1-2Mana1-3(GlcNAcb1- | NeuAca2-3Galb1-4GlcNAcb1-2Mana1-3(Galb1- |
| 2Mana1-6)Manb1-4GlcNAcb1-4(Fuca1-6)GlcNAc | 4GlcNAcb1-2Mana1-6)GlcNAcb1-4(Fuca1-6)GlcNAc |
| GlcNAcb1-4(NeuAca2-3/6Galb1-4GlcNAcb1- | GlcNAcb1-4(NeuAca2-3/6Galb1-4(Fuca1- |
| 2Mana1-3)(Mana1-6)Manb1-4GlcNAcb1-4(Fuca1- | 3)GlcNAcb1-2Mana1-3)(Mana1-6)Manb1- |
| 6)GlcNAc | 4GlcNAcb1-4GlcNAc |
| Fuca1-2Galb1-3(Fuca1-4)GlcNAcb1-3(Fuca1- | Fuca1-2Galb1-4(Fuca1-3)GlcNAcb1-2Mana1- |
| 2Galb1-3GlcNAcb1-6)Galb1-3(Galb1-4GlcNAcb1- | 3(Fuca1-3GlcNAcb1-2Mana1-6)Manb1-4GlcNAcb1- |
| 6)GalNAc | 4GlcNAc |
| | Galb1-4(Fuca1-3)GlcNAcb1-2(Galb1-4(Fuca1- |
| | 3)GlcNAcb1-6)Mana1-6Manb1-4GlcNAcb1-4(Fuca1- |
| | 6)GlcNAcb |
| Mana1-2Mana1-2Mana1-2Mana1-2Mana1-3(Galb1- | GlcNAcb1-2(GlcNAcb1-4)Mana1-3(GlcNAcb1- |
| 4GlcNAcb1-2Mana1-6)Manb1-4GlcNAcb1-4GlcNAc | 2(GlcNAcb1-4)(GlcNAcb1-6)Mana1-6)Manb1- |
| | 4GlcNAcb1-4GlcNAcb |
| GlcNAcb1-4(GlcNAcb1-2(GlcNAcb1-4)Mana1- | GlcNAcb1-4(GlcNAcb1-2Mana1-3)(GlcNAcb1- |
| 3)(GlcNAcb1-2(GlcNAcb1-4)Mana1-6)Manb1- | 2(GlcNAcb1-4)(GlcNAcb1-6)Mana1-6)Manb1- |
| 4GlcNAcb1-4GlcNAcb | 4GlcNAcb1-4GlcNAcb |
| GlcNAcb1-4(GlcNAcb1-2(GlcNAcb1-4)Mana1- | GlcNAcb1-4(GlcNAcb1-2Mana1-3)(GlcNAcb1- |
| 3)(GlcNAcb1-2(GlcNAcb1-4)Mana1-6)Manb1- | 2(GlcNAcb1-4)(GlcNAcb1-6)Mana1-6)Manb1- |
| 4GlcNAcb1-4GlcNAc | 4GlcNAcb1-4GlcNAc |
| GlcNAcb1-2(GlcNAcb1-4)Mana1-3(GlcNAcb1- | GlcNAcb1-4(GlcNAcb1-2Mana1-3)(GlcNAcb1- |
| 2(GlcNAcb1-4)(GlcNAcb1-6)Mana1-6)Manb1- | 2(GlcNAcb1-4)(GlcNAcb1-6)Mana1-6)Manb1- |
| 4GlcNAcb1-4GlcNAc | 4GlcNAcb1-4GlcNAc |
| GlcNAcb1-4(GlcNAcb1-2(GlcNAcb1-4)Mana1- | GalNAcb1-4GlcNAcb1-2Mana1-3(GlcNAcb1- |
| 3)(GlcNAcb1-2(GlcNAcb1-6)Mana1-6)Manb1- | 2(GalNAcb1-4GlcNAcb1-6)Mana1-6)Manb1- |
| 4GlcNAcb1-4GlcNAc | 4GlcNAcb1-4GlcNAc |
| GalNAcb1-4GlcNAcb1-2(GlcNAcb1-4)Mana1- | GalNAcb1-4GlcNAcb1-2(GlcNAcb1-4)Mana1- |
| 3(GalNAcb1-4GlcNAcb1-2Mana1-6)Manb1- | 3(GlcNAcb1-2(GlcNAcb1-6)Mana1-6)Manb1- |
| 4GlcNAcb1-4GlcNAc | 4GlcNAcb1-4GlcNAc |
| GlcNAcb1-4(GlcNAca1-2(GlcNAcb1-4)Mana1- | GlcNAcb1-4(GlcNAcb1-4Mana1-3)(GlcNAcb1- |
| 3)(GlcNAcb1-2(GlcNAcb1-6)Mana1-6)Manb1- | 2(GlcNAcb1-4)(GlcNAcb1-6)Mana1-6)Manb1- |
| 4GlcNAcb1-4GlcNAc | 4GlcNAcb1-4GlcNAc |
| GlcNAcb1-4(GlcNAcb1-2(GlcNAcb1-2Mana1- | NeuAca2-3Galb1-4GlcNAc[6S]b1-3Galb1- |
| 6GlcNAcb1-4)Mana1-3)Manb1-4GlcNAcb1- | 4GlcNAc[6S]b1-3Galb1-4GlcNAcb1-3Galb1-3GalNAc |
| 4GlcNAcb1-4GlcNAcb | |
| NeuAca2-6Galb1-4GlcNAcb1-2Mana1-3(Galb1- | Galb1-4GlcNAcb1-2Mana1-3(NeuAca2-6Galb1- |
| 4GlcNAcb1-2Mana1-6)Manb1-4GlcNAcb1-4GlcNAcb | 4GlcNAcb1-2Mana1-6)Manb1-4GlcNAcb1-4GlcNAcb |
| Galb1-4GlcNAcb1-2Mana1-3(NeuAca2-6Galb1- | NeuAca2-3Galb1-4GlcNAcb1-2Mana1-3(Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAcb |
| NeuAca2-6Galb1-4GlcNAcb1-2Mana1-3(Galb1- | NeuAca2-3Galb1-4GlcNAcb1-2Mana1-3(Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-6Galb1-4GlcNAcb1-2Mana1-3(Galb1- | Galb1-4GlcNAcb1-2Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| Galb1-4GlcNAcb1-2Mana1-3(NeuAca2-3Galb1- | Galb1-4GlcNAcb1-2Mana1-3(NeuAca2-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| GlcNAcb1-2Mana1-3(NeuGca2-6Galb1-4GlcNAcb1- | NeuGca2-6Galb1-4GlcNAcb1-2Mana1-3(GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| NeuAca2-6GalNAcb1-4GlcNAcb1-2Mana1-3(Mana1- | NeuAca2-3Galb1-3GlcNAcb1-2Mana1-3(Galb1- |
| 2Mana1-3Mana1-6)Manb1-4GlcNAcb1-4GlcNAc | 4GlcNAcb1-2Mana1-6)Manb1-4GlcNAcb1-4GlcNAc |
| Galb1-4GlcNAcb1-2Mana1-3(NeuAca2-3Galb1- | GlcNAcb1-4(Galb1-4(Fuca1-3)GlcNAcb1-2Mana1- |
| 4GlcNAcb1-2Mana1-6)Manb1-4GlcNAcb1-4GlcNAcb | 3)(Mana1-3Mana1-6)Manb1-4GlcNAcb1-4(Fuca1- |
| | 6)GlcNAc |
| Galb1-3GlcNAcb1-2Mana1-3(Galb1-4(Fuca1- | Galb1-4(Fuca1-3)GlcNAcb1-2Mana1-3(Galb1- |
| 3)GlcNAcb1-2Mana1-6)Manb1-4GlcNAcb1-4(Fuca1- | 4(Fuca1-3)GlcNAcb1-2Mana1-6)Manb1-4GlcNAcb1- |
| 6)GlcNAc | 4GlcNAc |
| Fuca1-2Galb1-4GlcNAcb1-2Mana1-3(Fuca1-2Galb1- | Galb1-4GlcNAcb1-2Mana1-3(Fuca1-2Galb1- |
| 4GlcNAcb1-2Mana1-6)Manb1-4GlcNAcb1-4GlcNAc | 4GlcNAcb1-2Mana1-6)Manb1-4GlcNAcb1-4(Fuca1- |
| | 6)GlcNAcb |
| Galb1-4GlcNAcb1-2Mana1-3(Galb1-4(Fuca1- | Gala1-3(Fuca1-2)Galb1-4GlcNAcb1-2Mana1- |
| 3)GlcNAcb1-2Mana1-6)Manb1-4GlcNAcb1-4(Fuca1- | 3(GlcNAcb1-2Mana1-6)Manb1-4GlcNAcb1-4(Fuca1- |
| 6)GlcNAcb | 6)GlcNAc |
| Fuca1-2Galb1-4GlcNAcb1-2Mana1-3(Galb1- | Galb1-4(Fuca1-3)GlcNAcb1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAc |
| Galb1-4(Fuca1-3)GlcNAcb1-2Mana1-3(Galb1- | Galb1-4GlcNAcb1-2Mana1-3(Fuca1-2Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAc |
| Fuca1-2Galb1-4GlcNAcb1-2Mana1-3(Galb1- | Galb1-4GlcNAcb1-2Mana1-3(Galb1-4(Fuca1- |
| 4GlcNAcb1-2Mana1-6)Manb1-4GlcNAcb1-4(Fuca1- | 3)GlcNAcb1-2Mana1-6)Manb1-4GlcNAcb1-4(Fuca1- |
| 6)GlcNAc | 6)GlcNAc |
| NeuGca2-3Galb1-4GlcNAc[6S]b1-3Galb1- | NeuGca2-3/6Galb1-4GlcNAcb1-2Mana1-3(Galb1- |
| 4GlcNAc[6S]b1-3Galb1-4GlcNAcb1-3Galb1-3GalNAc | 4GlcNAcb1-2Mana1-6)Manb1-4GlcNAcb1-4GlcNAc |
| GlcNAcb1-4(NeuGca2-3/6Galb1-4GlcNAcb1- | NeuGca2-6Galb1-4GlcNAcb1-2Mana1-3(Galb1- |
| 2Mana1-3)(Mana1-3Mana1-6)Manb1-4GlcNAcb1- | 4GlcNAcb1-2Mana1-6)Manb1-4GlcNAcb1-4GlcNAc |
| 4GlcNAc | |
| NeuGca2-6Galb1-4GlcNAcb1-2Mana1-3(Galb1- | Galb1-4GlcNAcb1-2Mana1-3(Galb1-3Galb1- |
| 4GlcNAcb1-2Mana1-6)Manb1-4GlcNAcb1-4GlcNAcb | 4GlcNAcb1-2Mana1-6)Manb1-4GlcNAcb1-4(Fuca1- |
| | 6)GlcNAc |
| Galb1-4GlcNAcb1-2Mana1-3(Gala1-3Galb1- | Gala1-3Galb1-4GlcNAcb1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6GlcNAcb |
| Galb1-3Galb1-4GlcNAcb1-2Mana1-3(Galb1- | GlcNAcb1-4(Galb1-4GlcNAcb1-2Mana1-3)(Mana1- |
| 4GlcNAcb1-2Mana1-6)Manb1-4GlcNAcb1-4(Fuca1- | 3(Mana1-6)Mana1-6)Manb1-4GlcNAcb1-4(Fuca1- |
| 6)GlcNAc | 6)GlcNAcb |
| Gala1-3Galb1-4GlcNAcb1-2Mana1-3(Galb1- | Galb1-4GlcNAcb1-2Mana1-3(Gala1-3Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAcb |
| GlcNAcb1-4(Galb1-4GlcNAcb1-2Mana1-3)(Mana1- | GlcNAcb1-4(Galb1-4(Fuca1-3)GlcNAcb1-2Mana1- |
| 3(Mana1-6)Mana1-6)Manb1-4GlcNAcb1-4(Fuca1- | 3)(Mana1-3(Mana1-6)Mana1-6)Manb1-4GlcNAcb1- |
| 6)GlcNAc | 4GlcNAc |
| Galb1-4GlcNAcb1-2Mana1-3(Gala1-3Galb1- | Galb1-4(Fuca1-3)GlcNAcb1-2(GlcNAcb1-4)Mana1- |
| 4GlcNAcb1-2Mana1-6)Manb1-4GlcNAcb1-4(Fuca1- | 3(Mana1-3(Mana1-6)Mana1-6)Manb1-4GlcNAcb1- |
| 6)GlcNAc | 4GlcNAc |
| GalNAca1-3(Fuca1-2)Galb1-4GlcNAcb1-3(Galb1- | |
| 4GlcNAcb1-6)Galb1-4GlcNAcb1-3(NeuAca2- | |
| 6)GalNAc | |
| | NeuAca2-6GalNAcb1-4GlcNAcb1-2Mana1- |
| | 3(GlcNAcb1-2Mana1-6)Manb1-4GlcNAcb1-4(Fuca1- |
| | 6)GlcNAcb |
| Galb1-4GlcNAcb1-2(Galb1-4GlcNAcb1-4)Mana1- | Galb1-4Galb1-4GlcNAcb1-2Mana1-3(Galb1-4Galb1- |
| 3(Galb1-4GlcNAcb1-2(Galb1-4GlcNAcb1-6)Mana1- | 4GlcNAcb1-2Mana1-6)Manb1-4GlcNAcb1-4GlcNAc |
| 6)Man | |
| Gala1-3Galb1-4GlcNAcb1-2Mana1-3(Gala1-3Galb1- | Gala1-3Galb1-4GlcNAcb1-2Mana1-3(Gala1-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| GlcNAcb1-4(Gala1-3Galb1-4GlcNAcb1-2Mana1- | Galb1-4GlcNAcb1-2(Galb1-4GlcNAcb1-4)Mana1- |
| 3)(Mana1-3(Mana1-6)Mana1-6)Manb1-4GlcNAcb1- | 3(Mana1-3(Mana1-6)Mana1-6)Manb1-4GlcNAcb1- |
| 4GlcNAc | 4GlcNAc |
| GlcNAcb1-4(NeuAca2-6Galb1-4GlcNAcb1-2Mana1- | NeuAca2-6GalNAcb1-4GlcNAcb1-2Mana1-3(Galb1- |
| 3)(GlcNAcb1-2Mana1-6)Manb1-4GlcNAcb1-4GlcNAc | 4GlcNAcb1-2Mana1-6)Manb1-4GlcNAcb1-4GlcNAcb |
| NeuAca2-6GalNAcb1-4GlcNAcb1-2Mana1-3(Galb1- | GlcNAcb1-4(NeuAca2-3/6Galb1-4GlcNAcb1- |
| 4GlcNAcb1-2Mana1-6)Manb1-4GlcNAcb1-4GlcNAc | 2Mana1-3)(GlcNAcb1-2Mana1-6)Manb1- |
| | 4GlcNAcb1-4GlcNAc |
| GlcNAcb1-4(GlcNAcb1-2Mana1-3)(NeuAca2- | GalNAcb1-4GlcNAcb1-2Mana1-3(NeuAca2-6Galb1- |
| 3Galb1-4GlcNAcb1-2Mana1-6)Manb1-4GlcNAcb1- | 4GlcNAcb1-2Mana1-6)Manb1-4GlcNAcb1-4GlcNAc |
| 4GlcNAc | |
| GlcNAcb1-4(Galb1-4(Fuca1-3)GlcNAcb1-2Mana1- | Galb1-4(Fuca1-3)GlcNAcb1-2Mana1-3(GalNAcb1- |
| 3)(GlcNAcb1-2Mana1-6)Manb1-4GlcNAcb1- | 4GlcNAcb1-2Mana1-6)Manb1-4GlcNAcb1-4(Fuca1- |
| 4(Fuca1-6)GlcNAc | 6)GlcNAc |
| GalNAca1-3(Fuca1-2)Galb1-3GlcNAcb1-3(Fuca1- | GalNAca1-3(Fuca1-2)Galb1-3GlcNAcb1-3(Fuca1- |
| 2Galb1-3GlcNAcb1-6)Galb1-3(Galb1-4GlcNAcb1- | 2Galb1-3GlcNAcb1-6)Galb1-3GlcNAcb1-3Galb1- |
| 6)GalNAc | 3GalNAc |
| Galb1-4(Fuca1-3)GlcNAcb1-2Mana1-3(GalNAcb1- | GlcNAcb1-4(GlcNAcb1-2Mana1-3)(Galb1-4(Fuca1- |
| 4(Fuca1-3)GlcNAcb1-2Mana1-6)Manb1-4GlcNAcb1- | 3)GlcNAcb1-2Mana1-6)Manb1-4GlcNAcb1-4(Fuca1- |
| 4GlcNAc | 6)GlcNAc |
| GlcNAcb1-4(GlcNAcb1-2Mana1-3)(Galb1-4(Fuca1- | GlcNAcb1-4(Galb1-4GlcNAcb1-2Mana1-3)(Fuca1- |
| 3)GlcNAcb1-2Mana1-6)Manb1-4GlcNAcb1-4(Fuca1- | 3GlcNAcb1-2Mana1-6)Manb1-4GlcNAcb1-4(Fuca1- |
| 6)GlcNAcb | 6)GlcNAcb |
| GalNAca1-3(Fuca1-2)Galb1-4GlcNAcb1-2Mana1- | NeuAca2-6Galb1-4GlcNAcb1-2Mana1-3(NeuAca2- |
| 3(GlcNAcb1-2Mana1-6)Manb1-4GlcNAcb1-4(Fuca1- | 6Galb1-4GlcNAcb1-2Mana1-6)Manb1-4Glcb |
| 6)GlcNAc | |
| NeuAca2-3Galb1-4GlcNAcb1-2Mana1-3(NeuAca2- | NeuAca2-3Galb1-4GlcNAcb1-2Mana1-3(NeuAca2- |
| 6Galb1-4GlcNAcb1-2Mana1-6)Manb1-4Glcb | 3Galb1-4GlcNAcb1-2Mana1-6)Manb1-4Glcb |
| GalNAc[4S]b1-4GlcNAcb1-2Mana1-3(Gal[3S]b1- | NeuAca2-3Galb1-3(NeuAca2-3Galb1-3(Fuca1- |
| 4GlcNAcb1-2Mana1-6)Manb1-4GlcNAcb1-4(Fuca1- | 4)GlcNAcb1-3Galb1-4(Fuca1-3)GlcNAcb1-6)GalNAc |
| 6)GlcNAc | |
| GlcNAcb1-4(Galb1-4GlcNAcb1-2Mana1-3)(Galb1- | GlcNAcb1-4(Galb1-4GlcNAcb1-4Mana1-3)(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAcb |
| GlcNAcb1-4(Galb1-4GlcNAcb1-2Mana1-3)(Galb1- | Fuca1-6GlcNAcb1-4GlcNAcb1-4(Galb1-4GlcNAcb1- |
| 4GlcNAcb1-2Mana1-6)Manb1-4GlcNAcb1-4(Fuca1- | 2Mana1-3)(Galb1-4GlcNAcb1-2Mana1-6)Manb1- |
| 6)GlcNAc | 4GlcNAc |
| Galb1-4GlcNAcb1-2(GlcNAcb1-4)Mana1-3(Galb1- | GlcNAcb1-4(Galb1-4(Fuca1-3)GlcNAcb1-2Mana1- |
| 4GlcNAcb1-2Mana1-6)Manb1-4GlcNAcb1-4(Fuca1- | 3)(Galb1-4GlcNAcb1-2Mana1-6)Manb1-4GlcNAcb1- |
| 6)GlcNAc | 4GlcNAc |
| GlcNAcb1-4(Galb1-4GlcNAcb1-4Mana1-3)(Galb1- | Galb1-4GlcNAcb1-2(GlcNAcb1-4)Mana1-3(Galb1- |
| 4GlcNAcb1-4Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| GlcNAcb1-2Mana1-3(Galb1-4GlcNAcb1-2(Galb1- | Galb1-4GlcNAcb1-2(Galb1-4GlcNAcb1-4)Mana1- |
| 4GlcNAcb1-6)Mana1-6)Manb1-4GlcNAcb1-4(Fuca1- | 3(GlcNAcb1-2Mana1-6)Manb1-4GlcNAcb1-4(Fuca1- |
| 6)GlcNAc | 6)GlcNAc |
| GlcNAcb1-2(Galb1-4GlcNAcb1-2Mana1-3)(Galb1- | GlcNAcb1-2/4Mana1-3(Galb1-4GlcNAcb1-2(Galb1- |
| 4GlcNAcb1-2Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAcb |
| Galb1-4GlcNAcb1-6(Galb1-4GlcNAcb1-2(Galb1- | Galb1-4GlcNAcb1-2Mana1-3(Galb1-4GlcNAcb1- |
| 4(Fuca1-3)GlcNAcb1-3)Manb1-3)Manb1- | 2Mana1-6)GlcNAcb1-4Manb1-4GlcNAcb1-4(Fuca1- |
| 4GlcNAcb1-4GlcNAcb | 6)GlcNAc |
| GlcNAcb1-4(Galb1-4GlcNAcb1-2Mana1-3)(Galb1- | |
| 4GlcNAcb1-2Mana1-6)Manb1-4GlcNAcb1-4(Fuca1- | |
| 6)GlcNAc | |
| | GlcNAcb1-4(Galb1-4GlcNAcb1-2Mana1-3)(Galb1- |
| | 4(Fuca1-3)GlcNAcb1-2Mana1-6)Manb1-4GlcNAcb1- |
| | 4GlcNAcb |
| Gala1-3Galb1-4GlcNAcb1-2Mana1-3(GalNAcb1- | Neua1-6Galb1-4GlcNAcb1-2Mana1-3(Neua1- |
| 4GlcNAcb1-2Mana1-6)Manb1-4GlcNAcb1-4(Fuca1- | 6Galb1-4GlcNAcb1-2Mana1-6)Manb1-4GlcNAcb1- |
| 6)GlcNAcb | 4GlcNAc |
| Neua1-3Galb1-4GlcNAcb1-2Mana1-3(Neua1- | NeuAca2-6Galb1-4GlcNAc[6S]b1-2Mana1- |
| 3Galb1-4GlcNAcb1-2Mana1-6)Manb1-4GlcNAcb1- | 3(GlcNAcb1-2Mana1-6)Manb1-4GlcNAcb1-4(Fuca1- |
| 4GlcNAc | 6)GlcNAc |
| Glca1-3Glca1-3Mana1-2Mana1-2Mana1-3(Mana1- | Mana1-2Mana1-2(Mana1-6Mana1-6)Mana1- |
| 2Mana1-3(Mana1-2Mana1-6)Mana1-6)Manb1- | 3(Mana1-3(Mana1-2Mana1-2Mana1-6)Mana1- |
| 4GlcNAc | 6)Manb1-4GlcNAc |
| Mana1-2Mana1-2(Mana1-6Mana1-6Mana1- | Mana1-3Mana1-2Mana1-2(Mana1-6)Mana1- |
| 6)Mana1-3(Mana1-3(Mana1-2Mana1-6)Mana1- | 3(Mana1-3(Mana1-3Mana1-2Mana1-6)Mana1- |
| 6)Manb1-4GlcNAc | 6)Manb1-4GlcNAc |
| Glca1-2Glca1-3Mana1-2Mana1-2Mana1-3(Mana1- | Mana1-2Mana1-2(Mana1-2Mana1-6)Mana1- |
| 2Mana1-3(Mana1-2Mana1-6)Mana1-6)Manb1- | 3(Mana1-2Mana1-3(Mana1-2Mana1-6)Mana1- |
| 4GlcNAc | 6)Manb1-4GlcNAc |
| Mana1-2Mana1-2(Mana1-2Mana1-6Mana1- | Mana1-2Mana1-2(Mana1-2(Mana1-6)Mana1- |
| 6)Mana1-3(Mana1-3(Mana1-2Mana1-6)Mana1- | 6)Mana1-3(Mana1-3(Mana1-2Mana1-6)Mana1- |
| 6)Manb1-4GlcNAc | 6)Manb1-4GlcNAc |
| Mana1-3Mana1-2Mana1-2Mana1-3(Mana1- | Glca1-2Glca1-3Glca1-3Mana1-2Mana1-2Mana1- |
| 3(Mana1-2(Mana1-2Mana1-6)Mana1-6)Mana1- | 3(Mana1-3(Mana1-2Mana1-6)Mana1-6)Manb1- |
| 6)Manb1-4GlcNAc | 4GlcNAc |
| Mana1-3Mana1-2Mana1-2(Mana1-3Mana1-2Mana1- | Mana1-3Mana1-2Mana1-2(Mana1-2Mana1- |
| 6)Mana1-3(Mana1-3(Mana1-6)Mana1-6)Manb1- | 6)Mana1-3(Mana1-3(Mana1-2Mana1-6)Mana1- |
| 4GlcNAc | 6)Manb1-4GlcNAc |
| Glca1-2Glca1-3Glca1-3Mana1-2Mana1-2(Mana1- | Glca1-2Glca1-3Glca1-3Mana1-2Mana1-2Mana1- |
| 6)Mana1-3(Mana1-3(Mana1-6)Mana1-6)Manb1- | 3(Mana1-2Mana1-3(Mana1-6)Mana1-6)Manb1- |
| 4GlcNAc | 4GlcNAc |
| Glcb1-2Glcb1-2Glcb1-2Mana1-2Mana1-2Mana1- | Glca1-3Glca1-3Mana1-2Mana1-2Mana1-3(Mana1- |
| 3(Mana1-3(Mana1-2Mana1-6)Mana1-6)Manb1- | 2Mana1-3(Mana1-2Mana1-6)Mana1-6)Manb1- |
| 4GlcNAc | 3GlcNAc |
| | NeuAca2-8NeuAca2-3/6Galb1-4(Fuca1-3)GlcNAcb1- |
| | 2Mana1-3(Mana1-6)Manb1-4GlcNAcb1-4GlcNAc |
| NeuAca2-8NeuAca2-3/6Galb1-4GlcNAcb1-2Mana1- | GlcNAcb1-4(GlcNAcb1-2(Galb1-4GlcNAcb1- |
| 3(Mana1-6)Manb1-4GlcNAcb1-4(Fuca1-6)GlcNAc | 4)Mana1-3)(Mana1-3(Mana1-6)Mana1-6)Manb1- |
| | 4GlcNAcb1-4GlcNAcb |
| Galb1-4GlcNAcb1-2(Galb1-4GlcNAcb1-4)Mana1- | Galb1-4GlcNAcb1-2(Galb1-4GlcNAcb1-4)Mana1- |
| 3(Galb1-4GlcNAcb1-2Mana1-6)Manb1-4GlcNAcb1- | 3(Galb1-4GlcNAcb1-2Mana1-6)Manb1-4GlcNAcb1- |
| 4GlcNAcb | 4GlcNAc |
| Galb1-4GlcNAcb1-2Mana1-3(Galb1-4GlcNAcb1- | Galb1-4GlcNAcb1-2Mana1-3(Galb1-4GlcNAcb1- |
| 2(Galb1-4GlcNAcb1-6)Mana1-6)Manb1-4GlcNAcb1- | 2(Galb1-4GlcNAcb1-4)Mana1-6)Manb1-4GlcNAcb1- |
| 4GlcNAcb | 4GlcNAc |
| Galb1-4GlcNAcb1-2Mana1-3(Galb1-4GlcNAcb1- | Galb1-4GlcNAcb1-3Galb1-4GlcNAcb1-2Mana1- |
| 2(Galb1-4GlcNAcb1-6)Mana1-6)Manb1-4GlcNAcb1- | 3(Galb1-4GlcNAcb1-2Mana1-6)Manb1-4GlcNAcb1- |
| 4GlcNAc | 4GlcNAc |
| Galb1-4GlcNAcb1-2(Galb1-4GlcNAcb1-6)Mana1- | Galb1-4GlcNAcb1-2(Galb1-4GlcNAcb1-4)Mana1- |
| 3(Galb1-4GlcNAcb1-2Mana1-6)Manb1-4GlcNAcb1- | 3(Galb1-4GlcNAcb1-2Mana1-6)Manb1-4GlcNAcb1- |
| 4GlcNAc | 4GlcNAc |
| Galb1-4GlcNAcb1-3Galb1-4GlcNAcb1-2Mana1- | Galb1-4GlcNAcb1-2Mana1-3(Galb1-4GlcNAcb1- |
| 3(Galb1-4GlcNAcb1-2Mana1-6)Manb1-4GlcNAcb1- | 2(Galb1-4GlcNAcb1-6)Mana1-6)Manb1-4GlcNAcb1- |
| 4GlcNAcb | 4GlcNAc |
| Galb1-4GlcNAcb1-2Mana1-3(Galb1-4GlcNAcb1- | Galb1-3GlcNAcb1-2Mana1-3(Galb1-4GlcNAcb1- |
| 2(Galb1-4GlcNAcb1-4)Mana1-6)Manb1-4GlcNAcb1- | 2(Galb1-4GlcNAcb1-6)Mana1-6)Manb1-4GlcNAcb1- |
| 4GlcNAcb | 4GlcNAc |
| Galb1-4GlcNAcb1-2Mana1-3(Galb1-4GlcNAcb1- | Galb1-4GlcNAcb1-2(Galb1-3GlcNAcb1-4)Mana1- |
| 2(Galb1-3GlcNAcb1-6)Mana1-6)Manb1-4GlcNAcb1- | 3(Galb1-4GlcNAcb1-2Mana1-6)Manb1-4GlcNAcb1- |
| 4GlcNAc | 4GlcNAc |
| GlcNAcb1-4(Gala1-3Galb1-4GlcNAcb1-2Mana1- | Galb1-3GlcNAcb1-2Mana1-3(Galb1-4GlcNAcb1- |
| 3)(Galb1-4GlcNAcb1-2Mana1-6)Manb1-4GlcNAcb1- | 2(Galb1-4GlcNAcb1-4)Mana1-6)Manb1-4GlcNAcb1- |
| 4GlcNAc | 4GlcNAc |
| | Galb1-4GlcNAcb1-2Mana1-3(Galb1-4GlcNAcb1- |
| | 3Galb1-4GlcNAcb1-2Mana1-6)Manb1-4GlcNAcb1- |
| | 4GlcNAc |
| Galb1-4GlcNAcb1-2(Galb1-3GlcNAcb1-4)Mana1- | Galb1-4GlcNAcb1-2(Galb1-3GlcNAcb1-4)Mana1- |
| 3(Galb1-4GlcNAcb1-2Mana1-6)Manb1-4GlcNAcb1- | 3(Galb1-4GlcNAcb1-2Mana1-6)Manb1-4GlcNAcb1- |
| 4GlcNAcb | 4GlcNAc |
| Galb1-3GlcNAcb1-2(Galb1-4GlcNAcb1-4)Mana1- | GlcNAcb1-4(GlcNAcb1-2(Galb1-4GlcNAcb1- |
| 3(Galb1-4GlcNAcb1-2Mana1-6)Manb1-4GlcNAcb1- | 4)Mana1-3)(Mana1-3(Mana1-6)Mana1-6)Manb1- |
| 4GlcNAc | 4GlcNAcb1-4GlcNAc |
| Galb1-4GlcNAcb1-2(Galb1-4GlcNAcb1-3)Mana1- | GlcNAcb1-4(Galb1-4GlcNAcb1-2(GlcNAcb1- |
| 3(Galb1-4GlcNAcb1-2Mana1-6)Manb1-4GlcNAcb1- | 4)Mana1-3)(Mana1-3(Mana1-6)Mana1-6)Manb1- |
| 4GlcNAcb | 4GlcNAcb1-4GlcNAc |
| GlcNAcb1-4(GlcNAcb1-2(Galb1-4GlcNAcb1- | Galb1-4GlcNAcb1-2(Galb1-4GlcNAcb1-4)Mana1- |
| 4)Mana1-3)(Mana1-3(Mana1-6)Mana1-6)Manb1- | 3(Galb1-4GlcNAcb1-2Mana1-6)Manb1-4GlcNAcb1- |
| 4GlcNAcb1-4GlcNAc | 4GlcNAc |
| NeuAca2-3Galb1-4GlcNAc[6S]b1-3Galb1- | Gal[3S]b1-4GlcNAcb1-2Mana1-3(NeuAca2-3Galb1- |
| 4GlcNAc[6S]b1-3Galb1-4GlcNAc[6S]b1-3Galb1- | 4GlcNAcb1-2Mana1-6)Manb1-4GlcNAcb1-4GlcNAc |
| 3GalNAc | |
| GalNAcb1-4(Fuca1-3)GlcNAcb1-2Mana1- | GalNAcb1-4GlcNAcb1-2Mana1-3(GalNAcb1- |
| 3(GalNAcb1-4GlcNAcb1-2Mana1-6)Manb1- | 4(Fuca1-3)GlcNAcb1-2Mana1-6)Manb1-4GlcNAcb1- |
| 4GlcNAcb1-4(Fuca1-6)GlcNAc | 4(Fuca1-6)GlcNAc |
| GalNAcb1-4GlcNAcb1-2Mana1-3(GalNAcb1- | GalNAcb1-4(Fuca1-3)GlcNAcb1-2Mana1- |
| 4(Fuca1-3)GlcNAcb1-2Mana1-6)Manb1-4GlcNAcb1- | 3(GalNAcb1-4GlcNAcb1-2Mana1-6)Manb1- |
| 4(Fuca1-6)GlcNAcb | 4GlcNAcb1-4(Fuca1-6)GlcNAcb |
| GalNAcb1-4(Fuca1-3)GlcNAcb1-2Mana1- | GlcNAcb1-4(GalNAcb1-4(Fuca1-3)GlcNAcb1- |
| 3(GalNAcb1-4(Fuca1-3)GlcNAcb1-2Mana1- | 2Mana1-3)(GlcNAcb1-2Mana1-6)Manb1- |
| 6)Manb1-4GlcNAcb1-4GlcNAc | 4GlcNAcb1-4(Fuca1-6)GlcNAc |
| NeuAca2-8NeuAca2-3/6Galb1-4GlcNAcb1-2Mana1- | NeuAca2-8NeuGca2-3/6Galb1-4GlcNAcb1-2Mana1- |
| 3(Mana1-3Mana1-6)Manb1-4GlcNAcb1-4GlcNAc | 3(Mana1-6)Manb1-4GlcNAcb1-4(Fuca1-6)GlcNAc |
| NeuAca2-8NeuGca2-3/6Galb1-4(Fuca1- | NeuAca2-6Galb1-4GlcNAcb1-2Mana1-3(NeuAca2- |
| 3)GlcNAcb1-2Mana1-3(Mana1-6)Manb1- | 3Galb1-4GlcNAcb1-2Mana1-6)Manb1-4GlcNAc |
| 4GlcNAcb1-4GlcNAc | |
| NeuAca2-6Galb1-4GlcNAcb1-2Mana1-3(NeuAca2- | |
| 6Galb1-4GlcNAcb1-2Mana1-6)Manb1-4GlcNAc | |
| | NeuAca2-3Galb1-4GlcNAcb1-2Mana1-3(NeuAca2- |
| | 3Galb1-4GlcNAcb1-2Mana1-6)Manb1-4GlcNAc |
| NeuAca2-6Galb1-4GlcNAcb1-2Manb1-3(NeuAca2- | NeuAca2-3Galb1-4GlcNAcb1-2Glca1-3(NeuAca2- |
| 6Galb1-4GlcNAcb1-2Manb1-6)Mana1-4GlcNAc | 3Galb1-4GlcNAcb1-2Glca1-6)Manb1-4GlcNAc |
| NeuAca2-3Galb1-4GlcNAcb1-2Mana1-3(NeuAca2- | NeuAca2-6Galb1-4GlcNAcb1-2Manb1-3(NeuAca2- |
| 6Galb1-4GlcNAcb1-2Mana1-6)Manb1-4GlcNAc | 3Galb1-4GlcNAcb1-2Manb1-6)Mana1-4GlcNAc |
| NeuAca2-3Galb1-4GlcNAcb1-2Glca1-3(NeuAca2- | NeuAca2-3Galb1-4GlcNAcb1-2Manb1-3(NeuAca2- |
| 6Galb1-4GlcNAcb1-2Glca1-6)Manb1-4GlcNAc | 3Galb1-4GlcNAcb1-2Manb1-6Mana1-4GlcNAc |
| NeuAca2-3Galb1-4GlcNAcb1-2Mana1-3(NeuAca2- | NeuAca2-3Galb1-3GlcNAcb1-2Mana1-3(NeuAca2- |
| 3Galb1-4GlcNAcb1-4Mana1-6)Manb1-4GlcNAc | 3Galb1-3GlcNAcb1-2Mana1-6)Manb1-4GlcNAcb |
| Gal[3ME]b1-6Gal[3ME]b1-3(Gal[3ME]b1- | Gal[3ME]b1-6Gal[3ME]b1-3(Gal[3ME]b1- |
| 6Gal[3ME]b1-6)GalNAcb1-4GlcNAcb1-2Mana1- | 6Gal[3ME]b1-6)GlcNAcb1-4GlcNAcb1-2Mana1- |
| 3(Mana1-6)Manb1-4GlcNAcb1-4GlcNAc | 3(Mana1-6)Manb1-4GlcNAcb1-4GlcNAc |
| NeuAca2-3/6Galb1-4(Fuca1-3)GlcNAcb1-2Mana1- | NeuGca2-3Galb1-4GlcNAc[6S]b1-3Galb1- |
| 3(Mana1-3Mana1-6)Manb1-4GlcNAcb1-4(Fuca1- | 4GlcNAc[6S]b1-3Galb1-4GlcNAc[6S]b1-3Galb1- |
| 6)GlcNAc | 3GalNAc |
| GalNAc[4S]b1-4GlcNAcb1-2Mana1- | GalNAc[4S]b1-4GlcNAcb1-2Mana1- |
| 3(GalNAc[4S]b1-4GlcNAcb1-2Mana1-6)Manb1- | 3(GalNAc[4S]b1-4GlcNAcb1-2Mana1-6)Manb1- |
| 4GlcNAcb1-4(Fuca1-6)GlcNAc | 4GlcNAcb1-4(Fuca1-6)GlcNAcb |
| GalNAc[3S]b1-4GlcNAcb1-2Mana1- | GlcNAcb1-3(NeuAca2-6)Galb1-4GlcNAcb1- |
| 3(GalNAc[3S]b1-4GlcNAcb1-2Mana1-6)Manb1- | 3(NeuAca2-6)Galb1-4GlcNAcb1-3(NeuAca2- |
| 4GlcNAcb1-4(Fuca1-6)GlcNAc | 6)GalNAc |
| Mana1-2Mana1-2Mana1-3(Mana1-2Mana1- | GlcNAcb1-2(GlcNAcb1-4)Mana1-3(Galb1- |
| 3(Mana1-2Mana1-6)Mana1-6)Manb1-4GlcNAcb1- | 4GlcNAcb1-2(GlcNAcb1-6)Mana1-6)Manb1- |
| 4(Fuca1-6)GlcNAc | 4GlcNAcb1-4(Fuca1-6)GlcNAc |
| GlcNAcb1-4(Galb1-4GlcNAcb1-2(GlcNAcb1- | Galb1-4(Fuca1-3)GlcNAcb1-2(GlcNAcb1-4)Mana1- |
| 4)Mana1-3)(GlcNAcb1-2Mana1-6)Manb1- | 3(GlcNAcb1-2(GlcNAcb1-6)Mana1-6)Manb1- |
| 4GlcNAcb1-4(Fuca1-6)GlcNAc | 4GlcNAcb1-4GlcNAc |
| GlcNAcb1-4(Galb1-4GlcNAcb1-2Mana1- | Galb1-4GlcNAcb1-2(GlcNAcb1-4)Mana1- |
| 3)(GalNAcb1-4GlcNAcb1-2Mana1-6)Manb1- | 3(GlcNAcb1-2(GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1-2Mana1- | GlcNAcb1-4(GlcNAcb1-2(Galb1-4GlcNAcb1- |
| 3)(GalNAcb1-4GlcNAcb1-2Mana1-6)Manb1- | 4)Mana1-3)(GlcNAcb1-2Mana1-6)Manb1- |
| 4GlcNAcb1-4GlcNAc | 4GlcNAcb1-4(Fuca1-6)GlcNAc |
| GalNAcb1-4GlcNAcb1-2(Galb1-4GlcNAcb1- | GlcNAcb1-2(Galb1-4GlcNAcb1-4)Mana1- |
| 4)Mana1-3(GlcNAcb1-2Mana1-6)Manb1- | 3(GlcNAcb1-2(GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-2(GlcNAcb1-4)Mana1-3(GlcNAcb1- | GlcNAcb1-4(GlcNAcb1-2(GlcNAcb1-4)Mana1- |
| 2(Galb1-4GlcNAcb1-6)Mana1-6)Manb1-4GlcNAcb1- | 3)(Galb1-4GlcNAcb1-2Mana1-6)Manb1-4GlcNAcb1- |
| 4(Fuca1-6)GlcNAc | 4(Fuca1-6)GlcNAc |
| GlcNAc[6S]b1-3Gal[6S]b1-4GlcNAc[6S]b1- | NeuAca2-6Galb1-4GlcNAcb1-2Mana1-3(Mana1- |
| 3Gal[6S]b1-4GlcNAc[6S]b1-3Gal[6S]b1- | 2Mana1-3Mana1-6)Manb1-4GlcNAcb1-4(Fuca1- |
| 4GlcNAc[6S]b1-3Gal | 6)GlcNAc |
| NeuAca2-3Galb1-4GlcNAcb1-3Mana1-3(Mana1- | NeuAca2-3Galb1-4GlcNAcb1-2Mana1-3(Mana1- |
| 3(Mana1-6)Mana1-6)Manb1-4GlcNAcb1-4(Fuca1- | 3(Mana1-6)Mana1-6)Manb1-4GlcNAcb1-4(Fuca1- |
| 6)GlcNAcb | 6)GlcNAc |
| NeuAca2-3Galb1-4GlcNAcb1-2Mana1-3(Mana1- | Fuca1-2Galb1-4(Fuca1-3)GlcNAcb1-2Mana1- |
| 3(Mana1-6)Mana1-6)Manb1-4GlcNAcb1-4(Fuca1- | 3(Mana1-3(Mana1-6)Mana1-6)Manb1-4GlcNAcb1- |
| 6)GlcNAcb | 4(Fuca1-6)GlcNAcb |
| Mana1-2Man[6P]a1-2Mana1-3(Mana1-2Mana1- | Glca1-3Glca1-3Mana1-2Mana1-2Mana1-3(Mana1- |
| 3(Mana1-2Man[6P]a1-6)Mana1-6)Manb1- | 3(Mana1-2Mana1-6)Mana1-6)Manb1-4GlcNAcb1- |
| 4GlcNAcb1-4GlcNAcb | 4GlcNAc |
| Mana1-2Mana1-2Mana1-3(Mana1-2Mana1- | Glca1-3Mana1-2Mana1-2Mana1-3(Mana1-2Mana1- |
| 3(Mana1-2Mana1-2Mana1-6)Mana1-6)Manb1- | 3(Mana1-2Mana1-6)Mana1-6)Manb1-4GlcNAcb1- |
| 4GlcNAcb1-4GlcNAc | 4GlcNAc |
| Glca1-3Mana1-2Mana1-2Mana1-3(Mana1-2Mana1- | Glca1-3Mana1-2Mana1-2Mana1-3(Mana1-2Mana1- |
| 3(Mana1-2Mana1-6)Mana1-6)Manb1-4GlcNAcb1- | 3(Mana1-2Mana1-6)Mana1-6)Manb1-4GlcNAcb1- |
| 4GlcNAc | 4GlcNAcb |
| Mana1-2Mana1-2Mana1-2Mana1-2Mana1-2Mana1- | |
| 3(Mana1-2Mana1-2Mana1-6)Manb1-4GlcNAcb1- | |
| 4GlcNAcb | |
| | Mana1-2Mana1-3(Mana1-2Mana1-2Mana1- |
| | 6)Mana1-3(Mana1-2Mana1-2Mana1-6)Manb1- |
| | 4GlcNAcb1-4GlcNAcb |
| Glca1-2Glca1-3Glca1-3Mana1-2Mana1-2Mana1- | Mana1-2Mana1-2Mana1-2Mana1-3(Mana1-2Mana1- |
| 3(Mana1-2Mana1-3Mana1-6)Manb1-4GlcNAcb1- | 3(Mana1-2Mana1-6)Mana1-6)Manb1-4GlcNAcb1- |
| 4GlcNAc | 4GlcNAc |
| Mana1-3Mana1-2Mana1-2Mana1-3(Mana1- | Glca1-3Glca1-3Mana1-2Mana1-2(Mana1-3Mana1- |
| 3(Mana1-3Mana1-2Mana1-6)Mana1-6)Manb1- | 2Mana1-6)Mana1-3(Mana1-6)Manb1-4GlcNAcb1- |
| 4GlcNAcb1-4GlcNAcb | 4GlcNAc |
| Mana1-3Mana1-2Mana1-2Mana1-3(Mana1- | Glca1-2Glca1-3Glca1-3Mana1-2Mana1-2Mana1- |
| 3(Mana1-3Mana1-2Mana1-6)Mana1-6)Manb1- | 3(Mana1-3(Mana1-6)Mana1-6)Manb1-4GlcNAcb1- |
| 4GlcNAcb1-4GlcNAc | 4GlcNAc |
| Glca1-2Glca1-3Glca1-3Mana1-2Mana1-2Mana1- | Mana1-2Mana1-2(Mana1-2Mana1-6)Mana1- |
| 3(Mana1-3(Mana1-6)Mana1-6)Manb1-4GlcNAcb1- | 3(Mana1-3(Mana1-2Mana1-6)Mana1-6)Manb1- |
| 4GlcNAcb | 4GlcNAcb1-4GlcNAc |
| Mana1-2Mana1-2(Mana1-2Mana1-6)Mana1- | Glca1-2Glca1-3Glca1-3Mana1-2Mana1-2(Mana1- |
| 3(Mana1-3(Mana1-2Mana1-6)Mana1-6)Manb1- | 2Mana1-6)Mana1-3(Mana1-6)Manb1-4GlcNAcb1- |
| 4GlcNAcb1-4GlcNAcb | 4GlcNAc |
| GlcNAcb1-4(Galb1-4GlcNAcb1-2(Galb1-4GlcNAcb1- | GalNAcb1-4GlcNAcb1-2(Galb1-4GlcNAcb1- |
| 4)Mana1-3)(GlcNAcb1-2Mana1-6)Manb1- | 4)Mana1-3(Galb1-4GlcNAcb1-2Mana1-6)Manb1- |
| 4GlcNAcb1-4GlcNAc | 4GlcNAcb1-4GlcNAc |
| GlcNAcb1-4(GlcNAcb1-2(Galb1-4GlcNAcb1- | GalNAcb1-4GlcNAcb1-2Mana1-3(Galb1-4GlcNAcb1- |
| 4)Mana1-3)(Galb1-4GlcNAcb1-2Mana1-6)Manb1- | 2(Galb1-4GlcNAcb1-6)Mana1-6)Manb1-4GlcNAcb1- |
| 4GlcNAcb1-4GlcNAc | 4GlcNAc |
| GlcNAcb1-2(GlcNAcb1-4)Mana1-3(Galb1- | GlcNAcb1-4(GlcNAcb1-2(Galb1-4GlcNAcb1- |
| 4GlcNAcb1-2(Galb1-4GlcNAcb1-6)Mana1-6)Manb1- | 4)Mana1-3)(Galb1-4GlcNAcb1-2Mana1-6)Manb1- |
| 4GlcNAcb1-4GlcNAc | 4GlcNAcb1-4GlcNAcb |
| GlcNAcb1-4(GlcNAcb1-2(GlcNAcb1-4)Mana1- | NeuGca2-8NeuGca2-3/6Galb1-4GlcNAcb1-2Mana1- |
| 3)(Mana1-3(Mana1-6)Mana1-6)Manb1-4GlcNAcb1- | 3(Mana1-3Mana1-6)Manb1-4GlcNAcb1-4GlcNAc |
| 4GlcNAcb1-4GlcNAc | |
| GlcNAc[3S]b1-4GlcNAcb1-2Mana1-3(NeuAca2- | GlcNAc[4S]b1-4GlcNAcb1-2Mana1-3(NeuAca2- |
| 6Galb1-4GlcNAcb1-2Mana1-6)Manb1-4GlcNAcb1- | 3Galb1-4GlcNAcb1-2Mana1-6)Manb1-4GlcNAcb1- |
| 4GlcNAc | 4GlcNAcb |
| GalNAc[4S]b1-4GlcNAcb1-2Mana1-3(NeuAca2- | GalNAc[4S]b1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4GlcNAc | 4GlcNAc |
| GalNAc[4S]b1-4GlcNAcb1-2Mana1-3(NeuAca2- | Gala1-3(Fuca1-2)Galb1-4GlcNAcb1-3(Gala1- |
| 6Galb1-4GlcNAcb1-2Mana1-6)Manb1-4GlcNAcb1- | 3(Fuca1-2)Galb1-4GlcNAcb1-6)Galb1-4GlcNAcb1- |
| 4GlcNAcb | 3Galb1-4Glcb |
| Fuca1-3GalNAcb1-4Galb1-3Galb1-3(NeuAca2- | NeuAca2-3Galb1-3(NeuAca2-3Galb1-4GlcNAcb1- |
| 8NeuAca2-8NeuAca2-8NeuAca2-6)GalNAca | 3Galb1-4GlcNAcb1-3Galb1-4GlcNAcb1-6)GalNAc |
| NeuAca2-6GlcNAcb1-2Mana1-3(NeuAca2-6Galb1- | NeuAca2-3Galb1-4GlcNAcb1-3Galb1-3(NeuAca2- |
| 4GlcNAcb1-2Mana1-6)Manb1-4GlcNAcb1-4GlcNAcb | 3Galb1-4GlcNAcb1-3Galb1-4GlcNAcb1-6)GalNAc |
| NeuAca2-3Galb1-3(Galb1-3(Fuca1-4)GlcNAcb1- | NeuAca2-6Galb1-4GlcNAcb1-2Mana1-3(Fuca1- |
| 3Galb1-4GlcNAcb1-3Galb1-4(Fuca1-3)GlcNAcb1- | 3GlcNAcb1-2Mana1-6)Manb1-4GlcNAcb1-4(Fuca1- |
| 6)GalNAc | 6)GlcNAcb |
| NeuAca2-3Galb1-3(Fuca1-2Galb1-3(Fuca1- | Fuca1-2Galb1-4(Fuca1-3)GlcNAcb1-2Mana1- |
| 4)GlcNAcb1-3Galb1-4GlcNAcb1-3Galb1-4GlcNAcb1- | 3(Fuca1-3GlcNAcb1-2Mana1-6)Manb1-4GlcNAcb1- |
| 6)GalNAc | 4(Fuca1-6)GlcNAc |
| GlcNAcb1-4(GalNAcb1-4(Fuca1-3)GlcNAcb1- | GlcNAcb1-4(GlcNAcb1-2(GlcNAcb1-4)Mana1- |
| 2Mana1-3)(GalNAcb1-4GlcNAcb1-2Mana1- | 3)(GlcNAcb1-2(GlcNAcb1-6)Mana1-6)Manb1- |
| 6)Manb1-4GlcNAcb1-4GlcNAc | 4GlcNAcb1-4(Fuca1-6)GlcNAc |
| GalNAcb1-4GlcNAcb1-2(GlcNAcb1-4)Mana1- | GalNAcb1-4GlcNAcb1-2Mana1-3(GlcNAcb1- |
| 3(GlcNAcb1-2(GlcNAcb1-6)Mana1-6)Manb1- | 2(GalNAcb1-4GlcNAcb1-6)Mana1-6)Manb1- |
| 4GlcNAcb1-4(Fuca1-6)GlcNAc | 4GlcNAcb1-4(Fuca1-6)GlcNAc |
| GalNAcb1-4GlcNAcb1-2(GlcNAcb1-4)Mana1- | GlcNAcb1-4(NeuAca2-8NeuGca2-3/6Galb1- |
| 3(GalNAcb1-4GlcNAcb1-2Mana1-6)Manb1- | 4GlcNAcb1-2Mana1-3)(Mana1-6)Manb1- |
| 4GlcNAcb1-4(Fuca1-6)GlcNAc | 4GlcNAcb1-4GlcNAc |
| NeuAca2-6Galb1-4GlcNAcb1-2Mana1-3(Galb1- | Galb1-4GlcNAcb1-2Mana1-3(NeuAca2-6Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| Galb1-4GlcNAcb1-2Mana1-3(NeuAca2-6Galb1- | NeuAca2-6Galb1-4GlcNAcb1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-6Galb1-4GlcNAcb1-2Mana1-3(Galb1- | NeuAca2-6GalNAcb1-4GlcNAcb1-2Mana1-3(Mana1- |
| 4GlcNAcb1-2Mana1-6)Manb1-4GlcNAcb1-4(Fuca1- | 2Mana1-3Mana1-6)Manb1-4GlcNAcb1-4(Fuca1- |
| 6)GlcNAcb | 6)GlcNAc |
| Galb1-4GlcNAcb1-2Mana1-3(NeuAca2-3Galb1- | Glcb1-4GlcNAcb1-2Mana1-3(NeuAca2-6Glcb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-6Galb1-4GlcNAcb1-2Mana1-3(Galb1- | Galb1-4GlcNAcb1-2Mana1-3(NeuAca2-3Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-3Galb1-4GlcNAcb1-2Mana1-3(Galb1- | Galb1-4GlcNAcb1-2Mana1-3(NeuAca2-3Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAcb |
| NeuAca2-3Galb1-4GlcNAcb1-2Mana1-3(Galb1- | NeuAca2-3Galb1-4GlcNAcb1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAc |
| Galb1-3GlcNAcb1-2Mana1-3(NeuAca2-3Galb1- | NeuAca2-6Galb1-4GlcNAcb1-2Mana1-3(Galb1- |
| 3GlcNAcb1-2Mana1-6)Manb1-4GlcNAcb1-4(Fuca1- | 4(Fuca1-3)GlcNAcb1-2Mana1-6)Manb1-4GlcNAcb1- |
| 6)GlcNAc | 4GlcNAc |
| Galb1-4GlcNAcb1-2Mana1-3(NeuAca2-6Galb1- | NeuAca2-3Galb1-4GlcNAca1-2Mana1-3(Galb1- |
| 4GlcNAcb1-2Mana1-6)Manb1-4GlcNAcb1-4(Fuca1- | 4GlcNAca1-2Mana1-6)Manb1-4GlcNAcb1-4(Fuca1- |
| 6)GlcNAcb | 6)GlcNAc |
| Galb1-4(Fuca1-3)GlcNAcb1-2Mana1-3(Galb1- | Galb1-4(Fuca1-3)GlcNAcb1-2Mana1-3(Galb1- |
| 4(Fuca1-3)GlcNAcb1-2Mana1-6)Manb1-4GlcNAcb1- | 4(Fuca1-3)GlcNAcb1-2Mana1-6)Manb1-4GlcNAcb1- |
| 4(Fuca1-6)GlcNAc | 4(Fuca1-3)GlcNAcb |
| Galb1-4(Fuca1-3)GlcNAcb1-2Mana1-3(Galb1- | Galb1-4(Fuca1-3)GlcNAcb1-4Mana1-3(Galb1- |
| 4(Fuca1-3)GlcNAcb1-2Mana1-6)Manb1-4GlcNAcb1- | 4(Fuca1-3)GlcNAcb1-2Mana1-6)Manb1-4GlcNAcb1- |
| 4(Fuca1-6)GlcNAcb | 4(Fuca1-6)GlcNAc |
| Galb1-4(Fuca1-3)GlcNAcb1-4Mana1-3(Galb1- | Fuca1-2Galb1-4GlcNAcb1-2Mana1-3(Fuca1-2Galb1- |
| 4(Fuca1-3)GlcNAcb1-2Mana1-6)Manb1-4GlcNAcb1- | 4GlcNAcb1-2Mana1-6)Manb1-4GlcNAcb1-4(Fuca1- |
| 4(Fuca1-6)GlcNAcb | 6)GlcNAcb |
| Fuca1-2Galb1-4(Fuca1-3)GlcNAcb1-2Mana1- | |
| 3(Galb1-4GlcNAcb1-2Mana1-6)Manb1-4GlcNAcb1- | |
| 4(Fuca1-6)GlcNAcb | |
| | Fuca1-2Galb1-3GlcNAcb1-2Mana1-3(Fuca1-2Galb1- |
| | 3GlcNAcb1-2Mana1-6)Manb1-4GlcNAcb1-4(Fuca1- |
| | 6)GlcNAc |
| Fuca1-2Galb1-3GlcNAcb1-3(Fuca1-2Galb1-3(Fuca1- | Fuca1-2Galb1-4(Fuca1-3)GlcNAcb1-2Mana1- |
| 4)GlcNAcb1-6)Galb1-3GlcNAcb1-3Galb1-3(Galb1- | 3(Galb1-4(Fuca1-3)GlcNAcb1-2Mana1-6)Manb1- |
| 6)GalNAc | 4GlcNAcb1-4GlcNAc |
| Fuca1-2Galb1-4GlcNAcb1-2Mana1-3(Fuca1-2Galb1- | Galb1-4GlcNAc[6S]b1-3Galb1-4GlcNAc[6S]b1- |
| 4GlcNAcb1-2Mana1-6)Manb1-4GlcNAcb1-4(Fuca1- | 3Galb1-4GlcNAc[6S]b1-3Galb1-4GlcNAcb1-3Galb1- |
| 6)GlcNAc | 3GalNAc |
| GlcNAcb1-4(Mana1-2Mana1-2Mana1-3)(Mana1- | GlcNAcb1-3Galb1-4GlcNAcb1-2(GlcNAcb1-4)Mana1- |
| 2Mana1-3(Mana1-2Mana1-6)Mana1-6)Manb1- | 3(GlcNAcb1-2(GlcNAcb1-6)Mana1-6)Manb1- |
| 4GlcNAcb1-4GlcNAcb | 4GlcNAcb1-4GlcNAc |
| GlcNAcb1-4(Galb1-4GlcNAcb1-2(GlcNAcb1- | GlcNAcb1-2(GlcNAcb1-4)Mana1-3(GlcNAcb1- |
| 4)Mana1-3)(GlcNAcb1-2(GlcNAcb1-6)Mana1- | 3Galb1-4GlcNAcb1-2(GlcNAcb1-6)Mana1-6)Manb1- |
| 6)Manb1-4GlcNAcb1-4GlcNAc | 4GlcNAcb1-4GlcNAc |
| GalNAcb1-4GlcNAcb1-2Mana1-3(Galb1-4GlcNAcb1- | GalNAcb1-4GlcNAcb1-2(Galb1-4GlcNAcb1- |
| 2(GalNAcb1-4GlcNAcb1-6)Mana1-6)Manb1- | 4)Mana1-3(GalNAcb1-4GlcNAcb1-2Mana1- |
| 4GlcNAcb1-4GlcNAc | 6)Manb1-4GlcNAcb1-4GlcNAc |
| NeuGca2-8NeuGca2-3/6Galb1-4GlcNAcb1-2Mana1- | GlcNAcb1-4(NeuGca2-8NeuGca2-3/6Galb1- |
| 3(GlcNAcb1-2Mana1-6)Manb1-4GlcNAcb1-4GlcNAc | 4GlcNAcb1-2Mana1-3)(Mana1-6)Manb1- |
| | 4GlcNAcb1-4GlcNAc |
| NeuAca2-6Galb1-4GlcNAcb1-2Mana1-3(Galb1- | NeuGca2-6Galb1-4GlcNAcb1-2Mana1-3(Galb1- |
| 4GlcNAcb1-2(Galb1-4GlcNAcb1-6)Mana1-6)Manb1- | 4GlcNAcb1-2Mana1-6)Manb1-4GlcNAcb1-4(Fuca1- |
| 4GlcNAc | 6)GlcNAc#pyridylamine |
| NeuGca2-6Galb1-4GlcNAcb1-2Mana1-3(Galb1- | NeuAca2-6Gab1-4GlcNAcb1-2Mana1-3(Gala1- |
| 4GlcNAcb1-2Mana1-6)Manb1-4GlcNAcb1-4(Fuca1- | 3Galb1-4GlcNAcb1-2Mana1-6)Manb1-4GlcNAcb1- |
| 6)GlcNAc | 4GlcNAc |
| Galb1-4GlcNAcb1-2Mana1-3(NeuGca2-6Galb1- | NeuAca2-6Galb1-4GlcNAcb1-2(Galb1-4GlcNAcb1- |
| 4GlcNAcb1-2Mana1-6)Manb1-4GlcNAcb1-4(Fuca1- | 4)Mana1-3(Galb1-4GlcNAcb1-2Mana1-6)Manb1- |
| 6)GlcNAc#pyridylamine | 4GlcNAc |
| Gala1-3Galb1-4GlcNAcb1-2Mana1-3(NeuAca2- | NeuAca2-3/6Galb1-4GlcNAcb1-2Mana1-3(Gala1- |
| 3Galb1-4GlcNAcb1-2Mana1-6)Manb1-4GlcNAcb1- | 3Galb1-4GlcNAcb1-2Mana1-6)Manb1-4GlcNAcb1- |
| 4GlcNAc | 4GlcNAc |
| Gala1-3Galb1-4GlcNAcb1-2Mana1-3(NeuAca2- | GlcNAcb1-4(NeuGca2-3/6Galb1-4(Fuca1- |
| 3/6Galb1-4GlcNAcb1-2Mana1-6)Manb1-4GlcNAcb1- | 3)GlcNAcb1-2Mana1-3)(Mana1-3Mana1-6)Manb1- |
| 4GlcNAc | 4GlcNAcb1-4GlcNAc |
| GlcNAcb1-4(NeuGca2-3/6Galb1-4GlcNAcb1- | GlcNAcb1-4(NeuAca2-3Galb1-4GlcNAcb1-2Mana1- |
| 2Mana1-3)(Mana1-3Mana1-6)Manb1-4GlcNAcb1- | 3)(Mana1-3(Mana1-6)Mana1-6)Manb1-4GlcNAcb1- |
| 4(Fuca1-6)GlcNAc | 4GlcNAcb |
| Galb1-4(Fuca1-3)GlcNAcb1-2Mana1-3(NeuGca2- | NeuAca2-3/6Galb1-4GlcNAcb1-2(GlcNAcb1- |
| 3/6Galb1-4GlcNAcb1-2Mana1-6)Manb1-4GlcNAcb1- | 4)Mana1-3(Mana1-3(Mana1-6)Mana1-6)Manb1- |
| 4GlcNAc | 4GlcNAcb1-4GlcNAc |
| GlcNAcb1-4(NeuAca2-3/6Galb1-4GlcNAcb1- | NeuGca2-3/6Galb1-4GlcNAcb1-2Mana1-3(Galb1- |
| 2Mana1-3)(Mana1-3(Mana1-6)Mana1-6)Manb1- | 4GlcNAcb1-2Mana1-6)Manb1-4GlcNAcb1-4(Fuca1- |
| 4GlcNAcb1-4GlcNAc | 6)GlcNAc |
| Galb1-4(Fuca1-3)GlcNAcb1-2Mana1-3(Gala1- | Fuca1-2Galb1-4(Fuca1-3)GlcNAcb1-2(Galb1- |
| 3Galb1-4GlcNAcb1-2Mana1-6)Manb1-4GlcNAcb1- | 4GlcNAcb1-4)Mana1-3(Mana1-3Mana1-6)Manb1- |
| 4(Fuca1-6)GlcNAcb | 4GlcNAcb1-4GlcNAc |
| GlcNAcb1-4(Galb1-4(Fuca1-3)GlcNAcb1-2Mana1- | GlcNAcb1-4(Galb1-4(Fuca1-3)GlcNAcb1-2Mana1- |
| 3)(Mana1-3(Mana1-6)Mana1-6)Manb1-4GlcNAcb1- | 3)(Mana1-3(Mana1-6)Mana1-6)Manb1-4GlcNAcb1- |
| 4(Fuca1-6)GlcNAc | 4(Fuca1-6)GlcNAcb |
| Galb1-4(Fuca1-3)GlcNAcb1-2(GlcNAcb1-4)Mana1- | Gala1-3(Fuca1-2)Galb1-4GlcNAcb1-2Mana1- |
| 3(Mana1-3(Mana1-6)Mana1-6)Manb1-4GlcNAcb1- | 3(Galb1-4GlcNAcb1-2Mana1-6)Manb1-4GlcNAcb1- |
| 4(Fuca1-6)GlcNAc | 4(Fuca1-6)GlcNAc |
| Galb1-4GlcNAcb1-2Mana1-3(Gala1-3(Fuca1- | GalNAca1-3(Fuca1-2)Galb1-4GlcNAcb1-2Mana1- |
| 2)Galb1-4GlcNAcb1-2Mana1-6)Manb1-4GlcNAcb1- | 3(Mana1-2Mana1-3Mana1-6)Manb1-4GlcNAcb1- |
| 4(Fuca1-6)GlcNAc | 4(Fuca1-6)GlcNAc |
| GalNAca1-3Galb1-3GlcNAcb1-3(NeuAca2-6Galb1- | GlcNAcb1-4(NeuGca2-3/6Galb1-4GlcNAcb1- |
| 4GlcNAcb1-6)Galb1-4GlcNAcb1-3(NeuAca2- | 2Mana1-3)(Mana1-3(Mana1-6)Mana1-6)Manb1- |
| 6)GalNAc | 4GlcNAcb1-4GlcNAc |
| Gala1-3Galb1-4GlcNAcb1-2Mana1-3(NeuGca2- | GlcNAcb1-4(Gala1-3Galb1-4GlcNAcb1-2Mana1- |
| 3/6Galb1-4GlcNAcb1-2Mana1-6)Manb1-4GlcNAcb1- | 3)(Mana1-3(Mana1-6)Mana1-6)Manb1-4GlcNAcb1- |
| 4GlcNAc | 4(Fuca1-6)GlcNAc |
| Gala1-3Galb1-4GlcNAcb1-2Mana1-3(Gala1-3Galb1- | Galb1-3Galb1-4GlcNAcb1-2Mana1-3(Galb1-3Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAcb | 6)GlcNAc |
| Gala1-3Galb1-4GlcNAcb1-2Mana1-3(Gala1-3Galb1- | Galb1-4(Fuca1-3)GlcNAcb1-2(Galb1-4GlcNAcb1- |
| 4GlcNAcb1-2Mana1-6)Manb1-4GlcNAcb1-4(Fuca1- | 4)Mana1-3(Mana1-3(Mana1-6)Mana1-6)Manb1- |
| 6)GlcNAc | 4GlcNAcb1-4GlcNAc |
| Gala1-3Galb1-4GlcNAcb1-2Mana1-3(Gala1-3Galb1- | Galb1-4GlcNAcb1-2(Galb1-4GlcNAcb1-4)Mana1- |
| 4GlcNAcb1-2Mana1-6)Manb1-4GlcNAcb1-4(Fuca1- | 3(Mana1-3(Mana1-6)Mana1-6)Manb1-4GlcNAcb1- |
| 6)GlcNAc | 4(Fuca1-6)GlcNAc |
| Galb1-4GlcNAcb1-2(Galb1-4GlcNAcb1-4)Mana1- | NeuAca2-6GalNAcb1-4GlcNAcb1-2Mana1-3(Galb1- |
| 3(Galb1-4GlcNAcb1-2Mana1-6)Manb1-4GlcNAcb1- | 4GlcNAcb1-2Mana1-6)Manb1-4GlcNAcb1-4(Fuca1- |
| 4(Fuca1-6)Glc | 6)GlcNAcb |
| GalNAcb1-4GlcNAcb1-2Mana1-3(NeuAca2-3Galb1- | NeuAca2-6Galb1-4GlcNAcb1-2Mana1-3(GalNAcb1- |
| 3GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAcb |
| GlcNAcb1-2(Galb1-3(NeuAca2-6)GlcNAcb1- | GlcNAcb1-4(NeuAca2-3/6Galb1-4(Fuca1- |
| 4)Mana1-3(GlcNAcb1-2Mana1-6)Manb1- | 3)GlcNAcb1-2Mana1-3)(GlcNAcb1-2Mana1- |
| 4GlcNAcb1-4(Fuca1-6)GlcNAc | 6)Manb1-4GlcNAcb1-4GlcNAc |
| GlcNAcb1-4(NeuAca2-6Galb1-4GlcNAcb1-2Mana1- | GalNAcb1-4GlcNAcb1-2Mana1-3(NeuAca2-6Galb1- |
| 3)(GlcNAcb1-2Mana1-6)Manb1-4GlcNAcb1- | 4GlcNAcb1-2Mana1-6)Manb1-4GlcNAcb1-4(Fuca1- |
| 4(Fuca1-6)GlcNAcb | 6)GlcNAcb |
| GlcNAcb1-4(NeuAca2-3/6Galb1-4GlcNAcb1- | Galb1-4(Fuca1-3)GlcNAcb1-2Mana1-3(GalNAcb1- |
| 2Mana1-3)(GlcNAcb1-2Mana1-6)Manb1- | 4(Fuca1-3)GlcNAcb1-2Mana1-6)Manb1-4GlcNAcb1- |
| 4GlcNAcb1-4(Fuca1-6)GlcNAc | 4(Fuca1-6)GlcNAc |
| Fuca1-2Galb1-4(Fuca1-3)GlcNAcb1-2Mana1- | GlcNAcb1-4(Fuca1-2Galb1-4(Fuca1-3)GlcNAcb1- |
| 3(GalNAcb1-4(Fuca1-3)GlcNAcb1-2Mana1- | 2Mana1-3)(Fuca1-3GlcNAcb1-2Mana1-6)Manb1- |
| 6)Manb1-4GlcNAcb1-4GlcNAc | 4GlcNAcb1-4GlcNAc |
| GlcNAcb1-4(Fuca1-2Galb1-4(Fuca1-3)GlcNAcb1- | GalNAcb1-4(Fuca1-2)GlcNAcb1-2Mana1-3(Galb1- |
| 2Mana1-3)(GlcNAcb1-2Mana1-6)Manb1- | 4(Fuca1-2)GlcNAcb1-2Mana1-6)Manb1-4GlcNAcb1- |
| 4GlcNAcb1-4(Fuca1-6)GlcNAc | 4(Fuca1-6)GlcNAcbb |
| GalNAca1-3(Fuca1-2)Galb1-4(Fuca1-3)GlcNAcb1- | Fuca1-3GalNAcb1-3Galb1-4Galb1-3(NeuGca2- |
| 2Mana1-3(GlcNAcb1-2Mana1-6)Manb1-4GlcNAcb1- | 8NeuGca2-8NeuGca2-8NeuGca2-6)GalNAc |
| 4(Fuca1-6)GlcNAc | |
| Mana1-3(Gal[3ME]b1-6Gal[3ME]b1-3(Gal[3ME]b1- | Galb1-4GlcNAcb1-2(Galb1-4GlcNAcb1-4)Mana1- |
| 6)GalNAcb1-4GlcNAcb1-2Mana1-6)(Xylb1- | 3(Galb1-4GlcNAcb1-2(Galb1-4GlcNAcb1-6)Mana1- |
| 2)Manb1-4GlcNAcb1-4(Fuca1-6)GlcNAc | 6)Manb1-4Glcb1-1 |
| GlcNAcb1-4(GlcNAcb1-2(GlcNAcb1-4)Mana1- | GlcNAcb1-4(GlcNAcb1-2(GlcNAcb1-4)Mana1- |
| 3)(GlcNAcb1-2(GlcNAcb1-4)(GlcNAcb1-6)Mana1- | 3)(GlcNAcb1-2(GlcNAcb1-4)(GlcNAcb1-6)Mana1- |
| 6)Manb1-4GlcNAcb1-4GlcNAcb | 6)Manb1-4GlcNAcb1-4GlcNAc |
| GlcNAcb1-4(GlcNAcb1-2(GlcNAcb1-4)Mana1- | GalNAcb1-4GlcNAcb1-2(GlcNAcb1-4)Mana1- |
| 3)(GlcNAcb1-2(GlcNAcb1-4)(GlcNAcb1-6)Mana1- | 3(GalNAcb1-4GlcNAcb1-2(GlcNAcb1-6)Mana1- |
| 6)Manb1-4GlcNAcb1-4GlcNAc | 6)Manb1-4GlcNAcb1-4GlcNAc |
| GalNAcb1-4GlcNAcb1-2Mana1-3(GalNAcb1- | GalNAcb1-4(NeuGca2-3)GalNAcb1-4Galb1-3Galb1- |
| 4GlcNAcb1-2(GalNAcb1-4GlcNAcb1-6)Mana1- | 3(NeuAca2-8NeuAca2-8NeuAca2-6)GalNAca |
| 6)Manb1-4GlcNAcb1-4GlcNAc | |
| GlcNAcb1-4(NeuAca2-6Galb1-4GlcNAcb1-2Mana1- | GlcNAcb1-4(NeuAca2-6Galb1-4GlcNAcb1-2Mana1- |
| 3)(Galb1-4GlcNAcb1-2Mana1-6)Manb1-4GlcNAcb1- | 3)(Galb1-4GlcNAcb1-2Mana1-6)Manb1-4GlcNAcb1- |
| 4GlcNAc | 4GlcNAc |
| GlcNAcb1-4(NeuAca2-6Galb1-4GlcNAcb1-2Mana1- | GlcNAcb1-4(NeuGca2-3/6Galb1-4(Fuca1- |
| 3)(Galb1-4GlcNAcb1-2Mana1-6)Manb1-4GlcNAcb1- | 3)GlcNAcb1-2Mana1-3)(GlcNAcb1-2Mana1- |
| 4GlcNAcb | 6)Manb1-4GlcNAcb1-4GlcNAc |
| GlcNAcb1-4(NeuGca2-3/6Galb1-4GlcNAcb1- | GlcNAcb1-4(Galb1-4(Fuca1-3)GlcNAcb1-2Mana1- |
| 2Mana1-3)(GlcNAcb1-2Mana1-6)Manb1- | 3)(Galb1-4(Fuca1-3)GlcNAcb1-2Mana1-6)Manb1- |
| 4GlcNAcb1-4(Fuca1-6)GlcNAc | 4GlcNAcb1-4GlcNAc |
| GlcNAcb1-4(Galb1-4(Fuca1-3)GlcNAcb1-2Mana1- | GalNAcb1-4(Fuca1-3)GlcNAcb1-2Mana1-3(Gala1- |
| 3)(Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAcb |
| GlcNAcb1-4(Galb1-4GlcNAcb1-2Mana1-3)(Galb1- | GalNAca1-3(Fuca1-2)Galb1-4GlcNAcb1-2Mana1- |
| 4(Fuca1-3)GlcNAcb1-2Mana1-6)Manb1-4GlcNAcb1- | 3(Galb1-4GlcNAcb1-2Mana1-6)Manb1-4GlcNAcb1- |
| 4(Fuca1-6)GlcNAcb | 4(Fuca1-6)GlcNAc |
| GlcNAcb1-4(Galb1-4(Fuca1-3)GlcNAcb1-2Mana1- | Galb1-4GlcNAcb1-2Mana1-3(GalNAca1-3(Fuca1- |
| 3)(Galb1-4GlcNAcb1-2Mana1-6)Manb1-4GlcNAcb1- | 2)Galb1-4GlcNAcb1-2Mana1-6)Manb1-4GlcNAcb1- |
| 4(Fuca1-6)GlcNAcb | 4(Fuca1-6)GlcNAc |
| GlcNAcb1-4(Galb1-4GlcNAcb1-2Mana1-3)(Fuca1- | GlcNAcb1-4(Fuca1-2Galb1-4GlcNAcb1-2Mana1- |
| 2Galb1-4GlcNAcb1-2Mana1-6)Manb1-4GlcNAcb1- | 3)(Galb1-4GlcNAcb1-2Mana1-6)Manb1-4GlcNAcb1- |
| 4(Fuca1-6)GlcNAc | 4(Fuca1-6)GlcNAc |
| Neua1-3Galb1-4GlcNAcb1-2Mana1-3(Neua1- | Kdna1-3Galb1-4GlcNAcb1-2Mana1-3(Kdna1- |
| 3Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4GlcNAcb |
| NeuGca2-3Galb1-4GlcNAcb1-3Galb1-4GlcNAcb1- | NeuGca2-3Galb1-4GlcNAcb1-3(Galb1-4GlcNAcb1- |
| 3(Galb1-4GlcNAcb1-6)Galb1-4GlcNAcb1-3Galb1- | 6)Galb1-4GlcNAcb1-3Galb1-4GlcNAcb1-3Galb1- |
| 3GalNAc | 3GalNAc |
| NeuGca2-3Galb1-4GlcNAcb1-3Galb1-4GlcNAcb1- | GlcNAcb1-4(GalNAc[4S]b1-4GlcNAcb1-2Mana1- |
| 3Galb1-4GlcNAcb1-3(Galb1-4GlcNAcb1-6)Galb1- | 3)(GalNAcb1-4GlcNAcb1-2Mana1-6)Manb1- |
| 3GalNAc | 4GlcNAcb1-4(Fuca1-6)GlcNAc |
| Galb1-4GlcNAcb1-2Mana1-3(Galb1-4GlcNAcb1- | Galb1-4GlcNAcb1-2(Galb1-4GlcNAcb1-4)Mana1- |
| 2(Galb1-4GlcNAcb1-6)Mana1-6)Manb1-4GlcNAcb1- | 3(Galb1-4GlcNAcb1-2Mana1-6)Manb1-4GlcNAcb1- |
| 4(Fuca1-6)GlcNAc | 4(Fuca1-6)GlcNAc |
| Galb1-4GlcNAcb1-2Mana1-3(Galb1-4GlcNAcb1- | Galb1-4GlcNAcb1-2(Galb1-4GlcNAcb1-4)Mana1- |
| 2(Galb1-4GlcNAcb1-6)Mana1-6)Manb1-4GlcNAcb1- | 3(Galb1-4GlcNAcb1-2Mana1-6)Manb1-4GlcNAcb1- |
| 4(Fuca1-6)GlcNAcb | 4(Fuca1-6)GlcNAcb |
| Galb1-4GlcNAcb1-2(Galb1-3GlcNAcb1-4)Mana1- | Galb1-4GlcNAcb1-2(Galb1-4GlcNAcb1-4)Mana1- |
| 3(Galb1-4GlcNAcb1-2Mana1-6)Manb1-4GlcNAcb1- | 3(Galb1-4GlcNAcb1-2Mana1-6)Manb1-4GlcNAcb1- |
| 4(Fuca1-6)GlcNAc | 4(Fuca1-6)GlcNAc |
| Gala1-4GlcNAcb1-2Mana1-3(Gala1-4GlcNAcb1- | |
| 2(Gala1-4GlcNAcb1-4)Mana1-6)Manb1-4GlcNAcb1- | |
| 4(Fuca1-6)GlcNAcb | |
| | Galb1-4GlcNAcb1-2(Galb1-4(Fuca1-3)GlcNAcb1- |
| | 4)Mana1-3(Galb1-4GlcNAcb1-2Mana1-6)Manb1- |
| | 4GlcNAcb1-4GlcNAc |
| Galb1-4GlcNAcb1-2Mana1-3(Galb1-4GlcNAcb1- | Galb1-4GlcNAcb1-2(Galb1-4GlcNAcb1-6)Mana1- |
| 2(Galb1-4GlcNAcb1-4)Mana1-6)Manb1-4GlcNAcb1- | 3(Galb1-4GlcNAcb1-6Mana1-6)Manb1-4GlcNAcb1- |
| 4(Fuca1-6)GlcNAc | 4(Fuca1-6)GlcNAc |
| Galb1-4GlcNAca1-2(Galb1-4(Fuca1-3)GlcNAcb1- | Galb1-4GlcNAcb1-2Mana1-3/6(Galb1-4GlcNAcb1- |
| 4)Mana1-3(Galb1-4GlcNAcb1-2Mana1-6)Manb1- | 2(Galb1-4GlcNAcb1-6)Mana1-6/3)Manb1- |
| 4GlcNAcb1-4GlcNAcb | 4GlcNAcb1-4(Fuca1-6)GlcNAc |
| Galb1-4GlcNAcb1-2Mana1-3(Galb1-4(Fuca1- | Galb1-4GlcNAcb1-4Mana1-3(Galb1-4GlcNAcb1- |
| 3)GlcNAcb1-2(Galb1-4GlcNAcb1-6)Mana1- | 2(Galb1-4GlcNAcb1-6)Mana1-6)Manb1-4GlcNAcb1- |
| 6)Manb1-4GlcNAcb1-4GlcNAc | 4(Fuca1-6)GlcNAc |
| Galb1-4GlcNAcb1-2Mana1-3(Galb1-4GlcNAcb1- | Galb1-4GlcNAcb1-2Mana1-3(Galb1-4GlcNAcb1- |
| 2(Galb1-4(Fuca1-3)GlcNAcb1-6)Mana1-6)Manb1- | 2(Galb1-4GlcNAcb1-6)Mana1-6)Manb1-4GlcNAcb1- |
| 4GlcNAcb1-4GlcNAc | 4(Fuca1-6)GlcNAc |
| Galb1-4GlcNAcb1-2(Galb1-4(Fuca1-3)GlcNAcb1- | Galb1-4(Fuca1-3)GlcNAcb1-2(Galb1-4GlcNAcb1- |
| 4)Mana1-3(Galb1-4GlcNAcb1-2Mana1-6)Manb1- | 4)Mana1-3(Galb1-4GlcNAcb1-2Mana1-6)Manb1- |
| 4GlcNAcb1-4GlcNAcb | 4GlcNAcb1-4GlcNAc |
| Galb1-4GlcNAcb1-2(Galb1-4(Fuca1-3)GlcNAcb1- | Galb1-4GlcNAcb1-2Mana1-3(Galb1-4GlcNAcb1- |
| 3)Manb1-3(Galb1-4GlcNAcb1-2Manb1-6)Manb1- | 3Galb1-4(Fuca1-3)GlcNAcb1-2Mana1-6)Manb1- |
| 4GlcNAcb1-4GlcNAcb | 4GlcNAcb1-4GlcNAc |
| Galb1-4GlcNAcb1-3Galb1-4GlcNAcb1-2Mana1- | Galb1-4GlcNAcb1-2Mana1-3(Galb1-4GlcNAcb1- |
| 3(Galb1-4(Fuca1-3)GlcNAcb1-2Mana1-6)Manb1- | 3Galb1-4GlcNAcb1-2Mana1-6)Manb1-4GlcNAcb1- |
| 4GlcNAcb1-4GlcNAc | 4(Fuca1-6)GlcNAc |
| Galb1-4GlcNAcb1-3Galb1-4GlcNAcb1-2Mana1- | Galb1-4GlcNAcb1-2(Galb1-3GlcNAcb1-4)Mana1- |
| 3(Galb1-4GlcNAcb1-2Mana1-6)Manb1-4GlcNAcb1- | 3(Galb1-3GlcNAcb1-2Mana1-6)Manb1-4GlcNAcb1- |
| 4(Fuca1-6)GlcNAc | 4(Fuca1-6)GlcNAc |
| Galb1-3GlcNAcb1-2Mana1-3(Galb1-3GlcNAcb1- | GlcNAcb1-4(Galb1-4GlcNAcb1-2Mana1-3)(Gala1- |
| 2(Galb1-3GlcNAcb1-6)Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAc |
| GlcNAca1-6Galb1-4GlcNAcb1-2Mana1-3(Gala1- | Galb1-4GlcNAcb1-2Mana1-3(Galb1-4GlcNAcb1- |
| 3Galb1-4GlcNAcb1-2Mana1-6)Manb1-4GlcNAcb1- | 2(Galb1-4GlcNAcb1-4)Mana1-6)Manb1-4GlcNAcb1- |
| 4(Fuca1-6)GlcNAc | 4(Fuca1-6)GlcNAcb |
| Galb1-4GlcNAcb1-2(Galb1-3GlcNAcb1-4)Mana1- | GlcNAcb1-4(Galb1-4GlcNAcb1-2(GlcNAcb1- |
| 3(Galb1-4GlcNAcb1-2Mana1-6)Manb1-4GlcNAcb1- | 4)Mana1-3)(Mana1-3(Mana1-6)Mana1-6)Manb1- |
| 4(Fuca1-6)GlcNAc | 4GlcNAcb1-4(Fuca1-6)GlcNAcb |
| GlcNAcb1-4(GlcNAcb1-2(Galb1-4GlcNAcb1- | GlcNAcb1-4(Gala1-3Galb1-4GlcNAcb1-2Mana1- |
| 4)Mana1-3)(Mana1-3(Mana1-6)Mana1-6)Manb1- | 3)(Galb1-4GlcNAcb1-2Mana1-6)Manb1-4GlcNAcb1- |
| 4GlcNAcb1-4(Fuca1-6)GlcNAc | 4(Fuca1-3)GlcNAc |
| Galb1-3GlcNAcb1-2(Galb1-4GlcNAcb1-4)Mana1- | Galb1-4GlcNAcb1-2Mana1-3(Galb1-4GlcNAcb1- |
| 3(Galb1-4GlcNAcb1-2Mana1-6)Manb1-4GlcNAcb1- | 2(Galb1-4(Fuca1-3)GlcNAcb1-6)Mana1-6)Manb1- |
| 4(Fuca1-6)GlcNAc | 4GlcNAcb1-4GlcNAcb |
| Galb1-4GlcNAcb1-4(Galb1-4GlcNAcb1-2Mana1- | Galb1-4GlcNAcb1-2(Galb1-4(Fuca1-3)GlcNAcb1- |
| 3)(Galb1-4GlcNAcb1-2Mana1-6)Manb1-4GlcNAcb1- | 4)Mana1-3(Galb1-4GlcNAcb1-2Mana1-6)Manb1- |
| 4(Fuca1-6)GlcNAcb | 4GlcNAcb1-4GlcNAc |
| GlcNAcb1-4(Gala1-3Galb1-4GlcNAcb1-2Mana1- | GlcNAcb1-4(Galb1-4(Fuca1-3)GlcNAcb1- |
| 3)(Galb1-4GlcNAcb1-2Mana1-6)Manb1-4GlcNAcb1- | 2(GlcNAcb1-4)Mana1-3)(Mana1-3(Mana1-6)Mana1- |
| 4(Fuca1-6)GlcNAc | 6)Manb1-4GlcNAcb1-4GlcNAc |
| NeuAca2-3Galb1-4GlcNAcb1-2Mana1-3(Gal[3S]b1- | NeuAca2-6Galb1-4GlcNAc[6S]b1-2Mana1-3(Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| Gal[3S]b1-4GlcNAcb1-2Mana1-3(NeuAca2-3Galb1- | NeuAca2-6Galb1-4GlcNAcb1-2Mana1-3(Gal[3S]b1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-6GalNAcb1-4GlcNAcb1-2Mana1- | GalNAcb1-4GlcNAcb1-2Mana1-3(NeuAca2- |
| 3(GalNAcb1-4GlcNAcb1-2Mana1-6)Manb1- | 6GalNAcb1-4GlcNAcb1-2Mana1-6)Manb1- |
| 4GlcNAcb1-4(Fuca1-6)GlcNAcb | 4GlcNAcb1-4(Fuca1-6)GlcNAcb |
| GalNAcb1-4(Fuca1-3)GlcNAcb1-2Mana1- | GalNAcb1-4(Fuca1-3)GlcNAcb1-2Mana1- |
| 3(GalNAcb1-4(Fuca1-3)GlcNAcb1-2Mana1- | 3(GalNAcb1-4(Fuca1-3)GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GalNAcb1-4(Fuca1-3)GlcNAcb1-2Mana1- | Glca1-2Glca1-3Glca1-3Mana1-2Mana1-2Mana1- |
| 3(GalNAcb1-4(Fuca1-3)GlcNAcb1-2Mana1- | 3(Mana1-2Mana1-3(Mana1-2Mana1-6)Mana1- |
| 6)Manb1-4GlcNAcb1-4(Fuca1-6)GlcNAcb | 6)Manb1-4GlcNAc |
| Mana1-3Mana1-2Mana1-2(Mana1-2Mana1- | |
| 6)Mana1-3(Mana1-3(Mana1-3Mana1-2Mana1- | |
| 6)Mana1-6)Manb1-4GlcNAc | |
| | Mana1-3Mana1-2Mana1-2(Mana1-3Mana1-2Mana1- |
| | 6)Mana1-3(Mana1-3(Mana1-2Mana1-6)Mana1- |
| | 6)Manb1-4GlcNAc |
| Mana1-3Mana1-2Mana1-2(Mana1-3Mana1- | Glca1-2Glca1-3Glca1-3Mana1-2Mana1-2Mana1- |
| 2(Mana1-6)Mana1-6)Mana1-3(Mana1-3(Mana1- | 3(Mana1-2Mana1-3(Mana1-2Mana1-6)Mana1- |
| 6)Mana1-6)Manb1-4GlcNAc | 6)Manb1-3GlcNAc |
| Glcb1-2Glcb1-2Glcb1-2Mana1-2Mana1-2Mana1- | GlcNAcb1-4(Neua1-6Galb1-4GlcNAcb1-2Mana1- |
| 3(Mana1-2Mana1-3(Mana1-2Mana1-6)Mana1- | 3)(Galb1-4GlcNAcb1-2Mana1-6)Manb1-4GlcNAcb1- |
| 6)Manb1-4GlcNAc | 4(Fuca1-6)GlcNAc |
| Galb1-4GlcNAcb1-2(Galb1-4GlcNAcb1-4)Mana1- | GlcNAcb1-4(Gala1-3Galb1-4GlcNAcb1-2Mana1- |
| 3(Galb1-4GlcNAca1-2(Galb1-4GlcNAcb1-6)Mana1- | 3)(Gala1-3Galb1-4GlcNAcb1-2Mana1-6)Manb1- |
| 6)Manb1-4GlcNAc | 4GlcNAcb1-4GlcNAc |
| GlcNAcb1-4(Galb1-4GlcNAcb1-2(Galb1-4GlcNAcb1- | Galb1-4GlcNAcb1-2(Galb1-4GlcNAcb1-6)Mana1- |
| 4)Mana1-3)(Mana1-3(Mana1-6)Mana1-6)Manb1- | 3(Galb1-4GlcNAcb1-2(Galb1-4GlcNAcb1-6)Mana1- |
| 4GlcNAcb1-4GlcNAcb | 6)Manb1-4GlcNAc |
| Galb1-4GlcNAcb1-2Mana1-3(Gala1-3Galb1- | Galb1-4GlcNAcb1-3Galb1-4GlcNAcb1-2Mana1- |
| 4GlcNAcb1-3Galb1-4GlcNAcb1-2Mana1-6)Manb1- | 3(Galb1-3Galb1-4GlcNAcb1-2Mana1-6)Manb1- |
| 4GlcNAcb1-4GlcNAc | 4GlcNAcb1-4GlcNAc |
| Galb1-4GlcNAcb1-2Mana1-3(Galb1-4GlcNAcb1- | Galb1-4GlcNAcb1-2(Galb1-4GlcNAcb1-4)Mana1- |
| 2(Galb1-4GlcNAcb1-3Galb1-4GlcNAcb1-6)Mana1- | 3(Galb1-4GlcNAcb1-3Galb1-4GlcNAcb1-2Mana1- |
| 6)Manb1-4GlcNAc | 6)Manb1-4GlcNAc |
| Galb1-4GlcNAcb1-3Galb1-4GlcNAcb1-2(Galb1- | Galb1-4GlcNAcb1-2Mana1-3(Galb1-4GlcNAcb1- |
| 4GlcNAcb1-4)Mana1-3(Galb1-4GlcNAcb1-2Mana1- | 3Galb1-4GlcNAcb1-2(Galb1-4GlcNAcb1-6)Mana1- |
| 6)Manb1-4GlcNAc | 6)Manb1-4GlcNAc |
| Galb1-4GlcNAcb1-3Galb1-4GlcNAcb1-2Mana1- | Galb1-4GlcNAcb1-3Galb1-4GlcNAcb1-2Mana1- |
| 3(Galb1-4GlcNAcb1-3Galb1-4GlcNAcb1-2Mana1- | 3(Galb1-4GlcNAcb1-2(Galb1-4GlcNAcb1-6)Mana1- |
| 6)Manb1-4GlcNAc | 6)Manb1-4GlcNAc |
| Galb1-4GlcNAcb1-2(Galb1-4GlcNAcb1-4)Mana1- | Galb1-4GlcNAcb1-2(Galb1-4GlcNAcb1-4)Mana1- |
| 3(Galb1-4GlcNAcb1-2(Glcb1-4GlcNAcb1-6)Mana1- | 3(Galb1-4GlcNAcb1-2(Galb1-4GlcNAcb1-6)Mana1- |
| 6)Manb1-4GlcNAcb | 6)Manb1-4GlcNAc |
| Galb1-4GlcNAcb1-2(Galb1-4GlcNAcb1-3Galb1- | NeuGca2-6Galb1-4GlcNAcb1-2Mana1-3(Gal[3S]b1- |
| 4GlcNAcb1-4)Mana1-3(Galb1-4GlcNAcb1-2Mana1- | 4GlcNAcb1-2Mana1-6)Manb1-4GlcNAcb1-4(Fuca1- |
| 6)Manb1-4GlcNAc | 6)GlcNAc |
| Galb1-4(Fuca1-3)GlcNAcb1-2(GlcNAcb1-4)Mana1- | GlcNAcb1-4(Galb1-4(Fuca1-3)GlcNAcb1-2Mana1- |
| 3(GlcNAcb1-2(GlcNAcb1-6)Mana1-6)Manb1- | 3)(GalNAcb1-4GlcNAcb1-2Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1- | GlcNAcb1-4(Galb1-4(Fuca1-3)GlcNAcb1-2Mana1- |
| 2(GlcNAcb1-4)Mana1-3)(GlcNAcb1-2Mana1- | 3)(GalNAcb1-4(Fuca1-3)GlcNAcb1-2Mana1- |
| 6)Manb1-4GlcNAcb1-4(Fuca1-6)GlcNAc | 6)Manb1-4GlcNAcb1-4GlcNAc |
| GlcNAcb1-4(GlcNAcb1-2(Fuca1-2Galb1-3GlcNAcb1- | GlcNAcb1-4(GalNAca1-3(Fuca1-2)Galb1- |
| 4)Mana1-3)(GlcNAcb1-2Mana1-6)Manb1- | 4GlcNAcb1-2Mana1-3)(GlcNAcb1-2Mana1- |
| 4GlcNAcb1-4(Fuca1-6)GlcNAc | 6)Manb1-4GlcNAcb1-4(Fuca1-6)GlcNAc |
| GalNAcb1-4(NeuGca2-3)GalNAcb1-3Galb1-4Galb1- | NeuAca2-3Galb1-4GlcNAcb1-2Mana1-3(Galb1- |
| 3(NeuGca2-8NeuGca2-8NeuGca2-6)GalNAc | 4(NeuAca2-3)Galb1-4GlcNAcb1-2Mana1-6)Manb1- |
| | 4GlcNAc |
| NeuAca2-6Galb1-3GlcNAcb1-3(NeuAca2-6Galb1- | Glca1-3Mana1-2Mana1-2Mana1-3(Mana1-2Mana1- |
| 3GlcNAcb1-6)Galb1-4GlcNAcb1-3(NeuAca2- | 3(Mana1-2Mana1-6)Mana1-6)Manb1-4GlcNAcb1- |
| 6)GalNAc | 4(Fuca1-6)GlcNAc |
| NeuGca2-3/6Galb1-4GlcNAcb1-2(GlcNAcb1- | GlcNAca1-6Galb1-4GlcNAcb1-2Mana1-3(GlcNAca1- |
| 4)Mana1-3(GlcNAcb1-2(GlcNAcb1-6)Mana1- | 6Galb1-4GlcNAcb1-2Mana1-6)Manb1-4GlcNAcb1- |
| 6)Manb1-4GlcNAcb1-4GlcNAc | 4(Fuca1-6)GlcNAc |
| GlcNAcb1-2(GlcNAcb1-4)Mana1-3(Galb1- | GalNAcb1-4GlcNAcb1-2Mana1-3(Galb1-4GlcNAcb1- |
| 4GlcNAcb1-2(Galb1-4GlcNAcb1-6)Mana1-6)Manb1- | 2(Galb1-4GlcNAcb1-6)Mana1-6)Manb1-4GlcNAcb1- |
| 4GlcNAcb1-4(Fuca1-6)GlcNAc | 4(Fuca1-6)GlcNAc |
| Galb1-4GlcNAcb1-2Mana1-3(GalNAcb1-4GlcNAcb1- | Galb1-4GlcNAcb1-2Mana1-3(Galb1-4GlcNAcb1- |
| 2(Galb1-4GlcNAcb1-6)Mana1-6)Manb1-4GlcNAcb1- | 2(GalNAcb1-4GlcNAcb1-6)Mana1-6)Manb1- |
| 4(Fuca1-6)GlcNAc | 4GlcNAcb1-4(Fuca1-6)GlcNAc |
| Galb1-4GlcNAcb1-2(Galb1-4GlcNAcb1-4)Mana1- | Galb1-4GlcNAcb1-2(GlcNAcb1-4)Mana1-3(Galb1- |
| 3(GlcNAcb1-2(GlcNAcb1-6)Mana1-6)Manb1- | 4GlcNAcb1-2(GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(Galb1-4GlcNAcb1-4)Mana1- | GlcNAcb1-2(GlcNAcb1-4)Mana1-3(Galb1- |
| 3(GlcNAcb1-2(GlcNAcb1-6)Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(GlcNAcb1-4)Mana1- | GlcNAcb1-4(GlcNAcb1-2(Galb1-4GlcNAcb1- |
| 3(GlcNAcb1-2(Galb1-4GlcNAcb1-6)Mana1- | 4)Mana1-3)(Galb1-4GlcNAcb1-2Mana1-6)Manb1- |
| 6)Manb1-4GlcNAcb1-4(Fuca1-6)GlcNAc | 4GlcNAcb1-4(Fuca1-6)GlcNAc |
| GalNAcb1-4GlcNAcb1-2(Galb1-4GlcNAcb1- | GlcNAcb1-4(Galb1-4GlcNAcb1-2(Galb1-4GlcNAcb1- |
| 4)Mana1-3(Galb1-4GlcNAcb1-2Mana1-6)Manb1- | 4)Mana1-3)(GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(GlcNAcb1-4)Mana1- | Galb1-4GlcNAcb1-2(GlcNAcb1-4)Mana1-3(Galb1- |
| 3(GlcNAcb1-2(Galb1-4GlcNAcb1-6)Mana1- | 4GlcNAcb1-2(GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| GlcNAcb1-3Galb1-4GlcNAcb1-2Mana1-3(GlcNAcb1- | GalNAc[3S]b1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAcb | 4(Fuca1-6)GlcNAc |
| GalNAc[4S]b1-4GlcNAcb1-2Mana1-3(NeuAca2- | GalNAc[4S]b1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAc | 4(Fuca1-6)GlcNAcb |
| GalNAc[4S]b1-4GlcNAcb1-2Mana1-3(NeuAca2- | Mana1-2Mana1-2Mana1-2Mana1-3(Mana1-2Mana1- |
| 3Galb1-4GlcNAcb1-2Mana1-6)Manb1-4GlcNAcb1- | 3(Mana1-2Mana1-2Mana1-6)Mana1-6)Manb1- |
| 4(Fuca1-6)GlcNAcb | 4GlcNAcb1-4GlcNAc |
| Glca1-3Glca1-3Mana1-2Mana1-2Mana1-3(Mana1- | Glca1-3Glca1-3Mana1-2Mana1-2Mana1-3(Mana1- |
| 2Mana1-3(Mana1-2Mana1-6)Mana1-6)Manb1- | 2Mana1-3(Mana1-2Mana1-6)Mana1-6)Manb1- |
| 4GlcNAcb1-4GlcNAc | 4GlcNAcb1-4GlcNAcb |
| Mana1-3Mana1-2Mana1-2(Mana1-2Mana1- | GlcNAcb1-4(NeuAca2-8NeuAca2-3/6Galb1-4(Fuca1- |
| 6)Mana1-3(Mana1-3(Mana1-2Mana1-6)Mana1- | 3)GlcNAcb1-2Mana1-3)(Mana1-6)Manb1- |
| 6)Manb1-4GlcNAcb1-4GlcNAc | 4GlcNAcb1-4GlcNAc |
| NeuAca2-3Galb1-3(Galb1-4(Fuca1-3)GlcNACb1- | NeuAca2-3Galb1-3(Fuca1-2Galb1-3(Fuca1- |
| 3Galb1-4(Fuca1-3)GlcNAcb1-3Galb1-4(FuCa1- | 4)GlcNAcb1-3(Galb1-4GlcNAcb1-6)Galb1-4(Fuca1- |
| 3)GlcNAcb1-6)GalNAc | 3)GlcNAcb1-6)GalNAc |
| NeuAca2-3Galb1-3(Fuca1-2Galb1-3(Fuca1- | Galb1-3(NeuAca2-2Galb1-4(Fuca1-3)GlcNAcb1- |
| 4)GlcNAcb1-3(Galb1-4(Fuca1-3)GlcNAcb1-6)Galb1- | 3Galb1-4(Fuca1-3)GlcNAcb1-3Galb1-4(Fuca1- |
| 4GlcNAcb1-6)GalNAc | 3)GlcNAcb1-6)GalNAc |
| GlcNAcb1-4(Galb1-4GlcNAcb1-2(Galb1-4GlcNAcb1- | Galb1-3(Galb1-4GlcNAcb1-3Galb1-4GlcNACb1- |
| 4)Mana1-3)(Galb1-4GlcNAcb1-2Mana1-6)Manb1- | 3Galb1-4GlcNAcb1-3Galb1-4GlcNAcb1-3Galb1- |
| 4GlcNAcb1-4GlcNAc | 4GlcNAcb1-6)GalNAc |
| Galb1-4GlcNAcb1-2(Galb1-4GlcNAcb1-4)Mana1- | Galb1-4GlcNAcb1-3Galb1-4GlcNAcb1-3Galb1- |
| 3(Galb1-4GlcNAcb1-2(GlcNAcb1-6)Mana1- | 4GlcNAcb1-3Galb1-4GlcNAcb1-3Galb1-4GlcNAcb1- |
| 6)Manb1-4GlcNAcb1-4GlcNAc | 3Galb1-3GalNAc |
| Galb1-4GlcNAcb1-2(GlcNAcb1-4)Mana1-3(Galb1- | GlcNAcb1-4(Galb1-4GlcNAcb1-2Mana1-3)(Galb1- |
| 4GlcNAcb1-2(Galb1-4GlcNAcb1-6)Mana1-6)Manb1- | 4GlcNAcb1-2(Galb1-4GlcNAcb1-6)Mana1-6)Manb1- |
| 4GlcNAcb1-4GlcNAc | 4GlcNAcb1-4GlcNAc |
| GlcNAcb1-4(Galb1-4GlcNAcb1-2(Galb1-4GlcNAcb1- | NeuGca2-8NeuGca2-3/6Galb1-4GlcNAcb1-2Mana1- |
| 4)Mana1-3)(Galb1-4GlcNAcb1-2Mana1-6)Manb1- | 3(Mana1-3(Mana1-6)Mana1-6)Manb1-4GlcNACb1- |
| 4GlcNAcb1-4GlcNAcb | 4GlcNAc |
| GlcNAcb1-4(GalNAcb1-4(Fuca1-3)GlcNAcb1- | GlcNAcb1-4(GalNAcb1-4(Fuca1-3)GlcNAcb1- |
| 2Mana1-3)(GalNAcb1-4(Fuca1-3)GlcNACb1- | 2Mana1-3)(GalNAcb1-4GlcNAcb1-2Mana1- |
| 2Mana1-6)Manb1-4GlcNAcb1-4GlcNAc | 6)Manb1-4GlcNAcb1-4(Fuca1-6)GlcNAC |
| Gal[3ME]b1-3GalNAcb1-4GlcNAcb1-2Mana1- | NeuAca2-6Galb1-4GlcNAcb1-2Mana1-3(NeuAca2- |
| 3(Gal[3ME]b1-3GalNAcb1-4GlcNAcb1-2Mana1- | 6Galb1-4GalNAcb1-2Mana1-6)Manb1-4GlcNAcb1- |
| 6)Manb1-4GlcNAcb1-4(Fuca1-6)GlcNAcb | 4GlcNAC |
| NeuAca2-6Galb1-4GlcNAcb1-4Mana1-3(NeuAca2- | NeuAca2-3Galb1-4GlcNAcb1-2Mana1-6(NeuAca2- |
| 6Galb1-4GlcNAcb1-4Mana1-6)Manb1-4GlcNAcb1- | 6GaFb1-4GlcNAcb1-2Manb1-3)Manb1-4GlcNAcb1- |
| 4GlcNAcb | 4GlcNAc |
| NeuAca2-6Galb1-4GlcNAcb1-2Mana1-3(NeuAca2- | NeuAca2-4Galb1-4GlcNAcb1-2Mana1-3(NeuAca2- |
| 6Galb1-4GlcNAcb1-2Mana1-6)Manb1-4GlcNAcb1- | 6Galb1-4GlcNAcb1-2Mana1-6)Manb1-4GlcNAcb1- |
| 4GlcNAc | 4GlcNAc |
| NeuAca2-6Galb1-4GlcNAcb1-2Mana1-3(NeuAca2- | NeuAca2-3Galb1-4GlcNAcb1-2Mana1-3(NeuAca2- |
| 6Galb1-4GlcNAcb1-2Mana1-6)Manb1-4GlcNAcb1- | 3Galb1-4GlcNAcb1-2Mana1-6)Manb1-4GlcNAcb1- |
| 4GlcNAc | 4GlcNAcb |
| NeuAca2-6Galb1-4GlcNAcb1-2Mana1-3(NeuAca2- | NeuAca2-6Galb1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4GlcNAc | 4GlcNAcb |
| NeuAca2-3Galb1-4GlcNAcb1-2Mana1-3(NeuAca2- | NeuAca2-3Galb1-4GlcNAcb1-2Mana1-3(NeuAca2- |
| 6Galb1-4GlcNAcb1-2Mana1-6)Manb1-4GlcNAcb1- | 3Galb1-4GlcNAcb1-2Mana1-6)Manb1-4GlcNAcb1- |
| 4GlcNAc | 4GlcNAc |
| NeuAca2-3Galb1-4GlcNAca1-2Mana1-3(NeuAca2- | NeuAca2-6Galb1-4GlcNAcb1-2Mana1-3(NeuAca2- |
| 3Galb1-4GlcNAca1-2Mana1-6)Manb1-4GlcNAcb1- | 3Galb1-4GlcNAcb1-2Mana1-6)Manb1-4GlcNAcb1- |
| 4GlcNAc | 4GlcNAcb |
| NeuAca2-6Galb1-4GlcNAcb1-4Mana1-3(NeuAca2- | NeuAca2-3Galb1-3GlcNAcb1-2Mana1-3(NeuAca2- |
| 6Galb1-4GlcNAcb1-2Mana1-6)Manb1-4GlcNAcb1- | 3Galb1-3GlcNAcb1-2Mana1-6)Manb1-4GlcNAcb1- |
| 4GlcNAcb | 4GlcNAc |
| NeuAca2-6Galb1-4GlcNAcb1-2Mana1-3(NeuAca2- | NeuAca2-6Galb1-4GlcNAcb1-2Mana1-3(Galb1- |
| 3Galb1-4GlcNAcb1-2Mana1-6)Manb1-4GlcNAcb1- | 4(Fuca1-3)GlcNAcb1-2Mana1-6)Manb1-4GlcNAcb1- |
| 4GlcNAc | 4(Fuca1-6)GlcNAcb |
| Galb1-4(Fuca1-3)GlcNAcb1-2Mana1-3(NeuAca2- | NeuAca2-6Galb1-4GlcNAcb1-2Mana1-3(Galb1- |
| 3Galb1-4GlcNAcb1-2Mana1-6)Manb1-4GlcNAcb1- | 4(Fuca1-3)GlcNAcb1-2Mana1-6)Manb1-4GlcNAcb1- |
| 4(Fuca1-6)GlcNAc | 4(Fuca1-6)GlcNAc |
| NeuAca2-6Galb1-4GlcNAcb1-2Mana1-3(Fuca1- | NeuAca2-6Galb1-4GlcNAcb1-2Mana1-2(Galb1- |
| 6Galb1-4GlcNAcb1-2Mana1-6)Manb1-4GlcNAcb1- | 4(Fuca1-3)GlcNAcb1-2Mana1-6)Manb1-4GlcNAcb1- |
| 4(Fuca1-6)GlcNAcb | 4(Fuca1-6)GlcNAcb |
| Fuca1-2Galb1-4(Fuca1-3)GlcNAcb1-2Mana1- | Fuca1-2Galb1-4(Fuca1-3)GlcNAcb1-2Mana1- |
| 3(Galb1-4(Fuca1-3)GlcNAcb1-2Mana1-6)Manb1- | 3(Fuca1-2Galb1-4(Fuca1-3)GlcNAcb1-2Mana1- |
| 4GlcNAcb1-4(Fuca1-6)GlcNAc | 6)Manb1-4GlcNAcb1-4GlcNAc |
| Galb1-4(Fuca1-3)GlcNAcb1-2Mana1-3(Fuca1- | Fuca1-2Galb1-4(Fuca1-3)GlcNAcb1-2Mana1- |
| 2Galb1-4(Fuca1-3)GlcNAcb1-2Mana1-6)Manb1- | 3(Fuca1-2Galb1-4GlcNAcb1-2Mana1-6)Manb1- |
| 4GlcNAcb1-4(Fuca1-6)GlcNAcb | 4GlcNAcb1-4(Fuca1-6)GlcNAcb |
| Fuca1-2Galb1-4(Fuca1-3)GlcNAcb1-2Mana1- | GlcNAcb1-2(GlcNAcb1-4)Mana1-3(GlcNAcb1- |
| 3(Galb1-4(Fuca1-3)GlcNAcb1-2Mana1-6)Manb1- | 3Galb1-4GlcNAcb1-2(GlcNAcb1-6)Mana1-6)Manb1- |
| 4GlcNAcb1-4(Fuca1-6)GlcNAcb | 4GlcNAcb1-4(Fuca1-6)GlcNAc |
| GlcNAcb1-3Galb1-4GlcNAcb1-2(GlcNAcb1-4)Mana1- | GalNAcb1-4GlcNAcb1-2Mana1-3(Galb1-4GlcNAcb1- |
| 3(GlcNAcb1-2(GlcNAcb1-6)Mana1-6)Manb1- | 2(GalNAcb1-4GlcNAcb1-6)Mana1-6)Manb1- |
| 4GlcNAcb1-4(Fuca1-6)GlcNAc | 4GlcNAcb1-4(Fuca1-6)GlcNAc |
| GalNAcb1-4GlcNAcb1-2(Galb1-4GlcNAcb1- | GlcNAcb1-4(Galb1-4(Fuca1-3)GlcNAcb1- |
| 4)Mana1-3(GalNAcb1-4GlcNAcb1-2Mana1- | 2(GlcNAcb1-4)Mana1-3)(GlcNAcb1-2(GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(Galb1-4GlcNAcb1-2(GlcNAcb1- | NeuGca2-6Galb1-4GlcNAcb1-2Mana1-3(NeuAca2- |
| 4)Mana1-3)(GlcNAcb1-2(GlcNAcb1-6)Mana1- | 3Galb1-4GlcNAcb1-2Mana1-6)Manb1-4GlcNAcb1- |
| 6)Manb1-4GlcNAcb1-4(Fuca1-6)GlcNAc | 4GlcNAc |
| NeuGca2-6Galb1-4GlcNAcb1-2Mana1-3(NeuAca2- | GlcNAcb1-4(NeuGca2-8NeuGca2-3/6Galb1- |
| 6Galb1-4GlcNAcb1-2Mana1-6)Manb1-4GlcNAcb1- | 4GlcNAcb1-2Mana1-3)(Mana1-6)Manb1- |
| 4GlcNAc | 4GlcNAcb1-4(Fuca1-6)GlcNAc |
| GlcNAcb1-4(NeuAca2-8NeuGca2-3/6Galb1- | NeuAca2-6Galb1-4GlcNAcb1-2Mana1-3(NeuGca2- |
| 4GlcNAcb1-2Mana1-3)(Mana1-3Mana1-6)Manb1- | 6Galb1-4GlcNAcb1-2Mana1-6)Manb1-4GlcNAcb1- |
| 4GlcNAcb1-4GlcNAc | 4GlcNAc |
| NeuAca2-6Galb1-4GlcNAcb1-2Mana1-3(Gala1- | NeuAca2-3Galb1-4GlcNAcb1-2Mana1-3(Galb1- |
| 3Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(FuCa1-6)GlcNAc |
| GlcNAcb1-4(NeuAca2-3Galb1-4GlcNAcb1-2Mana1- | NeuAca2-6Galb1-4GlcNAcb1-2Mana1-3(Galb1- |
| 3)(Mana1-3(Mana1-6)Mana1-6)Manb1-4GlcNAcb1- | 3Galb1-4GlcNAcb1-2Mana1-6)Manb1-4GlcNAcb1- |
| 4(Fuca1-6)GlcNAcb | 4(Fuca1-6)GlcNAc |
| NeuAca2-3Galb1-4GlcNAcb1-2Mana1-3(Gala1- | NeuAca2-6Galb1-4GlcNAcb1-2Mana1-3(Gala1- |
| 3Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAcb |
| NeuAca2-6Galb1-4GlcNAcb1-2Mana1-3(Galb1- | GlcNAcb1-4(NeuAca2-6Galb1-4GlcNAcb1-2Mana1- |
| 3Galb1-4GlcNAcb1-2Mana1-6)Manb1-4GlcNAcb1- | 3)(Mana1-3(Mana1-6)Mana1-6)Manb1-4GlcNAcb1- |
| 4(Fuca1-6)GlcNAcb | 4(Fuca1-6)GlcNAc |
| Fuca1-2Galb1-4(Fuca1-3)GlcNAcb1-2(Galb1- | Mana1-2Mana1-6(Mana1-2(ManaAll)Man[6P]a1- |
| 4GlcNAcb1-4)Mana1-3(Mana1-3Mana1-6)Manb1- | 2)Mana1-3(Mana1-3(Mana1-2Mana1-6)Mana1- |
| 4GlcNAcb1-4(Fuca1-6)GlcNAc | 6)Manb1-4GlcNAc |
| Mana1-2Mana1-2(Mana1-2Mana1-6)Mana1- | NeuGca2-6Galb1-4GlcNAcb1-2Mana1-3(NeuGca2- |
| 3(Mana1-3(Mana1-2(ManaAll)Man[6P]a1-6)Mana1- | 6Galb1-4GlcNAcb1-2Mana1-6)Manb1-4GlcNAcb1- |
| 6)Manb1-4GlcNAc | 4GlcNAcb |
| NeuGca2-6Galb1-4GlcNAcb1-2Mana1-3(NeuGca2- | NeuGca2-6Galb1-4GlcNAcb1-2Mana1-3(NeuGca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4GlcNAc | 4GlcNAc |
| NeuGca2-6Galb1-4GlcNAcb1-2Mana1-3(Gala1- | NeuGca2-6Galb1-4GlcNAcb1-2Mana1-3(Gala1- |
| 3Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAcb |
| NeuGca2-6Galb1-4GlcNAcb1-2Mana1-3(Galb1- | |
| 3Galb1-4GlcNAcb1-2Mana1-6)Manb1-4GlcNAcb1- | |
| 4(Fuca1-6)GlcNAc | |
| | Galb1-4(Fuca1-3)GlcNAcb1-2(Galb1-4GlcNAcb1- |
| | 4)Mana1-3(Mana1-3(Mana1-6)Mana1-6)Manb1- |
| | 4GlcNAcb1-4(Fuca1-6)GlcNAc |
| NeuAca2-6GalNAcb1-4GlcNAcb1-2Mana1- | NeuAca2-6GalNAcb1-4GlcNAcb1-2Mana1- |
| 3(NeuAca2-6Galb1-4GlcNAcb1-2Mana1-6)Manb1- | 3(NeuAca2-3Galb1-4GlcNAcb1-2Mana1-6)Manb1- |
| 4GlcNAcb1-4GlcNAc | 4GlcNAcb1-4GlcNAc |
| NeuAca2-6GalNAcb1-4GlcNAcb1-2Mana1- | NeuAca2-3GalNAcb1-4GlcNAcb1-2Mana1- |
| 3(NeuAca2-3Galb1-4GlcNAcb1-2Mana1-6)Manb1- | 3(NeuAca2-3Galb1-3GlcNAcb1-2Mana1-6)Manb1- |
| 4GlcNAcb1-4GlcNAcb | 4GlcNAcb1-4GlcNAc |
| NeuAca2-6Galb1-4GlcNAcb1-2Mana1- | NeuAc[4T]a1-6Galb1-4GlcNAcb1-2Mana1- |
| 3(NeuAc[4T]a1-6Galb1-4GlcNAcb1-2Mana1- | 3(NeuAca2-6Galb1-4GlcNAcb1-2Mana1-6)Manb1- |
| 6)Manb1-4GlcNAcb1-4GlcNAc | 4GlcNAcb1-4GlcNAc |
| GalNAcb1-4(Fuca1-3)GlcNAcb1-2Mana1- | Fuca1-2Galb1-4(Fuca1-3)GlcNAcb1-2Mana1- |
| 3(NeuAca2-6Galb1-4GlcNAcb1-2Mana1-6)Manb1- | 3(GalNAcb1-4(Fuca1-3)GlcNAcb1-2Mana1- |
| 4GlcNAcb1-4(Fuca1-6)GlcNAcb | 6)Manb1-4GlcNAcb1-4(Fuca1-6)GlcNAc |
| GlcNAcb1-4(Fuca1-2Galb1-4(Fuca1-3)GlcNAcb1- | GalNAcb1-4GlcNAcb1-4GlcNAcb1-2Mana1- |
| 2Mana1-3)(Fuca1-3GlcNAcb1-2Mana1-6)Manb1- | 3(GalNAcb1-4GlcNAcb1-4GlcNAcb1-2Mana1- |
| 4GlcNAcb1-4(Fuca1-6)GlcNAc | 6)Manb1-4GlcNAcb1-4(Fuca1-6)GlcNAc |
| GalNAcb1-4GlcNAcb1-2Mana1-3(GalNAcb1- | GalNAcb1-4GlcNAcb1-2(GlcNAcb1-4)Mana1- |
| 4GlcNAcb1-2(GalNAcb1-4GlcNAcb1-6)Mana1- | 3(GalNAcb1-4GlcNAcb1-2(GlcNAcb1-6)Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(NeuAca2-6Galb1-4GlcNAcb1-2Mana1- | GlcNAcb1-4(Galb1-4GlcNAcb1-2Mana1- |
| 3)(Galb1-4GlcNAcb1-2Mana1-6)Manb1-4GlcNAcb1- | 3)(NeuAca2-6Galb1-4GlcNAcb1-2Mana1-6)Manb1- |
| 4(Fuca1-6)GlcNAcb | 4GlcNAcb1-4(Fuca1-6)GlcNAcb |
| GlcNAcb1-4(NeuAca2-6Galb1-4GlcNAcb1-2Mana1- | GlcNAcb1-4(NeuAca2-3Galb1-4GlcNAcb1-2Mana1- |
| 3)(Galb1-4GlcNAcb1-2Mana1-6)Manb1-4GlcNAcb1- | 3)(Galb1-4GlcNAcb1-2Mana1-6)Manb1-4GlcNAcb1- |
| 4(Fuca1-6)GlcNAc | 4(FuCa1-6)GlcNAc |
| GlcNAcb1-4(NeuAca2-6Galb1-4GlcNAcb1-2Mana1- | NeuAca2-6GalNAcb1-4GlcNAcb1-2Mana1-3(Gala1- |
| 3)(Galb1-4GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAcb |
| GlcNAcb1-4(Galb1-4GlcNAcb1-2Mana1- | GalNAca1-3(Fuca1-2)Galb1-4(Fuca1-3)GlcNAcb1- |
| 3)(NeuAca2-6Galb1-4GlcNAcb1-2Mana1-6)Manb1- | 2Mana1-3(Galb1-4GlcNAcb1-2Mana1-6)Manb1- |
| 4GlcNAcb1-4(Fuca1-6)GlcNAc | 4GlcNAcb1-4(Fuca1-6)GlcNAc |
| GlcNAcb1-4(Fuca1-2Galb1-4GlcNAcb1-2Mana1- | GlcNAcb1-4(Galb1-4(Fuca1-3)GlcNAcb1-2Mana1- |
| 3)(Fuca1-2Galb1-4GlcNAcb1-2Mana1-6)Manb1- | 3)(Galb1-4(Fuca1-3)GlcNAcb1-2Mana1-6)Manb1- |
| 4GlcNAcb1-4(Fuca1-6)GlcNAc | 4GlcNAcb1-4(Fuca1-6)GlcNAc |
| GlcNAcb1-4(Fuca1-2Galb1-4(Fuca1-3)GlcNAcb1- | Kdna1-3Galb1-4GlcNAcb1-2Mana1-3(Kdna1- |
| 2Mana1-3)(Galb1-4(Fuca1-3)GlcNAcb1-2Mana1- | 3Galb1-4GlcNAcb1-2Mana1-6)Manb1-4GlcNAcb1- |
| 6)Manb1-4GlcNAcb1-4GlcNAc | 4(Fuca1-6)GlcNAcb |
| Gala1-3Galb1-4GlcNAcb1-2(Gala1-3Galb1- | GlcNAcb1-3Galb1-4GlcNAcb1-2(GlcNAcb1-4)Mana1- |
| 4GlcNAcb1-4)Mana1-3(Mana1-3(Mana1-6)Mana1- | 3(GalNAcb1-4GlcNAcb1-2(GlcNAcb1-6)Mana1- |
| 6)Manb1-4GlcNAcb1-4GlcNAc | 6)Manb1-4GlcNAcb1-4GlcNAc |
| GlcNAcb1-4(GlcNAcb1-2(Galb1-4GlcNAcb1- | GlcNAcb1-4(GlcNAcb1-2(GlcNAcb1-4)Mana1- |
| 4)Mana1-3)(GlcNAcb1-2(GlcNAcb1-4)(GlcNAcb1- | 3)(Galb1-4GlcNAcb1-2(GlcNAcb1-4)(GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(GlcNAcb1-2(GlcNAcb1-4)Mana1- | NeuAca2-3Galb1-4GlcNAc[6S]b1-3Galb1- |
| 3)(GlcNAcb1-2(Galb1-4GlcNAcb1-4)(GlcNAcb1- | 4GlcNAc[6S]b1-3Galb1-4GlcNAcb1-3Galb1- |
| 6)Mana1-6)Manb1-4GlcNAcb1-4GlcNAc | 4GlcNAcb1-3Galb1-3GalNAc |
| GlcNAcb1-4(Galb1-4(Fuca1-3)GlcNAcb1-2Mana1- | NeuAca2-3Galb1-4GlcNAcb1-2Mana1-3(Galb1- |
| 3)(NeuGca2-3/6Galb1-4GlcNAcb1-2Mana1- | 4GlcNAcb1-2(Galb1-4GlcNAcb1-6)Mana1-6)Manb1- |
| 6)Manb1-4GlcNAcb1-4GlcNAc-4GlcNAc | 4GlcNAcb1-4GlcNAc |
| NeuAca2-6Galb1-4GlcNAcb1-2(Galb1-4GlcNAcb1- | Galb1-4GlcNAcb1-2(Galb1-4GlcNAcb1-4)Mana1- |
| 4)Mana1-3(Galb1-4GlcNAcb1-2Mana1-6)Manb1- | 3(NeuAca2-3Galb1-4GlcNAcb1-2Mana1-6)Manb1- |
| 4GlcNAcb1-4GlcNAc | 4GlcNAcb1-4GlcNAc |
| Galb1-4GlcNAcb1-2(NeuAca2-3Galb1-4GlcNAcb1- | Galb1-4GlcNAcb1-2Mana1-3(NeuAca2-6Galb1- |
| 4)Mana1-3(Galb1-4GlcNAcb1-2Mana1-6)Manb1- | 4GlcNAcb1-2(Galb1-4GlcNAcb1-4)Mana1-6)Manb1- |
| 4GlcNAcb1-4GlcNAc | 4GlcNAcb1-4GlcNAc |
| Galb1-4GlcNAcb1-2(Galb1-3(NeuAca2-6)GlcNAcb1- | Galb1-4GlcNAcb1-2(Galb1-4GlcNAcb1-4)Mana1- |
| 4)Mana1-3(Galb1-4GlcNAcb1-2Mana1-6)Manb1- | 3(NeuAca2-6Galb1-4GlcNAcb1-2Mana1-6)Manb1- |
| 4GlcNAcb1-4GlcNAc | 4GlcNAcb1-4GlcNAc |
| Galb1-4GlcNAcb1-2Mana1-3(NeuAca2-3Galb1- | Galb1-4GlcNAcb1-2Mana1-3(NeuAca2-3Galb1- |
| 4GlcNAcb1-2(Galb1-4GlcNAcb1-4)Mana1-6)Manb1- | 4GlcNAcb1-2(Galb1-4GlcNAcb1-6)Mana1-6)Manb1- |
| 4GlcNAcb1-4GlcNAcb | 4GlcNAcb1-4GlcNAc |
| Galb1-4GlcNAcb1-2Mana1-3(Galb1-4GlcNAcb1- | |
| 2(NeuAca2-3Galb1-4GlcNAcb1-4)Mana1-6)Manb1- | |
| 4GlcNAcb1-4GlcNAcb | |
| Galb1-4GlcNAcb1-2(Galb1-4(Fuca1-3)GlcNAcb1- | Galb1-4GlcNAcb1-2(Galb1-4(Fuca1-3)GlcNAcb1- |
| 4)Mana1-3(Galb1-4GlcNAcb1-2Mana1-6)Manb1- | 4)Mana1-3(Galb1-4GlcNAcb1-2Mana1-6)Manb1- |
| 4GlcNAcb1-4(Fuca1-6)GlcNAc | 4GlcNAcb1-4(Fuca1-6)GlcNAcb |
| Galb1-4(Fuca1-3)GlcNAcb1-2(Galb1-4GlcNAcb1- | Galb1-4GlcNAcb1-2Mana1-3(Galb1-4(Fuca1- |
| 4)Mana1-3(Galb1-4GlcNAcb1-2Mana1-6)Manb1- | 3)GlcNAcb1-3Galb1-4(Fuca1-3)GlcNAcb1-2Mana1- |
| 4GlcNAcb1-4(Fuca1-6)GlcNAcb | 6)Manb1-4GlcNAcb1-4GlcNAc |
| Galb1-4GlcNAcb1-2Mana1-3(Galb1-4GlcNAcb1- | Galb1-4GlcNAcb1-2Mana1-3(Galb1-4(Fuca1- |
| 2(Galb1-4(Fuca1-3)GlcNAcb1-6)Mana1-6)Manb1- | 3)GlcNAcb1-3Galb1-4GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(Galb1-4GlcNAcb1-4)Mana1- | Galb1-4GlcNAcb1-3Galb1-4GlcNAcb1-2Mana1- |
| 3(Galb1-4(Fuca1-3)GlcNAcb1-2Mana1-6)Manb1- | 3(Galb1-4(Fuca1-3)GlcNAcb1-2Mana1-6)Manb1- |
| 4GlcNAcb1-4(Fuca1-6)GlcNAcb | 4GlcNAcb1-4(Fuca1-6)GlcNAc |
| Galb1-4(Fuca1-3)GlcNAcb1-2(Galb1-4GlcNAcb1- | GlcNAcb1-4(Fuca1-2Galb1-4(Fuca1-3)GlcNAcb1- |
| 4)Mana1-3(Galb1-4GlcNacb1-2Mana1-6)Manb1- | 2(Galb1-4GlcNAcb1-4)Mana1-3)(Mana1-3Mana1- |
| 4GlcNAcb1-4(Fuca1-6)GlcNAc | 6)Manb1-4GlcNAcb1-4GlcNAc |
| GlcNAcb1-4(Galb1-4(Fuca1-3)GlcNAcb1- | NeuAca2-6Galb1-4GlcNAcb1-2Mana1-3(NeuAca2- |
| 2(GlcNAcb1-4)Mana1-3)(Mana1-3(Mana1-6)Mana1- | 6Galb1-4GlcNAc[6S]b1-2Mana1-6)Manb1- |
| 6)Manb1-4GlcNAcb1-4(Fuca1-6)GlcNAc | 4GlcNAcb1-4GlcNAc |
| GalNAcb1-4(Fuca1-3)GlcNAcb1-2Mana1- | NeuAca2-6GalNAcb1-4GlcNAcb1-2Mana1- |
| 3(NeuAca2-3GalNAcb1-4GlcNAcb1-2Mana1- | 3(GalNAcb1-4(Fuca1-3)GlcNAcb1-2Mana1- |
| 6)Manb1-4GlcNAcb1-4(Fuca1-6)GlcNAcb | 6)Manb1-4GlcNAcb1-4(Fuca1-6)GlcNAcb |
| NeuAc[4T]a1-6Galb1-4GlcNAcb1-2Mana1- | NeuGca2-3Galb1-4GlcNAc[6S]b1-3Galb1- |
| 3(NeuAc[4T]a1-6Galb1-4GlcNAcb1-2Mana1- | 4GlcNAc[6S]b1-3Galb1-4GlcNAcb1-3Galb1- |
| 6)Manb1-4GlcNAcb1-4GlcNAc | 4GlcNAcb1-3Galb1-3GalNAc |
| Gala1-3Galb1-4GlcNAcb1-2(Galb1-4GlcNAcb1- | GlcNAcb1-4(Galb1-4GlcNAcb1-2(Galb1-4GlcNAcb1- |
| 4)Mana1-3(Galb1-4GlcNAcb1-2Mana1-6)Manb1- | 4)Mana1-3)(Mana1-3(Mana1-6)Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1-2(Galb1- | Galb1-4GlcNAcb1-2Mana1-3(Gala1-3Galb1- |
| 4GlcNAcb1-4)Mana1-3)(Mana1-3(Mana1-6)Mana1- | 4GlcNAcb1-3Galb1-4GlcNAcb1-2Mana1-6)Manb1- |
| 6)Manb1-4GlcNAcb1-4GlcNAc | 4GlcNAcb1-4(Fuca1-6)GlcNAc |
| GlcNAcb1-4(Gala1-3Galb1-4GlcNAcb1-2Mana1- | Galb1-4GlcNAcb1-2(Galb1-4GlcNAcb1-4)Mana1- |
| 3)(Gala1-3Galb1-4GlcNAcb1-2Mana1-6)Manb1- | 3(Gala1-3Galb1-4GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2Mana1-3(Galb1-4GlcNAcb1- | Galb1-4GlcNAcb1-2Mana1-3(Galb1-4GlcNAcb1- |
| 2(Galb1-3Galb1-4GlcNAcb1-4)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4GlcNAcb1-2Mana1-3(Galb1-3Galb1- | Galb1-4GlcNAcb1-2Mana1-3(Gala1-3Galb1- |
| 4GlcNAca1-2(Galb1-4GlcNAcb1-4)Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4GlcNAcb1-3Galb1-4GlcNAcb1-2Mana1- | NeuAca2-6Galb1-4GlcNAc[6S]b1-2Mana1-3(Gala1- |
| 3(Galb1-3Galb1-4GlcNAcb1-2Mana1-6)Manb1- | 3Galb1-4GlcNAcb1-2Mana1-6)Manb1-4GlcNAcb1- |
| 4GlcNAcb1-4(Fuca1-6)GlcNAc | 4(Fuca1-6)GlcNAc |
| NeuAca2-4GlcNAcb1-3(NeuAca2-6)Galb1- | NeuAca2-3/6Galb1-4(Fuca1-3)GlcNAcb1- |
| 4GlcNAcb1-3(NeuAca2-6)Galb1-4GlcNAcb1- | 2(GlcNAcb1-4)Mana1-3(GlcNAcb1-2(GlcNAcb1- |
| 3(NeuAca2-6)GalNAc | 6)Mana1-6)Manb1-4GlcNAcb1-4GlcNAc |
| NeuAca2-3/6Galb1-4GlcNAcb1-2(GlcNAcb1- | GlcNAcb1-4(NeuAca2-3/6Galb1-4GlcNAcb1- |
| 4)Mana1-3(GlcNAcb1-2(GlcNAcb1-6)Mana1- | 2(GlcNAcb1-4)Mana1-3)(GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(Fuca1-2Galb1-4(Fuca1-3)GlcNAcb1- | GlcNAcb1-4(Galb1-4(Fuca1-3)GlcNAcb1-2Mana1- |
| 2Mana1-3)(GalNAcb1-4(Fuca1-3)GlcNAcb1- | 3)(GalNAcb1-4(Fuca1-3)GlcNAcb1-2Mana1- |
| 2Mana1-6)Manb1-4GlcNAcb1-4GlcNAc | 6)Manb1-4GlcNAcb1-4(Fuca1-6)GlcNAc |
| Mana1-2Mana1-2(Mana1-2(Mana1-2(Mana1- | Mana1-3Mana1-2Mana1-2Mana1-3(Mana1- |
| 6)Mana1-6)Mana1-6)Mana1-3(Mana1-3(Mana1- | 3(Mana1-3Mana1-2(Mana1-3Mana1-2Mana1- |
| 2Mana1-6)Mana1-6)Manb1-4GlcNAc | 6)Mana1-6)Mana1-6)Manb1-4GlcNAc |
| Glca1-2Glca1-3Glca1-3Mana1-2Mana1-2(Mana1- | Glca1-2Glca1-3Glca1-3Mana1-2Mana1-2(Mana1- |
| 2Mana1-6)Mana1-3(Mana1-3(Mana1-2Mana1- | 6)Mana1-3(Mana1-3(Mana1-3Mana1-2Mana1- |
| 6)Mana1-6)Manb1-4GlcNAc | 6)Mana1-6)Manb1-4GlcNAc |
| Mana1-2Mana1-2(Mana1-2(Mana1-6Mana1- | Mana1-2Mana1-2Mana1-3(Mana1-3Mana1- |
| 6Mana1-6)Mana1-6)Mana1-3(Mana1-3(Mana1- | 3(Mana1-3Mana1-2(Mana1-3Mana1-2Mana1- |
| 2Mana1-6)Mana1-6)Manb1-4GlcNAc | 6)Mana1-6)Mana1-6)Manb1-4GlcNAc |
| NeuAca2-8NeuGca2-3/6Galb1-4(Fuca1- | NeuAca2-8NeuAca2-3/6Galb1-4(Fuca1-3)GlcNAcb1- |
| 3)GlcNAcb1-2Mana1-3(Mana1-3Mana1-6)Manb1- | 2Mana1-3(Mana1-3(Mana1-6)Mana1-6)Manb1- |
| 4GlcNAcb1-4(Fuca1-6)GlcNAc | 4GlcNAcb1-4GlcNAc |
| NeuAca2-8NeuAca2-3/6Galb1-4GlcNAcb1-2Mana1- | Gala1-3Galb1-4GlcNAcb1-2Mana1-3(Gala1-3Galb1- |
| 3(Mana1-3(Mana1-6)Mana1-6)Manb1-4GlcNAcb1- | 4GlcNAcb1-3Galb1-4GlcNAcb1-2Mana1-6)Manb1- |
| 4(Fuca1-6)GlcNAc | 4GlcNAcb1-4GlcNAc |
| GalNAcb1-4GlcNAcb1-2(GlcNAcb1-4)Mana1- | NeuGca2-6Galb1-4GlcNAc[6S]b1-2Mana1-3(Gala1- |
| 3(GalNAcb1-4GlcNAcb1-2(GalNAcb1-4GlcNAcb1- | 3Galb1-4GlcNAcb1-2Mana1-6)Manb1-4GlcNAcb1- |
| 6)Mana1-6)Manb1-4GlcNAcb1-4GlcNAc | 4(Fuca1-6)GlcNAc |
| NeuGca2-3/6Galb1-4(Fuca1-3)GlcNAcb1- | GlcNAcb1-4(Galb1-4(Fuca1-3)GlcNAcb1-2(Galb1- |
| 2(GlcNAcb1-4)Mana1-3(GlcNAcb1-2(GlcNAcb1- | 4GlcNAcb1-4)Mana1-3)(GlcNAcb1-2Mana1- |
| 6)Mana1-6)Manb1-4GlcNAcb1-4GlcNAc | 6)Manb1-4GlcNAcb1-4(Fuca1-6)GlcNAc |
| GlcNAcb1-4(GalNAca1-3(Fuca1-2)Galb1- | GlcNAcb1-4(Neua1-6Galb1-4GlcNAcb1-2Mana1- |
| 4GlcNAcb1-2Mana1-3)(Galb1-4GlcNAcb1-2Mana1- | 3)(Neua1-6Galb1-4GlcNAcb1-2Mana1-6)Manb1- |
| 6)Manb1-4GlcNAcb1-4(Fuca1-6)GlcNAc | 4GlcNAcb1-4(Fuca1-6)GlcNAc |
| Galb1-4(NeuAca2-3)Galb1-4GlcNAcb1-2Mana1- | Glca1-3Glca1-3Mana1-2Mana1-2Mana1-3(Mana1- |
| 3(Galb1-4(NeuAca2-3)Galb1-4GlcNAcb1-2Mana1- | 2Mana1-3(Mana1-2Mana1-6)Mana1-6)Manb1- |
| 6)Manb1-4GlcNAc | 4GlcNAcb1-4(Fuca1-6)GlcNAc |
| Galb1-4GlcNAcb1-2(Galb1-4GlcNAcb1-4)Mana1- | Galb1-4GlcNAcb1-2(GlcNAcb1-4)Mana1-3(Galb1- |
| 3(Galb1-4GlcNAcb1-2(GlcNAcb1-6)Mana1- | 4GlcNAcb1-2(Galb1-4GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| Galb1-4(Fuca1-3)GlcNAcb1-2(GlcNAcb1-4)Mana1- | GalNAcb1-4GlcNAcb1-2(Galb1-4GlcNAcb1- |
| 3(Galb1-4GlcNAcb1-2(Galb1-4GlcNAcb1-6)Mana1- | 4)Mana1-3(Gala1-3Galb1-4GlcNAcb1-2Mana1- |
| 6)Manb1-4GlcNAcb1-4GlcNAc | 6)Manb1-4GlcNAcb1-4(Fuca1-6)GlcNAcb |
| GlcNAcb1-4(Galb1-4GlcNAcb1-2(Galb1-4GlcNAcb1- | Galb1-4GlcNAcb1-2(GlcNAcb1-4)Mana1-3(Galb1- |
| 4)Mana1-3)(Galb1-4GlcNAcb1-2Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(Galb1-4GlcNAcb1-4)Mana1- | GlcNAcb1-4(Galb1-4GlcNAcb1-2Mana1-3)(Galb1- |
| 3(Galb1-4GlcNAcb1-2(GlcNAcb1-6)Mana1- | 4GlcNAcb1-2(Galb1-4GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| | GlcNAcb1-4(GalNAcb1-4(Fuca1-3)GlcNAcb1- |
| | 2Mana1-3)(GalNAcb1-4(Fuca1-3)GlcNAcb1- |
| | 2Mana1-6)Manb1-4GlcNAcb1-4(Fuca1-6)GlcNAc |
| Glca1-2Glca1-3Glca1-3Mana1-2Mana1-2Mana1- | Glca1-3Glca1-3Glca1-3Mana1-2Mana1-2Mana1- |
| 3(Mana1-2Mana1-3(Mana1-2Mana1-6)Mana1- | 3(Mana1-2Mana1-3(Mana1-2Mana1-6)Mana1- |
| 6)Manb1-4GlcNAcb1-4GlcNAc | 6)Manb1-4GlcNAcb1-4GlcNAc |
| Glca1-2Glca1-3Glca1-3Mana1-2Mana1-2Mana1- | Mana1-3Mana1-2Mana1-2Mana1-3(Mana1- |
| 3(Mana1-2Mana1-3(Mana1-2Mana1-6)Mana1- | 3(Mana1-3Mana1-2(Mana1-2Mana1-6)Mana1- |
| 6)Manb1-4GlcNAcb1-4GlcNAcb | 6)Mana1-6)Manb1-4GlcNAcb1-4GlcNAcb |
| NeuAca2-3Galb1-4GlcNAcb1-2Mana1-3(NeuAca2- | NeuAca2-6Galb1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAc | 4(Fuca1-6)GlcNAc |
| NeuAca2-3Galb1-4GlcNAcb1-2(NeuAca2-3Galb1- | NeuAca2-3Galb1-4GlcNAcb1-2Mana1-3(NeuAca2- |
| 4GlcNAcb1-4)Mana1-3(Mana1-6)Manb1- | 3Galb1-4GlcNAcb1-2Mana1-6)Manb1-4GlcNAcb1- |
| 4GlcNAcb1-4(Fuca1-6)GlcNAcb | 4(Fuca1-6)GlcNAcb |
| NeuAca2-3Galb1-4GlcNAca1-2Mana1-3(NeuAca2- | NeuAca2-6Galb1-4GlcNAcb1-2Mana1-3(NeuAca2- |
| 3Galb1-4GlcNAca1-2Mana1-6)Manb1-4GlcNAcb1- | 6Galb1-4GlcNAcb1-2Mana1-6)Manb1-4GlcNAcb1- |
| 4(Fuca1-6)GlcNAc | 4(Fuca1-6)GlcNAc |
| NeuAca2-3/6Galb1-4GlcNAcb1-2Mana1-3(NeuAca2- | NeuAca2-3Galb1-4GlcNAcb1-2Mana1-3(NeuAca2- |
| 3/6Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAcb | 4(Fuca1-6)GlcNAc |
| NeuAca2-6Galb1-4GlcNAcb1-2Mana1-3(NeuAca2- | NeuAca2-6Galb1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAcb | 4(Fuca1-6)GlcNAc |
| NeuAca2-6Galb1-4GlcNAcb1-2Mana1-3(NeuAca2- | NeuAca2-6Galb1-4GlcNAcb1-2Mana1-3(NeuAca2- |
| 3Galb1-4GlcNAcb1-2Mana1-6)Manb1-4GlcNAcb1- | 6Galb1-4GlcNAcb1-2Mana1-6)Manb1-4GlcNAcb1- |
| 4(Fuca1-6)GlcNAc | 4(Fuca1-6)GlcNAcb |
| NeuAca2-3Galb1-3GlcNAcb1-2Mana1-3(NeuAca2- | NeuAca2-6Galb1-4GlcNAcb1-2Mana1-3(NeuAca2- |
| 3Galb1-3GlcNAcb1-2Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAc |
| NeuAca2-3Galb1-4GlcNAcb1-2Mana1-3(NeuAca2- | NeuAca2-3Galb1-3GlcNAcb1-2Mana1-3(NeuAca2- |
| 6Galb1-4GlcNAcb1-2Mana1-6)Manb1-4GlcNAcb1- | 3Galb1-3GlcNAcb1-2Mana1-6)Manb1-4GlcNAcb1- |
| 4(Fuca1-6)GlcNAcb | 4(Fuca1-6)GlcNAcb |
| NeuAca2-6Galb1-4GlcNAcb1-4Mana1-3(NeuAca2- | |
| 6Galb1-4GlcNAcb1-2Mana1-6)Manb1-4GlcNAcb1- | |
| 4(Fuca1-6)GlcNAc | |
| | NeuAca2-6Galb1-4GlcNAcb1-2Mana1-3(NeuAca2- |
| | 6Galb1-4GalNAcb1-2Mana1-6)Manb1-4GlcNAcb1- |
| | 4(Fuca1-6)GlcNAc |
| NeuAca2-3Galb1-4GlcNAcb1-2(NeuAca2-3Galb1- | NeuAca2-6Galb1-4GlcNAcb1-2Mana1-3(NeuAca2- |
| 4GlcNAcb1-4)Mana1-3(Mana1-6)Manb1- | 6Galb1-4GlcNAcb1-2Mana1-6)Manb1-4GlcNAcb1- |
| 4GlcNAcb1-4(Fuca1-6)GlcNAc | 4(Fuca1-6)GlcNAc |
| NeuAca2-6Galb1-4(Fuca1-3)GlcNAcb1-2Mana1- | Galb1-4GlcNAcb1-2(Galb1-4GlcNAcb1-4)Mana1- |
| 3(Galb1-4(Fuca1-3)GlcNAcb1-2Mana1-6)Manb1- | 3(Galb1-4GlcNAcb1-2(Galb1-4GlcNAcb1-6)Mana1- |
| 4GlcNAcb1-4(Fuca1-6)GlcNAc | 6)Manb1-4GlcNAcb1-4GlcNAc |
| Galb1-4GlcNAcb1-2(Galb1-3GlcNAcb1-4)Mana1- | Galb1-4GlcNAcb1-2(Galb1-4GlcNAcb1-4)Mana1- |
| 3(Galb1-4GlcNAcb1-2(Galb1-4GlcNAcb1-6)Mana1- | 3(Galb1-4GlcNAcb1-2(Galb1-4GlcNAcb1-4)Mana1- |
| 6)Manb1-4GlcNAcb1-4GlcNAc | 6)Manb1-4GlcNAcb1-4GlcNAc |
| Galb1-4GlcNAcb1-2(Galb1-4GlcNAcb1-4)Mana1- | Galb1-4GlcNAcb1-3(Galb1-4GlcNAcb1-4)Mana1- |
| 3(Galb1-4GlcNAcb1-2(Galb1-4GlcNAcb1-6)Mana1- | 3(Galb1-4GlcNAcb1-2(Galb1-4GlcNAcb1-6)Mana1- |
| 6)Manb1-4GlcNAcb1-4GlcNAcb | 6)Manb1-4GlcNAcb1-4GlcNAc |
| Galb1-4GlcNAcb1-2(Galb1-4GlcNAcb1-4)Mana1- | Galb1-4GlcNAcb1-2(Galb1-4GlcNAcb1-6)Mana1- |
| 3(Galb1-4GlcNAcb1-2(Galb1-4GlcNAcb1-6)Mana1- | 3(Galb1-4GlcNAcb1-2(Galb1-4GlcNAcb1-4)Mana1- |
| 6)Manb1-4GlcNAcb1-4GlcNAc | 6)Manb1-4GlcNAcb1-4GlcNAc |
| Galb1-3GlcNAcb1-2(Galb1-4GlcNAcb1-4)Mana1- | Galb1-4GlcNAcb1-2Mana1-3(Galb1-4GlcNAcb1- |
| 3(Galb1-4GlcNAcb1-2(Galb1-4GlcNAcb1-6)Mana1- | 3Galb1-4GlcNAcb1-2(Galb1-4GlcNAcb1-6)Mana1- |
| 6)Manb1-4GlcNAcb1-4GlcNAc | 6)Manb1-4GlcNAcb1-4GlcNAc |
| Galb1-4GlcNAcb1-3Galb1-4GlcNAcb1-2Mana1- | Galb1-4GlcNAcb1-2Mana1-3(Galb1-4GlcNAcb1- |
| 3(Galb1-4GlcNAcb1-2(Galb1-4GlcNAcb1-6)Mana1- | 2(Galb1-4GlcNAcb1-3Galb1-4GlcNAcb1-6)Mana1- |
| 6)Manb1-4GlcNAcb1-4GlcNAc | 6)Manb1-4GlcNAcb1-4GlcNAc |
| Fuca1-2Galb1-4(Fuca1-3)GlcNAcb1-2Mana1- | Fuca1-2Galb1-4(Fuca1-3)GlcNAcb1-2Mana1- |
| 3(Fuca1-2Galb1-4(Fuca1-3)GlcNAcb1-2Mana1- | 3(Fuca1-2Galb1-4(Fuca1-3)GlcNAcb1-2Mana1- |
| 6)Manb1-4GlcNAcb1-4(Fuca1-6)GlcNAcb | 6)Manb1-4GlcNAcb1-4(Fuca1-6)GlcNAc |
| NeuAca2-3Galb1-4GlcNAc[6S]b1-3Galb1- | NeuAca2-6Galb1-4GlcNAcb1-2(Gal[3S]b1- |
| 4GlcNAc[6S]b1-3Galb1-4GlcNAc[6S]b1-3Galb1- | 4GlcNAcb1-4)Mana1-3(Galb1-4GlcNAcb1-2Mana1- |
| 4GlcNAcb1-3Galb1-3GalNAc | 6)Manb1-4GlcNAcb1-4GlcNAc |
| GlcNAcb1-4(Galb1-4(Fuca1-3)GlcNAcb1- | GlcNAcb1-4(GlcNAcb1-2(Fuca1-2Galb1-3GlcNAcb1- |
| 2(GlcNAcb1-4)Mana1-3)(GlcNAcb1-2(GlcNAcb1- | 4)Mana1-3)(GlcNAcb1-2(GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuGca2-3Galb1-4GlcNAcb1-2Mana1-3(NeuAca2- | NeuAca2-6Galb1-4GlcNAcb1-2Mana1-3(Galb1- |
| 3Galb1-4GlcNAcb1-2Mana1-6)Manb1-4GlcNAcb1- | 4GlcNAcb1-2(NeuAca2-6Galb1-4GlcNAcb1- |
| 4(Fuca1-6)GlcNAcb | 6)Mana1-6)Manb1-4GlcNAc |
| NeuAca2-6Galb1-4GlcNAcb1-2(Galb1-4GlcNAcb1- | NeuAca2-3Galb1-4GlcNAcb1-2Mana1-3(NeuGca2- |
| 4)Mana1-3(NeuAca2-6Galb1-4GlcNAcb1-2Mana1- | 3Galb1-4GlcNAcb1-2Mana1-6)Manb1-4GlcNAcb1- |
| 6)Manb1-4GlcNAc | 4(Fuca1-6)GlcNAcb |
| NeuAca2-6Galb1-4GlcNAcb1-2(NeuAca2-6Galb1- | NeuAca2-3Galb1-4GlcNAcb1-2Mana1-3(Galb1- |
| 4GlcNAcb1-4)Mana1-3(Galb1-4GlcNAcb1-2Mana1- | 4(NeuAca2-3)Galb1-4GlcNAcb1-2Mana1-6)Manb1- |
| 6)Manb1-4GlcNAc | 4GlcNAcb1-4GlcNAc |
| NeuAca2-6Galb1-4GlcNAcb1-2Mana1-3(NeuAca2- | NeuGca2-3/6Galb1-4(Fuca1-3)GlcNAcb1-2Mana1- |
| 6Galb1-4GlcNAcb1-2(Galb1-4GlcNAcb1-6)Mana1- | 3(NeuAca2-3/6Galb1-4GlcNAcb1-2Mana1-6)Manb1- |
| 6)Manb1-4GlcNAc | 4GlcNAcb1-4GlcNAc |
| GlcNAcb1-4(NeuAca2-8NeuGca2-3/6Galb1- | GlcNAcb1-4(NeuGca2-8NeuGca2-3/6Galb1- |
| 4(Fuca1-3)GlcNAcb1-2Mana1-3)(Mana1-3Mana1- | 4(Fuca1-3)GlcNAcb1-2Mana1-3)(Mana1-6)Manb1- |
| 6)Manb1-4GlcNAcb1-4GlcNAc | 4GlcNAcb1-4(Fuca1-6)GlcNAc |
| NeuAca2-6Galb1-4GlcNAcb1-2Mana1-3(NeuGca2- | NeuAca2-3/6Galb1-4(Fuca1-3)GlcNAcb1- |
| 6Galb1-4GlcNAcb1-2Mana1-6)Manb1-4GlcNAcb1- | 2(GlcNAcb1-4)Mana1-3(Mana1-3(Mana1-6)Mana1- |
| 4(Fuca1-6)GlcNAc | 6)Manb1-4GlcNAcb1-4(Fuca1-6)GlcNAc |
| GlcNAcb1-4(NeuAca2-3/6Galb1-4(Fuca1- | NeuGca2-3/6Galb1-4(Fuca1-3)GlcNAcb1-2Mana1- |
| 3)GlcNAcb1-2Mana1-3)(Mana1-3(Mana1-6)Mana1- | 3(Galb1-4(Fuca1-3)GlcNAcb1-2Mana1-6)Manb1- |
| 6)Manb1-4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2Mana1- | NeuGca2-3Galb1-4GlcNAc[6S]b1-3Galb1- |
| 3(Fuca1-2Galb1-4(Fuca1-3)GlcNAcb1-2Mana1- | 4GlcNAc[6S]b1-3Galb1-4GlcNAc[6S]b1-3Galb1- |
| 6)Manb1-4GlcNAcb1-4GlcNAc | 4GlcNAcb1-3Galb1-3GalNAc |
| GlcNAcb1-4(NeuGca2-3/6Galb1-4GlcNAcb1- | NeuGca2-6Galb1-4GlcNAcb1-2Mana1-3(NeuGca2- |
| 2(GlcNAcb1-4)Mana1-3)(GlcNAcb1-2(GlcNAcb1- | 6Galb1-4GlcNAcb1-2Mana1-6)Manb1-4GlcNAcb1- |
| 6)Mana1-6)Manb1-4GlcNAcb1-4GlcNAc | 4(Fuca1-6)GlcNAcb |
| GlcNAcb1-4(NeuGca2-8NeuGca2-3/6Galb1- | NeuGca2-3/6Galb1-4(Fuca1-3)GlcNAcb1-2Mana1- |
| 4GlcNAcb1-2Mana1-3)(Mana1-3Mana1-6)Manb1- | 3(NeuGca2-3/6Galb1-4GlcNAcb1-2Mana1-6)Manb1- |
| 4GlcNAcb1-4(Fuca1-6)GlcNAc | 4GlcNAcb1-4GlcNAc |
| GlcNAcb1-4(NeuAca2-8NeuGca2-3/6Galb1- | NeuGca2-6Galb1-4GlcNAcb1-2Mana1-3(NeuGca2- |
| 4GlcNAcb1-2Mana1-3)(Mana1-3(Mana1-6)Mana1- | 6Galb1-4GlcNAcb1-2Mana1-6)Manb1-4GlcNAcb1- |
| 6)Manb1-4GlcNAcb1-4GlcNAc | 4(Fuca1-6)GlcNAc |
| NeuGca2-3/6Galb1-4GlcNAcb1-2Mana1- | Gala1-3Galb1-4GlcNAcb1-2Mana1-3(NeuAca2- |
| 3(NeuGca2-3/6Galb1-4GlcNAcb1-2Mana1-6)Manb1- | 8NeuGca2-3/6Galb1-4GlcNAcb1-2Mana1-6)Manb1- |
| 4GlcNAcb1-4(Fuca1-6)GlcNAc | 4GlcNAcb1-4GlcNAc |
| GlcNAcb1-4(NeuGca2-8NeuGca2-3/6Galb1- | NeuGca2-6/3Galb1-4GlcNAcb1-2Mana1- |
| 4(Fuca1-3)GlcNAcb1-2Mana1-3)(Mana1-3Mana1- | 3(NeuGca2-6/3Galb1-4GlcNAcb1-2Mana1-6)Manb1- |
| 6)Manb1-4GlcNAcb1-4GlcNAc | 4GlcNAcb1-4(Fuca1-6)GlcNAcb |
| GlcNAcb1-4(GalNAc[4S]b1-4GlcNAcb1-2Mana1- | NeuAca2-3/6Galb1-4GlcNAcb1-2(Galb1-4GlcNAcb1- |
| 3)(NeuAca2-6Galb1-4GlcNAcb1-2Mana1-6)Manb1- | 4)Mana1-3(Mana1-3(Mana1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4(Fuca1- | NeuGca2-3/6Galb1-4(Fuca1-3)GlcNAcb1- |
| 3)GlcNAcb1-2Mana1-3)(Mana1-3(Mana1-6)Mana1- | 2(GlcNAcb1-4)Mana1-3(Mana1-3(Mana1-6)Mana1- |
| 6)Manb1-4GlcNAcb1-4(Fuca1-6)GlcNAc | 6)Manb1-4GlcNAcb1-4(Fuca1-6)GlcNAc |
| NeuAca2-3GalNAcb1-4GlcNAcb1-2Mana1- | GlcNAcb1-2(NeuAca2-3Galb1-3(NeuAca2- |
| 3(NeuAca2-3Galb1-3GlcNAcb1-2Mana1-6)Manb1- | 6)GlcNAcb1-4)Mana1-3(GlcNAcb1-2Mana1- |
| 4GlcNAcb1-4(Fuca1-6)GlcNAcb | 6)Manb1-4GlcNAcb1-4(Fuca1-6)GlcNAc |
| NeuAca2-6GalNAcb1-4GlcNAcb1-2Mana1- | NeuAca2-6GalNAcb1-4GlcNAcb1-2Mana1- |
| 3(NeuAca2-3Galb1-4GlcNAcb1-2Mana1-6)Manb1- | 3(NeuAca2-6Galb1-4GlcNAcb1-2Mana1-6)Manb1- |
| 4GlcNAcb1-4(Fuca1-6)GlcNAcb | 4GlcNAcb1-4(Fuca1-6)GlcNAcb |
| GlcNAcb1-4(NeuAca2-8NeuAca2-3/6Galb1-4(Fuca1- | GlcNAcb1-4(NeuAca2-8NeuAca2-3/6Galb1- |
| 3)GlcNAcb1-2Mana1-3)(GlcNAcb1-2Mana1- | 4GlcNAcb1-2Mana1-3)(GlcNAcb1-2Mana1- |
| 6)Manb1-4GlcNAcb1-4GlcNAc | 6)Manb1-4GlcNAcb1-4(Fuca1-6)GlcNAc |
| NeuAca2-3/6Galb1-4(Fuca1-3)GlcNAcb1-2Mana1- | GlcNAcb1-4(NeuAca2-3/6Galb1-4(Fuca1- |
| 3(GalNAcb1-4(Fuca1-3)GlcNAcb1-2Mana1- | 3)GlcNAcb1-2Mana1-3)(Fuca1-3GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(Galb1-4GlcNAcb1-2(GlcNAcb1- | GalNAcb1-4GlcNAcb1-2(Galb1-4GlcNAcb1- |
| 4)Mana1-3)(Galb1-4GlcNAcb1-2(Galb1-4GlcNAcb1- | 4)Mana1-3(Galb1-4GlcNAcb1-2(Galb1-4GlcNAcb1- |
| 6)Mana1-6)Manb1-4GlcNAcb1-4GlcNAc | 6)Mana1-6)Manb1-4GlcNAcb1-4GlcNAc |
| Gala1-3Galb1-4GlcNAcb1-2Mana1-3(NeuGca2- | GlcNAcb1-4(NeuGca2-8NeuGca2-3/6Galb1- |
| 8NeuGca2-3/6Galb1-4GlcNAcb1-2Mana1-6)Manb1- | 4GlcNAcb1-2Mana1-3)(Mana1-3(Mana1-6)Mana1- |
| 4GlcNAcb1-4GlcNAc | 6)Manb1-4GlcNAcb1-4GlcNAc |
| NeuAca2-3/6Galb1-4GlcNAcb1-2(Gala1-3Galb1- | NeuGca2-3/6Galb1-4GlcNAcb1-2(Galb1-4GlcNAcb1- |
| 4GlcNAcb1-4)Mana1-3(Mana1-3(Mana1-6)Mana1- | 4)Mana1-3(Mana1-3(Mana1-6)Mana1-6)Manb1- |
| 6)Manb1-4GlcNAcb1-4GlcNAc | 4GlcNAcb1-4(Fuca1-6)GlcNAc |
| Gala1-3(Fuca1-2)Galb1-4GlcNAcb1-3Galb1- | GlcNAcb1-4(NeuAca2-8NeuGca2-3/6Galb1- |
| 4GlcNAcb1-3(Gala1-3(Fuca1-2)Galb1-4GlcNAcb1- | 4(Fuca1-3)GlcNAcb1-2Mana1-3)(GlcNAcb1- |
| 6)Galb1-4GlcNAcb1-3Galb1-4Glcb | 2Mana1-6)Manb1-4GlcNAcb1-4GlcNAc |
| GlcNAcb1-4(NeuAca2-6Galb1-4GlcNAcb1-2Mana1- | GlcNAcb1-4(NeuAca2-3/6Galb1-4GlcNAcb1- |
| 3)(NeuAca2-6Galb1-4GlcNAcb1-2Mana1-6)Manb1- | 2Mana1-3)(NeuAca2-3/6Galb1-4GlcNAcb1-2Mana1- |
| 4GlcNAcb1-4GlcNAcb | 6)Manb1-4GlcNAcb1-4GlcNAc |
| GlcNAcb1-4(NeuAca2-8NeuGca2-3/6Galb1- | NeuAca2-3Galb1-3GlcNAcb1-2(GlcNAcb1-4)Mana1- |
| 4GlcNAcb1-2Mana1-3)(GlcNAcb1-2Mana1- | 3(NeuAca2-3Galb1-3GlcNAcb1-2Mana1-6)Manb1- |
| 6)Manb1-4GlcNAcb1-4(Fuca1-6)GlcNAc | 4GlcNAcb1-4GlcNAc |
| GlcNAcb1-4(NeuAca2-6Galb1-4GlcNAcb1-2Mana1- | GlcNAcb1-4(NeuAca2-3Galb1-4GlcNAcb1-2Mana1- |
| 3)(NeuAca2-6Galb1-4GlcNAcb1-2Mana1-6)Manb1- | 3)(NeuAca2-3Galb1-4GlcNAcb1-2Mana1-6)Manb1- |
| 4GlcNAcb1-4GlcNAc | 4GlcNAcb1-4GlcNAc |
| NeuGca2-3/6Galb1-4(Fuca1-3)GlcNAcb1-2Mana1- | GlcNAcb1-4(NeuAca2-3/6Galb1-4(Fuca1- |
| 3(GalNAcb1-4(Fuca1-3)GlcNAcb1-2Mana1- | 3)GlcNAcb1-2Mana1-3)(Galb1-4(Fuca1- |
| 6)Manb1-4GlcNAcb1-4(Fuca1-6)GlcNAc | 3)GlcNAcb1-2Mana1-6)Manb1-4GlcNAcb1-4GlcNAc |
| GlcNAcb1-4(Galb1-4(Fuca1-3)GlcNAcb1-2Mana1- | GlcNAcb1-4(NeuGca2-3/6Galb1-4(Fuca1- |
| 3)(NeuAca2-3/6Galb1-4GlcNAcb1-2Mana1- | 3)GlcNAcb1-2Mana1-3)(Fuca1-3GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(Fuca1-2Galb1-4(Fuca1-3)GlcNAcb1- | GlcNAcb1-4(Fuca1-2Galb1-4(Fuca1-3)GlcNAcb1- |
| 2Mana1-3)(Fuca1-2Galb1-4(Fuca1-3)GlcNAcb1- | 2Mana1-3)(Galb1-4(Fuca1-3)GlcNAcb1-2Mana1- |
| 2Mana1-6)Manb1-4GlcNAcb1-4GlcNAc | 6)Manb1-4GlcNAcb1-4(Fuca1-6)GlcNAc |
| NeuGca2-3/6Galb1-4GlcNAcb1-2(Gala1-3Galb1- | Gala1-3Galb1-4Galb1-4GlcNAcb1-2Mana1-3(Gala1- |
| 4GlcNAcb1-4)Mana1-3(Mana1-3(Mana1-6)Mana1- | 3Galb1-4Galb1-4GlcNAcb1-2Mana1-6)Manb1- |
| 6)Manb1-4GlcNAcb1-4GlcNAc | 4GlcNAcb1-4(Fuca1-6)GlcNAc |
| Gala1-3Galb1-4GlcNAcb1-2(Gala1-3Galb1- | |
| 4GlcNAcb1-4)Mana1-3(Mana1-3(Mana1-6)Mana1- | |
| 6)Manb1-4GlcNAcb1-4(Fuca1-6)GlcNAc | |
| | GlcNAcb1-3Galb1-4GlcNAcb1-2(GlcNAcb1-4)Mana1- |
| | 3(GalNAcb1-4GlcNAcb1-2(GlcNAcb1-6)Mana1- |
| | 6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-8NeuGca2-3/6Galb1- |
| 2Mana1-3)(NeuAca2-3/6Galb1-4GlcNAcb1-2Mana1- | 4(Fuca1-3)GlcNAcb1-2Mana1-3)(GlcNAcb1- |
| 6)Manb1-4GlcNAcb1-4GlcNAc | 2Mana1-6)Manb1-4GlcNAcb1-4GlcNAc |
| GlcNAcb1-4(NeuGca2-8NeuGca2-3/6Galb1- | GlcNAcb1-4(NeuAca2-3/6Galb1-4(Fuca1- |
| 4GlcNAcb1-2Mana1-3)(GlcNAcb1-2Mana1- | 3)GlcNAcb1-2(GlcNAcb1-4)Mana1-3)(Mana1- |
| 6)Manb1-4GlcNAcb1-4(Fuca1-6)GlcNAc | 3(Mana1-6)Mana1-6)Manb1-4GlcNAcb1-4GlcNAc |
| GlcNAcb1-4(NeuGca2-3/6Galb1-4(Fuca1- | GlcNAcb1-4(Galb1-4(Fuca1-3)GlcNAcb1-2Mana1- |
| 3)GlcNAcb1-2Mana1-3)(Galb1-4(Fuca1- | 3)(NeuGca2-3/6Galb1-4GlcNAcb1-2Mana1- |
| 3)GlcNAcb1-2Mana1-6)Manb1-4GlcNAcb1-4GlcNAc | 6)Manb1-4GlcNAcb1-4(Fuca1-6)GlcNAc |
| NeuAca2-3/6Galb1-4GlcNAcb1-2(Galb1-4GlcNAcb1- | GlcNAcb1-4(Gala1-3Galb1-4GlcNAcb1-2Mana1- |
| 4)Mana1-3(Galb1-4GlcNAcb1-2Mana1-6)Manb1- | 3)(NeuAca2-3/6Galb1-4GlcNAcb1-2Mana1- |
| 4GlcNAcb1-4(Fuca1-6)GlcNAc | 6)Manb1-4GlcNAcb1-4(Fuca1-6)GlcNAc |
| NeuAca2-6Galb1-4GlcNAcb1-2(Galb1-4GlcNAcb1- | Galb1-4GlcNAcb1-2(NeuAca2-3Galb1-4GlcNAcb1- |
| 4)Mana1-3(Galb1-4GlcNAcb1-2Mana1-6)Manb1- | 4)Mana1-3(Galb1-4GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2Mana1-3(Galb1-4GlcNAcb1- | NeuAca2-6Galb1-4GlcNAcb1-3Galb1-4GlcNAcb1- |
| 2(NeuAca2-3Galb1-4GlcNAcb1-4)Mana1-6)Manb1- | 2Mana1-3(Galb1-4(Fuca1-3)GlcNAcb1-2Mana1- |
| 4GlcNAcb1-4(Fuca1-6)GlcNAc | 6)Manb1-4GlcNAcb1-4GlcNAc |
| NeuAca2-3Galb1-4GlcNAcb1-2Mana1-3(GlcNAcb1- | Galb1-4(Fuca1-3)GlcNAcb1-2(Galb1-4(Fuca1- |
| 2Mana1-3(GlcNAcb1-2Mana1-6)Mana1-6)Manb1- | 3)GlcNAcb1-4)Mana1-3(Galb1-4(Fuca1- |
| 4GlcNAcb1-4(Fuca1-6)GlcNAcb | 3)GlcNAcb1-2Mana1-6)Manb1-4GlcNAcb1-4GlcNAc |
| Galb1-4GlcNAcb1-2(Galb1-4(Fuca1-3)GlcNAcb1- | Galb1-4(Fuca1-3)GlcNAcb1-2Mana1-3(Galb1- |
| 4)Mana1-3(Galb1-4(Fuca1-3)GlcNAcb1-2Mana1- | 4(Fuca1-3)GlcNAcb1-2(Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| Galb1-4(Fuca1-3)GlcNAcb1-2(Galb1-4GlcNAcb1- | GlcNAcb1-4(Fuca1-2Galb1-4(Fuca1-3)GlcNAcb1- |
| 4)Mana1-3(Galb1-4(Fuca1-3)GlcNAcb1-2Mana1- | 2(Galb1-4GlcNAcb1-4)Mana1-3)(Mana1-3Mana1- |
| 6)Manb1-4GlcNAcb1-4(Fuca1-6)GlcNAc | 6)Manb1-4GlcNAcb1-4(Fuca1-6)GlcNAc |
| NeuAca2-6Galb1-4GlcNAc[6S]b1-2Mana1- | NeuAca2-6Galb1-4GlcNAc[6S]b1-2Mana1- |
| 3(NeuAca2-6Galb1-4GlcNAcb1-2Mana1-6)Manb1- | 3(NeuAca2-3Galb1-4GlcNAcb1-2Mana1-6)Manb1- |
| 4GlcNAcb1-4(Fuca1-6)GlcNAc | 4GlcNAcb1-4(Fuca1-6)GlcNAc |
| NeuAca2-3GalNAcb1-4GlcNAcb1-2Mana1- | NeuAca2-6GalNAcb1-4GlcNAcb1-2Mana1- |
| 3(NeuAca2-3GalNAcb1-4GlcNAcb1-2Mana1- | 3(NeuAca2-6GalNAcb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAcb |
| GalNAca1-3(Fuca1-2)Galb1-3GlcNAcb1- | NeuAca2-3GalNAcb1-4GlcNAcb1-2Mana1- |
| 3(GalNAca1-3(NeuAca2-6)Galb1-3GlcNAcb1- | 3(NeuAca2-3GalNAcb1-4GlcNAcb1-2Mana1- |
| 6)Galb1-4GlcNAcb1-3(NeuAca2-6)GalNAc | 6)Manb1-4GlcNAcb1-4(Fuca1-6)GlcNAcb |
| Galb1-4GlcNAcb1-3Galb1-4GlcNAcb1-2(GlcNAcb1- | GlcNAcb1-2(GlcNAcb1-4)Mana1-3(GlcNAcb1- |
| 4)Mana1-3(GalNAcb1-4GlcNAcb1-2(GlcNAcb1- | 3Galb1-4GlcNAcb1-2(GlcNAcb1-3Galb1-4GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(GlcNAcb1-2(Galb1-4GlcNAcb1- | GlcNAcb1-4(GlcNAcb1-2(Galb1-4GlcNAcb1- |
| 4)Mana1-3)(Galb1-4GlcNAcb1-2(GlcNAcb1- | 4)Mana1-3)(GlcNAcb1-2(Galb1-4GlcNAcb1- |
| 4)(GlcNAcb1-6)Mana1-6)Manb1-4GlcNAcb1- | 4)(GlcNAcb1-6)Mana1-6)Manb1-4GlcNAcb1- |
| 4GlcNAc | 4GlcNAc |
| GalNAcb1-4GlcNAcb1-2(Galb1-4GlcNAcb1- | GlcNAcb1-4(NeuGca2-3/6Galb1-4GlcNAcb1- |
| 4)Mana1-3(GalNAcb1-4GlcNAcb1-2(Galb1- | 2Mana1-3)(NeuGca2-3/6Galb1-4GlcNAcb1-2Mana1- |
| 4GlcNAcb1-6)Mana1-6)Manb1-4GlcNAcb1-4GlcNAc | 6)Manb1-4GlcNAcb1-4GlcNAc |
| GlcNAcb1-4(NeuAca2-3/6Galb1-4GlcNAcb1- | NeuAca2-3/6Galb1-4GlcNAcb1-2(Galb1-4GlcNAcb1- |
| 2(Galb1-4GlcNAcb1-4)Mana1-3)(Mana1-3(Mana1- | 4)Mana1-3(Gala1-3Galb1-4GlcNAcb1-2Mana1- |
| 6)Mana1-6)Manb1-4GlcNAcb1-4GlcNAc | 6)Manb1-4GlcNAcb1-4GlcNAc |
| NeuAca2-3/6Galb1-4GlcNAcb1-2(Gala1-3Galb1- | GlcNAcb1-4(NeuGca2-3/6Galb1-4(Fuca1- |
| 4GlcNAcb1-4)Mana1-3(Galb1-4GlcNAcb1-2Mana1- | 3)GlcNAcb1-2(GlcNAcb1-4)Mana1-3)(Mana1- |
| 6)Manb1-4GlcNAcb1-4GlcNAc | 3(Mana1-6)Mana1-6)Manb1-4GlcNAcb1-4GlcNAc |
| NeuGca2-3/6Galb1-4GlcNAcb1-2(Galb1-4GlcNAcb1- | GlcNAcb1-4(Gala1-3Galb1-4GlcNAcb1-2Mana1- |
| 4)Mana1-3(Galb1-4GlcNAcb1-2Mana1-3)Manb1- | 3)(NeuGca2-3/6Galb1-4GlcNAcb1-2Mana1- |
| 4GlcNAcb1-4(Fuca1-6)GlcNAc | 6)Manb1-4GlcNAcb1-4(Fuca1-6)GlcNAc |
| NeuAca2-6Galb1-4GlcNAcb1-2(Galb1-4GlcNAcb1- | GlcNAcb1-4(Galb1-4(Fuca1-3)GlcNAcb1-2(Galb1- |
| 4)Mana1-3(Galb1-4GlcNAcb1-2(Galb1-4GlcNAcb1- | 4GlcNAcb1-4)Mana1-3)(Mana1-3(Mana1-6)Mana1- |
| 6)Mana1-6)Manb1-4GlcNAc | 6)Manb1-4GlcNAcb1-4(Fuca1-6)GlcNAc |
| | NeuAca2-6Galb1-4GlcNAc[6S]b1-2Mana1- |
| | 3(NeuGca2-6Galb1-4GlcNAcb1-2Mana1-6)Manb1- |
| | 4GlcNAcb1-4(Fuca1-6)GlcNAc |
| NeuGca2-6Galb1-4GlcNAc[6S]b1-2Mana1- | NeuGca2-6Galb1-4GlcNAc[6S]b1-2Mana1- |
| 3(NeuAca2-3Galb1-4GlcNAcb1-2Mana1-6)Manb1- | 3(NeuAca2-6Galb1-4GlcNAcb1-2Mana1-6)Manb1- |
| 4GlcNAcb1-4(Fuca1-6)GlcNAc | 4GlcNAcb1-4(Fuca1-6)GlcNAc |
| NeuAca2-8NeuAca2-3/6Galb1-4GlcNAcb1- | NeuAca2-3/6Galb1-4(Fuca1-3)GlcNAcb1- |
| 2(GlcNAcb1-4)Mana1-3(GlcNAcb1-2(GlcNAcb1- | 2(GlcNAcb1-4)Mana1-3(GlcNAcb1-2(GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | Galb1-4(Fuca1-3)GlcNAcb1-2(Fuca1-3GlcNAcb1- |
| 3)GlcNAcb1-2Mana1-3)(GalNAcb1-4(Fuca1- | 4)Mana1-3(Fuca1-3GlcNAcb1-2(Fuca1-3GlcNAcb1- |
| 3)GlcNAcb1-2Mana1-6)Manb1-4GlcNAcb1-4GlcNAc | 6)Mana1-6)Manb1-4GlcNAcb1-4GlcNAc |
| GlcNAcb1-4(Fuca1-2Galb1-4(Fuca1-3)GlcNAcb1- | NeuAca2-6Galb1-4GlcNAcb1-2(NeuAca2-3Galb1- |
| 2Mana1-3)(GalNAcb1-4(Fuca1-3)GlcNAcb1- | 3(NeuAca2-6)GlcNAcb1-4)Mana1-3(Galb1- |
| 2Mana1-6)Manb1-4GlcNAcb1-4(Fuca1-6)GlcNAc | 4GlcNAcb1-2Mana1-6)Manb1-4 |
| NeuAca2-6Galb1-4GlcNAcb1-2(NeuAca2-3Galb1- | NeuAca2-6Galb1-4GlcNAcb1-2(Galb1-3(NeuAca2- |
| 4GlcNAcb1-4)Mana1-3(NeuAca2-3Galb1- | 6)GlcNAcb1-4)Mana1-3(NeuAca2-6Galb1- |
| 4GlcNAcb1-2Mana1-6)Manb1-4 | 4GlcNAcb1-2Mana1-6)Manb1-4 |
| NeuAca2-6Galb1-4GlcNAcb1-2(NeuAca2-3Galb1- | Galb1-4GlcNAcb1-2(NeuAca2-3Galb1-3(NeuAca2- |
| 4GlcNAcb1-4)Mana1-3(NeuAca2-6Galb1- | 6)GlcNAcb1-4)Mana1-3(NeuAca2-6Galb1- |
| 4GlcNAcb1-2Mana1-6)Manb1-4 | 4GlcNAcb1-2Mana1-6)Manb1-4 |
| NeuAca2-6Galb1-4GlcNAcb1-2(NeuAca2-3Galb1- | NeuAca2-8NeuAca2-3/6Galb1-4(Fuca1-3)GlcNAcb1- |
| 3GlcNAcb1-4)Mana1-3(NeuAca2-3Galb1- | 2Mana1-3(Mana1-3(Mana1-6)Mana1-6)Manb1- |
| 4GlcNAcb1-2Mana1-6)Manb1-4 | 4GlcNAcb1-4(Fuca1-6)GlcNAc |
| Neua1-6Galb1-4GlcNAcb1-3Galb1-4GlcNAcb1- | GlcNAcb1-4(NeuGca2-3/6Galb1-4GlcNAcb1- |
| 2Mana1-3(Galb1-4(Fuca1-3)GlcNAcb1-2Mana1- | 2(Galb1-4GlcNAcb1-4)Mana1-3)(Mana1-3(Mana1- |
| 6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2Mana1-3(Gala1-3Galb1- | Gala1-3Galb1-4GlcNAcb1-2(Gala1-3Galb1- |
| 4GlcNAcb1-3Galb1-4GlcNAcb1-2Mana1-6)Manb1- | 4GlcNAcb1-4)Mana1-3(Galb1-4GlcNAcb1-2Mana1- |
| 4GlcNAcb1-4(Fuca1-6)GlcNAc | 6)Manb1-4GlcNAcb1-4(Fuca1-6)GlcNAc |
| GlcNAcb1-4(Gala1-3Galb1-4GlcNAcb1-2(Galb1- | Gala1-3Galb1-4GlcNAcb1-2(Galb1-4GlcNAcb1- |
| 4GlcNAcb1-4)Mana1-3)(Mana1-3(Mana1-6)Mana1- | 4)Mana1-3(Gala1-3Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAcb |
| Galb1-4GlcNAcb1-2Mana1-3(Galb1-3Galb1- | Galb1-4GlcNAcb1-2Mana1-3(Gala1-3Galb1- |
| 4GlcNAcb1-2(Galb1-3Galb1-4GlcNAcb1-4)Mana1- | 4GlcNAcb1-2(Gala1-3Galb1-4GlcNAcb1-6)Mana1- |
| 6)Manb1-4GlcNAcb1-4(Fuca1-6)GlcNAc | 6)Manb1-4GlcNAcb1-4(Fuca1-6)GlcNAc |
| Galb1-4GlcNAcb1-2(Gala1-3Galb1-4GlcNAcb1- | GalNAcb1-4GlcNAcb1-2(GlcNAcb1-4)Mana1- |
| 4)Mana1-3(Gala1-3Galb1-4GlcNAcb1-2Mana1- | 3(GalNAcb1-4GlcNAcb1-2(GalNAcb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| NeuGca2-6Galb1-4GlcNAc[6S]b1-2Mana1- | NeuAca2-8NeuGca2-3/6Galb1-4GlcNAcb1- |
| 3(NeuGca2-6Galb1-4GlcNAcb1-2Mana1-6)Manb1- | 2(GlcNAcb1-4)Mana1-3(GlcNAcb1-2(GlcNAcb1- |
| 4GlcNAcb1-4(Fuca1-6)GlcNAc | 6)Mana1-6)Manb1-4GlcNAcb1-4GlcNAc |
| GlcNAcb1-4(NeuGca2-3/6Galb1-4(Fuca1- | NeuGca2-3/6Galb1-4(Fuca1-3)GlcNAcb1- |
| 3)GlcNAcb1-2Mana1-3)(GalNAcb1-4(Fuca1- | 2(GlcNAcb1-4)Mana1-3(GlcNAcb1-2(GlcNAcb1- |
| 3)GlcNAcb1-2Mana1-6)Manb1-4GlcNAcb1-4GlcNAc | 6)Mana1-6)Manb1-4GlcNAcb1-4(Fuca1-6)GlcNAc |
| GlcNAcb1-4(Galb1-4(Fuca1-3)GlcNAcb1-2(Galb1- | GlcNAcb1-4(Galb1-4(Fuca1-3)GlcNAcb1-2(Galb1- |
| 4GlcNAcb1-4)Mana1-3)(Fuca1-3GlcNAcb1-2Mana1- | 4(Fuca1-3)GlcNAcb1-4)Mana1-3)(GlcNAcb1- |
| 6)Manb1-4GlcNAcb1-4(Fuca1-6)GlcNAc | 2Mana1-6)Manb1-4GlcNAcb1-4(Fuca1-6)GlcNAc |
| GalNAcb1-4(NeuGca2-3)GalNAcb1-3Galb1-4Galb1- | Glca1-2Glca1-3Glca1-3Mana1-2Mana1-2(Mana1- |
| 3(NeuGca2-8NeuGca2-8NeuGca2-8NeuGca2- | 2Mana1-6)Mana1-3(Mana1-3(Mana1-3Mana1- |
| 6)GalNAc | 2Mana1-6)Mana1-6)Manb1-4GlcNAc |
| Mana1-3Manb1-2Mana1-2(Mana1-3Mana1-3Mana1- | Mana1-3Mana1-2Mana1-2(Mana1-3Mana1-3Mana1- |
| 2Mana1-6)Mana1-3(Mana1-3(Mana1-3Mana1- | 2Mana1-6)Mana1-3(Mana1-3(Mana1-3Mana1- |
| 2Mana1-6)Mana1-6)Manb1-4GlcNAc | 2Mana1-6)Mana1-6)Manb1-4GlcNAc |
| NeuAca2-8NeuGca2-3/6Galb1-4(Fuca1- | GlcNAcb1-4(Kdna1-3Galb1-4GlcNAcb1-2Mana1- |
| 3)GlcNAcb1-2Mana1-3(Mana1-3(Mana1-6)Mana1- | 3)(Kdna1-3Galb1-4GlcNAcb1-2Mana1-6)Manb1- |
| 6)Manb1-4GlcNAcb1-4(Fuca1-6)GlcNAc | 4GlcNAcb1-4(Fuca1-6)GlcNAcb |
| Galb1-3Galb1-4GlcNAcb1-2Mana1-3(Galb1-3Galb1- | Galb1-4GlcNAcb1-2(Galb1-4GlcNAcb1-4)Mana1- |
| 4GlcNAcb1-2(Galb1-3Galb1-4GlcNAcb1-6)Mana1- | 3(Galb1-4GlcNAcb1-2(Galb1-4GlcNAcb1-3Galb1- |
| 6)Manb1-4GlcNAcb1-4GlcNAc | 4GlcNAcb1-6)Mana1-6)Manb1-4Glcb |
| | Galb1-4GlcNAcb1-2(Galb1-4GlcNAcb1-4)Mana1- |
| | 3(Galb1-4GlcNAcb1-3Galb1-4GlcNAcb1-2(Galb1- |
| | 4GlcNAcb1-6)Mana1-6)Manb1-4Glcb |
| Galb1-4GlcNAcb1-3Galb1-4GlcNAcb1-2(Galb1- | GlcNAcb1-4(Gala1-3Galb1-4GlcNAcb1-2(Gala1- |
| 4GlcNAcb1-4)Mana1-3(Galb1-4GlcNAcb1-2(Galb1- | 3Galb1-4GlcNAcb1-4)Mana1-3)(Mana1-3(Mana1- |
| 4GlcNAcb1-6)Mana1-6)Manb1-4Glcb | 6)Mana1-6)Manb1-4GlcNAcb1-4GlcNAc |
| Galb1-4GlcNAcb1-2(Galb1-4GlcNAcb1-3Galb1- | GlcNAcb1-4(GlcNAcb1-3Galb1-4GlcNAcb1- |
| 4GlcNAcb1-4)Mana1-3(Galb1-4GlcNAcb1-2(Galb1- | 2(GlcNAcb1-4)Mana1-3)(GalNAcb1-4GlcNAcb1- |
| 4GlcNAcb1-6)Mana1-6)Manb1-4Glcb | 2(GlcNAcb1-6)Mana1-6)Manb1-4GlcNAcb1-4GlcNAc |
| GalNAcb1-4GlcNAcb1-2(Galb1-4GlcNAcb1- | NeuGca2-8NeuGca2-3/6Galb1-4GlcNAcb1- |
| 4)Mana1-3(GalNAcb1-4GlcNAcb1-2(GalNAcb1- | 2(GlcNAcb1-4)Mana1-3(GlcNAcb1-2(GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| NeuAca2-3/6Galb1-4GlcNAcb1-2(GlcNAcb1- | GlcNAcb1-4(Galb1-4(Fuca1-3)GlcNAcb1-2(Galb1- |
| 4)Mana1-3(Galb1-4GlcNAcb1-2(Galb1-4GlcNAcb1- | 4GlcNAcb1-4)Mana1-3)(Galb1-4GlcNAcb1-2Mana1- |
| 6)Mana1-6)Manb1-4GlcNAcb1-4GlcNAc | 6)Manb1-4GlcNAcb1-4(Fuca1-6)GlcNAc |
| Galb1-4(Fuca1-3)GlcNAcb1-2(GlcNAcb1-4)Mana1- | Galb1-4(Fuca1-3)GlcNAcb1-2(GlcNAcb1-4)Mana1- |
| 3(Galb1-4GlcNAcb1-2(Galb1-4(Fuca1-3)GlcNAcb1- | 3(Galb1-4GlcNAcb1-2(Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-8NeuGca2-3/6Galb1-4(Fuca1- | NeuAca2-4Galb1-3(NeuAca2-6)GlcNAcb1-2Mana1- |
| 3)GlcNAcb1-2Mana1-3(Mana1-3(Mana1-6)Mana1- | 3(NeuAca2-6Galb1-4GlcNAcb1-2Mana1-6)Manb1- |
| 6)Manb1-4GlcNAcb1-4(Fuca1-6)GlcNAc | 4GlcNAcb1-4GlcNAc |
| NeuAca2-4Galb1-3(NeuAca2-6)GlcNAcb1-2Mana1- | NeuAca2-3Galb1-3(NeuAca2-6)GlcNAcb1-2Mana1- |
| 3(NeuAca2-4Galb1-3GlcNAcb1-2Mana1-6)Manb1- | 3(NeuAca2-6Galb1-3GlcNAcb1-2Mana1-6)Manb1- |
| 4GlcNAcb1-4GlcNAcb | 4GlcNAcb1-4GlcNAc |
| NeuAca2-3Galb1-3(NeuAca2-6)GlcNAcb1-2Mana1- | NeuAca2-3Galb1-3(NeuAca2-6)GlcNAcb1-2Glca1- |
| 3(NeuAca2-6Galb1-4GlcNAcb1-2Mana1-6)Manb1- | 3(NeuAca2-6Galb1-4GlcNAcb1-2Glca1-6)Manb1- |
| 4GlcNAcb1-4GlcNAc | 4GlcNAcb1-4GlcNAcb |
| NeuAca2-8NeuAca2-3/6Galb1-4GlcNAcb1-2Mana1- | NeuAca2-3Galb1-3(NeuAca2-6)GlcNAcb1-2Mana1- |
| 3(NeuAca2-3/6Galb1-4GlcNAcb1-2Mana1-6)Manb1- | 3(NeuAca2-3Galb1-4GlcNAcb1-2Mana1-6)Manb1- |
| 4GlcNAcb1-4GlcNAc | 4GlcNAcb1-4GlcNAcb |
| | NeuAca2-3Galb1-3(NeuAca2-6)GlcNAcb1-2Mana1- |
| | 3(NeuAca2-3Galb1-3GlcNAcb1-2Mana1-6)Manb1 |
| | 4GlcNAcb1-4GlcNAcb |
| NeuAca2-3Galb1-3(NeuAca2-6)GlcNAcb1-2Mana1- | NeuAca2-3/6Galb1-4(Fuca1-3)GlcNAcb1-2Mana1- |
| 3(NeuAca2-6Galb1-4GlcNAcb1-2Mana1-6)Manb1- | 3(NeuAca2-3/6Galb1-4GlcNAcb1-2Mana1-6)Manb1- |
| 4GlcNAcb1-4GlcNAcb | 4GlcNAcb1-4(Fuca1-6)GlcNAc |
| GlcNAcb1-4(NeuAca2-8NeuAca2-3/6Galb1-4(Fuca1- | NeuAca2-3/6Galb1-4(Fuca1-3)GlcNAcb1-2Mana1- |
| 3)GlcNAcb1-2Mana1-3)(Mana1-3Mana1-6)Manb1- | 3(NeuAca2-3/6Galb1-4(Fuca1-3)GlcNAcb1-2Mana1- |
| 4GlcNAcb1-4(Fuca1-6)GlcNAc | 6)Manb1-4GlcNAcb1-4GlcNAc |
| NeuGca2-3/6Galb1-4GlcNAcb1-2(GlcNAcb1- | NeuAca2-3/6Galb1-4(Fuca1-3)GlcNAcb1-2Mana1- |
| 4)Mana1-3(Galb1-4GlcNAcb1-2(Galb1-4GlcNAcb1- | 3(Fuca1-2Galb1-4(Fuca1-3)GlcNAcb1-2Mana1- |
| 6)Mana1-6)Manb1-4GlcNAcb1-4GlcNAc | 6)Manb1-4GlcNAcb1-4(Fuca1-6)GlcNAc |
| Galb1-4GlcNAcb1-2(Galb1-4GlcNAcb1-4)Mana1- | Galb1-4GlcNAcb1-2(Galb1-4GlcNAcb1-4)Mana1- |
| 3(Galb1-4GlcNAcb1-2(Galb1-4GlcNAcb1-6)Mana1- | 3(Galb1-4GlcNAcb1-2(Galb1-3GlcNAcb1-6)Mana1- |
| 6)Manb1-4GlcNAcb1-4(Fuca1-6)GlcNAcb | 6)Manb1-4GlcNAcb1-4(Fuca1-6)GlcNAc |
| Galb1-4GlcNAcb1-2(Galb1-4GlcNAcb1-4)Mana1- | GalNAcb1-4GlcNAcb1-2(Gala1-3Galb1-4GlcNAcb1- |
| 3(Galb1-4GlcNAcb1-2(Galb1-4GlcNAcb1-6)Mana1- | 4)Mana1-3(Gala1-3Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAcb |
| Galb1-4GlcNAcb1-2Galb1-4GlcNAcb1-2Mana1- | Galb1-4GlcNAcb1-2(Galb1-4GlcNAcb1-4)Mana1- |
| 3(Galb1-4GlcNAcb1-2Galb1-4GlcNAcb1-2Mana1- | 3/6(Galb1-4GlcNAcb1-2(Galb1-4GlcNAcb1- |
| 6)Manb1-4GlcNAcb1-4(Fuca1-6)GlcNAc | 6)Mana1-6/3)Manb1-4GlcNAcb1-4(Fuca1-6)GlcNAc |
| Galb1-4GlcNAcb1-2(Galb1-4GlcNAcb1-6)Mana1- | Galb1-4GlcNAcb1-2(Galb1-4GlcNAcb1-4)Mana1- |
| 3(Galb1-4GlcNAcb1-2(Galb1-4GlcNAcb1-4)Mana1- | 3(Galb1-4GlcNAcb1-2(Galb1-4GlcNAcb1-6)Mana1- |
| 6)Manb1-4GlcNAcb1-4(Fuca1-6)GlcNAc | 6)Manb1-4GlcNAcb1-4(Fuca1-6)GlcNAc |
| Galb1-4GlcNAcb1-2(Galb1-4(Fuca1-3)GlcNAcb1- | Galb1-4(Fuca1-3)GlcNAcb1-2(Galb1-4GlcNAcb1- |
| 4)Mana1-3(Galb1-4GlcNAcb1-2(Galb1-4GlcNAcb1- | 4)Mana1-3(Galb1-4GlcNAcb1-2(Galb1-4GlcNAcb1- |
| 6)Mana1-6)Manb1-4GlcNAcb1-4GlcNAc | 6)Mana1-6)Manb1-4GlcNAcb1-4GlcNAc |
| | Galb1-4GlcNAcb1-2(Galb1-4GlcNAcb1-4)Mana1- |
| | 6(Galb1-4GlcNAcb1-2(Galb1-4(Fuca1-3)GlcNAcb1- |
| | 4)Manb1-3)Manb1-4GlcNAcb1-4GlcNAc |
| Galb1-4GlcNAcb1-2(Galb1-3GlcNAcb1-4)Mana1- | Galb1-4GlcNAcb1-2(Galb1-4(Fuca1-3)GlcNAcb1- |
| 3(Galb1-4GlcNAcb1-2(Galb1-4GlcNAcb1-6)Mana1- | 4)Mana1-3(Galb1-4GlcNAcb1-2(Galb1-4GlcNAcb1- |
| 6)Manb1-4GlcNAcb1-4(Fuca1-6)GlcNAc | 6)Mana1-6)Manb1-4GlcNAcb1-4GlcNAc |
| Galb1-4GlcNAcb1-2(Galb1-3GlcNAcb1-4)Mana1- | Galb1-4GlcNAcb1-2(Galb1-4(Fuca1-3)GlcNAcb1- |
| 3(Galb1-4GlcNAcb1-2(Galb1-4GlcNAcb1-6)Mana1- | 4)Mana1-3(Galb1-4GlcNAcb1-2(Galb1-4GlcNAcb1- |
| 6)Manb1-4GlcNAcb1-4(Fuca1-6)GlcNAc | 6)Mana1-6)Manb1-4GlcNAcb1-4GlcNAc |
| Galb1-4GlcNAca1-2(Galb1-4GlcNAcb1-4)Mana1- | Galb1-4GlcNAca1-2(Galb1-4(Fuca1-3)GlcNAcb1- |
| 3(Galb1-4GlcNAcb1-2(Galb1-4GlcNAcb1-6)Mana1- | 4)Mana1-3(Galb1-4GlcNAcb1-2(Glca1-4GalNAcb1- |
| 6)Manb1-4GlcNAcb1-4(Fuca1-6)GlcNAc | 6)Mana1-6)Manb1-4GlcNAcb1-4GlcNAcb |
| Galb1-4GlcNAcb1-2Mana1-3(Galb1-4GlcNAcb1- | Galb1-4GlcNAcb1-3Galb1-4GlcNAcb1-2Mana1- |
| 3Galb1-4GlcNAcb1-3Galb1-4GlcNAcb1-2Mana1- | 3(Galb1-4GlcNAcb1-3Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| Galb1-4GlcNAcb1-3Galb1-4GlcNAcb1-3Galb1- | Galb1-4GlcNAc[6S]b1-3Galb1-4GlcNAc[6S]b1- |
| 4GlcNAcb1-2Mana1-3(Galb1-4GlcNAcb1-2Mana1- | 3Galb1-4GlcNAc[6S]b1-3Galb1-4GlcNAc[6S]b1- |
| 6)Manb1-4GlcNAcb1-4(Fuca1-6)GlcNAc | 3Galb1-4GlcNAcb1-3Galb1-3GalNAc |
| GlcNAcb1-4(NeuAca2-3/6Galb1-4(Fuca1- | GlcNAcb1-4(NeuAca2-3/6Galb1-4GlcNAcb1- |
| 3)GlcNAcb1-2(GlcNAcb1-4)Mana1-3)(GlcNAcb1- | 2(GlcNAcb1-4)Mana1-3)(GlcNAcb1-2(GlcNAcb1- |
| 2(GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-8NeuGca2-3/6Galb1-4GlcNAcb1-2Mana1- | Mana1-2Mana1-2(Mana1-2(Mana1-6)Mana1- |
| 3(NeuAca2-3/6Galb1-4GlcNAcb1-2Mana1-6)Manb1- | 6Mana1-6Mana1-6)Mana1-3(Mana1-3(Mana1- |
| 4GlcNAcb1-4GlcNAc | 2Mana1-6)Mana1-6)Manb1-4GlcNAcb1-4GlcNAcb |
| Mana1-2Mana1-2Mana1-2Mana1-3(Mana1-2Mana1- | Mana1-3Mana1-2Mana1-2(Mana1-3Mana1-2Mana1- |
| 2Mana1-3(Mana1-2Mana1-2Mana1-2Mana1- | 6)Mana1-3(Mana1-3(Mana1-3Mana1-2Mana1- |
| 6)Mana1-6)Manb1-4GlcNAcb1-4GlcNAc | 6)Mana1-6)Manb1-4GlcNAcb1-4GlcNAc |
| Mana1-3Mana1-2Mana1-2(Mana1-3Mana1-2Mana1- | NeuAca2-3(NeuAca2-6)Galb1-4GlcNAcb1-2Mana1- |
| 6)Mana1-3(Mana1-3(Mana1-3Mana1-2Mana1- | 3(Gala1-3Galb1-4GlcNAcb1-2Mana1-6)Manb1- |
| 6)Mana1-6)Manb1-4GlcNAcb1-4GlcNAcb | 4GlcNAcb1-4(Fuca1-6)GlcNAc |
| NeuGca2-3/6Galb1-4(Fuca1-3)GlcNAcb1-2Mana1- | GlcNAcb1-4(NeuAca2-8NeuAca2-3/6Galb1-4(Fuca1- |
| 3(NeuAca2-3/6Galb1-4GlcNAcb1-2Mana1-6)Manb1- | 3)GlcNAcb1-2Mana1-3)(Mana1-3(Mana1-6)Mana1- |
| 4GlcNAcb1-4(Fuca1-6)GlcNAc | 6)Manb1-4GlcNAcb1-4GlcNAc |
| Gala1-3Galb1-4GlcNAcb1-2Mana1-3(NeuAca2- | GlcNAcb1-4(NeuAca2-8NeuGca2-3/6Galb1- |
| 8NeuAca2-3/6Galb1-4GlcNAcb1-2Mana1-6)Manb1- | 4(Fuca1-3)GlcNAcb1-2Mana1-3)(Mana1-3Mana1- |
| 4GlcNAcb1-4(Fuca1-6)GlcNAc | 6)Manb1-4GlcNAcb1-4(Fuca1-6)GlcNAc |
| GlcNAcb1-4(NeuAca2-8NeuAca2-3/6Galb1- | NeuGca2-3/6Galb1-4(Fuca1-3)GlcNAcb1-2Mana1- |
| 4GlcNAcb1-2Mana1-3)(Mana1-3(Mana1-6)Mana1- | 3(NeuAca2-3/6Galb1-4(Fuca1-3)GlcNAcb1-2Mana1- |
| 6)Manb1-4GlcNAcb1-4(Fuca1-6)GlcNAc | 6)Manb1-4GlcNAcb1-4GlcNAc |
| NeuAca2-3(NeuAca2-6)Galb1-4GlcNAcb1-2Mana1- | NeuGca2-3/6Galb1-4(Fuca1-3)GlcNAcb1-2Mana1- |
| 3(Gala1-3Galb1-4GlcNAcb1-2Mana1-6)Manb1- | 3(Fuca1-2Galb1-4(Fuca1-3)GlcNAcb1-2Mana1- |
| 4GlcNAcb1-4(Fuca1-6)GlcNAcb | 6)Manb1-4GlcNAcb1-4(Fuca1-6)GlcNAc |
| Galb1-4GlcNAcb1-3Galb1-4GlcNAcb1-3Galb1- | Gala1-3Galb1-4GlcNAcb1-2(Galb1-4GlcNAcb1- |
| 4GlcNAcb1-2Mana1-3(Galb1-3Galb1-4GlcNAcb1- | 4)Mana1-3(Galb1-4GlcNAcb1-2(Galb1-4GlcNAcb1- |
| 2Mana1-6)Manb1-4GlcNAcb1-4GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(GlcNAcb1-4)Mana1-3)(GlcNAcb1- | 2(GlcNAcb1-4)Mana1-3)(GlcNAcb1-2(GlcNAcb1- |
| 2(GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-6Galb1-4GlcNAcb1-2Mana1-3(NeuAca2- | NeuGca2-8NeuGca2-3/6Galb1-4GlcNAcb1-2Mana1- |
| 6Galb1-4GlcNAcb1-2Mana1-6)Manb1-4GlcNAcb1- | 3(NeuAca2-3/6Galb1-4GlcNAcb1-2Mana1-6)Manb1- |
| 4(Fuca1-6)GlcNAcbNeuyrosine-Boc | 4GlcNAcb1-4GlcNAc |
| GlcNAcb1-4(NeuGca2-8NeuGca2-3/6Galb1- | GlcNAcb1-4(NeuAca2-8NeuGca2-3/6Galb1- |
| 4(Fuca1-3)GlcNAcb1-2Mana1-3)(Mana1-3Mana1- | 4(Fuca1-3)GlcNAcb1-2Mana1-3)(Mana1-3(Mana1- |
| 6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2Mana1-3(NeuAca2- | NeuGca2-3/6Galb1-4(Fuca1-3)GlcNAcb1-2Mana1- |
| 8NeuGca2-3/6Galb1-4GlcNAcb1-2Mana1-6)Manb1- | 3(NeuGca2-3/6Galb1-4GlcNAcb1-2Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2Mana1- | NeuAca2-3/6Galb1-4GlcNAcb1-2(NeuAca2- |
| 3(NeuGca2-3/6Galb1-4(Fuca1-3)GlcNAcb1- | 3/6Galb1-4GlcNAcb1-4)Mana1-3(Mana1-3(Mana1- |
| 2Mana1-6)Manb1-4GlcNAcb1-4GlcNAc | 6)Mana1-6)Manb1-4GlcNAcb1-4GlcNAc |
| GlcNAcb1-4(NeuAca2-8NeuGca2-3/6Galb1- | NeuAca2-3Galb1-4Galb1-4GlcNAcb1-2Mana1- |
| 4GlcNAcb1-2Mana1-3)(Mana1-3(Mana1-6)Mana1- | 3(NeuAca2-3Galb1-4Galb1-4GlcNAcb1-2Mana1- |
| 6)Manb1-4GlcNAcb1-4(Fuca1-6)GlcNAc | 6)Manb1-4GlcNAcb1-4GlcNAc |
| Galb1-4(NeuAca2-3)Galb1-4GlcNAcb1-2Mana1- | NeuAca2-3/6Galb1-4(Fuca1-3)GlcNAcb1-2(Galb1- |
| 3(Galb1-4(NeuAca2-3)Galb1-4GlcNAcb1-2Mana1- | 4(Fuca1-3)GlcNAcb1-4)Mana1-3(Mana1-3(Mana1- |
| 6)Manb1-4GlcNAcb1-4GlcNAc | 6)Mana1-6)Manb1-4GlcNAcb1-4GlcNAc |
| GlcNAcb1-4(NeuAca2-8NeuAca2-3/6Galb1-4(Fuca1- | NeuAca2-8NeuAca2-3/6Galb1-4(Fuca1-3)GlcNAcb1- |
| 3)GlcNAcb1-2Mana1-3)(GlcNAcb1-2Mana1- | 2Mana1-3(GalNAcb1-4(Fuca1-3)GlcNAcb1-2Mana1- |
| 6)Manb1-4GlcNAcb1-4(Fuca1-6)GlcNAc | 6)Manb1-4GlcNAcb1-4GlcNAc |
| GlcNAcb1-4(Galb1-4(Fuca1-3)GlcNAcb1- | GlcNAcb1-4(Galb1-4GlcNAcb1-2(GlcNAcb1- |
| 2(GlcNAcb1-4)Mana1-3)(Galb1-4GlcNAcb1- | 4)Mana1-3)(Galb1-4GlcNAcb1-2(Galb1-4GlcNAcb1- |
| 2(Galb1-4GlcNAcb1-6)Mana1-6)Manb1-4GlcNAcb1- | 6)Mana1-6)Manb1-4GlcNAcb1-4(Fuca1-6)GlcNAc |
| 4GlcNAc | |
| GlcNAcb1-4(GlcNAcb1-3Galb1-4GlcNAcb1-2(Galb1- | GalNAcb1-4GlcNAcb1-2(Galb1-4GlcNAcb1- |
| 4GlcNAcb1-4)Mana1-3)(Galb1-4GlcNAcb1-2Mana1- | 4)Mana1-3(Galb1-4GlcNAcb1-2(Galb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| NeuGca2-8NeuGca2-3/6Galb1-4GlcNAcb1-2Mana1- | GlcNAcb1-4(NeuGca2-8NeuGca2-3/6Galb1- |
| 3(NeuGca2-3/6Galb1-4GlcNAcb1-2Mana1-6)Manb1- | 4(Fuca1-3)GlcNAcb1-2Mana1-3)(Mana1-3(Mana1- |
| 4GlcNAcb1-4GlcNAc | 6)Mana1-6)Manb1-4GlcNAcb1-4GlcNAc |
| Gala1-3Galb1-4GlcNAcb1-2Mana1-3(NeuGca2- | GlcNAcb1-4(NeuGca2-8NeuGca2-3/6Galb1- |
| 8NeuGca2-3/6Galb1-4GlcNAcb1-2Mana1-6)Manb1- | 4GlcNAcb1-2Mana1-3)(Mana1-3(Mana1-6)Mana1- |
| 4GlcNAcb1-4(Fuca1-6)GlcNAc | 6)Manb1-4GlcNAcb1-4(Fuca1-6)GlcNAc |
| NeuGca2-3/6Galb1-4(Fuca1-3)GlcNAcb1-2(Galb1- | NeuAca2-3/6Galb1-4GlcNAcb1-2(Gala1-3Galb1- |
| 4(Fuca1-3)GlcNAcb1-4)Mana1-3(Mana1-3(Mana1- | 4GlcNAcb1-4)Mana1-3(Mana1-3(Mana1-6)Mana1- |
| 6)Mana1-6)Manb1-4GlcNAcb1-4GlcNAc | 6)Manb1-4GlcNAcb1-4(Fuca1-6)GlcNAc |
| NeuAca2-3/6Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(Mana1-3(Mana1- | 3)GlcNAcb1-2Mana1-3)(NeuAca2-3/6Galb1- |
| 6)Mana1-6)Manb1-4GlcNAcb1-4GlcNAc | 4GlcNAcb1-2Mana1-6)Manb1-4GlcNAcb1-4GlcNAc |
| NeuAca2-8NeuGca2-3/6Galb1-4(Fuca1- | GlcNAcb1-4(NeuAca2-3/6Galb1-4GlcNAcb1- |
| 3)GlcNAcb1-2Mana1-3(GalNAcb1-4(Fuca1- | 2Mana1-3)(NeuAca2-3/6Galb1-4GlcNAcb1-2Mana1- |
| 3)GlcNAcb1-2Mana1-6)Manb1-4GlcNAcb1-4GlcNAc | 6)Manb1-4GlcNAcb1-4(Fuca1-6)GlcNAc |
| GlcNAcb1-4(NeuAca2-8NeuGca2-3/6Galb1- | GlcNAcb1-4(NeuAca2-6Galb1-4GlcNAcb1-2Mana1- |
| 4(Fuca1-3)GlcNAcb1-2Mana1-3)(GlcNAcb1- | 3)(NeuAca2-6Galb1-4GlcNAcb1-2Mana1-6)Manb1- |
| 2Mana1-6)Manb1-4GlcNAcb1-4(Fuca1-6)GlcNAc | 4GlcNAcb1-4(Fuca1-6)GlcNAc |
| NeuAca2-3Galb1-3GlcNAcb1-2Mana1-3(GlcNAcb1- | GlcNAcb1-4(NeuAca2-3Galb1-4GlcNAcb1-2Mana1- |
| 2(NeuAca2-3Galb1-3GlcNAcb1-6)Mana1-6)Manb1- | 3)(NeuAca2-3Galb1-4GlcNAcb1-2Mana1-6)Manb1- |
| 4GlcNAcb1-4(Fuca1-6)GlcNAcb | 4GlcNAcb1-4(Fuca1-6)GlcNAcb |
| GlcNAcb1-4(NeuAca2-3Galb1-4GlcNAcb1-2Mana1- | NeuAca2-3Galb1-3GlcNAcb1-2Mana1-3(GlcNAcb1- |
| 3)(NeuAca2-3Galb1-4GlcNAcb1-2Mana1-6)Manb1- | 2(NeuAca2-3Galb1-3GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuAca2-6Galb1-4GlcNAcb1-2Mana1- | GlcNAcb1-4(NeuAca2-6Galb1-4GlcNAcb1-2Mana1- |
| 3)(NeuAca2-6Galb1-4GlcNAcb1-2Mana1-6)Manb1- | 3)(NeuAca2-6Galb1-4GlcNAcb1-2Mana1-6)Manb1- |
| 4GlcNAcb1-4(Fuca1-6)GlcNAcb | 4GlcNAcb1-4(Fuca1-6)GlcNAc |
| GlcNAcb1-4(NeuAca2-6Galb1-4GlcNAcb1-2Mana1- | GlcNAcb1-4(NeuAca2-6Galb1-4GlcNAcb1-2Mana1- |
| 3)(NeuAca2-6Galb1-4GlcNAcb1-2Mana1-6)Manb1- | 3)(NeuAca2-3Galb1-4GlcNAcb1-2Mana1-6)Manb1- |
| 4GlcNAcb1-4(Fuca1-6)GlcNAc | 4GlcNAcb1-4(Fuca1-6)GlcNAc |
| GlcNAcb1-4(NeuAca2-3/6Galb1-4GlcNAcb1- | GlcNAcb1-4(NeuAca2-3/6Galb1-4(Fuca1- |
| 2Mana1-3)(NeuAca2-3/6Galb1-4GlcNAcb1-2Mana1- | 3)GlcNAcb1-2Mana1-3)(Galb1-4(Fuca1- |
| 6)Manb1-4GlcNAcb1-4(Fuca1-6)GlcNAcb | 3)GlcNAcb1-2Mana1-6)Manb1-4GlcNAcb1-4(Fuca1- |
| | 6)GlcNAc |
| GlcNAcb1-4(NeuAca2-3/6Galb1-4(Fuca1- | |
| 3)GlcNAcb1-2Mana1-3)(Fuca1-2Galb1-4(Fuca1- | |
| 3)GlcNAcb1-2Mana1-6)Manb1-4GlcNAcb1-4GlcNAc | |
| GlcNAcb1-4(Galb1-4GlcNAcb1-2(Galb1-4GlcNAcb1- | GlcNAcb1-4(Fuca1-2Galb1-4(Fuca1-3)GlcNAcb1- |
| 4)Mana1-3)(Galb1-4GlcNAcb1-2(Galb1-4GlcNAcb1- | 2Mana1-3)(Fuca1-2Galb1-4(Fuca1-3)GlcNAcb1- |
| 6)Mana1-6)Manb1-4GlcNAcb1-4GlcNAc | 2Mana1-6)Manb1-4GlcNAcb1-4(Fuca1-6)GlcNAc |
| NeuGca2-3/6Galb1-4GlcNAcb1-2(Gala1-3Galb1- | NeuGca2-3/6Galb1-4(Fuca1-3)GlcNAcb1-2(Gala1- |
| 4GlcNAcb1-4)Mana1-3(Mana1-3(Mana1-6)Mana1- | 3Galb1-4GlcNAcb1-4)Mana1-3(Mana1-3(Mana1- |
| 6)Manb1-4GlcNAcb1-4(Fuca1-6)GlcNAc | 6)Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2Mana1-3)(NeuAca2-3/6Galb1-4GlcNAcb1-2Mana1- | 3)GlcNAcb1-2Mana1-3)(NeuAca2-3/6Galb1- |
| 6)Manb1-4GlcNAcb1-4(Fuca1-6)GlcNAc | 4GlcNAcb1-2Mana1-6)Manb1-4GlcNAcb1-4GlcNAc |
| NeuAca2-6Galb1-4GlcNAcb1-2Mana1-3(NeuAca2- | NeuAca2-3/6Galb1-4GlcNAcb1-2Mana1-3(NeuAca2- |
| 6Galb1-4GlcNAcb1-2(Galb1-4GlcNAcb1-4)Mana1- | 3/6Galb1-4GlcNAcb1-2(Galb1-4GlcNAcb1-6)Mana1- |
| 6)Manb1-4GlcNAcb1-4GlcNAcb | 6)Manb1-4GlcNAcb1-4GlcNAc |
| GlcNAcb1-4(Gala1-3Galb1-4GlcNAcb1-2Mana1- | GlcNAcb1-4(NeuGca2-8NeuGca2-3/6Galb1- |
| 3)(NeuAca2-8NeuAca2-3/6Galb1-4GlcNAcb1- | 4(Fuca1-3)GlcNAcb1-2Mana1-3)(GlcNAcb1- |
| 2Mana1-6)Manb1-4GlcNAcb1-4GlcNAc | 2Mana1-6)Manb1-4GlcNAcb1-4(Fuca1-6)GlcNAc |
| NeuGca2-8NeuGca2-3/6Galb1-4(Fuca1- | NeuAca2-6Galb1-4GlcNAcb1-2(NeuAca2-3Galb1- |
| 3)GlcNAcb1-2Mana1-3(GalNAcb1-4(Fuca1- | 4GlcNAcb1-4)Mana1-3(Galb1-4GlcNAcb1-2Mana1- |
| 3)GlcNAcb1-2Mana1-6)Manb1-4GlcNAcb1-4GlcNAc | 6)Manb1-4GlcNAcb1-4GlcNAc |
| NeuAca2-6Galb1-4GlcNAcb1-2(Galb1-4GlcNAcb1- | Galb1-4GlcNAcb1-2(NeuAca2-3Galb1-4GlcNAcb1- |
| 4)Mana1-3(NeuAca2-3Galb1-4GlcNAcb1-2Mana1- | 4)Mana1-3(NeuAca2-3Galb1-4GlcNAcb1-2Mana1- |
| 6)Manb1-4GlcNAcb1-4GlcNAc | 6)Manb1-4GlcNAcb1-4GlcNAc |
| Galb1-4GlcNAcb1-2Mana1-3(NeuAca2-6Galb1- | NeuAca2-3Galb1-4GlcNAcb1-2(NeuAca2-3Galb1- |
| 4GlcNAcb1-2(NeuAca2-6Galb1-4GlcNAcb1- | 4GlcNAcb1-4)Mana1-3(Galb1-4GlcNAcb1-2Mana1- |
| 4)Mana1-6)Manb1-4GlcNAcb1-4GlcNAc | 6)Manb1-4GlcNAcb1-4GlcNAc |
| NeuAca2-6Galb1-4GlcNAcb1-2(Galb1-4GlcNAcb1- | NeuAca2-6Galb1-4GlcNAcb1-2(NeuAca2-3Galb1- |
| 4)Mana1-3(NeuAca2-6Galb1-4GlcNAcb1-2Mana1- | 4GlcNAcb1-4)Mana1-3(Galb1-4GlcNAcb1-2Mana1- |
| 6)Manb1-4GlcNAcb1-4GlcNAc | 6)Manb1-4GlcNAcb1-4GlcNAcb |
| NeuAca2-3Galb1-4GlcNAcb1-2(Galb1-4GlcNAcb1- | NeuAca2-6Galb1-4GlcNAcb1-2(Galb1-4GlcNAcb1- |
| 4)Mana1-3(NeuAca2-3Galb1-4GlcNAcb1-2Mana1- | 4)Mana1-3(NeuAca2-6Galb1-4GlcNAcb1-2Mana1- |
| 6)Manb1-4GlcNAcb1-4GlcNAc | 6)Manb1-4GlcNAcb1-4GlcNAcb |
| Galb1-4GlcNAcb1-2Mana1-3(NeuAca2-3Galb1- | NeuAca2-3Galb1-4GlcNAcb1-2Mana1-3(NeuAca2- |
| 4GlcNAcb1-2(NeuAca2-3Galb1-4GlcNAcb1- | 3Galb1-4GlcNAcb1-2(Galb1-4GlcNAcb1-6)Mana1- |
| 6)Mana1-6)Manb1-4GlcNAcb1-4GlcNAcb | 6)Manb1-4GlcNAcb1-4GlcNAcb |
| NeuAca2-3Galb1-4GlcNAcb1-2Mana1-3(Galb1- | NeuAca2-3Galb1-4GlcNAcb1-2Mana1-3(NeuAca2- |
| 4GlcNAcb1-2(NeuAca2-3Galb1-4GlcNAcb1- | 3Galb1-4GlcNAcb1-2(Galb1-4GlcNAcb1-4)Mana1- |
| 4)Mana1-6)Manb1-4GlcNAcb1-4GlcNAcb | 6)Manb1-4GlcNAcb1-4GlcNAcb |
| NeuAca2-3Galb1-4GlcNAcb1-2Mana1-3(NeuAca2- | NeuAca2-6Galb1-4GlcNAcb1-2(Galb1-4GlcNAcb1- |
| 3Galb1-4GlcNAcb1-2(Galb1-4GlcNAcb1-6)Mana1- | 4)Mana1-3(NeuAca2-6Galb1-4GlcNAcb1-2Mana1- |
| 6)Manb1-4GlcNAcb1-4GlcNAc | 6)Manb1-4GlcNAcb1-4GlcNAc |
| NeuAca2-3Galb1-4GlcNAcb1-2Mana1-3(Galb1- | NeuAca2-6Galb1-4GlcNAcb1-2(NeuAca2-3Galb1- |
| 4GlcNAcb1-2(NeuAca2-3Galb1-4GlcNAcb1- | 4GlcNAcb1-4)Mana1-3(Galb1-4GlcNAcb1-2Mana1- |
| 6)Mana1-6)Manb1-4GlcNAcb1-4GlcNAcb | 6)Manb1-4GlcNAcb1-4GlcNAc |
| NeuAca2-6Galb1-4GlcNAcb1-2Mana1-3(Galb1- | Galb1-4(Fuca1-3)GlcNAcb1-2Mana1-3(NeuAca2- |
| 4(Fuca1-3)GlcNAcb1-3Galb1-4GlcNAcb1-2Mana1- | 6Galb1-4GlcNAcb1-3Galb1-4(Fuca1-3)GlcNAcb1- |
| 6)Manb1-4GlcNAcb1-4(Fuca1-6)GlcNAc | 2Mana1-6)Manb1-4GlcNAcb1-4GlcNAc |
| NeuAca2-6Galb1-4GlcNAcb1-3Galb1-4GlcNAcb1- | NeuAca2-6Galb1-4GlcNAcb1-2Mana1-3(Galb1- |
| 2Mana1-3(Galb1-4(Fuca1-3)GlcNAcb1-2Mana1- | 4(Fuca1-3)GlcNAcb1-3Galb1-4(Fuca1-3)GlcNAcb1- |
| 6)Manb1-4GlcNAcb1-4(Fuca1-6)GlcNAc | 2Mana1-6)Manb1-4GlcNAcb1-4GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2Mana1-3)(Galb1-4(Fuca1- | 3)GlcNAcb1-2(GlcNAcb1-4)Mana1-3)(Mana1- |
| 3)GlcNAcb1-2Mana1-6)Manb1-4GlcNAcb1-4(Fuca1- | 3(Mana1-6)Mana1-6)Manb1-4GlcNAcb1-4(Fuca1- |
| 6)GlcNAc | 6)GlcNAc |
| GlcNAcb1-4(NeuGca2-3/6Galb1-4(Fuca1- | Galb1-4(Fuca1-3)GlcNAcb1-2Mana1-3(Galb1- |
| 3)GlcNAcb1-2Mana1-3)(Fuca1-2Galb1-4(Fuca1- | 4(Fuca1-3)GlcNAcb1-2(Galb1-4(Fuca1-3)GlcNAcb1- |
| 3)GlcNAcb1-2Mana1-6)Manb1-4GlcNAcb1-4GlcNAc | 6)Mana1-6)Manb1-4GlcNAcb1-4(Fuca1-6)GlcNAc |
| Galb1-4(Fuca1-3)GlcNAcb1-2(Galb1-4(Fuca1- | Galb1-4(Fuca1-3)GlcNAcb1-2(Galb1-4(Fuca1- |
| 3)GlcNAcb1-4)Mana1-3(Galb1-4(Fuca1- | 3)GlcNAcb1-4)Mana1-3(Galb1-4(Fuca1- |
| 3)GlcNAcb1-2Mana1-6)Manb1-4GlcNAcb1-4(Fuca1- | 3)GlcNAcb1-2Mana1-6)Manb1-4GlcNAcb1-4(Fuca1- |
| 6)GlcNAc | 6GlcNAcb |
| GalNAcb1-4GlcNAcb1-2(Galb1-4GlcNAcb1- | Galb1-4GlcNAcb1-3Galb1-4GlcNAcb1-2(GlcNAcb1- |
| 4)Mana1-3(GalNAcb1-4GlcNAcb1-2(Galb1- | 4)Mana1-3(GalNAcb1-4GlcNAcb1-2(GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-2(GlcNAcb1-4)Mana1-3(GlcNAcb1- | GlcNAcb1-4(Gala1-3Galb1-4GlcNAcb1-2Mana1- |
| 3Galb1-4GlcNAcb1-2(GlcNAcb1-3Galb1-4GlcNAcb1- | 3)(NeuAca2-8NeuGca2-3/6Galb1-4GlcNAcb1- |
| 6)Mana1-6)Manb1-4GlcNAcb1-4(Fuca1-6)GlcNAc | 2Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2Mana1-3)(NeuGca2-3/6Galb1-4GlcNAcb1-2Mana1- | 3)GlcNAcb1-2Mana1-3)(NeuGca2-3/6Galb1- |
| 6)Manb1-4GlcNAcb1-4(Fuca1-6)GlcNAc | 4GlcNAcb1-2Mana1-6)Manb1-4GlcNAcb1-4GlcNAc |
| GlcNAcb1-4(NeuAca2-3/6Galb1-4GlcNAcb1- | NeuAca2-3/6Galb1-4GlcNAcb1-2Mana1-3(Gala1- |
| 2(Galb1-4GlcNAcb1-4)Mana1-3)(Mana1-3(Mana1- | 3Galb1-4GlcNAcb1-2(Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4(Fuca1- | NeuAca2-8NeuAca2-3/6Galb1-4GlcNAcb1- |
| 3)GlcNAcb1-2(GlcNAcb1-4)Mana1-3)(Mana1- | 2(GlcNAcb1-4)Mana1-3(GlcNAcb1-2(GlcNAcb1- |
| 3(Mana1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| NeuAca2-8NeuAca2-3/6Galb1-4(Fuca1-3)GlcNAcb1- | GlcNAcb1-4(NeuAca2-3/6Galb1-4(Fuca1- |
| 2(GlcNAcb1-4)Mana1-3(GlcNAcb1-2(GlcNAcb1- | 3)GlcNAcb1-2Mana1-3)(GalNAcb1-4(Fuca1- |
| 6)Mana1-6)Manb1-4GlcNAcb1-4GlcNAc | 3)GlcNAcb1-2Mana1-6)Manb1-4GlcNAcb1-4(Fuca1- |
| | 6)GlcNAc |
| Galb1-4GlcNAcb1-3Galb1-4GlcNAcb1-2(GlcNAcb1- | Galb1-4(Fuca1-3)GlcNAcb1-2(Fuca1-3GlcNAcb1- |
| 4)Mana1-3(GalNAcb1-4GlcNAcb1-2(Galb1- | 4)Mana1-3(Fuca1-3GlcNAcb1-2(Fuca1-3GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3Galb1-3(NeuAca2-6)GlcNAcb1-2Mana1- | GlcNAcb1-4(Gala1-3Galb1-4GlcNAcb1-2Mana1- |
| 3(NeuAca2-6Galb1-4GlcNAcb1-2Mana1-6)Manb1- | 3)(NeuGca2-8NeuGca2-3/6Galb1-4GlcNAcb1- |
| 4Glcb1-4(Fuca1-6)GlcNAcb | 2Mana1-6)Manb1-4GlcNAcb1-4GlcNAc |
| NeuGca2-3/6Galb1-4GlcNAcb1-2Mana1-3(Gala1- | GlcNAcb1-4(NeuGca2-3/6Galb1-4GlcNAcb1- |
| 3Galb1-4GlcNAcb1-2(Galb1-4GlcNAcb1-6)Mana1- | 2(Galb1-4GlcNAcb1-4)Mana1-3)(Mana1-3(Mana1- |
| 6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuAca2-3/6Galb1-4GlcNAcb1- | NeuAca2-8NeuGca2-3/6Galb1-4GlcNAcb1- |
| 2(Gala1-3Galb1-4GlcNAcb1-4)Mana1-3)(Mana1- | 2(GlcNAcb1-4)Mana1-3(GlcNAcb1-2(GlcNAcb1- |
| 3(Mana1-6)Mana1-6)Manb1-4GlcNAcb1-4GlcNAc | 6)Mana1-6)Manb1-4GlcNAcb1-4(Fuca1-6)GlcNAc |
| NeuAca2-8NeuGca2-3/6Galb1-4(Fuca1- | GlcNAcb1-4(NeuGca2-3/6Galb1-4(Fuca1- |
| 3)GlcNAcb1-2(GlcNAcb1-4)Mana1-3(GlcNAcb1- | 3)GlcNAcb1-2Mana1-3)(GalNAcb1-4(Fuca1- |
| 2(GlcNAcb1-6)Mana1-6)Manb1-4GlcNAcb1-4GlcNAc | 3)GlcNAcb1-2Mana1-6)Manb1-4GlcNAcb1-4(Fuca1- |
| | 6)GlcNAc |
| GlcNAcb1-4(NeuAca2-3/6Galb1-4GlcNAcb1- | GlcNAcb1-4(NeuGca2-3/6Galb1-4GlcNAcb1- |
| 2Mana1-3)(GlcNAcb1-2(Galb1-4(Fuca1- | 2(Gala1-3Galb1-4GlcNAcb1-4)Mana1-3)(Mana1- |
| 3)GlcNAcb1-6)Mana1-6)Manb1-4GlcNAcb1- | 3(Mana1-6)Mana1-6)Manb1-4GlcNAcb1-4GlcNAc |
| 4(Fuca1-6)GlcNAc | |
| GlcNAcb1-4(Gala1-3Galb1-4GlcNAcb1-2(Gala1- | Gala1-3Galb1-4GlcNAcb1-2Mana1-3(Gala1-3Galb1- |
| 3Galb1-4GlcNAcb1-4)Mana1-3)(Mana1-3(Mana1- | 4GlcNAcb1-2(Gala1-3Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| Galb1-3Galb1-4GlcNAcb1-2Mana1-3(Galb1-3Galb1- | Gala1-3Galb1-4GlcNAcb1-2(Gala1-3Galb1- |
| 4GlcNAcb1-2(Galb1-3Galb1-4GlcNAcb1-4)Mana1- | 4GlcNAcb1-4)Mana1-3(Gala1-3Galb1-4GlcNAcb1- |
| 6)Manb1-4GlcNAcb1-4(Fuca1-6)GlcNAc | 2Mana1-6)Manb1-4GlcNAcb1-4(Fuca1-6)GlcNAc |
| Galb1-3Galb1-4GlcNAcb1-2(Galb1-3Galb1- | Galb1-3Galb1-4GlcNAcb1-2Mana1-3(Galb1-3Galb1- |
| 4GlcNAcb1-4)Mana1-3(Galb1-3Galb1-4GlcNAcb1- | 4GlcNAcb1-2(Galb1-3Galb1-4GlcNAcb1-6)Mana1- |
| 2Mana1-6)Manb1-4GlcNAcb1-4(Fuca1-6)GlcNAc | 6)Manb1-4GlcNAcb1-4(Fuca1-6)GlcNAc |
| GalNAcb1-4GlcNAcb1-2(Galb1-4GlcNAcb1- | GlcNAcb1-4(GlcNAcb1-3Galb1-4GlcNAcb1- |
| 4)Mana1-3(GalNAcb1-4GlcNAcb1-2(GalNAcb1- | 2(GlcNAcb1-4)Mana1-3)(GalNAcb1-4GlcNAcb1- |
| 4GlcNAcb1-6)Mana1-6)Manb1-4GlcNAcb1-4(Fuca1- | 2(GlcNAcb1-6)Mana1-6)Manb1-4GlcNAcb1- |
| 6)GlcNAc | 4(Fuca1-6)GlcNAc |
| NeuGca2-8NeuGca2-3/6Galb1-4(Fuca1- | NeuGca2-8NeuGca2-3/6Galb1-4GlcNAcb1- |
| 3)GlcNAcb1-2(GlcNAcb1-4)Mana1-3(GlcNAcb1- | 2(GlcNAcb1-4)Mana1-3(GlcNAcb1-2(GlcNAcb1- |
| 2(GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1- | NeuAca2-3/6Galb1-4GlcNAcb1-2(GlcNAcb1- |
| 2(GlcNAcb1-4)Mana1-3(Galb1-4GlcNAcb1-2(Galb1- | 4)Mana1-3(Galb1-4GlcNAcb1-2(Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| Galb1-4(Fuca1-3)GlcNAcb1-2(GlcNAcb1-4)Mana1- | GlcNAcb1-4(Galb1-4(Fuca1-3)GlcNAcb1-2(Galb1- |
| 3(Galb1-4GlcNAcb1-2(Galb1-4(Fuca1-3)GlcNAcb1- | 4(Fuca1-3)GlcNAcb1-4)Mana1-3)(Galb1- |
| 6)Mana1-6)Manb1-4GlcNAcb1-4(Fuca1-6)GlcNAc | 4GlcNAcb1-2Mana1-6)Manb1-4GlcNAcb1-4(Fuca1- |
| | 6)GlcNAc |
| GlcNAcb1-4(Galb1-4(Fuca1-3)GlcNAcb1-2(Galb1- | Galb1-4(Fuca1-3)GlcNAcb1-2(GlcNAcb1-4)Mana1- |
| 4GlcNAcb1-4)Mana1-3)(Galb1-4(Fuca1- | 3(Galb1-4(Fuca1-3)GlcNAcb1-2(Galb1-4(Fuca1- |
| 3)GlcNAcb1-2Mana1-6)Manb1-4GlcNAcb1-4(Fuca1- | 3)GlcNAcb1-6)Mana1-6)Manb1-4GlcNAcb1-4GlcNAc |
| 6)GlcNAc | |
| GlcNAcb1-4(Galb1-4(Fuca1-3)GlcNAcb1-2(Galb1- | Glca1-2Glca1-3Glca1-3Mana1-2Mana1-2(Mana1- |
| 4(Fuca1-3)GlcNAcb1-4)Mana1-3)(Galb1-4(Fuca1- | 3Mana1-2 Mana1-6)Mana1-3(Mana1-3(Mana1- |
| 3)GlcNAcb1-2Mana1-6)Manb1-4GlcNAcb1-4GlcNAc | 3Mana1-2Mana1-6)Mana1-6)Manb1-4GlcNAc |
| GlcNAcb1-4(Galb1-4GlcNAcb1-3Galb1-4GlcNAcb1- | NeuAca2-8NeuAca2-3/6Galb1-4GlcNAcb1-2Mana1- |
| 2(GlcNAcb1-4)Mana1-3)(GalNAcb1-4GlcNAcb1- | 3(NeuAca2-3/6Galb1-4GlcNAcb1-2Mana1-6)Manb1- |
| 2(GlcNAcb1-6)Mana1-6)Manb1-4GlcNAcb1-4GlcNAc | 4GlcNAcb1-4(Fuca1-6)GlcNAc |
| NeuAca2-3(NeuAca2-6)Galb1-4GlcNAcb1-2Mana1- | NeuAca2-8NeuAca2-3/6Galb1-4(Fuca1-3)GlcNAcb1- |
| 3(NeuAca2-3Galb1-4GlcNAcb1-2Mana1-6)Manb1- | 2Mana1-3(NeuAca2-3/6Galb1-4GlcNAcb1-2Mana1- |
| 4GlcNAcb1-4(Fuca1-6)GlcNAcb | 6)Manb1-4GlcNAcb1-4GlcNAc |
| NeuAca2-3Galb1-3(NeuAca2-6)GlcNAcb1-2Mana1- | NeuAca2-3(NeuAca2-6)Galb1-4GlcNAcb1-2Mana1- |
| 3(NeuAca2-3Galb1-4GlcNAcb1-2Mana1-6)Manb1- | 3(NeuAca2-3Galb1-4GlcNAcb1-2Mana1-6)Manb1- |
| 4GlcNAcb1-4(Fuca1-6)GlcNAcb | 4GlcNAcb1-4(Fuca1-6)GlcNAc |
| NeuAca2-3/6Galb1-4(NeuAca2-3/6)GlcNAcb1- | |
| 2Mana1-3(NeuAca2-3/6Galb1-4GlcNAcb1-2Mana1- | |
| 6)Manb1-4GlcNAcb1-4(Fuca1-6)GlcNAcb | |
| NeuAca2-3Galb1-3(NeuAca2-6)GlcNAcb1-2Mana1- | NeuAca2-3Galb1-3(NeuAca2-6)GlcNAcb1-2Mana1- |
| 3(NeuAca2-6Galb1-4GlcNAcb1-2Mana1-6)Manb1- | 3(NeuAca2-3Galb1-3GlcNAcb1-2Mana1-6)Manb1- |
| 4GlcNAcb1-4(Fuca1-6)GlcNAcb | 4GlcNAcb1-4(Fuca1-6)GlcNAcb |
| NeuAca2-3Galb1-4(NeuAca2-3)GlcNAcb1-2Mana1- | NeuAca2-3/6Galb1-4(Fuca1-3)GlcNAcb1-2Mana1- |
| 3(NeuAca2-3Galb1-4GlcNAcb1-2Mana1-6)Manb1- | 3(NeuAca2-3/6Galb1-4(Fuca1-3)GlcNAcb1-2Mana1- |
| 4GlcNAcb1-4(Fuca1-6)GlcNAcb | 6)Manb1-4GlcNAcb1-4(Fuca1-6)GlcNAc |
| NeuAca2-8NeuAca2-3/6Galb1-4(Fuca1-3)GlcNAcb1- | NeuAca2-3Galb1-4(Fuca1-3)GlcNAcb1-2Mana1- |
| 2Mana1-3(Fuca1-2Galb1-4(Fuca1-3)GlcNAcb1- | 3(NeuAca2-3Galb1-4(Fuca1-3)GlcNAcb1-2Mana1- |
| 2Mana1-6)Manb1-4GlcNAcb1-4GlcNAc | 6)Manb1-4GlcNAcb1-4(Fuca1-6)GlcNAcb |
| NeuGca2-3/6Galb1-4(Fuca1-3)GlcNAcb1- | NeuGca2-3/6Galb1-4GlcNAcb1-2(GlcNAcb1- |
| 2(GlcNAcb1-4)Mana1-3(Galb1-4GlcNAcb1-2(Galb1- | 4)Mana1-3(Galb1-4GlcNAcb1-2(Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-6Galb1-4GlcNAcb1-2(Galb1-4GlcNAcb1- | NeuAca2-3/6Galb1-4GlcNAcb1-2(Galb1-4GlcNAcb1- |
| 4)Mana1-3(Galb1-4GlcNAcb1-2(Galb1-4GlcNAcb1- | 4)Mana1-3(Galb1-4GlcNAcb1-2(Galb1-4GlcNAcb1- |
| 6)Mana1-6)Manb1-4GlcNAcb1-4GlcNAc | 6)Mana1-6)Manb1-4GlcNAcb1-4GlcNAc |
| Galb1-4(Fuca1-3)GlcNAcb1-2(Galb1-4GlcNAcb1- | Galb1-4(Fuca1-3)GlcNAcb1-2(Galb1-4GlcNAcb1- |
| 4)Mana1-3(Galb1-4GlcNAcb1-2(Galb1-4(Fuca1- | 4)Mana1-3(Galb1-4GlcNAcb1-2(Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| Galb1-4(Fuca1-3)GlcNAcb1-4(Galb1-4GlcNAcb1- | Galb1-4GlcNAcb1-2(Galb1-4(Fuca1-3)GlcNAcb1- |
| 6)Mana1-3(Galb1-4(Fuca1-3)GlcNAcb1-2(Galb1- | 4)Mana1-3(Galb1-4(Fuca1-3)GlcNAcb1-2(Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuAca2-8NeuAca2-3/6Galb1- | GlcNAcb1-4(NeuAca2-3/6Galb1-4(Fuca1- |
| 4GlcNAcb1-2(GlcNAcb1-4)Mana1-3)(GlcNAcb1- | 3)GlcNAcb1-2(GlcNAcb1-4)Mana1-3)(GlcNAcb1- |
| 2(GlcNAcb1-6)Mana1-6)Manb1-4GlcNAcb1-4GlcNAc | 2(GlcNAcb1-6)Mana1-6)Manb1-4GlcNAcb1- |
| | 4(Fuca1-6)GlcNAc |
| GlcNAcb1-4(Galb1-4(Fuca1-3)GlcNAcb1-2(Fuca1- | NeuAca2-8NeuGca2-3/6Galb1-4GlcNAcb1-2Mana1- |
| 3GlcNAcb1-4)Mana1-3)(Fuca1-3GlcNAcb1-2(Fuca1- | 3(NeuAca2-3/6Galb1-4GlcNAcb1-2Mana1-6)Manb1- |
| 3GlcNAcb1-6)Mana1-6)Manb1-4GlcNAcb1-4GlcNAc | 4GlcNAcb1-4(Fuca1-6)GlcNAc |
| NeuAca2-8NeuGca2-3/6Galb1-4(Fuca1- | NeuAca2-6Galb1-4GlcNAcb1-2(NeuAca2-3Galb1- |
| 3)GlcNAcb1-2Mana1-3(NeuAca2-3/6Galb1- | 4GlcNAcb1-4)Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAc |
| NeuAca2-3Galb1-4GlcNAcb1-2(NeuAca2-3Galb1- | NeuAca2-3Galb1-4GlcNAcb1-2Mana1-3(NeuAca2- |
| 4GlcNAcb1-4)Mana1-3(NeuAca2-3Galb1- | 3Galb1-4GlcNAcb1-2(NeuAca2-3Galb1-4GlcNAcb1- |
| 4GlcNAcb1-2Mana1-6)Manb1-4GlcNAc | 6)Mana1-6)Manb1-4GlcNAc |
| NeuAca2-6Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-4)Mana1-3(NeuAca2-6Galb1- |
| 4GlcNAcb1-2Mana1-6)Manb1-4GlcNAc | 4GlcNAcb1-2Mana1-6)Manb1-4GlcNAc |
| NeuAca2-6Galb1-4GlcNAcb1-2(NeuAca2-3Galb1- | NeuAcb2-3Galb1-4GlcNAcb1-2(NeuAcb2-6Galb1- |
| 4GlcNAcb1-4)Mana1-3(NeuAca2-3Galb1- | 4GlcNAcb1-4)Manb1-3(NeuAca2-6Galb1- |
| 4GlcNAcb1-2Mana1-6)Manb1-4GlcNAc | 4GlcNAcb1-2Manb1-6)Manb1-4GlcNAc |
| NeuGca2-3/6Galb1-4(Fuca1-3)GlcNAcb1-2Mana1- | NeuAca2-8NeuGca2-3/6Galb1-4(Fuca1- |
| 3(NeuAca2-3/6Galb1-4(Fuca1-3)GlcNAcb1-2Mana1- | 3)GlcNAcb1-2Mana1-3(Fuca1-2Galb1-4(Fuca1- |
| 6)Manb1-4GlcNAcb1-4(Fuca1-6)GlcNAc | 3)GlcNAcb1-2Mana1-6)Manb1-4GlcNAcb1-4GlcNAc |
| GlcNAcb1-4(NeuAca2-8NeuAca2-3/6Galb1-4(Fuca1- | NeuGca2-3/6Galb1-4GlcNAcb1-2(Galb1-4GlcNAcb1- |
| 3)GlcNAcb1-2Mana1-3)(Mana1-3(Mana1-6)Mana1- | 4)Mana1-3(Galb1-4GlcNAcb1-2(Galb1-4GlcNAcb1- |
| 6)Manb1-4GlcNAcb1-4(Fuca1-6)GlcNAc | 6)Mana1-6)Manb1-4GlcNAcb1-4GlcNAc |
| Galb1-4(Fuca1-3)GlcNAcb1-2(Galb1-4GlcNAcb1- | Galb1-4GlcNAcb1-2(Galb1-4GlcNAcb1-4)Mana1- |
| 4)Mana1-3(Galb1-4GlcNAcb1-2(Gala1-3Galb1- | 3(Galb1-4GlcNAcb1-2(Gala1-3Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| Gala1-3Galb1-4GlcNAcb1-2(Galb1-4GlcNAcb1- | Galb1-4GlcNAcb1-2(Galb1-4GlcNAcb1-6)Mana1- |
| 4)Mana1-3(Galb1-4GlcNAcb1-2(Galb1-4GlcNAcb1- | 3(Galb1-4GlcNAcb1-2(Galb1-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| Galb1-4GlcNAcb1-3Galb1-4GlcNAcb1-3Galb1- | |
| 4GlcNAcb1-2Mana1-3(Galb1-3Galb1-4GlcNAcb1- | |
| 2Mana1-6)Manb1-4GlcNAcb1-4(Fuca1-6)GlcNAc | |
| | Neua1-3Gala1-4GlcNAcb1-2Mana1-3(Neua1- |
| | 3Gala1-4GlcNAcb1-2(Neua1-3Gala1-4GlcNAcb1- |
| | 4)Mana1-6)Manb1-4GlcNAcb1-4(Fuca1-6)GlcNAcb |
| GlcNAcb1-3(NeuAca2-6)Galb1-4GlcNAcb1- | GlcNAcb1-4(NeuAca2-8NeuGca2-3/6Galb1- |
| 3(NeuAca2-6)Galb1-4GlcNAcb1-3(NeuAca2- | 4GlcNAcb1-2(GlcNAcb1-4)Mana1-3)(GlcNAcb1- |
| 6)Galb1-4GlcNAcb1-3(NeuAca2-6)GalNAc | 2(GlcNAcb1-6)Mana1-6)Manb1-4GlcNAcb1-4GlcNAc |
| GlcNAcb1-4(NeuGca2-3/6Galb1-4(Fuca1- | NeuGca2-8NeuGca2-3/6Galb1-4GlcNAcb1-2Mana1- |
| 3)GlcNAcb1-2(GlcNAcb1-4)Mana1-3)(GlcNAcb1- | 3(NeuAca2-3/6Galb1-4GlcNAcb1-2Mana1-6)Manb1- |
| 2(GlcNAcb1-6)Mana1-6)Manb1-4GlcNAcb1- | 4GlcNAcb1-4(Fuca1-6)GlcNAc |
| 4(Fuca1-6)GlcNAc | |
| NeuGca2-8NeuGca2-3/6Galb1-4(Fuca1- | NeuGca2-8NeuGca2-3/6Galb1-4(Fuca1- |
| 3)GlcNAcb1-2Mana1-3(NeuAca2-3/6Galb1- | 3)GlcNAcb1-2Mana1-3(Fuca1-2Galb1-4(Fuca1- |
| 4GlcNAcb1-2Mana1-6)Manb1-4GlcNAcb1-4GlcNAc | 3)GlcNAcb1-2Mana1-6)Manb1-4GlcNAcb1-4GlcNAc |
| GlcNAcb1-4(NeuAca2-8NeuGca2-3/6Galb1- | NeuGca2-3/6Galb1-4(Fuca1-3)GlcNAcb1-2Mana1- |
| 4(Fuca1-3)GlcNAcb1-2Mana1-3)(Mana1-3(Mana1- | 3(NeuGca2-3/6Galb1-4(Fuca1-3)GlcNAcb1- |
| 6)Mana1-6)Manb1-4GlcNAcb1-4(Fuca1-6)GlcNAc | 2Mana1-6)Manb1-4GlcNAcb1-4(Fuca1-6)GlcNAc |
| NeuAca2-3/6Galb1-4(Fuca1-3)GlcNAcb1-2(Galb1- | Gala1-3Galb1-4GlcNAcb1-2(Galb1-4GlcNAcb1- |
| 4(Fuca1-3)GlcNAcb1-4)Mana1-3(Mana1-3(Mana1- | 4)Mana1-3(Galb1-4GlcNAcb1-2(Gala1-3Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-8NeuGca2-3/6Galb1- | NeuAca2-8NeuAca2-3/6Galb1-4(Fuca1-3)GlcNAcb1- |
| 4GlcNAcb1-2(GlcNAcb1-4)Mana1-3)(GlcNAcb1- | 2Mana1-3(GalNAcb1-4(Fuca1-3)GlcNAcb1-2Mana1- |
| 2(GlcNAcb1-6)Mana1-6)Manb1-4GlcNAcb1-4GlcNAc | 6)Manb1-4GlcNAcb1-4(Fuca1-6)GlcNAc |
| GlcNAcb1-4(NeuAca2-3/6Galb1-4GlcNAcb1- | GlcNAcb1-4(GlcNAcb1-2(Galb1-4GlcNAcb1- |
| 2(GlcNAcb1-4)Mana1-3)(Galb1-4GlcNAcb1- | 4)Mana1-3)(Galb1-4GlcNAcb1-2(Galb1-4(Fuca1- |
| 2(Galb1-4GlcNAcb1-6)Mana1-6)Manb1-4GlcNAcb1- | 3)GlcNAcb1-6)Mana1-6)Manb1-4GlcNAcb1- |
| 4GlcNAc | 4(Fuca1-6)GlcNAc |
| GlcNAcb1-4(Galb1-4(Fuca1-3)GlcNAcb1- | Galb1-4(Fuca1-3)GlcNAcb1-2(Galb1-4GlcNAcb1- |
| 2(GlcNAcb1-4)Mana1-3)(Galb1-4GlcNAcb1- | 4)Mana1-3(Galb1-4GlcNAcb1-2(GalNAcb1-4(Fuca1- |
| 2(Galb1-4(Fuca1-3)GlcNAcb1-6)Mana1-6)Manb1- | 3)GlcNAcb1-6)Mana1-6)Manb1-4GlcNAcb1-4GlcNAc |
| 4GlcNAcb1-4GlcNAc | |
| GlcNAcb1-4(Galb1-4(Fuca1-3)GlcNAcb1- | NeuGca2-8NeuGca2-3/6Galb1-4GlcNAcb1-2Mana1- |
| 2(GlcNAcb1-4)Mana1-3)(Galb1-4GlcNAcb1- | 3(NeuGca2-3/6Galb1-4GlcNAcb1-2Mana1-6)Manb1- |
| 2(Galb1-4GlcNAcb1-6)Mana1-6)Manb1-4GlcNAcb1- | 4GlcNAcb1-4(Fuca1-6)GlcNAc |
| 4(Fuca1-6)GlcNAc | |
| NeuGca2-8NeuGca2-3/6Galb1-4(Fuca1- | GlcNAcb1-4(NeuGca2-8NeuGca2-3/6Galb1- |
| 3)GlcNAcb1-2Mana1-3(NeuGca2-3/6Galb1- | 4(Fuca1-3)GlcNAcb1-2Mana1-3)(Mana1-3(Mana1- |
| 4GlcNAcb1-2Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1-2(Gala1- | NeuGca2-3/6Galb1-4(Fuca1-3)GlcNAcb1-2(Galb1- |
| 3Galb1-4GlcNAcb1-4)Mana1-3(Mana1-3(Mana1- | 4(Fuca1-3)GlcNAcb1-4)Mana1-3(Mana1-3(Mana1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuAca2-8NeuAca2-3/6Galb1- | NeuAca2-8NeuGca2-3/6Galb1-4(Fuca1- |
| 4GlcNAcb1-2Mana1-3)(NeuAca2-3/6Galb1- | 3)GlcNAcb1-2Mana1-3(GalNAcb1-4(Fuca1- |
| 4GlcNAcb1-2Mana1-6)Manb1-4GlcNAcb1-4GlcNAc | 3)GlcNAcb1-2Mana1-6)Manb1-4GlcNAcb1-4(Fuca1- |
| | 6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2Mana1-3)(NeuAca2-3/6Galb1- | 3)GlcNAcb1-2Mana1-3)(NeuAca2-3/6Galb1- |
| 4GlcNAcb1-2Mana1-6)Manb1-4GlcNAcb1-4(Fuca1- | 4(Fuca1-3)GlcNAcb1-2Mana1-6)Manb1-4GlcNAcb1- |
| 6)GlcNAc | 4GlcNAc |
| GlcNAcb1-4(NeuAca2-3Galb1-4(Fuca1-6)GlcNAcb1- | GlcNAcb1-4(NeuGca2-3/6Galb1-4GlcNAcb1- |
| 2Mana1-3)(NeuAca2-3Galb1-4GlcNAcb1-2Mana1- | 2(GlcNAcb1-4)Mana1-3)(Galb1-4GlcNAcb1- |
| 6)Manb1-4GlcNAcb1-4(Fuca1-6)GlcNAcb | 2(Galb1-4GlcNAcb1-6)Mana1-6)Manb1-4GlcNAcb1- |
| | 4GlcNAc |
| GlcNAcb1-4(NeuAca2-3/6Galb1-4(Fuca1- | GlcNAcb1-4(Galb1-4(Fuca1-3)GlcNAcb1-2(Galb1- |
| 3)GlcNAcb1-2Mana1-3)(Fuca1-2Galb1-4(Fuca1- | 4GlcNAcb1-4)Mana1-3)(Galb1-4GlcNAcb1-2(Galb1- |
| 3)GlcNAcb1-2Mana1-6)Manb1-4GlcNAcb1-4(Fuca1- | 4GlcNAcb1-6)Mana1-6)Manb1-4GlcNAcb1-4GlcNAc |
| 6)GlcNAc | |
| GlcNAcb1-4(Galb1-4GlcNAcb1-2(Galb1-4GlcNAcb1- | NeuGca2-3/6Galb1-4GlcNAcb1-2(NeuGca2- |
| 4)Mana1-3)(Galb1-4GlcNAcb1-2(Galb1-4GlcNAcb1- | 3/6Galb1-4GlcNAcb1-4)Mana1-3(Mana1-3(Mana1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1-2(Gala1- | Mana1-3Mana1-2Mana1-2(Mana1-2Mana1- |
| 3Galb1-4GlcNAcb1-4)Mana1-3(Mana1-3(Mana1- | 6)Mana1-3(Mana1-3(Mana1-3Mana1-2(Mana1- |
| 6)Mana1-6)Manb1-4GlcNAcb1-4(Fuca1-6)GlcNAc | 3ManaAll)Man[6P]a1-6)Mana1-6)Manb1-4GlcNAc |
| GlcNAcb1-4(NeuAca2-8NeuGca2-3/6Galb1- | GlcNAcb1-4(NeuGca2-3/6Galb1-4(Fuca1- |
| 4GlcNAcb1-2Mana1-3)(NeuAca2-3/6Galb1- | 3)GlcNAcb1-2Mana1-3)(NeuAca2-3/6Galb1- |
| 4GlcNAcb1-2Mana1-6)Manb1-4GlcNAcb1-4GlcNAc | 4(Fuca1-3)GlcNAcb1-2Mana1-6)Manb1-4GlcNAcb1- |
| | 4GlcNAc |
| GlcNAcb1-4(NeuGca2-3/6Galb1-4(Fuca1- | NeuGca2-8NeuGca2-3/6Galb1-4(Fuca1- |
| 3)GlcNAcb1-2Mana1-3)(NeuAca2-3/6Galb1- | 3)GlcNAcb1-2Mana1-3(GalNAcb1-4(Fuca1- |
| 4GlcNAcb1-2Mana1-6)Manb1-4GlcNAcb1-4(Fuca1- | 3)GlcNAcb1-2Mana1-6)Manb1-4GlcNAcb1-4(Fuca1- |
| 6)GlcNAc | 6)GlcNAc |
| GlcNAcb1-4(Gala1-3Galb1-4GlcNAcb1-2Mana1- | NeuAca2-6Galb1-4GlcNAcb1-2(Galb1-4GlcNAcb1- |
| 3)(NeuAca2-8NeuAca2-3/6Galb1-4GlcNAcb1- | 4)Mana1-3(NeuAca2-6Galb1-4GlcNAcb1-2Mana1- |
| 2Mana1-6)Manb1-4GlcNAcb1-4(Fuca1-6)GlcNAc | 6)Manb1-4GlcNAcb1-4(Fuca1-6)GlcNAcb |
| Galb1-4GlcNAcb1-2(NeuAca2-3Galb1-4GlcNAcb1- | NeuAca2-6Galb1-4GlcNAcb1-2Mana1-3(Galb1- |
| 4)Mana1-3(NeuAca2-6Galb1-4GlcNAcb1-2Mana1- | 4GlcNAcb1-2(NeuAca2-3Galb1-4GlcNAcb1- |
| 6)Manb1-4GlcNAcb1-4(Fuca1-6)GlcNAcb | 4)Mana1-6)Manb1-4GlcNAcb1-4(Fuca1-6)GlcNAcb |
| NeuAca2-6Galb1-4GlcNAcb1-2(Galb1-4(Fuca1- | NeuAca2-6Galb1-4GlcNAcb1-2(NeuAca2-3Galb1- |
| 3)GlcNAcb1-4)Mana1-3(NeuAca2-6Galb1- | 4GlcNAcb1-4)Mana1-3(Galb1-4GlcNAcb1-2Mana1- |
| 4GlcNAcb1-2Mana1-6)Manb1-4GlcNAcb1-4GlcNAcb | 6)Manb1-4GlcNAcb1-4(Fuca1-6)GlcNAcb |
| NeuAca2-3Galb1-4GlcNAcb1-2Mana1-3(Galb1- | NeuAca2-6Galb1-4GlcNAcb1-2(Galb1-4(Fuca1- |
| 4GlcNAcb1-2(NeuAca2-3Galb1-4GlcNAcb1- | 3)GlcNAcb1-4)Mana1-3(NeuAca2-3Galb1- |
| 6)Mana1-6)Manb1-4GlcNAcb1-4(Fuca1-6)GlcNAcb | 4GlcNAcb1-2Mana1-6)Manb1-4GlcNAcb1-4GlcNAcb |
| NeuAca2-3Galb1-4GlcNAcb1-2Mana1-3(NeuAca2- | Galb1-4GlcNAcb1-2Mana1-3(NeuAca2-3Galb1- |
| 3Galb1-4GlcNAcb1-2(Galb1-4GlcNAcb1-6)Mana1- | 4GlcNAcb1-2(NeuAca2-3Galb1-4GlcNAcb1- |
| 6)Manb1-4GlcNAcb1-4(Fuca1-6)GlcNAcb | 6)Mana1-6)Manb1-4GlcNAcb1-4(Fuca1-6)GlcNAcb |
| NeuAca2-6Galb1-4GlcNAcb1-2(NeuAca2-3Galb1- | NeuAca2-3Galb1-4GlcNAcb1-2(Galb1-4GlcNAcb1- |
| 4GlcNAcb1-4)Mana1-3(Galb1-4GlcNAcb1-2Mana1- | 4)Mana1-3(NeuAca2-3Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAcb |
| NeuAca2-3Galb1-4GlcNAcb1-2Mana1-3(Galb1- | NeuAca2-3Galb1-4GlcNAcb1-2(NeuAca2-3Galb1- |
| 4GlcNAcb1-2(NeuAca2-3Galb1-4GlcNAcb1- | 4GlcNAcb1-4)Mana1-3(Galb1-4GlcNAcb1-2Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuAca2-3Galb1-4GlcNAcb1-2Mana1-3(NeuAca2- | NeuAca2-3Galb1-4GlcNAcb1-2(Galb1-4GlcNAcb1- |
| 3Galb1-4GlcNAcb1-3Galb1-4GlcNAcb1-2Mana1- | 4)Mana1-3(NeuAca2-3Galb1-4GlcNAcb1-2Mana1- |
| 6)Manb1-4GlcNAcb1-4(Fuca1-6)GlcNAc | 6)Manb1-4GlcNAcb1-4(Fuca1-6)GlcNAc |
| NeuAca2-3Galb1-4GlcNAcb1-2Mana1-3(NeuAca2- | Galb1-4GlcNAcb1-2Mana1-3(NeuAca2-3Galb1- |
| 3Galb1-4GlcNAcb1-2(Galb1-4GlcNAcb1-6)Mana1- | 4GlcNAcb1-2(NeuAca2-3Galb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| NeuAca2-6Galb1-4GlcNAcb1-2Mana1-3(Galb1- | Galb1-4(Fuca1-3)GlcNAcb1-2Mana1-3(NeuAca2- |
| 4(Fuca1-3)GlcNAcb1-3Galb1-4(Fuca1-3)GlcNAcb1- | 6Galb1-4GlcNAcb1-3Galb1-4(Fuca1-3)GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| NeuAca2-6Galb1-4GlcNAcb1-2(Galb1-4(Fuca1- | GlcNAcb1-4(NeuGca2-3/6Galb1-4(Fuca1- |
| 3)GlcNAcb1-4)Mana1-3(Galb1-4(Fuca1- | 3)GlcNAcb1-2Mana1-3)(Fuca1-2Galb1-4(Fuca1- |
| 3)GlcNAcb1-2Mana1-6)Manb1-4GlcNAcb1-4(Fuca1- | 3)GlcNAcb1-2Mana1-6)Manb1-4GlcNAcb1-4(Fuca1- |
| 6)GlcNAc | 6)GlcNAc |
| Galb1-4(Fuca1-3)GlcNAcb1-2Mana1-3(NeuAca2- | Galb1-4GlcNAcb1-2(Galb1-4GlcNAcb1-4)Mana1- |
| 3/6Galb1-4GlcNAcb1-2(Galb1-4(Fuca1-3)GlcNAcb1- | 3(Galb1-4GlcNAcb1-3Galb1-4GlcNAcb1-2(Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(Gala1-3Galb1-4GlcNAcb1-2(Galb1- | Galb1-4GlcNAcb1-3Galb1-4GlcNAcb1-2(Galb1- |
| 4GlcNAcb1-4)Mana1-3)(Galb1-4GlcNAcb1-2(Galb1- | 4GlcNAcb1-4)Mana1-3(Galb1-4GlcNAcb1-2(Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| GlcNAcb1-4(Galb1-4GlcNAcb1-2(Galb1-4GlcNAcb1- | Galb1-4GlcNAcb1-2(Galb1-4GlcNAcb1-4)Mana1- |
| 4)Mana1-3)(Galb1-4GlcNAcb1-2(Gala1-3Galb1- | 3(Galb1-4GlcNAcb1-4Galb1-4GlcNAcb1-2(Galb1- |
| 4GlcNAcb1-6)Mana1-6)Manb1-4GlcNAcb1-4GlcNAc | 4GlcNAcb1-4)Mana1-6)Manb1-4GlcNAcb1-4GlcNAc |
| Galb1-4GlcNAcb1-2(Galb1-4GlcNAcb1-4)Mana1- | Galb1-4GlcNAcb1-2(Galb1-4GlcNAcb1-4)Mana1- |
| 3(Galb1-4GlcNAcb1-3Galb1-4GlcNAcb1-2(Galb1- | 3(Galb1-4GlcNAcb1-2(Galb1-4GlcNAcb1-4Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| Galb1-4GlcNAcb1-4(Galb1-4GlcNAcb1-6)Mana1- | Galb1-4GlcNAcb1-2(Galb1-4GlcNAcb1-4)Mana1- |
| 3(Galb1-4GlcNAcb1-2(Galb1-4GlcNAcb1-3Galb1- | 3(Galb1-4GlcNAcb1-2(Galb1-4GlcNAcb1-3Galb1- |
| 4GlcNAcb1-6)Mana1-6)Manb1-4GlcNAcb1-4GlcNAc | 3GlcNAcb1-6)Mana1-6)Manb1-4GlcNAcb1-4GlcNAc |
| Galb1-4GlcNAcb1-2(Galb1-4GlcNAcb1-4)Mana1- | Galb1-4GlcNAcb1-4(Galb1-4GlcNAcb1-6)Mana1- |
| 3(Galb1-4GlcNAcb1-4Galb1-4GlcNAcb1-2(Galb1- | 3(Galb1-4GlcNAcb1-3Galb1-4GlcNAcb1-2(Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| Galb1-4GlcNAcb1-2(Galb1-4GlcNAcb1-4)Mana1- | GlcNAcb1-4(NeuGca2-8NeuGca2-3/6Galb1- |
| 3(Galb1-4GlcNAcb1-3Galb1-4GlcNAcb1-2(Galb1- | 4GlcNAcb1-2Mana1-3)(NeuAca2-3/6Galb1- |
| 3GlcNAcb1-6)Mana1-6)Manb1-4GlcNAcb1-4GlcNAc | 4GlcNAcb1-2Mana1-6)Manb1-4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2Mana1-3)(NeuGca2-3/6Galb1- | 3)GlcNAcb1-2Mana1-3)(NeuGca2-3/6Galb1- |
| 4(Fuca1-3)GlcNAcb1-2Mana1-6)Manb1-4GlcNAcb1- | 4GlcNAcb1-2Mana1-6)Manb1-4GlcNAcb1-4(Fuca1- |
| 4GlcNAc | 6)GlcNAc |
| GlcNAcb1-4(Gala1-3Galb1-4GlcNAcb1-2Mana1- | NeuAca2-3/6Galb1-4GlcNAcb1-2(NeuAca2- |
| 3)(NeuAca2-8NeuGca2-3/6Galb1-4GlcNAcb1- | 3/6Galb1-4GlcNAcb1-4)Mana1-3(Gala1-3Galb1- |
| 2Mana1-6)Manb1-4GlcNAcb1-4(Fuca1-6)GlcNAc | 4GlcNAcb1-2Mana1-6)Manb1-4GlcNAcb1-4GlcNAc |
| GlcNAcb1-4(NeuAca2-3/6Galb1-4GlcNAcb1- | |
| 2(NeuAca2-3/6Galb1-4GlcNAcb1-4)Mana1- | |
| 3)(Mana1-3(Mana1-6)Mana1-6)Manb1-4GlcNAcb1- | |
| 4GlcNAc | |
| | NeuAca2-6Galb1-4GlcNAcb1-2(NeuAca2-6Galb1- |
| | 4GlcNAcb1-4)Mana1-3(Galb1-4GlcNAcb1-2(Galb1- |
| | 4GlcNAcb1-6)Mana1-6)Manb1-4GlcNAc |
| NeuAca2-6Galb1-4GlcNAcb1-2(Galb1-4GlcNAcb1- | GlcNAcb1-4(NeuAca2-3/6Galb1-4(Fuca1- |
| 4)Mana1-3(NeuAca2-6Galb1-4GlcNAcb1-2(Galb1- | 3)GlcNAcb1-2(Galb1-4(Fuca1-3)GlcNAcb1- |
| 4GlcNAcb1-6)Mana1-6)Manb1-4GlcNAc | 4)Mana1-3)(Mana1-3(Mana1-6)Mana1-6)Manb1- |
| | 4GlcNAcb1-4GlcNAc |
| NeuAca2-8NeuAca2-3/6Galb1-4(Fuca1-3)GlcNAcb1- | GlcNAcb1-4(NeuAca2-8NeuAca2-3/6Galb1-4(Fuca1- |
| 2(GlcNAcb1-4)Mana1-3(GlcNAcb1-2(GlcNAcb1- | 3)GlcNAcb1-2Mana1-3)(GalNAcb1-4(Fuca1- |
| 6)Mana1-6)Manb1-4GlcNAcb1-4(Fuca1-6)GlcNAc | 3)GlcNAcb1-2Mana1-6)Manb1-4GlcNAcb1-4GlcNAc |
| NeuAca2-8NeuAca2-3/6Galb1-4(Fuca1-3)GlcNAcb1- | Galb1-4(Fuca1-3)GlcNAcb1-3Galb1-4GlcNAcb1- |
| 2(GlcNAcb1-4)Mana1-3(GlcNAcb1-2(Fuca1- | 2(GlcNAcb1-4)Mana1-3(GalNAcb1-4GlcNAcb1- |
| 3GlcNAcb1-6)Mana1-6)Manb1-4GlcNAcb1-4GlcNAc | 2(Galb1-4GlcNAcb1-6)Mana1-6)Manb1-4GlcNAcb1- |
| | 4GlcNAc |
| Galb1-4GlcNAcb1-3Galb1-4GlcNAcb1-2(GlcNAcb1- | GalNAcb1-4Galb1-4GlcNAcb1-2Mana1-3(GalNAcb1- |
| 4)Mana1-3(GalNAcb1-4GlcNAcb1-2(Galb1- | 4Galb1-4GlcNAcb1-2(GalNAcb1-4Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAcb |
| 6)GlcNAc | |
| GlcNAcb1-4(NeuGca2-8NeuGca2-3/6Galb1- | NeuGca2-3/6Galb1-4GlcNAcb1-2(NeuAca2- |
| 4GlcNAcb1-2Mana1-3)(NeuGca2-3/6Galb1- | 3/6Galb1-4GlcNAcb1-4)Mana1-3(Gala1-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuGca2-3/6Galb1-4GlcNAcb1-2(NeuGca2- | GlcNAcb1-4(Gala1-3Galb1-4GlcNAcb1-2Mana1- |
| 3/6Galb1-4GlcNAcb1-4)Mana1-3(Galb1-4GlcNAcb1- | 3)(NeuGca2-8NeuGca2-3/6Galb1-4GlcNAcb1- |
| 2Mana1-6)Manb1-4GlcNAcb1-4(Fuca1-6)GlcNAc | 2Mana1-6)Manb1-4GlcNAcb1-4(Fuca1-6)GlcNAc |
| Galb1-4(Fuca1-3)GlcNAcb1-2(Gala1-3Galb1- | GlcNAcb1-4(Galb1-4(Fuca1-3)GlcNAcb1- |
| 4GlcNAcb1-4)Mana1-3(NeuGca2-3/6Galb1- | 2(NeuGca2-3/6Galb1-4GlcNAcb1-4)Mana1- |
| 4GlcNAcb1-2Mana1-6)Manb1-4GlcNAcb1-4(Fuca1- | 3)(Mana1-3(Mana1-6)Mana1-6)Manb1-4GlcNAcb1- |
| 6)GlcNAc | 4(Fuca1-6)GlcNAc |
| GlcNAcb1-4(NeuAca2-3/6Galb1-4GlcNAcb1- | |
| 2(Gala1-3Galb1-4GlcNAcb1-4)Mana1-3)(Mana1- | |
| 3(Mana1-6)Mana1-6)Manb1-4GlcNAcb1-4(Fuca1- | |
| 6)GlcNAc | |
| NeuAca2-3Galb1-4GlcNAcb1-2Mana1-3(Galb1- | GlcNAcb1-4(NeuAca2-3/6Galb1-4(Fuca1- |
| 3Galb1-4GlcNAcb1-2(Galb1-3Galb1-4GlcNAcb1- | 3)GlcNAcb1-2(Gala1-3Galb1-4GlcNAcb1-4)Mana1- |
| 4)Mana1-6)Manb1-4GlcNAcb1-4(Fuca1-6)GlcNAc | 3)(Mana1-3(Mana1-6)Mana1-6)Manb1-4GlcNAcb1- |
| | 4GlcNAc |
| NeuAca2-3/6Galb1-4GlcNAcb1-2(Gala1-3Galb1- | GlcNAcb1-4(NeuGca2-3/6Galb1-4(Fuca1- |
| 4GlcNAcb1-4)Mana1-3(Gala1-3Galb1-4GlcNAcb1- | 3)GlcNAcb1-2(Galb1-4(Fuca1-3)GlcNAcb1- |
| 2Mana1-6)Manb1-4GlcNAcb1-4(Fuca1-6)GlcNAc | 4)Mana1-3)(Mana1-3(Mana1-6)Mana1-6)Manb1- |
| | 4GlcNAcb1-4GlcNAc |
| NeuGca2-3/6Galb1-4GlcNAcb1-2(Gala1-3Galb1- | Mana1-2(GlcNAcbAll)Man[6P]a1-2Mana1-3(Mana1- |
| 4GlcNAcb1-4)Mana1-3(Galb1-4(Fuca1-3)GlcNAcb1- | 2Mana1-3(Mana1-2(GlcNAcbAll)Man[6P]a1- |
| 2Mana1-6)Manb1-4GlcNAcb1-4(Fuca1-6)GlcNAc | 6)Mana1-6)Manb1-4GlcNAcb1-4GlcNAcb |
| NeuAca2-8NeuGca2-3/6Galb1-4(Fuca1- | GlcNAcb1-4(NeuAca2-8NeuGca2-3/6Galb1- |
| 3)GlcNAcb1-2(GlcNAcb1-4)Mana1-3(GlcNAcb1- | 4(Fuca1-3)GlcNAcb1-2Mana1-3)(GalNAcb1- |
| 2(GlcNAcb1-6)Mana1-6)Manb1-4GlcNAcb1- | 4(Fuca1-3)GlcNAcb1-2Mana1-6)Manb1-4GlcNAcb1- |
| 4(Fuca1-6)GlcNAc | 4GlcNAc |
| NeuAca2-8NeuGca2-3/6Galb1-4(Fuca1- | GlcNAcb1-4(Galb1-4GlcNAcb1-2(Galb1-4GlcNAcb1- |
| 3)GlcNAcb1-2(GlcNAcb1-4)Mana1-3(GlcNAcb1- | 4)Mana1-3)(Galb1-4GlcNAcb1-2(GlcNAcb1- |
| 2(Fuca1-3GlcNAcb1-6)Mana1-6)Manb1-4GlcNAcb1- | 4)(Galb1-4GlcNAcb1-6)Mana1-6)Manb1- |
| 4GlcNAc | 4GlcNAcb1-4GlcNAc |
| Gala1-3Galb1-4GlcNAcb1-3Galb1-4GlcNAcb1- | NeuGca2-3/6Galb1-4GlcNAcb1-2(Gala1-3Galb1- |
| 2(NeuAca2-3/6Galb1-4GlcNAcb1-4)Mana1- | 4GlcNAcb1-4)Mana1-3(Gala1-3Galb1-4GlcNAcb1- |
| 3(Mana1-3(Mana1-6)Mana1-6)Manb1-4GlcNAcb1- | 2Mana1-6)Manb1-4GlcNAcb1-4(Fuca1-6)GlcNAc |
| 4GlcNAc | |
| GlcNAcb1-4(NeuGca2-3/6Galb1-4GlcNAcb1- | GlcNAcb1-4(NeuGca2-3/6Galb1-4(Fuca1- |
| 2(Gala1-3Galb1-4GlcNAcb1-4)Mana1-3)(Mana1- | 3)GlcNAcb1-2(Gala1-3Galb1-4GlcNAcb1-4)Mana1- |
| 3(Mana1-6)Mana1-6)Manb1-4GlcNAcb1-4(Fuca1- | 3)(Mana1-3(Mana1-6)Mana1-6)Manb1-4GlcNAcb1- |
| 6)GlcNAc | 4GlcNAc |
| Gala1-3(Fuca1-2)Galb1-4GlcNAcb1-3Galb1- | NeuAca2-6Galb1-4GlcNAcb1-2(GalNAcb1- |
| 4GlcNAcb1-3(Gala1-3(Fuca1-2)Galb1-4GlcNAcb1- | 4(NeuAca2-3)Galb1-4GlcNAcb1-4)Mana1-3(Galb1- |
| 6)Galb1-4GlcNAcb1-3Galb1-4GlcNAcb1-3Galb1- | 4GlcNAcb1-2Mana1-6)Manb1-4GlcNAcb1-4GlcNAc |
| 4Glcb | |
| NeuGca2-8NeuGca2-3/6Galb1-4(Fuca1- | NeuAca2-3/6Galb1-4GlcNAcb1-2(GlcNAcb1- |
| 3)GlcNAcb1-2(GlcNAcb1-4)Mana1-3(GlcNAcb1- | 4)Mana1-3(Galb1-4GlcNAcb1-2(NeuAca2-3/6Galb1- |
| 2(GlcNAcb1-6)Mana1-6)Manb1-4GlcNAcb1- | 4GlcNAcb1-6)Mana1-6)Manb1-4GlcNAcb1-4GlcNAc |
| 4(Fuca1-6)GlcNAc | |
| GlcNAcb1-4(NeuGca2-8NeuGca2-3/6Galb1- | NeuGca2-8NeuGca2-3/6Galb1-4(Fuca1- |
| 4(Fuca1-3)GlcNAcb1-2Mana1-3)(GalNAcb1- | 3)GlcNAcb1-2(GlcNAcb1-4)Mana1-3(GlcNAcb1- |
| 4(Fuca1-3)GlcNAcb1-2Mana1-6)Manb1-4GlcNAcb1- | 2(Fuca1-3GlcNAcb1-6)Mana1-6)Manb1-4GlcNAcb1- |
| 4GlcNAc | 4GlcNAc |
| NeuAca2-3/6Galb1-4(Fuca1-3)GlcNAcb1- | NeuAca2-3/6Galb1-4(Fuca1-3)GlcNAcb1- |
| 2(GlcNAcb1-4)Mana1-3(Galb1-4GlcNAcb1-2(Galb1- | 2(GlcNAcb1-4)Mana1-3(Galb1-4GlcNAcb1-2(Galb1- |
| 4GlcNAcb1-6)Mana1-6)Manb1-4GlcNAcb1-4(Fuca1- | 4(Fuca1-3)GlcNAcb1-6)Mana1-6)Manb1- |
| 6)GlcNAc | 4GlcNAcb1-4GlcNAc |
| Galb1-4(Fuca1-3)GlcNAcb1-2(GlcNAcb1-4)Mana1- | GlcNAcb1-4(Galb1-4(Fuca1-3)GlcNAcb1-2(Galb1- |
| 3(Galb1-4(Fuca1-3)GlcNAcb1-2(Galb1-4(Fuca1- | 4(Fuca1-3)GlcNAcb1-4)Mana1-3)(Galb1-4(Fuca1- |
| 3)GlcNAcb1-6)Mana1-6)Manb1-4GlcNAcb1- | 3)GlcNAcb1-2Mana1-6)Manb1-4GlcNAcb1- |
| 4(Fuca1-6)GlcNAc | 4(Fuca1-6)GlcNAc |
| Gala1-3Galb1-4GlcNAcb1-3Galb1-4GlcNAcb1- | GlcNAcb1-4(Galb1-4GlcNAcb1-3Galb1-4GlcNAcb1- |
| 2(NeuGca2-3/6Galb1-4GlcNAcb1-4)Mana1- | 2(GlcNAcb1-4)Mana1-3)(GalNAcb1-4GlcNAcb1- |
| 3(Mana1-3(Mana1-6)Mana1-6)Manb1-4GlcNAcb1- | 2(GlcNAcb1-6)Mana1-6)Manb1-4GlcNAcb1- |
| 4GlcNAc | 4(Fuca1-6)GlcNAc |
| NeuAca2-3Galb1-3(NeuAca2-6)GlcNAcb1-2Mana1- | NeuAca2-3Galb1-3(NeuAca2-6)GlcNAcb1-2Mana1- |
| 3(NeuAca2-3Galb1-3(NeuAca2-6)GlcNAcb1- | 3(NeuAca2-3Galb1-3(NeuAca2-6)GlcNAcb1- |
| 2Mana1-6)Manb1-4GlcNAcb1-4GlcAcb | 2Mana1-6)Manb1-4GlcNAcb1-4GlcNAc |
| NeuAca2-4Galb1-3(NeuAca2-6)GlcNAcb1-2Mana1- | NeuAca2-4Galb1-3(NeuAca2-6)GlcNAcb1-4Mana1- |
| 3(NeuAca2-4Galb1-3(NeuAca2-6)GlcNAcb1- | 3(NeuAca2-4Galb1-3(NeuAca2-6)GlcNAcb1- |
| 2Mana1-6)Manb1-4GlcNAcb1-4GlcNAcb | 2Mana1-6)Manb1-4GlcNAcb1-4GlcNAc |
| NeuAca2-8NeuAca2-3/6Galb1-4(Fuca1-3)GlcNAcb1- | NeuAca2-8NeuAca2-3/6Galb1-4(Fuca1-3)GlcNAcb1- |
| 2Mana1-3(NeuAca2-3/6Galb1-4(Fuca1-3)GlcNAcb1- | 2Mana1-3(NeuAca2-3/6Galb1-4GlcNAcb1-2Mana1- |
| 2Mana1-6)Manb1-4GlcNAcb1-4GlcNAc | 6)Manb1-4GlcNAcb1-4(Fuca1-6)GlcNAc |
| NeuGca2-3/6Galb1-4GlcNAcb1-2(GlcNAcb1- | NeuAca2-8NeuAca2-3/6Galb1-4(Fuca1-3)GlcNAcb1- |
| 4)Mana1-3(Galb1-4GlcNAcb1-2(NeuAca2-3/6Galb1- | 2Mana1-3(Fuca1-2Galb1-4(Fuca1-3)GlcNAcb1- |
| 4GlcNAcb1-6)Mana1-6)Manb1-4GlcNAcb1-4GlcNAc | 2Mana1-6)Manb1-4GlcNAcb1-4(Fuca1-6)GlcNAc |
| NeuAca2-3/6Galb1-4(Fuca1-3)GlcNAcb1-2(Galb1- | NeuAca2-3/6Galb1-4GlcNAcb1-2(Galb1-4GlcNAcb1- |
| 4GlcNAcb1-4)Mana1-3(Galb1-4GlcNAcb1-2(Galb1- | 4)Mana1-3(Galb1-4GlcNAcb1-2(Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-6Galb1-4GlcNAcb1-2(Galb1-4(Fuca1- | NeuGca2-3/6Galb1-4(Fuca1-3)GlcNAcb1- |
| 3)GlcNAcb1-4)Mana1-3(Galb1-4GlcNAcb1-2(Galb1- | 2(GlcNAcb1-4)Mana1-3(Galb1-4GlcNAcb1-2(Galb1- |
| 4GlcNAcb1-6)Mana1-6)Manb1-4GlcNAcb1-4GlcNAc | 4(Fuca1-3)GlcNAcb1-6)Mana1-6)Manb1- |
| | 4GlcNAcb1-4GlcNAc |
| NeuGca2-3/6Galb1-4(Fuca1-3)GlcNAcb1- | NeuAca2-6Galb1-4GlcNAcb1-2(Galb1-4GlcNAcb1- |
| 2(GlcNAcb1-4)Mana1-3(Galb1-4GlcNAcb1-2(Galb1- | 4)Mana1-3(Galb1-4GlcNAcb1-2(Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAcb |
| 6)GlcNAc | |
| Galb1-4(Fuca1-3)GlcNAcb1-2(Galb1-4GlcNAcb1- | Galb1-4(Fuca1-3)GlcNAcb1-2(Galb1-4GlcNAcb1- |
| 4)Mana1-3(Galb1-4(Fuca1-3)GlcNAcb1-2(Galb1- | 4)Mana1-3(Galb1-4GlcNAcb1-2(Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| NeuAca2-3Galb1-4GlcNAc[6S]b1-3Galb1- | GlcNAcb1-4(NeuAca2-8NeuAca2-3/6Galb1-4(Fuca1- |
| 4GlcNAc[6S]b1-3Galb1-4GlcNAc[6S]b1-3Galb1- | 3)GlcNAcb1-2(GlcNAcb1-4)Mana1-3)(GlcNAcb1- |
| 4GlcNAc[6S]b1-3Galb1-4GlcNAcb1-3Galb1-3GalNAc | 2(GlcNAcb1-6)Mana1-6)Manb1-4GlcNAcb1-4GlcNAc |
| GlcNAcb1-4(NeuAca2-8NeuAca2-3/6Galb1- | GlcNAcb1-4(Galb1-4GlcNAcb1-3Galb1-4GlcNAcb1- |
| 4GlcNAcb1-2(GlcNAcb1-4)Mana1-3)(GlcNAcb1- | 2(GlcNAcb1-4)Mana1-3)(GalNAcb1-4GlcNAcb1- |
| 2(GlcNAcb1-6)Mana1-6)Manb1-4GlcNAcb1- | 2(Galb1-4GlcNAcb1-6)Mana1-6)Manb1-4GlcNAcb1- |
| 4(Fuca1-6)GlcNAc | 4GlcNAc |
| GlcNAcb1-3Galb1-4GlcNAcb1-2(GlcNAcb1-4)Mana1- | GlcNAcb1-4(Galb1-4(Fuca1-3)GlcNAcb1-2(Fuca1- |
| 3(GlcNAcb1-3Galb1-4GlcNAcb1-2(GlcNAcb1- | 3GlcNAcb1-4)Mana1-3)(Fuca1-3GlcNAcb1-2(Fuca1- |
| 3Galb1-4GlcNAcb1-6)Mana1-6)Manb1-4GlcNAcb1- | 3GlcNAcb1-6)Mana1-6)Manb1-4GlcNAcb1-4(Fuca1- |
| 4GlcNAc | 6)GlcNAc |
| | NeuAca2-8NeuGca2-3/6Galb1-4(Fuca1- |
| | 3)GlcNAcb1-2Mana1-3(NeuAca2-3/6Galb1- |
| | 4GlcNAcb1-2Mana1-6)Manb1-4GlcNAcb1-4(Fuca1- |
| | 6)GlcNAc |
| NeuAca2-8NeuGca2-3/6Galb1-4(Fuca1- | NeuGca2-3/6Galb1-4GlcNAcb1-2(GlcNAcb1- |
| 3)GlcNAcb1-2Mana1-3(NeuAca2-3/6Galb1-4(Fuca1- | 4)Mana1-3(Galb1-4GlcNAcb1-2(NeuGca2-3/6Galb1- |
| 3)GlcNAcb1-2Mana1-6)Manb1-4GlcNAcb1-4GlcNAc | 4GlcNAcb1-6)Mana1-6)Manb1-4GlcNAcb1-4GlcNAc |
| NeuAca2-8NeuGca2-3/6Galb1-4(Fuca1- | Gala1-3Galb1-4GlcNAcb1-2(Galb1-4GlcNAcb1- |
| 3)GlcNAcb1-2Mana1-3(Fuca1-2Galb1-4(Fuca1- | 4)Mana1-3(Galb1-4GlcNAcb1-2(NeuAca2-3/6Galb1- |
| 3)GlcNAcb1-2Mana1-6)Manb1-4GlcNAcb1-4(Fuca1- | 4GlcNAcb1-6)Mana1-6)Manb1-4GlcNAcb1-4GlcNAc |
| 6)GlcNAc | |
| NeuGca2-3/6Galb1-4GlcNAcb1-2(Galb1-4GlcNAcb1- | NeuGca2-3/6Galb1-4(Fuca1-3)GlcNAcb1-2(Galb1- |
| 4)Mana1-3(Galb1-4GlcNAcb1-2(Galb1-4GlcNAcb1- | 4GlcNAcb1-4)Mana1-3(Galb1-4GlcNAcb1-2(Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| Gala1-3Galb1-4(Fuca1-3)GlcNAcb1-2(Galb1- | Galb1-4(Fuca1-3)GlcNAcb1-2(Galb1-4GlcNAcb1- |
| 4GlcNAcb1-4)Mana1-3(Galb1-4GlcNAcb1-2(Galb1- | 4)Mana1-3(Galb1-4GlcNAcb1-2(Gala1-3Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuGca2-3Galb1-4GlcNAc[6S]b1-3Galb1- | GlcNAcb1-4(NeuAca2-8NeuGca2-3/6Galb1- |
| 4GlcNAc[6S]b1-3Galb1-4GlcNAc[6S]b1-3Galb1- | 4(Fuca1-3)GlcNAcb1-2(GlcNAcb1-4)Mana1- |
| 4GlcNAc[6S]b1-3Galb1-4GlcNAcb1-3Galb1-3GalNAc | 3)(GlcNAcb1-2(GlcNAcb1-6)Mana1-6)Manb1- |
| | 4GlcNAcb1-4GlcNAc |
| GlcNAcb1-4(NeuAca2-8NeuGca2-3/6Galb1- | GlcNAcb1-4(GlcNAcb1-2(GlcNAcb1-4)Mana1- |
| 4GlcNAcb1-2(GlcNAcb1-4)Mana1-3)(GlcNAcb1- | 3)(NeuAca2-3/6Galb1-4GlcNAcb1-2(Galb1- |
| 2(GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4(Fuca1-6)GlcNAc |
| NeuGca2-8NeuGca2-3/6Galb1-4(Fuca1- | NeuGca2-8NeuGca2-3/6Galb1-4(Fuca1- |
| 3)GlcNAcb1-2Mana1-3(NeuAca2-3/6Galb1- | 3)GlcNAcb1-2Mana1-3(NeuAca2-3/6Galb1-4(Fuca1- |
| 4GlcNAcb1-2Mana1-6)Manb1-4GlcNAcb1-4(Fuca1- | 3)GlcNAcb1-2Mana1-6)Manb1-4GlcNAcb1-4GlcNAc |
| 6)GlcNAc | |
| NeuAca2-6Galb1-4GlcNAcb1-2(NeuAca2-3Galb1- | |
| 4GlcNAcb1-4)Mana1-3(NeuAca2-3Galb1- | |
| 4GlcNAcb1-2Mana1-6)Manb1-4GlcNAcb1-4Glc | |
| | NeuGca2-8NeuGca2-3/6Galb1-4(Fuca1- |
| | 3)GlcNAcb1-2Mana1-3(Fuca1-2Galb1-4(Fuca1- |
| | 3)GlcNAcb1-2Mana1-6)Manb1-4GlcNAcb1-4(Fuca1- |
| | 6)GlcNAc |
| Gala1-3Galb1-4GlcNAcb1-2(Galb1-4GlcNAcb1- | Gala1-3Galb1-4GlcNAcb1-2(Galb1-4GlcNAcb1- |
| 4)Mana1-3(Galb1-4GlcNAcb1-2(NeuGca2-3/6Galb1- | 4)Mana1-3(Galb1-4GlcNAcb1-2(Gala1-3Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| Galb1-4GlcNAcb1-3(Gala1-3Galb1-4GlcNAcb1- | Galb1-4GlcNAcb1-2(Galb1-4GlcNAcb1-6)Mana1- |
| 6)Galb1-4GlcNAcb1-2Mana1-3(Gala1-3Galb1- | 3(Galb1-3Galb1-4GlcNAcb1-2(Galb1-3Galb1- |
| 4GlcNAcb1-2Mana1-6)Manb1-4GlcNAcb1-4(Fuca1- | 4GlcNAcb1-4)Mana1-6)Manb1-4GlcNAcb1-4(Fuca1- |
| 6)GlcNAcb | 6)GlcNAc |
| Galb1-4(Fuca1-3)GlcNAcb1-3Galb1-4GlcNAcb1- | Gala1-3Galb1-4GlcNAcb1-2(Gala1-3Galb1- |
| 2(Galb1-4GlcNAcb1-3Galb1-4GlcNAcb1-4)Mana1- | 4GlcNAcb1-4)Mana1-3(Galb1-4GlcNAcb1-2(Galb1- |
| 3(Mana1-3(Mana1-6)Mana1-6)Manb1-4GlcNAcb1- | 4GlcNAcb1-6)Mana1-6)Manb1-4GlcNAcb1-4(Fuca1- |
| 4GlcNAc | 6)GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2(GlcNAcb1-4)Mana1- | 4GlcNAcb1-2(GlcNAcb1-4)Mana1-3)(GlcNAcb1- |
| 3)(GlcNAcb1-2(GlcNAcb1-6)Mana1-6)Manb1- | 2(GlcNAcb1-6)Mana1-6)Manb1-4GlcNAcb1- |
| 4GlcNAcb1-4GlcNAc | 4(Fuca1-6)GlcNAc |
| Mana1-2Mana1-6(Mana1-2(ManaAll)Man[6P]a1- | GlcNAcb1-4(NeuAca2-3/6Galb1-4(Fuca1- |
| 2)Mana1-3(Mana1-3(Mana1-2(ManaAll)Man[6P]a1- | 3)GlcNAcb1-2(GlcNAcb1-4)Mana1-3)(Galb1- |
| 6)Mana1-6)Manb1-4GlcNAcb1-4GlcNAcb | 4GlcNAcb1-2(Galb1-4GlcNAcb1-6)Mana1-6)Manb1- |
| | 4GlcNAcb1-4GlcNAc |
| GlcNAcb1-4(NeuAca2-3/6Galb1-4GlcNAcb1- | Galb1-4(Fuca1-3)GlcNAcb1-2(GalNAcb1- |
| 2(GlcNAcb1-4)Mana1-3)(Galb1-4GlcNAcb1- | 4GlcNAcb1-4)Mana1-3(Galb1-4(Fuca1-3)GlcNAcb1- |
| 2(Galb1-4GlcNAcb1-6)Mana1-6)Manb1-4GlcNAcb1- | 2(Galb1-4(Fuca1-3)GlcNAcb1-6)Mana1-6)Manb1- |
| 4(Fuca1-6)GlcNAc | 4GlcNAcb1-4GlcNAc |
| GlcNAcb1-4(Galb1-4(Fuca1-3)GlcNAcb1-2(Galb1- | Galb1-4(Fuca1-3)GlcNAcb1-2(Galb1-4GlcNAcb1- |
| 4GlcNAcb1-4)Mana1-3)(GlcNAcb1-2(Galb1- | 4)Mana1-3(Galb1-4GlcNAcb1-2(GalNAcb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(Galb1-4(Fuca1-3)GlcNAcb1- | |
| 2(GlcNAcb1-4)Mana1-3)(Galb1-4GlcNAcb1- | |
| 2(Galb1-4(Fuca1-3)GlcNAcb1-6)Mana1-6)Manb1- | |
| 4GlcNAcb1-4(Fuca1-6)GlcNAc | |
| GlcNAcb1-4(Galb1-4(Fuca1-3)GlcNAcb1- | NeuGca2-8NeuGca2-3/6Galb1-4(Fuca1- |
| 2(GlcNAcb1-4)Mana1-3)(Galb1-4(Fuca1- | 3)GlcNAcb1-2Mana1-3(NeuGca2-3/6Galb1- |
| 3)GlcNAcb1-2(Galb1-4(Fuca1-3)GlcNAcb1- | 4GlcNAcb1-2Mana1-6)Manb1-4GlcNAcb1-4(Fuca1- |
| 6)Mana1-6)Manb1-4GlcNAcb1-4GlcNAc | 6)GlcNAc |
| NeuGca2-8NeuGca2-3/6Galb1-4(Fuca1- | Galb1-4GlcNAcb1-2(Galb1-4GlcNAcb1-3Galb1- |
| 3)GlcNAcb1-2Mana1-3(NeuGca2-3/6Galb1- | 4GlcNAcb1-4)Mana1-3(Galb1-4GlcNAcb1-3Galb1- |
| 4(Fuca1-3)GlcNAcb1-2Mana1-6)Manb1-4GlcNAcb1- | 4GlcNAcb1-2(Galb1-4GlcNAcb1-6)Mana1-6)Manb1- |
| 4GlcNAc | 4Glcb |
| Gala1-3Galb1-4GlcNAcb1-2(Galb1-4GlcNAcb1- | Galb1-4GlcNAcb1-2(Galb1-4GlcNAcb1-4)Mana1- |
| 4)Mana1-3(Gala1-3Galb1-4GlcNAcb1-2(Gala1- | 3(Galb1-4GlcNAcb1-3Galb1-4GlcNAcb1-2(Galb1- |
| 3Galb1-4GlcNAcb1-6)Mana1-6)Manb1-4GlcNAcb1- | 4GlcNAcb1-3Galb1-4GlcNAcb1-6)Mana1-6)Manb1- |
| 4GlcNAc | 4Glcb |
| Galb1-4GlcNAcb1-3Galb1-4GlcNAcb1-2(Galb1- | Galb1-4GlcNAcb1-3Galb1-4GlcNAcb1-2(Galb1- |
| 4GlcNAcb1-4)Mana1-3(Galb1-4GlcNAcb1-3Galb1- | 4GlcNAcb1-4)Mana1-3(Galb1-4GlcNAcb1-2(Galb1- |
| 4GlcNAcb1-2(Galb1-4GlcNAcb1-6)Mana1-6)Manb1- | 4GlcNAcb1-3Galb1-4GlcNAcb1-6)Mana1-6)Manb1- |
| 4Glcb | 4Glcb |
| Galb1-4GlcNAcb1-3Galb1-4GlcNAcb1-2(Galb1- | Galb1-4GlcNAcb1-2(Galb1-4GlcNAcb1-3Galb1- |
| 4GlcNAcb1-3Galb1-4GlcNAcb1-4)Mana1-3(Galb1- | 4GlcNAcb1-4)Mana1-3(Galb1-4GlcNAcb1-2(Galb1- |
| 4GlcNAcb1-2(Galb1-4GlcNAcb1-6)Mana1-6)Manb1- | 4GlcNAcb1-3Galb1-4GlcNAcb1-6)Mana1-6)Manb1- |
| 4Glcb | 4Glcb |
| GlcNAcb1-4(NeuAca2-8NeuAca2-3/6Galb1- | GlcNAcb1-4(NeuAca2-8NeuAca2-3/6Galb1-4(Fuca1- |
| 4GlcNAcb1-2Mana1-3)(NeuAca2-3/6Galb1- | 3)GlcNAcb1-2Mana1-3)(NeuAca2-3/6Galb1- |
| 4GlcNAcb1-2Mana1-6)Manb1-4GlcNAcb1-4(Fuca1- | 4GlcNAcb1-2Mana1-6)Manb1-4GlcNAcb1-4GlcNAc |
| 6)GlcNAc | |
| GlcNAcb1-4(NeuAca2-3/6Galb1-4(Fuca1- | GlcNAcb1-4(NeuAca2-8NeuAca2-3/6Galb1-4(Fuca1- |
| 3)GlcNAcb1-2Mana1-3)(NeuAca2-3/6Galb1- | 3)GlcNAcb1-2Mana1-3)(Fuca1-2Galb1-4(Fuca1- |
| 4(Fuca1-3)GlcNAcb1-2Mana1-6)Manb1-4GlcNAcb1- | 3)GlcNAcb1-2Mana1-6)Manb1-4GlcNAcb1-4GlcNAc |
| 4(Fuca1-6)GlcNAc | |
| GlcNAcb1-4(NeuGca2-3/6Galb1-4GlcNAcb1- | GlcNAcb1-4(NeuAca2-3/6Galb1-4GlcNAcb1- |
| 2(GlcNAcb1-4)Mana1-3)(Galb1-4GlcNAcb1- | 2(Galb1-4GlcNAcb1-4)Mana1-3)(Galb1-4GlcNAcb1- |
| 2(Galb1-4GlcNAcb1-6)Mana1-6)Manb1-4GlcNAcb1- | 2(Galb1-4GlcNAcb1-6)Mana1-6)Manb1-4GlcNAcb1- |
| 4(Fuca1-6)GlcNAc | 4GlcNAc |
| | GlcNAcb1-4(NeuGca2-3/6Galb1-4(Fuca1- |
| | 3)GlcNAcb1-2(GlcNAcb1-4)Mana1-3)(Galb1- |
| | 4GlcNAcb1-2(Galb1-4GlcNAcb1-6)Mana1-6)Manb1- |
| | 4GlcNAcb1-4GlcNAc |
| GlcNAcb1-4(Galb1-4(Fuca1-3)GlcNAcb1-2(Galb1- | GlcNAcb1-4(Galb1-4(Fuca1-3)GlcNAcb1-2(Galb1- |
| 4GlcNAcb1-4)Mana1-3)(Galb1-4GlcNAcb1-2(Galb1- | 4GlcNAcb1-4)Mana1-3)(Galb1-4GlcNAcb1-2(Galb1- |
| 4GlcNAcb1-6)Mana1-6)Manb1-4GlcNAcb1-4(Fuca1- | 4(Fuca1-3)GlcNAcb1-6)Mana1-6)Manb1- |
| 6)GlcNAc | 4GlcNAcb1-4GlcNAc |
| NeuAca2-6Galb1-4GlcNAcb1-2(NeuAca2-3Galb1- | Galb1-4GlcNAcb1-2(NeuAca2-3Galb1-3(NeuAca2- |
| 4GlcNAcb1-4)Mana1-3(NeuAca2-3Galb1- | 6)GlcNAcb1-4)Mana1-3(NeuAca2-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-6Galb1-4GlcNAcb1-2(NeuAca2-3Galb1- | GlcNAcb1-4(NeuAca2-8NeuGca2-3/6Galb1- |
| 3GlcNAcb1-4)Mana1-3(NeuAca2-3Galb1- | 4GlcNAcb1-2Mana1-3)(NeuAca2-3/6Galb1- |
| 4GlcNAcb1-2Mana1-6)Manb1-4GlcNAcb1-4GlcNAc | 4GlcNAcb1-2Mana1-6)Manb1-4GlcNAcb1-4(Fuca1- |
| | 6)GlcNAc |
| NeuAca2-6Galb1-4GlcNAcb1-2(NeuAca2-3Galb1- | NeuAca2-3Galb1-4GlcNAcb1-2Mana1-3(NeuAca2- |
| 3GlcNAcb1-4)Mana1-3(NeuAca2-6Galb1- | 6Galb1-4GlcNAcb1-2(NeuAca2-3Galb1-4GlcNAcb1- |
| 4GlcNAcb1-2Mana1-6)Manb1-4GlcNAcb1-4GlcNAcb | 4)Mana1-6)Manb1-4GlcNAcb1-4GlcNAcb |
| NeuAca2-6Galb1-4GlcNAcb1-2(NeuAca2-2Galb1- | GlcNAcb1-4(NeuAca2-8NeuGca2-3/6Galb1- |
| 4GlcNAcb1-4)Mana1-3(NeuAca2-6Galb1- | 4(Fuca1-3)GlcNAcb1-2Mana1-3)(NeuAca2- |
| 4GlcNAcb1-2Mana1-6)Manb1-4GlcNAcb1-4GlcNAcb | 3/6Galb1-4GlcNAcb1-2Mana1-6)Manb1-4GlcNAcb1- |
| | 4GlcNAc |
| NeuAca2-6Galb1-4GlcNAcb1-2(NeuAca2-3Galb1- | NeuAca2-3Galb1-4GlcNAcb1-2Mana1-3(NeuAca2- |
| 3(NeuAca2-6)GlcNAcb1-4)Mana1-3(Galb1- | 6Galb1-4GalNAcb1-2(NeuAca2-3Galb1-4GalNAcb1- |
| 4GlcNAcb1-2Mana1-6)Manb1-4GlcNAcb1-4GlcNAc | 4)Mana1-6)Manb1-4GalNAcb1-4GlcNAcb |
| NeuAca2-3Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-4)Mana1-4(NeuAca2-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-6Galb1-4GlcNAcb1-2(NeuAca2-3Galb1- | |
| 4GlcNAcb1-4)Mana1-3(NeuAca2-6Galb1- | |
| 4GlcNAcb1-2Mana1-6)Manb1-4GlcNAcb1-4GlcNAc | |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2Mana1-6)Manb1-4GlcNAcb1-4GlcNAcb | 4GlcNAcb1-2Mana1-6)Manb1-4GlcNAcb1-4GlcNAcb |
| NeuAca2-6Galb1-4GlcNAcb1-2(NeuAca2-3Galb1- | NeuAca2-6Galb1-4GlcNAcb1-2(NeuAca2-6Galb1- |
| 3GlcNAcb1-4)Mana1-3(NeuAca2-6Galb1- | 4GlcNAcb1-4)Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-6Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3(NeuAca2-6Galb1- | 4GlcNAcb1-4)Mana1-3(NeuAca2-6Galb1- |
| 4GlcNAcb1-2Mana1-6)Manb1-4GlcNAcb1-4GlcNAcb | 4GalNAcb1-2Mana1-6)Manb1-4GlcNAcb1-4GlcNAc |
| NeuAca2-3Galb1-4GlcNAcb1-2(NeuAca2-6Galb1- | NeuAca2-6Galb1-4GlcNAcb1-2Mana1-3(NeuAca2- |
| 4GlcNAcb1-4)Mana1-3(NeuAca2-3Galb1- | 3Galb1-4GlcNAcb1-2(NeuAca2-3Galb1-4GlcNAcb1- |
| 4GlcNAcb1-2Mana1-6)Manb1-4GlcNAcb1-4GlcNAcb | 6)Mana1-6)Manb1-4GlcNAcb1-4GlcNAc |
| NeuAca2-3Galb1-4GlcNAcb1-2(NeuAca2-3Galb1- | NeuAca2-3Galb1-4GlcNAcb1-4(NeuAca2-6Galb1- |
| 4GlcNAcb1-6)Mana1-3(NeuAca2-3Galb1- | 4GlcNAcb1-2Mana1-3)(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-3Galb1-4GlcNAcb1-2Mana1-3(NeuAca2- | NeuAca2-6Galb1-4GlcNAcb1-2(NeuAca2-3Galb1- |
| 3Galb1-4GlcNAcb1-2(NeuAca2-3Galb1-4GlcNAcb1- | 3GlcNAcb1-4)Mana1-3(NeuAca2-6Galb1- |
| 6)Mana1-6)Manb1-4GlcNAcb1-4GlcNAcb | 4GlcNAcb1-2Mana1-6)Manb1-4GlcNAcb1-4GlcNAc |
| NeuAca2-6Galb1-4GlcNAcb1-2(NeuAca2-3Galb1- | NeuAca2-6Galb1-4GlcNAcb1-2Mana1-3(NeuAca2- |
| 4GlcNAcb1-4)Mana1-3(NeuAca2-6Galb1- | 6Galb1-4GlcNAca1-2(NeuAca2-3Galb1-4GlcNAcb1- |
| 4GlcNAcb1-2Mana1-6)Manb1-4GlcNAcb1-4GlcNAc | 4)Mana1-6)Manb1-4GlcNAcb1-4GlcNAc |
| NeuAca2-3Galb1-4GlcNAcb1-2Mana1-3(NeuAca2- | |
| 3Galb1-4GlcNAcb1-2(NeuAca2-3Galb1-4GlcNAcb1- | |
| 6)Mana1-6)Manb1-4GlcNAcb1-4GlcNAc | |
| NeuAca2-3Galb1-4GlcNAcb1-2(NeuAca2-6Galb1- | NeuAca2-6Galb1-4GlcNAcb1-2Mana1-3(NeuAca2- |
| 4GlcNAcb1-4)Mana1-3(NeuAca2-3Galb1- | 6Galb1-4GlcNAcb1-2(NeuAca2-6Galb1-4GlcNAcb1- |
| 4GlcNAcb1-2Mana1-6)Manb1-4GlcNAcb1-4GlcNAc | 6)Mana1-6)Manb1-4GlcNAcb1-4GlcNAc |
| NeuAca2-3Galb1-4GlcNAcb1-2(NeuAca2-3Galb1- | NeuAca2-6Galb1-4GlcNAcb1-2(NeuAca2-6Galb1- |
| 4GlcNAcb1-6)Mana1-3(NeuAca2-6Galb1- | 4GlcNAcb1-6)Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-3Galb1-4GlcNAcb1-2Mana1-3(NeuAca2- | NeuAca2-3Galb1-4GlcNAcb1-2Mana1-3(NeuAca2- |
| 3Galb1-4GlcNAcb1-2(NeuAca2-3Galb1-4GlcNAcb1- | 6Galb1-4GlcNAcb1-2(NeuAca2-3Galb1-4GlcNAcb1- |
| 4)Mana1-6)Manb1-4GlcNAcb1-4GlcNAcb | 6)Mana1-6)Manb1-4GlcNAcb1-4GlcNAc |
| NeuAca2-3Galb1-4GlcNAcb1-2(NeuAca2-6Galb1- | NeuAca2-3Galb1-4GlcNAcb1-2Mana1-3(NeuAca2- |
| 4GlcNAcb1-4)Mana1-3(NeuAca2-6Galb1- | 3Galb1-4GlcNAcb1-2(NeuAca2-3Galb1-4GlcNAcb1- |
| 4GlcNAcb1-2Mana1-6)Manb1-4GlcNAcb1-4GlcNAc | 4)Mana1-6)Manb1-4GlcNAcb1-4GlcNAc |
| NeuAca2-3Galb1-4GlcNAcb1-2Mana1-3(NeuAca2- | NeuAca2-6Galb1-4GlcNAcb1-2Mana1-3(NeuAca2- |
| 6Galb1-4GlcNAcb1-2(NeuAca2-3Galb1-4GlcNAcb1- | 3Galb1-4GlcNAcb1-2(NeuAca2-6Galb1-4GlcNAcb1- |
| 4)Mana1-6)Manb1-4GlcNAcb1-4GlcNAc | 4)Mana1-6)Manb1-4GlcNAcb1-4GlcNAc |
| NeuAca2-6Galb1-4GlcNAcb1-2Mana1-3(NeuAca2- | NeuAca2-3Galb1-4GlcNAcb1-2Mana1-3(NeuAca2- |
| 6Galb1-4GlcNAcb1-2(NeuAca2-3Galb1-4GlcNAcb1- | 6Galb1-4GlcNAcb1-2(NeuAca2-6Galb1-4GlcNAcb1- |
| 4)Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuAca2-6Galb1-3GlcNAcb1-2Mana1-3(NeuAca2- |
| 4GlcNAcb1-6)Mana1-3(NeuAca2-3Galb1- | 6Galb1-4GlcNAcb1-2(NeuAca2-3Galb1-4GlcNAcb1- |
| 4GlcNAcb1-2Mana1-6)Manb1-4GlcNAcb1-4GlcNAc | 6)Mana1-6)Manb1-4GlcNAcb1-4GlcNAc |
| NeuAca2-6Galb1-4GlcNAcb1-2Mana1-3(NeuAca2- | NeuAca2-6Galb1-4GlcNAcb1-2Mana1-3(NeuAca2- |
| 6Galb1-4GlcNAcb1-2(NeuAca2-3Galb1-4GlcNAcb1- | 3Galb1-4GlcNAcb1-2(NeuAca2-6Galb1-4GlcNAcb1- |
| 6)Mana1-6)Manb1-4GlcNAcb1-4GlcNAc | 6)Mana1-6)Manb1-4GlcNAcb1-4GlcNAc |
| | NeuAca2-6Galb1-4GlcNAcb1-2Mana1-3(NeuAca2- |
| | 6Galb1-4GlcNAcb1-2(NeuAca2-6Galb1-4GlcNAcb1- |
| | 4)Mana1-6)Manb1-4GlcNAcb1-4GlcNAc |
| NeuAca2-6Galb1-4GlcNAcb1-2(NeuAca2-3Galb1- | NeuAca2-6Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-6Galb1-4GlcNAcb1-2(NeuAca2-6Galb1- | NeuAca2-3Galb1-4GlcNAcb1-2Mana1-3(NeuAca2- |
| 4GlcNAcb1-4)Mana1-3(NeuAca2-3Galb1- | 3Galb1-4GlcNAcb1-2(NeuAca2-6Galb1-4GlcNAcb1- |
| 4GlcNAcb1-2Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuAca2-3Galb1-4GlcNAcb1-2Mana1-3(NeuAca2- |
| 4GlcNAcb1-4)Mana1-3(NeuAca2-6Galb1- | 3Galb1-4GlcNAcb1-2(NeuAca2-6Galb1-4GlcNAcb1- |
| 4GlcNAcb1-2Mana1-6)Manb1-4GlcNAcb1-4GlcNAc | 4)Mana1-6)Manb1-4GlcNAcb1-4GlcNAc |
| NeuAca2-6Galb1-4GlcNAcb1-2Mana1-3(NeuAca2- | NeuAca2-3Galb1-4GlcNAcb1-2Mana1-3(NeuAca2- |
| 3Galb1-4GlcNAcb1-2(NeuAca2-3Galb1-4GlcNAcb1- | 6Galb1-4GlcNAcb1-2(NeuAca2-6Galb1-4GlcNAcb1- |
| 4)Mana1-6)Manb1-4GlcNAcb1-4GlcNAc | 4)Mana1-6)Manb1-4GlcNAcb1-4GlcNAc |
| NeuAca2-3Galb1-4GlcNAcb1-2(NeuAca2-3Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-3Galb1- |
| 4GlcNAcb1-2Mana1-6)Manb1-4GlcNAcb1-4GlcNAc | 4GlcNAcb1-2Mana1-6)Manb1-4GlcNAcb1-4GlcNAc |
| NeuAca2-3Galb1-4GlcNAcb1-2(NeuAca2-6Galb1- | GlcNAcb1-4(NeuAca2-8NeuGca2-3/6Galb1- |
| 4GlcNAcb1-6)Mana1-3(NeuAca2-6Galb1- | 4(Fuca1-3)GlcNAcb1-2Mana1-3)(Fuca1-2Galb1- |
| 4GlcNAcb1-2Mana1-6)Manb1-4GlcNAcb1-4GlcNAc | 4(Fuca1-3)GlcNAcb1-2Mana1-6)Manb1-4GlcNAcb1- |
| | 4GlcNAc |
| NeuAca2-3/6Galb1-4GlcNAcb1-2Mana1-3(NeuAca2- | GlcNAcb1-4(NeuGca2-3/6Galb1-4(Fuca1- |
| 3/6Galb1-4GlcNAcb1-2(Galb1-4(Fuca1-3)GlcNAcb1- | 3)GlcNAcb1-2Mana1-3)(NeuAca2-3/6Galb1- |
| 6)Mana1-6)Manb1-4GlcNAcb1-2(Fuca1-6)GlcNAc | 4(Fuca1-3)GlcNAcb1-2Mana1-6)Manb1-4GlcNAcb1- |
| | 4(Fuca1-6)GlcNAc |
| GlcNAcb1-4(NeuGca2-3/6Galb1-4GlcNAcb1- | |
| 2(Galb1-4GlcNAcb1-4)Mana1-3)(Galb1-4GlcNAcb1- | |
| 2(Galb1-4GlcNAcb1-6)Mana1-6)Manb1-4GlcNAcb1- | |
| 4GlcNAc | |
| Galb1-4GlcNAcb1-2(Galb1-4GlcNAcb1-4)Mana1- | GlcNAcb1-4(Gala1-3Galb1-4GlcNAcb1-2(Galb1- |
| 3(Galb1-4GlcNAcb1-3Galb1-4GlcNAcb1-2(Galb1- | 4GlcNAcb1-4)Mana1-3)(Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| Galb1-4GlcNAcb1-3Galb1-4GlcNAcb1-2(Galb1- | Galb1-4GlcNAcb1-2(Galb1-4GlcNAcb1-3Galb1- |
| 4GlcNAcb1-4)Mana1-3(Galb1-4GlcNAcb1-2(Galb1- | 4GlcNAcb1-4)Mana1-3(Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| GlcNAcb1-4(Galb1-4(Fuca1-3)GlcNAcb1-2(Galb1- | Galb1-4(Fuca1-3)GlcNAcb1-2(Galb1-4GlcNAcb1- |
| 4GlcNAcb1-4)Mana1-3)(Galb1-4GlcNAcb1-2(Gala1- | 4)Mana1-3(Galb1-4GlcNAcb1-3Galb1-4GlcNAcb1- |
| 3Galb1-4GlcNAcb1-6)Mana1-6)Manb1-4GlcNAcb1- | 2(Galb1-4GlcNAcb1-6)Mana1-6)Manb1-4GlcNAcb1- |
| 4GlcNAc | 4GlcNAc |
| GalNAcb1-4GlcNAcb1-3(Gala1-3Galb1-4GlcNAcb1- | Galb1-4GlcNAcb1-2(Galb1-4GlcNAcb1-4)Mana1- |
| 6)Galb1-4GlcNAcb1-2Mana1-3(Gala1-3Galb1- | 3(Galb1-4GlcNAcb1-3Galb1-4GlcNAcb1-2(Galb1- |
| 4GlcNAcb1-2Mana1-6)Manb1-4GlcNAcb1-4(Fuca1- | 4GlcNAcb1-6)Mana1-6)Manb1-4GlcNAcb1-4(Fuca1- |
| 6)GlcNAcb | 6)GlcNAc |
| Galb1-4GlcNAcb1-3Galb1-4GlcNAcb1-2(Galb1- | Galb1-4GlcNAcb1-2(Galb1-4GlcNAcb1-4)Mana1- |
| 4GlcNAcb1-4)Mana1-3(Galb1-4GlcNAcb1-2(Galb1- | 3(Galb1-4GlcNAcb1-2(Galb1-4GlcNAcb1-4)(Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| Galb1-4GlcNAcb1-2(Galb1-4GlcNAcb1-4)Mana1- | Galb1-4GlcNAcb1-2(Galb1-4GlcNAcb1-4)(Galb1- |
| 3(Galb1-4GlcNAcb1-2(Galb1-4GlcNAcb1-3Galb1- | 4GlcNAcb1-6)Mana1-3(Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2Mana1-3)(NeuAca2- | 4GlcNAcb1-2Mana1-3)(NeuAca2-3/6Galb1- |
| 3/6Galb1-4GlcNAcb1-2Mana1-6)Manb1-4GlcNAcb1- | 4GlcNAcb1-2Mana1-6)Manb1-4GlcNAcb1-4(Fuca1- |
| 4GlcNAc | 6)GlcNAc |
| GlcNAcb1-4(NeuGca2-3/6Galb1-4(Fuca1- | GlcNAcb1-4(NeuGca2-8NeuGca2-3/6Galb1- |
| 3)GlcNAcb1-2Mana1-3)(NeuGca2-3/6Galb1- | 4(Fuca1-3)GlcNAcb1-2Mana1-3)(Fuca1-2Galb1- |
| 4(Fuca1-3)GlcNAcb1-2Mana1-6)Manb1-4GlcNAcb1- | 4(Fuca1-3)GlcNAcb1-2Mana1-6)Manb1-4GlcNAcb1- |
| 4(Fuca1-6)GlcNAc | 4GlcNAc |
| | Galb1-4(Fuca1-3)GlcNAcb1-2(NeuGca2-3/6Galb1- |
| | 4GlcNAcb1-4)Mana1-3(NeuAca2-3/6Galb1- |
| | 4GlcNAcb1-2Mana1-6)Manb1-4GlcNAcb1-4(Fuca1- |
| | 6)GlcNAc |
| NeuAca2-6Galb1-4GlcNAcb1-2(Gala1-3Galb1- | NeuAca2-3Galb1-4GlcNAcb1-2Mana1-3(NeuAca2- |
| 4GlcNAcb1-4)Mana1-3(NeuAca2-6Galb1- | 3Galb1-4GlcNAcb1-2(Galb1-3Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAc |
| 6)GlcNAcb | |
| NeuAca2-3Galb1-4GlcNAcb1-2(Gala1-3Galb1- | GlcNAcb1-4(NeuAca2-3/6Galb1-4(Fuca1- |
| 4GlcNAcb1-4)Mana1-3(NeuAca2-3Galb1- | 3)GlcNAcb1-2(Galb1-4(Fuca1-3)GlcNAcb1- |
| 4GlcNAcb1-2Mana1-6)Manb1-4GlcNAcb1-4(Fuca1- | 4)Mana1-3)(Mana1-3(Mana1-6)Mana1-6)Manb1- |
| 6)GlcNAcb | 4GlcNAcb1-4(Fuca1-6)GlcNAc |
| GlcNAcb1-4(Gala1-3Galb1-4GlcNAcb1-2(Galb1- | Galb1-4GlcNAcb1-3Galb1-4GlcNAcb1-3Galb1- |
| 4GlcNAcb1-4)Mana1-3)(Galb1-4GlcNAcb1-2(Gala1- | 4GlcNAcb1-3Galb1-4GlcNAcb1-2Mana1-3(Galb1- |
| 3Galb1-4GlcNAcb1-6)Mana1-6)Manb1-4GlcNAcb1- | 3Galb1-4GlcNAcb1-2Mana1-6)Manb1-4GlcNAcb1- |
| 4GlcNAc | 4GlcNAc |
| Galb1-4GlcNAcb1-3Galb1-4GlcNAcb1-3Galb1- | Galb1-4GlcNAcb1-3Galb1-4GlcNAcb1-2(Galb1- |
| 4GlcNAcb1-2Mana1-3(Galb1-4GlcNAcb1-3Galb1- | 4GlcNAcb1-3Galb1-4GlcNAcb1-4)Mana1-3(Galb1- |
| 4GlcNAcb1-3Galb1-4GlcNAcb1-2Mana1-6)Manb1- | 4GlcNAcb1-3Galb1-4GlcNAcb1-2Mana1-6)Manb1- |
| 4GlcNAc | 4GlcNAc |
| Galb1-4GlcNAcb1-3Galb1-4GlcNAcb1-2(Galb1- | Galb1-4GlcNAcb1-3Galb1-4GlcNAcb1-2Mana1- |
| 4GlcNAcb1-3Galb1-4GlcNAcb1-6)Mana1-3(Galb1- | 3(Galb1-4GlcNAcb1-3Galb1-4GlcNAcb1-2(Galb1- |
| 4GlcNAcb1-3Galb1-4GlcNAcb1-2Mana1-6)Manb1- | 4GlcNAcb1-3Galb1-4GlcNAcb1-6)Mana1-6)Manb1- |
| 4GlcNAc | 4GlcNAc |
| NeuAca2-8NeuAca2-3/6Galb1-4(Fuca1-3)GlcNAcb1- | NeuAca2-8NeuAca2-3/6Galb1-4(Fuca1-3)GlcNAcb1- |
| 2(Fuca1-3GlcNAcb1-4)Mana1-3(GlcNAcb1-2(Fuca1- | 2(GlcNAcb1-4)Mana1-3(GlcNAcb1-2(Fuca1- |
| 3GlcNAcb1-6)Mana1-6)Manb1-4GlcNAcb1-4GlcNAc | 3GlcNAcb1-6)Mana1-6)Manb1-4GlcNAcb1-4(Fuca1- |
| | 6)GlcNAc |
| GlcNAcb1-4(NeuAca2-8NeuAca2-3/6Galb1-4(Fuca1- | NeuAca2-3/6Galb1-4GlcNAcb1-3Galb1-4GlcNAcb1- |
| 3)GlcNAcb1-2Mana1-3)(GalNAcb1-4(Fuca1- | 2(GlcNAcb1-4)Mana1-3(GalNAcb1-4GlcNAcb1- |
| 3)GlcNAcb1-2Mana1-6)Manb1-4GlcNAcb1-4(Fuca1- | 2(Galb1-4GlcNAcb1-6)Mana1-6)Manb1-4GlcNAcb1- |
| 6)GlcNAc | 4GlcNAc |
| GlcNAcb1-4(Galb1-4(Fuca1-3)GlcNAcb1-2(Galb1- | |
| 4GlcNAcb1-4)Mana1-3)(Galb1-4GlcNAcb1- | |
| 2(GalNAcb1-4(Fuca1-3)GlcNAcb1-6)Mana1- | |
| 6)Manb1-4GlcNAcb1-4GlcNAc | |
| Galb1-4(Fuca1-3)GlcNAcb1-3Galb1-4GlcNAcb1- | Galb1-4(Fuca1-3)GlcNAcb1-3Galb1-4(Fuca1- |
| 2(GlcNAcb1-4)Mana1-3(GalNAcb1-4GlcNAcb1- | 3)GlcNAcb1-2(GlcNAcb1-4)Mana1-3(GalNAcb1- |
| 2(Galb1-4GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| GlcNAcb1-4(NeuGca2-8NeuGca2-3/6Galb1- | GlcNAcb1-4(NeuGca2-8NeuGca2-3/6Galb1- |
| 4GlcNAcb1-2Mana1-3)(NeuGca2-3/6Galb1- | 4(Fuca1-3)GlcNAcb1-2Mana1-3)(NeuGca2- |
| 4GlcNAcb1-2Mana1-6)Manb1-4GlcNAcb1-4(Fuca1- | 3/6Galb1-4GlcNAcb1-2Mana1-6)Manb1-4GlcNAcb1- |
| 6)GlcNAc | 4GlcNAc |
| NeuGca2-3/6Galb1-4GlcNAcb1-2(NeuGca2- | NeuGca2-3/6Galb1-4GlcNAcb1-2(NeuAca2- |
| 3/6Galb1-4GlcNAcb1-4)Mana1-3(Galb1-4(Fuca1- | 3/6Galb1-4GlcNAcb1-4)Mana1-3(Gala1-3Galb1- |
| 3)GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(Galb1-4(Fuca1-3)GlcNAcb1- | 3)GlcNAcb1-2(Gala1-3Galb1-4GlcNAcb1-4)Mana1- |
| 4)Mana1-3)(Mana1-3(Mana1-6)Mana1-6)Manb1- | 3)(Mana1-3(Mana1-6)Mana1-6)Manb1-4GlcNAcb1- |
| 4GlcNAcb1-4(Fuca1-6)GlcNAc | 4(Fuca1-6)GlcNAc |
| NeuAca2-8NeuGca2-3/6Galb1-4(Fuca1- | GlcNAcb1-4(NeuAca2-8NeuGca2-3/6Galb1- |
| 3)GlcNAcb1-2(GlcNAcb1-4)Mana1-3(GlcNAcb1- | 4(Fuca1-3)GlcNAcb1-2Mana1-3)(GalNAcb1- |
| 2(Fuca1-3GlcNAcb1-6)Mana1-6)Manb1-4GlcNAcb1- | 4(Fuca1-3)GlcNAcb1-2Mana1-6)Manb1-4GlcNAcb1- |
| 4(Fuca1-6)GlcNAc | 4(Fuca1-6)GlcNAc |
| NeuAca2-8NeuGca2-3/6Galb1-4(Fuca1- | NeuGca2-3/6Galb1-4GlcNAcb1-3Galb1-4GlcNAcb1- |
| 3)GlcNAcb1-2(Fuca1-3GlcNAcb1-4)Mana1- | 2(GlcNAcb1-4)Mana1-3(GalNAcb1-4GlcNAcb1- |
| 3(GlcNAcb1-2(Fuca1-3GlcNAcb1-6)Mana1- | 2(Galb1-4GlcNAcb1-6)Mana1-6)Manb1-4GlcNAcb1- |
| 6)Manb1-4GlcNAcb1-4GlcNAc | 4GlcNAc |
| Galb1-4(Fuca1-3)GlcNAcb1-3Galb1-4GlcNAcb1- | GlcNAcb1-4(GlcNAcb1-3Galb1-4GlcNAcb1-2(Galb1- |
| 2(GlcNAcb1-4)Mana1-3(GalNAcb1-4GlcNAcb1- | 4GlcNAcb1-4)Mana1-3)(Galb1-4GlcNAcb1-2(Galb1- |
| 2(Gala1-3Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuGca2-6/3Galb1-4GlcNAcb1-2(NeuGca2- | |
| 6/3Galb1-4GlcNAcb1-4)Mana1-3(NeuGca2- | |
| 6/3Galb1-4GlcNAcb1-2Mana1-6)Manb1-4GlcNAcb1- | |
| 4GlcNAc | |
| NeuGca2-3/6Galb1-4GlcNAcb1-2(NeuGca2- | GlcNAcb1-4(NeuGca2-3/6Galb1-4(Fuca1- |
| 3/6Galb1-4GlcNAcb1-4)Mana1-3(Gala1-3Galb1- | 3)GlcNAcb1-2(Gala1-3Galb1-4GlcNAcb1-4)Mana1- |
| 4GlcNAcb1-2Mana1-6)Manb1-4GlcNAcb1-4(Fuca1- | 3)(Mana1-3(Mana1-6)Mana1-6)Manb1-4GlcNAcb1- |
| 6)GlcNAc | 4(Fuca1-6)GlcNAc |
| Gala1-3Galb1-4GlcNAcb1-3Galb1-4GlcNAcb1- | NeuGca2-8NeuGca2-3/6Galb1-4(Fuca1- |
| 2(NeuAca2-3/6Galb1-4GlcNAcb1-4)Mana1- | 3)GlcNAcb1-2(GlcNAcb1-4)Mana1-3(GlcNAcb1- |
| 3(Mana1-3(Mana1-6)Mana1-6)Manb1-4GlcNAcb1- | 2(Fuca1-3GlcNAcb1-6)Mana1-6)Manb1-4GlcNAcb1- |
| 4(Fuca1-6)GlcNAc | 4(Fuca1-6)GlcNAc |
| NeuGca2-8NeuGca2-3/6Galb1-4(Fuca1- | NeuAca2-3/6Galb1-4(Fuca1-3)GlcNAcb1- |
| 3)GlcNAcb1-2(Fuca1-3GlcNAcb1-4)Mana1- | 2(GlcNAcb1-4)Mana1-3(Galb1-4GlcNAcb1- |
| 3(GlcNAcb1-2(Fuca1-3GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4GlcNAc |
| NeuAca2-3/6Galb1-4GlcNAcb1-2(GlcNAcb1- | GlcNAcb1-4(NeuGca2-8NeuGca2-3/6Galb1- |
| 4)Mana1-3(Galb1-4GlcNAcb1-2(NeuAca2-3/6Galb1- | 4(Fuca1-3)GlcNAcb1-2Mana1-3)(GalNAcb1- |
| 4GlcNAcb1-6)Mana1-6)Manb1-4GlcNAcb1-4(Fuca1- | 4(Fuca1-3)GlcNAcb1-2Mana1-6)Manb1-4GlcNAcb1- |
| 6)GlcNAc | 4(Fuca1-6)GlcNAc |
| NeuAca2-6Galb1-4GlcNAcb1-2(GalNAcb1- | GlcNAcb1-4(Galb1-4GlcNAcb1-2Mana1- |
| 4(NeuAca2-3)Galb1-4GlcNAcb1-4)Mana1-3(Galb1- | 3)(NeuAca2-3Galb1-4GlcNAcb1-2(NeuAca2-3Galb1- |
| 4GlcNAcb1-2Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAcb |
| GlcNAcb1-4(NeuAca2-3/6Galb1-4GlcNAcb1- | NeuAca2-3/6Galb1-4(Fuca1-3)GlcNAcb1- |
| 2(Galb1-4(Fuca1-3)GlcNAcb1-4)Mana1-3)(Galb1- | 2(GlcNAcb1-4)Mana1-3(Galb1-4GlcNAcb1-2(Galb1- |
| 4(Fuca1-3)GlcNAcb1-2Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4(Fuca1-6)GlcNAc |
| GlcNAcb1-4(Galb1-4GlcNAcb1-2(Galb1-4GlcNAcb1- | GlcNAcb1-4(Galb1-4GlcNAcb1-2(Galb1-4GlcNAcb1- |
| 4)Mana1-3)(Galb1-4GlcNAcb1-2(Galb1-4GlcNAcb1- | 4)Mana1-3)(Galb1-4GlcNAcb1-3Galb1-4GlcNAcb1- |
| 4)(Galb1-4GlcNAcb1-6)Mana1-6)Manb1- | 2(Galb1-4GlcNAcb1-6)Mana1-6)Manb1-4GlcNAcb1- |
| 4GlcNAcb1-4GlcNAc | 4GlcNAc |
| Galb1-4GlcNAcb1-3Galb1-4GlcNAcb1-2(GlcNAcb1- | Gala1-3Galb1-4GlcNAcb1-3Galb1-4GlcNAcb1- |
| 4)Mana1-3(Galb1-4GlcNAcb1-3Galb1-4GlcNAcb1- | 2(NeuGca2-3/6Galb1-4GlcNAcb1-4)Mana1- |
| 2(Galb1-4GlcNAcb1-6)Mana1-6)Manb1-4GlcNAcb1- | 3(Mana1-3(Mana1-6)Mana1-6)Manb1-4GlcNAcb1- |
| 4GlcNAc | 4(Fuca1-6)GlcNAc |
| | NeuAca2-3(NeuAca2-6)Galb1-3GlcNAcb1-4Mana1- |
| | 3(NeuAca2-3(NeuAca2-6)Galb1-3GlcNAcb1- |
| | 4Mana1-6)Manb1-4GlcNAcb1-4(Fuca1-6)GlcNAcb |
| NeuAca2-8NeuAca2-3/6Galb1-4(Fuca1-3)GlcNAcb1- | NeuGca2-3/6Galb1-4(Fuca1-3)GlcNAcb1- |
| 2Mana1-3(NeuAca2-3/6Galb1-4(Fuca1-3)GlcNAcb1- | 2(GlcNAcb1-4)Mana1-3(Galb1-4GlcNAcb1- |
| 2Mana1-6)Manb1-4GlcNAcb1-4(Fuca1-6)GlcNAc | 2(NeuAca2-3/6Galb1-4GlcNAcb1-6)Mana1- |
| | 6)Manb1-4GlcNAcb1-4GlcNAc |
| NeuAca2-6Galb1-4GlcNAcb1-2(NeuAca2-6Galb1- | NeuAca2-3/6Galb1-4GlcNAcb1-2(Galb1-4GlcNAcb1- |
| 4GlcNAcb1-4)Mana1-3(Galb1-4GlcNAcb1-2(Galb1- | 4)Mana1-3(Galb1-4GlcNAcb1-2(NeuAca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| Galb1-4GlcNAcb1-2(NeuAca2-6Galb1-4GlcNAcb1- | Galb1-4GlcNAcb1-2(Galb1-4GlcNAcb1-4)Mana1- |
| 4)Mana1-3(Galb1-4GlcNAcb1-2(NeuAca2-6Galb1- | 3(NeuAca2-6Galb1-4GlcNAcb1-2(NeuAca2-6Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| NeuGca2-3/6Galb1-4GlcNAcb1-2(GlcNAcb1- | NeuAca2-6Galb1-4GlcNAcb1-2(NeuAca2-6Galb1- |
| 4)Mana1-3(Galb1-4GlcNAcb1-2(NeuAca2-3/6Galb1- | 4GlcNAcb1-4)Mana1-3(Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| NeuAca2-3/6Galb1-4GlcNAcb1-2(NeuAca2- | NeuAca2-6Galb1-4GlcNAcb1-2(Galb1-4GlcNAcb1- |
| 3/6Galb1-4GlcNAcb1-4)Mana1-3(Galb1-4GlcNAcb1- | 4)Mana1-3(NeuAca2-6Galb1-4GcNAcb1-2(Galb1- |
| 2(Galb1-4GlcNAcb1-6)Mana1-6)Manb1-4GlcNAcb1- | 4GlcNAcb1-6)Mana1-6)Manb1-4GlcNAcb1-4GlcNAc |
| 4GlcNAc | |
| NeuGca2-3/6Galb1-4(Fuca1-3)GlcNAcb1- | NeuAca2-3/6Galb1-4(Fuca1-3)GlcNAcb1-2(Galb1- |
| 2(GlcNAcb1-4)Mana1-3(Galb1-4GlcNAcb1-2(Galb1- | 4GlcNAcb1-4)Mana1-3(Galb1-4GlcNAcb1-2(Galb1- |
| 4(Fuca1-3)GlcNAcb1-6)Mana1-6)Manb1- | 4(Fuca1-3)GlcNAcb1-6)Mana1-6)Manb1- |
| 4GlcNAcb1-4(Fuca1-6)GlNcAc | 4GlcNAcb1-4GlcNAc |
| NeuAca2-3/6Galb1-4(Fuca1-3)GlcNAcb1-2(Galb1- | Galb1-4(Fuca1-3)GlcNAcb1-2(Galb1-4(Fuca1- |
| 4GlcNAcb1-4)Mana1-3(Galb1-4GlcNAcb1-2(Galb1- | 3)GlcNAcb1-4)Mana1-3(Galb1-4(Fuca1- |
| 4GlcNAcb1-6)Mana1-6)Manb1-4GlcNAcb1-4(Fuca1- | 3)GlcNAcb1-2(Galb1-4(Fuca1-3)GlcNAcb1- |
| 6)GlcNAc | 6)Mana1-6)Manb1-4GlcNAcb1-4GlcNAc |
| Galb1-4(Fuca1-3)GlcNAcb1-2(Galb1-4(Fuca1- | |
| 3)GlcNAcb1-4)Mana1-3(Galb1-4GlcNAcb1-2(Galb1- | |
| 4(Fuca1-3)GlcNAcb1-6)Mana1-6)Manb1- | |
| 4GlcNAcb1-4(Fuca1-6)GlcNAc | |
| Galb1-4(Fuca1-3)GlcNAcb1-2(Galb1-4GlcNAcb1- | Galb1-4GlcNAcb1-3Galb1-4(Fuca1-3)GlcNAcb1- |
| 4)Mana1-3(Galb1-4(Fuca1-3)GlcNAcb1-2(Galb1- | 2Mana1-3(Galb1-4(Fuca1-3)GlcNAcb1-3Galb1- |
| 4(Fuca1-3)GlcNAcb1-6)Mana1-6)Manb1- | 4(Fuca1-3)GlcNAcb1-2Mana1-6)Manb1-4GlcNAcb1- |
| 4GlcNAcb1-4(Fuca1-6)GlcNAc | 4(Fuca1-6)GlcNAc |
| Galb1-4GlcNAcb1-2(Galb1-4(Fuca1-3)GlcNAcb1- | Galb1-4GlcNAcb1-2(Galb1-4(Fuca1-3)GlcNAcb1- |
| 4)Mana1-3(Galb1-4(Fuca1-3)GlcNAcb1-2(Galb1- | 4Galb1-4(Fuca1-3)GlcNAcb1-4)Mana1-3(Galb1- |
| 4(Fuca1-3)GlcNAcb1-6)Mana1-6)Manb1- | 4(Fuca1-3)GlcNAcb1-2Mana1-6)Manb1-4GlcNAcb1- |
| 4GlcNAcb1-4(Fuca1-6)GlcNAc | 4(Fuca1-6)GlcNAc |
| GlcNAcb1-4(Kdna1-3Galb1-4GlcNAcb1-2(Kdna1- | GlcNAcb1-4(NeuAca2-8NeuAca2-3/6Galb1-4(Fuca1- |
| 3Galb1-4GlcNAcb1-4)Mana1-3)(Kdna1-3Galb1- | 3)GlcNAcb1-2(GlcNAcb1-4)Mana1-3)(GlcNAcb1- |
| 4GlcNAcb1-2Mana1-6)Manb1-4GlcNAcb1-4GlcNAcb | 2(Fuca1-3GlcNAcb1-6)Mana1-6)Manb1-4GlcNAcb1- |
| | 4GlcNAc |
| GlcNAcb1-4(NeuAca2-8NeuAca2-3/6Galb1-4(Fuca1- | GlcNAcb1-4(Galb1-4(Fuca1-3)GlcNAcb1-3Galb1- |
| 3)GlcNAcb1-2(GlcNAcb1-4)Mana1-3)(GlcNAcb1- | 4GlcNAcb1-2(GlcNAcb1-4)Mana1-3)(GalNAcb1- |
| 2(GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| GlcNAcb1-3Galb1-4GlcNAcb1-2(GlcNAcb1-4)Mana1- | GlcNAcb1-4(Galb1-4GlcNAcb1-3Galb1-4GlcNAcb1- |
| 3(GlcNAcb1-3Galb1-4GlcNAcb1-2(GlcNAcb1- | 2(GlcNAcb1-4)Mana1-3)(GalNAcb1-4GlcNAcb1- |
| 3Galb1-4GlcNAcb1-6)Mana1-6)Manb1-4GlcNAcb1- | 2(Galb1-4GlcNAcb1-6)Mana1-6)Manb1-4GlcNAcb1- |
| 4(Fuca1-6)GlcNAc | 4(Fuca1-6)GlcNAc |
| NeuAca2-3/6Galb1-4(Fuca1-3)GlcNAcb1- | NeuAca2-8NeuGca2-3/6Galb1-4(Fuca1- |
| 2(NeuAca2-8NeuAca2-3/6Galb1-4(Fuca1- | 3)GlcNAcb1-2Mana1-3(NeuAca2-3/6Galb1-4(Fuca1- |
| 3)GlcNAcb1-4)Mana1-3(Mana1-3Mana1-6)Manb1- | 3)GlcNAcb1-2Mana1-6)Manb1-4GlcNAcb1-4(Fuca1- |
| 4GlcNAcb1-4GlcNAc | 6)GlcNAc |
| NeuGca2-3/6Galb1-4GlcNAcb1-2(Galb1-4GlcNAcb1- | NeuGca2-3/6Galb1-4GlcNAcb1-2(GlcNAcb1- |
| 4)Mana1-3(Galb1-4GlcNAcb1-2(NeuAca2-3/6Galb1- | 4)Mana1-3(Galb1-4GlcNAcb1-2(NeuGca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| NeuGca2-3/6Galb1-4(Fuca1-3)GlcNAcb1- | Gala1-3Galb1-4GlcNAcb1-2(Galb1-4GlcNAcb1- |
| 2(GlcNAcb1-4)Mana1-3(Galb1-4GlcNAcb1- | 4)Mana1-3(Galb1-4GlcNAcb1-2(NeuAca2-3/6Galb1- |
| 2(NeuGca2-3/6Galb1-4GlcNAcb1-6)Mana1- | 4GlcNAcb1-6)Mana1-6)Manb1-4GlcNAcb1-4(Fuca1- |
| 6)Manb1-4GlcNAcb1-4GlcNAc | 6)GlcNAc |
| | NeuGca2-3/6Galb1-4(Fuca1-3)GlcNAcb1-2(Galb1- |
| | 4GlcNAcb1-4)Mana1-3(Galb1-4GlcNAcb1-2(Galb1- |
| | 4GlcNAcb1-6)Mana1-6)Manb1-4GlcNAcb1-4(Fuca1- |
| | 6)GlcNAc |
| NeuAca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(Galb1-4GlcNAcb1-2(Gala1- | 4GlcNAcb1-4)Mana1-3(Galb1-4GlcNAcb1-2(Galb1- |
| 3Galb1-4GlcNAcb1-6)Mana1-6)Manb1-4GlcNAcb1- | 4(Fuca1-3)GlcNAcb1-6)Mana1-6)Manb1- |
| 4GlcNAc | 4GlcNAcb1-4GlcNAc |
| Gala1-3Galb1-4(Fuca1-3)GlcNAcb1-2(Galb1- | NeuAca2-4GlcNAcb1-3(NeuAca2-6)Galb1- |
| 4GlcNAcb1-4)Mana1-3(Galb1-4GlcNAcb1-2(Galb1- | 4GlcNAcb1-3(NeuAca2-6)Galb1-4GlcNAcb1- |
| 4(Fuca1-3)GlcNAcb1-6)Mana1-6)Manb1- | 3(NeuAca2-6)Galb1-4GlcNAcb1-3(NeuAca2- |
| 4GlcNAcb1-4(Fuca1-6)GlcNAc | 6)GalNAc |
| GlcNAcb1-4(NeuAca2-8NeuGca2-3/6Galb1- | GlcNAcb1-4(NeuAca2-8NeuGca2-3/6Galb1- |
| 4(Fuca1-3)GlcNAcb1-2(GlcNAcb1-4)Mana1- | 4(Fuca1-3)GlcNAcb1-2(GlcNAcb1-4)Mana1- |
| 3)(GlcNAcb1-2(Fuca1-3GlcNAcb1-6)Mana1- | 3)(GlcNAcb1-2(GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-3Galb1-4GlcNAcb1-2(GlcNAcb1-3Galb1- | NeuGca2-8NeuGca2-3/6Galb1-4(Fuca1- |
| 4GlcNAcb1-4)Mana1-3(GlcNAcb1-3Galb1- | 3)GlcNAcb1-2Mana1-3(NeuAca2-3/6Galb1-4(Fuca1- |
| 4GlcNAcb1-2(GlcNAcb1-3Galb1-4GlcNAcb1- | 3)GlcNAcb1-2Mana1-6)Manb1-4GlcNAcb1-4(Fuca1- |
| 6)Mana1-6)Manb1-4GlcNAc | 6)GlcNAc |
| NeuAca2-3/6Galb1-4(Fuca1-3)GlcNAcb1- | NeuAca2-3/6Galb1-4(Fuca1-3)GlcNAcb1- |
| 2(NeuAca2-8NeuAca2-3/6Galb1-4GlcNAcb1- | 2(NeuAca2-8NeuGca2-3/6Galb1-4(Fuca1- |
| 4)Mana1-3(Mana1-3(Mana1-6)Mana1-6)Manb1- | 3)GlcNAcb1-4)Mana1-3(Mana1-3Mana1-6)Manb1- |
| 4GlcNAcb1-4GlcNAc | 4GlcNAcb1-4GlcNAc |
| NeuAca2-3Galb1-4(Fuca1-3)Glcb1-4(NeuAca2- | NeuGca2-3/6Galb1-4GlcNAcb1-2(Galb1-4GlcNAcb1- |
| 6Galb1-4GlcNAcb1-2)Mana1-3(NeuAca2-3Galb1- | 4)Mana1-3(Galb1-4GlcNAcb1-2(NeuGca2-3/6Galb1- |
| 4GlcNAcb1-2Mana1-6)Manb1-4GlcNAcb1-4GlcNAc | 4GlcNAcb1-6)Mana1-6)Manb1-4GlcNAcb1-4GlcNAc |
| NeuGca2-3/6Galb1-4(Fuca1-3)GlcNAcb1-2(Galb1- | Gala1-3Galb1-4GlcNAcb1-2(Galb1-4GlcNAcb1- |
| 4GlcNAcb1-4)Mana1-3(Galb1-4GlcNAcb1-2(Gala1- | 4)Mana1-3(Gala1-3Galb1-4GlcNAcb1-2(NeuAca2- |
| 3Galb1-4GlcNAcb1-6)Mana1-6)Manb1-4GlcNAcb1- | 3/6Galb1-4GlcNAcb1-6)Mana1-6)Manb1- |
| 4GlcNAc | 4GlcNAcb1-4GlcNAc |
| GlcNAcb1-4(Gala1-3Galb1-4GlcNAcb1-3Galb1- | |
| 4GlcNAcb1-2(NeuAca2-3/6Galb1-4GlcNAcb1- | |
| 4)Mana1-3)(Mana1-3Mana1-6)Mana1-6)Manb1- | |
| 4GlcNAcb1-4GlcNAc | |
| Gala1-3Galb1-4GlcNAcb1-2(Galb1-4GlcNAcb1- | Galb1-4(Fuca1-3)GlcNAcb1-3Galb1-4GlcNAcb1- |
| 4)Mana1-3(Galb1-4GlcNAcb1-2(NeuGca2-3/6Galb1- | 2(Galb1-4(Fuca1-3)GlcNAcb1-3Galb1-4GlcNAcb1- |
| 4GlcNAcb1-6)Mana1-6)Manb1-4GlcNAcb1-4(Fuca1- | 4)Mana1-3(Mana1-3(Mana1-6)Mana1-6)Manb1- |
| 6)GlcNAc | 4GlcNAcb1-4GlcNAc |
| Galb1-4(Fuca1-3)GlcNAcb1-3Galb1-4GlcNAcb1- | GlcNAcb1-4(NeuGca2-8NeuGca2-3/6Galb1- |
| 2(Galb1-4GlcNAcb1-3Galb1-4GlcNAcb1-4)Mana1- | 4(Fuca1-3)GlcNAcb1-2(GlcNAcb1-4)Mana1- |
| 3(Mana1-3(Mana1-6)Mana1-6)Manb1-4GlcNAcb1- | 3)(GlcNAcb1-2(Fuca1-3GlcNAcb1-6)Mana1- |
| 4(Fuca1-6)GlcNAc | 6)Manb1-4GlcNAcb1-4GlcNAc |
| GlcNAcb1-4(NeuAca2-3/6Galb1-4GlcNAcb1- | GlcNAcb1-4(NeuGca2-8NeuGca2-3/6Galb1- |
| 2(GlcNAcb1-4)Mana1-3)(Galb1-4GlcNAcb1- | 4(Fuca1-3)GlcNAcb1-2(GlcNAcb1-4)Mana1- |
| 2(NeuAca2-3/6Galb1-4GlcNAcb1-6)Mana1- | 3)(GlcNAcb1-2(GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GlcNAcb1-4)Mana1-3)(Galb1- | 3)GlcNAcb1-2(GlcNAcb1-4)Mana1-3)(Galb1- |
| 4GlcNAcb1-2(Galb1-4(Fuca1-3)GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4(Fuca1-6)GlcNAc |
| Galb1-4(Fuca1-3)GlcNAcb1-2(GalNAcb1-4(Fuca1- | GlcNAcb1-4(Galb1-4(Fuca1-3)GlcNAcb1-2(Galb1- |
| 3)GlcNAcb1-4)Mana1-3(Galb1-4(Fuca1- | 4(Fuca1-3)GlcNAcb1-4)Mana1-3)(GlcNAcb1- |
| 3)GlcNAcb1-2(Galb1-4(Fuca1-3)GlcNAcb1- | 2(Galb1-4(Fuca1-3)GlcNAcb1-6)Mana1-6)Manb1- |
| 6)Mana1-6)Manb1-4GlcNAcb1-4GlcNAc | 4GlcNAcb1-4(Fuca1-6)GlcNAc |
| Galb1-4(Fuca1-3)GlcNAcb1-2(GalNAcb1- | GlcNAcb1-4(Galb1-4(Fuca1-3)GlcNAcb1- |
| 4GlcNAcb1-4)Mana1-3(Galb1-4(Fuca1-3)GlcNAcb1- | 2(GlcNAcb1-4)Mana1-3)(Galb1-4(Fuca1- |
| 2(Galb1-4(Fuca1-3)GlcNAcb1-6)Mana1-6)Manb1- | 3)GlcNAcb1-2(Galb1-4(Fuca1-3)GlcNAcb1- |
| 4GlcNAcb1-4(Fuca1-6)GlcNAc | 6)Mana1-6)Manb1-4GlcNAcb1-4(Fuca1-6)GlcNAc |
| GlcNAcb1-4(Galb1-4(Fuca1-3)GlcNAcb1-2(Galb1- | NeuGca2-8NeuGca2-3/6Galb1-4(Fuca1- |
| 4(Fuca1-3)GlcNAcb1-4)Mana1-3)(Galb1- | 3)GlcNAcb1-2Mana1-3(NeuGca2-3/6Galb1- |
| 4GlcNAcb1-2(Fuca1-3GlcNAcb1-6)Mana1-6)Manb1- | 4(Fuca1-3)GlcNAcb1-2Mana1-6)Manb1-4GlcNAcb1- |
| 4GlcNAcb1-4(Fuca1-6)GlcNAc | 4(Fuca1-6)GlcNAc |
| NeuAca2-3/6Galb1-4(Fuca1-3)GlcNAcb1- | |
| 2(NeuAca2-8NeuGca2-3/6Galb1-4GlcNAcb1- | |
| 4)Mana1-3(Mana1-3(Mana1-6)Mana1-6)Manb1- | |
| 4GlcNAcb1-4GlcNAc | |
| NeuAca2-3/6Galb1-4(Fuca1-3)GlcNAcb1- | GlcNAcb1-4(Gala1-3Galb1-4GlcNAcb1-3Galb1- |
| 2(NeuGca2-8NeuGca2-3/6Galb1-4(Fuca1- | 4GlcNAcb1-2(NeuGca2-3/6Galb1-4GlcNAcb1- |
| 3)GlcNAcb1-4)Mana1-3(Mana1-3Mana1-6)Manb1- | 4)Mana1-3)(Mana1-3(Mana1-6)Mana1-6)Manb1- |
| 4GlcNAcb1-4GlcNAc | 4GlcNAcb1-4GlcNAc |
| Gala1-3Galb1-4GlcNAcb1-2(Galb1-4GlcNAcb1- | Galb1-4GlcNAcb1-2(Gala1-3Galb1-4GlcNAcb1- |
| 4)Mana1-3(Gala1-3Galb1-4GlcNAcb1-2(NeuGca2- | 4)Mana1-3(Gala1-3Galb1-4GlcNAcb1-2(Gala1- |
| 3/6Galb1-4GlcNAcb1-6)Mana1-6)Manb1- | 3Galb1-4GlcNAcb1-6)Mana1-6)Manb1-4GlcNAcb1- |
| 4GlcNAcb1-4GlcNAc | 4(Fuca1-6)GlcNAc |
| Gala1-3Galb1-4GlcNAcb1-2(Galb1-4GlcNAcb1- | Galb1-3Galb1-4GlcNAcb1-2(Galb1-3Galb1- |
| 4)Mana1-3(Gala1-3Galb1-4GlcNAcb1-2(Gala1- | 4GlcNAcb1-6)Mana1-3(Galb1-4GlcNAcb1-2(Galb1- |
| 3Galb1-4GlcNAcb1-6)Mana1-6)Manb1-4GlcNAcb1- | 3Galb1-4GlcNAcb1-6)Mana1-6)Manb1-4GlcNAcb1- |
| 4(Fuca1-6)GlcNAc | 4(Fuca1-6)GlcNAc |
| Galb1-4GlcNAcb1-2(Galb1-3Galb1-4GlcNAcb1- | Gala1-3Galb1-4GlcNAcb1-3(Gala1-3Galb1- |
| 6)Mana1-3(Galb1-3Galb1-4GlcNAcb1-2(Galb1- | 4GlcNAcb1-6)Galb1-4GlcNAcb1-2Mana1-3(Gala1- |
| 3Galb1-4GlcNAcb1-4)Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAcb |
| GlcNAcb1-4(NeuAca2-8NeuAca2-3/6Galb1-4(Fuca1- | GlcNAcb1-4(NeuAca2-8NeuAca2-3/6Galb1-4(Fuca1- |
| 3)GlcNAcb1-2Mana1-3)(NeuAca2-3/6Galb1- | 3)GlcNAcb1-2Mana1-3)(NeuAca2-3/6Galb1- |
| 4(Fuca1-3)GlcNAcb1-2Mana1-6)Manb1-4GlcNAcb1- | 4GlcNAcb1-2Mana1-6)Manb1-4GlcNAcb1-4(Fuca1- |
| 4GlcNAc | 6)GlcNAc |
| GlcNAcb1-4(NeuGca2-3/6Galb1-4GlcNAcb1- | GlcNAcb1-4(NeuAca2-8NeuAca2-3/6Galb1-4(Fuca1- |
| 2(GlcNAcb1-4)Mana1-3)(Galb1-4GlcNAcb1- | 3)GlcNAcb1-2Mana1-3)(Fuca1-2Galb1-4(Fuca1- |
| 2(NeuAca2-3/6Galb1-4GlcNAcb1-6)Mana1- | 3)GlcNAcb1-2Mana1-6)Manb1-4GlcNAcb1-4(Fuca1- |
| 6)Manb1-4GlcNAcb1-4GlcNAc | 6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(GlcNAcb1-4)Mana1-3)(Galb1- | 3)GlcNAcb1-2(Galb1-4GlcNAcb1-4)Mana1- |
| 4GlcNAcb1-2(Galb1-4(Fuca1-3)GlcNAcb1-6)Mana1- | 3)(Galb1-4GlcNAcb1-2(Galb1-4GlcNAcb1-6)Mana1- |
| 6)Manb1-4GlcNAcb1-4GlcNAc | 6)Manb1-4GlcNAcb1-4GlcNAc |
| GlcNAcb1-4(NeuAca2-3/6Galb1-4GlcNAcb1- | GlcNAcb1-4(NeuGca2-3/6Galb1-4(Fuca1- |
| 2(Galb1-4GlcNAcb1-4)Mana1-3)(Galb1-4GlcNAcb1- | 3)GlcNAcb1-2(GlcNAcb1-4)Mana1-3)(Galb1- |
| 2(Galb1-4GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4(Fuca1-6)GlcNAc |
| | GlcNAcb1-4(Galb1-4(Fuca1-3)GlcNAcb1-2(Galb1- |
| | 4GlcNAcb1-4)Mana1-3)(Galb1-4GlcNAcb1-2(Galb1- |
| | 4(Fuca1-3)GlcNAcb1-6)Mana1-6)Manb1- |
| | 4GlcNAcb1-4(Fuca1-6)GlcNAc |
| GlcNAcb1-4(Galb1-4(Fuca1-3)GlcNAcb1-2(Galb1- | GlcNAcb1-4(Galb1-4(Fuca1-3)GlcNAcb1-2(Galb1- |
| 4GlcNAcb1-4)Mana1-3)(Galb1-4(Fuca1- | 4(Fuca1-3)GlcNAcb1-4)Mana1-3)(Galb1- |
| 3)GlcNAcb1-2(Galb1-4(Fuca1-3)GlcNAcb1- | 4GlcNAcb1-2(Galb1-4GlcNAcb1-6)Mana1-6)Manb1- |
| 6)Mana1-6)Manb1-4GlcNAcb1-4GlcNAc | 4GlcNAcb1-4(Fuca1-6)GlcNAc |
| NeuAca2-3/6Galb1-4(Fuca1-3)GlcNAcb1- | NeuGca2-3/6Galb1-4(Fuca1-3)GlcNAcb1- |
| 2(NeuGca2-8NeuGca2-3/6Galb1-4GlcNAcb1- | 2(NeuGca2-8NeuGca2-3/6Galb1-4(Fuca1- |
| 4)Mana1-3(Mana1-3(Mana1-6)Mana1-6)Manb1- | 3)GlcNAcb1-4)Mana1-3(Mana1-3Mana1-6)Manb1- |
| 4GlcNAcb1-4GlcNAc | 4GlcNAcb1-4GlcNAc |
| Mana1-2Mana1-2Mana1-2Mana1-2Mana1-3(Mana1- | Gala1-3Galb1-4GlcNAcb1-2(Gala1-3Galb1- |
| 2Mana1-2Mana1-2Mana1-3(Mana1-2Mana1- | 4GlcNAcb1-4)Mana1-3(Gala1-3Galb1-4GlcNAcb1- |
| 2Mana1-2Mana1-2Mana1-6)Mana1-6)Manb1- | 2(Gala1-3Galb1-4GlcNAcb1-6)Mana1-6)Manb1- |
| 4GlcNAcb1-4GlcNAc | 4GlcNAcb1-4GlcNAc |
| NeuAca2-3Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3(NeuAca2-3Galb1- | 4(Fuca1-3)GlcNAcb1-4)Mana1-3(NeuAca2-6Galb1- |
| 4GlcNAcb1-2Mana1-6)Manb1-4GlcNAcb1-4(Fuca1- | 4GlcNAcb1-2Mana1-6)Manb1-4GlcNAcb1-4GlcNAc |
| 6)GlcNAcb | |
| NeuAca2-6Galb1-4GlcNAcb1-2(NeuAca2-6Galb1- | NeuAca2-3Galb1-4GlcNAcb1-2Mana1-3(NeuAca2- |
| 4GlcNAcb1-6)Mana1-3(NeuAca2-6Galb1- | 6Galb1-4GlcNAcb1-2(NeuAca2-3Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAc |
| 6)GlcNAc | |
| NeuAca2-6Galb1-4GlcNAcb1-2Mana1-3(NeuAca2- | NeuAca2-6Galb1-4GlcNAcb1-2(NeuAca2-6Galb1- |
| 3Galb1-4GlcNAcb1-2(NeuAca2-6Galb1-4GlcNAcb1- | 4GlcNAcb1-6)Mana1-3(NeuAca2-3Galb1- |
| 6)Mana1-6)Manb1-4GlcNAcb1-4(Fuca1-6)GlcNAc | 4GlcNAcb1-2Mana1-6)Manb1-4GlcNAcb1-4(Fuca1- |
| | 6)GlcNAc |
| NeuAca2-6Galb1-4GlcNAcb1-2(NeuAca2-3Galb1- | |
| 4GlcNAcb1-4)Mana1-3(NeuAca2-3Galb1- | |
| 4GlcNAcb1-2Mana1-6)Manb1-4GlcNAcb1-4(Fuca1- | |
| 6)GlcNAcb | |
| NeuAca2-3Galb1-3GlcNAcb1-2Mana1-3(NeuAca2- | NeuAca2-3Galb1-3GlcNAcb1-4Mana1-3(NeuAca2- |
| 3Galb1-3GlcNAcb1-2(NeuAca2-3Galb1-3GlcNAcb1- | 3Galb1-3GlcNAcb1-2(NeuAca2-3Galb1-3GlcNAcb1- |
| 6)Mana1-6)Manb1-4GlcNAcb1-4(Fuca1-6)GlcNAcb | 6)Mana1-6)Manb1-4GlcNAcb1-4(Fuca1-6)GlcNAcb |
| NeuAca2-3Galb1-3GlcNAcb1-2(NeuAca2-3Galb1- | NeuAca2-3Galb1-3GlcNAcb1-2Mana1-3(NeuAca2- |
| 3GlcNAcb1-4)Mana1-3(NeuAca2-3Galb1- | 3Galb1-4GlcNAcb1-2(NeuAca2-3Galb1-3GlcNAcb1- |
| 3GlcNAcb1-2Mana1-6)Manb1-4GlcNAcb1-4(Fuca1- | 6)Mana1-6)Manb1-4GlcNAcb1-4(Fuca1-6)GlcNAcb |
| 6)GlcNAcb | |
| NeuAca2-3Galb1-4GlcNAcb1-2Mana1-3(NeuAca2- | NeuAca2-3Galb1-4GlcNAcb1-2Mana1-3(NeuAca2- |
| 3Galb1-4GlcNAcb1-2(NeuAca2-3Galb1-4GlcNAcb1- | 3Galb1-4GlcNAcb1-2(NeuAca2-3Galb1-4GlcNAcb1- |
| 6)Mana1-6)Manb1-4GlcNAcb1-4(Fuca1-6)GlcNAcb | 6)Mana1-6)Manb1-4GlcNAcb1-4(Fuca1-6)GlcNAc |
| NeuAca2-6Galb1-4GlcNAcb1-2(NeuAca2-3Galb1- | NeuAca2-6Galb1-4GlcNAcb1-2Mana1-3(NeuAca2- |
| 4GlcNAcb1-4)Mana1-3(NeuAca2-6Galb1- | 6Galb1-4GlcNAcb1-2(NeuAca2-3Galb1-4GlcNAcb1- |
| 4GlcNAcb1-2Mana1-6)Manb1-4GlcNAcb1-4(Fuca1- | 6)Mana1-6)Manb1-4GlcNAcb1-4(Fuca1-6)GlcNAc |
| 6)GlcNAc | |
| NeuAca2-3Galb1-4GlcNAcb1-2(NeuAca2-6Galb1- | NeuAca2-6Galb1-4GlcNAcb1-2(NeuAca2-6Galb1- |
| 4GlcNAcb1-4)Mana1-3(NeuAca2-3Galb1- | 4GlcNAcb1-4)Mana1-3(NeuAca2-6Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-3/6Galb1-4GlcNAcb1-2Mana1-3(NeuAca2- | NeuAca2-3/6Galb1-4GlcNAcb1-2(NeuAca2- |
| 3/6Galb1-4GlcNAcb1-2(NeuAca2-3/6Galb1- | 3/6Galb1-4GlcNAcb1-4)Mana1-3(NeuAca2- |
| 4GlcNAcb1-2)Mana1-6)Manb1-4GlcNAcb1-4(Fuca1- | 3/6Galb1-4GlcNAcb1-2Mana1-6)Manb1-4GlcNAcb1- |
| 6)GlcNAcb | 4(Fuca1-6)GlcNAcb |
| NeuAca2-3Galb1-4GlcNAcb1-2Mana1-3(NeuAca2- | NeuAca2-6Galb1-4GlcNAcb1-2(NeuAca2-3Galb1- |
| 3Galb1-4GlcNAcb1-2(NeuAca2-3Galb1-4GlcNAcb1- | 4GlcNAcb1-4)Mana1-3(NeuAca2-6Galb1- |
| 4)Mana1-6)Manb1-4GlcNAcb1-4(Fuca1-6)GlcNAc | 4GlcNAcb1-2Mana1-6)Manb1-4GlcNAcb1-4(Fuca1- |
| | 6)GlcNAcb |
| NeuAca2-3Galb1-4GlcNAcb1-2(NeuAca2-3Galb1- | NeuAca2-6Galb1-4GlcNAcb1-2Mana1-3(NeuAca2- |
| 4GlcNAcb1-4)Mana1-3(NeuAca2-3Galb1- | 6Galb1-4GlcNAcb1-2(NeuAca2-6Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAc |
| 6)GlcNAc | |
| | NeuAca2-3Galb1-4GlcNAcb1-2Mana1-3(NeuAca2- |
| | 6Galb1-4GlcNAcb1-2(NeuAca2-6Galb1-4GlcNAcb1- |
| | 4)Mana1-6)Manb1-4GlcNAcb1-4(Fuca1-6)GlcNAc |
| NeuAca2-6Galb1-4GlcNAcb1-2(NeuAca2-6Galb1- | NeuAca2-6Galb1-4GlcNAcb1-2(NeuAca2-6Galb1- |
| 4GlcNAcb1-4)Mana1-3(NeuAca2-3Galb1- | 4GlcNAcb1-4)Mana1-3(NeuAca2-6Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-3Galb1-3GlcNAcb1-4Mana1-3(NeuAca2- | NeuAca2-3Galb1-3GlcNAcb1-2Mana1-3(NeuAca2- |
| 3Galb1-3GlcNAcb1-2(NeuAca2-3Galb1-3GlcNAcb1- | 3Galb1-3GlcNAcb1-2(NeuAca2-3Galb1-3GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3Galb1-3GlcNAcb1-2(NeuAca2-3Galb1- | NeuAca2-3Galb1-3GlcNAcb1-2Mana1-3(NeuAca2- |
| 3GlcNAcb1-4)Mana1-3(NeuAca2-3Galb1- | 3Galb1-4GlcNAcb1-2(NeuAca2-3Galb1-3GlcNAcb1- |
| 3GlcNAcb1-2Mana1-6)Manb1-4GlcNAcb1-4(Fuca1- | 6)Mana1-6)Manb1-4GlcNAcb1-4(Fuca1-6)GlcNAc |
| 6)GlcNAc | |
| NeuAca2-3/6Galb1-4GlcNAcb1-2(NeuAca2- | NeuAca2-3Galb1-4GlcNAcb1-2Mana1-3(NeuAca2- |
| 3/6Galb1-4GlcNAcb1-4/6)Mana1-3/6(NeuAca2- | 3Galb1-4GlcNAcb1-2(NeuAca2-6Galb1-4GlcNAcb1- |
| 3/6Galb1-4GlcNAcb1-2Mana1-6/3)Manb1- | 6)Mana1-6)Manb1-4GlcNAcb1-4(Fuca1-6)GlcNAc |
| 4GlcNAcb1-4(Fuca1-6)GlcNAcb | |
| NeuAca2-3Galb1-4GlcNAcb1-2Mana1-3(NeuAca2- | NeuAca2-6Galb1-4GlcNAcb1-2Mana1-3(NeuAca2- |
| 6Galb1-4GlcNAcb1-2(NeuAca2-3Galb1-4GlcNAcb1- | 3Galb1-4GlcNAcb1-2(NeuAca2-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-6Galb1-4GlcNAcb1-2(NeuAca2-3Galb1- | NeuAca2-3Galb1-4GlcNAcb1-2Mana1-3(NeuAca2- |
| 4GlcNAcb1-4)Mana1-3(NeuAca2-6Galb1- | 3Galb1-4GlcNAcb1-2(NeuAca2-3Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAcb |
| 6)GlcNAc | |
| NeuAca2-6Galb1-4GlcNAcb1-2Mana1-3(NeuAca2- | NeuAca2-6Galb1-4GlcNAcb1-2Mana1-3(NeuAca2- |
| 3Galb1-4GlcNAcb1-2(NeuAca2-6Galb1-4GlcNAcb1- | 6Galb1-4GlcNAcb1-2(NeuAca2-3Galb1-4GlcNAcb1- |
| 4)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2Mana1-3(NeuAca2- | |
| 6Galb1-4GlcNAcb1-2(NeuAca2-6Galb1-4GlcNAcb1- | |
| 6)Mana1-6)Manb1-4GlcNAcb1-4(Fuca1-6)GlcNAc | |
| NeuAca2-3Galb1-4GlcNAcb1-2(NeuAca2-3Galb1- | NeuAca2-3Galb1-4GlcNAcb1-2(NeuAca2-6Galb1- |
| 4GlcNAcb1-6)Mana1-3(NeuAca2-3Galb1- | 4GlcNAcb1-6)Mana1-3(NeuAca2-3Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-3Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-6Galb1- |
| 4GlcNAcb1-2Mana1-6)Manb1-4GlcNAcb1-4(Fuca1- | 4GlcNAcb1-2Mana1-6)Manb1-4GlcNAcb1-4(Fuca1- |
| 6)GlcNAc | 6)GlcNAc |
| NeuAca2-6Galb1-4GlcNAcb1-2(NeuAca2-3Galb1- | NeuAca2-3Galb1-4GlcNAcb1-2Mana1-3(NeuAca2- |
| 4GlcNAcb1-6)Mana1-3(NeuAca2-6Galb1- | 3Galb1-4GlcNAcb1-2(NeuAca2-6Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAc |
| 6)GlcNAc | |
| NeuAca2-3Galb1-4GlcNAcb1-2Mana1-3(NeuAca2- | NeuAca2-6Galb1-4GlcNAcb1-2(NeuAca2-3Galb1- |
| 6Galb1-4GlcNAcb1-2(NeuAca2-6Galb1-4GlcNAcb1- | 4GlcNAcb1-4)Mana1-3(NeuAca2-3Galb1- |
| 6)Mana1-6)Manb1-4GlcNAcb1-4(Fuca1-6)GlcNAc | 4GlcNAcb1-2Mana1-6)Manb1-4GlcNAcb1-4(Fuca1- |
| | 6)GlcNAc |
| NeuAca2-6Galb1-4GlcNAcb1-2Mana1-3(NeuAca2- | NeuAca2-6Galb1-4GlcNAcb1-2(NeuAca2-3Galb1- |
| 3Galb1-4GlcNAcb1-2(NeuAca2-3Galb1-4GlcNAcb1- | 4GlcNAcb1-6)Mana1-3(NeuAca2-3Galb1- |
| 4)Mana1-6)Manb1-4GlcNAcb1-4(Fuca1-6)GlcNAc | 4GlcNAcb1-2Mana1-6)Manb1-4GlcNAcb1-4(Fuca1- |
| | 6)GlcNAc |
| NeuAca2-6Galb1-4GlcNAcb1-2(NeuAca2-3Galb1- | NeuAca2-3Galb1-4GlcNAcb1-2(NeuAca2-3Galb1- |
| 4(Fuca1-3)GlcNAcb1-4)Mana1-3(NeuAca2-6Galb1- | 4GlcNAcb1-4)Mana1-3(NeuAca2-6Galb1- |
| 4GlcNAcb1-2Mana1-6)Manb1-4GlcNAcb1-4GlcNAc | 4GlcNAcb1-2Mana1-6)Manb1-4GlcNAcb1-4(Fuca1- |
| | 6)GlcNAc |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-6)Mana1-3(NeuAca2-6Galb1- | 4GlcNAcb1-4)Mana1-3(NeuAca2-3Galb1- |
| 4GlcNAcb1-2Mana1-6)Manb1-4GlcNAcb1-4(Fuca1- | 4GlcNAcb1-6Mana1-6)Manb1-4GlcNAcb1-4(Fuca1- |
| 6)GlcNAc | 6)GlcNAcb |
| GlcNAcb1-4(NeuAca2-8NeuGca2-3/6Galb1- | |
| 4(Fuca1-3)GlcNAcb1-2Mana1-3)(NeuAca2- | |
| 3/6Galb1-4GlcNAcb1-2Mana1-6)Manb1-4GlcNAcb1- | |
| 4(Fuca1-6)GlcNAc | |
| NeuAca2-6Galb1-4GlcNAcb1-2(NeuAca2-6Galb1- | NeuAca2-3Galb1-4GlcNAcb1-2Mana1-3(NeuAca2- |
| 4GlcNAcb1-4)Mana1-3(NeuAca2-6Galb1- | 6Galb1-4GlcNAcb1-2(NeuAca2-6Galb1-4GlcNAcb1- |
| 4GlcNAcb1-2Mana1-6)Manb1-4GlcNAcb1-4(Fuca1- | 4)Mana1-6)Manb1-4GlcNAcb1-4(Fuca1-6)GlcNAcb |
| 6)GlcNAcb | |
| GlcNAcb1-4(NeuAca2-8NeuGca2-3/6Galb1- | NeuAca2-3Galb1-4GlcNAcb1-2(NeuAca2-3Galb1- |
| 4(Fuca1-3)GlcNAcb1-2Mana1-3)(NeuAca2- | 4GlcNAcb1-4)Mana1-3(NeuAca2-3Galb1- |
| 3/6Galb1-4(Fuca1-3)GlcNAcb1-2Mana1-6)Manb1- | 4GlcNAcb1-6Mana1-6)Manb1-4GlcNAcb1-4(Fuca1- |
| 4GlcNAcb1-4GlcNAc | 6)GlcNAc |
| NeuAca2-3/6Galb1-4GlcNAcb1-2Mana1-3(NeuAca2- | NeuAca2-3Galb1-4GlcNAcb1-4Mana1-3(NeuAca2- |
| 3/6Galb1-4GlcNAcb1-2(NeuAca2-3/6Galb1- | 3Galb1-4GlcNAcb1-2(NeuAca2-3Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAcb |
| 6)GlcNAc | |
| GlcNAcb1-4(NeuGca2-3/6Galb1-4GlcNAcb1- | GlcNAcb1-4(NeuAca2-8NeuGca2-3/6Galb1- |
| 2(GlcNAcb1-4)Mana1-3)(Galb1-4GlcNAcb1- | 4(Fuca1-3)GlcNAcb1-2Mana1-3)(Fuca1-2Galb1- |
| 2(NeuGca2-3/6Galb1-4GlcNAcb1-6)Mana1- | 4(Fuca1-3)GlcNAcb1-2Mana1-6)Manb1-4GlcNAcb1- |
| 6)Manb1-4GlcNAcb1-4GlcNAc | 4(Fuca1-6)GlcNAc |
| NeuAca2-3/6Galb1-4GlcNAcb1-2(Galb1-4GlcNAcb1- | GlcNAcb1-4(NeuGca2-3/6Galb1-4(Fuca1- |
| 4)Mana1-3(Galb1-4GlcNAcb1-3Galb1-4GlcNAcb1- | 3)GlcNAcb1-2(Galb1-4GlcNAcb1-4)Mana1- |
| 2(Galb1-4GlcNAcb1-6)Mana1-6)Manb1-4GlcNAcb1- | 3)(Galb1-4GlcNAcb1-2(Galb1-4GlcNAcb1-6)Mana1- |
| 4GlcNAc | 6)Manb1-4GlcNAcb1-4GlcNAc |
| GlcNAcb1-4(NeuGca2-3/6Galb1-4GlcNAcb1- | GlcNAcb1-4(Gala1-3Galb1-4GlcNAcb1-2(Galb1- |
| 2(Galb1-4GlcNAcb1-4)Mana1-3)(Galb1-4GlcNAcb1- | 4GlcNAcb1-4)Mana1-3)(Galb1-4GlcNAcb1- |
| 2(Galb1-4GlcNAcb1-6)Mana1-6)Manb1-4GlcNAcb1- | 2(NeuAca2-3/6Galb1-4GlcNAcb1-6)Mana1- |
| 4(Fuca1-6)GlcNAc | 6)Manb1-4GlcNAcb1-4GlcNAc |
| NeuAca2-6Galb1-4GlcNAcb1-2Mana1-3(Galb1- | Galb1-4(Fuca1-3)GlcNAcb1-2(Galb1-4GlcNAcb1- |
| 4GlcNAcb1-3Galb1-4GlcNAcb1-3Galb1-4GlcNAcb1- | 4)Mana1-3(Galb1-4GlcNAcb1-3Galb1-4GlcNAcb1- |
| 3Galb1-4GlcNAcb1-2Mana1-6)Manb1-4GlcNAcb1- | 2(Galb1-4GlcNAcb1-6)Mana1-6)Manb1-4GlcNAcb1- |
| 4GlcNAcb | 4(Fuca1-6)GlcNAc |
| GlcNAcb1-4(Galb1-4(Fuca1-3)GlcNAcb1-2(Galb1- | Galb1-4(Fuca1-3)GlcNAcb1-2(Galb1-4(Fuca1- |
| 4GlcNAcb1-4)Mana1-3)(Galb1-4GlcNAcb1-2(Gala1- | 3)GlcNAcb1-4)Mana1-3(Galb1-4GlcNAcb1-3Galb1- |
| 3Galb1-4GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| GlcNAcb1-4(Gala1-3Galb1-4(Fuca1-3)GlcNAcb1- | NeuGca2-3/6Galb1-4(Fuca1-3)GlcNAcb1- |
| 2(Galb1-4GlcNAcb1-4)Mana1-3)(Galb1-4GlcNAcb1- | 2(NeuGca2-8NeuGca2-3/6Galb1-4GlcNAcb1- |
| 2(Galb1-4(Fuca1-3)GlcNAcb1-6)Mana1-6)Manb1- | 4)Mana1-3(Mana1-3(Mana1-6)Mana1-6)Manb1- |
| 4GlcNAcb1-4GlcNAc | 4GlcNAcb1-4GlcNAc |
| NeuAca2-3/6Galb1-4GlcNAcb1-2(NeuAca2- | GlcNAcb1-4(NeuGca2-8NeuGca2-3/6Galb1- |
| 3/6Galb1-4GlcNAcb1-4)Mana1-3(NeuGca2- | 4(Fuca1-3)GlcNAcb1-2Mana1-3)(NeuAca2- |
| 3/6Galb1-4GlcNAcb1-2Mana1-6)Manb1-4GlcNAcb1- | 3/6Galb1-4(Fuca1-3)GlcNAcb1-2Mana1-6)Manb1- |
| 4(Fuca1-6)GlcNAcb | 4GlcNAcb1-4GlcNAc |
| GlcNAcb1-4(NeuGca2-8NeuGca2-3/6Galb1- | NeuAca2-6Galb1-4GlcNAcb1-2(NeuAca2-6Galb1- |
| 4(Fuca1-3)GlcNAcb1-2Mana1-3)(NeuAca2- | 4GlcNAcb1-4)Mana1-3(NeuAca2-6Galb1- |
| 3/6Galb1-4GlcNAcb1-2Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAc |
| GlcNAcb1-4(NeuGca2-8NeuGca2-3/6Galb1- | NeuGca2-3/6Galb1-4GlcNAcb1-2(Galb1-4GlcNAcb1- |
| 4(Fuca1-3)GlcNAcb1-2Mana1-3)(Fuca1-2Galb1- | 4)Mana1-3(Galb1-4GlcNAcb1-3Galb1-4GlcNAcb1- |
| 4(Fuca1-3)GlcNAcb1-2Mana1-6)Manb1-4GlcNAcb1- | 2(Galb1-4GlcNAcb1-6)Mana1-6)Manb1-4GlcNAcb1- |
| 4(Fuca1-6)GlcNAc | 4GlcNAc |
| GlcNAcb1-4(Gala1-3Galb1-4GlcNAcb1-2(Galb1- | GlcNAcb1-4(Galb1-4(Fuca1-3)GlcNAcb1-3Galb1- |
| 4GlcNAcb1-4)Mana1-3)(Galb1-4GlcNAcb1- | 4GlcNAcb1-2(Galb1-4GlcNAcb1-3Galb1-4GlcNAcb1- |
| 2(NeuGca2-3/6Galb1-4GlcNAcb1-6)Mana1- | 4)Mana1-3)(Mana1-3(Mana1-6)Mana1-6)Manb1- |
| 6)Manb1-4GlcNAcb1-4GlcNAc | 4GlcNAcb1-4GlcNAc |
| GlcNAcb1-4(Gala1-3Galb1-4GlcNAcb1-2(Galb1- | Galb1-4GlcNAcb1-3Galb1-4GlcNAcb1-3Galb1- |
| 4GlcNAcb1-4)Mana1-3)(Galb1-4GlcNAcb1-2(Gala1- | 4GlcNAcb1-3Galb1-4GlcNAcb1-2Mana1-3(Galb1- |
| 3Galb1-4GlcNAcb1-6)Mana1-6)Manb1-4GlcNAcb1- | 3Galb1-4GlcNAcb1-2Mana1-6)Manb1-4GlcNAcb1- |
| 4(Fuca1-6)GlcNAc | 4(Fuca1-6)GlcNAc |
| NeuAca2-8NeuAca2-3/6Galb1-4(Fuca1-3)GlcNAcb1- | NeuAca2-8NeuAca2-3/6Galb1-4(Fuca1-3)GlcNAcb1- |
| 2(Fuca1-3GlcNAcb1-4)Mana1-3(Fuca1-3GlcNAcb1- | 2(Fuca1-3GlcNAcb1-4)Mana1-3(GlcNAcb1-2(Fuca1- |
| 2(Fuca1-3GlcNAcb1-6)Mana1-6)Manb1-4GlcNAcb1- | 3GlcNAcb1-6)Mana1-6)Manb1-4GlcNAcb1-4(Fuca1- |
| 4GlcNAc | 6)GlcNAc |
| NeuAca2-3/6Galb1-4GlcNAcb1-3Galb1-4GlcNAcb1- | GlcNAcb1-4(Galb1-4(Fuca1-3)GlcNAcb1- |
| 2(GlcNAcb1-4)Mana1-3(GalNAcb1-4GlcNAcb1- | 2(GalNAcb1-4GlcNAcb1-4)Mana1-3)(Galb1- |
| 2(Galb1-4GlcNAcb1-6)Mana1-6)Manb1-4GlcNAcb1- | 4(Fuca1-3)GlcNAcb1-2(Galb1-4(Fuca1-3)GlcNAcb1- |
| 4(Fuca1-6)GlcNAc | 6)Mana1-6)Manb1-4GlcNAcb1-4GlcNAc |
| GlcNAcb1-4(Galb1-4(Fuca1-3)GlcNAcb1-2(Galb1- | Galb1-4(Fuca1-3)GlcNAcb1-3Galb1-4(Fuca1- |
| 4GlcNAcb1-4)Mana1-3)(Galb1-4GlcNAcb1- | 3)GlcNAcb1-2(GlcNAcb1-4)Mana1-3(GalNAcb1- |
| 2(GalNAcb1-4(Fuca1-3)GlcNAcb1-6)Mana1- | 4GlcNAcb1-2(Galb1-4GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2Mana1-3)(NeuGca2- | 4(Fuca1-3)GlcNAcb1-2Mana1-3)(NeuGca2- |
| 3/6Galb1-4GlcNAcb1-2Mana1-6)Manb1-4GlcNAcb1- | 3/6Galb1-4(Fuca1-3)GlcNAcb1-2Mana1-6)Manb1- |
| 4(Fuca1-6)GlcNAc | 4GlcNAcb1-4GlcNAc |
| GlcNAcb1-4(Gala1-3Galb1-4GlcNAcb1-2(Galb1- | NeuAca2-3GalNAcb1-4GlcNAcb1-2Mana1- |
| 4GlcNAcb1-4)Mana1-3)(Gala1-3Galb1-4GlcNAcb1- | 3(NeuAca2-3Galb1-3GlcNAcb1-2(NeuAca2-3Galb1- |
| 2(Gala1-3Galb1-4GlcNAcb1-6)Mana1-6)Manb1- | 3GlcNAcb1-6)Mana1-6)Manb1-4GlcNAcb1-4(Fuca1- |
| 4GlcNAcb1-4GlcNAc | 6)GlcNAcb |
| NeuAca2-3GalNAcb1-4GlcNAcb1-2Mana1- | NeuAca2-8NeuGca2-3/6Galb1-4(Fuca1- |
| 3(NeuAca2-3Galb1-3GlcNAcb1-2(NeuAca2-3Galb1- | 3)GlcNAcb1-2(Fuca1-3GlcNAcb1-4)Mana1- |
| 3GlcNAcb1-6)Mana1-6)Manb1-4GlcNAcb1-4(Fuca1- | 3(GlcNAcb1-2(Fuca1-3GlcNAcb1-6)Mana1- |
| 6)GlcNAc | 6)Manb1-4GlcNAcb1-4(Fuca1-6)GlcNAc |
| NeuAca2-8NeuGca2-3/6Galb1-4(Fuca1- | NeuAca2-3/6Galb1-4GlcNAcb1-3Galb1-4GlcNAcb1- |
| 3)GlcNAcb1-2(Fuca1-3GlcNAcb1-4)Mana1-3(Fuca1- | 2(GlcNAcb1-4)Mana1-3(GalNAcb1-4GlcNAcb1- |
| 3GlcNAcb1-2(Fuca1-3GlcNAcb1-6)Mana1-6)Manb1- | 2(Gala1-3Galb1-4GlcNAcb1-6)Mana1-6)Manb1- |
| 4GlcNAcb1-4GlcNAc | 4GlcNAcb1-4GlcNAc |
| NeuGca2-3/6Galb1-4GlcNAcb1-3Galb1-4GlcNAcb1- | Galb1-4(Fuca1-3)GlcNAcb1-3Galb1-4GlcNAcb1- |
| 2(GlcNAcb1-4)Mana1-3(GalNAcb1-4GlcNAcb1- | 2(GlcNAcb1-4)Mana1-3(GalNAcb1-4GlcNAcb1- |
| 2(Galb1-4GlcNAcb1-6)Mana1-6)Manb1-4GlcNAcb1- | 2(Gala1-3Galb1-4GlcNAcb1-6)Mana1-6)Manb1- |
| 4(Fuca1-6)GlcNAc | 4GlcNAcb1-4(Fuca1-6)GlcNAc |
| NeuGca2-6Galb1-4GlcNAcb1-2(NeuGca2-6Galb1- | NeuAca2-3/6Galb1-4GlcNAcb1-2(GlcNAcb1- |
| 4GlcNAcb1-4)Mana1-3(NeuGca2-6Galb1- | 4)Mana1-3(NeuAca2-3/6Galb1-4GlcNAcb1- |
| 4GlcNAcb1-2Mana1-6)Manb1-4GlcNAcb1-4(Fuca1- | 2(NeuAca2-3/6Galb1-4GlcNAcb1-6)Mana1- |
| 6)GlcNAcb | 6)Manb1-4GlcNAcb1-4GlcNAc |
| NeuAca2-3Galb1-4GlcNAcb1-2Mana1-3(NeuAca2- | NeuAca2-3/6Galb1-4(Fuca1-3)GlcNAcb1- |
| 6Galb1-4GlcNAcb1-2(NeuAca2-3Galb1-4GlcNAcb1- | 2(GlcNAcb1-4)Mana1-3(Galb1-4GlcNAcb1- |
| 4)Mana1-6)Manb1-4GlcNAcb1-4GlcNAcb1-4GlcNAcb | 2(NeuAca2-3/6Galb1-4(Fuca1-3)GlcNAcb1- |
| | 6)Mana1-6)Manb1-4GlcNAcb1-4GlcNAc |
| NeuAca2-3/6Galb1-4(Fuca1-3)GlcNAcb1- | NeuGca2-8NeuGca2-3/6Galb1-4(Fuca1- |
| 2(GlcNAcb1-4)Mana1-3(Galb1-4GlcNAcb1- | 3)GlcNAcb1-2(Fuca1-3GlcNAcb1-4)Mana1-3(Fuca1- |
| 2(NeuAca2-3/6Galb1-4GlcNAcb1-6)Mana1- | 3GlcNAcb1-2(Fuca1-3GlcNAcb1-6)Mana1-6)Manb1- |
| 6)Manb1-4GlcNAcb1-4(Fuca1-6)GlcNAc | 4GlcNAcb1-4GlcNAc |
| NeuGca2-8NeuGca2-3/6Galb1-4(Fuca1- | NeuGca2-3/6Galb1-4GlcNAcb1-3Galb1-4GlcNAcb1- |
| 3)GlcNAcb1-2(Fuca1-3GlcNAcb1-4)Mana1- | 2(GlcNAcb1-4)Mana1-3(GalNAcb1-4GlcNAcb1- |
| 3(GlcNAcb1-2(Fuca1-3GlcNAcb1-6)Mana1- | 2(Gala1-3Galb1-4GlcNAcb1-6)Mana1-6)Manb1- |
| 6)Manb1-4GlcNAcb1-4(Fuca1-6)GlcNAc | 4GlcNAcb1-4GlcNAc |
| GlcNAcb1-4(Galb1-4(Fuca1-3)GlcNAcb1-2(Galb1- | GlcNAcb1-4(Galb1-4GlcNAcb1-2(Galb1-4GlcNAcb1- |
| 4GlcNAcb1-4)Mana1-3)(Galb1-4GlcNAcb1-3Galb1- | 4)Mana1-3)(Galb1-4GlcNAcb1-2(Galb1-4GlcNAcb1- |
| 4GlcNAcb1-2(Galb1-4GlcNAcb1-6)Mana1-6)Manb1- | 4)(Galb1-4GlcNAcb1-6)Mana1-6)Manb1- |
| 4GlcNAcb1-4GlcNAc | 4GlcNAcb1-4(Fuca1-6)GlcNAcb |
| Galb1-4GlcNAcb1-3Galb1-4GlcNAcb1-2(GlcNAcb1- | GlcNAcb1-4(Galb1-4GlcNAcb1-2(Galb1-4GlcNAcb1- |
| 4)Mana1-3(Galb1-4GlcNAcb1-3Galb1-4GlcNAcb1- | 4)Mana1-3)(Galb1-4GlcNAcb1-3Galb1-4GlcNAcb1- |
| 2(Galb1-4GlcNAcb1-6)Mana1-6)Manb1-4GlcNAcb1- | 2(Galb1-4GlcNAcb1-6)Mana1-6)Manb1-4GlcNAcb1- |
| 4(Fuca1-6)GlcNAc | 4(Fuca1-6)GlcNAc |
| NeuGca2-3/6Galb1-4GlcNAcb1-2(GlcNAcb1- | NeuAca2-3/6Galb1-4GlcNAcb1-2(NeuAca2- |
| 4)Mana1-3(NeuAca2-3/6Galb1-4GlcNAcb1- | 3/6Galb1-4GlcNAcb1-4)Mana1-3(Galb1-4GlcNAcb1- |
| 2(NeuAca2-3/6Galb1-4GlcNAcb1-6)Mana1- | 2(Galb1-4GlcNAcb1-6)Mana1-6)Manb1-4GlcNAcb1- |
| 6)Manb1-4GlcNAcb1-4GlcNAc | 4(Fuca1-6)GlcNAc |
| NeuGca2-3/6Galb1-4(Fuca1-3)GlcNAcb1- | NeuAca2-3/6Galb1-4GlcNAcb1-2(Galb1-4GlcNAcb1- |
| 2(GlcNAcb1-4)Mana1-3(Galb1-4GlcNAcb1- | 4)Mana1-3(Galb1-4GlcNAcb1-2(NeuAca2-3/6Galb1- |
| 2(NeuAca2-3/6Galb1-4(Fuca1-3)GlcNAcb1- | 4GlcNAcb1-6)Mana1-6)Manb1-4GlcNAcb1-4(Fuca1- |
| 6)Mana1-6)Manb1-4GlcNAcb1-4GlcNAc | 6)GlcNAc |
| NeuAca2-3/6Galb1-4(Fuca1-3)GlcNAcb1-2(Galb1- | NeuGca2-3/6Galb1-4(Fuca1-3)GlcNAcb1- |
| 4GlcNAcb1-4)Mana1-3(Galb1-4GlcNAcb1- | 2(GlcNAcb1-4)Mana1-3(Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| Galb1-4GlcNAcb1-2(Galb1-4GlcNAcb1-4)Mana1- | NeuAca2-3Galb1-4GlcNAcb1-2(NeuAca2-3Galb1- |
| 3(NeuAca2-3Galb1-4GlcNAcb1-2(NeuAca2-3Galb1- | 4GlcNAcb1-4)Mana1-3(Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAcb | 6)GlcNAc |
| Galb1-4GlcNAcb1-2(NeuAca2-3Galb1-4GlcNAcb1- | Galb1-4(Fuca1-3)GlcNAcb1-2(NeuAca2-3/6Galb1- |
| 4)Mana1-3(NeuAca2-3Galb1-4GlcNAcb1-2(Galb1- | 4GlcNAcb1-4)Mana1-3(Galb1-4(Fuca1-3)GlcNAcb1- |
| 4GlcNAcb1-6)Mana1-6)Manb1-4GlcNAcb1-4(Fuca1- | 2(Galb1-4(Fuca1-3)GlcNAcb1-6)Mana1-6)Manb1- |
| 6)GlcNAc | 4GlcNAcb1-4GlcNAc |
| NeuAca2-3/6Galb1-4(Fuca1-3)GlcNAcb1-2(Galb1- | Galb1-4GlcNAcb1-2(Galb1-4GlcNAcb1-4)Mana1- |
| 4GlcNAcb1-4)Mana1-3(Galb1-4GlcNAcb1-2(Galb1- | 3(Galb1-4GlcNAcb1-3Galb1-4GlcNAcb1-2(Galb1- |
| 4(Fuca1-3)GlcNAcb1-6)Mana1-6)Manb1- | 4GlcNAcb1-3Galb1-4GlcNAcb1-6)Mana1-6)Manb1- |
| 4GlcNAcb1-4(Fuca1-6)GlcNAc | 4GlcNAcb1-4GlcNAc |
| Galb1-4GlcNAcb1-3Galb1-4GlcNAcb1-3Galb1- | Galb1-4(Fuca1-3)GlcNAcb1-2(Galb1-4(Fuca1- |
| 4GlcNAcb1-2Mana1-3(Galb1-4GlcNAcb1-3Galb1- | 3)GlcNAcb1-3Galb1-4(Fuca1-3)GlcNAcb1-4)Mana1- |
| 4GlcNAcb1-3Galb1-4GlcNAcb1-2Mana1-6)Manb1- | 3(Galb1-4(Fuca1-3)GlcNAcb1-2Mana1-6)Manb1- |
| 4GlcNAcb1-4GlcNAc | 4GlcNAcb1-4(Fuca1-6)GlcNAc |
| Galb1-4(Fuca1-3)GlcNAcb1-2(Galb1-4(Fuca1- | Galb1-4(Fuca1-3)GlcNAcb1-3Galb1-4(Fuca1- |
| 3)GlcNAcb1-4)Mana1-3(Galb1-4(Fuca1- | 3)GlcNAcb1-2Mana1-3(Galb1-4(Fuca1-3)GlcNAcb1- |
| 3)GlcNAcb1-2(Galb1-4(Fuca1-3)GlcNAcb1- | 3Galb1-4(Fuca1-3)GlcNAcb1-2Mana1-6)Manb1- |
| 6)Mana1-6)Manb1-4GlcNAcb1-4(Fuca1-6)GlcNAc | 4GlcNAcb1-4(Fuca1-6)GlcNAc |
| Galb1-4(Fuca1-3)GlcNAcb1-2(Fuca1-2Galb1- | GlcNAcb1-4(Kdna1-3Galb1-4GlcNAcb1-2(Kdna1- |
| 4(Fuca1-3)GlcNAcb1-4)Mana1-3(Galb1-4(Fuca1- | 3Galb1-4GlcNAcb1-4)Mana1-3)(Kdna1-3Galb1- |
| 3)GlcNAcb1-2(Galb1-4(Fuca1-3)GlcNAcb1- | 4GlcNAcb1-2Mana1-6)Manb1-4GlcNAcb1-4(Fuca1- |
| 6)Mana1-6)Manb1-4GlcNAcb1-4GlcNAc | 6)GlcNAcb |
| GlcNAcb1-4(NeuAca2-8NeuAca2-3/6Galb1-4(Fuca1- | GlcNAcb1-4(NeuAca2-8NeuAca2-3/6Galb1-4(Fuca1- |
| 3)GlcNAcb1-2(GlcNAcb1-4)Mana1-3)(GlcNAcb1- | 3)GlcNAcb1-2(Fuca1-3GlcNAcb1-4)Mana1- |
| 2(Fuca1-3GlcNAcb1-6)Mana1-6)Manb1-4GlcNAcb1- | 3)(GlcNAcb1-2(Fuca1-3GlcNAcb1-6)Mana1- |
| 4(Fuca1-6)GlcNAc | 6)Manb1-4GlcNAcb1-4GlcNAc |
| GlcNAcb1-4(NeuAca2-3/6Galb1-4GlcNAcb1-3Galb1- | GlcNAcb1-4(Galb1-4(Fuca1-3)GlcNAcb1-3Galb1- |
| 4GlcNAcb1-2(GlcNAcb1-4)Mana1-3)(GalNAcb1- | 4(Fuca1-3)GlcNAcb1-2(GlcNAcb1-4)Mana1- |
| 4GlcNAcb1-2(Galb1-4GlcNAcb1-6)Mana1-6)Manb1- | 3)(GalNAcb1-4GlcNAcb1-2(Galb1-4GlcNAcb1- |
| 4GlcNAcb1-4GlcNAc | 6)Mana1-6)Manb1-4GlcNAcb1-4GlcNAc |
| GlcNAcb1-4(Galb1-4(Fuca1-3)GlcNAcb1-3Galb1- | NeuGca2-3/6Galb1-4GlcNAcb1-2(GlcNAcb1- |
| 4GlcNAcb1-2(GlcNAcb1-4)Mana1-3)(GalNAcb1- | 4)Mana1-3(NeuGca2-3/6Galb1-4GlcNAcb1- |
| 4GlcNAcb1-2(Galb1-4GlcNAcb1-6)Mana1-6)Manb1- | 2(NeuAca2-3/6Galb1-4GlcNAcb1-6)Mana1- |
| 4GlcNAcb1-4(Fuca1-6)GlcNAc | 6)Manb1-4GlcNAcb1-4GlcNAc |
| NeuAca2-3/6Galb1-4(Fuca1-3)GlcNAcb1- | NeuGca2-3/6Galb1-4(Fuca1-3)GlcNAcb1- |
| 2(NeuAca2-8NeuAca2-3/6Galb1-4(Fuca1- | 2(GlcNAcb1-4)Mana1-3(Galb1-4GlcNAcb1- |
| 3)GlcNAcb1-4)Mana1-3(Mana1-3Mana1-6)Manb1- | 2(NeuGca2-3/6Galb1-4GlcNAcb1-6)Mana1- |
| 4GlcNAcb1-4(Fuca1-6)GlcNAc | 6)Manb1-4GlcNAcb1-4(Fuca1-6)GlcNAc |
| NeuGca2-3/6Galb1-4(Fuca1-3)GlcNAcb1- | NeuGca2-3/6Galb1-4GlcNAcb1-2(Galb1-4GlcNAcb1- |
| 2(GlcNAcb1-4)Mana1-3(Galb1-4GlcNAcb1- | 4)Mana1-3(Galb1-4GlcNAcb1-2(NeuAca2-3/6Galb1- |
| 2(NeuGca2-3/6Galb1-4(Fuca1-3)GlcNAcb1- | 4GlcNAcb1-6)Mana1-6)Manb1-4GlcNAcb1-4(Fuca1- |
| 6)Mana1-6)Manb1-4GlcNAcb1-4GlcNAc | 6)GlcNAc |
| Gala1-3Galb1-4GlcNAcb1-2(Galb1-4GlcNAcb1- | NeuGca2-3/6Galb1-4(Fuca1-3)GlcNAcb1-2(Galb1- |
| 4)Mana1-3(NeuAca2-3/6Galb1-4GlcNAcb1- | 4GlcNAcb1-4)Mana1-3(Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4GlcNAc |
| NeuAca2-3/6Galb1-4(Fuca1-3)GlcNAcb1-2(Galb1- | Galb1-4(Fuca1-3)GlcNAcb1-2(NeuGca2-3/6Galb1- |
| 4GlcNAcb1-4)Mana1-3(Galb1-4GlcNAcb1-2(Gala1- | 4GlcNAcb1-4)Mana1-3(Galb1-4(Fuca1-3)GlcNAcb1- |
| 3Galb1-4GlcNAcb1-6)Mana1-6)Manb1-4GlcNAcb1- | 2(Galb1-4(Fuca1-3)GlcNAcb1-6)Mana1-6)Manb1- |
| 4(Fuca1-6)GlcNAc | 4GlcNAcb1-4GlcNAc |
| NeuAca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(Gala1-3Galb1-4GlcNAcb1- | 4GlcNAcb1-4)Mana1-3(Galb1-4GlcNAcb1-2(Galb1- |
| 2(Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| Fuca1-2Galb1-4(Fuca1-3)GlcNAcb1-2(Gala1- | GlcNAcb1-4(NeuAca2-8NeuGca2-3/6Galb1- |
| 3Galb1-4GlcNAcb1-4)Mana1-3(Galb1-4(Fuca1- | 4(Fuca1-3)GlcNAcb1-2(GlcNAcb1-4)Mana1- |
| 3)GlcNAcb1-2(Galb1-4(Fuca1-3)GlcNAcb1- | 3)(GlcNAcb1-2(Fuca1-3GlcNAcb1-6)Mana1- |
| 6)Mana1-6)Manb1-4GlcNAcb1-4GlcNAc | 6)Manb1-4GlcNAcb1-4(Fuca1-6)GlcNAc |
| GlcNAcb1-4(NeuAca2-8NeuGca2-3/6Galb1- | GlcNAcb1-4(NeuGca2-3/6Galb1-4GlcNAcb1-3Galb1- |
| 4(Fuca1-3)GlcNAcb1-2(Fuca1-3GlcNAcb1-4)Mana1- | 4GlcNAcb1-2(GlcNAcb1-4)Mana1-3)(GalNAcb1- |
| 3)(GlcNAcb1-2(Fuca1-3GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4GlcNAc |
| GlcNAcb1-4(Galb1-4(Fuca1-3)GlcNAcb1-3Galb1- | NeuGca2-3/6Galb1-4GlcNAcb1-2(GlcNAcb1- |
| 4GlcNAcb1-2(GlcNAcb1-4)Mana1-3)(GalNAcb1- | 4)Mana1-3(NeuGca2-3/6Galb1-4GlcNAcb1- |
| 4GlcNAcb1-2(Gala1-3Galb1-4GlcNAcb1-6)Mana1- | 2(NeuGca2-3/6Galb1-4GlcNAcb1-6)Mana1- |
| 6)Manb1-4GlcNAcb1-4GlcNAc | 6)Manb1-4GlcNAcb1-4GlcNAc |
| NeuAca2-3/6Galb1-4(Fuca1-3)GlcNAcb1- | NeuAca2-3/6Galb1-4(Fuca1-3)GlcNAcb1- |
| 2(NeuAca2-8NeuAca2-3/6Galb1-4GlcNAcb1- | 2(NeuAca2-8NeuGca2-3/6Galb1-4(Fuca1- |
| 4)Mana1-3(Mana1-3(Mana1-6)Mana1-6)Manb1- | 3)GlcNAcb1-4)Mana1-3(Mana1-3Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2(Galb1- | Gala1-3Galb1-4GlcNAcb1-2(Galb1-4GlcNAcb1- |
| 4GlcNAcb1-4)Mana1-3(Galb1-4GlcNAcb1- | 4)Mana1-3(NeuGca2-3/6Galb1-4GlcNAcb1- |
| 2(NeuGca2-3/6Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4GlcNAc |
| NeuGca2-3/6Galb1-4GlcNAcb1-2(Galb1-4GlcNAcb1- | NeuGca2-3/6Galb1-4(Fuca1-3)GlcNAcb1-2(Galb1- |
| 4)Mana1-3(Galb1-4GlcNAcb1-2(NeuGca2-3/6Galb1- | 4GlcNAcb1-4)Mana1-3(Galb1-4GlcNAcb1-2(Gala1- |
| 4GlcNAcb1-6)Mana1-6)Manb1-4GlcNAcb1-4(Fuca1- | 3Galb1-4GlcNAcb1-6)Mana1-6)Manb1-4GlcNAcb1- |
| 6)GlcNAc | 4(Fuca1-6)GlcNAc |
| NeuGca2-3/6Galb1-4(Fuca1-3)GlcNAcb1-2(Galb1- | GlcNAcb1-4(Gala1-3Galb1-4GlcNAcb1-3Galb1- |
| 4GlcNAcb1-4)Mana1-3(Gala1-3Galb1-4GlcNAcb1- | 4GlcNAcb1-2(NeuAca2-3/6Galb1-4GlcNAcb1- |
| 2(Galb1-4(Fuca1-3)GlcNAcb1-6)Mana1-6)Manb1- | 4)Mana1-3)(Mana1-3(Mana1-6)Mana1-6)Manb1- |
| 4GlcNAcb1-4GlcNAc | 4GlcNAcb1-4(Fuca1-6)GlcNAc |
| NeuAca2-3/6Galb1-4(Fuca1-3)GlcNAcb1-3Galb1- | Gala1-3Galb1-4GlcNAcb1-2(Galb1-4GlcNAcb1- |
| 4GlcNAcb1-2(Galb1-4GlcNAcb1-3Galb1-4GlcNAcb1- | 4)Mana1-3(Gala1-3Galb1-4GlcNAcb1-2(NeuAca2- |
| 4)Mana1-3(Mana1-3(Mana1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| Galb1-4(Fuca1-3)GlcNAcb1-3Galb1-4GlcNAcb1- | Fuca1-2Galb1-4(Fuca1-3)GlcNAcb1-3Galb1- |
| 2(Galb1-4(Fuca1-3)GlcNAcb1-3Galb1-4GlcNAcb1- | 4GlcNAcb1-2(Galb1-4(Fuca1-3)GlcNAcb1-3Galb1- |
| 4)Mana1-3(Mana1-3(Mana1-6)Mana1-6)Manb1- | 4GlcNAcb1-4)Mana1-3(Mana1-3(Mana1-6)Mana1- |
| 4GlcNAcb1-4(Fuca1-6)GlcNAc | 6)Manb1-4GlcNAcb1-4GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2(GlcNAcb1-4)Mana1- | 4(Fuca1-3)GlcNAcb1-2(Fuca1-3GlcNAcb1-4)Mana1- |
| 3)(GlcNAcb1-2(Fuca1-3GlcNAcb1-6)Mana1- | 3)(GlcNAcb1-2(Fuca1-3GlcNAcb1-6)Mana1- |
| 6)Manb1-4GlcNAcb1-4(Fuca1-6)GlcNAc | 6)Manb1-4GlcNAcb1-4GlcNAc |
| GlcNAcb1-4(NeuAca2-3/6Galb1-4(Fuca1- | GlcNAcb1-4(NeuAca2-3/6Galb1-4GlcNAcb1- |
| 3)GlcNAcb1-2(GlcNAcb1-4)Mana1-3)(Galb1- | 2(GlcNAcb1-4)Mana1-3)(Galb1-4GlcNAcb1- |
| 4GlcNAcb1-2(NeuAca2-3/6Galb1-4GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuACa2-3/6Galb1-4(Fuca1-3)GlcNAcb1- | GlcNAcb1-4(NeuAca2-3/6Galb1-4(Fuca1- |
| 2(GalNAcb1-4GlcNAcb1-4)Mana1-3(Galb1-4(Fuca1- | 3)GlcNAcb1-2(GlcNAcb1-4)Mana1-3)(Galb1- |
| 3)GlcNAcb1-2(Galb1-4(Fuca1-3)GlcNAcb1- | 4GlcNAcb1-2(Galb1-4(Fuca1-3)GlcNAcb1-6)Mana1- |
| 6)Mana1-6)Manb1-4GlcNAcb1-4GlcNAc | 6)Manb1-4GlcNAcb1-4(Fuca1-6)GlcNAc |
| GlcNAcb1-4(Galb1-4GlcNAcb1-3Galb1-4GlcNAcb1- | Galb1-4(Fuca1-3)GlcNAcb1-2(GalNAcb1-4(Fuca1- |
| 2(GlcNAcb1-4)Mana1-3)(Galb1-4GlcNAcb1-3Galb1- | 3)GlcNAcb1-4)Mana1-3(Galb1-4(Fuca1- |
| 4GlcNAcb1-2(Galb1-4GlcNAcb1-6)Mana1-6)Manb1- | 3)GlcNAcb1-2(Galb1-4(Fuca1-3)GlcNAcb1- |
| 4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1- | NeuAca2-3/6Galb1-4(Fuca1-3)GlcNAcb1- |
| 2(NeuGca2-8NeuGca2-3/6Galb1-4(Fuca1- | 2(NeuAca2-8NeuGca2-3/6Galb1-4GlcNAcb1- |
| 3)GlcNAcb1-4)Mana1-3(Mana1-3Mana1-6)Manb1- | 4)Mana1-3(Mana1-3(Mana1-6)Mana1-6)Manb1- |
| 4GlcNAcb1-4(Fuca1-6)GlcNAc | 4GlcNAcb1-4(Fuca1-6)GlcNAc |
| Gala1-3Galb1-4GlcNAcb1-2(Galb1-4GlcNAcb1- | GlcNAcb1-4(Gala1-3Galb1-4GlcNAcb1-3Galb1- |
| 4)Mana1-3(NeuGca2-3/6Galb1-4GlcNAcb1- | 4GlcNAcb1-2(NeuGca2-3/6Galb1-4GlcNAcb1- |
| 2(NeuGca2-3/6Galb1-4GlcNAcb1-6)Mana1- | 4)Mana1-3)(Mana1-3(Mana1-6)Mana1-6)Manb1- |
| 6)Manb1-4GlcNAcb1-4GlcNAc | 4GlcNAcb1-4(Fuca1-6)GlcNAc |
| Gala1-3Galb1-4GlcNAcb1-2(NeuAca2-3/6Galb1- | NeuGca2-3/6Galb1-4(Fuca1-3)GlcNAcb1-3Galb1- |
| 4GlcNAcb1-4)Mana1-3(Gala1-3Galb1-4GlcNAcb1- | 4GlcNAcb1-2(Galb1-4GlcNAcb1-3Galb1-4GlcNAcb1- |
| 2(Gala1-3Galb1-4GlcNAcb1-6)Mana1-6)Manb1- | 4)Mana1-3(Mana1-3(Mana1-6)Mana1-6)Manb1- |
| 4GlcNAcb1-4GlcNAc | 4GlcNAcb1-4GlcNAc |
| Gala1-3Galb1-4GlcNAcb1-2(Galb1-4GlcNAcb1- | Gala1-3Galb1-4GlcNAcb1-3Galb1-4GlcNAcb1- |
| 4)Mana1-3(Gala1-3Galb1-4GlcNAcb1-2(NeuGca2- | 2(Fuca1-2Galb1-4(Fuca1-3)GlcNAcb1-3Galb1- |
| 3/6Galb1-4GlcNAcb1-6)Mana1-6)Manb1- | 4GlcNAcb1-4)Mana1-3(Mana1-3(Mana1-6)Mana1- |
| 4GlcNAcb1-4(Fuca1-6)GlcNAc | 6)Manb1-4GlcNAcb1-4GlcNAc |
| Fuca1-2Galb1-4(Fuca1-3)GlcNAcb1-2(Gala1- | GlcNAcb1-4(NeuAca2-8NeuAca2-3/6Galb1-4(Fuca1- |
| 3Galb1-4GlcNAcb1-4)Mana1-3(Gala1-3Galb1- | 3)GlcNAcb1-2Mana1-3)(NeuAca2-3/6Galb1- |
| 4GlcNAcb1-2(Gala1-3Galb1-4GlcNAcb1-6)Mana1- | 4(Fuca1-3)GlcNAcb1-2Mana1-6)Manb1-4GlcNAcb1- |
| 6)Manb1-4GlcNAcb1-4GlcNAc | 4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(GlcNAcb1-4)Mana1-3)(Galb1-4GlcNAcb1- | 3)GlcNAcb1-2(GlcNAcb1-4)Mana1-3)(Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4GlcNAcb1- | NeuGca2-3/6Galb1-4(Fuca1-3)GlcNAcb1- |
| 2(Galb1-4GlcNAcb1-4)Mana1-3)(Galb1-4GlcNAcb1- | 2(GalNAcb1-4GlcNAcb1-4)Mana1-3(Galb1-4(Fuca1- |
| 2(NeuAca2-3/6Galb1-4GlcNAcb1-6)Mana1- | 3)GlcNAcb1-2(Galb1-4(Fuca1-3)GlcNAcb1- |
| 6)Manb1-4GlcNAcb1-4GlcNAc | 6)Mana1-6)Manb1-4GlcNAcb1-4GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GlcNAcb1-4)Mana1-3)(Galb1- |
| 3)(Galb1-4GlcNAcb1-2(Galb1-4(Fuca1-3)GlcNAcb1- | 4GlcNAcb1-2(Galb1-4(Fuca1-3)GlcNAcb1-6)Mana1- |
| 6)Mana1-6)Manb1-4GlcNAcb1-4GlcNAc | 6)Manb1-4GlcNAcb1-4(Fuca1-6)GlcNAc |
| GlcNAcb1-4(NeuAca2-3/6Galb1-4(Fuca1- | GlcNAcb1-4(Galb1-4(Fuca1-3)GlcNAcb1-2(Galb1- |
| 3)GlcNAcb1-2(Galb1-4GlcNAcb1-4)Mana1- | 4GlcNAcb1-4)Mana1-3)(Galb1-4(Fuca1- |
| 3)(Galb1-4GlcNAcb1-2(Galb1-4GlcNAcb1-6)Mana1- | 3)GlcNAcb1-2(Galb1-4(Fuca1-3)GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Galb1-4(Fuca1-3)GlcNAcb1-2(Galb1- | GlcNAcb1-4(Galb1-4(Fuca1-3)GlcNAcb1-2(Galb1- |
| 4(Fuca1-3)GlcNAcb1-4)Mana1-3)(Galb1-4(Fuca1- | 4(Fuca1-3)GlcNAcb1-4)Mana1-3)(Galb1-4(Fuca1- |
| 3)GlcNAcb1-2(Galb1-4(Fuca1-3)GlcNAcb1- | 3)GlcNAcb1-2(Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| Galb1-4GlcNAcb1-2(Galb1-4GlcNAcb1-4)(Fuca1- | NeuGca2-3/6Galb1-4(Fuca1-3)GlcNAcb1- |
| 3)Mana1-3(Fuca1-2Galb1-3GalNAcb1-4GlcNAcb1- | 2(NeuGca2-8NeuGca2-3/6Galb1-4(Fuca1- |
| 2(Galb1-4GlcNAcb1-6)(Fuca1-3)Mana1-6)Manb1- | 3)GlcNAcb1-4)Mana1-3(Mana1-3Mana1-6)Manb1- |
| 4GlcNAcb1-4(Fuca1-6)GlcNAcb | 4GlcNAcb1-4(Fuca1-6)GlcNAc |
| NeuAca2-3/6Galb1-4(Fuca1-3)GlcNAcb1- | Gala1-3Galb1-4GlcNAcb1-2(NeuGca2-3/6Galb1- |
| 2(NeuGca2-8NeuGca2-3/6Galb1-4GlcNAcb1- | 4GlcNAcb1-4)Mana1-3(Gala1-3Galb1-4GlcNAcb1- |
| 4)Mana1-3(Mana1-3(Mana1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4GlcNAc |
| Gala1-3Galb1-4GlcNAcb1-2(Gala1-3Galb1- | Galb1-3Galb1-4GlcNAcb1-2(Galb1-3Galb1- |
| 4GlcNAcb1-4)Mana1-3(Gala1-3Galb1-4GlcNAcb1- | 4GlcNAcb1-6)Mana1-3(Galb1-3Galb1-4GlcNAcb1- |
| 2(Gala1-3Galb1-4GlcNAcb1-6)Mana1-6)Manb1- | 2(Galb1-3Galb1-4GlcNAcb1-4)Mana1-6)Manb1- |
| 4GlcNAcb1-4(Fuca1-6)GlcNAc | 4GlcNAcb1-4(Fuca1-6)GlcNAc |
| Galb1-3Galb1-4GlcNAcb1-2(Galb1-3Galb1- | Gala1-3Galb1-4GlcNAcb1-2(Gala1-3Galb1- |
| 4GlcNAcb1-4)Mana1-3(Galb1-3Galb1-4GlcNAcb1- | 4GlcNAcb1-4)Mana1-3(Gala1-3Galb1-4GlcNAcb1- |
| 2(Galb1-3Galb1-4GlcNAcb1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAcb |
| NeuAca2-6Galb1-4GlcNAcb1-2(NeuAca2-3Galb1- | NeuAca2-6Galb1-4(NeuAca2-6)GlcNAcb1- |
| 3(NeuAca2-6)GlcNAcb1-4)Mana1-3(NeuAca2- | 2(NeuAca2-3Galb1-4GlcNAcb1-4)Mana1- |
| 3Galb1-4GlcNAcb1-2Mana1-6)Manb1-4GlcNAcb1- | 3(NeuAca2-6Galb1-4GlcNAcb1-2Mana1-6)Manb1- |
| 4GlcNAc | 4GlcNAcb1-4GlcNAcb |
| NeuAca2-3Galb1-4(NeuAca2-3)GlcNAcb1- | NeuAca2-6Galb1-4GlcNAcb1-2(NeuAca2-3Galb1- |
| 2(NeuAca2-3Galb1-4GlcNAcb1-4)Mana1- | 3(NeuAca2-6)GlcNAcb1-4)Mana1-3(NeuAca2- |
| 3(NeuAca2-3Galb1-4GlcNAcb1-2Mana1-6)Manb1- | 6Galb1-4GlcNAcb1-2Mana1-6)Manb1-4GlcNAcb1- |
| 4GlcNAcb1-4GlcNAc | 4GlcNAc |
| NeuAca2-6Galb1-4(NeuAca2-6)GlcNAcb1- | NeuAca2-6Galb1-4GlcNAcb1-2(NeuAca2-3Galb1- |
| 2(NeuAca2-3Galb1-4GlcNAcb1-4)Mana1- | 4(NeuAca2-6)GlcNAcb1-4)Mana1-3(NeuAca2- |
| 3(NeuAca2-3Galb1-4GlcNAcb1-2Mana1-6)Manb1- | 3Galb1-4GlcNAcb1-2Mana1-6)Manb1-4GlcNAcb1- |
| 4GlcNAcb1-4GlcNAcb | 4GlcNAc |
| NeuAca2-6Galb1-4GlcNAcb1-2(NeuAca2- | NeuAca2-3Galb1-4GlcNAcb1-2(NeuAca2-3Galb1- |
| 3(NeuAca2-6)Galb1-4GlcNAcb1-4)Mana1- | 3(NeuAca2-6)GlcNAcb1-4)Mana1-3(NeuAca2- |
| 3(NeuAca2-3Galb1-4GlcNAcb1-2Mana1-6)Manb1- | 3Galb1-4GlcNAcb1-2Mana1-6)Manb1-4GlcNAcb1- |
| 4GlcNAcb1-4GlcNAc | 4GlcNAc |
| NeuAca2-6Galb1-4GlcNAcb1-2(NeuAca2-3Galb1- | GlcNAcb1-4(NeuAca2-8NeuGca2-3/6Galb1- |
| 4(NeuAca2-6)GlcNAcb1-4)Mana1-3(NeuAca2- | 4(Fuca1-3)GlcNAcb1-2Mana1-3)(NeuAca2- |
| 6Galb1-4GlcNAcb1-2Mana1-6)Manb1-4GlcNAcb1- | 3/6Galb1-4(Fuca1-3)GlcNAcb1-2Mana1-6)Manb1- |
| 4GlcNAc | 4GlcNAcb1-4(Fuca1-6)GlcNAc |
| GlcNAcb1-4(NeuAca2-3/6Galb1-4(Fuca1- | GlcNAcb1-4(NeuGca2-3/6Galb1-4GlcNAcb1- |
| 3)GlcNAcb1-2(NeuAca2-8NeuAca2-3/6Galb1- | 2(GlcNAcb1-4)Mana1-3)(Galb1-4GlcNAcb1- |
| 4(Fuca1-3)GlcNAcb1-4)Mana1-3)(Mana1-3Mana1- | 2(NeuGca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(Galb1-4GlcNAcb1-4)Mana1-3)(Galb1-4GlcNAcb1- | 3)GlcNAcb1-2(GlcNAcb1-4)Mana1-3)(Galb1- |
| 2(NeuAca2-3/6Galb1-4GlcNAcb1-6)Mana1- | 4GlcNAcb1-2(NeuGca2-3/6Galb1-4GlcNAcb1- |
| 6)Manb1-4GlcNAcb1-4GlcNAc | 6)Mana1-6)Manb1-4GlcNAcb1-4GlcNAc |
| NeuAca2-3/6Galb1-4GlcNAcb1-2(Galb1-4GlcNAcb1- | GlcNAcb1-4(Gala1-3Galb1-4GlcNAcb1-2(Galb1- |
| 4)Mana1-3(Galb1-4GlcNAcb1-3Galb1-4GlcNAcb1- | 4GlcNAcb1-4)Mana1-3)(Galb1-4GlcNAcb1- |
| 2(Galb1-4GlcNAcb1-6)Mana1-6)Manb1-4GlcNAcb1- | 2(NeuAca2-3/6Galb1-4GlcNAcb1-6)Mana1- |
| 4(Fuca1-6)GlcNAc | 6)Manb1-4GlcNAcb1-4(Fuca1-6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(Galb1-4GlcNAcb1-2(Galb1-4GlcNAcb1-6)Mana1- | 3)(Galb1-4GlcNAcb1-2(Gala1-3Galb1-4GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuGca2-3/6Galb1-4(Fuca1- | NeuAca2-3/6Galb1-4(Fuca1-3)GlcNAcb1-2(Galb1- |
| 3)GlcNAcb1-2(Galb1-4GlcNAcb1-4)Mana1- | 4GlcNAcb1-4)Mana1-3(Galb1-4GlcNAcb1-3Galb1- |
| 3)(Galb1-4GlcNAcb1-2(Galb1-4(Fuca1-3)GlcNAcb1- | 4GlcNAcb1-2(Galb1-4GlcNAcb1-6)Mana1-6)Manb1- |
| 6)Mana1-6)Manb1-4GlcNAcb1-4GlcNAc | 4GlcNAcb1-4GlcNAc |
| Galb1-4(Fuca1-3)GlcNAcb1-2(Galb1-4(Fuca1- | GlcNAcb1-4(Gala1-3Galb1-4(Fuca1-3)GlcNAcb1- |
| 3)GlcNAcb1-4)Mana1-3(Galb1-4GlcNAcb1-3Galb1- | 2(Galb1-4GlcNAcb1-4)Mana1-3)(Galb1-4GlcNAcb1- |
| 4GlcNAcb1-2(Galb1-4GlcNAcb1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4(Fuca1-3)GlcNAcb1-2(Galb1-4(Fuca1- | NeuGca2-3/6Galb1-4(Fuca1-3)GlcNAcb1- |
| 3)GlcNAcb1-4)Mana1-3(Galb1-4(Fuca1- | 2(NeuGca2-8NeuGca2-3/6Galb1-4GlcNAcb1- |
| 3)GlcNAcb1-3Galb1-4GlcNAcb1-2(Galb1- | 4)Mana1-3(Mana1-3(Mana1-6)Mana1-6)Manb1- |
| 4GlcNAcb1-6)Mana1-6)Manb1-4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuGca2-8NeuGca2-3/6Galb1- |
| 3)GlcNAcb1-2(NeuAca2-8NeuGca2-3/6Galb1- | 4(Fuca1-3)GlcNAcb1-2Mana1-3)(NeuAca2- |
| 4(Fuca1-3)GlcNAcb1-4)Mana1-3)(Mana1-3Mana1- | 3/6Galb1-4(Fuca1-3)GlcNAcb1-2Mana1-6)Manb1- |
| 6)Manb1-4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuGca2-3/6Galb1-4GlcNAcb1- |
| 3)GlcNAcb1-2(NeuAca2-8NeuAca2-3/6Galb1- | 2(Galb1-4GlcNAcb1-4)Mana1-3)(Galb1-4GlcNAcb1- |
| 4GlcNAcb1-4)Mana1-3)(Mana1-3(Mana1-6)Mana1- | 2(NeuGca2-3/6Galb1-4GlcNAcb1-6)Mana1- |
| 6)Manb1-4GlcNAcb1-4GlcNAc | 6)Manb1-4GlcNAcb1-4GlcNAc |
| GlcNAcb1-4(Gala1-3Galb1-4GlcNAcb1-2(Galb1- | GlcNAcb1-4(Gala1-3Galb1-4GlcNAcb1-2(Galb1- |
| 4GlcNAcb1-4)Mana1-3)(Gala1-3Galb1-4GlcNAcb1- | 4GlcNAcb1-4)Mana1-3)(Galb1-4GlcNAcb1- |
| 2(NeuAca2-3/6Galb1-4GlcNAcb1-6)Mana1- | 2(NeuGca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| GlcNAcb1-4(NeuGca2-3/6Galb1-4(Fuca1- | NeuGca2-3/6Galb1-4(Fuca1-3)GlcNAcb1-2(Galb1- |
| 3)GlcNAcb1-2(Galb1-4GlcNAcb1-4)Mana1- | 4GlcNAcb1-4)Mana1-3(Galb1-4GlcNAcb1-3Galb1- |
| 3)(Galb1-4GlcNAcb1-2(Gala1-3Galb1-4GlcNAcb1- | 4GlcNAcb1-2(Galb1-4GlcNAcb1-6)Mana1-6)Manb1- |
| 6)Mana1-6)Manb1-4GlcNAcb1-4GlcNAc | 4GlcNAcb1-4GlcNAc |
| NeuGca2-3/6Galb1-4GlcNAcb1-2(Galb1-4GlcNAcb1- | Galb1-4GlcNAcb1-2(Gala1-3Galb1-4GlcNAcb1- |
| 4)Mana1-3(Galb1-4GlcNAcb1-3Galb1-4GlcNAcb1- | 4)Mana1-3(NeuAca2-3/6Galb1-4GlcNAcb1-3Galb1- |
| 2(Galb1-4GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| Galb1-4(Fuca1-3)GlcNAcb1-2(Gala1-3Galb1- | GlcNAcb1-4(Galb1-4(Fuca1-3)GlcNAcb1-3Galb1- |
| 4GlcNAcb1-4)Mana1-3(Galb1-4GlcNAcb1-3Galb1- | 4GlcNAcb1-2(Galb1-4GlcNAcb1-3Galb1-4GlcNAcb1- |
| 4GlcNAcb1-2(Galb1-4(Fuca1-3)GlcNAcb1-6)Mana1- | 4)Mana1-3)(Mana1-3(Mana1-6)Mana1-6)Manb1- |
| 6)Manb1-4GlcNAcb1-4GlcNAc | 4GlcNAcb1-4(Fuca1-6)GlcNAc |
| GlcNAcb1-4(Galb1-4(Fuca1-3)GlcNAcb1-3Galb1- | NeuAca2-8NeuAca2-3/6Galb1-4GlcNAcb1-3Galb1- |
| 4GlcNAcb1-2(Galb1-4(Fuca1-3)GlcNAcb1-3Galb1- | 4GlcNAcb1-2(GlcNAcb1-4)Mana1-3(GalNAcb1- |
| 4GlcNAcb1-4)Mana1-3)(Mana1-3(Mana1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4GlcNAc |
| NeuAca2-8NeuAca2-3/6Galb1-4(Fuca1-3)GlcNAcb1- | GlcNAcb1-4(Gab1-4(Fuca1-3)GlcNAcb1- |
| 2(Fuca1-3GlcNAcb1-4)Mana1-3(Fuca1-3GlcNAcb1- | 2(GalNAcb1-4(Fuca1-3)GlcNAcb1-4)Mana1- |
| 2(Fuca1-3GlcNAcb1-6)Mana1-6)Manb1-4GlcNAcb1- | 3)(Galb1-4(Fuca1-3)GlcNAcb1-2(Galb1-4(Fuca1- |
| 4(Fuca1-6)GlcNAc | 3)GlcNAcb1-6)Mana1-6)Manb1-4GlcNAcb1-4GlcNAc |
| GlcNAcb1-4(Galb1-4(Fuca1-3)GlcNAcb1- | GlcNAcb1-4(NeuAca2-3/6Galb1-4(Fuca1- |
| 2(GalNAcb1-4GlcNAcb1-4)Mana1-3)(Galb1- | 3)GlcNAcb1-2(NeuGca2-8NeuGca2-3/6Galb1- |
| 4(Fuca1-3)GlcNAcb1-2(Galb1-4(Fuca1-3)GlcNAcb1- | 4(Fuca1-3)GlcNAcb1-4)Mana1-3)(Mana1-3Mana1- |
| 6)Mana1-6)Manb1-4GlcNAcb1-4(Fuca1-6)GlcNAc | 6)Manb1-4GlcNAcb1-4GlcNAc |
| GlcNAcb1-4(NeuGca2-8NeuGca2-3/6Galb1- | GlcNAcb1-4(NeuAca2-3/6Galb1-4(Fuca1- |
| 4(Fuca1-3)GlcNAcb1-2Mana1-3)(NeuGca2- | 3)GlcNAcb1-2(NeuAca2-8NeuGca2-3/6Galb1- |
| 3/6Galb1-4(Fuca1-3)GlcNAcb1-2Mana1-6)Manb1- | 4GlcNAcb1-4)Mana1-3)(Mana1-3(Mana1-6)Mana1- |
| 4GlcNAcb1-4(Fuca1-6)GlcNAc | 6)Manb1-4GlcNAcb1-4GlcNAc |
| GlcNAcb1-4(Gala1-3Galb1-4GlcNAcb1-2(Galb1- | Galb1-4GlcNAcb1-2(Gala1-3Galb1-4GlcNAcb1- |
| 4GlcNAcb1-4)Mana1-3)(Gala1-3Galb1-4GlcNAcb1- | 4)Mana1-3(NeuGca2-3/6Galb1-4GlcNAcb1-3Galb1- |
| 2(NeuGca2-3/6Galb1-4GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4GlcNAc |
| Galb1-4(Fuca1-3)GlcNAcb1-3Galb1-4GlcNAcb1- | GlcNAcb1-4(Gala1-3Galb1-4GlcNAcb1-2(Galb1- |
| 2(Gala1-3Galb1-4GlcNAcb1-4)Mana1-3(Gala1- | 4GlcNAcb1-4)Mana1-3)(Gala1-3Galb1-4GlcNAcb1- |
| 3Galb1-4GlcNAcb1-2(Galb1-4GlcNAcb1-6)Mana1- | 2(Gala1-3Galb1-4GlcNAcb1-6)Mana1-6)Manb1- |
| 6)Manb1-4GlcNAcb1-4GlcNAc | 4GlcNAcb1-4(Fuca1-6)GlcNAc |
| NeuAca2-8NeuGca2-3/6Galb1-4GlcNAcb1-3Galb1- | NeuAca2-8NeuGca2-3/6Galb1-4(Fuca1- |
| 4GlcNAcb1-2(GlcNAcb1-4)Mana1-3(GalNAcb1- | 3)GlcNAcb1-2(Fuca1-3GlcNAcb1-4)Mana1-3(Fuca1- |
| 4GlcNAcb1-2(Galb1-4GlcNAcb1-6)Mana1-6)Manb1- | 3GlcNAcb1-2(Fuca1-3GlcNAcb1-6)Mana1-6)Manb1- |
| 4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(NeuGca2-8NeuGca2-3/6Galb1- | 3)GlcNAcb1-2(NeuGca2-8NeuGca2-3/6Galb1- |
| 4GlcNAcb1-4)Mana1-3)(Mana1-3(Mana1-6)Mana1- | 4(Fuca1-3)GlcNAcb1-4)Mana1-3)(Mana1-3Mana1- |
| 6)Manb1-4GlcNAcb1-4GlcNAc | 6)Manb1-4GlcNAcb1-4GlcNAc |
| Galb1-4GlcNAcb1-3Galb1-4GlcNAcb1-2(Gala1- | GlcNAcb1-4(Gala1-3Galb1-4GlcNAcb1-2(Gala1- |
| 3Galb1-4GlcNAcb1-4)Mana1-3(Gala1-3Galb1- | 3Galb1-4GlcNAcb1-4)Mana1-3)(Gala1-3Galb1- |
| 4GlcNAcb1-2(Gala1-3Galb1-4GlcNAcb1-6)Mana1- | 4GlcNAcb1-2(Gala1-3Galb1-4GlcNAcb1-6)Mana1- |
| 6)Manb1-4GlcNAcb1-4GlcNAc | 6)Manb1-4GlcNAcb1-4GlcNAc |
| Galb1-4GlcNAcb1-3Galb1-4GlcNAcb1-2(Galb1- | Galb1-4GlcNAcb1-3Galb1-4GlcNAcb1-2(Galb1- |
| 4GlcNAcb1-4)Mana1-3(Galb1-4GlcNAcb1-3Galb1- | 4GlcNAcb1-3Galb1-4GlcNAcb1-4)Mana1-3(Galb1- |
| 4GlcNAcb1-2(Galb1-4GlcNAcb1-3Galb1-4GlcNAcb1- | 4GlcNAcb1-2(Galb1-4GlcNAcb1-3Galb1-4GlcNAcb1- |
| 6)Mana1-6)Manb1-4Glcb | 6)Mana1-6)Manb1-4Glcb |
| Galb1-4GlcNAcb1-2(Galb1-4GlcNAcb1-3Galb1- | Galb1-4GlcNAcb1-3Galb1-4GlcNAcb1-2(Galb1- |
| 4GlcNAcb1-4)Mana1-3(Galb1-4GlcNAcb1-3Galb1- | 4GlcNAcb1-3Galb1-4GlcNAcb1-4)Mana1-3(Galb1- |
| 4GlcNAcb1-2(Galb1-4GlcNAcb1-3Galb1-4GlcNAcb1- | 4GlcNAcb1-3Galb1-4GlcNAcb1-2(Galb1-4GlcNAcb1- |
| 6)Mana1-6)Manb1-4Glcb | 6)Mana1-6)Manb1-4Glcb |
| NeuAca2-3/6Galb1-4GlcNAcb1-2(GlcNAcb1- | NeuAca2-3/6Galb1-4(Fuca1-3)GlcNAcb1- |
| 4)Mana1-3(NeuAca2-3/6Galb1-4GlcNAcb1- | 2(GlcNAcb1-4)Mana1-3(NeuAca2-3/6Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-6Galb1-4GlcNAcb1-2Mana1- | NeuAca2-3Galb1-3GlcNAcb1-2(NeuAca2-3Galb1- |
| 3)(NeuAca2-6Galb1-4GlcNAcb1-2(NeuAca2-3Galb1- | 3GlcNAcb1-4)Mana1-3(NeuAca2-3Galb1- |
| 4GlcNAcb1-6)Mana1-6)Manb1-4GlcNAcb1-4(Fuca1- | 3GlcNAcb1-2(GlcNAcb1-6)Mana1-6)Manb1- |
| 6)GlcNAcb | 4GlcNAcb1-4(Fuca1-6)GlcNAc |
| NeuAca2-3Galb1-3GlcNAcb1-2(NeuAca2-3Galb1- | GlcNAcb1-4(NeuAca2-3Galb1-4GlcNAcb1- |
| 3GlcNAcb1-4)Mana1-3(GlcNAcb1-2(NeuAca2- | 2(NeuAca2-3Galb1-4GlcNAcb1-4)Mana1- |
| 3Galb1-3GlcNAcb1-6)Mana1-6)Manb1-4GlcNAcb1- | 3)(NeuAca2-3Galb1-4GlcNAcb1-2Mana1-6)Manb1- |
| 4(Fuca1-6)GlcNAc | 4GlcNAcb1-4(Fuca1-6)GlcNAc |
| GlcNAcb1-4(NeuAca2-3Galb1-4GlcNAcb1-4Mana1- | NeuAca2-6Galb1-4GlcNAcb1-2(GalNAcb1- |
| 3)(NeuAca2-3Galb1-4GlcNAcb1-2(NeuAca2-3Galb1- | 4(NeuAca2-3)Galb1-4GlcNAcb1-4)Mana1- |
| 4GlcNAcb1-6)Mana1-6)Manb1-4GlcNAcb1-4(Fuca1- | 3(NeuAca2-3Galb1-4GlcNAcb1-2Mana1-6)Manb1- |
| 6)GlcNAcb | 4GlcNAcb1-4(Fuca1-6)GlcNAc |
| GlcNAcb1-4(NeuAca2-3Galb1-4GlcNAcb1- | NeuAca2-3Galb1-3GlcNAcb1-2(NeuAca2-3Galb1- |
| 2(NeuAca2-3Galb1-4GlcNAcb1-4)Mana1- | 3GlcNAcb1-4)Mana1-3(NeuAca2-3Galb1- |
| 3)(NeuAca2-3Galb1-4GlcNAcb1-2Mana1-6)Manb1- | 3GlcNAcb1-2(GlcNAcb1-6)Mana1-6)Manb1- |
| 4GlcNAcb1-4(Fuca1-6)GlcNAcb | 4GlcNAcb1-4(Fuca1-6)GlcNAcb |
| NeuAca2-3Galb1-3GlcNAcb1-2(NeuAca2-3Galb1- | NeuGca2-8NeuGca2-3/6Galb1-4GlcNAcb1-3Galb1- |
| 3GlcNAcb1-4)Mana1-3(GlcNAcb1-2(NeuAca2- | 4GlcNAcb1-2(GlcNAcb1-4)Mana1-3(GalNAcb1- |
| 3Galb1-3GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAcb | 4GlcNAcb1-4GlcNAc |
| NeuAca2-3/6Galb1-4(Fuca1-3)GlcNAcb1- | NeuGca2-8NeuGca2-3/6Galb1-4(Fuca1- |
| 2(GlcNAcb1-4)Mana1-3(Galb1-4GlcNAcb1- | 3)GlcNAcb1-2(Fuca1-3GlcNAcb1-4)Mana1-3(Fuca1- |
| 2(NeuAca2-3/6Galb1-4(Fuca1-3)GlcNAcb1- | 3GlcNAcb1-2(Fuca1-3GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| GlcNAcb1-4(NeuAca2-3/6Galb1-4GlcNAcb1- | GlcNAcb1-4(Galb1-4(Fuca1-3)GlcNAcb1-2(Galb1- |
| 2(Galb1-4GlcNAcb1-4)Mana1-3)(Galb1-4GlcNAcb1- | 4GlcNAcb1-4)Mana1-3)(Galb1-4GlcNAcb1-3Galb1- |
| 3Galb1-4GlcNAcb1-2(Galb1-4GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3)(Galb1- | 3)GlcNAcb1-2(NeuGca2-8NeuGca2-3/6Galb1- |
| 4GlcNAcb1-3Galb1-4GlcNAcb1-2(Galb1-4GlcNAcb1- | 4GlcNAcb1-4)Mana1-3)(Mana1-3(Mana1-6)Mana1- |
| 6)Mana1-6)Manb1-4GlcNAcb1-4GlcNAc | 6)Manb1-4GlcNAcb1-4GlcNAc |
| NeuAca2-3/6Galb1-4GlcNAcb1-2(Galb1-4GlcNAcb1- | NeuGca2-3/6Galb1-4(Fuca1-3)GlcNAcb1- |
| 4)Mana1-3(NeuAca2-3/6Galb1-4GlcNAcb1- | 2(GlcNAcb1-4)Mana1-3(NeuAca2-3/6Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuGca2-3/6Galb1-4GlcNAcb1-2(GlcNAcb1- |
| 4GlcNAcb1-4)Mana1-3(NeuAca2-6Galb1- | 4)Mana1-3(NeuAca2-3/6Galb1-4GlcNAcb1- |
| 4GlcNAcb1-2(Galb1-4GlcNAcb1-6)Mana1-6)Manb1- | 2(NeuAca2-3/6Galb1-4GlcNAcb1-6)Mana1- |
| 4GlcNAcb1-4GlcNAc | 6)Manb1-4GlcNAcb1-4(Fuca1-6)GlcNAc |
| NeuGca2-3/6Galb1-4(Fuca1-3)GlcNAcb1- | NeuAca2-3/6Galb1-4(Fuca1-3)GlcNAcb1-2(Galb1- |
| 2(GlcNAcb1-4)Mana1-3(Galb1-4GlcNAcb1- | 4GlcNAcb1-4)Mana1-3(Galb1-4GlcNAcb1- |
| 2(NeuAca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuAca2-3/6Galb1-4(Fuca1-3)GlcNAcb1-2(Galb1- | GlcNAcb1-4(NeuGca2-3/6Galb1-4GlcNAcb1- |
| 4GlcNAcb1-4)Mana1-3(Galb1-4GlcNAcb1- | 2(Galb1-4GlcNAcb1-4)Mana1-3)(Galb1-4GlcNAcb1- |
| 2(NeuAca2-3/6Galb1-4(Fuca1-3)GlcNAcb1- | 3Galb1-4GlcNAcb1-2(Galb1-4GlcNAcb1-6)Mana1- |
| 6)Mana1-6)Manb1-4GlcNAcb1-4GlcNAc | 6)Manb1-4GlcNAcb1-4GlcNAc |
| Galb1-4(Fuca1-3)GlcNAcb1-2(Galb1-4(Fuca1- | Galb1-4(Fuca1-3)GlcNAcb1-2(NeuAca2-3/6Galb1- |
| 3)GlcNAcb1-4)Mana1-3(NeuAca2-3/6Galb1- | 4GlcNAcb1-4)Mana1-3(Galb1-4(Fuca1-3)GlcNAcb1- |
| 4GlcNAcb1-2(Galb1-4(Fuca1-3)GlcNAcb1-6)Mana1- | 2(Galb1-4(Fuca1-3)GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| NeuAca2-3/6Galb1-4(Fuca1-3)GlcNAcb1-2(Galb1- | NeuAca2-6Galb1-4GlcNAcb1-2(Galb1-4(Fuca1- |
| 4(Fuca1-3)GlcNAcb1-4)Mana1-3(Galb1-4(Fuca1- | 3)GlcNAcb1-4)Mana1-3(Galb1-4(Fuca1- |
| 3)GlcNAcb1-2(Galb1-4(Fuca1-3)GlcNAcb1- | 3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuAca2-6Galb1-4GlcNAcb1-2(Galb1-4(Fuca1- | NeuAca2-6Galb1-4GlcNAcb1-3Galb1-4(Fuca1- |
| 3)GlcNAcb1-6Galb1-4(Fuca1-3)GlcNAcb1-4)Mana1- | 3)GlcNAcb1-2Mana1-3(Galb1-4(Fuca1-3)GlcNAcb1- |
| 3(Galb1-4(Fuca1-3)GlcNAcb1-2Mana1-6)Manb1- | 3Galb1-4(Fuca1-3)GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(Galb1-4GlcNAcb1-4)Mana1- | Galb1-4GlcNAcb1-3Galb1-4GlcNAcb1-3Galb1- |
| 3(Galb1-4GlcNAcb1-3Galb1-4GlcNAcb1-2(Galb1- | 4GlcNAcb1-2Mana1-3(Galb1-4GlcNAcb1-3Galb1- |
| 4GlcNAcb1-3Galb1-4GlcNAcb1-6)Mana1-6)Manb1- | 4GlcNAcb1-3Galb1-4GlcNAcb1-2Mana1-6)Manb1- |
| 4GlcNAcb1-4(Fuca1-6)GlcNAc | 4GlcNAcb1-4(Fuca1-6)GlcNAc |
| Galb1-4GlcNAcb1-2(Galb1-4GlcNAcb1-4)Mana1- | Galb1-4GlcNAcb1-2Galb1-4GlcNAcb1-2(Galb1- |
| 3(Galb1-4GlcNAcb1-3Galb1-4GlcNAcb1-2(Galb1- | 4GlcNAcb1-2Galb1-4GlcNAcb1-4)Mana1-3(Galb1- |
| 4GlcNAcb1-3Galb1-4GlcNAcb1-6)Mana1-6)Manb1- | 4GlcNAcb1-2Galb1-4GlcNAcb1-2Mana1-6)Manb1- |
| 4GlcNAcb1-4(Fuca1-6)GlcNAc | 4GlcNAcb1-4(Fuca1-6)GlcNAc |
| Galb1-4(Fuca1-3)GlcNAcb1-2(Fuca1-2Galb1- | GlcNAcb1-4(NeuAca2-8NeuAca2-3/6Galb1-4(Fuca1- |
| 4(Fuca1-3)GlcNAcb1-4)Mana1-3(Galb1-4(Fuca1- | 3)GlcNAcb1-2(Fuca1-3GlcNAcb1-4)Mana1- |
| 3)GlcNAcb1-2(Galb1-4(Fuca1-3)GlcNAcb1- | 3)(GlcNAcb1-2(Fuca1-3GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(NeuAca2-8NeuAca2-3/6Galb1-4(Fuca1- | GlcNAcb1-4(NeuAca2-3/6Galb1-4GlcNAcb1-3Galb1- |
| 3)GlcNAcb1-2(Fuca1-3GlcNAcb1-4)Mana1- | 4GlcNAcb1-2(GlcNAcb1-4)Mana1-3)(GalNAcb1- |
| 3)(Fuca1-3GlcNAcb1-2(Fuca1-3GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(Galb1-4(Fuca1-3)GlcNAcb1-3Galb1- | NeuGca2-3/6Galb1-4(Fuca1-3)GlcNAcb1- |
| 4(Fuca1-3)GlcNAcb1-2(GlcNAcb1-4)Mana1- | 2(GlcNAcb1-4)Mana1-3(NeuGca2-3/6Galb1- |
| 3)(GalNAcb1-4GlcNAcb1-2(Galb1-4GlcNAcb1- | 4GlcNAcb1-2(NeuAca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4GlcNAc |
| NeuGca2-3/6Galb1-4GlcNAcb1-2(GlcNAcb1- | NeuGca2-3/6Galb1-4GlcNAcb1-2(Galb1-4GlcNAcb1- |
| 4)Mana1-3(NeuGca2-3/6Galb1-4GlcNAcb1- | 4)Mana1-3(NeuAca2-3/6Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4(Fuca1-6)GlcNAc | 6)Manb1-4GlcNAcb1-4GlcNAc |
| NeuAca2-3/6Galb1-4(Fuca1-3)GlcNAcb1-2(Galb1- | Gala1-3Galb1-4GlcNAcb1-2(Galb1-4GlcNAcb1- |
| 4GlcNAcb1-4)Mana1-3(NeuAca2-3/6Galb1- | 4)Mana1-3(NeuAca2-3/6Galb1-4GlcNAcb1- |
| 4GlcNAcb1-2(Gala1-3Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1-2(Galb1- |
| 2(GlcNAcb1-4)Mana1-3(Galb1-4GlcNAcb1- | 4GlcNAcb1-4)Mana1-3(Galb1-4GlcNAcb1- |
| 2(NeuGca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuGca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(Galb1-4GlcNAcb1- | 4(Fuca1-3)GlcNAcb1-4)Mana1-3(Galb1-4(Fuca1- |
| 2(NeuAca2-3/6Galb1-4(Fuca1-3)GlcNAcb1- | 3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| Galb1-4(Fuca1-3)GlcNAcb1-2(NeuGca2-3/6Galb1- | Gala1-3Galb1-4(Fuca1-3)GlcNAcb1-2(Galb1- |
| 4GlcNAcb1-4)Mana1-3(Galb1-4(Fuca1-3)GlcNAcb1- | 4GlcNAcb1-4)Mana1-3(Galb1-4(Fuca1-3)GlcNAcb1- |
| 2(Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4GlcNAc |
| NeuAca2-3/6Galb1-4(Fuca1-3)GlcNAcb1-2(Galb1- | Fuca1-2Galb1-4(Fuca1-3)GlcNAcb1-2(Gala1- |
| 4GlcNAcb1-4)Mana1-3(Gala1-3Galb1-4GlcNAcb1- | 3Galb1-4GlcNAcb1-4)Mana1-3(Galb1-4(Fuca1- |
| 2(Galb1-4(Fuca1-3)GlcNAcb1-6)Mana1-6)Manb1- | 3)GlcNAcb1-2(Galb1-4(Fuca1-3)GlcNAcb1- |
| 4GlcNAcb1-4(Fuca1-6)GlcNAc | 6)Mana1-6)Manb1-4GlcNAcb1-4(Fuca1-6)GlcNAc |
| GlcNAcb1-4(NeuAca2-8NeuGca2-3/6Galb1- | GlcNAcb1-4(NeuAca2-8NeuGca2-3/6Galb1- |
| 4(Fuca1-3)GlcNAcb1-2(Fuca1-3GlcNAcb1-4)Mana1- | 4(Fuca1-3)GlcNAcb1-2(Fuca1-3GlcNAcb1-4)Mana1- |
| 3)(Fuca1-3GlcNAcb1-2(Fuca1-3GlcNAcb1-6)Mana1- | 3)(GlcNAcb1-2(Fuca1-3GlcNAcb1-6)Mana1- |
| 6)Manb1-4GlcNAcb1-4GlcNAc | 6)Manb1-4GlcNAcb1-4(Fuca1-6)GlcNAc |
| GlcNAcb1-4(NeuAca2-3/6Galb1-4GlcNAcb1-3Galb1- | GlcNAcb1-4(NeuGca2-3/6Galb1-4GlcNAcb1-3Galb1- |
| 4GlcNAcb1-2(GlcNAcb1-4)Mana1-3)(GalNAcb1- | 4GlcNAcb1-2(GlcNAcb1-4)Mana1-3)(GalNAcb1- |
| 4GlcNAcb1-2(Gala1-3Galb1-4GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(Galb1-4(Fuca1-3)GlcNAcb1-3Galb1- | NeuGca2-3/6Galb1-4(Fuca1-3)GlcNAcb1- |
| 4GlcNAcb1-2(GlcNAcb1-4)Mana1-3)(GalNAcb1- | 2(GlcNAcb1-4)Mana1-3(NeuGca2-3/6Galb1- |
| 4GlcNAcb1-2(Gala1-3Galb1-4GlcNAcb1-6)Mana1- | 4GlcNAcb1-2(NeuGca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuGca2-3/6Galb1-4GlcNAcb1-2(GlcNAcb1- | NeuGca2-3/6Galb1-4GlcNAcb1-2(Galb1-4GlcNAcb1- |
| 4)Mana1-3(NeuGca2-3/6Galb1-4GlcNAcb1- | 4)Mana1-3(NeuGca2-3/6Galb1-4GlcNAcb1- |
| 2(NeuGca2-3/6Galb1-4GlcNAcb1-6)Mana1- | 2(NeuAca2-3/6Galb1-4GlcNAcb1-6)Mana1- |
| 6)Manb1-4GlcNAcb1-4(Fuca1-6)GlcNAc | 6)Manb1-4GlcNAcb1-4GlcNAc |
| NeuGca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(Galb1-4GlcNAcb1- | 4GlcNAcb1-4)Mana1-3(Galb1-4GlcNAcb1- |
| 2(NeuGca2-3/6Galb1-4(Fuca1-3)GlcNAcb1- | 2(NeuGca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| Gala1-3Galb1-4GlcNAcb1-2(Gala1-3Galb1- | NeuGca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(NeuAca2-3/6Galb1- |
| 4GlcNAcb1-2(NeuAca2-3/6Galb1-4GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4GlcNAc |
| Gala1-3Galb1-4GlcNAcb1-2(Galb1-4GlcNAcb1- | Gala1-3Galb1-4(Fuca1-3)GlcNAcb1-2(Galb1- |
| 4)Mana1-3(NeuGca2-3/6Galb1-4GlcNAcb1- | 4GlcNAcb1-4)Mana1-3(Galb1-4(Fuca1-3)GlcNAcb1- |
| 2(NeuAca2-3/6Galb1-4GlcNAcb1-6)Mana1- | 2(NeuGca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| NeuAca2-3/6Galb1-4(Fuca1-3)GlcNAcb1-3Galb1- | NeuGca2-3/6Galb1-4(Fuca1-3)GlcNAcb1-2(Galb1- |
| 4GlcNAcb1-2(Galb1-4GlcNAcb1-3Galb1-4GlcNAcb1- | 4GlcNAcb1-4)Mana1-3(Gala1-3Galb1-4GlcNAcb1- |
| 4)Mana1-3(Mana1-3(Mana1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| Fuca1-2Galb1-4(Fuca1-3)GlcNAcb1-3Galb1- | GlcNAcb1-4(NeuAca2-3/6Galb1-4GlcNAcb1- |
| 4GlcNAcb1-2(Galb1-4(Fuca1-3)GlcNAcb1-3Galb1- | 2(GlcNAcb1-4)Mana1-3)(NeuAca2-3/6Galb1- |
| 4GlcNAcb1-4)Mana1-3(Mana1-3(Mana1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GlcNAcb1-4)Mana1-3)(Galb1- | 3)GlcNAcb1-2(GlcNAcb1-4)Mana1-3)(Galb1- |
| 4GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2(Fuca1-3GlcNAcb1-4)Mana1- | 4(Fuca1-3)GlcNAcb1-2(Fuca1-3GlcNAcb1-4)Mana1- |
| 3)(GlcNAcb1-2(Fuca1-3GlcNAcb1-6)Mana1- | 3)(Fuca1-3GlcNAcb1-2(Fuca1-3GlcNAcb1-6)Mana1- |
| 6)Manb1-4GlcNAcb1-4(Fuca1-6)GlcNAc | 6)Manb1-4GlcNAcb1-4GlcNAc |
| GlcNAcb1-4(NeuGca2-3/6Galb1-4GlcNAcb1-3Galb1- | NeuAca2-3/6Galb1-4(Fuca1-3)GlcNAcb1- |
| 4GlcNAcb1-2(GlcNAcb1-4)Mana1-3)(GalNAcb1- | 2(GalNAcb1-4(Fuca1-3)GlcNAcb1-4)Mana1- |
| 4GlcNAcb1-2(Gala1-3Galb1-4GlcNAcb1-6)Mana1- | 3(Galb1-4(Fuca1-3)GlcNAcb1-2(Galb1-4(Fuca1- |
| 6)Manb1-4GlcNAcb1-4GlcNAc | 3)GlcNAcb1-6)Mana1-6)Manb1-4GlcNAcb1-4GlcNAc |
| NeuAca2-3/6Galb1-4(Fuca1-3)GlcNAcb1- | GlcNAcb1-4(Galb1-4GlcNAcb1-3Galb1-4GlcNAcb1- |
| 2(GalNAcb1-4GlcNAcb1-4)Mana1-3(Galb1-4(Fuca1- | 2(GlcNAcb1-4)Mana1-3)(Galb1-4GlcNAcb1-3Galb1- |
| 3)GlcNAcb1-2(Galb1-4(Fuca1-3)GlcNAcb1- | 4GlcNAcb1-2(Galb1-4GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| NeuGca2-3/6Galb1-4GlcNAcb1-2(Galb1-4GlcNAcb1- | Gala1-3Galb1-4GlcNAcb1-2(Gala1-3Galb1- |
| 4)Mana1-3(NeuGca2-3/6Galb1-4GlcNAcb1- | 4GlcNAcb1-4)Mana1-3(NeuGca2-3/6Galb1- |
| 2(NeuGca2-3/6Galb1-4GlcNAcb1-6)Mana1- | 4GlcNAcb1-2(NeuAca2-3/6Galb1-4GlcNAcb1- |
| 6)Manb1-4GlcNAcb1-4GlcNAc | 6)Mana1-6)Manb1-4GlcNAcb1-4GlcNAc |
| Gala1-3Galb1-4GlcNAcb1-2(Galb1-4GlcNAcb1- | NeuGca2-3/6Galb1-4(Fuca1-3)GlcNAcb1-2(Galb1- |
| 4)Mana1-3(NeuGca2-3/6Galb1-4GlcNAcb1- | 4GlcNAcb1-4)Mana1-3(NeuGca2-3/6Galb1- |
| 2(NeuGca2-3/6Galb1-4GlcNAcb1-6)Mana1- | 4GlcNAcb1-2(Gala1-3Galb1-4GlcNAcb1-6)Mana1- |
| 6)Manb1-4GlcNAcb1-4(Fuca1-6)GlcNAc | 6)Manb1-4GlcNAcb1-4GlcNAc |
| NeuAca2-3Galb1-4GlcNAcb1-2(Galb1-3Galb1- | NeuAca2-6Galb1-4GlcNAcb1-2(Gala1-3Galb1- |
| 4GlcNAcb1-6)Mana1-3(Galb1-3Galb1-4GlcNAcb1- | 4GlcNAcb1-4)Mana1-3(Gala1-3Galb1-4GlcNAcb1- |
| 2(Galb1-3Galb1-4GlcNAcb1-4)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAcb |
| NeuGca2-3/6Galb1-4(Fuca1-3)GlcNAcb1-3Galb1- | Gala1-3Galb1-4GlcNAcb1-2(NeuAca2-3/6Galb1- |
| 4GlcNAcb1-2(Galb1-4GlcNAcb1-3Galb1-4GlcNAcb1- | 4GlcNAcb1-4)Mana1-3(Gala1-3Galb1-4GlcNAcb1- |
| 4)Mana1-3(Mana1-3(Mana1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Fuca1-2Galb1-4(Fuca1-3)GlcNAcb1-2(Gala1- | Gala1-3Galb1-4GlcNAcb1-3Galb1-4GlcNAcb1- |
| 3Galb1-4GlcNAcb1-4)Mana1-3(Gala1-3Galb1- | 2(Fuca1-2Galb1-4(Fuca1-3)GlcNAcb1-3Galb1- |
| 4GlcNAcb1-2(Gala1-3Galb1-4GlcNAcb1-6)Mana1- | 4GlcNAcb1-4)Mana1-3(Mana1-3(Mana1-6)Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(GlcNAcb1-4)Mana1-3)(NeuAca2-3/6Galb1- | 3)GlcNAcb1-2(GlcNAcb1-4)Mana1-3)(Galb1- |
| 4GlcNAcb1-2(NeuAca2-3/6Galb1-4GlcNAcb1- | 4GlcNAcb1-2(NeuAca2-3/6Galb1-4GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GlcNAcb1-4)Mana1-3)(Galb1- |
| 3)(Galb1-4GlcNAcb1-2(NeuAca2-3/6Galb1- | 4GlcNAcb1-2(NeuAca2-3/6Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1-4GlcNAc |
| GlcNAcb1-4(NeuAca2-3/6Galb1-4GlcNAcb1- | GlcNAcb1-4(NeuAca2-6Galb1-4GlcNAcb1-2(Galb1- |
| 2(Galb1-4GlcNAcb1-4)Mana1-3)(Galb1-4GlcNAcb1- | 4GlcNAcb1-4)Mana1-3)(NeuAca2-6Galb1- |
| 2(NeuAca2-3/6Galb1-4GlcNAcb1-6)Mana1- | 4GlcNAcb1-2(Galb1-4GlcNAcb1-4)Mana1-6)Manb1- |
| 6)Manb1-4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1- | GlcNAcb1-4(NeuAca2-3/6Galb1-4(Fuca1- |
| 2(NeuAca2-3/6Galb1-4GlcNAcb1-4)Mana1- | 3)GlcNAcb1-2(Galb1-4GlcNAcb1-4)Mana1- |
| 3)(Galb1-4(Fuca1-3)GlcNAcb1-2(Galb1-4(Fuca1- | 3)(Galb1-4GlcNAcb1-2(Galb1-4(Fuca1-3)GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1- |
| 2(GalNAcb1-4(Fuca1-3)GlcNAcb1-4)Mana1- | 2(GalNAcb1-4GlcNAcb1-4)Mana1-3(Galb1-4(Fuca1- |
| 3(Galb1-4(Fuca1-3)GlcNAcb1-2(Galb1-4(Fuca1- | 3)GlcNAcb1-2(Galb1-4(Fuca1-3)GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(Galb1-4(Fuca1-3)GlcNAcb1-2(Fuca1- | GlcNAcb1-4(Galb1-4(Fuca1-3)GlcNAcb1-2(Galb1- |
| 2Galb1-4(Fuca1-3)GlcNAcb1-4)Mana1-3)(Galb1- | 4(Fuca1-3)GlcNAcb1-4)Mana1-3)(Galb1-4(Fuca1- |
| 4(Fuca1-3)GlcNAcb1-2(Galb1-4(Fuca1-3)GlcNAcb1- | 3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Gala1-4(Fuca1-3)GlcNAcb1-2(Galb1- | Gala1-3Galb1-4GlcNAcb1-2(Gala1-3Galb1- |
| 4(Fuca1-3)GlcNAcb1-4)Mana1-3)(Galb1-4(Fuca1- | 4GlcNAcb1-4)Mana1-3(NeuGca2-3/6Galb1- |
| 3)GlcNAcb1-2(Galb1-4(Fuca1-3)GlcNAcb1- | 4GlcNAcb1-2(NeuGca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2(NeuGca2-3/6Galb1- | NeuAca2-3Galb1-4GlcNAcb1-2Mana1-3(NeuAca2- |
| 4GlcNAcb1-4)Mana1-3(Gala1-3Galb1-4GlcNAcb1- | 3Galb1-4GlcNAcb1-2(NeuAca2-3Galb1-4(NeuAca2- |
| 2(Gala1-3Galb1-4GlcNAcb1-6)Mana1-6)Manb1- | 3)GlcNAcb1-4)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4GlcNAcb1- | GlcNAcb1-4(NeuAca2-3/6Galb1-4(Fuca1- |
| 2(GlcNAcb1-4)Mana1-3)(NeuGca2-3/6Galb1- | 3)GlcNAcb1-2(NeuAca2-8NeuAca2-3/6Galb1- |
| 4GlcNAcb1-2(NeuAca2-3/6Galb1-4GlcNAcb1- | 4(Fuca1-3)GlcNAcb1-4)Mana1-3)(Mana1-3Mana1- |
| 6)Mana1-6)Manb1-4GlcNAcb1-4GlcNAc | 6)Manb1-4GlcNAcb1-4(Fuca1-6)GlcNAc |
| GlcNAcb1-4(NeuGca2-3/6Galb1-4(Fuca1- | NeuAca2-3/6Galb1-4GlcNAcb1-2(Galb1-4GlcNAcb1- |
| 3)GlcNAcb1-2(GlcNAcb1-4)Mana1-3)(Galb1- | 4)Mana1-3(NeuAca2-3/6Galb1-4GlcNAcb1-3Galb1- |
| 4GlcNAcb1-2(NeuGca2-3/6Galb1-4GlcNAcb1- | 4GlcNAcb1-2(Galb1-4GlcNAcb1-6)Mana1-6)Manb1- |
| 6)Mana1-6)Manb1-4GlcNAcb1-4(Fuca1-6)GlcNAc | 4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2(Galb1-4GlcNAcb1-4)Mana1-3)(Galb1-4GlcNAcb1- | 3)GlcNAcb1-2(GlcNAcb1-4)Mana1-3)(Galb1- |
| 2(NeuAca2-3/6Galb1-4GlcNAcb1-6)Mana1- | 4GlcNAcb1-2(NeuGca2-3/6Galb1-4(Fuca1- |
| 6)Manb1-4GlcNAcb1-4(Fuca1-6)GlcNAc | 3)GlcNAcb1-6)Mana1-6)Manb1-4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(Galb1-4GlcNAcb1-4)Mana1- | 4GlcNAcb1-4)Mana1-3)(NeuAca2-3/6Galb1- |
| 3)(Galb1-4GlcNAcb1-2(NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| NeuAca2-3/6Galb1-4(Fuca1-3)GlcNAcb1-2(Galb1- | GlcNAcb1-4(NeuAca2-3/6Galb1-4(Fuca1- |
| 4GlcNAcb1-4)Mana1-3(Galb1-4GlcNAcb1-3Galb1- | 3)GlcNAcb1-2(Galb1-4GlcNAcb1-4)Mana1- |
| 4GlcNAcb1-2(Galb1-4GlcNAcb1-6)Mana1-6)Manb1- | 3)(Galb1-4GlcNAcb1-2(Gala1-3Galb1-4GlcNAcb1- |
| 4GlcNAcb1-4(Fuca1-6)GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(Gala1-3Galb1-4GlcNAcb1-2(Galb1- |
| 3)GlcNAcb1-2(Galb1-4GlcNAcb1-4)Mana1- | 4(Fuca1-3)GlcNAcb1-4)Mana1-3)(NeuAca2- |
| 3)(Gala1-3Galb1-4GlcNAcb1-2(Galb1-4(Fuca1- | 3/6Galb1-4GlcNAcb1-2(Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1-2(Galb1- | GlcNAcb1-4(Galb1-4(Fuca1-3)GlcNAcb1- |
| 4(Fuca1-3)GlcNAcb1-4)Mana1-3(Galb1-4GlcNAcb1- | 2(NeuGca2-3/6Galb1-4GlcNAcb1-4)Mana1- |
| 3Galb1-4GlcNAcb1-2(Galb1-4GlcNAcb1-6)Mana1- | 3)(Galb1-4(Fuca1-3)GlcNAcb1-2(Galb1-4(Fuca1- |
| 6)Manb1-4GlcNAcb1-4GlcNAc | 3)GlcNAcb1-6)Mana1-6)Manb1-4GlcNAcb1-4GlcNAc |
| GlcNAcb1-4(Galb1-4GlcNAcb1-2(Galb1-4(Fuca1- | GlcNAcb1-4(NeuGca2-3/6Galb1-4(Fuca1- |
| 3)GlcNAcb1-4)Mana1-3)(NeuAca2-3/6Galb1- | 3)GlcNAcb1-2(Galb1-4GlcNAcb1-4)Mana1- |
| 4GlcNAcb1-2(Gala1-3Galb1-4GlcNAcb1-6)Mana1- | 3)(Galb1-4GlcNAcb1-2(Galb1-4(Fuca1-3)GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Fuca1-2Galb1-4(Fuca1-3)GlcNAcb1- | Galb1-4(Fuca1-3)GlcNAcb1-2(Galb1-4(Fuca1- |
| 2(Gala1-3Galb1-4GlcNAcb1-4)Mana1-3)(Galb1- | 3)GlcNAcb1-4)Mana1-3(Galb1-4(Fuca1- |
| 4(Fuca1-3)GlcNAcb1-2(Galb1-4(Fuca1-3)GlcNAcb1- | 3)GlcNAcb1-3Galb1-4GlcNAcb1-2(Galb1- |
| 6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(Galb1-4(Fuca1-3)GlcNAcb1-2(Galb1- | GalNAcb1-4Galb1-4GlcNAcb1-2(GalNAcb1-4Galb1- |
| 4(Fuca1-3)GlcNAcb1-4)Mana1-3)(Galb1-4(Fuca1- | 4GlcNAcb1-4)Mana1-3(GalNAcb1-4Galb1- |
| 3)GlcNAcb1-2(Gala1-3Galb1-4GlcNAcb1-6)Mana1- | 4GlcNAcb1-2(GalNAcb1-4Galb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAcb |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAc | 6)Mana1-6)Manb1-4GlcNAc |
| NeuAca2-6Galb1-4GlcNAcb1-2(NeuAca2-3Galb1- | GlcNAcb1-4(NeuGca2-3/6Galb1-4GlcNAcb1- |
| 4GlcNAcb1-4)Mana1-3(NeuAca2-6Galb1- | 2(GlcNAcb1-4)Mana1-3)(NeuGca2-3/6Galb1- |
| 4GlcNAcb1-2(NeuAca2-3Galb1-4GlcNAcb1- | 4GlcNAcb1-2(NeuGca2-3/6Galb1-4GlcNAcb1- |
| 6)Mana1-6)Manb1-4GlcNAc | 6)Mana1-6)Manb1-4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(NeuAca2-8NeuAca2-3/6Galb1- | 3)GlcNAcb1-2(NeuAca2-8NeuGca2-3/6Galb1- |
| 4GlcNAcb1-4)Mana1-3)(Mana1-3(Mana1-6)Mana1- | 4(Fuca1-3)GlcNAcb1-4)Mana1-3)(Mana1-3Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4GlcNAcb1- | NeuGca2-3/6Galb1-4GlcNAcb1-2(Galb1-4GlcNAcb1- |
| 2(Galb1-4GlcNAcb1-4)Mana1-3)(Galb1-4GlcNAcb1- | 4)Mana1-3(NeuAca2-3/6Galb1-4GlcNAcb1-3Galb1- |
| 2(NeuGca2-3/6Galb1-4GlcNAcb1-6)Mana1- | 4GlcNAcb1-2(Galb1-4GlcNAcb1-6)Mana1-6)Manb1- |
| 6)Manb1-4GlcNAcb1-4(Fuca1-6)GlcNAc | 4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(Galb1-4GlcNAcb1-4)Mana1- | 4GlcNAcb1-4)Mana1-3)(NeuGca2-3/6Galb1- |
| 3)(Galb1-4GlcNAcb1-2(NeuGca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| GlcNAcb1-4(NeuAca2-3/6Galb1-4(Fuca1- | NeuGca2-3/6Galb1-4(Fuca1-3)GlcNAcb1-2(Galb1- |
| 3)GlcNAcb1-3Galb1-4GlcNAcb1-2(Galb1- | 4(Fuca1-3)GlcNAcb1-4)Mana1-3(Galb1-4GlcNAcb1- |
| 4GlcNAcb1-3Galb1-4GlcNAcb1-4)Mana1-3)(Mana1- | 3Galb1-4GlcNAcb1-2(Galb1-4GlcNAcb1-6)Mana1- |
| 3(Mana1-6)Mana1-6)Manb1-4GlcNAcb1-4GlcNAc | 6)Manb1-4GlcNAcb1-4GlcNAc |
| GlcNAcb1-4(NeuGca2-3/6Galb1-4(Fuca1- | Galb1-4GlcNAcb1-2(Gala1-3Galb1-4GlcNAcb1- |
| 3)GlcNAcb1-2(Galb1-4GlcNAcb1-4)Mana1- | 4)Mana1-3(NeuAca2-3/6Galb1-4GlcNAcb1-3Galb1- |
| 3)(Gala1-3Galb1-4GlcNAcb1-2(Galb1-4(Fuca1- | 4GlcNAcb1-2(Galb1-4GlcNAcb1-6)Mana1-6)Manb1- |
| 3)GlcNAcb1-6)Mana1-6)Manb1-4GlcNAcb1-4GlcNAc | 4GlcNAcb1-4(Fuca1-6)GlcNAc |
| Galb1-4(Fuca1-3)GlcNAcb1-2(Gala1-3Galb1- | NeuGca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(Galb1-4GlcNAcb1-3Galb1- |
| 4GlcNAcb1-3Galb1-4GlcNAcb1-2(Galb1-4GlcNAcb1- | 4GlcNAcb1-2(Galb1-4GlcNAcb1-6)Mana1-6)Manb1- |
| 6)Mana1-6)Manb1-4GlcNAcb1-4GlcNAc | 4GlcNAcb1-4(Fuca1-6)GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(Galb1-4GlcNAcb1-4)Mana1- | 4GlcNAcb1-4)Mana1-3)(Gala1-3Galb1-4GlcNAcb1- |
| 3)(Galb1-4GlcNAcb1-2(Gala1-3Galb1-4GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| Galb1-4(Fuca1-3)GlcNAcb1-2(Gala1-3Galb1- | GlcNAcb1-4(Fuca1-2Galb1-4(Fuca1-3)GlcNAcb1- |
| 4GlcNAcb1-4)Mana1-3(Galb1-4GlcNAcb1-3Galb1- | 3Galb1-4GlcNAcb1-2(Galb1-4(Fuca1-3)GlcNAcb1- |
| 4GlcNAcb1-2(Galb1-4(Fuca1-3)GlcNAcb1-6)Mana1- | 3Galb1-4GlcNAcb1-4)Mana1-3)(Mana1-3(Mana1- |
| 6)Manb1-4GlcNAcb1-4(Fuca1-6)GlcNAc | 6)Mana1-6)Manb1-4GlcNAcb1-4GlcNAc |
| GlcNAcb1-4(Galb1-4(Fuca1-3)GlcNAcb1-3Galb1- | GlcNAcb1-3(NeuAca2-6)Galb1-4GlcNAcb1- |
| 4GlcNAcb1-2(Galb1-4(Fuca1-3)GlcNAcb1-3Galb1- | 3(NeuAca2-6)Galb1-4GlcNAcb1-3(NeuAca2- |
| 4GlcNAcb1-4)Mana1-3)(Mana1-3(Mana1-6)Mana1- | 6)Galb1-4GlcNAcb1-3(NeuAca2-6)Galb1- |
| 6)Manb1-4GlcNAcb1-4(Fuca1-6)GlcNAc | 4GlcNAcb1-3(NeuAca2-6)GalNAc |
| NeuAca2-8NeuAca2-3/6Galb1-4GlcNAcb1-3Galb1- | GlcNAcb1-4(NeuAca2-3/6Galb1-4(Fuca1- |
| 4GlcNAcb1-2(GlcNAcb1-4)Mana1-3(GalNAcb1- | 3)GlcNAcb1-2(GalNAcb1-4GlcNAcb1-4)Mana1- |
| 4GlcNAcb1-2(Galb1-4GlcNAcb1-6)Mana1-6)Manb1- | 3)(Galb1-4(Fuca1-3)GlcNAcb1-2(Galb1-4(Fuca1- |
| 4GlcNAcb1-4(Fuca1-6)GlcNAc | 3)GlcNAcb1-6)Mana1-6)Manb1-4GlcNAcb1-4GlcNAc |
| GlcNAcb1-4(Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(NeuAca2-8NeuGca2-3/6Galb1- |
| 3)(Galb1-4(Fuca1-3)GlcNAcb1-2(Galb1-4(Fuca1- | 4GlcNAcb1-4)Mana1-3)(Mana1-3(Mana1-6)Mana1- |
| 3)GlcNAcb1-6)Mana1-6)Manb1-4GlcNAcb1- | 6)Manb1-4GlcNAcb1-4(Fuca1-6)GlcNAc |
| 4(Fuca1-6)GlcNAc | |
| GlcNAcb1-4(NeuAca2-3/6Galb1-4(Fuca1- | NeuGca2-3/6Galb1-4GlcNAcb1-2(Galb1-4GlcNAcb1- |
| 3)GlcNAcb1-2(NeuGca2-8NeuGca2-3/6Galb1- | 4)Mana1-3(NeuGca2-3/6Galb1-4GlcNAcb1-3Galb1- |
| 4(Fuca1-3)GlcNAcb1-4)Mana1-3)(Mana1-3Mana1- | 4GlcNAcb1-2(Galb1-4GlcNAcb1-6)Mana1-6)Manb1- |
| 6)Manb1-4GlcNAcb1-4(Fuca1-6)GlcNAc | 4GlcNAcb1-4GlcNAc |
| GlcNAcb1-4(Gala1-3Galb1-4GlcNAcb1-2(Galb1- | Galb1-4GlcNAcb1-2(Galb1-4GlcNAcb1-4)Mana1- |
| 4GlcNAcb1-4)Mana1-3)(NeuGca2-3/6Galb1- | 3(Gala1-4Galb1-4GlcNAcb1-2(Gala1-4Galb1- |
| 4GlcNAcb1-2(NeuGca2-3/6Galb1-4GlcNAcb1- | 4GlcNAcb1-4)(NeuAca2-6Galb1-4GlcNAcb1- |
| 6)Mana1-6)Manb1-4GlcNAcb1-4GlcNAc | 6)Mana1-6)Manb1-4GlcNAcb1-4GlcNAcb |
| Galb1-4GlcNAcb1-2(Gala1-4Galb1-4GlcNAcb1- | GlcNAcb1-4(Gala1-3Galb1-4GlcNAcb1-2(Galb1- |
| 4)Mana1-3(Galb1-4GlcNAcb1-2(Gala1-4Galb1- | 4GlcNAcb1-4)Mana1-3)(Gala1-3Galb1-4GlcNAcb1- |
| 4GlcNAcb1-4)(NeuAca2-6Galb1-4GlcNAcb1- | 2(NeuGca2-3/6Galb1-4GlcNAcb1-6)Mana1- |
| 6)Mana1-6)Manb1-4GlcNAcb1-4GlcNAcb | 6)Manb1-4GlcNAcb1-4(Fuca1-6)GlcNAc |
| Galb1-4GlcNAcb1-3Galb1-4GlcNAcb1-2(Gala1- | GlcNAcb1-4(Gala1-3Galb1-4GlcNAcb1-2(NeuAca2- |
| 3Galb1-4GlcNAcb1-4)Mana1-3(Gala1-3Galb1- | 3/6Galb1-4GlcNAcb1-4)Mana1-3)(Gala1-3Galb1- |
| 4GlcNAcb1-2(NeuAca2-3/6Galb1-4GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4GlcNAc |
| Galb1-4GlcNAcb1-2(Gala1-3Galb1-4GlcNAcb1- | Galb1-4GlcNAcb1-2(Gala1-4Galb1-4GlcNAcb1- |
| 4)Mana1-3(NeuGca2-3/6Galb1-4GlcNAcb1-3Galb1- | 4)Mana1-3(Gala1-4Galb1-4GlcNAcb1-2(Galb1- |
| 4GlcNAcb1-2(Galb1-4GlcNAcb1-6)Mana1-6)Manb1- | 4GlcNAcb1-4)(NeuAca2-6Galb1-4GlcNAcb1- |
| 4GlcNAcb1-4(Fuca1-6)GlcNAc | 6)Mana1-6)Manb1-4GlcNAcb1-4GlcNAcb |
| Gala1-4Galb1-4GlcNAcb1-2(Galb1-4GlcNAcb1- | GlcNAcb1-4(NeuGca2-3/6Galb1-4(Fuca1- |
| 4)Mana1-3(Gala1-4Galb1-4GlcNAcb1-2(Galb1- | 3)GlcNAcb1-3Galb1-4GlcNAcb1-2(Galb1- |
| 4GlcNAcb1-4)(NeuAca2-6Galb1-4GlcNAcb1- | 4GlcNAcb1-3Galb1-4GlcNAcb1-4)Mana1-3)(Mana1- |
| 6)Mana1-6)Manb1-4GlcNAcb1-4GlcNAcb | 3(Mana1-6)Mana1-6)Manb1-4GlcNAcb1-4GlcNAc |
| Gala1-4Galb1-4GlcNAcb1-2(Gala1-4Galb1- | Galb1-4(Fuca1-3)GlcNAcb1-2(Gala1-3Galb1- |
| 4GlcNAcb1-4)Mana1-3(Galb1-4GlcNAcb1-2(Galb1- | 4GlcNAcb1-4)Mana1-3(NeuGca2-3/6Galb1- |
| 4GlcNAcb1-4)(NeuAca2-6Galb1-4GlcNAcb1- | 4GlcNAcb1-3Galb1-4GlcNAcb1-2(Galb1-4GlcNAcb1- |
| 6)Mana1-6)Manb1-4GlcNAcb1-4GlcNAcb | 6)Mana1-6)Manb1-4GlcNAcb1-4GlcNAc |
| Gala1-4Galb1-4GlcNAcb1-2(Galb1-4GlcNAcb1- | Galb1-4(Fuca1-3)GlcNAcb1-3Galb1-4GlcNAcb1- |
| 4)Mana1-3(Galb1-4GlcNAcb1-2(Gala1-4Galb1- | 2(Gala1-3Galb1-4GlcNAcb1-4)Mana1-3(Gala1- |
| 4GlcNAcb1-4)(NeuAca2-6Galb1-4GlcNAcb1- | 3Galb1-4GlcNAcb1-2(Galb1-4GlcNAcb1-6)Mana1- |
| 6)Mana1-6)Manb1-4GlcNAcb1-4GlcNAcb | 6)Manb1-4GlcNAcb1-4(Fuca1-6)GlcNAc |
| Galb1-4(Fuca1-3)GlcNAcb1-3Galb1-4GlcNAcb1- | GlcNAcb1-4(Gala1-3Galb1-4GlcNAcb1-3Galb1- |
| 2(Gala1-3Galb1-4GlcNAcb1-4)Mana1-3(Gala1- | 4GlcNAcb1-2(Fuca1-2Galb1-4(Fuca1-3)GlcNAcb1- |
| 3Galb1-4GlcNAcb1-2(Galb1-4(Fuca1-3)GlcNAcb1- | 3Galb1-4GlcNAcb1-4)Mana1-3)(Mana1-3(Mana1- |
| 6)Mana1-6)Manb1-4GlcNAcb1-4GlcNAc | 6)Mana1-6)Manb1-4GlcNAcb1-4GlcNAc |
| GlcNAcb1-4(Fuca1-2Galb1-4(Fuca1-3)GlcNAcb1- | NeuAca2-8NeuAca2-3/6Galb1-4GlcNAcb1-3Galb1- |
| 2(Gala1-3Galb1-4GlcNAcb1-4)Mana1-3)(Gala1- | 4GlcNAcb1-2(GlcNAcb1-4)Mana1-3(GalNAcb1- |
| 3Galb1-4GlcNAcb1-2(Gala1-3Galb1-4GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4GlcNAc |
| NeuAca2-8NeuGca2-3/6Galb1-4GlcNAcb1-3Galb1- | GlcNAcb1-4(NeuGca2-3/6Galb1-4(Fuca1- |
| 4GlcNAcb1-2(GlcNAcb1-4)Mana1-3(GalNAcb1- | 3)GlcNAcb1-2(GalNAcb1-4GlcNAcb1-4)Mana1- |
| 4GlcNAcb1-2(Galb1-4GlcNAcb1-6)Mana1-6)Manb1- | 3)(Galb1-4(Fuca1-3)GlcNAcb1-2(Galb1-4(Fuca1- |
| 4GlcNAcb1-4(Fuca1-6)GlcNAc | 3)GlcNAcb1-6)Mana1-6)Manb1-4GlcNAcb1-4GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(NeuGca2-8NeuGca2-3/6Galb1- | 3)GlcNAcb1-2(NeuGca2-8NeuGca2-3/6Galb1- |
| 4(Fuca1-3)GlcNAcb1-4)Mana1-3)(Mana1-3Mana1- | 4GlcNAcb1-4)Mana1-3)(Mana1-3(Mana1-6)Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(Gala1-3Galb1-4GlcNAcb1-2(NeuGca2- | Galb1-4GlcNAcb1-3Galb1-4GlcNAcb1-2(Gala1- |
| 3/6Galb1-4GlcNAcb1-4)Mana1-3)(Gala1-3Galb1- | 3Galb1-4GlcNAcb1-4)Mana1-3(Gala1-3Galb1- |
| 4GlcNAcb1-2(Gala1-3Galb1-4GlcNAcb1-6)Mana1- | 4GlcNAcb1-2(NeuGca2-3/6Galb1-4GlcNAcb1- |
| 6)Manb1-4GlcNAcb1-4GlcNAc | 6)Mana1-6)Manb1-4GlcNAcb1-4GlcNAc |
| Galb1-4GlcNAcb1-3Galb1-4GlcNAcb1-2(Gala1- | GlcNAcb1-4(Gala1-3Galb1-4GlcNAcb1-2(Gala1- |
| 3Galb1-4GlcNAcb1-4)Mana1-3(Gala1-3Galb1- | 3Galb1-4GlcNAcb1-4)Mana1-3)(Gala1-3Galb1- |
| 4GlcNAcb1-2(Gala1-3Galb1-4GlcNAcb1-6)Mana1- | 4GlcNAcb1-2(Gala1-3Galb1-4GlcNAcb1-6)Mana1- |
| 6)Manb1-4GlcNAcb1-4(Fuca1-6)GlcNAc | 6)Manb1-4GlcNAcb1-4(Fuca1-6)GlcNAc |
| Galb1-4(Fuca1-3)GlcNAcb1-3Galb1-4GlcNAcb1- | NeuAca2-3/6Galb1-4GlcNAcb1-2(GlcNAcb1- |
| 2(Gala1-3Galb1-4GlcNAcb1-4)Mana1-3(Gala1- | 4)Mana1-3(NeuAca2-3/6Galb1-4GlcNAcb1- |
| 3Galb1-4GlcNAcb1-2(Gala1-3Galb1-4GlcNAcb1- | 2(NeuAca2-8NeuAca2-3/6Galb1-4GlcNAcb1- |
| 6)Mana1-6)Manb1-4GlcNAcb1-4GlcNAc | 6)Mana1-6)Manb1-4GlcNAcb1-4GlcNAc |
| NeuAca2-3/6Galb1-4(Fuca1-3)GlcNAcb1- | NeuAca2-3/6Galb1-4(Fuca1-3)GlcNAcb1- |
| 2(GlcNAcb1-4)Mana1-3(NeuAca2-3/6Galb1- | 2(GlcNAcb1-4)Mana1-3(NeuAca2-3/6Galb1- |
| 4GlcNAcb1-2(NeuAca2-3/6Galb1-4GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| NeuAca2-8NeuGca2-3/6Galb1-4GlcNAcb1-3Galb1- | NeuGca2-8NeuGca2-3/6Galb1-4GlcNAcb1-3Galb1- |
| 4GlcNAcb1-2(GlcNAcb1-4)Mana1-3(GalNAcb1- | 4GlcNAcb1-2(GlcNAcb1-4)Mana1-3(GalNAcb1- |
| 4GlcNAcb1-2(Gala1-3Galb1-4GlcNAcb1-6)Mana1- | 4GlcNAcb1-2(Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuAca2-3/6Galb1-4GlcNAcb1- | GlcNAcb1-4(NeuAca2-3/6Galb1-4(Fuca1- |
| 2(Galb1-4GlcNAcb1-4)Mana1-3)(Galb1-4GlcNAcb1- | 3)GlcNAcb1-2(Galb1-4GlcNAcb1-4)Mana1- |
| 3Galb1-4GlcNAcb1-2(Galb1-4GlcNAcb1-6)Mana1- | 3)(Galb1-4GlcNAcb1-3Galb1-4GlcNAcb1-2(Galb1- |
| 6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(Galb1-4(Fuca1-3)GlcNAcb1-2(Galb1- | GlcNAcb1-4(Galb1-4(Fuca1-3)GlcNAcb1-2(Galb1- |
| 4(Fuca1-3)GlcNAcb1-4)Mana1-3)(Galb1-4(Fuca1- | 4(Fuca1-3)GlcNAcb1-4)Mana1-3)(Galb1- |
| 3)GlcNAcb1-3Galb1-4GlcNAcb1-2(Galb1- | 4GlcNAcb1-3Galb1-4GlcNAcb1-2(Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4(Fuca1- | NeuGca2-3/6Galb1-4GlcNAcb1-2(GlcNAcb1- |
| 3)GlcNAcb1-2(NeuGca2-8NeuGca2-3/6Galb1- | 4)Mana1-3(NeuAca2-3/6Galb1-4GlcNAcb1- |
| 4GlcNAcb1-4)Mana1-3)(Mana1-3(Mana1-6)Mana1- | 2(NeuAca2-8NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuAca2-3/6Galb1-4(Fuca1-3)GlcNAcb1-2(Galb1- | NeuAca2-3Galb1-4GlcNAcb1-2(NeuAca2-3Galb1- |
| 4GlcNAcb1-4)Mana1-3(NeuAca2-3/6Galb1- | 4GlcNAcb1-4)Mana1-3(NeuAca2-3Galb1- |
| 4GlcNAcb1-2(NeuAca2-3/6Galb1-4GlcNAcb1- | 4GlcNAcb1-3Galb1-4GlcNAcb1-2Mana1-6)Manb1- |
| 6)Mana1-6)Manb1-4GlcNAcb1-4GlcNAc | 4GlcNAcb1-4(Fuca1-6)GlcNAc |
| NeuGca2-3/6Galb1-4(Fuca1-3)GlcNAcb1- | NeuAca2-3/6Galb1-4GlcNAcb1-2(Galb1-4GlcNAcb1- |
| 2(GlcNAcb1-4)Mana1-3(NeuAca2-3/6Galb1- | 4)Mana1-3(NeuAca2-3/6Galb1-4GlcNAcb1- |
| 4GlcNAcb1-2(NeuAca2-3/6Galb1-4GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuGca2-3/6Galb1-4(Fuca1-3)GlcNAcb1- | NeuAca2-3Galb1-4GlcNAcb1-2Mana1-3(NeuAca2- |
| 2(GlcNAcb1-4)Mana1-3(NeuAca2-3/6Galb1- | 3Galb1-4GlcNAcb1-3Galb1-4GlcNAcb1-2(NeuAca2- |
| 4GlcNAcb1-2(NeuAca2-3/6Galb1-4(Fuca1- | 3Galb1-4GlcNAcb1-6)Mana1-6)Manb1-4GlcNAcb1- |
| 3)GlcNAcb1-6)Mana1-6)Manb1-4GlcNAcb1-4GlcNAc | 4(Fuca1-6)GlcNAc |
| NeuAca2-3Galb1-4GlcNAcb1-2(NeuAca2-3Galb1- | NeuAca2-3Galb1-4GlcNAcb1-2(Galb1-4GlcNAcb1- |
| 4GlcNAcb1-4)Mana1-3(NeuAca2-3Galb1- | 4)Mana1-3(NeuAca2-3Galb1-4GlcNAcb1- |
| 4GlcNAcb1-2(Galb1-4GlcNAcb1-6)Mana1-6)Manb1- | 2(NeuAca2-3Galb1-4GlcNAcb1-6)Mana1-6)Manb1- |
| 4GlcNAcb1-4(Fuca1-6)GlcNAcb | 4GlcNAcb1-4(Fuca1-6)GlcNAcb |
| NeuAca2-3Galb1-4GlcNAcb1-2(NeuAca2-3Galb1- | Galb1-4GlcNAcb1-2(NeuAca2-3Galb1-4GlcNAcb1- |
| 4GlcNAcb1-4)Mana1-3(Galb1-4GlcNAcb1- | 4)Mana1-3(NeuAca2-3Galb1-4GlcNAcb1- |
| 2(NeuAca2-3Galb1-4GlcNAcb1-6)Mana1-6)Manb1- | 2(NeuAca2-3Galb1-4GlcNAcb1-6)Mana1-6)Manb1- |
| 4GlcNAcb1-4(Fuca1-6)GlcNAcb | 4GlcNAcb1-4(Fuca1-6)GlcNAcb |
| NeuAca2-3Galb1-4GlcNAcb1-2(Galb1-4GlcNAcb1- | NeuAca2-3Galb1-4GlcNAcb1-2Mana1-3(NeuAca2- |
| 4)Mana1-3(NeuAca2-3Galb1-4GlcNAcb1- | 3Galb1-4GlcNAcb1-2(NeuAca2-3Galb1-4GlcNAcb1- |
| 2(NeuAca2-3Galb1-4GlcNAcb1-6)Mana1-6)Manb1- | 3Galb1-4GlcNAcb1-6)Mana1-6)Manb1-4GlcNAcb1- |
| 4GlcNAcb1-4(Fuca1-6)GlcNAc | 4(Fuca1-6)GlcNAc |
| Galb1-4GlcNAcb1-2(NeuAca2-3Galb1-4GlcNAcb1- | NeuAca2-3Galb1-4GlcNAcb1-2(NeuAca2-3Galb1- |
| 4)Mana1-3(NeuAca2-3Galb1-4GlcNAcb1- | 4GlcNAcb1-4)Mana1-3(Galb1-4GlcNAcb1- |
| 2(NeuAca2-3Galb1-4GlcNAcb1-6)Mana1-6)Manb1- | 2(NeuAca2-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| NeuAca2-3Galb1-4GlcNAcb1-2(NeuAca2-3Galb1- | NeuGca2-8NeuGca2-3/6Galb1-4GlcNAcb1-3Galb1- |
| 4GlcNAcb1-4)Mana1-3(NeuAca2-3Galb1- | 4GlcNAcb1-2(GlcNAcb1-4)Mana1-3(GalNAcb1- |
| 4GlcNAcb1-2(Galb1-4GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4GlcNAc |
| Galb1-4(Fuca1-3)GlcNAcb1-2(NeuAca2-3/6Galb1- | NeuAca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(Galb1-4(Fuca1-3)GlcNAcb1- |
| 4GlcNAcb1-2(Galb1-4(Fuca1-3)GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| NeuAca2-3/6Galb1-4(Fuca1-3)GlcNAcb1-2(Galb1- | GlcNAcb1-4(NeuGca2-3/6Galb1-4GlcNAcb1- |
| 4GlcNAcb1-4)Mana1-3(Galb1-4GlcNAcb1- | 2(Galb1-4GlcNAcb1-4)Mana1-3)(Galb1-4GlcNAcb1- |
| 2(NeuAca2-3/6Galb1-4(Fuca1-3)GlcNAcb1- | 3Galb1-4GlcNAcb1-2(Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4(Fuca1- | GlcNAcb1-4(Galb1-4GlcNAcb1-2(Gala1-3Galb1- |
| 3)GlcNAcb1-2(Galb1-4GlcNAcb1-4)Mana1- | 4GlcNAcb1-4)Mana1-3)(NeuAca2-3/6Galb1- |
| 3)(Galb1-4GlcNAcb1-3Galb1-4GlcNAcb1-2(Galb1- | 4GlcNAcb1-3Galb1-4GlcNAcb1-2(Galb1-4GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| NeuAca2-3/6Galb1-4(Fuca1-3)GlcNAcb1-2(Fuca1- | NeuAca2-3/6Galb1-4(Fuca1-3)GlcNAcb1-2(Galb1- |
| 2Galb1-4(Fuca1-3)GlcNAcb1-4)Mana1-3(Galb1- | 4(Fuca1-3)GlcNAcb1-4)Mana1-3(Galb1-4(Fuca1- |
| 4(Fuca1-3)GlcNAcb1-2(Galb1-4(Fuca1-3)GlcNAcb1- | 3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Galb1-4(Fuca1-3)GlcNAcb1-2(Gala1- | GlcNAcb1-4(NeuAca2-8NeuAca2-3/6Galb1- |
| 3Galb1-4GlcNAcb1-4)Mana1-3)(Galb1-4GlcNAcb1- | 4GlcNAcb1-3Galb1-4GlcNAcb1-2(GlcNAcb1- |
| 3Galb1-4GlcNAcb1-2(Galb1-4(Fuca1-3)GlcNAcb1- | 4)Mana1-3)(GalNAcb1-4GlcNAcb1-2(Galb1- |
| 6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuAca2-8NeuAca2-3/6Galb1-4(Fuca1- | NeuGca2-3/6Galb1-4GlcNAcb1-2(GlcNAcb1- |
| 3)GlcNAcb1-2(Fuca1-3GlcNAcb1-4)Mana1- | 4)Mana1-3(NeuGca2-3/6Galb1-4GlcNAcb1- |
| 3)(Fuca1-3GlcNAcb1-2(Fuca1-3GlcNAcb1-6)Mana1- | 2(NeuAca2-8NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2(NeuAca2-3/6Galb1- | NeuGca2-3/6Galb1-4(Fuca1-3)GlcNAcb1- |
| 4GlcNAcb1-4)Mana1-3(NeuAca2-3/6Galb1- | 2(GlcNAcb1-4)Mana1-3(NeuGca2-3/6Galb1- |
| 4GlcNAcb1-2(NeuAca2-3/6Galb1-4GlcNAcb1- | 4GlcNAcb1-2(NeuAca2-3/6Galb1-4(Fuca1- |
| 6)Mana1-6)Manb1-4GlcNAcb1-4GlcNAc | 3)GlcNAcb1-6)Mana1-6)Manb1-4GlcNAcb1-4GlcNAc |
| NeuGca2-3/6Galb1-4GlcNAcb1-2(Galb1-4GlcNAcb1- | NeuGca2-3/6Galb1-4(Fuca1-3)GlcNAcb1-2(Galb1- |
| 4)Mana1-3(NeuAca2-3/6Galb1-4GlcNAcb1- | 4GlcNAcb1-4)Mana1-3(NeuAca2-3/6Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1- | Gala1-3Galb1-4(Fuca1-3)GlcNAcb1-2(Galb1- |
| 2(GlcNAcb1-4)Mana1-3(NeuGca2-3/6Galb1- | 4GlcNAcb1-4)Mana1-3(NeuAca2-3/6Galb1- |
| 4GlcNAcb1-2(NeuAca2-3/6Galb1-4GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| NeuAca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(Galb1-4GlcNAcb1- |
| 4GlcNAcb1-2(Gala1-3Galb1-4GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1-2(Galb1- | GlcNAcb1-4(Galb1-4GlcNAcb1-2(Gala1-3Galb1- |
| 4GlcNAcb1-4)Mana1-3(Galb1-4(Fuca1-3)GlcNAcb1- | 4GlcNAcb1-4)Mana1-3)(NeuGca2-3/6Galb1- |
| 2(NeuAca2-3/6Galb1-4(Fuca1-3)GlcNAcb1- | 4GlcNAcb1-3Galb1-4GlcNAcb1-2(Galb1-4GlcNAcb1- |
| 6)Mana1-6)Manb1-4GlcNAcb1-4GlcNAc | 6)Mana1-6)Manb1-4GlcNAcb1-4GlcNAc |
| NeuGca2-3/6Galb1-4(Fuca1-3)GlcNAcb1-2(Fuca1- | Gala1-3Galb1-4(Fuca1-3)GlcNAcb1-2(Galb1- |
| 2Galb1-4(Fuca1-3)GlcNAcb1-4(Mana1-3(Galb-1 | 4GlcNAcb1-4)Mana1-3(Galb1-4(Fuca1-3)GlcNAcb1- |
| 4(Fuca1-3)GlcNAcb1-2(Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| Fuca1-2Galb1-4(Fuca1-3)GlcNAcb1-2(Gala1- | NeuGca2-3/6Galb1-4(Fuca1-3)GlcNAcb1-2(Galb1- |
| 3Galb1-4GlcNAcb1-4)Mana1-3(NeuAca2-3/6Galb1- | 4(Fuca1-3)GlcNAcb1-4)Mana1-3(Galb1-4(Fuca1- |
| 4(Fuca1-3)GlcNAcb1-2(Galb1-4(Fuca1-3)GlcNAcb1- | 3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Galb1-4(Fuca1-3)GlcNAcb1-3Galb1- | GlcNAcb1-4(NeuAca2-8NeuGca2-3/6Galb1- |
| 4GlcNAcb1-2(Gala1-3Galb1-4GlcNAcb1-4)Mana1- | 4GlcNAcb1-3Galb1-4GlcNAcb1-2(GlcNAcb1- |
| 3)(Gala1-3Galb1-4GlcNAcb1-2(Galb1-4GlcNAcb1- | 4)Mana1-3)(GalNAcb1-4GlcNAcb1-2(Galb1- |
| 6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuAca2-8NeuGca2-3/6Galb1- | NeuGca2-3/6Galb1-4GlcNAcb1-2(GlcNAcb1- |
| 4(Fuca1-3)GlcNAcb1-2(Fuca1-3GlcNAcb1-4)Mana1- | 4)Mana1-3(NeuGca2-3/6Galb1-4GlcNAcb1- |
| 3)(Fuca1-3GlcNAcb1-2(Fuca1-3GlcNAcb1-6)Mana1- | 2(NeuAca2-8NeuGca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuGca2-3/6Galb1-4GlcNAcb1-2(Galb1-4GlcNAcb1- | NeuGca2-3/6Galb1-4(Fuca1-3)GlcNAcb1- |
| 4)Mana1-3(NeuGca2-3/6Galb1-4GlcNAcb1- | 2(GlcNAcb1-4)Mana1-3(NeuGca2-3/6Galb1- |
| 2(NeuAca2-3/6Galb1-4GlcNAcb1-6)Mana1- | 4GlcNAcb1-2(NeuGca2-3/6Galb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| Gala1-3Galb1-4GlcNAcb1-2(NeuGca2-3/6Galb1- | NeuGca2-3/6Galb1-4(Fuca1-3)GlcNAcb1- |
| 4GlcNAcb1-4)Mana1-3(NeuAca2-3/6Galb1- | 2(GlcNAcb1-4)Mana1-3(NeuGca2-3/6Galb1- |
| 4GlcNAcb1-2(NeuAca2-3/6Galb1-4GlcNAcb1- | 4GlcNAcb1-2(NeuGca2-3/6Galb1-4(Fuca1- |
| 6)Mana1-6)Manb1-4GlcNAcb1-4GlcNAc | 3)GlcNAcb1-6)Mana1-6)Manb1-4GlcNAcb1-4GlcNAc |
| NeuGca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(NeuGca2-3/6Galb1- | 4GlcNAcb1-4)Mana1-3(Galb1-4GlcNAcb1- |
| 4GlcNAcb1-2(NeuAca2-3/6Galb1-4GlcNAcb1- | 2(NeuGca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-2(Galb1- | NeuAca2-3/6Galb1-4(Fuca1-3)GlcNAcb1-3Galb1- |
| 4GlcNAcb1-4)Mana1-3(Galb1-4(Fuca1-3)GlcNAcb1- | 4GlcNAcb1-2(NeuAca2-3/6Galb1-4GlcNAcb1- |
| 2(NeuGca2-3/6Galb1-4(Fuca1-3)GlcNAcb1- | 3Galb1-4GlcNAcb1-4)Mana1-3(Mana1-3(Mana1- |
| 6)Mana1-6)Manb1-4GlcNAcb1-4GlcNAc | 6)Mana1-6)Manb1-4GlcNAcb1-4GlcNAc |
| Gala1-3Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(NeuGca2-3/6Galb1- | 4GlcNAcb1-4)Mana1-3(NeuAca2-3/6Galb1- |
| 4GlcNAcb1-2(NeuAca2-3/6Galb1-4(Fuca1- | 4GlcNAcb1-2(Gala1-3Galb1-4GlcNAcb1-6)Mana1- |
| 3)GlcNAcb1-6)Mana1-6)Manb1-4GlcNAcb1-4GlcNAc | 6)Manb1-4GlcNAcb1-4(Fuca1-6)GlcNAc |
| Gala1-3Galb1-4GlcNAcb1-2(Gala1-3Galb1- | NeuAca2-3Galb1-4GlcNAcb1-2(NeuAca2-3Galb1- |
| 4GlcNAcb1-4)Mana1-3(NeuAca2-3/6Galb1- | 4GlcNAcb1-6)Mana1-3(Galb1-3Galb1-4GlcNAcb1- |
| 4GlcNAcb1-2(NeuAca2-3/6Galb1-4GlcNAcb1- | 2(Galb1-3Galb1-4GlcNAcb1-4)Mana1-6)Manb1- |
| 6)Mana1-6)Manb1-4GlcNAcb1-4(Fuca1-6)GlcNAc | 4GlcNAcb1-4(Fuca1-6)GlcNAc |
| NeuAca2-6Galb1-4GlcNAcb1-2(Gala1-3Galb1- | NeuAca2-6Galb1-4GlcNAcb1-2(NeuAca2-3Galb1- |
| 4GlcNAcb1-4)Mana1-3(NeuAca2-6Galb1- | 4GlcNAcb1-4)Mana1-3(Gala1-3Galb1-4GlcNAcb1- |
| 4GlcNAcb1-2(Gala1-3Galb1-4GlcNAcb1-6)Mana1- | 2(Gala1-3Galb1-4GlcNAcb1-6)Mana1-6)Manb1- |
| 6)Manb1-4GlcNAcb1-4(Fuca1-6)GlcNAcb | 4GlcNAcb1-4(Fuca1-6)GlcNAcb |
| NeuAca2-3/6Galb1-4(Fuca1-3)GlcNAcb1-3Galb1- | Fuca1-2Galb1-4(Fuca1-3)GlcNAcb1-2(Gala1- |
| 4GlcNAcb1-2(Fuca1-2Galb1-4(Fuca1-3)GlcNAcb1- | 3Galb1-4GlcNAcb1-4)Mana1-3(NeuGca2-3/6Galb1- |
| 3Galb1-4GlcNAcb1-4)Mana1-3(Mana1-3(Mana1- | 4(Fuca1-3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| Gala1-3Galb1-4(Fuca1-3)GlcNAcb1-2(Galb1- | Galb1-4GlcNAcb1-3Galb1-4GlcNAcb1-2(Gala1- |
| 4GlcNAcb1-4)Mana1-3(Galb1-4(Fuca1-3)GlcNAcb1- | 3Galb1-4GlcNAcb1-4)Mana1-3(Galb1-4GlcNAcb1- |
| 2(NeuGca2-3/6Galb1-4(Fuca1-3)GlcNAcb1- | 3Galb1-4GlcNAcb1-2(Gala1-3Galb1-4GlcNAcb1- |
| 6)Mana1-6)Manb1-4GlcNAcb1-4(Fuca1-6)GlcNAc | 6)Mana1-6)Manb1-4GlcNAcb1-4GlcNAc |
| GlcNAcb1-4(Galb1-4GlcNAcb1-3Galb1-4GlcNAcb1- | GlcNAcb1-4(NeuAca2-3/6Galb1-4(Fuca1- |
| 2(Gala1-3Galb1-4GlcNAcb1-4)Mana1-3)(Gala1- | 3)GlcNAcb1-2(GlcNAcb1-4)Mana1-3)(NeuAca2- |
| 3Galb1-4GlcNAcb1-2(Gala1-3Galb1-4GlcNAcb1- | 3/6Galb1-4GlcNAcb1-2(NeuAca2-3/6Galb1- |
| 6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuAca2-3/6Galb1-4GlcNAcb1- | GlcNAcb1-4(NeuGca2-8NeuGca2-3/6Galb1- |
| 2(GlcNAcb1-4)Mana1-3)(NeuAca2-3/6Galb1- | 4GlcNAcb1-3Galb1-4GlcNAcb1-2(GlcNAcb1- |
| 4GlcNAcb1-2(NeuAca2-3/6Galb1-4GlcNAcb1- | 4)Mana1-3)(GalNAcb1-4GlcNAcb1-2(Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| NeuAca2-3/6Galb1-4(Fuca1-3)GlcNAcb1- | GlcNAcb1-4(NeuAca2-3/6Galb1-4(Fuca1- |
| 2(GalNAcb1-4GlcNAcb1-4)Mana1-3(Galb1-4(Fuca1- | 3)GlcNAcb1-2(GlcNAcb1-4)Mana1-3)(Galb1- |
| 3)GlcNAcb1-2(NeuAca2-3/6Galb1-4(Fuca1- | 4GlcNAcb1-2(NeuAca2-3/6Galb1-4(Fuca1- |
| 3)GlcNAcb1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| GlcNAcb1-4(NeuGca2-8NeuGca2-3/6Galb1- | NeuAca2-3/6Galb1-4(Fuca1-3)GlcNAcb1- |
| 4(Fuca1-3)GlcNAcb1-2(Fuca1-3GlcNAcb1-4)Mana1- | 2(GalNAcb1-4(Fuca1-3)GlcNAcb1-4)Mana1- |
| 3)(Fuca1-3GlcNAcb1-2(Fuca1-3GlcNAcb1-6)Mana1- | 3(Galb1-4(Fuca1-3)GlcNAcb1-2(Galb1-4(Fuca1- |
| 6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| NeuGca2-3/6Galb1-4GlcNAcb1-2(GlcNAcb1- | NeuGca2-3/6Galb1-4GlcNAcb1-2(Galb1-4GlcNAcb1- |
| 4)Mana1-3(NeuGca2-3/6Galb1-4GlcNAcb1- | 4)Mana1-3(NeuGca2-3/6Galb1-4GlcNAcb1- |
| 2(NeuGca2-8NeuGca2-3/6Galb1-4GlcNAcb1- | 2(NeuGca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1-2(Galb1- | Gala1-3Galb1-4GlcNAcb1-2(NeuGca2-3/6Galb1- |
| 4GlcNAcb1-4)Mana1-3(NeuGca2-3/6Galb1- | 4GlcNAcb1-4)Mana1-3(NeuGca2-3/6Galb1- |
| 4GlcNAcb1-2(NeuGca2-3/6Galb1-4GlcNAcb1- | 4GlcNAcb1-2(NeuAca2-3/6Galb1-4GlcNAcb1- |
| 6)Mana1-6)Manb1-4GlcNAcb1-4GlcNAc | 6)Mana1-6)Manb1-4GlcNAcb1-4GlcNAc |
| Gala1-3Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(NeuGca2-3/6Galb1- | 4GlcNAcb1-4)Mana1-3(NeuGca2-3/6Galb1- |
| 4GlcNAcb1-2(NeuGca2-3/6Galb1-4(Fuca1- | 4GlcNAcb1-2(Gala1-3Galb1-4GlcNAcb1-6)Mana1- |
| 3)GlcNAcb1-6)Mana1-6)Manb1-4GlcNAcb1-4GlcNAc | 6)Manb1-4GlcNAcb1-4(Fuca1-6)GlcNAc |
| NeuAca2-3/6Galb1-4(Fuca1-3)GlcNAcb1-3Galb1- | Gala1-3Galb1-4GlcNAcb1-2(Gala1-3Galb1- |
| 4GlcNAcb1-2(NeuGca2-3/6Galb1-4GlcNAcb1- | 4GlcNAcb1-4)Mana1-3(NeuGca2-3/6Galb1- |
| 3Galb1-4GlcNAcb1-4)Mana1-3(Mana1-3(Mana1- | 4GlcNAcb1-2(NeuAca2-3/6Galb1-4GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-3Galb1- | Gala1-3Galb1-4GlcNAcb1-3Galb1-4(Fuca1- |
| 4GlcNAcb1-2(Fuca1-2Galb1-4(Fuca1-3)GlcNAcb1- | 3)GlcNAcb1-2(NeuAca2-3/6Galb1-4(Fuca1- |
| 3Galb1-4GlcNAcb1-4)Mana1-3(Mana1-3(Mana1- | 3)GlcNAcb1-3Galb1-4GlcNAcb1-4)Mana1-3(Mana1- |
| 6)Mana1-6)Manb1-4GlcNAcb1-4GlcNAc | 3(Mana1-6)Mana1-6)Manb1-4GlcNAcb1-4GlcNAc |
| Gala1-3Galb1-4GlcNAcb1-3Galb1-4(Fuca1- | GlcNAcb1-4(NeuAca2-3/6Galb1-4GlcNAcb1- |
| 3)GlcNAcb1-2(Fuca1-2Galb1-4(Fuca1-3)GlcNAcb1- | 2(Galb1-4GlcNAcb1-4)Mana1-3)(NeuAca2- |
| 3Galb1-4(Fuca1-3)GlcNAcb1-4)Mana1-3(Mana1- | 3/6Galb1-4GlcNAcb1-2(NeuAca2-3/6Galb1- |
| 3(Mana1-6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2(GlcNAcb1-4)Mana1-3)(NeuAca2-3/6Galb1- | 3)GlcNAcb1-2(GlcNAcb1-4)Mana1-3)(NeuAca2- |
| 4GlcNAcb1-2(NeuAca2-3/6Galb1-4GlcNAcb1- | 3/6Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4GlcNAcb1-4)Mana1-3(Galb1-4(Fuca1- | 3)GlcNAcb1-2(Galb1-4GlcNAcb1-4)Mana1- |
| 3)GlcNAcb1-2(NeuAca2-3/6Galb1-4(Fuca1- | 3)(Galb1-4GlcNAcb1-2(NeuAca2-3/6Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(GlcNAcb1-4)Mana1-3)(Galb1- | 3)GlcNAcb1-2(Galb1-4GlcNAcb1-4)Mana1- |
| 4GlcNAcb1-2(NeuAca2-3/6Galb1-4(Fuca1- | 3)(Galb1-4GlcNAcb1-2(NeuAca2-3/6Galb1- |
| 3)GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(Galb1-4(Fuca1-3)GlcNAcb1- |
| 3(Galb1-4(Fuca1-3)GlcNAcb1-2(Galb1-4(Fuca1- | 4)Mana1-3)(Galb1-4(Fuca1-3)GlcNAcb1-2(Galb1- |
| 3)GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| GlcNAcb1-4(Galb1-4(Fuca1-3)GlcNAcb1- | GlcNAcb1-3Galb1-4GlcNAcb1-2(Galb1-4GlcNAcb1- |
| 2(NeuAca2-3/6Galb1-4GlcNAcb1-4)Mana1- | 3Galb1-4GlcNAcb1-4)Mana1-3(Galb1-4GlcNAcb1- |
| 3)(Galb1-4(Fuca1-3)GlcNAcb1-2(Galb1-4(Fuca1- | 2(Galb1-4GlcNAcb1-3Galb1-4GlcNAcb1-6)Mana1- |
| 3)GlcNAcb1-6)Mana1-6)Manb1-4GlcNAcb1- | 6)Manb1-4GlcNAcb1-4(Fuca1-6)GlcNAc |
| 4(Fuca1-6)GlcNAc | |
| GlcNAcb1-4(Galb1-4(Fuca1-3)GlcNAcb1-2(Fuca1- | Gala1-3Galb1-4GlcNAcb1-2(NeuGca2-3/6Galb1- |
| 2Galb1-4(Fuca1-3)GlcNAcb1-4)Mana1-3)(Galb1- | 4GlcNAcb1-4)Mana1-3(NeuGca2-3/6Galb1- |
| 4(Fuca1-3)GlcNAcb1-2(Galb1-4(Fuca1-3)GlcNAcb1- | 4GlcNAcb1-2(NeuGca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2(Gala1-3Galb1- | NeuGca2-3/6Galb1-4(Fuca1-3)GlcNAcb1-3Galb1- |
| 4GlcNAcb1-4)Mana1-3(NeuGca2-3/6Galb1- | 4GlcNAcb1-2(NeuGca2-3/6Galb1-4GlcNAcb1- |
| 4GlcNAcb1-2(NeuGca2-3/6Galb1-4GlcNAcb1- | 3Galb1-4GlcNAcb1-4)Mana1-3(Mana1-3(Mana1- |
| 6)Mana1-6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-3Galb1-4(Fuca1- | NeuAca2-3Galb1-4GlcNAcb1-2(NeuAca2-3Galb1- |
| 3)GlcNAcb1-2(NeuGca2-3/6Galb1-4(Fuca1- | 3(NeuAca2-6)GlcNAcb1-4)Mana1-3(NeuAca2- |
| 3)GlcNAcb1-3Galb1-4GlcNAcb1-4)Mana1-3(Mana1- | 3Galb1-3(NeuAca2-6)GlcNAcb1-2Mana1-6)Manb1- |
| 3(Mana1-6)Mana1-6)Manb1-4GlcNAcb1-4GlcNAc | 4GlcNAcb1-4GlcNAc |
| NeuAca2-6Galb1-4GlcNAcb1-2(NeuAca2-3Galb1- | GlcNAcb1-4(NeuGca2-3/6Galb1-4GlcNAcb1- |
| 3(NeuAca2-6)GlcNAcb1-4)Mana1-3(NeuAca2- | 2(Galb1-4GlcNAcb1-4)Mana1-3)(NeuAca2- |
| 3Galb1-3(NeuAca2-6)GlcNAcb1-2Mana1-6)Manb1- | 3/6Galb1-4GlcNAcb1-2(NeuAca2-3/6Galb1- |
| 4GlcNAcb1-4GlcNAc | 4GlcNAcb1-6)Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2(GlcNAcb1-4)Mana1-3)(NeuGca2-3/6Galb1- | 3)GlcNAcb1-2(GlcNAcb1-4)Mana1-3)(NeuGca2- |
| 4GlcNAcb1-2(NeuAca2-3/6Galb1-4GlcNAcb1- | 3/6Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(Galb1-4GlcNAcb1-2(NeuAca2-3/6Galb1- | 3)(NeuAca2-3/6Galb1-4GlcNAcb1-2(Gala1-3Galb1- |
| 4(Fuca1-3)GlcNAcb1-6)Mana1-6)Manb1- | 4GlcNAcb1-6)Mana1-6)Manb1-4GlcNAcb1-4GlcNAc |
| 4GlcNAcb1-4GlcNAc | |
| NeuAca2-3/6Galb1-4GlcNAcb1-2(Galb1-4GlcNAcb1- | NeuGca2-3/6Galb1-4(Fuca1-3)GlcNAcb1- |
| 4)Mana1-3(NeuAca2-3/6Galb1-4GlcNAcb1-3Galb1- | 2(GalNAcb1-4GlcNAcb1-4)Mana1-3(Galb1-4(Fuca1- |
| 4GlcNAcb1-2(Galb1-4GlcNAcb1-6)Mana1-6)Manb1- | 3)GlcNAcb1-2(NeuGca2-3/6Galb1-4(Fuca1- |
| 4GlcNAcb1-4(Fuca1-6)GlcNAc | 3)GlcNAcb1-6)Mana1-6)Manb1-4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(GlcNAcb1-4)Mana1-3)(Galb1- | 4GlcNAcb1-4)Mana1-3)(NeuAca2-3/6Galb1- |
| 4GlcNAcb1-2(NeuGca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| GlcNAcb1-4(NeuGca2-3/6Galb1-4(Fuca1- | GlcNAcb1-4(Galb1-4(Fuca1-3)GlcNAcb1- |
| 3)GlcNAcb1-2(Galb1-4GlcNAcb1-4)Mana1- | 2(NeuGca2-3/6Galb1-4GlcNAcb1-4)Mana1- |
| 3)(Galb1-4GlcNAcb1-2(NeuAca2-3/6Galb1- | 3)(Galb1-4(Fuca1-3)GlcNAcb1-2(Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1- |
| 6)GlcNAc | 4(Fuca1-6)GlcNAc |
| GlcNAcb1-4(NeuAca2-3/6Galb1-4(Fuca1- | NeuAca2-3/6Galb1-4(Fuca1-3)GlcNAcb1-2(Galb1- |
| 3)GlcNAcb1-2(Galb1-4GlcNAcb1-4)Mana1- | 4(Fuca1-3)GlcNAcb1-4)Mana1-3(Galb1-4GlcNAcb1- |
| 3)(Gala1-3Galb1-4GlcNAcb1-2(Galb1-4(Fuca1- | 3Galb1-4GlcNAcb1-2(Galb1-4GlcNAcb1-6)Mana1- |
| 3)GlcNAcb1-6)Mana1-6)Manb1-4GlcNAcb1- | 6)Manb1-4GlcNAcb1-4(Fuca1-6)GlcNAc |
| 4(Fuca1-6)GlcNAc | |
| NeuAca2-3/6Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3(Galb1-4(Fuca1- | 3)GlcNAcb1-2(Galb1-4(Fuca1-3)GlcNAcb1- |
| 3)GlcNAcb1-3Galb1-4GlcNAcb1-2(Galb1- | 4)Mana1-3)(Galb1-4(Fuca1-3)GlcNAcb1-2(Galb1- |
| 4GlcNAcb1-6)Mana1-6)Manb1-4GlcNAcb1-4GlcNAc | 4(Fuca1-3)GlcNAcb1-6)Mana1-6)Manb1- |
| | 4GlcNAcb1-4GlcNAc |
| GlcNAcb1-4(Gala1-3Galb1-4(Fuca1-3)GlcNAcb1- | GlcNAcb1-4(Galb1-4(Fuca1-3)GlcNAcb1-2(Galb1- |
| 2(Galb1-4GlcNAcb1-4)Mana1-3)(Galb1-4(Fuca1- | 4(Fuca1-3)GlcNAcb1-4)Mana1-3)(NeuAca2- |
| 3)GlcNAcb1-2(NeuAca2-3/6Galb1-4(Fuca1- | 3/6Galb1-4GlcNAcb1-2(Gala1-3Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| Galb1-4GlcNAcb1-3Galb1-4GlcNAcb1-2(Galb1- | GlcNAcb1-4(Fuca1-2Galb1-4(Fuca1-3)GlcNAcb1- |
| 4GlcNAcb1-4)Mana1-3(Galb1-4GlcNAcb1-3Galb1- | 2(Gala1-3Galb1-4GlcNAcb1-4)Mana1-3)(Galb1- |
| 4GlcNAcb1-2(Galb1-4GlcNAcb1-3Galb1-4GlcNAcb1- | 4(Fuca1-3)GlcNAcb1-2(Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4GlcNAcb1- |
| 2(GlcNAcb1-4)Mana1-3)(NeuGca2-3/6Galb1- | 2(Galb1-4GlcNAcb1-4)Mana1-3)(NeuGca2- |
| 4GlcNAcb1-2(NeuGca2-3/6Galb1-4GlcNAcb1- | 3/6Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GlcNAcb1-4)Mana1-3)(NeuGca2- | 3)GlcNAcb1-2(Galb1-4GlcNAcb1-4)Mana1- |
| 3/6Galb1-4GlcNAcb1-2(NeuGca2-3/6Galb1- | 3)(NeuAca2-3/6Galb1-4GlcNAcb1-2(Gala1-3Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Gala1- |
| 3)GlcNAcb1-2(Galb1-4GlcNAcb1-4)Mana1- | 3Galb1-4GlcNAcb1-4)Mana1-3)(NeuAca2-3/6Galb1- |
| 3)(Galb1-4GlcNAcb1-2(NeuGca2-3/6Galb1- | 4GlcNAcb1-2(NeuAca2-3/6Galb1-4GlcNAcb1- |
| 4(Fuca1-3)GlcNAcb1-6)Mana1-6)Manb1- | 6)Mana1-6)Manb1-4GlcNAcb1-4GlcNAc |
| 4GlcNAcb1-4GlcNAc | |
| GlcNAcb1-4(Gala1-3Galb1-4GlcNAcb1-2(Galb1- | GlcNAcb1-4(NeuGca2-3/6Galb1-4(Fuca1- |
| 4GlcNAcb1-4)Mana1-3)(NeuGca2-3/6Galb1- | 3)GlcNAcb1-2(Galb1-4GlcNAcb1-4)Mana1- |
| 4GlcNAcb1-2(NeuAca2-3/6Galb1-4GlcNAcb1- | 3)(Galb1-4GlcNAcb1-2(NeuGca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4(Fuca1- |
| | 6)GlcNAc |
| NeuGca2-3/6Galb1-4GlcNAcb1-2(Galb1-4GlcNAcb1- | Gala1-3Galb1-4GlcNAcb1-2(Galb1-4GlcNAcb1- |
| 4)Mana1-3(NeuAca2-3/6Galb1-4GlcNAcb1-3Galb1- | 4)Mana1-3(NeuAca2-3/6Galb1-4GlcNAcb1-3Galb1- |
| 4GlcNAcb1-2(Galb1-4GlcNAcb1-6)Mana1-6)Manb1- | 4GlcNAcb1-2(Neu Aca2-3/6Galb1-4GlcNAcb1- |
| 4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3(Galb1-4GlcNAcb1- | 3)GlcNAcb1-2(Galb1-4GlcNAcb1-4)Mana1- |
| 3Galb1-4GlcNAcb1-2(Galb1-4GlcNAcb1-6)Mana1- | 3)(Gala1-3Galb1-4GlcNAcb1-2(Galb1-4(Fuca1- |
| 6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| NeuGca2-3/6Galb1-4(Fuca1-3)GlcNAcb1-2(Galb1- | Galb1-4(Fuca1-3)GlcNAcb1-2(Gala1-3Galb1- |
| 4(Fuca1-3)GlcNAcb1-4)Mana1-3(Galb1-4(Fuca1- | 4GlcNAcb1-4)Mana1-3(NeuAca2-3/6Galb1- |
| 3)GlcNAcb1-3Galb1-4GlcNAcb1-2(Galb1- | 4GlcNAcb1-3Galb1-4GlcNAcb1-2(Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1-4GlcNAc |
| Galb1-4(Fuca1-3)GlcNAcb1-2(Gala1-3Galb1- | GlcNAcb1-4(NeuAca2-3/6Galb1-4(Fuca1- |
| 4GlcNAcb1-4)Mana1-3(NeuAca2-3/6Galb1- | 3)GlcNAcb1-3Galb1-4GlcNAcb1-2(Galb1- |
| 4GlcNAcb1-3Galb1-4GlcNAcb1-2(Galb1-4GlcNAcb1- | 4GlcNAcb1-3Galb1-4GlcNAcb1-4)Mana1-3)(Mana1- |
| 6)Mana1-6)Manb1-4GlcNAcb1-4(Fuca1-6)GlcNAc | 3(Mana1-6)Mana1-6)Manb1-4GlcNAcb1-4(Fuca1- |
| | 6)GlcNAc |
| GlcNAcb1-4(Gala1-3Galb1-4(Fuca1-3)GlcNAcb1- | GlcNAcb1-4(Fuca1-2Galb1-4(Fuca1-3)GlcNAcb1- |
| 2(Galb1-4GlcNAcb1-4)Mana1-3)(Galb1-4(Fuca1- | 3Galb1-4GlcNAcb1-2(Galb1-4(Fuca1-3)GlcNAcb1- |
| 3)GlcNAcb1-2(NeuGca2-3/6Galb1-4(Fuca1- | 3Galb1-4GlcNAcb1-4)Mana1-3)(Mana1-3(Mana1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GalNAcb1-4(Fuca1-3)GlcNAcb1- | 3)GlcNAcb1-2(GalNAcb1-4GlcNAcb1-4)Mana1- |
| 4)Mana1-3)(Galb1-4(Fuca1-3)GlcNAcb1-2(Galb1- | 3)(Galb1-4(Fuca1-3)GlcNAcb1-2(Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| GlcNAcb1-4(NeuGca2-3/6Galb1-4GlcNAcb1- | GlcNAcb1-4(Gala1-3Galb1-4GlcNAcb1-2(Gala1- |
| 2(Galb1-4GlcNAcb1-4)Mana1-3)(NeuGca2- | 3Galb1-4GlcNAcb1-4)Mana1-3)(NeuGca2-3/6Galb1- |
| 3/6Galb1-4GlcNAcb1-2(NeuGca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| Gala1-3Galb1-4GlcNAcb1-2(Galb1-4GlcNAcb1- | GlcNAcb1-4(NeuGca2-3/6Galb1-4(Fuca1- |
| 4)Mana1-3(NeuGca2-3/6Galb1-4GlcNAcb1-3Galb1- | 3)GlcNAcb1-2(Galb1-4GlcNAcb1-4)Mana1- |
| 4GlcNAcb1-2(NeuAca2-3/6Galb1-4GlcNAcb1- | 3)(NeuGca2-3/6Galb1-4GlcNAcb1-2(Gala1-3Galb1- |
| 6)Mana1-6)Manb1-4GlcNAcb1-4GlcNAc | 4GlcNAcb1-6)Mana1-6)Manb1-4GlcNAcb1-4GlcNAc |
| NeuGca2-3/6Galb1-4GlcNAcb1-2(Galb1-4GlcNAcb1- | GlcNAcb1-4(Gala1-3Galb1-4GlcNAcb1-2(Galb1- |
| 4)Mana1-3(NeuGca2-3/6Galb1-4GlcNAcb1-3Galb1- | 4GlcNAcb1-4)Mana1-3)(NeuGca2-3/6Galb1- |
| 4GlcNAcb1-2(Galb1-4GlcNAcb1-6)Mana1-6)Manb1- | 4GlcNAcb1-2(NeuGca2-3/6Galb1-4GlcNAcb1- |
| 4GlcNAcb1-4(Fuca1-6)GlcNAc | 6)Mana1-6)Manb1-4GlcNAcb1-4(Fuca1-6)GlcNAc |
| Galb1-4(Fuca1-3)GlcNAcb1-2(Gala1-3Galb1- | Galb1-4(Fuca1-3)GlcNAcb1-2(Gala1-3Galb1- |
| 4GlcNAcb1-4)Mana1-3(NeuGca2-3/6Galb1- | 4GlcNAcb1-4)Mana1-3(NeuGca2-3/6Galb1- |
| 4GlcNAcb1-3Galb1-4GlcNAcb1-2(Galb1-4GlcNAcb1- | 4GlcNAcb1-3Galb1-4GlcNAcb1-2(Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| GlcNAcb1-4(NeuGca2-3/6Galb1-4(Fuca1- | Galb1-4GlcNAcb1-3Galb1-4GlcNAcb1-2(Gala1- |
| 3)GlcNAcb1-3Galb1-4GlcNAcb1-2(Galb1- | 3Galb1-4GlcNAcb1-4)Mana1-3(Gala1-3Galb1- |
| 4GlcNAcb1-3Galb1-4GlcNAcb1-4)Mana1-3)(Mana1- | 4GlcNAcb1-2(NeuAca2-3/6Galb1-4GlcNAcb1- |
| 3(Mana1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-4(Gala1-3Galb1-4GlcNAcb1-2(NeuAca2- | Galb1-4(Fuca1-3)GlcNAcb1-3Galb1-4GlcNAcb1- |
| 3/6Galb1-4GlcNAcb1-4)Mana1-3)(Gala1-3Galb1- | 2(Gala1-3Galb1-4GlcNAcb1-4)Mana1-3(Gala1- |
| 4GlcNAcb1-2(Gala1-3Galb1-4GlcNAcb1-6)Mana1- | 3Galb1-4GlcNAcb1-2(Fuca1-2Galb1-4(Fuca1- |
| 6)Manb1-4GlcNAcb1-4(Fuca1-6)GlcNAc | 3)GlcNAcb1-6)Mana1-6)Manb1-4GlcNAcb1-4GlcNAc |
| Galb1-4(Fuca1-3)GlcNAcb1-3Galb1-4GlcNAcb1- | GlcNAcb1-4(Fuca1-2Galb1-4(Fuca1-3)GlcNAcb1- |
| 2(Gala1-3Galb1-4GlcNAcb1-4)Mana1-3(Gala1- | 2(Gala1-3Galb1-4GlcNAcb1-4)Mana1-3)(Gala1- |
| 3Galb1-4GlcNAcb1-2(Galb1-4(Fuca1-3)GlcNAcb1- | 3Galb1-4GlcNAcb1-2(Gala1-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Gala1-3Galb1-4GlcNAcb1-3Galb1- | GlcNAcb1-4(NeuGca2-3/6Galb1-4(Fuca1- |
| 4GlcNAcb1-2(Fuca1-2Galb1-4(Fuca1-3)GlcNAcb1- | 3)GlcNAcb1-2(GalNAcb1-4(Fuca1-3)GlcNAcb1- |
| 3Galb1-4GlcNAcb1-4)Mana1-3)(Mana1-3(Mana1- | 4)Mana1-3)(Galb1-4(Fuca1-3)GlcNAcb1-2(Galb1- |
| 6)Mana1-6)Manb1-4GlcNAcb1-4(Fuca1-6)GlcNAc | 4(Fuca1-3)GlcNAcb1-6)Mana1-6)Manb1- |
| | 4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Gala1- |
| 3)GlcNAcb1-2(GalNAcb1-4GlcNAcb1-4)Mana1- | 3Galb1-4GlcNAcb1-4)Mana1-3)(NeuGca2-3/6Galb1- |
| 3)(Galb1-4(Fuca1-3)GlcNAcb1-2(Galb1-4(Fuca1- | 4GlcNAcb1-2(NeuGca2-3/6Galb1-4GlcNAcb1- |
| 3)GlcNAcb1-6)Mana1-6)Manb1-4GlcNAcb1- | 6)Mana1-6)Manb1-4GlcNAcb1-4GlcNAc |
| 4(Fuca1-6)GlcNAc | |
| Gala1-3Galb1-4GlcNAcb1-2(Galb1-4GlcNAcb1- | Galb1-4GlcNAcb1-3Galb1-4GlcNAcb1-2(Gala1- |
| 4)Mana1-3(NeuGca2-3/6Galb1-4GlcNAcb1-3Galb1- | 3Galb1-4GlcNAcb1-4)Mana1-3(Gala1-3Galb1- |
| 4GlcNAcb1-2(NeuGca2-3/6Galb1-4GlcNAcb1- | 4GlcNAcb1-2(NeuGca2-3/6Galb1-4GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Gala1-3Galb1-4GlcNAcb1-2(NeuGca2- | NeuAca2-3/6Galb1-4GlcNAcb1-3Galb1-4GlcNAcb1- |
| 3/6Galb1-4GlcNAcb1-4)Mana1-3)(Gala1-3Galb1- | 2(Gala1-3Galb1-4GlcNAcb1-4)Mana1-3(Gala1- |
| 4GlcNAcb1-2(Gala1-3Galb1-4GlcNAcb1-6)Mana1- | 3Galb1-4GlcNAcb1-2(Gala1-3Galb1-4GlcNAcb1- |
| 6)Manb1-4GlcNAcb1-4(Fuca1-6)GlcNAc | 6)Mana1-6)Manb1-4GlcNAcb1-4GlcNAc |
| Galb1-4(Fuca1-3)GlcNAcb1-3Galb1-4(Fuca1- | Galb1-4(Fuca1-3)GlcNAcb1-3Galb1-4GlcNAcb1- |
| 3)GlcNAcb1-2(Gala1-3Galb1-4GlcNAcb1-4)Mana1- | 2(Gala1-3Galb1-4GlcNAcb1-4)Mana1-3(Gala1- |
| 3(Gala1-3Galb1-4GlcNAcb1-2(Gala1-3Galb1- | 3Galb1-4GlcNAcb1-2(Gala1-3Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4GlcNAcb1-2(GlcNAcb1- | NeuAca2-3/6Galb1-4(Fuca1-3)GlcNAcb1- |
| 4)Mana1-3(NeuAca2-3/6Galb1-4GlcNAcb1- | 2(GlcNAcb1-4)Mana1-3(NeuAca2-3/6Galb1- |
| 2(NeuAca2-8NeuAca2-3/6Galb1-4GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| GlcNAcb1-4(NeuAca2-6(Fuca1-2)Galb1-4GlcNAcb1- | GlcNAcb1-4(NeuAca2-3/6Galb1-4GlcNAcb1- |
| 2(NeuAca2-6(Fuca1-2)Galb1-4GlcNAcb1-6)Mana1- | 2(Galb1-4GlcNAcb1-4)Mana1-3)(NeuAca2- |
| 3)(NeuAca2-6Galb1-4GlcNAcb1-2Mana1-6)Manb1- | 3/6Galb1-4GlcNAcb1-3Galb1-4GlcNAcb1-2(Galb1- |
| 4GlcNAcb1-4(Fuca1-6)GlcNAcb | 4GlcNAcb1-6)Mana1-6)Manb1-4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4(Fuca1-3)GlcNAcb1- |
| 3)(Galb1-4GlcNAcb1-3Galb1-4GlcNAcb1-2(Galb1- | 4)Mana1-3)(Gatb1-4GlcNAcb1-3Galb1-4GlcNAcb1- |
| 4GlcNAcb1-6)Mana1-6)Manb1-4GlcNAcb1-4(Fuca1- | 2(Galb1-4GlcNAcb1-6)Mana1-6)Manb1-4GlcNAcb1- |
| 6)GlcNAc | 4GlcNAc |
| GlcNAcb1-4(Galb1-4(Fuca1-3)GlcNAcb1-2(Galb1- | NeuGca2-3/6Galb1-4GlcNAcb1-3Galb1-4GlcNAcb1- |
| 4(Fuca1-3)GlcNAcb1-4)Mana1-3)(Galb1-4(Fuca1- | 2(Gala1-3Galb1-4GlcNAcb1-4)Mana1-3(Gala1- |
| 3)GlcNAcb1-3Galb1-4GlcNAcb1-2(Galb1- | 3Galb1-4GlcNAcb1-2(Gala1-3Galb1-4GlcNAcb1- |
| 4GlcNAcb1-6)Mana1-6)Manb1-4GlcNAcb1-4(Fuca1- | 6)Mana1-6)Manb1-4GlcNAcb1-4GlcNAc |
| 6)GlcNAc | |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4GlcNAc | 6)Mana1-6)Manb1-4GlcNAcb1-4GlcNAcb |
| NeuAca2-6Galb1-4GlcNAcb1-2(NeuAca2-6Galb1- | NeuAca2-6Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-3Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4GlcNAc | 4)Mana1-6)Manb1-4GlcNAcb1-4GlcNAc |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-6Galb1-4GlcNAcb1- |
| 4)Mana1-6)Manb1-4GlcNAcb1-4GlcNAc | 4)Mana1-6)Manb1-4GlcNAcb1-4GlcNAc |
| NeuAca2-3Galb1-4GlcNAcb1-2(NeuAca2-6Galb1- | NeuAca2-6Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 4)Mana1-6)Manb1-4GlcNAcb1-4GlcNAc | 4)Mana1-6)Manb1-4GlcNAcb1-4GlcNAc |
| NeuAca2-6Galb1-4GlcNAcb1-2(NeuAca2-6Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-6Galb1-4GlcNAcb1- |
| 6)Mana1-6)Manb1-4GlcNAcb1-4GlcNAc | 4)Mana1-6)Manb1-4GlcNAcb1-4GlcNAc |
| NeuAca2-6Galb1-4GlcNAcb1-2(NeuAca2-6Galb1- | NeuAca2-6Galb1-4GlcNAcb1-2(NeuAca2-3Galb1- |
| 4GlcNAcb1-6)Mana1-3(NeuAca2-6Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-6Galb1-4GlcNAcb1- |
| 4)Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-6Galb1-4GlcNAcb1- | 4GlcNAcb1-2(NeuAca2-6Galb1-4GlcNAcb1- |
| 6)Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuAca2-6Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4GlcNAc | 4)Mana1-6)Manb1-4GlcNAcb1-4GlcNAc |
| NeuAca2-3Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-6Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4GlcNAcb | 4)Mana1-6)Manb1-4GlcNAcb1-4GlcNAc |
| NeuAca2-3Galb1-4GlcNAcb1-2(NeuAca2-6Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-6Galb1- |
| 4GlcNAcb1-2(NeuAca2-3Galb1-4GlcNAcb1- | 4GlcNAcb1-2(NeuAca2-6Galb1-4GlcNAcb1- |
| 6)Mana1-6)Manb1-4GlcNAcb1-4GlcNAc | 6)Mana1-6)Manb1-4GlcNAcb1-4GlcNAc |
| NeuAca2-3Galb1-4GlcNAcb1-2(NeuAca2-6Galb1- | NeuAca2-3Galb1-4GlcNAcb1-2(NeuAca2-3Galb1- |
| 4GlcNAcb1-6)Mana1-3(NeuAca2-3Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 4)Mana1-6)Manb1-4GlcNAcb1-4GlcNAc | 6)Mana1-6)Manb1-4GlcNAcb1-4GlcNAc |
| NeuAca2-6Galb1-4GlcNAcb1-2(NeuAca2-3Galb1- | NeuAca2-3Galb1-4GlcNAcb1-2(NeuAca2-6Galb1- |
| 4GlcNAcb1-4)Mana1-3(NeuAca2-3Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-6Galb1-4GlcNAcb1- |
| 6)Mana1-6)Manb1-4GlcNAcb1-4GlcNAc | 6)Mana1-6)Manb1-4GlcNAcb1-4GlcNAc |
| NeuAca2-3Galb1-4GlcNAcb1-2(NeuAca2-6Galb1- | NeuAca2-6Galb1-4GlcNAcb1-2(NeuAca2-3Galb1- |
| 4GlcNAcb1-6)Mana1-3(NeuAca2-6Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 4)Mana1-6)Manb1-4GlcNAcb1-4GlcNAc | 6)Mana1-6)Manb1-4GlcNAcb1-4GlcNAc |
| NeuAca2-3Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4GlcNAc | 4)Mana1-6)Manb1-4GlcNAcb1-4GlcNAc |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-3Galb1- |
| 4GlcNAcb1-2(NeuAca2-6Galb1-4GlcNAcb1- | 4GlcNAcb1-2(NeuAca2-3Galb1-4GlcNAcb1- |
| 4)Mana1-6)Manb1-4GlcNAcb1-4GlcNAc | 4)Mana1-6)Manb1-4GlcNAcb1-4GlcNAc |
| NeuAca2-3Galb1-4GlcNAcb1-2(NeuAca2-3Galb1- | NeuAca2-6Galb1-4GlcNAcb1-2(NeuAca2-6Galb1- |
| 4GlcNAcb1-6)Mana1-3(NeuAca2-3Galb1- | 4GlcNAcb1-6)Mana1-3(NeuAca2-3Galb1- |
| 4GlcNAcb1-2(NeuAca2-6Galb1-4GlcNAcb1- | 4GlcNAcb1-2(NeuAca2-6Galb1-4GlcNAcb1- |
| 4)Mana1-6)Manb1-4GlcNAcb1-4GlcNAc | 4)Mana1-6)Manb1-4GlcNAcb1-4GlcNAc |
| NeuGca2-3/6Galb1-4GlcNAcb1-2(GlcNAcb1- | NeuAca2-3/6Galb1-4GlcNAcb1-2(NeuAca2- |
| 4)Mana1-3(NeuAca2-3/6Galb1-4GlcNAcb1- | 3/6Galb1-4GlcNAcb1-4)Mana1-3(NeuAca2- |
| 2(NeuAca2-8NeuAca2-3/6Galb1-4GlcNAcb1- | 3/6Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| NeuAca2-3Galb1-4GlcNAcb1-2(NeuAca2-6Galb1- | NeuAca2-3Galb1-4GlcNAcb1-2(NeuAca2-3Galb1- |
| 4GlcNAcb1-4)Mana1-3(NeuAca2-6Galb1- | 4GlcNAcb1-4)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4GlcNAcb | 6)Mana1-6)Manb1-4GlcNAcb1-4GlcNAcb |
| NeuAca2-3Galb1-4GlcNAcb1-2(NeuAca2-6Galb1- | NeuAca2-6Galb1-4GlcNAcb1-2(NeuAca2-3Galb1- |
| 4GlcNAcb1-4)Mana1-3(NeuAca2-6Galb1- | 4GlcNAcb1-4)Mana1-3(NeuAca2-3Galb1- |
| 4GlcNAcb1-2(NeuAca2-6Galb1-4GlcNAcb1- | 4GlcNAcb1-2(NeuAca2-6Galb1-4GlcNAcb1- |
| 6)Mana1-6)Manb1-4GlcNAcb1-4GlcNAcb | 6)Mana1-6)Manb1-4GlcNAcb1-4GlcNAcb |
| NeuAca2-3/6Galb1-4GlcNAcb1-2(NeuAca2- | NeuGca2-3/6Galb1-4(Fuca1-3)GlcNAcb1- |
| 3/6Galb1-4GlcNAcb1-4)Mana1-3(NeuAca2- | 2(GlcNAcb1-4)Mana1-3(NeuAca2-3/6Galb1- |
| 3/6Galb1-4GlcNAcb1-2(Galb1-4(Fuca1-3)GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| NeuAca2-3/6Galb1-4(Fuca1-3)GlcNAcb1-2(Galb1- | NeuAca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(NeuAca2-3/6Galb1- |
| 4GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4GlcNAcb1- | NeuAca2-3/6Galb1-4(Fuca1-3)GlcNAcb1-2(Galb1- |
| 2(Galb1-4GlcNAcb1-4)Mana1-3)(NeuAca2- | 4(Fuca1-3)GlcNAcb1-4)Mana1-3(Galb1-4(Fuca1- |
| 3/6Galb1-4GlcNAcb1-3Galb1-4GlcNAcb1-2(Galb1- | 3)GlcNAcb1-2(NeuAca2-3/6Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1-4GlcNAc |
| NeuAca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(Galb1-4(Fuca1-3)GlcNAcb1- | 3)GlcNAcb1-2(Galb1-4GlcNAcb1-4)Mana1- |
| 2(NeuAca2-3/6Galb1-4(Fuca1-3)GlcNAcb1- | 3)(Galb1-4GlcNAcb1-3Galb1-4GlcNAcb1-2(Galb1- |
| 6)Mana1-6)Manb1-4GlcNAcb1-4(Fuca1-6)GlcNAc | 4GlcNAcb1-6)Mana1-6)Manb1-4GlcNAcb1-4(Fuca1- |
| | 6)GlcNAc |
| GlcNAcb1-4(Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3)(NeuAca2-3/6Galb1- | 3)GlcNAcb1-2(Galb1-4(Fuca1-3)GlcNAcb1- |
| 4GlcNAcb1-3Galb1-4GlcNAcb1-2(Galb1-4GlcNAcb1- | 4)Mana1-3)(Galb1-4GlcNAcb1-3Galb1-4GlcNAcb1- |
| 6)Mana1-6)Manb1-4GlcNAcb1-4GlcNAc | 2(Galb1-4GlcNAcb1-6)Mana1-6)Manb1-4GlcNAcb1- |
| | 4GlcNAc |
| GlcNAcb1-4(Galb1-4GlcNAcb1-2(Gala1-3Galb1- | NeuAca2-3/6Galb1-4(Fuca1-3)GlcNAcb1-2(Fuca1- |
| 4GlcNAcb1-4)Mana1-3)(NeuAca2-3/6Galb1- | 2Galb1-4(Fuca1-3)GlcNAcb1-4)Mana1-3(Galb1- |
| 4GlcNAcb1-3Galb1-4GlcNAcb1-2(Galb1-4GlcNAcb1- | 4(Fuca1-3)GlcNAcb1-2(Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| Galb1-4GlcNAcb1-2(Galb1-4(Fuca1-3)GlcNAcb1- | GlcNAcb1-4(Galb1-4(Fuca1-3)GlcNAcb1-2(Gala1- |
| 3Galb1-4(Fuca1-3)GlcNAcb1-4)Mana1-3(Galb1- | 3Galb1-4GlcNAcb1-4)Mana1-3)(Galb1-4GlcNAcb1- |
| 4GlcNAcb1-2(Galb1-4GlcNAcb1-3Galb1-4GlcNAcb1- | 3Galb1-4GlcNAcb1-2(Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuAca2-8NeuAca2-3/6Galb1- | NeuGca2-3/6Galb1-4GlcNAcb1-2(GlcNAcb1- |
| 4GlcNAcb1-3Galb1-4GlcNAcb1-2(GlcNAcb1- | 4)Mana1-3(NeuGca2-3/6Galb1-4GlcNAcb1- |
| 4)Mana1-3)(GalNAcb1-4GlcNAcb1-2(Galb1- | 2(NeuAca2-8NeuAca2-3/6Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| NeuAca2-3/6Galb1-4GlcNAcb1-2(NeuGca2- | Gala1-3Galb1-4GlcNAcb1-2(NeuAca2-3/6Galb1- |
| 3/6Galb1-4GlcNAcb1-4)Mana1-3(NeuAca2- | 4GlcNAcb1-4)Mana1-3(NeuAca2-3/6Galb1- |
| 3/6Galb1-4GlcNAcb1-2(NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-2(Galb1- | NeuGca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(NeuAca2-3/6Galb1- |
| 4GlcNAcb1-2(NeuAca2-3/6Galb1-4GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| NeuGca2-3/6Galb1-4(Fuca1-3)GlcNAcb1- | NeuAca2-3/6Galb1-4(Fuca1-3)GlcNAcb1- |
| 2(GlcNAcb1-4)Mana1-3(NeuGca2-3/6Galb1- | 2(NeuAca2-3/6Galb1-4GlcNAcb1-4)Mana1- |
| 4GlcNAcb1-2(NeuAca2-3/6Galb1-4(Fuca1- | 3(NeuAca2-3/6Galb1-4GlcNAcb1-2(Gala1-3Galb1- |
| 3)GlcNAcb1-6)Mana1-6)Manb1-4GlcNAcb1- | 4GlcNAcb1-6)Mana1-6)Manb1-4GlcNAcb1-4GlcNAc |
| 4(Fuca1-6)GlcNAc | |
| NeuAca2-3Galb1-4GlcNAcb1-2(NeuAca2-3Galb1- | GlcNAcb1-4(NeuGca2-3/6Galb1-4GlcNAcb1- |
| 4GlcNAcb1-6)Mana1-3(NeuAca2-3Galb1- | 2(Galb1-4GlcNAcb1-4)Mana1-3)(NeuGca2- |
| 4GlcNAcb1-2(Galb1-3Galb1-4GlcNAcb1-4)Mana1- | 3/6Galb1-4GlcNAcb1-3Galb1-4GlcNAcb1-2(Galb1- |
| 6)Manb1-4GlcNAcb1-4(Fuca1-6)GlcNAc | 4GlcNAcb1-6)Mana1-6)Manb1-4GlcNAcb1-4GlcNAc |
| NeuGca2-3/6Galb1-4(Fuca1-3)GlcNAcb1-2(Galb1- | Gala1-3Galb1-4(Fuca1-3)GlcNAcb1-2(Galb1- |
| 4(Fuca1-3)GlcNAcb1-4)Mana1-3(Galb1-4(Fuca1- | 4GlcNAcb1-4)Mana1-3(NeuAca2-3/6Galb1- |
| 3)GlcNAcb1-2(NeuAca2-3/6Galb1-4(Fuca1- | 4GlcNAcb1-2(NeuAca2-3/6Galb1-4(Fuca1- |
| 3)GlcNAcb1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| NeuGca2-3/6Galb1-4(Fuca1-3)GlcNAcb1-2(Galb1- | Gala1-3Galb1-4(Fuca1-3)GlcNAcb1-2(Galb1- |
| 4GlcNAcb1-4)Mana1-3(Galb1-4(Fuca1-3)GlcNAcb1- | 4GlcNAcb1-4)Mana1-3(NeuAca2-3/6Galb1-4(Fuca1- |
| 2(NeuAca2-3/6Galb1-4(Fuca1-3)GlcNAcb1- | 3)GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| GlcNAcb1-4(Galb1-4(Fuca1-3)GlcNAcb1-2(Gala1- | GlcNAcb1-4(Galb1-4GlcNAcb1-3Galb1-4GlcNAcb1- |
| 3Galb1-4GlcNAcb1-4)Mana1-3)(NeuGca2-3/6Galb1- | 2(Gala1-3Galb1-4GlcNAcb1-4)Mana1-3)(Gala1- |
| 4GlcNAcb1-3Galb1-4GlcNAcb1-2(Galb1-4GlcNAcb1- | 3Galb1-4GlcNAcb1-2(NeuAca2-3/6Galb1- |
| 6)Mana1-6)Manb1-4GlcNAcb1-4GlcNAc | 4GlcNAcb1-6)Mana1-6)Manb1-4GlcNAcb1-4GlcNAc |
| GlcNAcb1-4(Galb1-4GlcNAcb1-2(Gala1-3Galb1- | Fuca1-2Galb1-4(Fuca1-3)GlcNAcb1-2(Gala1- |
| 4GlcNAcb1-4)Mana1-3)(NeuGca2-3/6Galb1- | 3Galb1-4GlcNAcb1-4)Mana1-3(NeuAca2-3/6Galb1- |
| 4GlcNAcb1-3Galb1-4GlcNAcb1-2(Galb1-4GlcNAcb1- | 4(Fuca1-3)GlcNAcb1-2(Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1-2(Fuca1- | GlcNAcb1-4(Galb1-4(Fuca1-3)GlcNAcb1-3Galb1- |
| 2Galb1-4(Fuca1-3)GlcNAcb1-4)Mana1-3(Galb1- | 4GlcNAcb1-2(Gala1-3Galb1-4GlcNAcb1-4)Mana1- |
| 4(Fuca1-3)GlcNAcb1-2(Galb1-4(Fuca1-3)GlcNAcb1- | 3)(Gala1-3Galb1-4GlcNAcb1-2(Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Galb1-4(Fuca1-3)GlcNAcb1-3Galb1- | GlcNAcb1-4(NeuAca2-8NeuGca2-3/6Galb1- |
| 4GlcNAcb1-2(Gala1-3Galb1-4GlcNAcb1-4)Mana1- | 4GlcNAcb1-3Galb1-4GlcNAcb1-2(GlcNAcb1- |
| 3)(Gala1-3Galb1-4GlcNAcb1-2(Galb1-4(Fuca1- | 4)Mana1-3)(GalNAcb1-4GlcNAcb1-2(Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuAca2-8NeuAca2-3/6Galb1- | NeuGca2-3/6Galb1-4GlcNAcb1-2(NeuGca2- |
| 4GlcNAcb1-3Galb1-4GlcNAcb1-2(GlcNAcb1- | 3/6Galb1-4GlcNAcb1-4)Mana1-3(NeuAca2- |
| 4)Mana1-3)(GalNAcb1-4GlcNAcb1-2(Gala1-3Galb1- | 3/6Galb1-4GlcNAcb1-2(NeuAca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| NeuGca2-3/6Galb1-4GlcNAcb1-2(GlcNAcb1- | NeuAca2-3/6Galb1-4(Fuca1-3)GlcNAcb1- |
| 4)Mana1-3(NeuGca2-3/6Galb1-4GlcNAcb1- | 2(NeuGca2-3/6Galb1-4GlcNAcb1-4)Mana1- |
| 2(NeuAca2-8NeuGca2-3/6Galb1-4GlcNAcb1- | 3(NeuAca2-3/6Galb1-4GlcNAcb1-2(Gala1-3Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| NeuGca2-3/6Galb1-4(Fuca1-3)GlcNAcb1-2(Galb1- | Gala1-3Galb1-4GlcNAcb1-2(NeuGca2-3/6Galb1- |
| 4GlcNAcb1-4)Mana1-3(NeuGca2-3/6Galb1- | 4GlcNAcb1-4)Mana1-3(NeuAca2-3/6Galb1- |
| 4GlcNAcb1-2(NeuAca2-3/6Galb1-4GlcNAcb1- | 4GlcNAcb1-2(NeuAca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| Gala1-3Galb1-4GlcNAcb1-2(Gala1-3Galb1- | NeuGca2-3/6Galb1-4(Fuca1-3)GlcNAcb1-2(Galb1- |
| 4GlcNAcb1-4)Mana1-3(NeuAca2-8NeuAca2- | 4GlcNAcb1-4)Mana1-3(NeuGca2-3/6Galb1- |
| 3/6Galb1-4GlcNAcb1-2(NeuAca2-3/6Galb1- | 4GlcNAcb1-2(NeuAca2-3/6Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1-4GlcNAc |
| NeuGca2-3/6Galb1-4(Fuca1-3)GlcNAcb1- | NeuAca2-3/6Galb1-4(Fuca1-3)GlcNAcb1-3Galb1- |
| 2(GlcNAcb1-4)Mana1-3(NeuGca2-3/6Galb1- | 4GlcNAcb1-2(NeuAca2-3/6Galb1-4GlcNAcb1- |
| 4GlcNAcb1-2(NeuGca2-3/6Galb1-4(Fuca1- | 3Galb1-4GlcNAcb1-4)Mana1-3(Mana1-3(Mana1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| NeuAca2-3/6Galb1-4(Fuca1-3)GlcNAcb1-3Galb1- | Gala1-3Galb1-4(Fuca1-3)GlcNAcb1-2(Galb1- |
| 4GlcNAcb1-2(NeuAca2-3/6Galb1-4(Fuca1- | 4GlcNAcb1-4)Mana1-3(NeuGca2-3/6Galb1- |
| 3)GlcNAcb1-3Galb1-4GlcNAcb1-4)Mana1-3(Mana1- | 4GlcNAcb1-2(NeuAca2-3/6Galb1-4(Fuca1- |
| 3(Mana1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| NeuGca2-3/6Galb1-4(Fuca1-3)GlcNAcb1-2(Galb1- | Gala1-3Galb1-4(Fuca1-3)GlcNAcb1-2(Galb1- |
| 4(Fuca1-3)GlcNAcb1-4)Mana1-3(Galb1-4(Fuca1- | 4GlcNAcb1-4)Mana1-3(NeuGca2-3/6Galb1- |
| 3)GlcNAcb1-2(NeuGca2-3/6Galb1-4(Fuca1- | 4(Fuca1-3)GlcNAcb1-2(NeuAca2-3/6Galb1- |
| 3)GlcNAcb1-6)Mana1-6)Manb1-4GlcNAcb1-4GlcNAc | 4(Fuca1-3)GlcNAcb1-6)Mana1-6)Manb1- |
| | 4GlcNAcb1-4GlcNAc |
| NeuGca2-3/6Galb1-4(Fuca1-3)GlcNAcb1-2(Galb1- | GlcNAcb1-4(Galb1-4GlcNAcb1-3Galb1-4GlcNAcb1- |
| 4GlcNAcb1-4)Mana1-3(Galb1-4(Fuca1-3)GlcNAcb1- | 2(Gala1-3Galb1-4GlcNAcb1-4)Mana1-3)(Gala1- |
| 2(NeuGca2-3/6Galb1-4(Fuca1-3)GlcNAcb1- | 3Galb1-4GlcNAcb1-2(NeuGca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| NeuAca2-3/6Galb1-4(Fuca1-3)GlcNAcb1-3Galb1- | Fuca1-2Galb1-4(Fuca1-3)GlcNAcb1-2(Gala1- |
| 4(Fuca1-3)GlcNAcb1-2(Galb1-4(Fuca1-3)GlcNAcb1- | 3Galb1-4GlcNAcb1-4)Mana1-3(NeuGca2-3/6Galb1- |
| 3Galb1-4(Fuca1-3)GlcNAcb1-4)Mana1-3(Mana1- | 4(Fuca1-3)GlcNAcb1-2(Galb1-4(Fuca1-3)GlcNAcb1- |
| 3(Mana1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1-3Galb1- | Galb1-3Galb1-4GlcNAcb1-2(Galb1-3Galb1- |
| 4GlcNAcb1-2(Fuca1-2Galb1-4(Fuca1-3)GlcNAcb1- | 4GlcNAcb1-4)Mana1-3(Galb1-4GlcNAcb1-3Galb1- |
| 3Galb1-4GlcNAcb1-4)Mana1-3(Mana1-3(Mana1- | 4GlcNAcb1-2(Galb1-4GlcNAcb1-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| Galb1-4GlcNAcb1-3Galb1-4GlcNAcb1-2(Gala1- | GlcNAcb1-4(Galb1-4(Fuca1-3)GlcNAcb1-3Galb1- |
| 3Galb1-4GlcNAcb1-4)Mana1-3(Galb1-4GlcNAcb1- | 4GlcNAcb1-2(Gala1-3Galb1-4GlcNAcb1-4)Mana1- |
| 3Galb1-4GlcNAcb1-2(Gala1-3Galb1-4GlcNAcb1- | 3)(Gala1-3Galb1-4GlcNAcb1-2(Gala1-3Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(Galb1-4GlcNAcb1-3Galb1-4GlcNAcb1- | GlcNAcb1-4(NeuAca2-3/6Galb1-4GlcNAcb1- |
| 2(Gala1-3Galb1-4GlcNAcb1-4)Mana1-3)(Gala1- | 2(GlcNAcb1-4)Mana1-3)(NeuAca2-3/6Galb1- |
| 3Galb1-4GlcNAcb1-2(Gala1-3Galb1-4GlcNAcb1- | 4GlcNAcb1-2(NeuAca2-8NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GlcNAcb1-4)Mana1-3)(NeuAca2- | 3)GlcNAcb1-2(GlcNAcb1-4)Mana1-3)(NeuAca2- |
| 3/6Galb1-4GlcNAcb1-2(NeuAca2-3/6Galb1- | 3/6Galb1-4GlcNAcb1-2(NeuAca2-3/6Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-8NeuGca2-3/6Galb1- | GlcNAcb1-4(NeuAca2-8NeuGca2-3/6Galb1- |
| 4GlcNAcb1-3Galb1-4GlcNAcb1-2(GlcNAcb1- | 4GlcNAcb1-3Galb1-4GlcNAcb1-2(GlcNAcb1- |
| 4)Mana1-3)(GalNAcb1-4GlcNAcb1-2(Galb1- | 4)Mana1-3)(GalNAcb1-4GlcNAcb1-2(Gala1-3Galb1- |
| 4GlcNAcb1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| NeuAca2-3/6Galb1-4(Fuca1-3)GlcNAcb1- | NeuAca2-3/6Galb1-4(Fuca1-3)GlcNAcb1- |
| 2(GalNAcb1-4(Fuca1-3)GlcNAcb1-4)Mana1- | 2(GalNAcb1-4GlcNAcb1-4)Mana1-3(Galb1-4(Fuca1- |
| 3(Galb1-4(Fuca1-3)GlcNAcb1-2(NeuAca2- | 3)GlcNAcb1-2(NeuAca2-3/6Galb1-4(Fuca1- |
| 3/6Galb1-4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| NeuGca2-3/6Galb1-4GlcNAcb1-2(NeuGca2- | NeuGca2-3/6Galb1-4GlcNAcb1-2(GlcNAcb1- |
| 3/6Galb1-4GlcNAcb1-4)Mana1-3(NeuGca2- | 4)Mana1-3(NeuGca2-3/6Galb1-4GlcNAcb1- |
| 3/6Galb1-4GlcNAcb1-2(NeuAca2-3/6Galb1- | 2(NeuGca2-8NeuGca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| Gala1-3Galb1-4GlcNAcb1-2(Gala1-3Galb1- | NeuGca2-3/6Galb1-4(Fuca1-3)GlcNAcb1-2(Galb1- |
| 4GlcNAcb1-4)Mana1-3(NeuAca2-8NeuGca2- | 4GlcNAcb1-4)Mana1-3(NeuGca2-3/6Galb1- |
| 3/6Galb1-4GlcNAcb1-2(NeuAca2-3/6Galb1- | 4GlcNAcb1-2(NeuGca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-2(Galb1- | NeuGca2-3/6Galb1-4(Fuca1-3)GlcNAcb1- |
| 4GlcNAcb1-4)Mana1-3(NeuGca2-3/6Galb1- | 2(NeuGca2-3/6Galb1-4GlcNAcb1-4)Mana1- |
| 4GlcNAcb1-2(NeuGca2-3/6Galb1-4(Fuca1- | 3(NeuAca2-3/6Galb1-4GlcNAcb1-2(Gala1-3Galb1- |
| 3)GlcNAcb1-6)Mana1-6)Manb1-4GlcNAcb1-4GlcNAc | 4GlcNAcb1-6)Mana1-6)Manb1-4GlcNAcb1-4GlcNAc |
| Gala1-3Galb1-4GlcNAcb1-2(NeuGca2-3/6Galb1- | NeuAca2-3/6Galb1-4(Fuca1-3)GlcNAcb1-3Galb1- |
| 4GlcNAcb1-4)Mana1-3(NeuGca2-3/6Galb1- | 4GlcNAcb1-2(NeuGca2-3/6Galb1-4(Fuca1- |
| 4GlcNAcb1-2(NeuAca2-3/6Galb1-4GlcNAcb1- | 3)GlcNAcb1-3Galb1-4GlcNAcb1-4)Mana1-3(Mana1- |
| 6)Mana1-6)Manb1-4GlcNAcb1-4(Fuca1-6)GlcNAc | 3(Mana1-6)Mana1-6)Manb1-4GlcNAcb1-4GlcNAc |
| Gala1-3Galb1-4(Fuca1-3)GlcNAcb1-2(Galb1- | Gala1-3Galb1-4(Fuca1-3)GlcNAcb1-2(Galb1- |
| 4GlcNAcb1-4)Mana1-3(NeuGca2-3/6Galb1- | 4GlcNAcb1-4)Mana1-3(NeuGca2-3/6Galb1- |
| 4(Fuca1-3)GlcNAcb1-2(NeuGca2-3/6Galb1- | 4GlcNAcb1-2(NeuGca2-3/6Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| NeuAca2-3/6Galb1-4(Fuca1-3)GlcNAcb1-3Galb1- | NeuGca2-3/6Galb1-4(Fuca1-3)GlcNAcb1-3Galb1- |
| 4GlcNAcb1-2(NeuGca2-3/6Galb1-4GlcNAcb1- | 4(Fuca1-3)GlcNAcb1-2(Galb1-4(Fuca1-3)GlcNAcb1- |
| 3Galb1-4GlcNAcb1-4)Mana1-3(Mana1-3(Mana1- | 3Galb1-4(Fuca1-3)GlcNAcb1-4)Mana1-3(Mana1- |
| 6)Mana1-6)Manb1-4GlcNAcb1-4(Fuca1-6)GlcNAc | 3(Mana1-6)Mana1-6)Manb1-4GlcNAcb1-4GlcNAc |
| NeuGca2-3/6Galb1-4(Fuca1-3)GlcNAcb1-3Galb1- | Gala1-3Galb1-4GlcNAcb1-3Galb1-4(Fuca1- |
| 4GlcNAcb1-2(Fuca1-2Galb1-4(Fuca1-3)GlcNAcb1- | 3)GlcNAcb1-2(NeuAca2-3/6Galb1-4(Fuca1- |
| 3Galb1-4GlcNAcb1-4)Mana1-3(Mana1-3(Mana1- | 3)GlcNAcb1-3Galb1-4GlcNAcb1-4)Mana1-3(Mana1- |
| 6)Mana1-6)Manb1-4GlcNAcb1-4(Fuca1-6)GlcNAc | 3(Mana1-6)Mana1-6)Manb1-4GlcNAcb1-4(Fuca1- |
| | 6)GlcNAc |
| Gala1-3Galb1-4GlcNAcb1-3Galb1-4(Fuca1- | GlcNAcb1-4(NeuGca2-3/6Galb1-4GlcNAcb1- |
| 3)GlcNAcb1-2(Fuca1-2Galb1-4(Fuca1-3)GlcNAcb1- | 2(GlcNAcb1-4)Mana1-3)(NeuAca2-3/6Galb1- |
| 3Galb1-4(Fuca1-3)GlcNAcb1-4)Mana1-3(Mana1- | 4GlcNAcb1-2(NeuAca2-8NeuAca2-3/6Galb1- |
| 3(Mana1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GlcNAcb1-4)Mana1-3)(NeuAca2- | 3)GlcNAcb1-2(GlcNAcb1-4)Mana1-3)(NeuAca2- |
| 3/6Galb1-4GlcNAcb1-2(NeuAca2-3/6Galb1- | 3/6Galb1-4GlcNAcb1-2(NeuAca2-3/6Galb1- |
| 4GlcNAcb1-6)Mana1-6)Manb1-4GlcNAcb1-4(Fuca1- | 4(Fuca1-3)GlcNAcb1-6)Mana1-6)Manb1- |
| 6)GlcNAc | 4GlcNAcb1-4GlcNAc |
| GlcNAcb1-4(NeuAca2-3/6Galb1-4GlcNAcb1- | NeuAca2-3Galb1-4GlcNAcb1-2(NeuAca2-3Galb1- |
| 2(Galb1-4GlcNAcb1-4)Mana1-3)(NeuAca2- | 4GlcNAcb1-4)Mana1-3(NeuAca2-3Galb1- |
| 3/6Galb1-4GlcNAcb1-2(NeuAca2-3/6Galb1- | 4GlcNAcb1-2(GlcNAcb1-3Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-4(NeuAca2-3/6Galb1-4(Fuca1- | GlcNAcb1-4(NeuGca2-8NeuGca2-3/6Galb1- |
| 3)GlcNAcb1-2(Galb1-4GlcNAcb1-4)Mana1- | 4GlcNAcb1-3Galb1-4GlcNAcb1-2(GlcNAcb1- |
| 3)(NeuAca2-3/6Galb1-4GlcNAcb1-2(NeuAca2- | 4)Mana1-3)(GalNAcb1-4GlcNAcb1-2(Gala1-3Galb1- |
| 3/6Galb1-4GlcNAcb1-6)Mana1-6)Manb1- | 4GlcNAcb1-6)Mana1-6)Manb1-4GlcNAcb1-4GlcNAc |
| 4GlcNAcb1-4GlcNAc | |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(Galb1-4(Fuca1-3)GlcNAcb1-2(NeuAca2- | 3)(Galb1-4GlcNAcb1-2(NeuAca2-3/6Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1- |
| 2(GalNAcb1-4GlcNAcb1-4)Mana1-3(Galb1-4(Fuca1- | 2(GalNAcb1-4(Fuca1-3)GlcNAcb1-4)Mana1- |
| 3)GlcNAcb1-2(NeuAca2-3/6Galb1-4(Fuca1- | 3(Galb1-4(Fuca1-3)GlcNAcb1-2(NeuAca2- |
| 3)GlcNAcb1-6)Mana1-6)Manb1-4GlcNAcb1- | 3/6Galb1-4(Fuca1-3)GlcNAcb1-6)Mana1-6)Manb1- |
| 4(Fuca1-6)GlcNAc | 4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4(Fuca1-3)GlcNAcb1- | 3)GlcNAcb1-2(Fuca1-2Galb1-4(Fuca1-3)GlcNAcb1- |
| 4)Mana1-3)(Galb1-4(Fuca1-3)GlcNAcb1-2(Galb1- | 4)Mana1-3)(Galb1-4(Fuca1-3)GlcNAcb1-2(Galb1- |
| 4(Fuca1-3)GlcNAcb1-6)Mana1-6)Manb1- | 4(Fuca1-3)GlcNAcb1-6)Mana1-6)Manb1- |
| 4GlcNAcb1-4(Fuca1-6)GlcNAc | 4GlcNAcb1-4GlcNAc |
| NeuGca2-3/6Galb1-4GlcNAcb1-2(NeuGca2- | NeuGca2-3/6Galb1-4(Fuca1-3)GlcNAcb1- |
| 3/6Galb1-4GlcNAcb1-4)Mana1-3(NeuGca2- | 2(NeuGca2-3/6Galb1-4GlcNAcb1-4)Mana1- |
| 3/6Galb1-4GlcNAcb1-2(NeuGca2-3/6Galb1- | 3(NeuGca2-3/6Galb1-4GlcNAcb1-2(Gala1-3Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| Gala1-3Galb1-4GlcNAcb1-2(Gala1-3Galb1- | Gala1-3Galb1-4GlcNAcb1-2(NeuGca2-3/6Galb1- |
| 4GlcNAcb1-4)Mana1-3(NeuGca2-8NeuGca2- | 4GlcNAcb1-4)Mana1-3(NeuGca2-3/6Galb1- |
| 3/6Galb1-4GlcNAcb1-2(NeuAca2-3/6Galb1- | 4GlcNAcb1-2(NeuGca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-3Galb1- | NeuGca2-3/6Galb1-4(Fuca1-3)GlcNAcb1-3Galb1- |
| 4GlcNAcb1-2(NeuGca2-3/6Galb1-4(Fuca1- | 4GlcNAcb1-2(NeuGca2-3/6Galb1-4GlcNAcb1- |
| 3)GlcNAcb1-3Galb1-4GlcNAcb1-4)Mana1-3(Mana1- | 3Galb1-4GlcNAcb1-4)Mana1-3(Mana1-3(Mana1- |
| 3(Mana1-6)Mana1-6)Manb1-4GlcNAcb1-4GlcNAc | 6)Mana1-6)Manb1-4GlcNAcb1-4(Fuca1-6)GlcNAc |
| Gala1-3Galb1-4GlcNAcb1-3Galb1-4(Fuca1- | GlcNAcb1-4(NeuGca2-3/6Galb1-4GlcNAcb1- |
| 3)GlcNAcb1-2(NeuGca2-3/6Galb1-4(Fuca1- | 2(GlcNAcb1-4)Mana1-3)(NeuGca2-3/6Galb1- |
| 3)GlcNAcb1-3Galb1-4GlcNAcb1-4)Mana1-3(Mana1- | 4GlcNAcb1-2(NeuAca2-8NeuAca2-3/6Galb1- |
| 3(Mana1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GlcNAcb1-4)Mana1-3)(NeuGca2- | 3)GlcNAcb1-2(Galb1-4GlcNAcb1-4)Mana1- |
| 3/6Galb1-4GlcNAcb1-2(NeuAca2-3/6Galb1- | 3)(NeuAca2-3/6Galb1-4GlcNAcb1-2(NeuAca2- |
| 4(Fuca1-3)GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(GlcNAcb1-4)Mana1-3)(NeuGca2- | 2(Galb1-4GlcNAcb1-4)Mana1-3)(NeuAca2- |
| 3/6Galb1-4GlcNAcb1-2(NeuAca2-3/6Galb1- | 3/6Galb1-4GlcNAcb1-2(NeuAca2-3/6Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6GlcNAc | 6)GlcNAc |
| NeuAca2-3/6Galb1-4GlcNAcb1-2(Galb1-4GlcNAcb1- | GlcNAcb1-4(Gala1-3Galb1-4GlcNAcb1-2(NeuAca2- |
| 4)Mana1-3(NeuAca2-3/6Galb1-4GlcNAcb1-3Galb1- | 3/6Galb1-4GlcNAcb1-4)Mana1-3)(NeuAca2- |
| 4GlcNAcb1-2(NeuAca2-3/6Galb1-4GlcNAcb1- | 3/6Galb1-4GlcNAcb1-2(NeuAca2-3/6Galb1- |
| 6)Mana1-6)Manb1-4GlcNAcb1-4GlcNAc | 4GlcNAcb1-6)Mana1-6)Manb1-4GlcNAcb1-4GlcNAc |
| NeuAca2-3/6Galb1-4(Fuca1-3)GlcNAcb1-2(Galb1- | NeuGca2-3/6Galb1-4(Fuca1-3)GlcNAcb1- |
| 4(Fuca1-3)GlcNAcb1-4)Mana1-3(NeuAca2- | 2(GalNAcb1-4GlcNAcb1-4)Mana1-3(Galb1-4(Fuca1- |
| 3/6Galb1-4GlcNAcb1-3Galb1-4GlcNAcb1-2(Galb1- | 3)GlcNAcb1-2(NeuGca2-3/6Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| GlcNAcb1-4(Gala1-3Galb1-4(Fuca1-3)GlcNAcb1- | GlcNAcb1-4(NeuGca2-3/6Galb1-4(Fuca1- |
| 2(Galb1-4GlcNAcb1-4)Mana1-3)(NeuAca2- | 3)GlcNAcb1-2(Galb1-4GlcNAcb1-4)Mana1- |
| 3/6Galb1-4GlcNAcb1-2(NeuAca2-3/6Galb1- | 3)(Galb1-4(Fuca1-3)GlcNAcb1-2(NeuAca2- |
| 4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(Galb1-4GlcNAcb1-4)Mana1- |
| 3(Galb1-4(Fuca1-3)GlcNAcb1-2(NeuGca2- | 3)(NeuAca2-3/6Galb1-4GlcNAcb1-2(Gala1-3Galb1- |
| 3/6Galb1-4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | GlcNAcb1-4(Fuca1-2Galb1-4(Fuca1-3)GlcNAcb1- |
| 3)GlcNAcb1-2(Galb1-4GlcNAcb1-4)Mana1- | 2(Gala1-3Galb1-4GlcNAcb1-4)Mana1-3)(NeuAca2- |
| 3)(Galb1-4GlcNAcb1-2(NeuAca2-3/6Galb1- | 3/6Galb1-4(Fuca1-3)GlcNAcb1-2(Galb1-4(Fuca1- |
| 4(Fuca1-3)GlcNAcb1-6)Mana1-6)Manb1- | 3)GlcNAcb1-6)Mana1-6)Manb1-4GlcNAcb1-4GlcNAc |
| 4GlcNAcb1-4(Fuca1-6)GlcNAc | |
| Galb1-4(Fuca1-3)GlcNAcb1-2(Galb1-4(Fuca1- | NeuAca2-3/6Galb1-4(Fuca1-3)GlcNAcb1-2(Galb1- |
| 3)GlcNAcb1-4)Mana1-3(NeuAca2-3/6Galb1- | 4(Fuca1-3)GlcNAcb1-4)Mana1-3(Galb1-4(Fuca1- |
| 4(Fuca1-3)GlcNAcb1-3Galb1-4GlcNAcb1-2(Galb1- | 3)GlcNAcb1-3Galb1-4GlcNAcb1-2(Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | GlcNAcb1-4(Gala1-3Galb1-4(Fuca1-3)GlcNAcb1- |
| 3)GlcNAcb1-2(Galb1-4(Fuca1-3)GlcNAcb1- | 2(Galb1-4GlcNAcb1-4)Mana1-3)(Galb1-4(Fuca1- |
| 4)Mana1-3)(Galb1-4(Fuca1-3)GlcNAcb1-2(Galb1- | 3)GlcNAcb1-2(NeuAca2-3/6Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | Galb1-4GlcNAcb1-3Galb1-4GlcNAcb1-2(Galb1- |
| 3)GlcNAcb1-2(Fuca1-2Galb1-4(Fuca1-3)GlcNAcb1- | 4GlcNAcb1-4)Mana1-3(Galb1-4GlcNAcb1-3Galb1- |
| 4)Mana1-3)(Galb1-4(Fuca1-3)GlcNAcb1-2(Galb1- | 4GlcNAcb1-2(Galb1-4GlcNAcb1-3Galb1-4GlcNAcb1- |
| 4(Fuca1-3)GlcNAcb1-6)Mana1-6)Manb1- | 6)Mana1-6)Manb1-4GlcNAcb1-4(Fuca1-6)GlcNAc |
| 4GlcNAcb1-4GlcNAc | |
| Galb1-4GlcNAcb1-3Galb1-4GlcNAcb1-2(Galb1- | Gala1-3Galb1-4GlcNAcb1-2(Gala1-3Galb1- |
| 4GlcNAcb1-4)Mana1-3(Galb1-4GlcNAcb1-3Galb1- | 4GlcNAcb1-4)Mana1-3(NeuGca2-8NeuGca2- |
| 4GlcNAcb1-2(Galb1-4GlcNAcb1-3Galb1-4GlcNAcb1- | 3/6Galb1-4GlcNAcb1-2(NeuGca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4GlcNAcb1- |
| 2(GlcNAcb1-4)Mana1-3)(NeuGca2-3/6Galb1- | 2(Galb1-4GlcNAcb1-4)Mana1-3)(NeuGca2- |
| 4GlcNAcb1-2(NeuAca2-8NeuGca2-3/6Galb1- | 3/6Galb1-4GlcNAcb1-2(NeuAca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| NeuGca2-3/6Galb1-4GlcNAcb1-2(Galb1-4GlcNAcb1- | GlcNAcb1-4(NeuGca2-3/6Galb1-4(Fuca1- |
| 4)Mana1-3(NeuAca2-3/6Galb1-4GlcNAcb1-3Galb1- | 3)GlcNAcb1-2(Galb1-4GlcNAcb1-4)Mana1- |
| 4GlcNAcb1-2(NeuAca2-3/6Galb1-4GlcNAcb1- | 3)(NeuGca2-3/6Galb1-4GlcNAcb1-2(NeuAca2- |
| 6)Mana1-6)Manb1-4GlcNAcb1-4GlcNAc | 3/6Galb1-4GlcNAcb1-6)Mana1-6)Manb1- |
| | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GlcNAcb1-4)Mana1-3)(NeuGca2- | 3)GlcNAcb1-2(GlcNAcb1-4)Mana1-3)(NeuGca2- |
| 3/6Galb1-4GlcNAcb1-2(NeuGca2-3/6Galb1- | 3/6Galb1-4GlcNAcb1-2(NeuGca2-3/6Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(Gala1-3Galb1-4GlcNAcb1-2(NeuGca2- | GlcNAcb1-4(Gala1-3Galb1-4GlcNAcb1-2(Gala1- |
| 3/6Galb1-4GlcNAcb1-4)Mana1-3)(NeuAca2- | 3Galb1-4GlcNAcb1-4)Mana1-3)(NeuAca2-3/6Galb1- |
| 3/6Galb1-4GlcNAcb1-2(NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4GlcNAcb1- | GlcNAcb1-4(NeuAca2-3/6Galb1-4GlcNAcb1- |
| 2(Gala1-3Galb1-4GlcNAcb1-4)Mana1-3)(Galb1- | 2(Gala1-3Galb1-4GlcNAcb1-4)Mana1-3)(Gala1- |
| 4(Fuca1-3)GlcNAcb1-2(NeuAca2-3/6Galb1- | 3Galb1-4GlcNAcb1-2(NeuAca2-3/6Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(NeuAca2-3/6Galb1-4GlcNAcb1-2(Gala1-3Galb1- | 3)(Galb1-4(Fuca1-3)GlcNAcb1-2(NeuGca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(Gala1-3Galb1-4(Fuca1-3)GlcNAcb1- | Gala1-3Galb1-4GlcNAcb1-2(Galb1-4GlcNAcb1- |
| 2(Galb1-4GlcNAcb1-4)Mana1-3)(NeuGca2- | 4)Mana1-3(NeuAca2-3/6Galb1-4GlcNAcb1-3Galb1- |
| 3/6Galb1-4GlcNAcb1-2(NeuAca2-3/6Galb1- | 4GlcNAcb1-2(NeuAca2-3/6Galb1-4GlcNAcb1- |
| 4(Fuca1-3)GlcNAcb1-6)Mana1-6)Manb1- | 6)Mana1-6)Manb1-4GlcNAcb1-4(Fuca1-6)GlcNAc |
| 4GlcNAcb1-4GlcNAc | |
| GlcNAcb1-4(NeuGca2-3/6Galb1-4(Fuca1- | Galb1-4(Fuca1-3)GlcNAcb1-2(Gala1-3Galb1- |
| 3)GlcNAcb1-2(Galb1-4GlcNAcb1-4)Mana1- | 4GlcNAcb1-4)Mana1-3(NeuAca2-3/6Galb1- |
| 3)(Galb1-4GlcNAcb1-2(NeuGca2-3/6Galb1- | 4GlcNAcb1-3Galb1-4GlcNAcb1-2(NeuAca2- |
| 4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4GlcNAc |
| GlcNAcb1-4(NeuGca2-3/6Galb1-4GlcNAcb1- | NeuGca2-3/6Galb1-4(Fuca1-3)GlcNAcb1-2(Galb1- |
| 2(Galb1-4(Fuca1-3)GlcNAcb1-4)Mana1-3)(Galb1- | 4(Fuca1-3)GlcNAcb1-4)Mana1-3(NeuAca2- |
| 4(Fuca1-3)GlcNAcb1-2(NeuGca2-3/6Galb1- | 3/6Galb1-4GlcNAcb1-3Galb1-4GlcNAcb1-2(Galb1- |
| 4GlcNAcb1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| GlcNAcb1-4(NeuAca2-3/6Galb1-4(Fuca1- | Galb1-4(Fuca1-3)GlcNAcb1-2(Galb1-4(Fuca1- |
| 3)GlcNAcb1-3Galb1-4GlcNAcb1-2(NeuAca2- | 3)GlcNAcb1-4)Mana1-3(NeuGca2-3/6Galb1- |
| 3/6Galb1-4GlcNAcb1-3Galb1-4GlcNAcb1-4)Mana1- | 4(Fuca1-3)GlcNAcb1-3Galb1-4GlcNAcb1-2(Galb1- |
| 3)(Mana1-3(Mana1-6)Mana1-6)Manb1-4GlcNAcb1- | 4(Fuca1-3)GlcNAcb1-6)Mana1-6)Manb1- |
| 4GlcNAc | 4GlcNAcb1-4GlcNAc |
| Fuca1-2Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(NeuAca2-3/6Galb1- | 3)GlcNAcb1-3Galb1-4GlcNAcb1-2(Fuca1-2Galb1- |
| 4GlcNAcb1-3Galb1-4GlcNAcb1-2(Galb1-4(Fuca1- | 4(Fuca1-3)GlcNAcb1-3Galb1-4GlcNAcb1-4)Mana1- |
| 3)GlcNAcb1-6)Mana1-6)Manb1-4GlcNAcb1-4GlcNAc | 3)(Mana1-3(Mana1-6)Mana1-6)Manb1-4GlcNAcb1- |
| | 4GlcNAc |
| GlcNAcb1-4(Gala1-3Galb1-4(Fuca1-3)GlcNAcb1- | Galb1-4(Fuca1-3)GlcNAcb1-2(Gala1-3Galb1- |
| 2(Galb1-4GlcNAcb1-4)Mana1-3)(Galb1-4(Fuca1- | 4GlcNAcb1-4)Mana1-3(NeuAca2-3/6Galb1- |
| 3)GlcNAcb1-2(NeuGca2-3/6Galb1-4(Fuca1- | 4GlcNAcb1-3Galb1-4GlcNAcb1-2(Galb1-4(Fuca1- |
| 3)GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| NeuGca2-3/6Galb1-4(Fuca1-3)GlcNAcb1-2(Galb1- | GlcNAcb1-4(Fuca1-2Galb1-4(Fuca1-3)GlcNAcb1- |
| 4(Fuca1-3)GlcNAcb1-4)Mana1-3(Galb1-4(Fuca1- | 2(Gala1-3Galb1-4GlcNAcb1-4)Mana1-3)(NeuGca2- |
| 3)GlcNAcb1-3Galb1-4GlcNAcb1-2(Galb1- | 3/6Galb1-4(Fuca1-3)GlcNAcb1-2(Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1-4GlcNAc |
| 6)GlcNAc | |
| GlcNAcb1-4(Galb1-4GlcNAcb1-3Galb1-4GlcNAcb1- | GlcNAcb1-4(NeuAca2-3/6Galb1-4(Fuca1- |
| 2(Gala1-3Galb1-4GlcNAcb1-4)Mana1-3)(Galb1- | 3)GlcNAcb1-2(GalNAcb1-4GlcNAcb1-4)Mana1- |
| 4GlcNAcb1-3Galb1-4GlcNAcb1-2(Gala1-3Galb1- | 3)(Galb1-4(Fuca1-3)GlcNAcb1-2(NeuAca2- |
| 4GlcNAcb1-6)Mana1-6)Manb1-4GlcNAcb1-4GlcNAc | 3/6Galb1-4(Fuca1-3)GlcNAcb1-6)Mana1-6)Manb1- |
| | 4GlcNAcb1-4GlcNAc |
| GlcNAcb1-4(NeuAca2-3/6Galb1-4(Fuca1- | GlcNAcb1-4(NeuGca2-3/6Galb1-4GlcNAcb1- |
| 3)GlcNAcb1-2(GalNAcb1-4(Fuca1-3)GlcNAcb1- | 2(GlcNAcb1-4)Mana1-3)(NeuGca2-3/6Galb1- |
| 4)Mana1-3)(Galb1-4(Fuca1-3)GlcNAcb1-2(Galb1- | 4GlcNAcb1-2(NeuGca2-8NeuGca2-3/6Galb1- |
| 4(Fuca1-3)GlcNAcb1-6)Mana1-6)Manb1- | 4GlcNAcb1-6)Mana1-6)Manb1-4GlcNAcb1-4GlcNAc |
| 4GlcNAcb1-4(Fuca1-6)GlcNAc | |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(Galb1-4GlcNAcb1-4)Mana1- | 2(Galb1-4GlcNAcb1-4)Mana1-3)(NeuGca2- |
| 3)(NeuGca2-3/6Galb1-4GlcNAcb1-2(NeuGca2- | 3/6Galb1-4GlcNAcb1-2(NeuGca2-3/6Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuGca2-3/6Galb1-4GlcNAcb1-2(Galb1-4GlcNAcb1- | GlcNAcb1-4(Gala1-3Galb1-4GlcNAcb1-2(NeuGca2- |
| 4)Mana1-3(NeuGca2-3/6Galb1-4GlcNAcb1-3Galb1- | 3/6Galb1-4GlcNAcb1-4)Mana1-3)(NeuGca2- |
| 4GlcNAcb1-2(NeuAca2-3/6Galb1-4GlcNAcb1- | 3/6Galb1-4GlcNAcb1-2(NeuAca2-3/6Galb1- |
| 6)Mana1-6)Manb1-4GlcNAcb1-4GlcNAc | 4GlcNAcb1-6)Mana1-6)Manb1-4GlcNAcb1-4GlcNAc |
| Gala1-3Galb1-4GlcNAcb1-2(Galb1-4GlcNAcb1- | GlcNAcb1-4(Gala1-3Galb1-4GlcNAcb1-2(Gala1- |
| 4)Mana1-3(NeuGca2-3/6Galb1-4GlcNAcb1-3Galb1- | 3Galb1-4GlcNAcb1-4)Mana1-3)(NeuGca2-3/6Galb1- |
| 4GlcNAcb1-2(NeuAca2-3/6Galb1-4GlcNAcb1- | 4GlcNAcb1-2(NeuAca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1-2(Galb1- | Galb1-4(Fuca1-3)GlcNAcb1-2(Gala1-3Galb1- |
| 4(Fuca1-3)GlcNAcb1-4)Mana1-3(NeuGca2- | 4GlcNAcb1-4)Mana1-3(NeuGca2-3/6Galb1- |
| 3/6Galb1-4GlcNAcb1-3Galb1-4GlcNAcb1-2(Galb1- | 4GlcNAcb1-3Galb1-4GlcNAcb1-2(NeuAca2- |
| 4GlcNAcb1-6)Mana1-6)Manb1-4GlcNAcb1-4GlcNAc | 3/6Galb1-4GlcNAcb1-6)Mana1-6)Manb1- |
| | 4GlcNAcb1-4GlcNAc |
| NeuAca2-3/6Galb1-4GlcNAcb1-3Galb1-4GlcNAcb1- | GlcNAcb1-4(NeuGca2-3/6Galb1-4(Fuca1- |
| 2(Gala1-3Galb1-4GlcNAcb1-4)Mana1-3(Gala1- | 3)GlcNAcb1-2(Galb1-4GlcNAcb1-4)Mana1- |
| 3Galb1-4GlcNAcb1-2(NeuAca2-3/6Galb1- | 3)(NeuGca2-3/6Galb1-4GlcNAcb1-2(Gala1-3Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(Gala1-3Galb1-4(Fuca1-3)GlcNAcb1- | GlcNAcb1-4(NeuAca2-3/6Galb1-4(Fuca1- |
| 2(Galb1-4GlcNAcb1-4)Mana1-3)(NeuGca2- | 3)GlcNAcb1-3Galb1-4GlcNAcb1-2(NeuGca2- |
| 3/6Galb1-4GlcNAcb1-2(NeuGca2-3/6Galb1- | 3/6Galb1-4GlcNAcb1-3Galb1-4GlcNAcb1-4)Mana1- |
| 4(Fuca1-3)GlcNAcb1-6)Mana1-6)Manb1- | 3)(Mana1-3(Mana1-6)Mana1-6)Manb1-4GlcNAcb1- |
| 4GlcNAcb1-4GlcNAc | 4GlcNAc |
| Fuca1-2Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3(NeuGca2-3/6Galb1- | 3)GlcNAcb1-3Galb1-4GlcNAcb1-2(Fuca1-2Galb1- |
| 4GlcNAcb1-3Galb1-4GlcNAcb1-2(Galb1-4(Fuca1- | 4(Fuca1-3)GlcNAcb1-3Galb1-4GlcNAcb1-4)Mana1- |
| 3)GlcNAcb1-6)Mana1-6)Manb1-4GlcNAcb1-4GlcNAc | 3)(Mana1-3(Mana1-6)Mana1-6)Manb1-4GlcNAcb1- |
| | 4GlcNAc |
| Galb1-4(Fuca1-3)GlcNAcb1-2(Gala1-3Galb1- | GlcNAcb1-4(Gala1-3Galb1-4GlcNAcb1-3Galb1- |
| 4GlcNAcb1-4)Mana1-3(NeuGca2-3/6Galb1- | 4(Fuca1-3)GlcNAcb1-2(NeuAca2-3/6Galb1- |
| 4GlcNAcb1-3Galb1-4GlcNAcb1-2(Galb1-4(Fuca1- | 4(Fuca1-3)GlcNAcb1-3Galb1-4GlcNAcb1-4)Mana1- |
| 3)GlcNAcb1-6)Mana1-6)Manb1-4GlcNAcb1- | 3)(Mana1-3(Mana1-6)Mana1-6)Manb1-4GlcNAcb1- |
| 4(Fuca1-6)GlcNAc | 4GlcNAc |
| Galb1-4(Fuca1-3)GlcNAcb1-3Galb1-4GlcNAcb1- | Galb1-4(Fuca1-3)GlcNAcb1-3Galb1-4GlcNAcb1- |
| 2(Gala1-3Galb1-4GlcNAcb1-4)Mana1-3(Gala1- | 2(Gala1-3Galb1-4GlcNAcb1-4)Mana1-3(Gala1- |
| 3Galb1-4GlcNAcb1-2(NeuAca2-3/6Galb1-4(Fuca1- | 3Galb1-4GlcNAcb1-2(Fuca1-2Galb1-4(Fuca1- |
| 3)GlcNAcb1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| GlcNAcb1-4(Gala1-3Galb1-4GlcNAcb1-3Galb1- | Galb1-4(Fuca1-3)GlcNAcb1-3Galb1-4(Fuca1- |
| 4(Fuca1-3)GlcNAcb1-2(Fuca1-2Galb1-4(Fuca1- | 3)GlcNAcb1-2(Gala1-3Galb1-4GlcNAcb1-4)Mana1- |
| 3)GlcNAcb1-3Galb1-4(Fuca1-3)GlcNAcb1-4)Mana1- | 3(Gala1-3Galb1-4GlcNAcb1-2(Fuca1-2Galb1- |
| 3)(Mana1-3(Mana1-6)Mana1-6)Manb1-4GlcNAcb1- | 4(Fuca1-3)GlcNAcb1-6)Mana1-6)Manb1- |
| 4GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GalNAcb1-4GlcNAcb1-4)Mana1- | 3)GlcNAcb1-2(GalNAcb1-4(Fuca1-3)GlcNAcb1- |
| 3)(Galb1-4(Fuca1-3)GlcNAcb1-2(NeuAca2- | 4)Mana1-3)(Galb1-4(Fuca1-3)GlcNAcb1-2(Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(Gala1-3Galb1-4GlcNAcb1-2(NeuGca2- | NeuGca2-3/6Galb1-4GlcNAcb1-2(Galb1-4GlcNAcb1- |
| 3/6Galb1-4GlcNAcb1-4)Mana1-3)(NeuGca2- | 4)Mana1-3(NeuGca2-3/6Galb1-4GlcNAcb1-3Galb1- |
| 3/6Galb1-4GlcNAcb1-2(NeuGca2-3/6Galb1- | 4GlcNAcb1-2(NeuGca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4GlcNAc |
| GlcNAcb1-4(NeuGca2-3/6Galb1-4(Fuca1- | Gala1-3Galb1-4GlcNAcb1-2(Galb1-4GlcNAcb1- |
| 3)GlcNAcb1-3Galb1-4GlcNAcb1-2(NeuGca2- | 4)Mana1-3(NeuGca2-3/6Galb1-4GlcNAcb1-3Galb1- |
| 3/6Galb1-4GlcNAcb1-3Galb1-4GlcNAcb1-4)Mana1- | 4GlcNAcb1-2(NeuGca2-3/6Galb1-4GlcNAcb1- |
| 3)(Mana1-3(Mana1-6)Mana1-6)Manb1-4GlcNAcb1- | 6)Mana1-6)Manb1-4GlcNAcb1-4(Fuca1-6)GlcNAc |
| 4GlcNAc | |
| GlcNAcb1-4(Gala1-3Galb1-4GlcNAcb1-2(Gala1- | Galb1-4(Fuca1-3)GlcNAcb1-2(Gala1-3Galb1- |
| 3Galb1-4GlcNAcb1-4)Mana1-3)(NeuGca2-3/6Galb1- | 4GlcNAcb1-4)Mana1-3(NeuGca2-3/6Galb1- |
| 4GlcNAcb1-2(NeuGca2-3/6Galb1-4GlcNAcb1- | 4GlcNAcb1-3Galb1-4GlcNAcb1-2(NeuGca2- |
| 6)Mana1-6)Manb1-4GlcNAcb1-4(Fuca1-6)GlcNAc | 3/6Galb1-4GlcNAcb1-6)Mana1-6)Manb1- |
| | 4GlcNAcb1-4GlcNAc |
| NeuGca2-3/6Galb1-4GlcNAcb1-3Galb1-4GlcNAcb1- | NeuAca2-3/6Galb1-4(Fuca1-3)GlcNAcb1-3Galb1- |
| 2(Gala1-3Galb1-4GlcNAcb1-4)Mana1-3(Gala1- | 4GlcNAcb1-2(Gala1-3Galb1-4GlcNAcb1-4)Mana1- |
| 3Galb1-4GlcNAcb1-2(NeuAca2-3/6Galb1- | 3(Gala1-3Galb1-4GlcNAcb1-2(Gala1-3Galb1- |
| 4GlcNAcb1-6)Mana1-6)Manb1-4GlcNAcb1-4GlcNAc | 4GlcNAcb1-6)Mana1-6)Manb1-4GlcNAcb1-4GlcNAc |
| GlcNAcb1-4(Gala1-3Galb1-4GlcNAcb1-3Galb1- | NeuAca2-3/6Galb1-4GlcNAcb1-3Galb1-4GlcNAcb1- |
| 4(Fuca1-3)GlcNAcb1-2(NeuGca2-3/6Galb1- | 2(Gala1-3Galb1-4GlcNAcb1-4)Mana1-3(Gala1- |
| 4(Fuca1-3)GlcNAcb1-3Galb1-4GlcNAcb1-4)Mana1- | 3Galb1-4GlcNAcb1-2(Gala1-3Galb1-4GlcNAcb1- |
| 3)(Mana1-3(Mana1-6)Mana1-6)Manb1-4GlcNAcb1- | 6)Mana1-6)Manb1-4GlcNAcb1-4(Fuca1-6)GlcNAc |
| 4GlcNAc | |
| Galb1-4(Fuca1-3)GlcNAcb1-3Galb1-4GlcNAcb1- | Galb1-4(Fuca1-3)GlcNAcb1-3Galb1-4(Fuca1- |
| 2(Gala1-3Galb1-4GlcNAcb1-4)Mana1-3(Gala1- | 3)GlcNAcb1-2(Gala1-3Galb1-4GlcNAcb1-4)Mana1- |
| 3Galb1-4GlcNAcb1-2(NeuGca2-3/6Galb1-4(Fuca1- | 3(Gala1-3Galb1-4GlcNAcb1-2(Gala1-3Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuAca2-3/6Galb1-4GlcNAcb1- | GlcNAcb1-4(NeuGca2-3/6Galb1-4(Fuca1- |
| 2(Galb1-4GlcNAcb1-4)Mana1-3)(NeuAca2- | 3)GlcNAcb1-2(GalNAcb1-4GlcNAcb1-4)Mana1- |
| 3/6Galb1-4GlcNAcb1-3Galb1-4GlcNAcb1-2(Galb1- | 3)(Galb1-4(Fuca1-3)GlcNAcb1-2(NeuGca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4(Fuca1-3)GlcNAcb1- | 3)GlcNAcb1-2(Galb1-4(Fuca1-3)GlcNAcb1- |
| 4)Mana1-3)(Galb1-4GlcNAcb1-3Galb1-4GlcNAcb1- | 4)Mana1-3)(Galb1-4(Fuca1-3)GlcNAcb1-3Galb1- |
| 2(Galb1-4GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| NeuGca2-3/6Galb1-4GlcNAcb1-3Galb1-4GlcNAcb1- | NeuGca2-3/6Galb1-4GlcNAcb1-3Galb1-4GlcNAcb1- |
| 2(Gala1-3Galb1-4GlcNAcb1-4)Mana1-3(Gala1- | 2(Gala1-3Galb1-4GlcNAcb1-4)Mana1-3(Gala1- |
| 3Galb1-4GlcNAcb1-2(NeuGca2-3/6Galb1- | 3Galb1-4GlcNAcb1-2(Gala1-3Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4(Fuca1-3)GlcNAcb1-3Galb1- | NeuAca2-6Galb1-4GlcNAcb1-2(NeuAca2-3Galb1- |
| 4GlcNAcb1-2(Gala1-3Galb1-4GlcNAcb1-4)Mana1- | 4GlcNAcb1-4)Mana1-3(NeuAca2-6Galb1- |
| 3(Gala1-3Galb1-4GlcNAcb1-2(Gala1-3Galb1- | 4GlcNAcb1-2(NeuAca2-3Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAcb |
| NeuAca2-6Galb1-4GlcNAcb1-2(NeuAca2-3Galb1- | NeuAca2-3/6Galb1-4GlcNAcb1-2(NeuAca2- |
| 4GlcNAcb1-4)Mana1-3(NeuAca2-6Galb1- | 3/6Galb1-4GlcNAcb1-4)Mana1-3(NeuAca2- |
| 4GlcNAcb1-2(NeuAca2-3Galb1-4(Fuca1- | 3/6Galb1-4GlcNAcb1-2(NeuAca2-3/6Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-6)Mana1-3(NeuAca2-3Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-3Galb1-4GlcNAcb1-2(NeuAca2-3Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAcb | 6)Mana1-6)Manb1-4GlcNAcb1-4(Fuca1-6)GlcNAc |
| NeuAca2-6Galb1-4GlcNAcb1-2(NeuAca2-6Galb1- | NeuAca2-3Galb1-4GlcNAcb1-2(NeuAca2-6Galb1- |
| 4GlcNAcb1-6)Mana1-3(NeuAca2-6Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-6Galb1-4GlcNAcb1- |
| 4)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-6Galb1-4GlcNAcb1-2(NeuAca2-6Galb1- | NeuAca2-3Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-6Galb1- |
| 4GlcNAcb1-2(NeuAca2-6Galb1-4GlcNAcb1- | 4GlcNAcb1-2(NeuAca2-6Galb1-4GlcNAcb1- |
| 4)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-6)Mana1-3(NeuAca2-3Galb1- | 4GlcNAcb1-4)Mana1-3(NeuAca2-3Galb1- |
| 4GlcNAcb1-2(NeuAca2-3Galb1-4GlcNAcb1- | 4GlcNAcb1-2(NeuAca2-6Galb1-4GlcNAcb1- |
| 4)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3Galb1-4GlcNAcb1-2(NeuAca2-3Galb1- | NeuAca2-6Galb1-4GlcNAcb1-2(NeuAca2-3Galb1- |
| 4GlcNAcb1-6)Mana1-3(NeuAca2-3Galb1- | 4GlcNAcb1-6)Mana1-3(NeuAca2-3Galb1- |
| 4GlcNAcb1-2(NeuAca2-6Galb1-4GlcNAcb1- | 4GlcNAcb1-2(NeuAca2-6Galb1-4GlcNAcb1- |
| 4)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-6Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-3Galb1-4GlcNAcb1-2(NeuAca2-3Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-6)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-6Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAcb |
| NeuAca2-6Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-6Galb1- | 4GlcNAcb1-4)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3Galb1-4GlcNAcb1-2(NeuAca2-6Galb1- | NeuAca2-6Galb1-4GlcNAcb1-2(NeuAca2-3Galb1- |
| 4GlcNAcb1-4)Mana1-3(NeuAca2-3Galb1- | 4GlcNAcb1-6)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-3Galb1-4GlcNAcb1-2(NeuAca2-6Galb1- | NeuAca2-3Galb1-4GlcNAcb1-2(NeuAca2-6Galb1- |
| 4GlcNAcb1-4)Mana1-3(NeuAca2-3Galb1- | 4GlcNAcb1-6)Mana1-3(NeuAca2-6Galb1- |
| 4GlcNAcb1-2(NeuAca2-3Galb1-4GlcNAcb1- | 4GlcNAcb1-2(NeuAca2-6Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-6Galb1- | NeuAca2-6Galb1-4GlcNAcb1-2(NeuAca2-6Galb1- |
| 4GlcNAcb1-4)Mana1-3(NeuAca2-3Galb1- | 4GlcNAcb1-6)Mana1-3(NeuAca2-3Galb1- |
| 4GlcNAcb1-2(NeuAca2-3Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-6Galb1- | NeuAca2-3Galb1-3GlcNAcb1-2(NeuAca2-3Galb1- |
| 4GlcNAcb1-4)Mana1-3(NeuAca2-6Galb1- | 3GlcNAcb1-4)Mana1-3(NeuAca2-3Galb1- |
| 4GlcNAcb1-2(NeuAca2-3Galb1-4GlcNAcb1- | 3GlcNAcb1-2(NeuAca2-3Galb1-3GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAcb |
| NeuAca2-3Galb1-4GlcNAcb1-2(NeuAca2-3Galb1- | NeuAca2-3Galb1-4GlcNAcb1-2(NeuAca2-3Galb1- |
| 3GlcNAcb1-4)Mana1-3(NeuAca2-3Galb1- | 4GlcNAcb1-4)Mana1-3(NeuAca2-6Galb1- |
| 3GlcNAcb1-2(NeuAca2-3Galb1-3GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3Galb1-4GlcNAcb1-2(NeuAca2-6Galb1- | NeuAca2-3Galb1-4GlcNAcb1-2(NeuAca2-6Galb1- |
| 4GlcNAcb1-6)Mana1-3(NeuAca2-3Galb1- | 4GlcNAcb1-6)Mana1-3(NeuAca2-3Galb1- |
| 4GlcNAcb1-2(NeuAca2-3Galb1-4GlcNAcb1- | 4GlcNAcb1-2(NeuAca2-6Galb1-4GlcNAcb1- |
| 4)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-6Galb1-4GlcNAcb1-2(NeuAca2-3Galb1- | NeuAca2-6Galb1-4GlcNAcb1-2(NeuAca2-6Galb1- |
| 4GlcNAcb1-4)Mana1-3(NeuAca2-3Galb1- | 4GlcNAcb1-6)Mana1-3(NeuAca2-6Galb1- |
| 4GlcNAcb1-2(NeuAca2-6Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAc | 4)Mana1-6)Manb1-4GlcNAcb1-4(Fuca1-6)GlcNAc |
| NeuAca2-3Galb1-4GlcNAcb1-2(NeuAca2-3Galb1- | NeuAca2-3Galb1-3GlcNAcb1-2(NeuAca2-3Galb1- |
| 4GlcNAcb1-4)Mana1-3(NeuAca2-3Galb1- | 3GlcNAcb1-4)Mana1-3(NeuAca2-3Galb1- |
| 4GlcNAcb1-2(NeuAca2-3Galb1-4GlcNAcb1- | 3GlcNAcb1-2(NeuAca2-3Galb1-3GlcNAcb1- |
| 4)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3/6Galb1-4(Fuca1-3)GlcNAcb1-2(Galb1- | NeuAca2-3/6Galb1-4(Fuca1-3)GlcNAcb1-2(Galb1- |
| 4GlcNAcb1-4)Mana1-3(NeuAca2-3/6Galb1- | 4GlcNAcb1-4)Mana1-3(NeuAca2-3/6Galb1-4(Fuca1- |
| 4GlcNAcb1-2(NeuAca2-3/6Galb1-4(Fuca1- | 3)GlcNAcb1-2(NeuAca2-3/6Galb1-4(Fuca1- |
| 3)GlcNAcb1-6)Mana1-6)Manb1-4GlcNAcb1- | 3)GlcNAcb1-6)Mana1-6)Manb1-4GlcNAcb1-4GlcNAc |
| 4(Fuca1-6)GlcNAc | |
| GlcNAcb1-4(Gala1-3Galb1-4GlcNAcb1-2(Galb1- | GlcNAcb1-4(NeuGca2-3/6Galb1-4GlcNAcb1- |
| 4GlcNAcb1-4)Mana1-3)(NeuAca2-3/6Galb1- | 2(Galb1-4GlcNAcb1-4)Mana1-3)(NeuAca2- |
| 4GlcNAcb1-3Galb1-4GlcNAcb1-2(NeuAca2- | 3/6Galb1-4GlcNAcb1-3Galb1-4GlcNAcb1-2(Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuAca2-3/6Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3(Galb1-4(Fuca1- | 3)GlcNAcb1-2(Galb1-4(Fuca1-3)GlcNAcb1- |
| 3)GlcNAcb1-2(NeuAca2-3/6Galb1-4(Fuca1- | 4)Mana1-3)(Galb1-4(Fuca1-3)GlcNAcb1-3Galb1- |
| 3)GlcNAcb1-6)Mana1-6)Manb1-4GlcNAcb1- | 4GlcNAcb1-2(Galb1-4GlcNAcb1-6)Mana1-6)Manb1- |
| 4(Fuca1-6)GlcNAc | 4GlcNAcb1-4GlcNAc |
| GlcNAcb1-4(Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3)(NeuAca2-3/6Galb1- | 3)GlcNAcb1-2(Galb1-4(Fuca1-3)GlcNAcb1- |
| 4GlcNAcb1-3Galb1-4GlcNAcb1-2(Galb1-4GlcNAcb1- | 4)Mana1-3)(Galb1-4GlcNAcb1-3Galb1-4GlcNAcb1- |
| 6)Mana1-6)Manb1-4GlcNAcb1-4(Fuca1-6)GlcNAc | 2(Galb1-4GlcNAcb1-6)Mana1-6)Manb1-4GlcNAcb1- |
| | 4(Fuca1-6)GlcNAc |
| GlcNAcb1-4(Galb1-4(Fuca1-3)GlcNAcb1-2(Gala1- | NeuAca2-3/6Galb1-4GlcNAcb1-2(NeuGca2- |
| 3Galb1-4GlcNAcb1-4)Mana1-3)(NeuAca2-3/6Galb1- | 3/6Galb1-4GlcNAcb1-4)Mana1-3(NeuAca2- |
| 4GlcNAcb1-3Galb1-4GlcNAcb1-2(Galb1-4(Fuca1- | 3/6Galb1-4GlcNAcb1-2(NeuAca2-3/6Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| NeuAca2-3/6Galb1-4(Fuca1-3)GlcNAcb1- | NeuGca2-3/6Galb1-4(Fuca1-3)GlcNAcb1-2(Galb1- |
| 2(NeuAca2-3/6Galb1-4GlcNAcb1-4)Mana1- | 4GlcNAcb1-4)Mana1-3(NeuAca2-3/6Galb1-4(Fuca1- |
| 3(NeuAca2-3/6Galb1-4GlcNAcb1-2(Gala1-3Galb1- | 3)GlcNAcb1-2(NeuAca2-3/6Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1-4GlcNAc |
| 6)GlcNAc | |
| NeuGca2-3/6Galb1-4(Fuca1-3)GlcNAcb1-2(Galb1- | Gala1-3Galb1-4(Fuca1-3)GlcNAcb1-2(NeuAca2- |
| 4GlcNAcb1-4)Mana1-3(NeuAca2-3/6Galb1- | 3/6Galb1-4GlcNAcb1-4)Mana1-3(NeuAca2- |
| 4GlcNAcb1-2(NeuAca2-3/6Galb1-4(Fuca1- | 3/6Galb1-4GlcNAcb1-2(NeuAca2-3/6Galb1- |
| 3)GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| GlcNAcb1-4(Gala1-3Galb1-4GlcNAcb1-2(Galb1- | GlcNAcb1-4(NeuGca2-3/6Galb1-4GlcNAcb1- |
| 4GlcNAcb1-4)Mana1-3)(NeuGca2-3/6Galb1- | 2(Galb1-4GlcNAcb1-4)Mana1-3)(NeuGca2- |
| 4GlcNAcb1-3Galb1-4GlcNAcb1-2(NeuAca2- | 3/6Galb1-4GlcNAcb1-3Galb1-4GlcNAcb1-2(Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| Fuca1-2Galb1-4(Fuca1-3)GlcNAcb1-2(Gala1- | Gala1-3Galb1-4(Fuca1-3)GlcNAcb1-2(Galb1- |
| 3Galb1-4GlcNAcb1-4)Mana1-3(NeuAca2-3/6Galb1- | 4GlcNAcb1-4)Mana1-3(NeuAca2-3/6Galb1-4(Fuca1- |
| 4(Fuca1-3)GlcNAcb1-2(NeuAca2-3/6Galb1- | 3)GlcNAcb1-2(NeuAca2-3/6Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| NeuGca2-3/6Galb1-4(Fuca1-3)GlcNAcb1-2(Galb1- | GlcNAcb1-4(Galb1-4(Fuca1-3)GlcNAcb1-2(Gala1- |
| 4(Fuca1-3)GlcNAcb1-4)Mana1-3(Galb1-4(Fuca1- | 3Galb1-4GlcNAcb1-4)Mana1-3)(NeuGca2-3/6Galb1- |
| 3)GlcNAcb1-2(NeuAca2-3/6Galb1-4(Fuca1- | 4GlcNAcb1-3Galb1-4GlcNAcb1-2(Galb1-4(Fuca1- |
| 3)GlcNAcb1-6)Mana1-6)Manb1-4GlcNAcb1- | 3)GlcNAcb1-6)Mana1-6)Manb1-4GlcNAcb1-4GlcNAc |
| 4(Fuca1-6)GlcNAc | |
| GlcNAcb1-4(Galb1-4GlcNAcb1-3Galb1-4GlcNAcb1- | GlcNAcb1-4(Galb1-4(Fuca1-3)GlcNAcb1-2(Gala1- |
| 2(Gala1-3Galb1-4GlcNAcb1-4)Mana1-3)(Gala1- | 3Galb1-4GlcNAcb1-4)Mana1-3)(NeuGca2-3/6Galb1- |
| 3Galb1-4GlcNAcb1-2(NeuAca2-3/6Galb1- | 4GlcNAcb1-3Galb1-4GlcNAcb1-2(Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-4(Galb1-4(Fuca1-3)GlcNAcb1-3Galb1- | GlcNAcb1-4(Galb1-4(Fuca1-3)GlcNAcb1-3Galb1- |
| 4GlcNAcb1-2(Gala1-3Galb1-4GlcNAcb1-4)Mana1- | 4GlcNAcb1-2(Gala1-3Galb1-4GlcNAcb1-4)Mana1- |
| 3)(Gala1-3Galb1-4GlcNAcb1-2(Galb1-4(Fuca1- | 3)(Gala1-3Galb1-4GlcNAcb1-2(Fuca1-2Galb1- |
| 3)GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| NeuGca2-3/6Galb1-4GlcNAcb1-2(NeuGca2- | NeuGca2-3/6Galb1-4(Fuca1-3)GlcNAcb1-2(Galb1- |
| 3/6Galb1-4GlcNAcb1-4)Mana1-3(NeuAca2- | 4GlcNAcb1-4)Mana1-3(NeuGca2-3/6Galb1- |
| 3/6Galb1-4GlcNAcb1-2(NeuAca2-3/6Galb1- | 4(Fuca1-3)GlcNAcb1-2(NeuAca2-3/6Galb1- |
| 4GlcNAcb1-6)Mana1-6)Manb1-4GlcNAcb1-4(Fuca1- | 4(Fuca1-3)GlcNAcb1-6)Mana1-6)Manb1- |
| 6)GlcNAc | 4GlcNAcb1-4GlcNAc |
| Gala1-3Galb1-4(Fuca1-3)GlcNAcb1-2(NeuGca2- | Gala1-3Galb1-4GlcNAcb1-2(Gala1-3Galb1- |
| 3/6Galb1-4GlcNAcb1-4)Mana1-3(NeuAca2- | 4GlcNAcb1-4)Mana1-3(NeuAca2-8NeuAca2- |
| 3/6Galb1-4GlcNAcb1-2(NeuAca2-3/6Galb1- | 3/6Galb1-4GlcNAcb1-2(NeuAca2-3/6Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuAca2-3/6Galb1-4(Fuca1-3)GlcNAcb1- | NeuAca2-8NeuAca2-3/6Galb1-4GlcNAcb1-3Galb1- |
| 2(NeuGca2-3/6Galb1-4GlcNAcb1-4)Mana1- | 4GlcNAcb1-2(NeuAca2-3/6Galb1-4(Fuca1- |
| 3(NeuAca2-3/6Galb1-4GlcNAcb1-2(Gala1-3Galb1- | 3)GlcNAcb1-3Galb1-4GlcNAcb1-4)Mana1-3(Mana1- |
| 4GlcNAcb1-6)Mana1-6)Manb1-4GlcNAcb1-4(Fuca1- | 3(Mana1-6)Mana1-6)Manb1-4GlcNAcb1-4GlcNAc |
| 6)GlcNAc | |
| NeuGca2-3/6Galb1-4(Fuca1-3)GlcNAcb1-2(Galb1- | GlcNAcb1-4(Gala1-3Galb1-4GlcNAcb1-2(Galb1- |
| 4GlcNAcb1-4)Mana1-3(NeuGca2-3/6Galb1- | 4GlcNAcb1-4)Mana1-3)(NeuGca2-3/6Galb1- |
| 4GlcNAcb1-2(NeuAca2-3/6Galb1-4(Fuca1- | 4GlcNAcb1-3Galb1-4GlcNAcb1-2(NeuGca2- |
| 3)GlcNAcb1-6)Mana1-6)Manb1-4GlcNAcb1- | 3/6Galb1-4GlcNAcb1-6)Mana1-6)Manb1- |
| 4(Fuca1-6)GlcNAc | 4GlcNAcb1-4GlcNAc |
| Fuca1-2Galb1-4(Fuca1-3)GlcNAcb1-2(Gala1- | NeuAca2-3/6Galb1-4(Fuca1-3)GlcNAcb1-3Galb1- |
| 3Galb1-4GlcNAcb1-4)Mana1-3(NeuGca2-3/6Galb1- | 4(Fuca1-3)GlcNAcb1-2(NeuAca2-3/6Galb1- |
| 4(Fuca1-3)GlcNAcb1-2(NeuAca2-3/6Galb1- | 4(Fuca1-3)GlcNAcb1-3Galb1-4GlcNAcb1-4)Mana1- |
| 4(Fuca1-3)GlcNAcb1-6)Mana1-6)Manb1- | 3(Mana1-3(Mana1-6)Mana1-6)Manb1-4GlcNAcb1- |
| 4GlcNAcb1-4GlcNAc | 4GlcNAc |
| NeuAca2-3/6Galb1-4(Fuca1-3)GlcNAcb1-3Galb1- | Gala1-3Galb1-4(Fuca1-3)GlcNAcb1-2(Galb1- |
| 4GlcNAcb1-2(NeuAca2-3/6Galb1-4(Fuca1- | 4GlcNAcb1-4)Mana1-3(NeuGca2-3/6Galb1- |
| 3)GlcNAcb1-3Galb1-4GlcNAcb1-4)Mana1-3(Mana1- | 4(Fuca1-3)GlcNAcb1-2(NeuAca2-3/6Galb1- |
| 3(Mana1-6)Mana1-6)Manb1-4GlcNAcb1-4(Fuca1- | 4(Fuca1-3)GlcNAcb1-6)Mana1-6)Manb1- |
| 6)GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(Galb1-4GlcNAcb1-3Galb1-4GlcNAcb1- |
| 4(Fuca1-3)GlcNAcb1-4)Mana1-3(Galb1-4(Fuca1- | 2(Gala1-3Galb1-4GlcNAcb1-4)Mana1-3)(Gala1- |
| 3)GlcNAcb1-2(NeuGca2-3/6Galb1-4(Fuca1- | 3Galb1-4GlcNAcb1-2(NeuGca2-3/6Galb1- |
| 3)GlcNAcb1-6)Mana1-6)Manb1-4GlcNAcb1- | 4GlcNAcb1-6)Mana1-6)Manb1-4GlcNAcb1-4(Fuca1- |
| 4(Fuca1-6)GlcNAc | 6)GlcNAc |
| GlcNAcb1-4(NeuAca2-3/6Galb1-4GlcNAcb1-3Galb1- | NeuAca2-3/6Galb1-4(Fuca1-3)GlcNAcb1-3Galb1- |
| 4GlcNAcb1-2(Gala1-3Galb1-4GlcNAcb1-4)Mana1- | 4(Fuca1-3)GlcNAcb1-2(Galb1-4(Fuca1-3)GlcNAcb1- |
| 3)(Gala1-3Galb1-4GlcNAcb1-2(Gala1-3Galb1- | 3Galb1-4(Fuca1-3)GlcNAcb1-4)Mana1-3(Mana1- |
| 4GlcNAcb1-6)Mana1-6)Manb1-4GlcNAcb1-4GlcNAc | 3(Mana1-6)Mana1-6)Manb1-4GlcNAcb1-4(Fuca1- |
| | 6)GlcNAc |
| GlcNAcb1-4(Galb1-4(Fuca1-3)GlcNAcb1-3Galb1- | GlcNAcb1-4(Galb1-4(Fuca1-3)GlcNAcb1-3Galb1- |
| 4(Fuca1-3)GlcNAcb1-2(Gala1-3Galb1-4GlcNAcb1- | 4GlcNAcb1-2(Gala1-3Galb1-4GlcNAcb1-4)Mana1- |
| 4)Mana1-3)(Gala1-3Galb1-4GlcNAcb1-2(Gala1- | 3)(Gala1-3Galb1-4GlcNAcb1-2(Gala1-3Galb1- |
| 3Galb1-4GlcNAcb1-6)Mana1-6)Manb1-4GlcNAcb1- | 4GlcNAcb1-6)Mana1-6)Manb1-4GlcNAcb1-4(Fuca1- |
| 4GlcNAc | 6)GlcNAc |
| GlcNAcb1-4(NeuAca2-3/6Galb1-4GlcNAcb1- | NeuAca2-3/6Galb1-4(Fuca1-3)GlcNAcb1- |
| 2(GlcNAcb1-4)Mana1-3)(NeuAca2-3/6Galb1- | 2(GalNAcb1-4GlcNAcb1-4)Mana1-3(NeuAca2- |
| 4GlcNAcb1-2(NeuAca2-8NeuAca2-3/6Galb1- | 3/6Galb1-4(Fuca1-3)GlcNAcb1-2(NeuAca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(NeuAca2-3/6Galb1-4(Fuca1- | NeuAca2-3/6Galb1-4(Fuca1-3)GlcNAcb1- |
| 3)GlcNAcb1-2(GlcNAcb1-4)Mana1-3)(NeuAca2- | 2(GalNAcb1-4(Fuca1-3)GlcNAcb1-4)Mana1- |
| 3/6Galb1-4GlcNAcb1-2(NeuAca2-3/6Galb1- | 3(Galb1-4(Fuca1-3)GlcNAcb1-2(NeuAca2- |
| 4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4GlcNAcb1-2(NeuGca2- | NeuAca2-8NeuAca2-3/6Galb1-4GlcNAcb1-3Galb1- |
| 3/6Galb1-4GlcNAcb1-4)Mana1-3(NeuGca2- | 4GlcNAcb1-2(NeuGca2-3/6Galb1-4(Fuca1- |
| 3/6Galb1-4GlcNAcb1-2(NeuAca2-3/6Galb1- | 3)GlcNAcb1-3Galb1-4GlcNAcb1-4)Mana1-3(Mana1- |
| 4GlcNAcb1-6)Mana1-6)Manb1-4GlcNAcb1-4(Fuca1- | 3(Mana1-6)Mana1-6)Manb1-4GlcNAcb1-4GlcNAc |
| 6)GlcNAc | |
| NeuGca2-3/6Galb1-4(Fuca1-3)GlcNAcb1- | NeuGca2-3/6Galb1-4(Fuca1-3)GlcNAcb1-2(Galb1- |
| 2(NeuGca2-3/6Galb1-4GlcNAcb1-4)Mana1- | 4GlcNAcb1-4)Mana1-3(NeuGca2-3/6Galb1- |
| 3(NeuAca2-3/6Galb1-4GlcNAcb1-2(Gala1-3Galb1- | 4GlcNAcb1-2(NeuGca2-3/6Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1- |
| 6)GlcNAc | 4(Fuca1-6)GlcNAc |
| Gala1-3Galb1-4(Fuca1-3)GlcNAcb1-2(NeuGca2- | Gala1-3Galb1-4GlcNAcb1-2(Gala1-3Galb1- |
| 3/6Galb1-4GlcNAcb1-4)Mana1-3(NeuGca2- | 4GlcNAcb1-4)Mana1-3(NeuAca2-8NeuGca2- |
| 3/6Galb1-4GlcNAcb1-2(NeuAca2-3/6Galb1- | 3/6Galb1-4GlcNAcb1-2(NeuAca2-3/6Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| NeuGca2-3/6Galb1-4(Fuca1-3)GlcNAcb1-2(Galb1- | NeuAca2-3/6Galb1-4(Fuca1-3)GlcNAcb1-3Galb1- |
| 4GlcNAcb1-4)Mana1-3(NeuGca2-3/6Galb1- | 4GlcNAcb1-2(NeuGca2-3/6Galb1-4(Fuca1- |
| 4(Fuca1-3)GlcNAcb1-2(NeuGca2-3/6Galb1- | 3)GlcNAcb1-3Galb1-4GlcNAcb1-4)Mana1-3(Mana1- |
| 4(Fuca1-3)GlcNAcb1-6)Mana1-6)Manb1- | 3(Mana1-6)Mana1-6)Manb1-4GlcNAcb1-4(Fuca1- |
| 4GlcNAcb1-4GlcNAc | 6)GlcNAc |
| Fuca1-2Galb1-4(Fuca1-3)GlcNAcb1-2(Gala1- | Gala1-3Galb1-4(Fuca1-3)GlcNAcb1-2(Galb1- |
| 3Galb1-4GlcNAcb1-4)Mana1-3(NeuGca2-3/6Galb1- | 4GlcNAcb1-4)Mana1-3(NeuGca2-3/6Galb1- |
| 4(Fuca1-3)GlcNAcb1-2(NeuGca2-3/6Galb1- | 4(Fuca1-3)GlcNAcb1-2(NeuGca2-3/6Galb1- |
| 4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| NeuAca2-3/6Galb1-4(Fuca1-3)GlcNAcb1-3Galb1- | GlcNAcb1-4(NeuGca2-3/6Galb1-4GlcNAcb1-3Galb1- |
| 4(Fuca1-3)GlcNAcb1-2(NeuGca2-3/6Galb1- | 4GlcNAcb1-2(Gala1-3Galb1-4GlcNAcb1-4)Mana1- |
| 4(Fuca1-3)GlcNAcb1-3Galb1-4GlcNAcb1-4)Mana1- | 3)(Gala1-3Galb1-4GlcNAcb1-2(Gala1-3Galb1- |
| 3(Mana1-3(Mana1-6)Mana1-6)Manb1-4GlcNAcb1- | 4GlcNAcb1-6)Mana1-6)Manb1-4GlcNAcb1-4GlcNAc |
| 4GlcNAc | |
| NeuGca2-3/6Galb1-4(Fuca1-3)GlcNAcb1-3Galb1- | GlcNAcb1-4(NeuAca2-3/6Galb1-4GlcNAcb1- |
| 4(Fuca1-3)GlcNAcb1-2(Galb1-4(Fuca1-3)GlcNAcb1- | 2(NeuAca2-3/6Galb1-4GlcNAcb1-4)Mana1- |
| 3Galb1-4(Fuca1-3)GlcNAcb1-4)Mana1-3(Mana1- | 3)(NeuAca2-3/6Galb1-4GlcNAcb1-2(NeuAca2- |
| 3(Mana1-6)Mana1-6)Manb1-4GlcNAcb1-4(Fuca1- | 3/6Galb1-4GlcNAcb1-6)Mana1-6)Manb1- |
| 6)GlcNAc | 4GlcNAcb1-4GlcNAc |
| GlcNAcb1-4(NeuGca2-3/6Galb1-4GlcNAcb1- | NeuGca2-3/6Galb1-4(Fuca1-3)GlcNAcb1- |
| 2(GlcNAcb1-4)Mana1-3)(NeuAca2-3/6Galb1- | 2(GalNAcb1-4GlcNAcb1-4)Mana1-3(NeuAca2- |
| 4GlcNAcb1-2(NeuAca2-8NeuAca2-3/6Galb1- | 3/6Galb1-4(Fuca1-3)GlcNAcb1-2(NeuAca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GlcNAcb1-4)Mana1-3)(NeuAca2- |
| 3)(NeuAca2-3/6Galb1-4GlcNAcb1-2(NeuAca2- | 3/6Galb1-4GlcNAcb1-2(NeuAca2-3/6Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(NeuAca2-3/6Galb1-4GlcNAcb1-2(NeuAca2- | 3)(Galb1-4(Fuca1-3)GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(Galb1-4(Fuca1-3)GlcNAcb1- |
| 3(Galb1-4(Fuca1-3)GlcNAcb1-2(NeuAca2- | 4)Mana1-3)(Galb1-4(Fuca1-3)GlcNAcb1- |
| 3/6Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4GlcNAc |
| GlcNAcb1-4(NeuAca2-3/6Galb1-4(Fuca1- | NeuGca2-3/6Galb1-4GlcNAcb1-2(NeuGca2- |
| 3)GlcNAcb1-2(Fuca1-2Galb1-4(Fuca1-3)GlcNAcb1- | 3/6Galb1-4GlcNAcb1-4)Mana1-3(NeuGca2- |
| 4)Mana1-3)(Galb1-4(Fuca1-3)GlcNAcb1-2(Galb1- | 3/6Galb1-4GlcNAcb1-2(NeuGca2-3/6Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| NeuGca2-6/3Galb1-4GlcNAcb1-2(NeuGca2- | Gala1-3Galb1-4(Fuca1-3)GlcNAcb1-2(NeuGca2- |
| 6/3Galb1-4GlcNAcb1-4)Mana1-3(NeuGca2- | 3/6Galb1-4GlcNAcb1-4)Mana1-3(NeuGca2- |
| 6/3Galb1-4GlcNAcb1-2(NeuGca2-6/3Galb1- | 3/6Galb1-4GlcNAcb1-2(NeuGca2-3/6Galb1- |
| 4GlcNAcb1-4)Mana1-6)Manb1-4GlcNAcb1-4(Fuca1- | 4(Fuca1-3)GlcNAcb1-6)Mana1-6)Manb1- |
| 6)GlcNAcb | 4GlcNAcb1-4GlcNAc |
| NeuAca2-8NeuGca2-3/6Galb1-4GlcNAcb1-3Galb1- | NeuGca2-3/6Galb1-4(Fuca1-3)GlcNAcb1- |
| 4GlcNAcb1-2(NeuGca2-3/6Galb1-4(Fuca1- | 2(NeuGca2-3/6Galb1-4GlcNAcb1-4)Mana1- |
| 3)GlcNAcb1-3Galb1-4GlcNAcb1-4)Mana1-3(Mana1- | 3(NeuGca2-3/6Galb1-4GlcNAcb1-2(Gala1-3Galb1- |
| 3(Mana1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| Gala1-3Galb1-4GlcNAcb1-2(Gala1-3Galb1- | NeuGca2-3/6Galb1-4(Fuca1-3)GlcNAcb1-3Galb1- |
| 4GlcNAcb1-4)Mana1-3(NeuGca2-8NeuGca2- | 4GlcNAcb1-2(NeuGca2-3/6Galb1-4(Fuca1- |
| 3/6Galb1-4GlcNAcb1-2(NeuAca2-3/6Galb1- | 3)GlcNAcb1-3Galb1-4GlcNAcb1-4)Mana1-3(Mana1- |
| 4GlcNAcb1-6)Mana1-6)Manb1-4GlcNAcb1-4(Fuca1- | 3(Mana1-6)Mana1-6)Manb1-4GlcNAcb1-4(Fuca1- |
| 6)GlcNAc | 6)GlcNAc |
| NeuGca2-3/6Galb1-4(Fuca1-3)GlcNAcb1-3Galb1- | GlcNAcb1-4(NeuAca2-3/6Galb1-4GlcNAcb1- |
| 4(Fuca1-3)GlcNAcb1-2(NeuGca2-3/6Galb1- | 2(NeuGca2-3/6Galb1-4GlcNAcb1-4)Mana1- |
| 4(Fuca1-3)GlcNAcb1-3Galb1-4GlcNAcb1-4)Mana1- | 3)(NeuAca2-3/6Galb1-4GlcNAcb1-2(NeuAca2- |
| 3(Mana1-3(Mana1-6)Mana1-6)Manb1-4GlcNAcb1- | 3/6Galb1-4GlcNAcb1-6)Mana1-6)Manb1- |
| 4GlcNAc | 4GlcNAcb1-4GlcNAc |
| GlcNAcb1-4(NeuGca2-3/6Galb1-4GlcNAcb1- | NeuAca2-3/6Galb1-4GlcNAcb1-2(Galb1-4GlcNAcb1- |
| 2(GlcNAcb1-4)Mana1-3)(NeuGca2-3/6Galb1- | 4)Mana1-3(NeuAca2-3/6Galb1-4GlcNAcb1-3Galb1- |
| 4GlcNAcb1-2(NeuAca2-8NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| NeuAca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuAca2-3/6Galb1- | 3)GlcNAcb1-2(Galb1-4GlcNAcb1-4)Mana1- |
| 4GlcNAcb1-3Galb1-4GlcNAcb1-2(NeuAca2- | 3)(NeuAca2-3/6Galb1-4GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GlcNAcb1-4)Mana1-3)(NeuGca2- |
| 3)(NeuAca2-3/6Galb1-4GlcNAcb1-2(NeuAca2- | 3/6Galb1-4GlcNAcb1-2(NeuAca2-3/6Galb1- |
| 3/6Galb1-4GlcNAcb1-6)Mana1-6)Manb1- | 4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Gala1-3Galb1-4GlcNAcb1-2(NeuAca2- | NeuGca2-3/6Galb1-4(Fuca1-3)GlcNAcb1- |
| 3/6Galb1-4GlcNAcb1-4)Mana1-3)(NeuAca2- | 2(GalNAcb1-4GlcNAcb1-4)Mana1-3(NeuGca2- |
| 3/6Galb1-4GlcNAcb1-2(NeuAca2-3/6Galb1- | 3/6Galb1-4(Fuca1-3)GlcNAcb1-2(NeuAca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(NeuAca2-3/6Galb1-4(Fuca1- | NeuAca2-3Galb1-4GlcNAcb1-2Mana1-3(NeuAca2- |
| 3)GlcNAcb1-2(NeuAca2-3/6Galb1-4GlcNAcb1- | 3Galb1-4GlcNAcb1-3Galb1-4GlcNAcb1-2(NeuAca2- |
| 4)Mana1-3)(NeuAca2-3/6Galb1-4GlcNAcb1- | 3Galb1-4GlcNAcb1-3Galb1-4GlcNAcb1-6)Mana1- |
| 2(Gala1-3Galb1-4GlcNAcb1-6)Mana1-6)Manb1- | 6)Manb1-4GlcNAcb1-4(Fuca1-6)GlcNAc |
| 4GlcNAcb1-4GlcNAc | |
| NeuAca2-3Galb1-4GlcNAcb1-2(Galb1-4GlcNAcb1- | NeuAca2-3Galb1-4GlcNAcb1-2(NeuAca2-3Galb1- |
| 4)Mana1-3(NeuAca2-3Galb1-4GlcNAcb1- | 4GlcNAcb1-4)Mana1-3(Galb1-4GlcNAcb1-3Galb1- |
| 2(NeuAca2-3Galb1-4GlcNAcb1-3Galb1-4GlcNAcb1- | 4GlcNAcb1-2(NeuAca2-3Galb1-4GlcNAcb1- |
| 6)Mana1-6)Manb1-4GlcNAcb1-4(Fuca1-6)GlcNAcb | 6)Mana1-6)Manb1-4GlcNAcb1-4(Fuca1-6)GlcNAc |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(Galb1-4GlcNAcb1- |
| 4GlcNAcb1-3Galb1-4GlcNAcb1-2(Galb1-4GlcNAcb1- | 2(NeuAca2-3Galb1-4GlcNAcb1-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3/6Galb1-4(Fuca1-3)GlcNAcb1-2(Galb1- | GlcNAcb1-4(Gala1-3Galb1-4(Fuca1-3)GlcNAcb1- |
| 4(Fuca1-3)GlcNAcb1-4)Mana1-3(NeuAca2- | 2(Galb1-4GlcNAcb1-4)Mana1-3)(NeuAca2- |
| 3/6Galb1-4GlcNAcb1-3Galb1-4GlcNAcb1-2(Galb1- | 3/6Galb1-4(Fuca1-3)GlcNAcb1-2(NeuAca2- |
| 4GlcNAcb1-6)Mana1-6)Manb1-4GlcNAcb1-4(Fuca1- | 3/6Galb1-4(Fuca1-3)GlcNAcb1-6)Mana1-6)Manb1- |
| 6)GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4(Fuca1-3)GlcNAcb1- | 3)GlcNAcb1-2(Galb1-4GlcNAcb1-4)Mana1- |
| 4)Mana1-3)(Galb1-4(Fuca1-3)GlcNAcb1- | 3)(Galb1-4(Fuca1-3)GlcNAcb1-2(NeuAca2- |
| 2(NeuAca2-3/6Galb1-4(Fuca1-3)GlcNAcb1- | 3/6Galb1-4(Fuca1-3)GlcNAcb1-6)Mana1-6)Manb1- |
| 6)Mana1-6)Manb1-4GlcNAcb1-4GlcNAc | 4GlcNAcb1-4(Fuca1-6)GlcNAc |
| NeuGca2-3/6Galb1-4(Fuca1-3)GlcNAcb1- | GlcNAcb1-4(Gala1-3Galb1-4(Fuca1-3)GlcNAcb1- |
| 2(GalNAcb1-4(Fuca1-3)GlcNAcb1-4)Mana1- | 2(Galb1-4GlcNAcb1-4)Mana1-3)(NeuAca2- |
| 3(Galb1-4(Fuca1-3)GlcNAcb1-2(NeuGca2- | 3/6Galb1-4GlcNAcb1-2(NeuAca2-3/6Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| Galb1-4(Fuca1-3)GlcNAcb1-2(Fuca1-2Galb1- | GlcNAcb1-4(Fuca1-2Galb1-4(Fuca1-3)GlcNAcb1- |
| 4(Fuca1-3)GlcNAcb1-4)Mana1-3(NeuAca2- | 2(Gala1-3Galb1-4GlcNAcb1-4)Mana1-3)(NeuAca2- |
| 3/6Galb1-4(Fuca1-3)GlcNAcb1-3Galb1-4GlcNAcb1- | 3/6Galb1-4(Fuca1-3)GlcNAcb1-2(Galb1-4(Fuca1- |
| 2(Galb1-4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| GlcNAcb1-4(NeuGca2-3/6Galb1-4(Fuca1- | Galb1-4(Fuca1-3)GlcNAcb1-2(Galb1-4(Fuca1- |
| 3)GlcNAcb1-2(Fuca1-2Galb1-4(Fuca1-3)GlcNAcb1- | 3)GlcNAcb1-4)Mana1-3(NeuAca2-3/6Galb1- |
| 4)Mana1-3)(Galb1-4(Fuca1-3)GlcNAcb1-2(Galb1- | 4(Fuca1-3)GlcNAcb1-3Galb1-4GlcNAcb1-2(Galb1- |
| 4(Fuca1-3)GlcNAcb1-6)Mana1-6)Manb1- | 4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-8NeuGca2-3/6Galb1-4GlcNAcb1-3Galb1- | Gala1-3Galb1-4GlcNAcb1-2(Gala1-3Galb1- |
| 4GlcNAcb1-2(NeuGca2-3/6Galb1-4(Fuca1- | 4GlcNAcb1-4)Mana1-3(NeuGca2-8NeuGca2- |
| 3)GlcNAcb1-3Galb1-4GlcNAcb1-4)Mana1-3(Mana1- | 3/6Galb1-4GlcNAcb1-2(NeuGca2-3/6Galb1- |
| 3(Mana1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuGca2-3/6Galb1-4GlcNAcb1- | GlcNAcb1-4(NeuGca2-3/6Galb1-4GlcNAcb1- |
| 2(GlcNAcb1-4)Mana1-3)(NeuGca2-3/6Galb1- | 2(NeuGca2-3/6Galb1-4GlcNAcb1-4)Mana1- |
| 4GlcNAcb1-2(NeuAca2-8NeuGca2-3/6Galb1- | 3)(NeuAca2-3/6Galb1-4GlcNAcb1-2(NeuAca2- |
| 4GlcNAcb1-6)Mana1-6)Manb1-4GlcNAcb1-4(Fuca1- | 3/6Galb1-4GlcNAcb1-6)Mana1-6)Manb1- |
| 6)GlcNAc | 4GlcNAcb1-4GlcNAc |
| GlcNAcb1-4(NeuGca2-3/6Galb1-4(Fuca1- | NeuGca2-3/6Galb1-4(Fuca1-3)GlcNAcb1- |
| 3)GlcNAcb1-2(GlcNAcb1-4)Mana1-3)(NeuGca2- | 2(GalNAcb1-4GlcNAcb1-4)Mana1-3(NeuGca2- |
| 3/6Galb1-4GlcNAcb1-2(NeuGca2-3/6Galb1- | 3/6Galb1-4(Fuca1-3)GlcNAcb1-2(NeuGca2- |
| 4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| NeuGca2-3/6Galb1-4GlcNAcb1-2(Galb1-4GlcNAcb1- | NeuGca2-3/6Galb1-4(Fuca1-3)GlcNAcb1-2(Galb1- |
| 4)Mana1-3(NeuAca2-3/6Galb1-4GlcNAcb1-3Galb1- | 4GlcNAcb1-4)Mana1-3(NeuAca2-3/6Galb1- |
| 4GlcNAcb1-2(NeuAca2-3/6Galb1-4GlcNAcb1- | 4GlcNAcb1-3Galb1-4GlcNAcb1-2(NeuAca2- |
| 6)Mana1-6)Manb1-4GlcNAcb1-4(Fuca1-6)GlcNAc | 3/6Galb1-4GlcNAcb1-6)Mana1-6)Manb1- |
| | 4GlcNAcb1-4GlcNAc |
| GlcNAcb1-4(Gala1-3Galb1-4GlcNAcb1-2(Gala1- | GlcNAcb1-4(NeuGca2-3/6Galb1-4(Fuca1- |
| 3Galb1-4GlcNAcb1-4)Mana1-3)(NeuAca2- | 3)GlcNAcb1-2(Galb1-4GlcNAcb1-4)Mana1- |
| 8NeuAca2-3/6Galb1-4GlcNAcb1-2(NeuAca2- | 3)(NeuGca2-3/6Galb1-4GlcNAcb1-2(NeuAca2- |
| 3/6Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| GlcNAcb1-4(Gala1-3Galb1-4GlcNAcb1-2(NeuGca2- | GlcNAcb1-4(NeuAca2-3/6Galb1-4(Fuca1- |
| 3/6Galb1-4GlcNAcb1-4)Mana1-3)(NeuAca2- | 3)GlcNAcb1-2(NeuGca2-3/6Galb1-4GlcNAcb1- |
| 3/6Galb1-4GlcNAcb1-2(NeuAca2-3/6Galb1- | 4)Mana1-3)(NeuAca2-3/6Galb1-4GlcNAcb1- |
| 4GlcNAcb1-6)Mana1-6)Manb1-4GlcNAcb1-4(Fuca1- | 2(Gala1-3Galb1-4GlcNAcb1-6)Mana1-6)Manb1- |
| 6)GlcNAc | 4GlcNAcb1-4GlcNAc |
| Gala1-3Galb1-4GlcNAcb1-2(Galb1-4GlcNAcb1- | GlcNAcb1-4(NeuGca2-3/6Galb1-4(Fuca1- |
| 4)Mana1-3(NeuAca2-8NeuAca2-3/6Galb1- | 3)GlcNAcb1-2(Galb1-4GlcNAcb1-4)Mana1- |
| 4GlcNAcb1-3Galb1-4GlcNAcb1-2(NeuAca2- | 3)(NeuGca2-3/6Galb1-4GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-3Galb1-4GlcNAcb1-2(NeuAca2- | 3)GlcNAcb1-3Galb1-4GlcNAcb1-2(NeuAca2- |
| 3/6Galb1-4(Fuca1-3)GlcNAcb1-3Galb1-4GlcNAcb1- | 3/6Galb1-4GlcNAcb1-3Galb1-4GlcNAcb1-4)Mana1- |
| 4)Mana1-3)(Mana1-3(Mana1-6)Mana1-6)Manb1- | 3)(Mana1-3(Mana1-6)Mana1-6)Manb1-4GlcNAcb1- |
| 4GlcNAcb1-4GlcNAc | 4(Fuca1-6)GlcNAc |
| GlcNAcb1-4(Gala1-3Galb1-4(Fuca1-3)GlcNAcb1- | GlcNAcb1-4(NeuGca2-3/6Galb1-4(Fuca1- |
| 2(Galb1-4GlcNAcb1-4)Mana1-3)(NeuGca2- | 3)GlcNAcb1-2(Galb1-4GlcNAcb1-4)Mana1- |
| 3/6Galb1-4GlcNAcb1-2(NeuAca2-3/6Galb1- | 3)(Galb1-4(Fuca1-3)GlcNAcb1-2(NeuGca2- |
| 4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4(Fuca1- | GlcNAcb1-4(Gala1-3Galb1-4(Fuca1-3)GlcNAcb1- |
| 3)GlcNAcb1-2(Galb1-4(Fuca1-3)GlcNAcb1- | 2(Galb1-4GlcNAcb1-4)Mana1-3)(NeuGca2- |
| 4)Mana1-3)(Galb1-4(Fuca1-3)GlcNAcb1- | 3/6Galb1-4(Fuca1-3)GlcNAcb1-2(NeuAca2- |
| 2(NeuGca2-3/6Galb1-4(Fuca1-3)GlcNAcb1- | 3/6Galb1-4(Fuca1-3)GlcNAcb1-6)Mana1-6)Manb1- |
| 6)Mana1-6)Manb1-4GlcNAcb1-4GlcNAc | 4GlcNAcb1-4GlcNAc |
| Galb1-4(Fuca1-3)GlcNAcb1-2(Gala1-3Galb1- | NeuGca2-3/6Galb1-4(Fuca1-3)GlcNAcb1-2(Galb1- |
| 4GlcNAcb1-4)Mana1-3(NeuAca2-3/6Galb1- | 4(Fuca1-3)GlcNAcb1-4)Mana1-3(NeuAca2- |
| 4GlcNAcb1-3Galb1-4GlcNAcb1-2(NeuAca2- | 3/6Galb1-4GlcNAcb1-3Galb1-4GlcNAcb1-2(Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| Fuca1-2Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(NeuAca2-3/6Galb1- | 3)GlcNAcb1-3Galb1-4(Fuca1-3)GlcNAcb1-2(Galb1- |
| 4GlcNAcb1-3Galb1-4GlcNAcb1-2(Galb1-4(Fuca1- | 4(Fuca1-3)GlcNAcb1-3Galb1-4(Fuca1-3)GlcNAcb1- |
| 3)GlcNAcb1-6)Mana1-6)Manb1-4GlcNAcb1- | 4)Mana1-3)(Mana1-3(Mana1-6)Mana1-6)Manb1- |
| 4(Fuca1-6)GlcNAc | 4GlcNAcb1-4GlcNAc |
| GlcNAcb1-4(Fuca1-2Galb1-4(Fuca1-3)GlcNAcb1- | Galb1-4(Fuca1-3)GlcNAcb1-2(Fuca1-2Galb1- |
| 2(Gala1-3Galb1-4GlcNAcb1-4)Mana1-3)(NeuGca2- | 4(Fuca1-3)GlcNAcb1-4)Mana1-3(NeuGca2- |
| 3/6Galb1-4(Fuca1-3)GlcNAcb1-2(Galb1-4(Fuca1- | 3/6Galb1-4(Fuca1-3)GlcNAcb1-3Galb1-4GlcNAcb1- |
| 3)GlcNAcb1-6)Mana1-6)Manb1-4GlcNAcb1- | 2(Galb1-4(Fuca1-3)GlcNAcb1-6)Mana1-6)Manb1- |
| 4(Fuca1-6)GlcNAc | 4GlcNAcb1-4GlcNAc |
| Fuca1-2Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(NeuAca2-3/6Galb1- | 3)GlcNAcb1-3Galb1-4GlcNAcb1-2(Fuca1-2Galb1- |
| 4(Fuca1-3)GlcNAcb1-3Galb1-4GlcNAcb1-2(Galb1- | 4(Fuca1-3)GlcNAcb1-3Galb1-4GlcNAcb1-4)Mana1- |
| 4(Fuca1-3)GlcNAcb1-6)Mana1-6)Manb1- | 3)(Mana1-3(Mana1-6)Mana1-6)Manb1-4GlcNAcb1- |
| 4GlcNAcb1-4GlcNAc | 4(Fuca1-6)GlcNAc |
| Galb1-4(Fuca1-3)GlcNAcb1-2(Galb1-4(Fuca1- | GlcNAcb1-4(Galb1-4GlcNAcb1-3Galb1-4GlcNAcb1- |
| 3)GlcNAcb1-4)Mana1-3(NeuGca2-3/6Galb1- | 2(Gala1-3Galb1-4GlcNAcb1-4)Mana1-3)(Galb1- |
| 4(Fuca1-3)GlcNAcb1-3Galb1-4GlcNAcb12(Galb1- | 4GlcNAcb1-3Galb1-4GlcNAcb1-2(Gala1-3Galb1- |
| 4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GalNAcb1-4(Fuca1-3)GlcNAcb1- | 3)GlcNAcb1-2(GalNAcb1-4GlcNAcb1-4)Mana1- |
| 4)Mana1-3)(Galb1-4(Fuca1-3)GlcNAcb1- | 3)(Galb1-4(Fuca1-3)GlcNAcb1-2(NeuAca2- |
| 2(NeuAca2-3/6Galb1-4(Fuca1-3)GlcNAcb1- | 3/6Galb1-4(Fuca1-3)GlcNAcb1-6)Mana1-6)Manb1- |
| 6)Mana1-6)Manb1-4GlcNAcb1-4GlcNAc | 4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4GlcNAcb1- |
| 2(NeuGca2-3/6Galb1-4GlcNAcb1-4)Mana1- | 2(GlcNAcb1-4)Mana1-3)(NeuGca2-3/6Galb1- |
| 3)(NeuGca2-3/6Galb1-4GlcNAcb1-2(NeuAca2- | 4GlcNAcb1-2(NeuGca2-8NeuGca2-3/6Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(NeuGca2-3/6Galb1-4GlcNAcb1-2(NeuGca2- | 3)(NeuGca2-3/6Galb1-4GlcNAcb1-2(NeuGca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Gala1-3Galb1-4GlcNAcb1-2(Gala1- | NeuGca2-3/6Galb1-4GlcNAcb1-2(Galb1-4GlcNAcb1- |
| 3Galb1-4GlcNAcb1-4)Mana1-3)(NeuAca2- | 4)Mana1-3(NeuGca2-3/6Galb1-4GlcNAcb1-3Galb1- |
| 8NeuGca2-3/6Galb1-4GlcNAcb1-2(NeuAca2- | 4GlcNAcb1-2(NeuAca2-3/6Galb1-4GlcNAcb1- |
| 3/6Galb1-4GlcNAcb1-6)Mana1-6)Manb1- | 6)Mana1-6)Manb1-4GlcNAcb1-4(Fuca1-6)GlcNAc |
| 4GlcNAcb1-4GlcNAc | |
| GlcNAcb1-4(Gala1-3Galb1-4GlcNAcb1-2(NeuGca2- | Gala1-3Galb1-4GlcNAcb1-2(Galb1-4GlcNAcb1- |
| 3/6Galb1-4GlcNAcb1-4)Mana1-3)(NeuGca2- | 4)Mana1-3(NeuAca2-8NeuGca2-3/6Galb1- |
| 3/6Galb1-4GlcNAcb1-2(NeuAca2-3/6Galb1- | 4GlcNAcb1-3Galb1-4GlcNAcb1-2(NeuAca2- |
| 4GlcNAcb1-6)Mana1-6)Manb1-4GlcNAcb1-4(Fuca1- | 3/6Galb1-4GlcNAcb1-6)Mana1-6)Manb1- |
| 6)GlcNAc | 4GlcNAcb1-4GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuGca2-3/6Galb1- | 3)GlcNAcb1-2(NeuGca2-3/6Galb1-4GlcNAcb1- |
| 4GlcNAcb1-3Galb1-4GlcNAcb1-2(NeuAca2- | 4)Mana1-3)(NeuAca2-3/6Galb1-4GlcNAcb1- |
| 3/6Galb1-4GlcNAcb1-6)Mana1-6)Manb1- | 2(Gala1-3Galb1-4GlcNAcb1-6)Mana1-6)Manb1- |
| 4GlcNAcb1-4GlcNAc | 4GlcNAcb1-4GlcNAc |
| NeuGca2-3/6Galb1-4(Fuca1-3)GlcNAcb1-2(Galb1- | NeuAca2-3/6Galb1-4GlcNAcb1-3Galb1-4GlcNAcb1- |
| 4(Fuca1-3)GlcNAcb1-4)Mana1-3(NeuGca2- | 2(Gala1-3Galb1-4GlcNAcb1-4)Mana1-3(Gala1- |
| 3/6Galb1-4GlcNAcb1-3Galb1-4GlcNAcb1-2(Galb1- | 3Galb1-4GlcNAcb1-2(NeuAca2-3/6Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| Galb1-4(Fuca1-3)GlcNAcb1-2(Gala1-3Galb1- | GlcNAcb1-4(Gala1-3Galb1-4(Fuca1-3)GlcNAcb1- |
| 4GlcNAcb1-4)Mana1-3(NeuGca2-3/6Galb1- | 2(Galb1-4GlcNAcb1-4)Mana1-3)(NeuGca2- |
| 4GlcNAcb1-3Galb1-4GlcNAcb1-2(NeuAca2- | 3/6Galb1-4(Fuca1-3)GlcNAcb1-2(NeuGca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(NeuAca2-3/6Galb1-4(Fuca1- | GlcNAcb1-4(Gala1-3Galb1-4(Fuca1-3)GlcNAcb1- |
| 3)GlcNAcb1-3Galb1-4GlcNAcb1-2(NeuGca2- | 2(Galb1-4GlcNAcb1-4)Mana1-3)(NeuGca2- |
| 3/6Galb1-4(Fuca1-3)GlcNAcb1-3Galb1-4GlcNAcb1- | 3/6Galb1-4GlcNAcb1-2(NeuGca2-3/6Galb1- |
| 4)Mana1-3)(Mana1-3(Mana1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(NeuAca2-3/6Galb1-4(Fuca1- | Galb1-4(Fuca1-3)GlcNAcb1-3Galb1-4(Fuca1- |
| 3)GlcNAcb1-3Galb1-4GlcNAcb1-2(NeuGca2- | 3)GlcNAcb1-2(Gala1-3Galb1-4GlcNAcb1-4)Mana1- |
| 3/6Galb1-4GlcNAcb1-3Galb1-4GlcNAcb1-4)Mana1- | 3(Gala1-3Galb1-4GlcNAcb1-2(NeuAca2-3/6Galb1- |
| 3)(Mana1-3(Mana1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-3Galb1-4(Fuca1-3)GlcNAcb1-2(Galb1- | 3)GlcNAcb1-3Galb1-4GlcNAcb1-2(Fuca1-2Galb1- |
| 4(Fuca1-3)GlcNAcb1-3Galb1-4(Fuca1-3)GlcNAcb1- | 4(Fuca1-3)GlcNAcb1-3Galb1-4GlcNAcb1-4)Mana1- |
| 4)Mana1-3)(Mana1-3(Mana1-6)Mana1-6)Manb1- | 3)(Mana1-3(Mana1-6)Mana1-6)Manb1-4GlcNAcb1- |
| 4GlcNAcb1-4GlcNAc | 4(Fuca1-6)GlcNAc |
| GlcNAcb1-4(Gala1-3Galb1-4GlcNAcb1-3Galb1- | Galb1-4(Fuca1-3)GlcNAcb1-3Galb1-4GlcNAcb1- |
| 4(Fuca1-3)GlcNAcb1-2(NeuAca2-3/6Galb1- | 2(Gala1-3Galb1-4GlcNAcb1-4)Mana1-3(Gala1- |
| 4(Fuca1-3)GlcNAcb1-3Galb1-4GlcNAcb1-4)Mana1- | 3Galb1-4GlcNAcb1-2(NeuAca2-3/6Galb1-4(Fuca1- |
| 3)(Mana1-3(Mana1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| Fuca1-2Galb1-4(Fuca1-3)GlcNAcb1-2(Gala1- | Fuca1-2Galb1-4(Fuca1-3)GlcNAcb1-2(Gala1- |
| 3Galb1-4GlcNAcb1-4)Mana1-3(NeuGca2-3/6Galb1- | 3Galb1-4GlcNAcb1-4)Mana1-3(NeuGca2-3/6Galb1- |
| 4(Fuca1-3)GlcNAcb1-3Galb1-4GlcNAcb1-2(Galb1- | 4GlcNAcb1-3Galb1-4GlcNAcb1-2(Galb1-4(Fuca1- |
| 4(Fuca1-3)GlcNAcb1-6)Mana1-6)Manb1- | 3)GlcNAcb1-6)Mana1-6)Manb1-4GlcNAcb1- |
| 4GlcNAcb1-4GlcNAc | 4(Fuca1-6)GlcNAc |
| Galb1-4(Fuca1-3)GlcNAcb1-3Galb1-4(Fuca1- | GlcNAcb1-4(Gala1-3Galb1-4GlcNAcb1-3Galb1- |
| 3)GlcNAcb1-2(Gala1-3Galb1-4GlcNAcb1-4)Mana1- | 4(Fuca1-3)GlcNAcb1-2(Fuca1-2Galb1-4(Fuca1- |
| 3(Gala1-3Galb1-4GlcNAcb1-2(Fuca1-2Galb1- | 3)GlcNAcb1-3Galb1-4(Fuca1-3)GlcNAcb1-4)Mana1- |
| 4(Fuca1-3)GlcNAcb1-6)Mana1-6)Manb1- | 3)(Mana1-3(Mana1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GalNAcb1-4GlcNAcb1-4)Mana1- | 3)GlcNAcb1-2(GalNAcb1-4(Fuca1-3)GlcNAcb1- |
| 3)(Galb1-4(Fuca1-3)GlcNAcb1-2(NeuAca2- | 4)Mana1-3)(Galb1-4(Fuca1-3)GlcNAcb1- |
| 3/6Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4GlcNAc |
| GlcNAcb1-4(NeuGca2-3/6Galb1-4GlcNAcb1- | GlcNAcb1-4(Gala1-3Galb1-4GlcNAcb1-2(NeuGca2- |
| 2(NeuGca2-3/6Galb1-4GlcNAcb1-4)Mana1- | 3/6Galb1-4GlcNAcb1-4)Mana1-3)(NeuGca2- |
| 3)(NeuGca2-3/6Galb1-4GlcNAcb1-2(NeuGca2- | 3/6Galb1-4GlcNAcb1-2(NeuGca2-3/6Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | NeuGca2-3/6Galb1-4(Fuca1-3)GlcNAcb1-2(Galb1- |
| 3)GlcNAcb1-2(NeuGca2-3/6Galb1-4GlcNAcb1- | 4GlcNAcb1-4)Mana1-3(NeuGca2-3/6Galb1- |
| 4)Mana1-3)(NeuGca2-3/6Galb1-4GlcNAcb1- | 4GlcNAcb1-3Galb1-4GlcNAcb1-2(NeuGca2- |
| 2(Gala1-3Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4GlcNAc |
| NeuGca2-3/6Galb1-4GlcNAcb1-2(Galb1-4GlcNAcb1- | GlcNAcb1-4(Gala1-3Galb1-4GlcNAcb1-2(Gala1- |
| 4)Mana1-3(NeuGca2-3/6Galb1-4GlcNAcb1-3Galb1- | 3Galb1-4GlcNAcb1-4)Mana1-3)(NeuGca2- |
| 4GlcNAcb1-2(NeuGca2-3/6Galb1-4GlcNAcb1- | 8NeuGca2-3/6Galb1-4GlcNAcb1-2(NeuAca2- |
| 6)Mana1-6)Manb1-4GlcNAcb1-4(Fuca1-6)GlcNAc | 3/6Galb1-4GlcNAcb1-6)Mana1-6)Manb1- |
| | 4GlcNAcb1-4GlcNAc |
| Gala1-3Galb1-4GlcNAcb1-2(Galb1-4GlcNAcb1- | NeuGca2-3/6Galb1-4GlcNAcb1-3Galb1-4GlcNAcb1- |
| 4)Mana1-3(NeuGca2-8NeuGca2-3/6Galb1- | 2(Gala1-3Galb1-4GlcNAcb1-4)Mana1-3(Gala1- |
| 4GlcNAcb1-3Galb1-4GlcNAcb1-2(NeuAca2- | 3Galb1-4GlcNAcb1-2(NeuAca2-3/6Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | NeuAca2-8NeuAca2-3/6Galb1-4GlcNAcb1-3Galb1- |
| 3)GlcNAcb1-3Galb1-4GlcNAcb1-2(NeuGca2- | 4GlcNAcb1-2(Gala1-3Galb1-4GlcNAcb1-4)Mana1- |
| 3/6Galb1-4(Fuca1-3)GlcNAcb1-3Galb1-4GlcNAcb1- | 3(Gala1-3Galb1-4GlcNAcb1-2(Gala1-3Galb1- |
| 4)Mana1-3)(Mana1-3(Mana1-6)Mana1-6)Manb1- | 4GlcNAcb1-6)Mana1-6)Manb1-4GlcNAcb1-4GlcNAc |
| 4GlcNAcb1-4GlcNAc | |
| GlcNAcb1-4(NeuGca2-3/6Galb1-4(Fuca1- | Galb1-4(Fuca1-3)GlcNAcb1-2(Gala1-3Galb1- |
| 3)GlcNAcb1-3Galb1-4GlcNAcb1-2(NeuGca2- | 4GlcNAcb1-4)Mana1-3(NeuGca2-3/6Galb1- |
| 3/6Galb1-4GlcNAcb1-3Galb1-4GlcNAcb1-4)Mana1- | 4GlcNAcb1-3Galb1-4GlcNAcb1-2(NeuGca2- |
| 3)(Mana1-3(Mana1-6)Mana1-6)Manb1-4GlcNAcb1- | 3/6Galb1-4GlcNAcb1-6)Mana1-6)Manb1- |
| 4(Fuca1-6)GlcNAc | 4GlcNAcb1-4(Fuca1-6)GlcNAc |
| Galb1-4(Fuca1-3)GlcNAcb1-3Galb1-4GlcNAcb1- | NeuAca2-3/6Galb1-4(Fuca1-3)GlcNAcb1-3Galb1- |
| 2(Gala1-3Galb1-4GlcNAcb1-4)Mana1-3(Gala1- | 4GlcNAcb1-2(Gala1-3Galb1-4GlcNAcb1-4)Mana1- |
| 3Galb1-4GlcNAcb1-2(NeuGca2-3/6Galb1-4(Fuca1- | 3(Gala1-3Galb1-4GlcNAcb1-2(Gala1-3Galb1- |
| 3)GlcNAcb1-6)Mana1-6)Manb1-4GlcNAcb1- | 4GlcNAcb1-6)Mana1-6)Manb1-4GlcNAcb1-4(Fuca1- |
| 4(Fuca1-6)GlcNAc | 6)GlcNAc |
| NeuAca2-3/6Galb1-4(Fuca1-3)GlcNAcb1-3Galb1- | Galb1-4(Fuca1-3)GlcNAcb1-3Galb1-4(Fuca1- |
| 4(Fuca1-3)GlcNAcb1-2(Gala1-3Galb1-4GlcNAcb1- | 3)GlcNAcb1-2(Gala1-3Galb1-4GlcNAcb1-4)Mana1- |
| 4)Mana1-3(Gala1-3Galb1-4GlcNAcb1-2(Gala1- | 3(Gala1-3Galb1-4GlcNAcb1-2(NeuGca2-3/6Galb1- |
| 3Galb1-4GlcNAcb1-6)Mana1-6)Manb1-4GlcNAcb1- | 4(Fuca1-3)GlcNAcb1-6)Mana1-6)Manb1- |
| 4GlcNAc | 4GlcNAcb1-4GlcNAc |
| GlcNAcb1-4(Gala1-3Galb1-4GlcNAcb1-3Galb1- | GlcNAcb1-4(NeuAca2-3/6Galb1-4GlcNAcb1- |
| 4(Fuca1-3)GlcNAcb1-2(NeuGca2-3/6Galb1- | 2(Galb1-4GlcNAcb1-4)Mana1-3)(NeuAca2- |
| 4(Fuca1-3)GlcNAcb1-3Galb1-4GlcNAcb1-4)Mana1- | 3/6Galb1-4GlcNAcb1-3Galb1-4GlcNAcb1- |
| 3)(Mana1-3(Mana1-6)Mana1-6)Manb1-4GlcNAcb1- | 2(NeuAca2-3/6Galb1-4GlcNAcb1-6)Mana1- |
| 4(Fuca1-6)GlcNAc | 6)Manb1-4GlcNAcb1-4GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(GalNAcb1-4GlcNAcb1-4)Mana1- | 3)GlcNAcb1-2(Galb1-4(Fuca1-3)GlcNAcb1- |
| 3)(Galb1-4(Fuca1-3)GlcNAcb1-2(NeuGca2- | 4)Mana1-3)(NeuAca2-3/6Galb1-4GlcNAcb1-3Galb1- |
| 3/6Galb1-4(Fuca1-3)GlcNAcb1-6)Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4GlcNAc |
| GlcNAcb1-4(NeuGca2-3/6Galb1-4(Fuca1- | GlcNAcb1-4(Galb1-4(Fuca1-3)GlcNAcb1-2(Galb1- |
| 3)GlcNAcb1-2(GalNAcb1-4(Fuca1-3)GlcNAcb1- | 4(Fuca1-3)GlcNAcb1-4)Mana1-3)(NeuAca2- |
| 4)Mana1-3)(Galb1-4(Fuca1-3)GlcNAcb1- | 3/6Galb1-4(Fuca1-3)GlcNAcb1-3Galb1-4GlcNAcb1- |
| 2(NeuGca2-3/6Galb1-4(Fuca1-3)GlcNAcb1- | 2(Galb1-4(Fuca1-3)GlcNAcb1-6)Mana1-6)Manb1- |
| 6)Mana1-6)Manb1-4GlcNAcb1-4GlcNAc | 4GlcNAcb1-4GlcNAc |
| GlcNAcb1-4(NeuAca2-3/6Galb1-4(Fuca1- | GlcNAcb1-3Galb1-4GlcNAcb1-2(Galb1-4GlcNAcb1- |
| 3)GlcNAcb1-2(Galb1-4(Fuca1-3)GlcNAcb1- | 3Galb1-4GlcNAcb1-4)Mana1-3(Galb1-4GlcNAcb1- |
| 4)Mana1-3)(Galb1-4(Fuca1-3)GlcNAcb1-3Galb1- | 3Galb1-4GlcNAcb1-2(Galb1-4GlcNAcb1-3Galb1- |
| 4GlcNAcb1-2(Galb1-4GlcNAcb1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| Gala1-3Galb1-4GlcNAcb1-2(Galb1-4GlcNAcb1- | GlcNAcb1-4(Gala1-3Galb1-4GlcNAcb1-2(Gala1- |
| 4)Mana1-3(NeuGca2-8NeuGca2-3/6Galb1- | 3Galb1-4GlcNAcb1-4)Mana1-3)(NeuGca2- |
| 4GlcNAcb1-3Galb1-4GlcNAcb1-2(NeuGca2- | 8NeuGca2-3/6Galb1-4GlcNAcb1-2(NeuGca2- |
| 3/6Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4GlcNAc |
| NeuGca2-3/6Galb1-4GlcNAcb1-3Galb1-4GlcNAcb1- | NeuAca2-8NeuGca2-3/6Galb1-4GlcNAcb1-3Galb1- |
| 2(Gala1-3Galb1-4GlcNAcb1-4)Mana1-3(Gala1- | 4GlcNAcb1-2(Gala1-3Galb1-4GlcNAcb1-4)Mana1- |
| 3Galb1-4GlcNAcb1-2(NeuGca2-3/6Galb1- | 3(Gala1-3Galb1-4GlcNAcb1-2(Gala1-3Galb1- |
| 4GlcNAcb1-6)Mana1-6)Manb1-4GlcNAcb1-4(Fuca1- | 4GlcNAcb1-6)Mana1-6)Manb1-4GlcNAcb1-4GlcNAc |
| 6)GlcNAc | |
| NeuGca2-3/6Galb1-4(Fuca1-3)GlcNAcb1-3Galb1- | NeuGca2-3/6Galb1-4(Fuca1-3)GlcNAcb1-3Galb1- |
| 4(Fuca1-3)GlcNAcb1-2(Gala1-3Galb1-4GlcNAcb1- | 4GlcNAcb1-2(Gala1-3Galb1-4GlcNAcb1-4)Mana1- |
| 4)Mana1-3(Gala1-3Galb1-4GlcNAcb1-2(Gala1- | 3(Gala1-3Galb1-4GlcNAcb1-2(Gala1-3Galb1- |
| 3Galb1-4GlcNAcb1-6)Mana1-6)Manb1-4GlcNAcb1- | 4GlcNAcb1-6)Mana1-6)Manb1-4GlcNAcb1-4(Fuca1- |
| 4GlcNAc | 6)GlcNAc |
| NeuAca2-8NeuAca2-3/6Galb1-4GlcNAcb1- | NeuAca2-3/6Galb1-4(Fuca1-3)GlcNAcb1- |
| 2(NeuAca2-3/6Galb1-4GlcNAcb1-4)Mana1- | 2(NeuAca2-3/6Galb1-4GlcNAcb1-4)Mana1- |
| 3(NeuAca2-3/6Galb1-4GlcNAcb1-2(NeuAca2- | 3(NeuAca2-3/6Galb1-4GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| NeuAca2-6Galb1-4GlcNAcb1-2(NeuAca2-6Galb1- | NeuAca2-6Galb1-4GlcNAcb1-2(NeuAca2-3Galb1- |
| 4(Fuca1-3)GlcNAcb1-4)Mana1-3(NeuAca2-3Galb1- | 4(Fuca1-3)GlcNAcb1-4)Mana1-3(NeuAca2-6Galb1- |
| 4GlcNAcb1-2(NeuAca2-3Galb1-4(Fuca1- | 4GlcNAcb1-2(NeuAca2-3Galb1-4(Fuca1- |
| 3)GlcNAcb1-6)Mana1-6)Manb1-4GlcNAcb1-4GlcNAc | 3)GlcNAcb1-4)Mana1-6)Manb1-4GlcNAcb1-4GlcNAc |
| GlcNAcb1-4(NeuGca2-3/6Galb1-4GlcNAcb1- | NeuAca2-3/6Galb1-4(Fuca1-3)GlcNAcb1-2(Galb1- |
| 2(Galb1-4GlcNAcb1-4)Mana1-3)(NeuAca2- | 4GlcNAcb1-4)Mana1-3(NeuAca2-3/6Galb1-4(Fuca1- |
| 3/6Galb1-4GlcNAcb1-3Galb1-4GlcNAcb1- | 3)GlcNAcb1-2(NeuAca2-3/6Galb1-4(Fuca1- |
| 2(NeuAca2-3/6Galb1-4GlcNAcb1-6)Mana1- | 3)GlcNAcb1-6)Mana1-6)Manb1-4GlcNAcb1- |
| 6)Manb1-4GlcNAcb1-4GlcNAc | 4(Fuca1-6)GlcNAc |
| GlcNAcb1-4(NeuGca2-3/6Galb1-4(Fuca1- | GlcNAcb1-4(Galb1-4(Fuca1-3)GlcNAcb1-2(Gala1- |
| 3)GlcNAcb1-2(Galb1-4(Fuca1-3)GlcNAcb1- | 3Galb1-4GlcNAcb1-4)Mana1-3)(NeuAca2-3/6Galb1- |
| 4)Mana1-3)(NeuAca2-3/6Galb1-4GlcNAcb1-3Galb1- | 4GlcNAcb1-3Galb1-4GlcNAcb1-2(NeuAca2- |
| 4GlcNAcb1-2(Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4GlcNAc |
| GlcNAcb1-4(Gala1-3Galb1-4GlcNAcb1-2(Galb1- | GlcNAcb1-4(NeuGca2-3/6Galb1-4(Fuca1- |
| 4GlcNAcb1-4)Mana1-3)(NeuAca2-3/6Galb1- | 3)GlcNAcb1-2(Galb1-4(Fuca1-3)GlcNAcb1- |
| 4GlcNAcb1-3Galb1-4GlcNAcb1-2(NeuAca2- | 4)Mana1-3)(Galb1-4(Fuca1-3)GlcNAcb1-3Galb1- |
| 3/6Galb1-4GlcNAcb1-6)Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1-2(Gala1- | GlcNAcb1-4(Galb1-4(Fuca1-3)GlcNAcb1-2(Galb1- |
| 3Galb1-4GlcNAcb1-4)Mana1-3)(NeuAca2-3/6Galb1- | 4(Fuca1-3)GlcNAcb1-4)Mana1-3)(NeuGca2- |
| 4GlcNAcb1-3Galb1-4GlcNAcb1-2(Galb1-4(Fuca1- | 3/6Galb1-4(Fuca1-3)GlcNAcb1-3Galb1-4GlcNAcb1- |
| 3)GlcNAcb1-6)Mana1-6)Manb1-4GlcNAcb1- | 2(Galb1-4(Fuca1-3)GlcNAcb1-6)Mana1-6)Manb1- |
| 4(Fuca1-6)GlcNAc | 4GlcNAcb1-4GlcNAc |
| GlcNAcb1-4(Fuca1-2Galb1-4(Fuca1-3)GlcNAcb1- | NeuGca2-8NeuGca2-3/6Galb1-4GlcNAcb1-3Galb1- |
| 2(Gala1-3Galb1-4GlcNAcb1-4)Mana1-3)(NeuAca2- | 4GlcNAcb1-2(Gala1-3Galb1-4GlcNAcb1-4)Mana1- |
| 3/6Galb1-4GlcNAcb1-3Galb1-4GlcNAcb1-2(Galb1- | 3(Gala1-3Galb1-4GlcNAcb1-2(Gala1-3Galb1- |
| 4(Fuca1-3)GlcNAcb1-6)Mana1-6)Manb1- | 4GlcNAcb1-6)Mana1-6)Manb1-4GlcNAcb1-4GlcNAc |
| 4GlcNAcb1-4GlcNAc | |
| NeuAca2-8NeuAca2-3/6Galb1-4GlcNAcb1- | NeuAca2-3/6Galb1-4(Fuca1-3)GlcNAcb1- |
| 2(NeuGca2-3/6Galb1-4GlcNAcb1-4)Mana1- | 2(NeuGca2-3/6Galb1-4GlcNAcb1-4)Mana1- |
| 3(NeuAca2-3/6Galb1-4GlcNAcb1-2(NeuAca2- | 3(NeuAca2-3/6Galb1-4GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| GlcNAcb1-4(NeuGca2-3/6Galb1-4GlcNAcb1- | Gala1-3Galb1-4(Fuca1-3)GlcNAcb1-2(NeuAca2- |
| 2(Galb1-4GlcNAcb1-4)Mana1-3)(NeuGca2- | 3/6Galb1-4GlcNAcb1-4)Mana1-3(NeuAca2- |
| 3/6Galb1-4GlcNAcb1-3Galb1-4GlcNAcb1- | 3/6Galb1-4GlcNAcb1-2(NeuAca2-3/6Galb1- |
| 2(NeuAca2-3/6Galb1-4GlcNAcb1-6)Mana1- | 4(Fuca1-3)GlcNAcb1-6)Mana1-6)Manb1- |
| 6)Manb1-4GlcNAcb1-4GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(NeuAca2-3/6Galb1-4GlcNAcb1-3Galb1- |
| 4GlcNAcb1-4)Mana1-3(NeuAca2-3/6Galb1-4(Fuca1- | 4GlcNAcb1-2(Gala1-3Galb1-4GlcNAcb1-4)Mana1- |
| 3)GlcNAcb1-2(NeuAca2-3/6Galb1-4(Fuca1- | 3)(Gala1-3Galb1-4GlcNAcb1-2(NeuAca2-3/6Galb1- |
| 3)GlcNAcb1-6)Mana1-6)Manb1-4GlcNAcb1- | 4GlcNAcb1-6)Mana1-6)Manb1-4GlcNAcb1-4GlcNAc |
| 4(Fuca1-6)GlcNAc | |
| GlcNAcb1-4(Galb1-4(Fuca1-3)GlcNAcb1-2(Gala1- | GlcNAcb1-4(Gala1-3Galb1-4GlcNAcb1-2(Galb1- |
| 3Galb1-4GlcNAcb1-4)Mana1-3)(NeuGca2-3/6Galb1- | 4GlcNAcb1-4)Mana1-3)(NeuGca2-3/6Galb1- |
| 4GlcNAcb1-3Galb1-4GlcNAcb1-2(NeuAca2- | 4GlcNAcb1-3Galb1-4GlcNAcb1-2(NeuAca2- |
| 3/6Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| GlcNAcb1-4(NeuGca2-3/6Galb1-4(Fuca1- | Fuca1-2Galb1-4(Fuca1-3)GlcNAcb1-2(Gala1- |
| 3)GlcNAcb1-2(Galb1-4(Fuca1-3)GlcNAcb1- | 3Galb1-4GlcNAcb1-4)Mana1-3(NeuAca2-3/6Galb1- |
| 4)Mana1-3)(NeuGca2-3/6Galb1-4GlcNAcb1-3Galb1- | 4(Fuca1-3)GlcNAcb1-2(NeuAca2-3/6Galb1- |
| 4GlcNAcb1-2(Galb1-4GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(Galb1-4(Fuca1-3)GlcNAcb1-2(Gala1- | GlcNAcb1-4(Fuca1-2Galb1-4(Fuca1-3)GlcNAcb1- |
| 3Galb1-4GlcNAcb1-4)Mana1-3)(NeuGca2-3/6Galb1- | 2(Gala1-3Galb1-4GlcNAcb1-4)Mana1-3)(NeuGca2- |
| 4GlcNAcb1-3Galb1-4GlcNAcb1-2(Galb1-4(Fuca1- | 3/6Galb1-4GlcNAcb1-3Galb1-4GlcNAcb1-2(Galb1- |
| 3)GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4GlcNAc |
| GlcNAcb1-4(Galb1-4(Fuca1-3)GlcNAcb1-3Galb1- | GlcNAcb1-4(Galb1-4(Fuca1-3)GlcNAcb1-3Galb1- |
| 4GlcNAcb1-2(Gala1-3Galb1-4GlcNAcb1-4)Mana1- | 4(Fuca1-3)GlcNAcb1-2(Gala1-3Galb1-4GlcNAcb1- |
| 3)(Gala1-3Galb1-4GlcNAcb1-2(NeuAca2-3/6Galb1- | 4)Mana1-3)(Gala1-3Galb1-4GlcNAcb1-2(Fuca1- |
| 4(Fuca1-3)GlcNAcb1-6)Mana1-6)Manb1- | 2Galb1-4(Fuca1-3)GlcNAcb1-6)Mana1-6)Manb1- |
| 4GlcNAcb1-4GlcNAc | 4GlcNAcb1-4GlcNAc |
| GlcNAcb1-4(Galb1-4(Fuca1-3)GlcNAcb1-3Galb1- | NeuAca2-8NeuGca2-3/6Galb1-4GlcNAcb1- |
| 4GlcNAcb1-2(Gala1-3Galb1-4GlcNAcb1-4)Mana1- | 2(NeuGca2-3/6Galb1-4GlcNAcb1-4)Mana1- |
| 3)(Gala1-3Galb1-4GlcNAcb1-2(Fuca1-2Galb1- | 3(NeuAca2-3/6Galb1-4GlcNAcb1-2(NeuAca2- |
| 4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4GlcNAc |
| NeuGca2-3/6Galb1-4(Fuca1-3)GlcNAcb1- | GlcNAcb1-4(NeuGca2-3/6Galb1-4GlcNAcb1- |
| 2(NeuGca2-3/6Galb1-4GlcNAcb1-4)Mana1- | 2(Galb1-4GlcNAcb1-4)Mana1-3)(NeuGca2- |
| 3(NeuAca2-3/6Galb1-4GlcNAcb1-2(NeuAca2- | 3/6Galb1-4GlcNAcb1-3Galb1-4GlcNAcb1- |
| 3/6Galb1-4(Fuca1-3)GlcNAcb1-6)Mana1-6)Manb1- | 2(NeuGca2-3/6Galb1-4GlcNAcb1-6)Mana1- |
| 4GlcNAcb1-4GlcNAc | 6)Manb1-4GlcNAcb1-4GlcNAc |
| NeuGca2-3/6Galb1-4(Fuca1-3)GlcNAcb1-2(Galb1- | NeuAca2-8NeuAca2-3/6Galb1-4GlcNAcb1-3Galb1- |
| 4GlcNAcb1-4)Mana1-3(NeuGca2-3/6Galb1- | 4GlcNAcb1-2(NeuAca2-3/6Galb1-4(Fuca1- |
| 4(Fuca1-3)GlcNAcb1-2(NeuAca2-3/6Galb1- | 3)GlcNAcb1-3Galb1-4GlcNAcb1-4)Mana1-3(Mana1- |
| 4(Fuca1-3)GlcNAcb1-6)Mana1-6)Manb1- | 3(Mana1-6)Mana1-6)Manb1-4GlcNAcb1-4(Fuca1- |
| 4GlcNAcb1-4(Fuca1-6)GlcNAc | 6)GlcNAc |
| Gala1-3Galb1-4(Fuca1-3)GlcNAcb1-2(NeuGca2- | GlcNAcb1-4(Gala1-3Galb1-4GlcNAcb1-2(Galb1- |
| 3/6Galb1-4GlcNAcb1-4)Mana1-3(NeuAca2- | 4GlcNAcb1-4)Mana1-3)(NeuGca2-3/6Galb1- |
| 3/6Galb1-4GlcNAcb1-2(NeuAca2-3/6Galb1- | 4GlcNAcb1-3Galb1-4GlcNAcb1-2(NeuGca2- |
| 4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4GlcNAcb1-3Galb1- | GlcNAcb1-4(Galb1-4(Fuca1-3)GlcNAcb1-2(Gala1- |
| 4GlcNAcb1-2(Gala1-3Galb1-4GlcNAcb1-4)Mana1- | 3Galb1-4GlcNAcb1-4)Mana1-3)(NeuGca2-3/6Galb1- |
| 3)(Gala1-3Galb1-4GlcNAcb1-2(NeuAca2-3/6Galb1- | 4GlcNAcb1-3Galb1-4GlcNAcb1-2(NeuGca2- |
| 4GlcNAcb1-6)Mana1-6)Manb1-4GlcNAcb1-4GlcNAc | 3/6Galb1-4GlcNAcb1-6)Mana1-6)Manb1- |
| | 4GlcNAcb1-4GlcNAc |
| NeuAca2-3/6Galb1-4(Fuca1-3)GlcNAcb1-3Galb1- | Fuca1-2Galb1-4(Fuca1-3)GlcNAcb1-2(Gala1- |
| 4(Fuca1-3)GlcNAcb1-2(NeuAca2-3/6Galb1- | 3Galb1-4GlcNAcb1-4)Mana1-3(NeuGca2-3/6Galb1- |
| 4(Fuca1-3)GlcNAcb1-3Galb1-4GlcNAcb1-4)Mana1- | 4(Fuca1-3)GlcNAcb1-2(NeuAca2-3/6Galb1- |
| 3(Mana1-3(Mana1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4(Fuca1-6)GlcNAc |
| NeuAca2-3/6Galb1-4(Fuca1-3)GlcNAcb1-3Galb1- | GlcNAcb1-4(Galb1-4(Fuca1-3)GlcNAcb1-3Galb1- |
| 4(Fuca1-3)GlcNAcb1-2(NeuAca2-3/6Galb1- | 4GlcNAcb1-2(Gala1-3Galb1-4GlcNAcb1-4)Mana1- |
| 4(Fuca1-3)GlcNAcb1-3Galb1-4(Fuca1-3)GlcNAcb1- | 3)(Gala1-3Galb1-4GlcNAcb1-2(NeuGca2-3/6Galb1- |
| 4)Mana1-3(Mana1-3(Mana1-6)Mana1-6)Manb1- | 4(Fuca1-3)GlcNAcb1-6)Mana1-6)Manb1- |
| 4GlcNAcb1-4GlcNAc | 4GlcNAcb1-4GlcNAc |
| GlcNAcb1-4(NeuAca2-3/6Galb1-4(Fuca1- | GlcNAcb1-4(NeuAca2-3/6Galb1-4GlcNAcb1-3Galb1- |
| 3)GlcNAcb1-3Galb1-4GlcNAcb1-2(Gala1-3Galb1- | 4GlcNAcb1-2(Gala1-3Galb1-4GlcNAcb1-4)Mana1- |
| 4GlcNAcb1-4)Mana1-3)(Gala1-3Galb1-4GlcNAcb1- | 3)(Gala1-3Galb1-4GlcNAcb1-2(Gala1-3Galb1- |
| 2(Gala1-3Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(Galb1-4(Fuca1-3)GlcNAcb1-3Galb1- | NeuAca2-3/6Galb1-4(Fuca1-3)GlcNAcb1- |
| 4(Fuca1-3)GlcNAcb1-2(Gala1-3Galb1-4GlcNAcb1- | 2(GalNAcb1-4(Fuca1-3)GlcNAcb1-4)Mana1- |
| 4)Mana1-3)(Gala1-3Galb1-4GlcNAcb1-2(Gala1- | 3(NeuAca2-3/6Galb1-4(Fuca1-3)GlcNAcb1- |
| 3Galb1-4GlcNAcb1-6)Mana1-6)Manb1-4GlcNAcb1- | 2(NeuAca2-3/6Galb1-4(Fuca1-3)GlcNAcb1- |
| 4(Fuca1-6)GlcNAc | 6)Mana1-6)Manb1-4GlcNAcb1-4GlcNAc |
| NeuAca2-3/6Galb1-4(Fuca1-3)GlcNAcb1- | NeuGca2-8NeuGca2-3/6Galb1-4GlcNAcb1- |
| 2(GalNAcb1-4GlcNAcb1-4)Mana1-3(NeuAca2- | 2(NeuGca2-3/6Galb1-4GlcNAcb1-4)Mana1- |
| 3/6Galb1-4(Fuca1-3)GlcNAcb1-2(NeuAca2- | 3(NeuAca2-3/6Galb1-4GlcNAcb1-2(NeuAca2- |
| 3/6Galb1-4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4GlcNAc |
| NeuGca2-3/6Galb1-4(Fuca1-3)GlcNAcb1- | Gala1-3Galb1-4(Fuca1-3)GlcNAcb1-2(NeuGca2- |
| 2(NeuGca2-3/6Galb1-4GlcNAcb1-4)Mana1- | 3/6Galb1-4GlcNAcb1-4)Mana1-3(NeuGca2- |
| 3(NeuGca2-3/6Galb1-4GlcNAcb1-2(NeuAca2- | 3/6Galb1-4GlcNAcb1-2(NeuAca2-3/6Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| NeuGca2-3/6Galb1-4(Fuca1-3)GlcNAcb1-2(Galb1- | NeuAca2-8NeuAca2-3/6Galb1-4GlcNAcb1-3Galb1- |
| 4GlcNAcb1-4)Mana1-3(NeuGca2-3/6Galb1- | 4GlcNAcb1-2(NeuGca2-3/6Galb1-4(Fuca1- |
| 4(Fuca1-3)GlcNAcb1-2(NeuGca2-3/6Galb1- | 3)GlcNAcb1-3Galb1-4GlcNAcb1-4)Mana1-3(Mana1- |
| 4(Fuca1-3)GlcNAcb1-6)Mana1-6)Manb1- | 3(Mana1-6)Mana1-6)Manb1-4GlcNAcb1-4(Fuca1- |
| 4GlcNAcb1-4(Fuca1-6)GlcNAc | 6)GlcNAc |
| GlcNAcb1-4(NeuGca2-3/6Galb1-4GlcNAcb1-3Galb1- | NeuAca2-3/6Galb1-4(Fuca1-3)GlcNAcb1-3Galb1- |
| 4GlcNAcb1-2(Gala1-3Galb1-4GlcNAcb1-4)Mana1- | 4(Fuca1-3)GlcNAcb1-2(NeuGca2-3/6Galb1- |
| 3)(Gala1-3Galb1-4GlcNAcb1-2(NeuGca2-3/6Galb1- | 4(Fuca1-3)GlcNAcb1-3Galb1-4(Fuca1-3)GlcNAcb1- |
| 4GlcNAcb1-6)Mana1-6)Manb1-4GlcNAcb1-4GlcNAc | 4)Mana1-3(Mana1-3(Mana1-6)Mana1-6)Manb1- |
| | 4GlcNAcb1-4GlcNAc |
| Fuca1-2Galb1-4(Fuca1-3)GlcNAcb1-2(Gala1- | NeuAca2-3/6Galb1-4(Fuca1-3)GlcNAcb1-3Galb1- |
| 3Galb1-4GlcNAcb1-4)Mana1-3(NeuGca2-3/6Galb1- | 4(Fuca1-3)GlcNAcb1-2(NeuGca2-3/6Galb1- |
| 4(Fuca1-3)GlcNAcb1-2(NeuGca2-3/6Galb1- | 4(Fuca1-3)GlcNAcb1-3Galb1-4GlcNAcb1-4)Mana1- |
| 4(Fuca1-3)GlcNAcb1-6)Mana1-6)Manb1- | 3(Mana1-3(Mana1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4GlcNAcb1-3Galb1- | GlcNAcb1-4(NeuGca2-3/6Galb1-4(Fuca1- |
| 4GlcNAcb1-2(Gala1-3Galb1-4GlcNAcb1-4)Mana1- | 3)GlcNAcb1-3Galb1-4GlcNAcb1-2(Gala1-3Galb1- |
| 3)(Gala1-3Galb1-4GlcNAcb1-2(Gala1-3Galb1- | 4GlcNAcb1-4)Mana1-3)(Gala1-3Galb1-4GlcNAcb1- |
| 4GlcNAcb1-6)Mana1-6)Manb1-4GlcNAcb1-4(Fuca1- | 2(Gala1-3Galb1-4GlcNAcb1-6)Mana1-6)Manb1- |
| 6)GlcNAc | 4GlcNAcb1-4GlcNAc |
| GlcNAcb1-4(NeuAca2-3/6Galb1-4GlcNAcb1- | GlcNAcb1-4(NeuAca2-3Galb1-4GlcNAcb1- |
| 2(NeuAca2-3/6Galb1-4GlcNAcb1-4)Mana1- | 2(NeuAca2-3Galb1-4GlcNAcb1-4)Mana1- |
| 3)(NeuAca2-3/6Galb1-4GlcNAcb1-2(NeuAca2- | 3)(NeuAca2-3Galb1-4GlcNAcb1-2(NeuAca2- |
| 3/6Galb1-4GlcNAcb1-6)Mana1-6)Manb1- | 3Galb1-4GlcNAcb1-6)Mana1-6)Manb1-4GlcNAcb1- |
| 4GlcNAcb1-4(Fuca1-6)GlcNAc | 4(Fuca1-6)GlcNAcb |
| NeuGca2-3/6Galb1-4(Fuca1-3)GlcNAcb1- | GlcNAcb1-4(NeuAca2-3/6Galb1-4(Fuca1- |
| 2(GalNAcb1-4GlcNAcb1-4)Mana1-3(NeuAca2- | 3)GlcNAcb1-2(Galb1-4GlcNAcb1-4)Mana1- |
| 3/6Galb1-4(Fuca1-3)GlcNAcb1-2(NeuAca2- | 3)(NeuAca2-3/6Galb1-4GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(Galb1-4GlcNAcb1-4)Mana1- |
| 3(NeuAca2-3/6Galb1-4(Fuca1-3)GlcNAcb1- | 3)(NeuAca2-3/6Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(NeuAca2-3/6Galb1-4(Fuca1- | NeuGca2-8NeuGca2-3/6Galb1-4GlcNAcb1- |
| 3)GlcNAcb1-2(Galb1-4(Fuca1-3)GlcNAcb1- | 2(NeuGca2-3/6Galb1-4GlcNAcb1-4)Mana1- |
| 4)Mana1-3)(Galb1-4(Fuca1-3)GlcNAcb1- | 3(NeuGca2-3/6Galb1-4GlcNAcb1-2(NeuAca2- |
| 2(NeuAca2-3/6Galb1-4(Fuca1-3)GlcNAcb1- | 3/6Galb1-4GlcNAcb1-6)Mana1-6)Manb1- |
| 6)Mana1-6)Manb1-4GlcNAcb1-4(Fuca1-6)GlcNAc | 4GlcNAcb1-4GlcNAc |
| NeuGca2-3/6Galb1-4(Fuca1-3)GlcNAcb1- | NeuAca2-8NeuGca2-3/6Galb1-4GlcNAcb1-3Galb1- |
| 2(NeuGca2-3/6Galb1-4GlcNAcb1-4)Mana1- | 4GlcNAcb1-2(NeuGca2-3/6Galb1-4(Fuca1- |
| 3(NeuGca2-3/6Galb1-4GlcNAcb1-2(NeuGca2- | 3)GlcNAcb1-3Galb1-4GlcNAcb1-4)Mana1-3(Mana1- |
| 3/6Galb1-4(Fuca1-3)GlcNAcb1-6)Mana1-6)Manb1- | 3(Mana1-6)Mana1-6)Manb1-4GlcNAcb1-4(Fuca1- |
| 4GlcNAcb1-4GlcNAc | 6)GlcNAc |
| Gala1-3Galb1-4(Fuca1-3)GlcNAcb1-2(NeuGca2- | NeuGca2-3/6Galb1-4(Fuca1-3)GlcNAcb1-3Galb1- |
| 3/6Galb1-4GlcNAcb1-4)Mana1-3(NeuGca2- | 4(Fuca1-3)GlcNAcb1-2(NeuGca2-3/6Galb1- |
| 3/6Galb1-4GlcNAcb1-2(NeuGca2-3/6Galb1- | 4(Fuca1-3)GlcNAcb1-3Galb1-4(Fuca1-3)GlcNAcb1- |
| 4(Fuca1-3)GlcNAcb1-6)Mana1-6)Manb1- | 4)Mana1-3(Mana1-3(Mana1-6)Mana1-6)Manb1- |
| 4GlcNAcb1-4(Fuca1-6)GlcNAc | 4GlcNAcb1-4GlcNAc |
| NeuGca2-3/6Galb1-4(Fuca1-3)GlcNAcb1-3Galb1- | NeuAca2-3/6Galb1-4GlcNAcb1-2(NeuAca2- |
| 4(Fuca1-3)GlcNAcb1-2(NeuGca2-3/6Galb1- | 3/6Galb1-4GlcNAcb1-4)Mana1-3(Galb1-4GlcNAcb1- |
| 4(Fuca1-3)GlcNAcb1-3Galb1-4GlcNAcb1-4)Mana1- | 2(NeuAca2-3/6Galb1-4GlcNAcb1-4)(NeuAca2- |
| 3(Mana1-3(Mana1-6)Mana1-6)Manb1-4GlcNAcb1- | 3/6Galb1-4GlcNAcb1-6)Mana1-6)Manb1- |
| 4(Fuca1-6)GlcNAc | 4GlcNAcb1-4GlcNAc |
| NeuAca2-3/6Galb1-4GlcNAcb1-2(NeuAca2- | GlcNAcb1-4(NeuAca2-3/6Galb1-4GlcNAcb1- |
| 3/6Galb1-4GlcNAcb1-4)Mana1-3(NeuAca2- | 2(NeuGca2-3/6Galb1-4GlcNAcb1-4)Mana1- |
| 3/6Galb1-4GlcNAcb1-3Galb1-4GlcNAcb1- | 3)(NeuAca2-3/6Galb1-4GlcNAcb1-2(NeuAca2- |
| 2(NeuAca2-3/6Galb1-4GlcNAcb1-6)Mana1- | 3/6Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(Gala1-3Galb1-4(Fuca1-3)GlcNAcb1- | NeuGca2-3/6Galb1-4(Fuca1-3)GlcNAcb1- |
| 2(NeuAca2-3/6Galb1-4GlcNAcb1-4)Mana1- | 2(GalNAcb1-4(Fuca1-3)GlcNAcb1-4)Mana1- |
| 3)(NeuAca2-3/6Galb1-4GlcNAcb1-2(NeuAca2- | 3(NeuGca2-3/6Galb1-4(Fuca1-3)GlcNAcb1- |
| 3/6Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4GlcNAc | 6)Mana1-6)Manb1-4GlcNAcb1-4GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(NeuAca2-3/6Galb1-4GlcNAcb1- | 3)GlcNAcb1-2(Galb1-4GlcNAcb1-4)Mana1- |
| 4)Mana1-3)(NeuAca2-3/6Galb1-4GlcNAcb1- | 3)(NeuAca2-3/6Galb1-4GlcNAcb1-2(NeuAca2- |
| 2(Gala1-3Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuAca2-3/6Galb1-4(Fuca1-3)GlcNAcb1-2(Galb1- | NeuGca2-3/6Galb1-4(Fuca1-3)GlcNAcb1- |
| 4GlcNAcb1-4)Mana1-3(NeuAca2-3/6Galb1- | 2(GalNAcb1-4GlcNAcb1-4)Mana1-3(NeuGca2- |
| 4GlcNAcb1-3Galb1-4GlcNAcb1-2(NeuAca2- | 3/6Galb1-4(Fuca1-3)GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(Galb1-4(Fuca1-3)GlcNAcb1- |
| 3)(NeuAca2-3/6Galb1-4(Fuca1-3)GlcNAcb1- | 4)Mana1-3)(Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Gala1-3Galb1-4(Fuca1-3)GlcNAcb1- | GlcNAcb1-4(Fuca1-2Galb1-4(Fuca1-3)GlcNAcb1- |
| 2(Galb1-4GlcNAcb1-4)Mana1-3)(NeuAca2- | 2(Gala1-3Galb1-4GlcNAcb1-4)Mana1-3)(NeuAca2- |
| 3/6Galb1-4(Fuca1-3)GlcNAcb1-2(NeuAca2- | 3/6Galb1-4(Fuca1-3)GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| Galb1-4(Fuca1-3)GlcNAcb1-2(Fuca1-2Galb1- | NeuGca2-8NeuGca2-3/6Galb1-4GlcNAcb1- |
| 4(Fuca1-3)GlcNAcb1-4)Mana1-3(NeuAca2- | 2(NeuGca2-3/6Galb1-4GlcNAcb1-4)Mana1- |
| 3/6Galb1-4(Fuca1-3)GlcNAcb1-3Galb1-4GlcNAcb1- | 3(NeuGca2-3/6Galb1-4GlcNAcb1-2(NeuGca2- |
| 2(Galb1-4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4GlcNAc |
| NeuGca2-8NeuGca2-3/6Galb1-4GlcNAcb1-3Galb1- | NeuAca2-3/6Galb1-4GlcNAcb1-2(NeuGca2- |
| 4GlcNAcb1-2(NeuGca2-3/6Galb1-4(Fuca1- | 3/6Galb1-4GlcNAcb1-4)Mana1-3(NeuAca2- |
| 3)GlcNAcb1-3Galb1-4GlcNAcb1-4)Mana1-3(Mana1- | 3/6Galb1-4GlcNAcb1-3Galb1-4GlcNAcb1- |
| 3(Mana1-6)Mana1-6)Manb1-4GlcNAcb1-4(Fuca1- | 2(NeuAca2-3/6Galb1-4GlcNAcb1-6)Mana1- |
| 6)GlcNAc | 6)Manb1-4GlcNAcb1-4GlcNAc |
| GlcNAcb1-4(NeuGca2-3/6Galb1-4GlcNAcb1- | NeuAca2-3/6Galb1-4GlcNAcb1-2(NeuGca2- |
| 2(NeuGca2-3/6Galb1-4GlcNAcb1-4)Mana1- | 3/6Galb1-4GlcNAcb1-4)Mana1-3(Galb1-4GlcNAcb1- |
| 3)(NeuAca2-3/6Galb1-4GlcNAcb1-2(NeuAca2- | 2(NeuAca2-3/6Galb1-4GlcNAcb1-4)(NeuAca2- |
| 3/6Galb1-4GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4GlcNAc |
| Gala1-3Galb1-4GlcNAcb1-2(Galb1-4GlcNAcb1- | GlcNAcb1-4(NeuAca2-3/6Galb1-4(Fuca1- |
| 4)Mana1-3(NeuAca2-8NeuAca2-3/6Galb1- | 3)GlcNAcb1-2(NeuGca2-3/6Galb1-4GlcNAcb1- |
| 4GlcNAcb1-3Galb1-4GlcNAcb1-2(NeuAca2- | 4)Mana1-3)(NeuAca2-3/6Galb1-4GlcNAcb1- |
| 3/6Galb1-4GlcNAcb1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Gala1-3Galb1-4(Fuca1-3)GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(Galb1-4GlcNAcb1-4)Mana1- |
| 3)(NeuAca2-3/6Galb1-4GlcNAcb1-2(NeuAca2- | 3)(NeuGca2-3/6Galb1-4(Fuca1-3)GlcNAcb1- |
| 3/6Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4GlcNAc | 6)Mana1-6)Manb1-4GlcNAcb1-4GlcNAc |
| NeuGca2-3/6Galb1-4(Fuca1-3)GlcNAcb1- | GlcNAcb1-4(NeuGca2-3/6Galb1-4(Fuca1- |
| 2(GalNAcb1-4GlcNAcb1-4)Mana1-3(NeuGca2- | 3)GlcNAcb1-2(Galb1-4GlcNAcb1-4)Mana1- |
| 3/6Galb1-4(Fuca1-3)GlcNAcb1-2(NeuGca2- | 3)(NeuGca2-3/6Galb1-4GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1-2(Galb1- |
| 2(GalNAcb1-4(Fuca1-3)GlcNAcb1-4)Mana1- | 4GlcNAcb1-4)Mana1-3(NeuAca2-3/6Galb1- |
| 3(NeuGca2-3/6Galb1-4(Fuca1-3)GlcNAcb1- | 4GlcNAcb1-3Galb1-4GlcNAcb1-2(NeuAca2- |
| 2(NeuGca2-3/6Galb1-4(Fuca1-3)GlcNAcb1- | 3/6Galb1-4GlcNAcb1-6)Mana1-6)Manb1- |
| 6)Mana1-6)Manb1-4GlcNAcb1-4GlcNAc | 4GlcNAcb1-4(Fuca1-6)GlcNAc |
| GlcNAcb1-4(NeuAca2-8NeuAca2-3/6Galb1- | GlcNAcb1-4(Gala1-3Galb1-4GlcNAcb1-2(Gala1- |
| 4GlcNAcb1-3Galb1-4GlcNAcb1-2(NeuAca2- | 3Galb1-4GlcNAcb1-4)Mana1-3)(NeuAca2- |
| 3/6Galb1-4(Fuca1-3)GlcNAcb1-3Galb1-4GlcNAcb1- | 8NeuAca2-3/6Galb1-4GlcNAcb1-2(NeuAca2- |
| 4)Mana1-3)(Mana1-3(Mana1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| GlcNAcb1-4(Gala1-3Galb1-4(Fuca1-3)GlcNAcb1- | GlcNAcb1-4(NeuGca2-3/6Galb1-4(Fuca1- |
| 2(Galb1-4GlcNAcb1-4)Mana1-3)(NeuGca2- | 3)GlcNAcb1-2(Galb1-4(Fuca1-3)GlcNAcb1- |
| 3/6Galb1-4(Fuca1-3)GlcNAcb1-2(NeuAca2- | 4)Mana1-3)(Gab1-4(Fuca1-3)GlcNAcb1- |
| 3/6Galb1-4(Fuca1-3)GlcNAcb1-6)Mana1-6)Manb1- | 2(NeuGca2-3/6Galb1-4(Fuca1-3)GlcNAcb1- |
| 4GlcNAcb1-4(Fuca1-6)GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(Fuca1-2Galb1-4(Fuca1-3)GlcNAcb1- |
| 3)GlcNAcb1-3Galb1-4(Fuca1-3)GlcNAcb1- | 2(Gala1-3Galb1-4GlcNAcb1-4)Mana1-3)(NeuGca2- |
| 2(NeuAca2-3/6Galb1-4(Fuca1-3)GlcNAcb1-3Galb1- | 3/6Galb1-4(Fuca1-3)GlcNAcb1-2(NeuAca2- |
| 4GlcNAcb1-4)Mana1-3)(Mana1-3(Mana1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4GlcNAc |
| GlcNAcb1-4(NeuAca2-3/6Galb1-4(Fuca1- | Galb1-4(Fuca1-3)GlcNAcb1-2(Fuca1-2Galb1- |
| 3)GlcNAcb1-3Galb1-4GlcNAcb1-2(NeuAca2- | 4(Fuca1-3)GlcNAcb1-4)Mana1-3(NeuGca2- |
| 3/6Galb1-4(Fuca1-3)GlcNAcb1-3Galb1-4GlcNAcb1- | 3/6Galb1-4(Fuca1-3)GlcNAcb1-3Galb1-4GlcNAcb1- |
| 4)Mana1-3)(Mana1-3(Mana1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| Fuca1-2Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(NeuAca2-3/6Galb1- | 3)GlcNAcb1-3Galb1-4(Fuca1-3)GlcNAcb1-2(Galb1- |
| 4(Fuca1-3)GlcNAcb1-3Galb1-4GlcNAcb1-2(Galb1- | 4(Fuca1-3)GlcNAcb1-3Galb1-4(Fuca1-3)GlcNAcb1- |
| 4(Fuca1-3)GlcNAcb1-6)Mana1-6)Manb1- | 4)Mana1-3)(Mana1-3(Mana1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GalNAcb1-4GlcNAcb1-4)Mana1- | 3)GlcNAcb1-2(GalNAcb1-4(Fuca1-3)GlcNAcb1- |
| 3)(NeuAca2-3/6Galb1-4(Fuca1-3)GlcNAcb1- | 4)Mana1-3)(Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4GlcNAcb1-2(NeuGca2- | NeuGca2-3/6Galb1-4GlcNAcb1-2(NeuGca2- |
| 3/6Galb1-4GlcNAcb1-4)Mana1-3(Galb1-4GlcNAcb1- | 3/6Galb1-4GlcNAcb1-4)Mana1-3(NeuAca2- |
| 2(NeuAca2-3/6Galb1-4GlcNAcb1-4)(NeuAca2- | 3/6Galb1-4GlcNAcb1-3Galb1-4GlcNAcb1- |
| 3/6Galb1-4GlcNAcb1-6)Mana1-6)Manb1- | 2(NeuAca2-3/6Galb1-4GlcNAcb1-6)Mana1- |
| 4GlcNAcb1-4GlcNAc | 6)Manb1-4GlcNAcb1-4GlcNAc |
| GlcNAcb1-4(NeuGca2-3/6Galb1-4GlcNAcb1- | GlcNAcb1-4(NeuAca2-8NeuAca2-3/6Galb1- |
| 2(NeuGca2-3/6Galb1-4GlcNAcb1-4)Mana1- | 4GlcNAcb1-3Galb1-4GlcNAcb1-2(NeuGca2- |
| 3)(NeuGca2-3/6Galb1-4GlcNAcb1-2(NeuAca2- | 3/6Galb1-4(Fuca1-3)GlcNAcb1-3Galb1-4GlcNAcb1- |
| 3/6Galb1-4GlcNAcb1-6)Mana1-6)Manb1- | 4)Mana1-3)(Mana1-3(Mana1-6)Mana1-6)Manb1- |
| 4GlcNAcb1-4(Fuca1-6)GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(Galb1-4GlcNAcb1-4)Mana1- |
| 3)(NeuGca2-3/6Galb1-4(Fuca1-3)GlcNAcb1- | 3)(NeuGca2-3/6Galb1-4GlcNAcb1-2(NeuGca2- |
| 2(NeuGca2-3/6Galb1-4(Fuca1-3)GlcNAcb1- | 3/6Galb1-4(Fuca1-3)GlcNAcb1-6)Mana1-6)Manb1- |
| 6)Mana1-6)Manb1-4GlcNAcb1-4GlcNAc | 4GlcNAcb1-4(Fuca1-6)GlcNAc |
| GlcNAcb1-4(Gala1-3Galb1-4GlcNAcb1-2(Gala1- | Gala1-3Galb1-4GlcNAcb1-2(Galb1-4GlcNAcb1- |
| 3Galb1-4GlcNAcb1-4)Mana1-3)(NeuAca2- | 4)Mana1-3(NeuAca2-8NeuGca2-3/6Galb1- |
| 8NeuGca2-3/6Galb1-4GlcNAcb1-2(NeuAca2- | 4GlcNAcb1-3Galb1-4GlcNAcb1-2(NeuAca2- |
| 3/6Galb1-4GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuGca2-3/6Galb1- | 3)GlcNAcb1-2(NeuGca2-3/6Galb1-4GlcNAcb1- |
| 4GlcNAcb1-3Galb1-4GlcNAcb1-2(NeuAca2- | 4)Mana1-3)(NeuAca2-3/6Galb1-4GlcNAcb1- |
| 3/6Galb1-4GlcNAcb1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Gala1-3Galb1-4(Fuca1-3)GlcNAcb1- | GlcNAcb1-4(NeuAca2-3/6Galb1-4(Fuca1- |
| 2(NeuGca2-3/6Galb1-4GlcNAcb1-4)Mana1- | 3)GlcNAcb1-3Galb1-4GlcNAcb1-2(NeuGca2- |
| 3)(NeuGca2-3/6Galb1-4GlcNAcb1-2(NeuAca2- | 3/6Galb1-4(Fuca1-3)GlcNAcb1-3Galb1-4GlcNAcb1- |
| 3/6Galb1-4(Fuca1-3)GlcNAcb1-6)Mana1-6)Manb1- | 4)Mana1-3)(Mana1-3(Mana1-6)Mana1-6)Manb1- |
| 4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(Fuca1-2Galb1-4(Fuca1-3)GlcNAcb1- |
| 3)GlcNAcb1-3Galb1-4(Fuca1-3)GlcNAcb1- | 2(Gala1-3Galb1-4GlcNAcb1-4)Mana1-3)(NeuGca2- |
| 2(NeuGca2-3/6Galb1-4(Fuca1-3)GlcNAcb1-3Galb1- | 3/6Galb1-4(Fuca1-3)GlcNAcb1-2(NeuGca2- |
| 4GlcNAcb1-4)Mana1-3)(Mana1-3(Mana1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4GlcNAc |
| GlcNAcb1-4(Gala1-3Galb1-4(Fuca1-3)GlcNAcb1- | Fuca1-2Galb1-4(Fuca1-3)GlcNAcb1-2(Gala1- |
| 2(Galb1-4GlcNAcb1-4)Mana1-3)(NeuGca2- | 3Galb1-4GlcNAcb1-4)Mana1-3(NeuGca2-3/6Galb1- |
| 3/6Galb1-4(Fuca1-3)GlcNAcb1-2(NeuGca2- | 4(Fuca1-3)GlcNAcb1-3Galb1-4GlcNAcb1-2(Galb1- |
| 3/6Galb1-4(Fuca1-3)GlcNAcb1-6)Mana1-6)Manb1- | 4(Fuca1-3)GlcNAcb1-6)Mana1-6)Manb1- |
| 4GlcNAcb1-4(Fuca1-6)GlcNAc | 4GlcNAcb1-4(Fuca1-6GlcNAc |
| Galb1-4(Fuca1-3)GlcNAcb1-3Galb1-4(Fuca1- | GlcNAcb1-4(NeuGca2-3/6Galb1-4(Fuca1- |
| 3)GlcNAcb1-2(Gala1-3Galb1-4GlcNAcb1-4)Mana1- | 3)GlcNAcb1-3Galb1-4(Fuca1-3)GlcNAcb1-2(Galb1- |
| 3(Gala1-3Galb1-4GlcNAcb1-2(NeuAca2-3/6Galb1- | 4(Fuca1-3)GlcNAcb1-3Galb1-4(Fuca1-3)GlcNAcb1- |
| 4(Fuca1-3)GlcNAcb1-6)Mana1-6)Manb1- | 4)Mana1-3)(Mana1-3(Mana1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GalNAcb1-4GlcNAcb1-4)Mana1- | 3)GlcNAcb1-2(GalNAcb1-4(Fuca1-3)GlcNAcb1- |
| 3)(NeuAca2-3/6Galb1-4(Fuca1-3)GlcNAcb1- | 4)Mana1-3)(Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuGca2-3/6Galb1-4GlcNAcb1-2(NeuGca2- | GlcNAcb1-4(NeuGca2-3/6Galb1-4GlcNAcb1- |
| 3/6Galb1-4GlcNAcb1-4)Mana1-3(NeuGca2- | 2(NeuGca2-3/6Galb1-4GlcNAcb1-4)Mana1- |
| 3/6Galb1-4GlcNAcb1-3Galb1-4GlcNAcb1- | 3)(NeuGca2-3/6Galb1-4GlcNAcb1-2(NeuGca2- |
| 2(NeuAca2-3/6Galb1-4GlcNAcb1-6)Mana1- | 3/6Galb1-4GlcNAcb1-6)Mana1-6)Manb1- |
| 6)Manb1-4GlcNAcb1-4GlcNAc | 4GlcNAcb1-4(Fuca1-6)GlcNAc |
| NeuGca2-3/6Galb1-4GlcNAcb1-2(NeuGca2- | Gala1-3Galb1-4GlcNAcb1-2(Galb1-4GlcNAcb1- |
| 3/6Galb1-4GlcNAcb1-4)Mana1-3(Galb1-4GlcNAcb1- | 4)Mana1-3(NeuGca2-8NeuGca2-3/6Galb1- |
| 2(NeuGca2-3/6Galb1-4GlcNAcb1-4)(NeuAca2- | 4GlcNAcb1-3Galb1-4GlcNAcb1-2(NeuAca2- |
| 3/6Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| GlcNAcb1-4(NeuAca2-8NeuGca2-3/6Galb1- | GlcNAcb1-4(Gala1-3Galb1-4(Fuca1-3)GlcNAcb1- |
| 4GlcNAcb1-3Galb1-4GlcNAcb1-2(NeuGca2- | 2(NeuGca2-3/6Galb1-4GlcNAcb1-4)Mana1- |
| 3/6Galb1-4(Fuca1-3)GlcNAcb1-3Galb1-4GlcNAcb1- | 3)(NeuGca2-3/6Galb1-4GlcNAcb1-2(NeuGca2- |
| 4)Mana1-3)(Mana1-3(Mana1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Gala1- |
| 3)GlcNAcb1-2(NeuGca2-3/6Galb1-4GlcNAcb1- | 3Galb1-4GlcNAcb1-4)Mana1-3)(NeuGca2- |
| 4)Mana1-3)(NeuGca2-3/6Galb1-4GlcNAcb1- | 8NeuGca2-3/6Galb1-4GlcNAcb1-2(NeuAca2- |
| 2(Gala1-3Galb1-4GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuGca2-3/6Galb1- | 3)GlcNAcb1-3Galb1-4(Fuca1-3)GlcNAcb1- |
| 4GlcNAcb1-3Galb1-4GlcNAcb1-2(NeuGca2- | 2(NeuGca2-3/6Galb1-4(Fuca1-3)GlcNAcb1-3Galb1- |
| 3/6Galb1-4GlcNAcb1-6)Mana1-6)Manb1- | 4GlcNAcb1-4)Mana1-3)(Mana1-3(Mana1-6)Mana1- |
| 4GlcNAcb1-4(Fuca1-6)GlcNAc | 6)Manb1-4GlcNAcb1-4GlcNAc |
| GlcNAcb1-4(NeuGca2-3/6Galb1-4(Fuca1- | NeuAca2-8NeuAca2-3/6Galb1-4GlcNAcb1-3Galb1- |
| 3)GlcNAcb1-3Galb1-4GlcNAcb1-2(NeuGca2- | 4GlcNAcb1-2(Gala1-3Galb1-4GlcNAcb1-4)Mana1- |
| 3/6Galb1-4(Fuca1-3)GlcNAcb1-3Galb1-4GlcNAcb1- | 3(Gala1-3Galb1-4GlcNAcb1-2(Gala1-3Galb1- |
| 4)Mana1-3)(Mana1-3(Mana1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| NeuAca2-3/6Galb1-4(Fuca1-3)GlcNAcb1-3Galb1- | Galb1-4(Fuca1-3)GlcNAcb1-3Galb1-4(Fuca1- |
| 4(Fuca1-3)GlcNAcb1-2(Gala1-3Galb1-4GlcNAcb1- | 3)GlcNAcb1-2(Gala1-3Galb1-4GlcNAcb1-4)Mana1- |
| 4)Mana1-3(Gala1-3Galb1-4GlcNAcb1-2(Gala1- | 3(Gala1-3Galb1-4GlcNAcb1-2(NeuGca2-3/6Galb1- |
| 3Galb1-4GlcNAcb1-6)Mana1-6)Manb1-4GlcNAcb1- | 4(Fuca1-3)GlcNAcb1-6)Mana1-6)Manb1- |
| 4(Fuca1-6)GlcNAc | 4GlcNAcb1-4(Fuca1-6)GlcNAc |
| GlcNAcb1-4(NeuAca2-3/6Galb1-4GlcNAcb1- | GlcNAcb1-4(NeuGca2-3/6Galb1-4(Fuca1- |
| 2(Galb1-4GlcNAcb1-4)Mana1-3)(NeuAca2- | 3)GlcNAcb1-2(GalNAcb1-4GlcNAcb1-4)Mana1- |
| 3/6Galb1-4GlcNAcb1-3Galb1-4GlcNAcb1- | 3)(NeuGca2-3/6Galb1-4(Fuca1-3)GlcNAcb1- |
| 2(NeuAca2-3/6Galb1-4GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GalNAcb1-4(Fuca1-3)GlcNAcb1- |
| 3)(NeuAca2-3/6Galb1-4GlcNAcb1-3Galb1- | 4)Mana1-3)(Galb1-4(Fuca1-3)GlcNAcb1- |
| 4GlcNAcb1-2(NeuAca2-3/6Galb1-4GlcNAcb1- | 2(NeuGca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(Galb1-4(Fuca1-3)GlcNAcb1-2(Fuca1- |
| 3)GlcNAcb1-2(Galb1-4(Fuca1-3)GlcNAcb1- | 2Galb1-4(Fuca1-3)GlcNAcb1-4)Mana1-3)(NeuAca2- |
| 4)Mana1-3)(NeuAca2-3/6Galb1-4GlcNAcb1-3Galb1- | 3/6Galb1-4(Fuca1-3)GlcNAcb1-3Galb1-4GlcNAcb1- |
| 4GlcNAcb1-2(Galb1-4GlcNAcb1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Galb1-4(Fuca1-3)GlcNAcb1-2(Galb1- | NeuGca2-3/6Galb1-4GlcNAcb1-2(NeuGca2- |
| 4(Fuca1-3)GlcNAcb1-4)Mana1-3)(NeuAca2- | 3/6Galb1-4GlcNAcb1-4)Mana1-3(NeuGca2- |
| 3/6Galb1-4(Fuca1-3)GlcNAcb1-3Galb1-4GlcNAcb1- | 3/6Galb1-4GlcNAcb1-3Galb1-4GlcNAcb1- |
| 2(Galb1-4(Fuca1-3)GlcNAcb1-6)Mana1-6)Manb1- | 2(NeuGca2-3/6Galb1-4GlcNAcb1-6)Manab1- |
| 4GlcNAcb1-4(Fuca1-6)GlcNAc | 6)Manb1-4GlcNAcb1-4GlcNAc |
| GlcNAcb1-4(NeuGca2-8NeuGca2-3/6Galb1- | Gala1-3Galb1-4GlcNAcb1-2(Galb1-4GlcNAcb1- |
| 4GlcNAcb1-3Galb1-4GlcNAcb1-2(NeuGca2- | 4)Mana1-3(NeuGca2-8NeuGca2-3/6Galb1- |
| 3/6Galb1-4(Fuca1-3)GlcNAcb1-3Galb1-4GlcNAcb1- | 4GlcNAcb1-3Galb1-4GlcNAcb1-2(NeuGca2- |
| 4)Mana1-3)(Mana1-3(Mana1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| GlcNAcb1-4(Gala1-3Galb1-4GlcNAcb1-2(Gala1- | NeuAca2-8NeuGca2-3/6Galb1-4GlcNAcb1-3Galb1- |
| 3Galb1-4GlcNAcb1-4)Mana1-3)(NeuGca2- | 4GlcNAcb1-2(Gala1-3Galb1-4GlcNAcb1-4)Mana1- |
| 8NeuGca2-3/6Galb1-4GlcNAcb1-2(NeuGca2- | 3(Gala1-3Galb1-4GlcNAcb1-2(Gala1-3Galb1- |
| 3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4(Fuca1-6)GlcNAc | 6)GlcNAc |
| NeuGca2-3/6Galb1-4(Fuca1-3)GlcNAcb1-3Galb1- | NeuAca2-8NeuAca2-3/6Galb1-4GlcNAcb1- |
| 4(Fuca1-3)GlcNAcb1-2(Gala1-3Galb1-4GlcNAcb1- | 2(NeuAca2-3/6Galb1-4GlcNAcb1-4)Mana1- |
| 4)Mana1-3(Gala1-3Galb1-4GlcNAcb1-2(Gala1- | 3(NeuAca2-3/6Galb1-4GlcNAcb1-2(NeuAca2- |
| 3Galb1-4GlcNAcb1-6)Mana1-6)Manb1-4GlcNAcb1- | 3/6Galb1-4GlcNAcb1-6)Mana1-6)Manb1- |
| 4(Fuca1-6)GlcNAc | 4GlcNAcb1-4(Fuca1-6)GlcNAc |
| NeuAca2-3/6Galb1-4(Fuca1-3)GlcNAcb1- | GlcNAcb1-4(NeuGca2-3/6Galb1-4(Fuca1- |
| 2(NeuAca2-3/6Galb1-4GlcNAcb1-4)Mana1- | 3)GlcNAcb1-2(Galb1-4GlcNAcb1-4)Mana1- |
| 3(NeuAca2-3/6Galb1-4GlcNAcb1-2(NeuAca2- | 3)(NeuAca2-3/6Galb1-4GlcNAcb1-3Galb1- |
| 3/6Galb1-4(Fuca1-3)GlcNAcb1-6)Mana1-6)Manb1- | 4GlcNAcb1-2(NeuAca2-3/6Galb1-4GlcNAcb1- |
| 4GlcNAcb1-4(Fuca1-6)GlcNAc | 6)Mana1-6)Manb1-4GlcNAcb1-4GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(GalNAcb1-4GlcNAcb1-4)Mana1- | 4GlcNAcb1-4)Mana1-3)(NeuAca2-8NeuAca2- |
| 3)(NeuGca2-3/6Galb1-4(Fuca1-3)GlcNAcb1- | 3/6Galb1-4GlcNAcb1-3Galb1-4GlcNAcb1- |
| 2(NeuGca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4GlcNAc |
| GlcNAcb1-4(NeuGca2-3/6Galb1-4GlcNAcb1- | NeuAca2-3/6Galb1-4(Fuca1-3)GlcNAcb1-2(Fuca1- |
| 2(Galb1-4GlcNAcb1-4)Mana1-3)(NeuAca2- | 2Galb1-4(Fuca1-3)GlcNAcb1-4)Mana1-3(NeuAca2- |
| 3/6Galb1-4GlcNAcb1-3Galb1-4GlcNAcb1- | 3/6Galb1-4(Fuca1-3)GlcNAcb1-2(NeuAca2- |
| 2(NeuAca2-3/6Galb1-4GlcNAcb1-6)Mana1- | 3/6Galb1-4(Fuca1-3)GlcNAcb1-6)Mana1-6)Manb1- |
| 6)Manb1-4GlcNAcb1-4(Fuca1-6)GlcNAc | 4GlcNAcb1-4GlcNAc |
| GlcNAcb1-4(NeuGca2-3/6Galb1-4(Fuca1- | GlcNAcb1-4(Galb1-4(Fuca1-3)GlcNAcb1-2(Gala1- |
| 3)GlcNAcb1-2(Galb1-4(Fuca1-3)GlcNAcb1- | 3Galb1-4GlcNAcb1-4)Mana1-3)(NeuAca2-3/6Galb1- |
| 4)Mana1-3)(NeuAca2-3/6Galb1-4GlcNAcb1-3Galb1- | 4GlcNAcb1-3Galb1-4GlcNAcb1-2(NeuAca2- |
| 4GlcNAcb1-2(Galb1-4GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1-2(Fuca1- | GlcNAcb1-4(Galb1-4(Fuca1-3)GlcNAcb1-2(Galb1- |
| 2Galb1-4(Fuca1-3)GlcNAcb1-4)Mana1-3)(NeuGca2- | 4(Fuca1-3)GlcNAcb1-4)Mana1-3)(NeuGca2- |
| 3/6Galb1-4(Fuca1-3)GlcNAcb1-3Galb1-4GlcNAcb1- | 3/6Galb1-4(Fuca1-3)GlcNAcb1-3Galb1-4GlcNAcb1- |
| 2(Galb1-4(Fuca1-3)GlcNAcb1-6)Mana1-6)Manb1- | 2(Galb1-4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(Fuca1-2Galb1-4(Fuca1-3)GlcNAcb1- | GlcNAcb1-4(Fuca1-2Galb1-4(Fuca1-3)GlcNAcb1- |
| 2(Gala1-3Galb1-4GlcNAcb1-4)Mana1-3)(NeuAca2- | 2(Gala1-3Galb1-4GlcNAcb1-4)Mana1-3)(NeuAca2- |
| 3/6Galb1-4(Fuca1-3)GlcNAcb1-3Galb1-4GlcNAcb1- | 3/6Galb1-4GlcNAcb1-3Galb1-4GlcNAcb1-2(Galb1- |
| 2(Galb1-4(Fuca1-3)GlcNAcb1-6)Mana1-6)Manb1- | 4(Fuca1-3)GlcNAcb1-6)Mana1-6)Manb1- |
| 4GlcNAcb1-4GlcNAc | 4GlcNAcb1-4(Fuca1-6)GlcNAc |
| Galb1-4GlcNAcb1-3Galb1-4GlcNAcb1-2(Galb1- | NeuGca2-8NeuGca2-3/6Galb1-4GlcNAcb1-3Galb1- |
| 4GlcNAcb1-3Galb1-4GlcNAcb1-6)Mana1-3(Galb1- | 4GlcNAcb1-2(Gala1-3Galb1-4GlcNAcb1-4)Mana1- |
| 4GlcNAcb1-3Galb1-4GlcNAcb1-2(Galb1-4GlcNAcb1- | 3(Gala1-3Galb1-4GlcNAcb1-2(Gala1-3Galb1- |
| 3Galb1-4GlcNAcb1-4)Mana1-6)Manb1-4GlcNAcb1- | 4GlcNAcb1-6)Mana1-6)Manb1-4GlcNAcb1-4(Fuca1- |
| 4(Fuca1-6)GlcNAc | 6)GlcNAc |
| NeuAca2-8NeuAca2-3/6Galb1-4GlcNAcb1- | Gala1-3Galb1-4(Fuca1-3)GlcNAcb1-2(NeuAca2- |
| 2(NeuGca2-3/6Galb1-4GlcNAcb1-4)Mana1- | 3/6Galb1-4GlcNAcb1-4)Mana1-3(NeuAca2- |
| 3(NeuAca2-3/6Galb1-4GlcNAcb1-2(NeuAca2- | 8NeuAca2-3/6Galb1-4GlcNAcb1-2(NeuAca2- |
| 3/6Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| NeuAca2-3/6Galb1-4(Fuca1-3)GlcNAcb1- | GlcNAcb1-4(Gala1-3Galb1-4GlcNAcb1-2(Galb1- |
| 2(NeuGca2-3/6Galb1-4GlcNAcb1-4)Mana1- | 4GlcNAcb1-4)Mana1-3)(NeuAca2-8NeuGca2- |
| 3(NeuAca2-3/6Galb1-4GlcNAcb1-2(NeuAca2- | 3/6Galb1-4GlcNAcb1-3Galb1-4GlcNAcb1- |
| 3/6Galb1-4(Fuca1-3)GlcNAcb1-6)Mana1-6)Manb1- | 2(NeuAca2-3/6Galb1-4GlcNAcb1-6)Mana1- |
| 4GlcNAcb1-4(Fuca1-6)GlcNAc | 6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2(Galb1-4GlcNAcb1-4)Mana1-3)(NeuGca2- | 3)GlcNAcb1-2(Galb1-4GlcNAcb1-4)Mana1- |
| 3/6Galb1-4GlcNAcb1-3Galb1-4GlcNAcb1- | 3)(NeuGca2-3/6Galb1-4GlcNAcb1-3Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1-2(Fuca1- | GlcNAcb1-4(NeuAca2-3/6Galb1-4GlcNAcb1-3Galb1- |
| 2Galb1-4(Fuca1-3)GlcNAcb1-4)Mana1-3(NeuAca2- | 4GlcNAcb1-2(Gala1-3Galb1-4GlcNAcb1-4)Mana1- |
| 3/6Galb1-4(Fuca1-3)GlcNAcb1-2(NeuAca2- | 3)(Gala1-3Galb1-4GlcNAcb1-2(NeuAca2-3/6Galb1- |
| 3/6Galb1-4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3)(NeuGca2-3/6Galb1- | 3)GlcNAcb1-2(Galb1-4(Fuca1-3)GlcNAcb1- |
| 4GlcNAcb1-3Galb1-4GlcNAcb1-2(NeuAca2- | 4)Mana1-3)(NeuGca2-3/6Galb1-4GlcNAcb1-3Galb1- |
| 3/6Galb1-4GlcNAcb1-6)Mana1-6)Manb1- | 4GlcNAcb1-2(Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Fuca1-2Galb1-4(Fuca1-3)GlcNAcb1- | GlcNAcb1-4(Fuca1-2Galb1-4(Fuca1-3)GlcNAcb1- |
| 2(Gala1-3Galb1-4GlcNAcb1-4)Mana1-3)(NeuGca2- | 2(Gala1-3Galb1-4GlcNAcb1-4)Mana1-3)(NeuGca2- |
| 3/6Galb1-4GlcNAcb1-3Galb1-4GlcNAcb1-2(Galb1- | 3/6Galb1-4(Fuca1-3)GlcNAcb1-3Galb1-4GlcNAcb1- |
| 4(Fuca1-3)GlcNAcb1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Galb1-4(Fuca1-3)GlcNAcb1-3Galb1- | GlcNAcb1-4(Galb1-4(Fuca1-3)GlcNAcb1-3Galb1- |
| 4GlcNAcb1-2(Gala1-3Galb1-4GlcNAcb1-4)Mana1- | 4(Fuca1-3)GlcNAcb1-2(Gala1-3Galb1-4GlcNAcb1- |
| 3)(Gala1-3Galb1-4GlcNAcb1-2(NeuAca2-3/6Galb1- | 4)Mana1-3)(Gata1-3Galb1-4GlcNAcb1-2(NeuAca2- |
| 4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Galb1-4(Fuca1-3)GlcNAcb1-3Galb1- | NeuAca2-8NeuGca2-3/6Galb1-4GlcNAcb1- |
| 4(Fuca1-3)GlcNAcb1-2(Gala1-3Galb1-4GlcNAcb1- | 2(NeuGca2-3/6Galb1-4GlcNAcb1-4)Mana1- |
| 4)Mana1-3)(Gala1-3Galb1-4GlcNAcb1-2(Fuca1- | 3(NeuAca2-3/6Galb1-4GlcNAcb1-2(NeuAca2- |
| 2Galb1-4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1- | Gala1-3Galb1-4(Fuca1-3)GlcNAcb1-2(NeuGca2- |
| 2(NeuGca2-3/6Galb1-4GlcNAcb1-4)Mana1- | 3/6Galb1-4GlcNAcb1-4)Mana1-3(NeuAca2- |
| 3(NeuAca2-3/6Galb1-4GlcNAcb1-2(NeuAca2- | 8NeuAca2-3/6Galb1-4GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Gala1-3Galb1-4GlcNAcb1-2(Galb1- | GlcNAcb1-4(NeuGca2-3/6Galb1-4(Fuca1- |
| 4GlcNAcb1-4)Mana1-3)(NeuGca2-8NeuGca2- | 3)GlcNAcb1-2(Galb1-4GlcNAcb1-4)Mana1- |
| 3/6Galb1-4GlcNAcb1-3Galb1-4GlcNAcb1- | 3)(NeuGca2-3/6Galb1-4GlcNAcb1-3Galb1- |
| 2(NeuAca2-3/6Galb1-4GlcNAcb1-6)Mana1- | 4GlcNAcb1-2(NeuGca2-3/6Galb1-4GlcNAcb1- |
| 6)Manb1-4GlcNAcb1-4GlcNAc | 6)Mana1-6)Manb1-4GlcNAcb1-4GlcNAc |
| GlcNAcb1-4(NeuGca2-3/6Galb1-4GlcNAcb1- | NeuGca2-3/6Galb1-4(Fuca1-3)GlcNAcb1-2(Fuca1- |
| 2(Galb1-4GlcNAcb1-4)Mana1-3)(NeuGca2- | 2Galb1-4(Fuca1-3)GlcNAcb1-4)Mana1-3(NeuGca2- |
| 3/6Galb1-4GlcNAcb1-3Galb1-4GlcNAcb1- | 3/6Galb1-4(Fuca1-3)GlcNAcb1-2(NeuAca2- |
| 2(NeuGca2-3/6Galb1-4GlcNAcb1-6)Mana1- | 3/6Galb1-4(Fuca1-3)GlcNAcb1-6)Mana1-6)Manb1- |
| 6)Manb1-4GlcNAcb1-4(Fuca1-6)GlcNAc | 4GlcNAcb1-4GlcNAc |
| NeuAca2-8NeuAca2-3/6Galb1-4(Fuca1-3)GlcNAcb1- | GlcNAcb1-4(NeuGca2-3/6Galb1-4GlcNAcb1-3Galb1- |
| 3Galb1-4(Fuca1-3)GlcNAcb1-2(NeuAca2-3/6Galb1- | 4GlcNAcb1-2(Gala1-3Galb1-4GlcNAcb1-4)Mana1- |
| 4(Fuca1-3)GlcNAcb1-3Galb1-4GlcNAcb1-4)Mana1- | 3)(Gala1-3Galb1-4GlcNAcb1-2(NeuAca2-3/6Galb1- |
| 3(Mana1-3(Mana1-6)Mana1-6)Manb1-4GlcNAcb1- | 4GlcNAcb1-6)Mana1-6)Manb1-4GlcNAcb1-4(Fuca1- |
| 4GlcNAc | 6)GlcNAc |
| GlcNAcb1-4(NeuAca2-8NeuAca2-3/6Galb1- | GlcNAcb1-4(Galb1-4(Fuca1-3)GlcNAcb1-2(Gala1- |
| 4GlcNAcb1-3Galb1-4GlcNAcb1-2(Gala1-3Galb1- | 3Galb1-4GlcNAcb1-4)Mana1-3)(NeuGca2-3/6Galb1- |
| 4GlcNAcb1-4)Mana1-3)(Gala1-3Galb1-4GlcNAcb1- | 4GlcNAcb1-3Galb1-4GlcNAcb1-2(NeuGca2- |
| 2(Gala1-3Galb1-4GlcNAcb1-6)Mana1-6)Manb1- | 3/6Galb1-4GlcNAcb1-6)Mana1-6)Manb1- |
| 4GlcNAcb1-4GlcNAc | 4GlcNAcb1-4(Fuca1-6)GlcNAc |
| NeuAca2-3/6Galb1-4(Fuca1-3)GlcNAcb1-3Galb1- | GlcNAcb1-4(Galb1-4(Fuca1-3)GlcNAcb1-3Galb1- |
| 4(Fuca1-3)GlcNAcb1-2(NeuAca2-3/6Galb1- | 4(Fuca1-3)GlcNAcb1-2(Gala1-3Galb1-4GlcNAcb1- |
| 4(Fuca1-3)GlcNAcb1-3Galb1-4(Fuca1-3)GlcNAcb1- | 4)Mana1-3)(Gala1-3Galb1-4GlcNAcb1-2(NeuGca2- |
| 4)Mana1-3(Mana1-3(Mana1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4GlcNAc |
| GlcNAcb1-4(Galb1-4(Fuca1-3)GlcNAcb1-3Galb1- | GlcNAcb1-4(NeuAca2-3/6Galb1-4(Fuca1- |
| 4GlcNAcb1-2(Gala1-3Galb1-4GlcNAcb1-4)Mana1- | 3)GlcNAcb1-3Galb1-4(Fuca1-3)GlcNAcb1-2(Gala1- |
| 3)(Gala1-3Galb1-4GlcNAcb1-2(NeuGca2-3/6Galb1- | 3Galb1-4GlcNAcb1-4)Mana1-3)(Gala1-3Galb1- |
| 4(Fuca1-3)GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4GlcNAc |
| GlcNAcb1-4(NeuAca2-3/6Galb1-4(Fuca1- | NeuAca2-3/6Galb1-4(Fuca1-3)GlcNAcb1- |
| 3)GlcNAcb1-3Galb1-4GlcNAcb1-2(Gala1-3Galb1- | 2(GalNAcb1-4(Fuca1-3)GlcNAcb1-4)Mana1- |
| 4GlcNAcb1-4)Mana1-3)(Gala1-3Galb1-4GlcNAcb1- | 3(NeuAca2-3/6Galb1-4(Fuca1-3)GlcNAcb1- |
| 2(Gala1-3Galb1-4GlcNAcb1-6)Mana1-6)Manb1- | 2(NeuAca2-8NeuAca2-3/6Galb1-4GlcNAcb1- |
| 4GlcNAcb1-4(Fuca1-6)GlcNAc | 6)Mana1-6)Manb1-4GlcNAcb1-4GlcNAc |
| NeuAca2-3/6Galb1-4(Fuca1-3)GlcNAcb1- | NeuGca2-8NeuGca2-3/6Galb1-4GlcNAcb1- |
| 2(GalNAcb1-4(Fuca1-3)GlcNAcb1-4)Mana1- | 2(NeuGca2-3/6Galb1-4GlcNAcb1-4)Mana1- |
| 3(NeuAca2-3/6Galb1-4(Fuca1-3)GlcNAcb1- | 3(NeuAca2-3/6Galb1-4GlcNAcb1-2(NeuAca2- |
| 2(NeuAca2-3/6Galb1-4(Fuca1-3)GlcNAcb1- | 3/6Galb1-4GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| Gala1-3Galb1-4(Fuca1-3)GlcNAcb1-2(NeuGca2- | NeuGca2-3/6Galb1-4(Fuca1-3)GlcNAcb1- |
| 3/6Galb1-4GlcNAcb1-4)Mana1-3(NeuAca2- | 2(NeuGca2-3/6Galb1-4GlcNAcb1-4)Mana1- |
| 8NeuGca2-3/6Galb1-4GlcNAcb1-2(NeuAca2- | 3(NeuGca2-3/6Galb1-4GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(Gala1-3Galb1-4GlcNAcb1-2(Galb1- | NeuAca2-8NeuAca2-3/6Galb1-4(Fuca1-3)GlcNAcb1- |
| 4GlcNAcb1-4)Mana1-3)(NeuGca2-8NeuGca2- | 3Galb1-4(Fuca1-3)GlcNAcb1-2(NeuGca2-3/6Galb1- |
| 3/6Galb1-4GlcNAcb1-3Galb1-4GlcNAcb1- | 4(Fuca1-3)GlcNAcb1-3Galb1-4GlcNAcb1-4)Mana1- |
| 2(NeuGca2-3/6Galb1-4GlcNAcb1-6)Mana1- | 3(Mana1-3(Mana1-6)Mana1-6)Manb1-4GlcNAcb1- |
| 6)Manb1-4GlcNAcb1-4GlcNAc | 4GlcNAc |
| NeuGca2-3/6Galb1-4(Fuca1-3)GlcNAcb1-2(Fuca1- | GlcNAcb1-4(NeuGca2-3/6Galb1-4GlcNAcb1-3Galb1- |
| 2Galb1-4(Fuca1-3)GlcNAcb1-4)Mana1-3(NeuGca2- | 4GlcNAcb1-2(Gala1-3Galb1-4GlcNAcb1-4)Mana1- |
| 3/6Galb1-4(Fuca1-3)GlcNAcb1-2(NeuGca2- | 3)(Gala1-3Galb1-4GlcNAcb1-2(NeuGca2-3/6Galb1- |
| 3/6Galb1-4(Fuca1-3)GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuAca2-8NeuGca2-3/6Galb1- | NeuAca2-3/6Galb1-4(Fuca1-3)GlcNAcb1-3Galb1- |
| 4GlcNAcb1-3Galb1-4GlcNAcb1-2(Gala1-3Galb1- | 4(Fuca1-3)GlcNAcb1-2(NeuGca2-3/6Galb1- |
| 4GlcNAcb1-4)Mana1-3)(Gala1-3Galb1-4GlcNAcb1- | 4(Fuca1-3)GlcNAcb1-3Galb1-4(Fuca1-3)GlcNAcb1- |
| 2(Gala1-3Galb1-4GlcNAcb1-6)Mana1-6)Manb1- | 4)Mana1-3(Mana1-3(Mana1-6)Mana1-6)Manb1- |
| 4GlcNAcb1-4GlcNAc | 4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-3Galb1-4GlcNAcb1-2(Gala1-3Galb1- | 3)GlcNAcb1-3Galb1-4(Fuca1-3)GlcNAcb1-2(Gala1- |
| 4GlcNAcb1-4)Mana1-3)(Gala1-3Galb1-4GlcNAcb1- | 3Galb1-4GlcNAcb1-4)Mana1-3)(Gala1-3Galb1- |
| 2(Gala1-3Galb1-4GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4GlcNAc |
| GlcNAcb1-4(NeuAca2-8NeuAca2-3/6Galb1- | NeuGca2-3/6Galb1-4(Fuca1-3)GlcNAcb1- |
| 4GlcNAcb1-2(NeuAca2-3/6Galb1-4GlcNAcb1- | 2(GalNAcb1-4(Fuca1-3)GlcNAcb1-4)Mana1- |
| 4)Mana1-3)(NeuAca2-3/6Galb1-4GlcNAcb1- | 3(NeuAca2-3/6Galb1-4(Fuca1-3)GlcNAcb1- |
| 2(NeuAca2-3/6Galb1-4GlcNAcb1-6)Mana1- | 2(NeuAca2-8NeuAca2-3/6Galb1-4GlcNAcb1- |
| 6)Manb1-4GlcNAcb1-4GlcNAc | 6)Mana1-6)Manb1-4GlcNAcb1-4GlcNAc |
| GlcNAcb1-4(NeuAca2-3/6Galb1-4(Fuca1- | NeuGca2-3/6Galb1-4(Fuca1-3)GlcNAcb1- |
| 3)GlcNAcb1-2(NeuAca2-3/6Galb1-4GlcNAcb1- | 2(GalNAcb1-4(Fuca1-3)GlcNAcb1-4)Mana1- |
| 4)Mana1-3)(NeuAca2-3/6Galb1-4GlcNAcb1- | 3(NeuAca2-3/6Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | NeuGca2-8NeuGca2-3/6Galb1-4GlcNAcb1- |
| 3)GlcNAcb1-2(Galb1-4GlcNAcb1-4)Mana1- | 2(NeuGca2-3/6Galb1-4GlcNAcb1-4)Mana1- |
| 3)(NeuAca2-3/6Galb1-4(Fuca1-3)GlcNAcb1- | 3(NeuGca2-3/6Galb1-4GlcNAcb1-2(NeuAca2- |
| 2(NeuAca2-3/6Galb1-4(Fuca1-3)GlcNAcb1- | 3/6Galb1-4GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| Gala1-3Galb1-4(Fuca1-3)GlcNAcb1-2(NeuGca2- | NeuGca2-3/6Galb1-4(Fuca1-3)GlcNAcb1- |
| 3/6Galb1-4GlcNAcb1-4)Mana1-3(NeuGca2- | 2(NeuGca2-3/6Galb1-4GlcNAcb1-4)Mana1- |
| 8NeuGca2-3/6Galb1-4GlcNAcb1-2(NeuAca2- | 3(NeuGca2-3/6Galb1-4GlcNAcb1-2(NeuGca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4(Fuca1-6)GlcNAc |
| NeuAca2-8NeuGca2-3/6Galb1-4(Fuca1- | GlcNAcb1-4(NeuGca2-8NeuGca2-3/6Galb1- |
| 3)GlcNAcb1-3Galb1-4(Fuca1-3)GlcNAcb1- | 4GlcNAcb1-3Galb1-4GlcNAcb1-2(Gala1-3Galb1- |
| 2(NeuGca2-3/6Galb1-4(Fuca1-3)GlcNAcb1-3Galb1- | 4GlcNAcb1-4)Mana1-3)(Gala1-3Galb1-4GlcNAcb1- |
| 4GlcNAcb1-4)Mana1-3(Mana1-3(Mana1-6)Mana1- | 2(Gala1-3Galb1-4GlcNAcb1-6)Mana1-6)Manb1- |
| 6)Manb1-4GlcNAcb1-4GlcNAc | 4GlcNAcb1-4GlcNAc |
| NeuGca2-3/6Galb1-4(Fuca1-3)GlcNAcb1-3Galb1- | GlcNAcb1-4(NeuAca2-8NeuAca2-3/6Galb1- |
| 4(Fuca1-3)GlcNAcb1-2(NeuGca2-3/6Galb1- | 4GlcNAcb1-2(NeuGca2-3/6Galb1-4GlcNAcb1- |
| 4(Fuca1-3)GlcNAcb1-3Galb1-4(Fuca1-3)GlcNAcb1- | 4)Mana1-3)(NeuAca2-3/6Galb1-4GlcNAcb1- |
| 4)Mana1-3(Mana1-3(Mana1-6)Mana1-6)Manb1- | 2(NeuAca2-3/6Galb1-4GlcNAcb1-6)Mana1- |
| 4GlcNAcb1-4(Fuca1-6)GlcNAc | 6)Manb1-4GlcNAcb1-4GlcNAc |
| NeuGca2-3/6Galb1-4(Fuca1-3)GlcNAcb1- | GlcNAcb1-4(NeuAca2-3/6Galb1-4(Fuca1- |
| 2(GalNAcb1-4(Fuca1-3)GlcNAcb1-4)Mana1- | 3)GlcNAcb1-2(NeuGca2-3/6Galb1-4GlcNAcb1- |
| 3(NeuGca2-3/6Galb1-4(Fuca1-3)GlcNAcb1- | 4)Mana1-3)(NeuAca2-3/6Galb1-4GlcNAcb1- |
| 2(NeuAca2-8NeuAca2-3/6Galb1-4GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| NeuAca2-3/6Galb1-4GlcNAcb1-2(NeuAca2- | NeuAca2-3/6Galb1-4GlcNAcb1-2(NeuAca2- |
| 3/6Galb1-4GlcNAcb1-4)Mana1-3(NeuAca2- | 3/6Galb1-4GlcNAcb1-4)Mana1-3(Galb1-4GlcNAcb1- |
| 3/6Galb1-4GlcNAcb1-3Galb1-4GlcNAcb1- | 2(NeuAca2-3/6Galb1-4GlcNAcb1-4)(NeuAca2- |
| 2(NeuAca2-3/6Galb1-4GlcNAcb1-6)Mana1- | 3/6Galb1-4GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| NeuAca2-3/6Galb1-4(Fuca1-3)GlcNAcb1-2(Galb1- | NeuAca2-3Galb1-4GlcNAcb1-2(NeuAca2-3Galb1- |
| 4GlcNAcb1-4)Mana1-3(NeuAca2-8NeuAca2- | 4GlcNAcb1-4)Mana1-3(NeuAca2-3Galb1- |
| 3/6Galb1-4GlcNAcb1-3Galb1-4GlcNAcb1- | 4GlcNAcb1-2(NeuAca2-3Galb1-4GlcNAcb1-3Galb1- |
| 2(NeuAca2-3/6Galb1-4GlcNAcb1-6)Mana1- | 4GlcNAcb1-6)Mana1-6)Manb1-4GlcNAcb1-4(Fuca1- |
| 6)Manb1-4GlcNAcb1-4GlcNAc | 6)GlcNAcb |
| NeuAca2-3Galb1-4GlcNAcb1-2(NeuAca2-4Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-3Galb1-4GlcNAcb1-2(NeuAca2-3Galb1- | 4(NeuAca2-3Galb1-4GlcNAcb1-3Galb1-4GlcNAcb1- |
| 4GlcNAcb1-6)Mana1-6)Manb1-4GlcNAcb1-4(Fuca1- | 6)GlcNAcb1-2Mana1-6)Manb1-4GlcNAcb1-4(Fuca1- |
| 6)GlcNAc | 6)GlcNAc |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-3Galb1-4GlcNAcb1-2(NeuAca2-3Galb1- | 4GlcNAcb1-3Galb1-4GlcNAcb1-2(NeuAca2-3Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAcb | 6)GlcNAc |
| NeuAca2-3Galb1-4GlcNAcb1-2(NeuAca2-3Galb1- | GlcNAcb1-4(NeuGca2-3/6Galb1-4(Fuca1- |
| 4GlcNAcb1-4)Mana1-3(NeuAca2-3Galb1- | 3)GlcNAcb1-2(Galb1-4GlcNAcb1-4)Mana1- |
| 4GlcNAcb1-2(NeuAca2-3Galb1-4GlcNAcb1-3Galb1- | 3)(NeuAca2-3/6Galb1-4(Fuca1-3)GlcNAcb1- |
| 4GlcNAcb1-6)Mana1-6)Manb1-4GlcNAcb1-4(Fuca1- | 2(NeuAca2-3/6Galb1-4(Fuca1-3)GlcNAcb1- |
| 6)GlcNAc | 6)Mana1-6)Manb1-4GlcNAcb1-4(Fuca1-6)GlcNAc |
| NeuGca2-3/6Galb1-4(Fuca1-3)GlcNAcb1- | GlcNAcb1-4(Gala1-3Galb1-4(Fuca1-3)GlcNAcb1- |
| 2(GalNAcb1-4(Fuca1-3)GlcNAcb1-4)Mana1- | 2(NeuAca2-3/6Galb1-4GlcNAcb1-4)Mana1- |
| 3(NeuGca2-3/6Galb1-4(Fuca1-3)GlcNAcb1- | 3)(NeuAca2-3/6Galb1-4GlcNAcb1-2(NeuAca2- |
| 2(NeuAca2-3/6Galb1-4(Fuca1-3)GlcNAcb1- | 3/6Galb1-4(Fuca1-3)GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| NeuAca2-3/6Galb1-4(Fuca1-3)GlcNAcb1-2(Galb1- | NeuAca2-3/6Galb1-4(Fuca1-3)GlcNAcb1-2(Fuca1- |
| 4(Fuca1-3)GlcNAcb1-4)Mana1-3(NeuAca2- | 2Galb1-4(Fuca1-3)GlcNAcb1-4)Mana1-3(NeuAca2- |
| 3/6Galb1-4(Fuca1-3)GlcNAcb1-3Galb1-4GlcNAcb1- | 3/6Galb1-4(Fuca1-3)GlcNAcb1-3Galb1-4GlcNAcb1- |
| 2(NeuAca2-3/6Galb1-4GlcNAcb1-6)Mana1- | 2(Galb1-4(Fuca1-3)GlcNAcb1-6)Mana1-6)Manb1- |
| 6)Manb1-4GlcNAcb1-4GlcNAc | 4GlcNAcb1-4GlcNAc |
| GlcNAcb1-4(Fuca1-2Galb1-4(Fuca1-3)GlcNAcb1- | NeuGca2-8NeuGca2-3/6Galb1-4GlcNAcb1- |
| 2(Gala1-3Galb1-4GlcNAcb1-4)Mana1-3)(NeuAca2- | 2(NeuGca2-3/6Galb1-4GlcNAcb1-4)Mana1- |
| 3/6Galb1-4(Fuca1-3)GlcNAcb1-2(NeuAca2- | 3(NeuGca2-3/6Galb1-4GlcNAcb1-2(NeuGca2- |
| 3/6Galb1-4(Fuca1-3)GlcNAcb1-6)Mana1-6)Manb1- | 3/6Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Gala1-3Galb1-4(Fuca1-3)GlcNAcb1-2(NeuGca2- | NeuGca2-8NeuGca2-3/6Galb1-4(Fuca1- |
| 3/6Galb1-4GlcNAcb1-4)Mana1-3(NeuGca2- | 3)GlcNAcb1-3Galb1-4(Fuca1-3)GlcNAcb1- |
| 8NeuGca2-3/6Galb1-4GlcNAcb1-2(NeuGca2- | 2(NeuGca2-3/6Galb1-4(Fuca1-3)GlcNAcb1-3Galb1- |
| 3/6Galb1-4(Fuca1-3)GlcNAcb1-6)Mana1-6)Manb1- | 4GlcNAcb1-4)Mana1-3(Mana1-3(Mana1-6)Mana1- |
| 4GlcNAcb1-4GlcNAc | 6)Manb1-4GlcNAcb1-4GlcNAc |
| GlcNAcb1-4(NeuAca2-8NeuGca2-3/6Galb1- | NeuAca2-3/6Galb1-4GlcNAcb1-2(NeuGca2- |
| 4GlcNAcb1-2(NeuGca2-3/6Galb1-4GlcNAcb1- | 3/6Galb1-4GlcNAcb1-4)Mana1-3(NeuAca2- |
| 4)Mana1-3)(NeuAca2-3/6Galb1-4GlcNAcb1- | 3/6Galb1-4GlcNAcb1-3Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1-2(Galb1- |
| 2(GalNAcb1-4(Fuca1-3)GlcNAcb1-4)Mana1- | 4GlcNAcb1-4)Mana1-3(NeuAca2-8NeuAca2- |
| 3(NeuGca2-3/6Galb1-4(Fuca1-3)GlcNAcb1- | 3/6Galb1-4GlcNAcb1-3Galb1-4GlcNAcb1- |
| 2(NeuAca2-8NeuGca2-3/6Galb1-4GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4GlcNAc |
| GlcNAcb1-4(NeuGca2-3/6Galb1-4(Fuca1- | NeuAca2-3/6Galb1-4GlcNAcb1-2(NeuGca2- |
| 3)GlcNAcb1-2(NeuGca2-3/6Galb1-4GlcNAcb1- | 3/6Galb1-4GlcNAcb1-4)Mana1-3(Galb1-4GlcNAcb1- |
| 4)Mana1-3)(NeuAca2-3/6Galb1-4GlcNAcb1- | 2(NeuAca2-3/6Galb1-4GlcNAcb1-4)(NeuAca2- |
| 2(NeuAca2-3/6Galb1-4(Fuca1-3)GlcNAcb1- | 3/6Galb1-4GlcNAcb1-6)Mana1-6)Manb1- |
| 6)Mana1-6)Manb1-4GlcNAcb1-4GlcNAc | 4GlcNAcb1-4(Fuca1-6)GlcNAc |
| Gala1-3Galb1-4GlcNAcb1-2(NeuAca2-3/6Galb1- | GlcNAcb1-4(Gala1-3Galb1-4(Fuca1-3)GlcNAcb1- |
| 4GlcNAcb1-4)Mana1-3(NeuAca2-8NeuAca2- | 2(NeuGca2-3/6Galb1-4GlcNAcb1-4)Mana1- |
| 3/6Galb1-4GlcNAcb1-3Galb1-4GlcNAcb1- | 3)(NeuAca2-3/6Galb1-4GlcNAcb1-2(NeuAca2- |
| 2(NeuAca2-3/6Galb1-4GlcNAcb1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuAca2-8NeuAca2-3/6Galb1- | GlcNAcb1-4(NeuGca2-3/6Galb1-4(Fuca1- |
| 4GlcNAcb1-3Galb1-4GlcNAcb1-2(NeuAca2- | 3)GlcNAcb1-2(Galb1-4GlcNAcb1-4)Mana1- |
| 3/6Galb1-4(Fuca1-3)GlcNAcb1-3Galb1-4GlcNAcb1- | 3)(NeuGca2-3/6Galb1-4(Fuca1-3)GlcNAcb1- |
| 4)Mana1-3)(Mana1-3(Mana1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1-2(Galb1- |
| 2(GalNAcb1-4(Fuca1-3)GlcNAcb1-4)Mana1- | 4(Fuca1-3)GlcNAcb1-4)Mana1-3(NeuAca2- |
| 3(NeuGca2-3/6Galb1-4(Fuca1-3)GlcNAcb1- | 3/6Galb1-4(Fuca1-3)GlcNAcb1-3Galb1-4GlcNAcb1- |
| 2(NeuGca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4GlcNAc |
| Fuca1-2Galb1-4(Fuca1-3)GlcNAcb1-2(Gala1- | GlcNAcb1-4(NeuAca2-3/6Galb1-4(Fuca1- |
| 3Galb1-4GlcNAcb1-4)Mana1-3(NeuAca2-3/6Galb1- | 3)GlcNAcb1-3Galb1-4(Fuca1-3)GlcNAcb1- |
| 4(Fuca1-3)GlcNAcb1-3Galb1-4GlcNAcb1- | 2(NeuAca2-3/6Galb1-4(Fuca1-3)GlcNAcb1-3Galb1- |
| 2(NeuAca2-3/6Galb1-4(Fuca1-3)GlcNAcb1- | 4(Fuca1-3)GlcNAcb1-4)Mana1-3)(Mana1-3(Mana1- |
| 6)Mana1-6)Manb1-4GlcNAcb1-4GlcNAc | 6)Mana1-6)Manb1-4GlcNAcb1-4GlcNAc |
| NeuGca2-3/6Galb1-4(Fuca1-3)GlcNAcb1-2(Fuca1- | GlcNAcb1-4(Fuca1-2Galb1-4(Fuca1-3)GlcNAcb1- |
| 2Galb1-4(Fuca1-3)GlcNAcb1-4)Mana1-3(NeuAca2- | 2(Gala1-3Galb1-4GlcNAcb1-4)Mana1-3)(NeuGca2- |
| 3/6Galb1-4(Fuca1-3)GlcNAcb1-3Galb1-4GlcNAcb1- | 3/6Galb1-4(Fuca1-3)GlcNAcb1-2(NeuAca2- |
| 2(Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4GlcNAc | 4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-3Galb1-4(Fuca1-3)GlcNAcb1- | 3)GlcNAcb1-2(GalNAcb1-4GlcNAcb1-4)Mana1- |
| 2(NeuAca2-3/6Galb1-4(Fuca1-3)GlcNAcb1-3Galb1- | 3)(NeuAca2-3/6Galb1-4(Fuca1-3)GlcNAcb1- |
| 4GlcNAcb1-4)Mana1-3)(Mana1-3(Mana1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(NeuGca2-8NeuGca2-3/6Galb1- |
| 3)GlcNAcb1-2(GalNAcb1-4(Fuca1-3)GlcNAcb1- | 4GlcNAcb1-2(NeuGca2-3/6Galb1-4GlcNAcb1- |
| 4)Mana1-3)(NeuAca2-3/6Galb1-4(Fuca1- | 4)Mana1-3)(NeuAca2-3/6Galb1-4GlcNAcb1- |
| 3)GlcNAcb1-2(NeuAca2-3/6Galb1-4(Fuca1- | 2(NeuAca2-3/6Galb1-4GlcNAcb1-6)Mana1- |
| 3)GlcNAcb1-6)Mana1-6)Manb1-4GlcNAcb1-4GlcNAc | 6)Manb1-4GlcNAcb1-4GlcNAc |
| NeuGca2-3/6Galb1-4GlcNAcb1-2(NeuGca2- | Gala1-3Galb1-4GlcNAcb1-2(NeuGca2-3/6Galb1- |
| 3/6Galb1-4GlcNAcb1-4)Mana1-3(NeuAca2- | 4GlcNAcb1-4)Mana1-3(NeuAca2-8NeuAca2- |
| 3/6Galb1-4GlcNAcb1-3Galb1-4GlcNAcb1- | 3/6Galb1-4GlcNAcb1-3Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4(Fuca1-6)GlcNAc | 6)Manb1-4GlcNAcb1-4GlcNAc |
| NeuGca2-3/6Galb1-4(Fuca1-3)GlcNAcb1- | NeuGca2-3/6Galb1-4GlcNAcb1-2(NeuGca2- |
| 2(GalNAcb1-4(Fuca1-3)GlcNAcb1-4)Mana1- | 3/6Galb1-4GlcNAcb1-4)Mana1-3(Galb1-4GlcNAcb1- |
| 3(NeuGca2-3/6Galb1-4(Fuca1-3)GlcNAcb1- | 2(NeuAca2-3/6Galb1-4GlcNAcb1-4)(NeuAca2- |
| 2(NeuGca2-8NeuGca2-3/6Galb1-4GlcNAcb1- | 3/6Galb1-4GlcNAcb1-6)Mana1-6)Manb1- |
| 6)Mana1-6)Manb1-4GlcNAcb1-4GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuAca2-8NeuGca2- | 3)GlcNAcb1-2(NeuGca2-3/6Galb1-4GlcNAcb1- |
| 3/6Galb1-4GlcNAcb1-3Galb1-4GlcNAcb1- | 4)Mana1-3)(NeuGca2-3/6Galb1-4GlcNAcb1- |
| 2(NeuAca2-3/6Galb1-4GlcNAcb1-6)Mana1- | 2(NeuAca2-3/6Galb1-4(Fuca1-3)GlcNAcb1- |
| 6)Manb1-4GlcNAcb1-4GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuAca2-8NeuAca2-3/6Galb1- |
| 3)GlcNAcb1-2(Galb1-4GlcNAcb1-4)Mana1- | 4GlcNAcb1-3Galb1-4GlcNAcb1-2(NeuGca2- |
| 3)(NeuGca2-3/6Galb1-4(Fuca1-3)GlcNAcb1- | 3/6Galb1-4(Fuca1-3)GlcNAcb1-3Galb1-4GlcNAcb1- |
| 2(NeuGca2-3/6Galb1-4(Fuca1-3)GlcNAcb1- | 4)Mana1-3)(Mana1-3(Mana1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(Gala1-3Galb1-4(Fuca1-3)GlcNAcb1- |
| 4(Fuca1-3)GlcNAcb1-4)Mana1-3(NeuGca2- | 2(NeuGca2-3/6Galb1-4GlcNAcb1-4)Mana1- |
| 3/6Galb1-4(Fuca1-3)GlcNAcb1-3Galb1-4GlcNAcb1- | 3)(NeuGca2-3/6Galb1-4GlcNAcb1-2(NeuAca2- |
| 2(NeuAca2-3/6Galb1-4GlcNAcb1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(Fuca1-2Galb1-4(Fuca1-3)GlcNAcb1- | GlcNAcb1-4(NeuAca2-3/6Galb1-4(Fuca1- |
| 2(Gala1-3Galb1-4GlcNAcb1-4)Mana1-3)(NeuGca2- | 3)GlcNAcb1-3Galb1-4(Fuca1-3)GlcNAcb1- |
| 3/6Galb1-4(Fuca1-3)GlcNAcb1-2(NeuGca2- | 2(NeuGca2-3/6Galb1-4(Fuca1-3)GlcNAcb1-3Galb1- |
| 3/6Galb1-4(Fuca1-3)GlcNAcb1-6)Mana1-6)Manb1- | 4(Fuca1-3)GlcNAcb1-4)Mana1-3)(Mana1-3(Mana1- |
| 4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1-2(Fuca1- | GlcNAcb1-4(NeuAca2-3/6Galb1-4(Fuca1- |
| 2Galb1-4(Fuca1-3)GlcNAcb1-4)Mana1-3(NeuGca2- | 3)GlcNAcb1-3Galb1-4(Fuca1-3)GlcNAcb1- |
| 3/6Galb1-4(Fuca1-3)GlcNAcb1-3Galb1-4GlcNAcb1- | 2(NeuGca2-3/6Galb1-4(Fuca1-3)GlcNAcb1-3Galb1- |
| 2(Galb1-4(Fuca1-3)GlcNAcb1-6)Mana1-6)Manb1- | 4GlcNAcb1-4)Mana1-3)(Mana1-3(Mana1-6)Mana1- |
| 4GlcNAcb1-4GlcNAc | 6)Manb1-4GlcNAcb1-4(Fuca1-6)GlcNAc |
| Fuca1-2Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3(NeuGca2-3/6Galb1- | 3)GlcNAcb1-2(GalNAcb1-4(Fuca1-3)GlcNAcb1- |
| 4(Fuca1-3)GlcNAcb1-3Galb1-4GlcNAcb1- | 4)Mana1-3)(NeuAca2-3/6Galb1-4(Fuca1- |
| 2(NeuAca2-3/6Galb1-4(Fuca1-3)GlcNAcb1- | 3)GlcNAcb1-2(NeuAca2-3/6Galb1-4(Fuca1- |
| 6)Mana1-6)Manb1-4GlcNAcb1-4GlcNAc | 3)GlcNAcb1-6)Mana1-6)Manb1-4GlcNAcb1-4GlcNAc |
| GlcNAcb1-4(NeuGca2-3/6Galb1-4(Fuca1- | GlcNAcb1-4(NeuGca2-8NeuGca2-3/6Galb1- |
| 3)GlcNAcb1-2(GalNAcb1-4GlcNAcb1-4)Mana1- | 4GlcNAcb1-2(NeuGca2-3/6Galb1-4GlcNAcb1- |
| 3)(NeuAca2-3/6Galb1-4(Fuca1-3)GlcNAcb1- | 4)Mana1-3)(NeuGca2-3/6Galb1-4GlcNAcb1- |
| 2(NeuAca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4GlcNAc |
| NeuGca2-3/6Galb1-4GlcNAcb1-2(NeuGca2- | Gala1-3Galb1-4GlcNAcb1-2(NeuGca2-3/6Galb1- |
| 3/6Galb1-4GlcNAcb1-4)Mana1-3(NeuGca2- | 4GlcNAcb1-4)Mana1-3(NeuAca2-8NeuGca2- |
| 3/6Galb1-4GlcNAcb1-3Galb1-4GlcNAcb1- | 3/6Galb1-4GlcNAcb1-3Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4(Fuca1-6)GlcNAc | 6)Manb1-4GlcNAcb1-4GlcNAc |
| NeuGca2-3/6Galb1-4(Fuca1-3)GlcNAcb1-2(Galb1- | NeuGca2-3/6Galb1-4GlcNAcb1-2(NeuGca2- |
| 4GlcNAcb1-4)Mana1-3(NeuGca2-8NeuGca2- | 3/6Galb1-4GlcNAcb1-4)Mana1-3(Galb1-4GlcNAcb1- |
| 3/6Galb1-4GlcNAcb1-3Galb1-4GlcNAcb1- | 2(NeuGca2-3/6Galb1-4GlcNAcb1-4)(NeuAca2- |
| 2(NeuAca2-3/6Galb1-4GlcNAcb1-6)Mana1- | 3/6Galb1-4GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuGca2-3/6Galb1-4(Fuca1- | GlcNAcb1-4(NeuAca2-8NeuGca2-3/6Galb1- |
| 3)GlcNAcb1-2(NeuGca2-3/6Galb1-4GlcNAcb1- | 4GlcNAcb1-3Galb1-4GlcNAcb1-2(NeuGca2- |
| 4)Mana1-3)(NeuGca2-3/6Galb1-4GlcNAcb1- | 3/6Galb1-4(Fuca1-3)GlcNAcb1-3Galb1-4GlcNAcb1- |
| 2(NeuGca2-3/6Galb1-4(Fuca1-3)GlcNAcb1- | 4)Mana1-3)(Mana1-3(Mana1-6)Mana1-6)Manb1- |
| 6)Mana1-6)Manb1-4GlcNAcb1-4GlcNAc | 4GlcNAcb1-4(Fuca1-6)GlcNAc |
| NeuGca2-3/6Galb1-4(Fuca1-3)GlcNAcb1-2(Galb1- | GlcNAcb1-4(Gala1-3Galb1-4(Fuca1-3)GlcNAcb1- |
| 4(Fuca1-3)GlcNAcb1-4)Mana1-3(NeuGca2- | 2(NeuGca2-3/6Galb1-4GlcNAcb1-4)Mana1- |
| 3/6Galb1-4(Fuca1-3)GlcNAcb1-3Galb1-4GlcNAcb1- | 3)(NeuGca2-3/6Galb1-4GlcNAcb1-2(NeuGca2- |
| 2(NeuGca2-3/6Galb1-4GlcNAcb1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuGca2-3/6Galb1-4(Fuca1- | Fuca1-2Galb1-4(Fuca1-3)GlcNAcb1-2(Gala1- |
| 3)GlcNAcb1-3Galb1-4(Fuca1-3)GlcNAcb1- | 3Galb1-4GlcNAcb1-4)Mana1-3(NeuGca2-3/6Galb1- |
| 2(NeuGca2-3/6Galb1-4(Fuca1-3)GlcNAcb1-3Galb1- | 4(Fuca1-3)GlcNAcb1-3Galb1-4GlcNAcb1- |
| 4(Fuca1-3)GlcNAcb1-4)Mana1-3)(Mana1-3(Mana1- | 2(NeuGca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuAca2-3/6Galb1-4GlcNAcb1- |
| 3)GlcNAcb1-3Galb1-4(Fuca1-3)GlcNAcb1- | 2(NeuAca2-3/6Galb1-4GlcNAcb1-4)Mana1- |
| 2(NeuGca2-3/6Galb1-4(Fuca1-3)GlcNAcb1-3Galb1- | 3)(Galb1-4GlcNAcb1-2(NeuAca2-3/6Galb1- |
| 4GlcNAcb1-4)Mana1-3)(Mana1-3(Mana1-6)Mana1- | 4GlcNAcb1-4)(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4GlcNAcb1- | GlcNAcb1-4(NeuGca2-3/6Galb1-4(Fuca1- |
| 2(NeuAca2-3/6Galb1-4GlcNAcb1-4)Mana1- | 3)GlcNAcb1-2(GalNAcb1-4GlcNAcb1-4)Mana1- |
| 3)(NeuAca2-3/6Galb1-4GlcNAcb1-3Galb1- | 3)(NeuGca2-3/6Galb1-4(Fuca1-3)GlcNAcb1- |
| 4GlcNAcb1-2(NeuAca2-3/6Galb1-4GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(GalNAcb1-4(Fuca1-3)GlcNAcb1- | 3)GlcNAcb1-2(Galb1-4GlcNAcb1-4)Mana1- |
| 4)Mana1-3)(NeuGca2-3/6Galb1-4(Fuca1- | 3)(NeuAca2-3/6Galb1-4GlcNAcb1-3Galb1- |
| 3)GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(Galb1-4(Fuca1-3)GlcNAcb1-2(Fuca1- | GlcNAcb1-4(NeuGca2-8NeuGca2-3/6Galb1- |
| 2Galb1-4(Fuca1-3)GlcNAcb1-4)Mana1-3)(NeuAca2- | 4GlcNAcb1-2(NeuGca2-3/6Galb1-4GlcNAcb1- |
| 3/6Galb1-4(Fuca1-3)GlcNAcb1-3Galb1-4GlcNAcb1- | 4)Mana1-3)(NeuGca2-3/6Galb1-4GlcNAcb1- |
| 2(Galb1-4(Fuca1-3)GlcNAcb1-6)Mana1-6)Manb1- | 2(NeuGca2-3/6Galb1-4GlcNAcb1-6)Mana1- |
| 4GlcNAcb1-4(Fuca1-6)GlcNAc | 6)Manb1-4GlcNAcb1-4GlcNAc |
| NeuGca2-3/6Galb1-4(Fuca1-3)GlcNAcb1-2(Galb1- | Gala1-3Galb1-4GlcNAcb1-2(NeuGca2-3/6Galb1- |
| 4GlcNAcb1-4)Mana1-3(NeuGca2-8NeuGca2- | 4GlcNAcb1-4)Mana1-3(NeuGca2-8NeuGca2- |
| 3/6Galb1-4GlcNAcb1-3Galb1-4GlcNAcb1- | 3/6Galb1-4GlcNAcb1-3Galb1-4GlcNAcb1- |
| 2(NeuGca2-3/6Galb1-4GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4GlcNAc |
| NeuGca2-3/6Galb1-4GlcNAcb1-2(NeuGca2- | GlcNAcb1-4(NeuGca2-8NeuGca2-3/6Galb1- |
| 3/6Galb1-4GlcNAcb1-4)Mana1-3(NeuGca2- | 4GlcNAcb1-3Galb1-4GlcNAcb1-2(NeuGca2- |
| 3/6Galb1-4GlcNAcb1-3Galb1-4GlcNAcb1- | 3/6Galb1-4(Fuca1-3)GlcNAcb1-3Galb1-4GlcNAcb1- |
| 2(NeuGca2-3/6Gab1-4GlcNAcb1-6)Mana1- | 4)Mana1-3)(Mana1-3(Mana1-6)Mana1-6)Manb1- |
| 6)Manb1-4GlcNAcb1-4(Fuca1-6)GlcNAc | 4GlcNAcb1-4(Fuca1-6)GlcNAc |
| NeuAca2-8NeuAca2-3/6Galb1-4(Fuca1-3)GlcNAcb1- | GlcNAcb1-4(NeuAca2-3/6Galb1-4GlcNAcb1- |
| 2(NeuAca2-3/6Galb1-4GlcNAcb1-4)Mana1- | 2(NeuGca2-3/6Galb1-4GlcNAcb1-4)Mana1- |
| 3(NeuAca2-3/6Galb1-4GlcNAcb1-2(NeuAca2- | 3)(NeuAca2-3/6Galb1-4GlcNAcb1-3Galb1- |
| 3/6Galb1-4(Fuca1-3)GlcNAcb1-6)Mana1-6)Manb1- | 4GlcNAcb1-2(NeuAca2-3/6Galb1-4GlcNAcb1- |
| 4GlcNAcb1-4GlcNAc | 6)Mana1-6)Manb1-4GlcNAcb1-4GlcNAc |
| GlcNAcb1-4(NeuAca2-3/6Galb1-4GlcNAcb1- | GlcNAcb1-4(NeuGca2-3/6Galb1-4cFuca1- |
| 2(NeuGca2-3/6Galb1-4GlcNAcb1-4)Mana1- | 3)GlcNAcb1-2(GalNAcb1-4GlcNAcb1-4)Mana1- |
| 3)(Galb1-4GlcNAcb1-2(NeuAca2-3/6Galb1- | 3)(NeuGca2-3/6Galb1-4(Fuca1-3)GlcNAcb1- |
| 4GlcNAcb1-4)(NeuAca2-3/6Galb1-4GlcNAcb1- | 2(NeuGca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GalNAcb1-4(Fuca1-3)GlcNAcb1- |
| 3)(NeuAca2-3/6Galb1-4GlcNAcb1-3Galb1- | 4)Mana1-3)(NeuGca2-3/6Galb1-4(Fuca1- |
| 4GlcNAcb1-2(NeuAca2-3/6Galb1-4GlcNAcb1- | 3)GlcNAcb1-2(NeuGca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| NeuAca2-3Galb1-4GlcNAcb1-2(Galb1-4GlcNAcb1- | Galb1-4GlcNAcb1-2(NeuAca2-3Galb1-4GlcNAcb1- |
| 4)Mana1-3(NeuAca2-3Galb1-4GlcNAcb1-3Galb1- | 4)Mana1-3(NeuAca2-3Galb1-4GlcNAcb1-3Galb1- |
| 4GlcNAcb1-2(NeuAca2-3Galb1-4GlcNAcb1-3Galb1- | 4GlcNAcb1-2(NeuAca2-3Galb1-4GlcNAcb1-3Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| NeuAca2-3Galb1-4GlcNAcb1-2(Galb1-4GlcNAcb1- | GlcNAcb1-4(Gala1-3Galb1-4GlcNAcb1-2(Galb1- |
| 4)Mana1-3(NeuAca2-3Galb1-4GlcNAcb1-3Galb1- | 4GlcNAcb1-4)Mana1-3)(NeuAca2-8NeuAca2- |
| 4GlcNAcb1-2(NeuAca2-3Galb1-4GlcNAcb1-3Galb1- | 3/6Galb1-4GlcNAcb1-3Galb1-4GlcNAcb1- |
| 4GlcNAcb1-6)Mana1-6)Manb1-4GlcNAcb1-4(Fuca1- | 2(NeuAca2-3/6Galb1-4GlcNAcb1-6)Mana1- |
| 6)GlcNAcb | 6)Manb1-4GlcNAcb1-4(Fuca1-6)GlcNAc |
| NeuAca2-3/6Galb1-4(Fuca1-3)GlcNAcb1-2(Fuca1- | GlcNAcb1-4(Fuca1-2Galb1-4(Fuca1-3)GlcNAcb1- |
| 2Galb1-4(Fuca1-3)GlcNAcb1-4)Mana1-3(NeuAca2- | 2(Gala1-3Galb1-4GlcNAcb1-4)Mana1-3)(NeuAca2- |
| 3/6Galb1-4(Fuca1-3)GlcNAcb1-2(NeuAca2- | 3/6Galb1-4(Fuca1-3)GlcNAcb1-3Galb1-4GlcNAcb1- |
| 3/6Galb1-4(Fuca1-3)GlcNAcb1-6)Mana1-6)Manb1- | 2(Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Galb1-4(Fuca1-3)GlcNAcb1-2(Fuca1- | Gala1-3Galb1-4GlcNAcb1-2(NeuGca2-3/6Galb1- |
| 2Galb1-4(Fuca1-3)GlcNAcb1-4)Mana1-3)(NeuGca2- | 4GlcNAcb1-4)Mana1-3(NeuGca2-8NeuGca2- |
| 3/6Galb1-4(Fuca1-3)GlcNAcb1-3Galb1-4GlcNAcb1- | 3/6Galb1-4GlcNAcb1-3Galb1-4GlcNAcb1- |
| 2(Galb1-4(Fuca1-3)GlcNAcb1-6)Mana1-6)Manb1- | 2(NeuGca2-3/6Galb1-4GlcNAcb1-6)Mana1- |
| 4GlcNAcb1-4(Fuca1-6)GlcNAc | 6)Manb1-4GlcNAcb1-4GlcNAc |
| NeuAca2-8NeuAca2-3/6Galb1-4(Fuca1-3)GlcNAcb1- | NeuAca2-8NeuAca2-3/6Galb1-4(Fuca1-3)GlcNAcb1- |
| 2(NeuGca2-3/6Galb1-4GlcNAcb1-4)Mana1- | 2(NeuAca2-3/6Galb1-4GlcNAcb1-4)Mana1- |
| 3(NeuAca2-3/6Galb1-4GlcNAcb1-2(NeuAca2- | 3(NeuAca2-8NeuAca2-3/6Galb1-4GlcNAcb1- |
| 3/6Galb1-4(Fuca1-3)GlcNAcb1-6)Mana1-6)Manb1- | 2(Gala1-3Galb1-4GlcNAcb1-6)Mana1-6)Manb1- |
| 4GlcNAcb1-4GlcNAc | 4GlcNAcb1-4GlcNAc |
| GlcNAcb1-4(NeuGca2-3/6Galb1-4GlcNAcb1- | GlcNAcb1-4(NeuGca2-3/6Galb1-4GlcNAcb1- |
| 2(NeuGca2-3/6Galb1-4GlcNAcb1-4)Mana1- | 2(NeuGca2-3/6Galb1-4GlcNAcb1-4)Mana1- |
| 3)(NeuAca2-3/6Galb1-4GlcNAcb1-3Galb1- | 3)(Galb1-4GlcNAcb1-2(NeuAca2-3/6Galb1- |
| 4GlcNAcb1-2(NeuAca2-3/6Galb1-4GlcNAcb1- | 4GlcNAcb1-4)(NeuAca2-3/6Galb1-4GlcNAcb1- |
| 6)Mana1-6)Manb1-4GlcNAcb1-4GlcNAc | 6)Mana1-6)Manb1-4GlcNAcb1-4GlcNAc |
| Gala1-3Galb1-4(Fuca1-3)GlcNAcb1-2(Galb1- | Gala1-3Galb1-4(Fuca1-3)GlcNAcb1-2(NeuAca2- |
| 4GlcNAcb1-4)Mana1-3(NeuAca2-8NeuAca2- | 3/6Galb1-4GlcNAcb1-4)Mana1-3(NeuAca2- |
| 3/6Galb1-4(Fuca1-3)GlcNAcb1-2(NeuAca2- | 8NeuAca2-3/6Galb1-4GlcNAcb1-2(NeuAca2- |
| 8NeuAca2-3/6Galb1-4(Fuca1-3)GlcNAcb1-6)Mana1- | 3/6Galb1-4(Fuca1-3)GlcNAcb1-6)Mana1-6)Manb1- |
| 6)Manb1-4GlcNAcb1-4GlcNAc | 4GlcNAcb1-4(Fuca1-6)GlcNAc |
| GlcNAcb1-4(NeuGca2-3/6Galb1-4(Fuca1- | GlcNAcb1-4(Gala1-3Galb1-4GlcNAcb1-2(Galb1- |
| 3)GlcNAcb1-2(Galb1-4GlcNAcb1-4)Mana1- | 4GlcNAcb1-4)Mana1-3)(NeuAca2-8NeuGca2- |
| 3)(NeuGca2-3/6Galb1-4GlcNAcb1-3Galb1- | 3/6Galb1-4GlcNAcb1-3Galb1-4GlcNAcb1- |
| 4GlcNAcb1-2(NeuAca2-3/6Galb1-4GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuGca2-3/6Galb1-4(Fuca1-3)GlcNAcb1-2(Fuca1- | GlcNAcb1-4(Galb1-4(Fuca1-3)GlcNAcb1-3Galb1- |
| 2Galb1-4(Fuca1-3)GlcNAcb1-4)Mana1-3(NeuAca2- | 4(Fuca1-3)GlcNAcb1-2(Gala1-3Galb1-4GlcNAcb1- |
| 3/6Galb1-4(Fuca1-3)GlcNAcb1-2(NeuAca2- | 4)Mana1-3)(Gala1-3Galb1-4GlcNAcb1-2(NeuAca2- |
| 3/6Galb1-4(Fuca1-3)GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(Fuca1-2Galb1-4(Fuca1-3)GlcNAcb1- | NeuAca2-8NeuGca2-3/6Galb1-4(Fuca1- |
| 2(Gala1-3Galb1-4GlcNAcb1-4)Mana1-3)(NeuGca2- | 3)GlcNAcb1-2(NeuGca2-3/6Galb1-4GlcNAcb1- |
| 3/6Galb1-4(Fuca1-3)GlcNAcb1-3Galb1-4GlcNAcb1- | 4)Mana1-3(NeuAca2-3/6Galb1-4GlcNAcb1- |
| 2(Galb1-4(Fuca1-3)GlcNAcb1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4GlcNAc |
| NeuAca2-8NeuAca2-3/6Galb1-4(Fuca1-3)GlcNAcb1- | GlcNAcb1-4(NeuGca2-3/6Galb1-4GlcNAcb1- |
| 2(NeuGca2-3/6Galb1-4GlcNAcb1-4)Mana1- | 2(NeuGca2-3/6Galb1-4GlcNAcb1-4)Mana1- |
| 3(NeuAca2-8NeuAca2-3/6Galb1-4GlcNAcb1- | 3)(NeuGca2-3/6Galb1-4GlcNAcb1-3Galb1- |
| 2(Gala1-3Galb1-4GlcNAcb1-6)Mana1-6)Manb1- | 4GlcNAcb1-2(NeuAca2-3/6Galb1-4GlcNAcb1- |
| 4GlcNAcb1-4GlcNAc | 6)Mana1-6)Manb1-4GlcNAcb1-4GlcNAc |
| GlcNAcb1-4(NeuGca2-3/6Galb1-4GlcNAcb1- | Gala1-3Galb1-4(Fuca1-3)GlcNAcb1-2(NeuGca2- |
| 2(NeuGca2-3/6Galb1-4GlcNAcb1-4)Mana1- | 3/6Galb1-4GlcNAcb1-4)Mana1-3(NeuAca2- |
| 3)(Galb1-4GlcNAcb1-2(NeuGca2-3/6Galb1- | 8NeuAca2-3/6Galb1-4GlcNAcb1-2(NeuAca2- |
| 4GlcNAcb1-4)(NeuAca2-3/6Galb1-4GlcNAcb1- | 3/6Galb1-4(Fuca1-3)GlcNAcb1-6)Mana1-6)Manb1- |
| 6)Mana1-6)Manb1-4GlcNAcb1-4GlcNAc | 4GlcNAcb1-4(Fuca1-6)GlcNAc |
| Gala1-3Galb1-4(Fuca1-3)GlcNAcb1-2(Galb1- | GlcNAcb1-4(Gala1-3Galb1-4GlcNAcb1-2(Galb1- |
| 4GlcNAcb1-4)Mana1-3(NeuAca2-8NeuGca2- | 4GlcNAcb1-4)Mana1-3)(NeuGca2-8NeuGca2- |
| 3/6Galb1-4(Fuca1-3)GlcNAcb1-2(NeuAca2- | 3/6Galb1-4GlcNAcb1-3Galb1-4GlcNAcb1- |
| 8NeuAca2-3/6Galb1-4(Fuca1-3)GlcNAcb1-6)Mana1- | 2(NeuAca2-3/6Galb1-4GlcNAcb1-6)Mana1- |
| 6)Manb1-4GlcNAcb1-4GlcNAc | 6)Manb1-4GlcNAcb1-4(Fuca1-6)GlcNAc |
| GlcNAcb1-4(NeuGca2-3/6Galb1-4(Fuca1- | NeuAca2-8NeuAca2-3/6Galb1-4(Fuca1-3)GlcNAcb1- |
| 3)GlcNAcb1-2(Galb1-4GlcNAcb1-4)Mana1- | 3Galb1-4(Fuca1-3)GlcNAcb1-2(NeuAca2-3/6Galb1- |
| 3)(NeuGca2-3/6Galb1-4GlcNAcb1-3Galb1- | 4(Fuca1-3)GlcNAcb1-3Galb1-4GlcNAcb1-4)Mana1- |
| 4GlcNAcb1-2(NeuGca2-3/6Galb1-4GlcNAcb1- | 3(Mana1-3(Mana1-6)Mana1-6)Manb1-4GlcNAcb1- |
| 6)Mana1-6)Manb1-4GlcNAcb1-4(Fuca1-6)GlcNAc | 4(Fuca1-6)GlcNAc |
| NeuGca2-3/6Galb1-4(Fuca1-3)GlcNAcb1-2(Fuca1- | GlcNAcb1-4(NeuAca2-8NeuAca2-3/6Galb1- |
| 2Galb1-4(Fuca1-3)GlcNAcb1-4)Mana1-3(NeuGca2- | 4GlcNAcb1-3Galb1-4GlcNAcb1-2(Gala1-3Galb1- |
| 3/6Galb1-4(Fuca1-3)GlcNAcb1-2(NeuAca2- | 4GlcNAcb1-4)Mana1-3)(Gala1-3Galb1-4GlcNAcb1- |
| 3/6Galb1-4(Fuca1-3)GlcNAcb1-6)Mana1-6)Manb1- | 2(Gala1-3Galb1-4GlcNAcb1-6)Mana1-6)Manb1- |
| 4GlcNAcb1-4(Fuca1-6)GlcNAc | 4GlcNAcb1-4(Fuca1-6)GlcNAc |
| Galb1-3Galb1-4GlcNAcb1-2(Galb1-3Galb1- | GlcNAcb1-4(NeuAca2-3/6Galb1-4(Fuca1- |
| 4GlcNAcb1-4)Mana1-3(NeuAca2-6Galb1- | 3)GlcNAcb1-3Galb1-4(Fuca1-3)GlcNAcb1-2(Gala1- |
| 4GlcNAcb1-3Galb1-4GlcNAcb1-2(NeuAca2-6Galb1- | 3Galb1-4GlcNAcb1-4)Mana1-3)(Gala1-3Galb1- |
| 4GlcNAcb1-3Galb1-4GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4(Fuca1-6)GlcNAc |
| GlcNAcb1-4(Galb1-4(Fuca1-3)GlcNAcb1-3Galb1- | NeuAca2-3/6Galb1-4(Fuca1-3)GlcNAcb1- |
| 4(Fuca1-3)GlcNAcb1-2(Gala1-3Galb1-4GlcNAcb1- | 2(GalNAcb1-4(Fuca1-3)GlcNAcb1-4)Mana1- |
| 4)Mana1-3)(Gala1-3Galb1-4GlcNAcb1-2(NeuGca2- | 3(NeuAca2-3/6Galb1-4(Fuca1-3)GlcNAcb1- |
| 3/6Galb1-4(Fuca1-3)GlcNAcb1-6)Mana1-6)Manb1- | 2(NeuAca2-8NeuAca2-3/6Galb1-4GlcNAcb1- |
| 4GlcNAcb1-4(Fuca1-6)GlcNAc | 6)Mana1-6)Manb1-4GlcNAcb1-4(Fuca1-6)GlcNAc |
| NeuGca2-8NeuGca2-3/6Galb1-4(Fuca1- | NeuAca2-8NeuGca2-3/6Galb1-4(Fuca1- |
| 3)GlcNAcb1-2(NeuGca2-3/6Galb1-4GlcNAcb1- | 3)GlcNAcb1-2(NeuGca2-3/6Galb1-4GlcNAcb1- |
| 4)Mana1-3(NeuAca2-3/6Galb1-4GlcNAcb1- | 4)Mana1-3(NeuAca2-8NeuAca2-3/6Galb1- |
| 2(NeuAca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4GlcNAc |
| GlcNAcb1-4(NeuGca2-3/6Galb1-4GlcNAcb1- | Gala1-3Galb1-4(Fuca1-3)GlcNAcb1-2(Galb1- |
| 2(NeuGca2-3/6Galb1-4GlcNAcb1-4)Mana1- | 4GlcNAcb1-4)Mana1-3(NeuGca2-8NeuGca2- |
| 3)(NeuGca2-3/6Galb1-4GlcNAcb1-3Galb1- | 3/6Galb1-4(Fuca1-3)GlcNAcb1-2(NeuAca2- |
| 4GlcNAcb1-2(NeuGca2-3/6Galb1-4GlcNAcb1- | 8NeuAca2-3/6Galb1-4(Fuca1-3)GlcNAcb1-6)Mana1- |
| 6)Mana1-6)Manb1-4GlcNAcb1-4GlcNAc | 6)Manb1-4GlcNAcb1-4GlcNAc |
| Gala1-3Galb1-4(Fuca1-3)GlcNAcb1-2(NeuGca2- | GlcNAcb1-4(Gala1-3Galb1-4GlcNAcb1-2(Galb1- |
| 3/6Galb1-4GlcNAcb1-4)Mana1-3(NeuAca2- | 4GlcNAcb1-4)Mana1-3)(NeuGca2-8NeuGca2- |
| 8NeuGca2-3/6Galb1-4GlcNAcb1-2(NeuAca2- | 3/6Galb1-4GlcNAcb1-3Galb1-4GlcNAcb1- |
| 3/6Galb1-4(Fuca1-3)GlcNAcb1-6)Mana1-6)Manb1- | 2(NeuGca2-3/6Galb1-4GlcNAcb1-6)Mana1- |
| 4GlcNAcb1-4(Fuca1-6)GlcNAc | 6)Manb1-4GlcNAcb1-4(Fuca1-6)GlcNAc |
| NeuAca2-8NeuAca2-3/6Galb1-4(Fuca1-3)GlcNAcb1- | NeuGca2-3/6Galb1-4(Fuca1-3)GlcNAcb1-2(Fuca1- |
| 3Galb1-4(Fuca1-3)GlcNAcb1-2(NeuGca2-3/6Galb1- | 2Galb1-4(Fuca1-3)GlcNAcb1-4)Mana1-3(NeuGca2- |
| 4(Fuca1-3)GlcNAcb1-3Galb1-4GlcNAcb1-4)Mana1- | 3/6Galb1-4(Fuca1-3)GlcNAcb1-2(NeuGca2- |
| 3(Mana1-3(Mana1-6)Mana1-6)Manb1-4GlcNAcb1- | 3/6Galb1-4(Fuca1-3)GlcNAcb1-6)Mana1-6)Manb1- |
| 4(Fuca1-6)GlcNAc | 4GlcNAcb1-4(Fuca1-6)GlcNAc |
| GlcNAcb1-4(NeuAca2-8NeuGca2-3/6Galb1- | GlcNAcb1-4(NeuGca2-3/6Galb1-4(Fuca1- |
| 4GlcNAcb1-3Galb1-4GlcNAcb1-2(Gala1-3Galb1- | 3)GlcNAcb1-3Galb1-4(Fuca1-3)GlcNAcb1-2(Gala1- |
| 4GlcNAcb1-4)Mana1-3)(Gala1-3Galb1-4GlcNAcb1- | 3Galb1-4GlcNAcb1-4)Mana1-3)(Gala1-3Galb1- |
| 2(Gala1-3Galb1-4GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4(Fuca1-6)GlcNAc |
| GlcNAcb1-4(NeuAca2-8NeuAca2-3/6Galb1- | NeuGca2-3/6Galb1-4(Fuca1-3)GlcNAcb1- |
| 4GlcNAcb1-2(NeuAca2-3/6Galb1-4GlcNAcb1- | 2(GalNAcb1-4(Fuca1-3)GlcNAcb1-4)Mana1- |
| 4)Mana1-3)(NeuAca2-3/6Galb1-4GlcNAcb1- | 3(NeuAca2-3/6Galb1-4(Fuca1-3)GlcNAcb1- |
| 2(NeuAca2-3/6Galb1-4GlcNAcb1-6)Mana1- | 2(NeuAca2-8NeuAca2-3/6Galb1-4GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(NeuAca2-3/6Galb1-4GlcNAcb1- | 3)GlcNAcb1-2(Fuca1-2Galb1-4(Fuca1-3)GlcNAcb1- |
| 4)Mana1-3)(NeuAca2-3/6Galb1-4GlcNAcb1- | 4)Mana1-3)(NeuAca2-3/6Galb1-4(Fuca1- |
| 2(NeuAca2-3/6Galb1-4(Fuca1-3)GlcNAcb1- | 3)GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1-4GlcNAc |
| NeuGca2-8NeuGca2-3/6Galb1-4(Fuca1- | NeuGca2-8NeuGca2-3/6Galb1-4(Fuca1- |
| 3)GlcNAcb1-2(NeuGca2-3/6Galb1-4GlcNAcb1- | 3)GlcNAcb1-2(NeuGca2-3/6Galb1-4GlcNAcb1- |
| 4)Mana1-3(NeuGca2-3/6Galb1-4GlcNAcb1- | 4)Mana1-3(NeuAca2-8NeuAca2-3/6Galb1- |
| 2(NeuAca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4GlcNAc |
| Gala1-3Galb1-4(Fuca1-3)GlcNAcb1-2(NeuGca2- | Gala1-3Galb1-4(Fuca1-3)GlcNAcb1-2(Galb1- |
| 3/6Galb1-4GlcNAcb1-4)Mana1-3(NeuGca2- | 4GlcNAcb1-4)Mana1-3(NeuGca2-8NeuGca2- |
| 8NeuGca2-3/6Galb1-4GlcNAcb1-2(NeuAca2- | 3/6Galb1-4(Fuca1-3)GlcNAcb1-2(NeuAca2- |
| 3/6Galb1-4(Fuca1-3)GlcNAcb1-6)Mana1-6)Manb1- | 8NeuGca2-3/6Galb1-4(Fuca1-3)GlcNAcb1- |
| 4GlcNAcb1-4(Fuca1-6)GlcNAc | 6)Mana1-6)Manb1-4GlcNAcb1-4GlcNAc |
| NeuAca2-8NeuGca2-3/6Galb1-4(Fuca1- | GlcNAcb1-4(NeuGca2-8NeuGca2-3/6Galb1- |
| 3)GlcNAcb1-3Galb1-4(Fuca1-3)GlcNAcb1- | 4GlcNAcb1-3Galb1-4GlcNAcb1-2(Gala1-3Galb1- |
| 2(NeuGca2-3/6Galb1-4(Fuca1-3)GlcNAcb1-3Galb1- | 4GlcNAcb1-4)Mana1-3)(Gala1-3Galb1-4GlcNAcb1- |
| 4GlcNAcb1-4)Mana1-3(Mana1-3(Mana1-6)Mana1- | 2(Gala1-3Galb1-4GlcNAcb1-6)Mana1-6)Manb1- |
| 6)Manb1-4GlcNAcb1-4(Fuca1-6)GlcNAc | 4GlcNAcb1-4(Fuca1-6)GlcNAc |
| NeuAca2-3/6Galb1-4GlcNAcb1-2(NeuAca2- | GlcNAcb1-4(NeuAca2-8NeuAca2-3/6Galb1- |
| 3/6Galb1-4GlcNAcb1-4)Mana1-3(NeuAca2- | 4GlcNAcb1-2(NeuGca2-3/6Galb1-4GlcNAcb1- |
| 8NeuAca2-3/6Galb1-4GlcNAcb1-3Galb1- | 4)Mana1-3)(NeuAca2-3/6Galb1-4GlcNAcb1- |
| 4GlcNAcb1-2(NeuAca2-3/6Galb1-4GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuAca2-3/6Galb1-4(Fuca1-3)GlcNAcb1-2(Galb1- | GlcNAcb1-4(Gala1-3Galb1-4(Fuca1-3)GlcNAcb1- |
| 4GlcNAcb1-4)Mana1-3(NeuAca2-8NeuAca2- | 2(NeuAca2-3/6Galb1-4GlcNAcb1-4)Mana1- |
| 3/6Galb1-4GlcNAcb1-3Galb1-4GlcNAcb1- | 3)(NeuAca2-8NeuAca2-3/6Galb1-4GlcNAcb1- |
| 2(NeuAca2-3/6Galb1-4GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4(Fuca1- | NeuGca2-3/6Galb1-4(Fuca1-3)GlcNAcb1- |
| 3)GlcNAcb1-2(NeuGca2-3/6Galb1-4GlcNAcb1- | 2(GalNAcb1-4(Fuca1-3)GlcNAcb1-4)Mana1- |
| 4)Mana1-3)(NeuAca2-3/6Galb1-4GlcNAcb1- | 3(NeuGca2-3/6Galb1-4(Fuca1-3)GlcNAcb1- |
| 2(NeuAca2-3/6Galb1-4(Fuca1-3)GlcNAcb1- | 2(NeuAca2-8NeuAca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuAca2-3/6Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3(NeuAca2- | 3)GlcNAcb1-2(Fuca1-2Galb1-4(Fuca1-3)GlcNAcb1- |
| 3/6Galb1-4(Fuca1-3)GlcNAcb1-3Galb1-4GlcNAcb1- | 4)Mana1-3)(NeuAca2-3/6Galb1-4(Fuca1- |
| 2(NeuAca2-3/6Galb1-4GlcNAcb1-6)Mana1- | 3)GlcNAcb1-2(NeuAca2-3/6Galb1-4(Fuca1- |
| 6)Manb1-4GlcNAcb1-4(Fuca1-6)GlcNAc | 3)GlcNAcb1-6)Mana1-6)Manb1-4GlcNAcb1-4GlcNAc |
| NeuAca2-3/6Galb1-4(Fuca1-3)GlcNAcb1-2(Fuca1- | NeuGca2-8NeuGca2-3/6Galb1-4(Fuca1- |
| 2Galb1-4(Fuca1-3)GlcNAcb1-4)Mana1-3(NeuAca2- | 3)GlcNAcb1-2(NeuGca2-3/6Galb1-4GlcNAcb1- |
| 3/6Galb1-4(Fuca1-3)GlcNAcb1-3Galb1-4GlcNAcb1- | 4)Mana1-3(NeuAca2-8NeuGca2-3/6Galb1- |
| 2(Galb1-4(Fuca1-3)GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4GlcNAc |
| NeuGca2-8NeuGca2-3/6Galb1-4(Fuca1- | Gala1-3Galb1-4(Fuca1-3)GlcNAcb1-2(Galb1- |
| 3)GlcNAcb1-2(NeuGca2-3/6Galb1-4GlcNAcb1- | 4GlcNAcb1-4)Mana1-3(NeuGca2-8NeuGca2- |
| 4)Mana1-3(NeuGca2-3/6Galb1-4GlcNAcb1- | 3/6Galb1-4(Fuca1-3)GlcNAcb1-2(NeuGca2- |
| 2(NeuGca2-3/6Galb1-4(Fuca1-3)GlcNAcb1- | 8NeuGca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| Gala1-3Galb1-4(Fuca1-3)GlcNAcb1-2(NeuGca2- | NeuGca2-8NeuGca2-3/6Galb1-4(Fuca1- |
| 3/6Galb1-4GlcNAcb1-4)Mana1-3(NeuGca2- | 3)GlcNAcb1-3Galb1-4(Fuca1-3)GlcNAcb1- |
| 8NeuGca2-3/6Galb1-4GlcNAcb1-2(NeuGca2- | 2(NeuGca2-3/6Galb1-4(Fuca1-3)GlcNAcb1-3Galb1- |
| 3/6Galb1-4(Fuca1-3)GlcNAcb1-6)Mana1-6)Manb1- | 4GlcNAcb1-4)Mana1-3(Mana1-3(Mana1-6)Mana1- |
| 4GlcNAcb1-4(Fuca1-6)GlcNAc | 6)Manb1-4GlcNAcb1-4(Fuca1-6)GlcNAc |
| NeuAca2-3/6Galb1-4GlcNAcb1-2(NeuGca2- | GlcNAcb1-4(NeuAca2-8NeuGca2-3/6Galb1- |
| 3/6Galb1-4GlcNAcb1-4)Mana1-3(NeuAca2- | 4GlcNAcb1-2(NeuGca2-3/6Galb1-4GlcNAcb1- |
| 8NeuAca2-3/6Galb1-4GlcNAcb1-3Galb1- | 4)Mana1-3)(NeuAca2-3/6Galb1-4GlcNAcb1- |
| 4GlcNAcb1-2(NeuAca2-3/6Galb1-4GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1- | NeuGca2-3/6Galb1-4(Fuca1-3)GlcNAcb1-2(Galb1- |
| 2(GalNAcb1-4(Fuca1-3)GlcNAcb1-4)Mana1- | 4GlcNAcb1-4)Mana1-3(NeuAca2-8NeuAca2- |
| 3(NeuGca2-3/6Galb1-4(Fuca1-3)GlcNAcb1- | 3/6Galb1-4GlcNAcb1-3Galb1-4GlcNAcb1- |
| 2(NeuAca2-8NeuGca2-3/6Galb1-4GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4(Fuca1- | GlcNAcb1-4(Gala1-3Galb1-4(Fuca1-3)GlcNAcb1- |
| 3)GlcNAcb1-2(NeuGca2-3/6Galb1-4GlcNAcb1- | 2(NeuGca2-3/6Galb1-4GlcNAcb1-4)Mana1- |
| 4)Mana1-3)(NeuAca2-3/6Galb1-4GlcNAcb1- | 3)(NeuAca2-8NeuAca2-3/6Galb1-4GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2(NeuAca2-3/6Galb1- | GlcNAcb1-4(NeuGca2-3/6Galb1-4(Fuca1- |
| 4GlcNAcb1-4)Mana1-3(NeuAca2-8NeuAca2- | 3)GlcNAcb1-2(Fuca1-2Galb1-4(Fuca1-3)GlcNAcb1- |
| 3/6Galb1-4GlcNAcb1-3Galb1-4GlcNAcb1- | 4)Mana1-3)(NeuGca2-3/6Galb1-4(Fuca1- |
| 2(NeuAca2-3/6Galb1-4GlcNAcb1-6)Mana1- | 3)GlcNAcb1-2(NeuAca2-3/6Galb1-4(Fuca1- |
| 6)Manb1-4GlcNAcb1-4(Fuca1-6)GlcNAc | 3)GlcNAcb1-6)Mana1-6)Manb1-4GlcNAcb1-4GlcNAc |
| NeuGca2-3/6Galb1-4(Fuca1-3)GlcNAcb1-2(Galb1- | GlcNAcb1-4(NeuAca2-8NeuAca2-3/6Galb1-4(Fuca1- |
| 4(Fuca1-3)GlcNAcb1-4)Mana1-3(NeuAca2- | 3)GlcNAcb1-3Galb1-4(Fuca1-3)GlcNAcb1- |
| 3/6Galb1-4(Fuca1-3)GlcNAcb1-3Galb1-4GlcNAcb1- | 2(NeuAca2-3/6Galb1-4(Fuca1-3)GlcNAcb1-3Galb1- |
| 2(NeuAca2-3/6Galb1-4GlcNAcb1-6)Mana1- | 4GlcNAcb1-4)Mana1-3)(Mana1-3(Mana1-6)Mana1- |
| 6)Manb1-4GlcNAcb1-4(Fuca1-6)GlcNAc | 6)Manb1-4GlcNAcb1-4GlcNAc |
| GlcNAcb1-4(NeuAca2-3/6Galb1-4(Fuca1- | Fuca1-2Galb1-4(Fuca1-3)GlcNAcb1-2(Gala1- |
| 3)GlcNAcb1-3Galb1-4(Fuca1-3)GlcNAcb1- | 3Galb1-4GlcNAcb1-4)Mana1-3(NeuAca2-3/6Galb1- |
| 2(NeuAca2-3/6Galb1-4(Fuca1-3)GlcNAcb1-3Galb1- | 4(Fuca1-3)GlcNAcb1-3Galb1-4GlcNAcb1- |
| 4(Fuca1-3)GlcNAcb1-4)Mana1-3)(Mana1-3(Mana1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1-2(Fuca1- | NeuGca2-8NeuGca2-3/6Galb1-4(Fuca1- |
| 2Galb1-4(Fuca1-3)GlcNAcb1-4)Mana1-3(NeuAca2- | 3)GlcNAcb1-2(NeuGca2-3/6Galb1-4GlcNAcb1- |
| 3/6Galb1-4(Fuca1-3)GlcNAcb1-3Galb1-4GlcNAcb1- | 4)Mana1-3(NeuGca2-8NeuGca2-3/6Galb1- |
| 2(Galb1-4(Fuca1-3)GlcNAcb1-6)Mana1-6)Manb1- | 4GlcNAcb1-2(Gala1-3Galb1-4GlcNAcb1-6)Mana1- |
| 4GlcNAcb1-4(Fuca1-6)GlcNAc | 6)Manb1-4GlcNAcb1-4GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(GalNAcb1-4(Fuca1-3)GlcNAcb1- | 3)GlcNAcb1-2(GalNAcb1-4(Fuca1-3)GlcNAcb1- |
| 4)Mana1-3)(NeuAca2-3/6Galb1-4(Fuca1- | 4)Mana1-3)(NeuAca2-3/6Galb1-4(Fuca1- |
| 3)GlcNAcb1-2(NeuAca2-8NeuAca2-3/6Galb1- | 3)GlcNAcb1-2(NeuAca2-3/6Galb1-4(Fuca1- |
| 4GlcNAcb1-6)Mana1-6)Manb1-4GlcNAcb1-4GlcNAc | 3)GlcNAcb1-6)Mana1-6)Manb1-4GlcNAcb1- |
| | 4(Fuca1-6)GlcNAc |
| GlcNAcb1-4(NeuGca2-8NeuGca2-3/6Galb1- | NeuGca2-3/6Galb1-4GlcNAcb1-2(NeuGca2- |
| 4GlcNAcb1-2(NeuGca2-3/6Galb1-4GlcNAcb1- | 3/6Galb1-4GlcNAcb1-4)Mana1-3(NeuAca2- |
| 4)Mana1-3)(NeuAca2-3/6Galb1-4GlcNAcb1- | 8NeuAca2-3/6Galb1-4GlcNAcb1-3Galb1- |
| 2(NeuAca2-3/6Galb1-4GlcNAcb1-6)Mana1- | 4GlcNAcb1-2(NeuAca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1- | GlcNAcb1-4(NeuGca2-3/6Galb1-4(Fuca1- |
| 2(GalNAcb1-4(Fuca1-3)GlcNAcb1-4)Mana1- | 3)GlcNAcb1-2(NeuGca2-3/6Galb1-4GlcNAcb1- |
| 3(NeuGca2-3/6Galb1-4(Fuca1-3)GlcNAcb1- | 4)Mana1-3)(NeuGca2-3/6Galb1-4GlcNAcb1- |
| 2(NeuGca2-8NeuGca2-3/6Galb1-4GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Gala1-3Galb1-4(Fuca1-3)GlcNAcb1- | Gala1-3Galb1-4GlcNAcb1-2(NeuGca2-3/6Galb1- |
| 2(NeuGca2-3/6Galb1-4GlcNAcb1-4)Mana1- | 4GlcNAcb1-4)Mana1-3(NeuAca2-8NeuAca2- |
| 3)(NeuAca2-8NeuGca2-3/6Galb1-4GlcNAcb1- | 3/6Galb1-4GlcNAcb1-3Galb1-4GlcNAcb1- |
| 2(NeuAca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1-2(Galb1- | GlcNAcb1-4(NeuAca2-8NeuAca2-3/6Galb1-4(Fuca1- |
| 4GlcNAcb1-4)Mana1-3(NeuAca2-8NeuGca2- | 3)GlcNAcb1-3Galb1-4(Fuca1-3)GlcNAcb1- |
| 3/6Galb1-4GlcNAcb1-3Galb1-4GlcNAcb1- | 2(NeuGca2-3/6Galb1-4(Fuca1-3)GlcNAcb1-3Galb1- |
| 2(NeuAca2-3/6Galb1-4GlcNAcb1-6)Mana1- | 4GlcNAcb1-4)Mana1-3)(Mana1-3(Mana1-6)Mana1- |
| 6)Manb1-4GlcNAcb1-4(Fuca1-6)GlcNAc | 6)Manb1-4GlcNAcb1-4GlcNAc |
| NeuGca2-3/6Galb1-4(Fuca1-3)GlcNAcb1-2(Galb1- | GlcNAcb1-4(NeuGca2-3/6Galb1-4(Fuca1- |
| 4(Fuca1-3)GlcNAcb1-4)Mana1-3(NeuGca2- | 3)GlcNAcb1-2(Fuca1-2Galb1-4(Fuca1-3)GlcNAcb1- |
| 3/6Galb1-4(Fuca1-3)GlcNAcb1-3Galb1-4GlcNAcb1- | 4)Mana1-3)(NeuGca2-3/6Galb1-4(Fuca1- |
| 2(NeuAca2-3/6Galb1-4GlcNAcb1-6)Mana1- | 3)GlcNAcb1-2(NeuGca2-3/6Galb1-4(Fuca1- |
| 6)Manb1-4GlcNAcb1-4(Fuca1-6)GlcNAc | 3)GlcNAcb1-6)Mana1-6)Manb1-4GlcNAcb1-4GlcNAc |
| GlcNAcb1-4(NeuAca2-3/6Galb1-4(Fuca1- | NeuGca2-3/6Galb1-4(Fuca1-3)GlcNAcb1-2(Fuca1- |
| 3)GlcNAcb1-3Galb1-4(Fuca1-3)GlcNAcb1- | 2Galb1-4(Fuca1-3)GlcNAcb1-4)Mana1-3(NeuGca2- |
| 2(NeuGca2-3/6Galb1-4(Fuca1-3)GlcNAcb1-3Galb1- | 3/6Galb1-4(Fuca1-3)GlcNAcb1-3Galb1-4GlcNAcb1- |
| 4(Fuca1-3)GlcNAcb1-4)Mana1-3)(Mana1-3(Mana1- | 2(Galb1-4(Fuca1-3)GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| Fuca1-2Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3(NeuGca2-3/6Galb1- | 3)GlcNAcb1-2(GalNAcb1-4(Fuca1-3)GlcNAcb1- |
| 4(Fuca1-3)GlcNAcb1-3Galb1-4GlcNAcb1- | 4)Mana1-3)(NeuAca2-3/6Galb1-4(Fuca1- |
| 2(NeuAca2-3/6Galb1-4(Fuca1-3)GlcNAcb1- | 3)GlcNAcb1-2(NeuAca2-8NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4(Fuca1- | NeuGca2-3/6Galb1-4GlcNAcb1-2(NeuGca2- |
| 3)GlcNAcb1-2(GalNAcb1-4(Fuca1-3)GlcNAcb1- | 3/6Galb1-4GlcNAcb1-4)Mana1-3(NeuAca2- |
| 4)Mana1-3)(NeuAca2-3/6Galb1-4(Fuca1- | 8NeuGca2-3/6Galb1-4GlcNAcb1-3Galb1- |
| 3)GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1- | 6)Mana1-6)Manb1-4GlcNAcb1-4GlcNAc |
| 4(Fuca1-6)GlcNAc | |
| GlcNAcb1-4(NeuGca2-8NeuGca2-3/6Galb1- | NeuGca2-3/6Galb1-4(Fuca1-3)GlcNAcb1-2(Galb1- |
| 4GlcNAcb1-2(NeuGca2-3/6Galb1-4GlcNAcb1- | 4GlcNAcb1-4)Mana1-3(NeuGca2-8NeuGca2- |
| 4)Mana1-3)(NeuGca2-3/6Galb1-4GlcNAcb1- | 3/6Galb1-4GlcNAcb1-3Galb1-4GlcNAcb1- |
| 2(NeuAca2-3/6Galb1-4GlcNAcb1-6)Mana1- | 2(NeuAca2-3/6Galb1-4GlcNAcb1-6)Mana1- |
| 6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4(Fuca1- | Gala1-3Galb1-4GlcNAcb1-2(NeuGca2-3/6Galb1- |
| 3)GlcNAcb1-2(NeuGca2-3/6Galb1-4GlcNAcb1- | 4GlcNAcb1-4)Mana1-3(NeuAca2-8NeuGca2- |
| 4)Mana1-3)(NeuGca2-3/6Galb1-4GlcNAcb1- | 3/6Galb1-4GlcNAcb1-3Galb1-4GlcNAcb1- |
| 2(NeuGca2-3/6Galb1-4(Fuca1-3)GlcNAcb1- | 2(NeuAca2-3/6Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(Gala1-3Galb1-4(Fuca1-3)GlcNAcb1- | NeuGca2-3/6Galb1-4(Fuca1-3)GlcNAcb1-2(Galb1- |
| 2(NeuGca2-3/6Galb1-4GlcNAcb1-4)Mana1- | 4(Fuca1-3)GlcNAcb1-4)Mana1-3(NeuGca2- |
| 3)(NeuGca2-8NeuGca2-3/6Galb1-4GlcNAcb1- | 3/6Galb1-4(Fuca1-3)GlcNAcb1-3Galb1-4GlcNAcb1- |
| 2(NeuAca2-3/6Galb1-4(Fuca1-3)GlcNAcb1- | 2(NeuGca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| GlcNAcb1-4(NeuAca2-8NeuGca2-3/6Galb1- | GlcNAcb1-4(NeuGca2-3/6Galb1-4(Fuca1- |
| 4(Fuca1-3)GlcNAcb1-3Galb1-4(Fuca1-3)GlcNAcb1- | 3)GlcNAcb1-3Galb1-4(Fuca1-3)GlcNAcb1- |
| 2(NeuGca2-3/6Galb1-4(Fuca1-3)GlcNAcb1-3Galb1- | 2(NeuGca2-3/6Galb1-4(Fuca1-3)GlcNAcb1-3Galb1- |
| 4GlcNAcb1-4)Mana1-3)(Mana1-3(Mana1-6)Mana1- | 4(Fuca1-3)GlcNAcb1-4)Mana1-3)(Mana1-3(Mana1- |
| 6)Manb1-4GlcNAcb1-4GlcNAc | 6)Mana1-6)Manb1-4GlcNAcb1-4(Fuca1-6)GlcNAc |
| Fuca1-2Galb1-4(Fuca1-3)GlcNAcb1-2(Gala1- | GlcNAcb1-4(NeuGca2-3/6Galb1-4(Fuca1- |
| 3Galb1-4GlcNAcb1-4)Mana1-3(NeuGca2-3/6Galb1- | 3)GlcNAcb1-2(GalNAcb1-4(Fuca1-3)GlcNAcb1- |
| 4(Fuca1-3)GlcNAcb1-3Galb1-4GlcNAcb1- | 4)Mana1-3)(NeuGca2-3/6Galb1-4(Fuca1- |
| 2(NeuGca2-3/6Galb1-4(Fuca1-3)GlcNAcb1- | 3)GlcNAcb1-2(NeuAca2-8NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuAca2-3/6Galb1-4(Fuca1- | GlcNAcb1-4(NeuAca2-3/6Galb1-4GlcNAcb1- |
| 3)GlcNAcb1-2(Galb1-4GlcNAcb1-4)Mana1- | 2(NeuAca2-3/6Galb1-4GlcNAcb1-4)Mana1- |
| 3)(NeuAca2-8NeuAca2-3/6Galb1-4GlcNAcb1- | 3)(Galb1-4GlcNAcb1-2(NeuAca2-3/6Galb1- |
| 3Galb1-4GlcNAcb1-2(NeuAca2-3/6Galb1- | 4GlcNAcb1-4)(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4GlcNAcb1- | GlcNAcb1-4(NeuGca2-3/6Galb1-4(Fuca1- |
| 2(NeuAca2-3/6Galb1-4GlcNAcb1-4)Mana1- | 3)GlcNAcb1-2(GalNAcb1-4(Fuca1-3)GlcNAcb1- |
| 3)(NeuAca2-3/6Galb1-4GlcNAcb1-3Galb1- | 4)Mana1-3)(NeuGca2-3/6Galb1-4(Fuca1- |
| 4GlcNAcb1-2(NeuAca2-3/6Galb1-4GlcNAcb1- | 3)GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4(Fuca1-3)GlcNAcb1- | 3)GlcNAcb1-2(Fuca1-2Galb1-4(Fuca1-3)GlcNAcb1- |
| 4)Mana1-3)(NeuAca2-3/6Galb1-4(Fuca1- | 4)Mana1-3)(NeuAca2-3/6Galb1-4(Fuca1- |
| 3)GlcNAcb1-3Galb1-4GlcNAcb1-2(NeuAca2-3/ | 3)GlcNAcb1-3Galb1-4GlcNAcb1-2(Galb1-4(Fuca1- |
| 6Galb1-4GlcNAcb1-6)Mana1-6)Manb1-4GlcNAcb1- | 3)GlcNAcb1-6)Mana1-6)Manb1-4GlcNAcb1-4GlcNAc |
| 4GlcNAc | |
| NeuGca2-3/6Galb1-4GlcNAcb1-2(NeuGca2- | GlcNAcb1-4(NeuGca2-8NeuGca2-3/6Galb1- |
| 3/6Galb1-4GlcNAcb1-4)Mana1-3(NeuGca2- | 4GlcNAcb1-2(NeuGca2-3/6Galb1-4GlcNAcb1- |
| 8NeuGca2-3/6Galb1-4GlcNAcb1-3Galb1- | 4)Mana1-3)(NeuGca2-3/6Galb1-4GlcNAcb1- |
| 4GlcNAcb1-2(NeuAca2-3/6Galb1-4GlcNAcb1- | 2(NeuGca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-3/6Galb1-4(Fuca1-3)GlcNAcb1-2(Galb1- | GlcNAcb1-4(Gala1-3Galb1-4(Fuca1-3)GlcNAcb1- |
| 4GlcNAcb1-4)Mana1-3(NeuGca2-8NeuGca2- | 2(NeuGca2-3/6Galb1-4GlcNAcb1-4)Mana1- |
| 3/6Galb1-4GlcNAcb1-3Galb1-4GlcNAcb1- | 3)(NeuGca2-8NeuGca2-3/6Galb1-4GlcNAcb1- |
| 2(NeuGca2-3/6Galb1-4GlcNAcb1-6)Mana1- | 2(NeuGca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| Gala1-3Galb1-4GlcNAcb1-2(NeuGca2-3/6Galb1- | GlcNAcb1-4(NeuGca2-8NeuGca2-3/6Galb1- |
| 4GlcNAcb1-4)Mana1-3(NeuGca2-8NeuGca2- | 4(Fuca1-3)GlcNAcb1-3Galb1-4(Fuca1-3)GlcNAcb1- |
| 3/6Galb1-4GlcNAcb1-3Galb1-4GlcNAcb1- | 2(NeuGca2-3/6Galb1-4(Fuca1-3)GlcNAcb1-3Galb1- |
| 2(NeuAca2-3/6Galb1-4GlcNAcb1-6)Mana1- | 4GlcNAcb1-4)Mana1-3)(Mana1-3(Mana1-6)Mana1- |
| 6)Manb1-4GlcNAcb1-4(Fuca1-6)GlcNAc | 6)Manb1-4GlcNAcb1-4GlcNAc |
| NeuAca2-8NeuAca2-3/6Galb1-4(Fuca1-3)GlcNAcb1- | GlcNAcb1-4(NeuGca2-3/6Galb1-4(Fuca1- |
| 2(NeuAca2-3/6Galb1-4GlcNAcb1-4)Mana1- | 3)GlcNAcb1-2(GalNAcb1-4(Fuca1-3)GlcNAcb1- |
| 3(NeuAca2-3/6Galb1-4GlcNAcb1-2(NeuAca2- | 4)Mana1-3)(NeuGca2-3/6Galb1-4(Fuca1- |
| 3/6Galb1-4(Fuca1-3)GlcNAcb1-6)Mana1-6)Manb1- | 3)GlcNAcb1-2(NeuAca2-8NeuGca2-3/6Galb1- |
| 4GlcNAcb1-4(Fuca1-6)GlcNAc | 4GlcNAcb1-6)Mana1-6)Manb1-4GlcNAcb1-4GlcNAc |
| GlcNAcb1-4(NeuAca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(Galb1-4GlcNAcb1-4)Mana1- |
| 3)(Galb1-4GlcNAcb1-2(NeuAca2-3/6Galb1- | 3)(NeuAca2-8NeuAca2-3/6Galb1-4GlcNAcb1- |
| 4GlcNAcb1-4)(NeuAca2-3/6Galb1-4GlcNAcb1- | 3Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(Gala1-3Galb1-4GlcNAcb1-2(NeuAca2- | GlcNAcb1-4(NeuAca2-3/6Galb1-4GlcNAcb1- |
| 3/6Galb1-4GlcNAcb1-4)Mana1-3)(NeuAca2- | 2(NeuGca2-3/6Galb1-4GlcNAcb1-4)Mana1- |
| 8NeuAca2-3/6Galb1-4GlcNAcb1-3Galb1- | 3)(NeuAca2-3/6Galb1-4GlcNAcb1-3Galb1- |
| 4GlcNAcb1-2(NeuAca2-3/6Galb1-4GlcNAcb1- | 4GlcNAcb1-2(NeuAca2-3/6Galb1-4GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(GalNAcb1-4(Fuca1-3)GlcNAcb1- | 3)GlcNAcb1-2(Galb1-4(Fuca1-3)GlcNAcb1- |
| 4)Mana1-3)(NeuGca2-3/6Galb1-4(Fuca1- | 4)Mana1-3)(NeuAca2-3/6Galb1-4(Fuca1- |
| 3)GlcNAcb1-2(NeuGca2-3/6Galb1-4(Fuca1- | 3)GlcNAcb1-3Galb1-4GlcNAcb1-2(NeuAca2-3/ |
| 3)GlcNAcb1-6)Mana1-6)Manb1-4GlcNAcb1- | 6Galb1-4GlcNAcb1-6)Mana1-6)Manb1-4GlcNAcb1- |
| 4(Fuca1-6)GlcNAc | 4GlcNAc |
| GlcNAcb1-4(NeuGca2-3/6Galb1-4(Fuca1- | GlcNAcb1-4(Fuca1-2Galb1-4(Fuca1-3)GlcNAcb1- |
| 3)GlcNAcb1-2(Fuca1-2Galb1-4(Fuca1-3)GlcNAcb1- | 2(Gala1-3Galb1-4GlcNAcb1-4)Mana1-3)(NeuAca2- |
| 4)Mana1-3)(NeuAca2-3/6Galb1-4(Fuca1- | 3/6Galb1-4(Fuca1-3)GlcNAcb1-3Galb1-4GlcNAcb1- |
| 3)GlcNAcb1-3Galb1-4GlcNAcb1-2(Galb1-4(Fuca1- | 2(NeuAca2-3/6Galb1-4(Fuca1-3)GlcNAcb1- |
| 3)GlcNAcb1-6)Mana1-6)Manb1-4GlcNAcb1-4GlcNAc | 6)Mana1-6)Manb1-4GlcNAcb1-4GlcNAc |
| NeuGca2-3/6Galb1-4GlcNAcb1-2(NeuGca2- | Gala1-3Galb1-4GlcNAcb1-2(NeuGca2-3/6Galb1- |
| 3/6Galb1-4GlcNAcb1-4)Mana1-3(NeuGca2- | 4GlcNAcb1-4)Mana1-3(NeuGca2-8NeuGca2- |
| 8NeuGca2-3/6Galb1-4GlcNAcb1-3Galb1- | 3/6Galb1-4GlcNAcb1-3Galb1-4GlcNAcb1- |
| 4GlcNAcb1-2(NeuGca2-3/6Galb1-4GlcNAcb1- | 2(NeuGca2-3/6Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuAca2-8NeuAca2-3/6Galb1-4(Fuca1-3)GlcNAcb1- | NeuAca2-8NeuAca2-3/6Galb1-4(Fuca1-3)GlcNAcb1- |
| 2(NeuAca2-3/6Galb1-4GlcNAcb1-4)Mana1- | 2(NeuGca2-3/6Galb1-4GlcNAcb1-4)Mana1- |
| 3(NeuAca2-8NeuAca2-3/6Galb1-4GlcNAcb1- | 3(NeuAca2-3/6Galb1-4GlcNAcb1-2(NeuAca2- |
| 2(Gala1-3Galb1-4GlcNAcb1-6)Mana1-6)Manb1- | 3/6Galb1-4(Fuca1-3)GlcNAcb1-6)Mana1-6)Manb1- |
| 4GlcNAcb1-4(Fuca1-6)GlcNAc | 4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(GalNAcb1-4(Fuca1-3)GlcNAcb1- | 2(NeuGca2-3/6Galb1-4GlcNAcb1-4)Mana1- |
| 4)Mana1-3)(NeuGca2-3/6Galb1-4(Fuca1- | 3)(NeuAca2-3/6Galb1-4GlcNAcb1-3Galb1- |
| 3)GlcNAcb1-2(NeuGca2-8NeuGca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(Galb1-4GlcNAcb1-4)Mana1- |
| 3)(Galb1-4GlcNAcb1-2(NeuAca2-3/6Galb1- | 3)(NeuAca2-8NeuGca2-3/6Galb1-4GlcNAcb1- |
| 4GlcNAcb1-4)(NeuAca2-3/6Galb1-4GlcNAcb1- | 3Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(Gala1-3Galb1-4GlcNAcb1-2(NeuGca2- | Gala1-3Galb1-4(Fuca1-3)GlcNAcb1-2(Galb1- |
| 3/6Galb1-4GlcNAcb1-4)Mana1-3)(NeuAca2- | 4GlcNAcb1-4)Mana1-3(NeuAca2-8NeuAca2- |
| 8NeuAca2-3/6Galb1-4GlcNAcb1-3Galb1- | 3/6Galb1-4(Fuca1-3)GlcNAcb1-2(NeuAca2- |
| 4GlcNAcb1-2(NeuAca2-3/6Galb1-4GlcNAcb1- | 8NeuAca2-3/6Galb1-4(Fuca1-3)GlcNAcb1-6)Mana1- |
| 6)Mana1-6)Manb1-4GlcNAcb1-4GlcNAc | 6)Manb1-4GlcNAcb1-4(Fuca1-6)GlcNAc |
| GlcNAcb1-4(NeuGca2-3/6Galb1-4(Fuca1- | GlcNAcb1-4(Fuca1-2Galb1-4(Fuca1-3)GlcNAcb1- |
| 3)GlcNAcb1-2(Galb1-4(Fuca1-3)GlcNAcb1- | 2(Gala1-3Galb1-4GlcNAcb1-4)Mana1-3)(NeuGca2- |
| 4)Mana1-3)(NeuGca2-3/6Galb1-4(Fuca1- | 3/6Galb1-4(Fuca1-3)GlcNAcb1-3Galb1-4GlcNAcb1- |
| 3)GlcNAcb1-3Galb1-4GlcNAcb1-2(NeuAca2-3/ | 2(NeuAca2-3/6Galb1-4(Fuca1-3)GlcNAcb1- |
| 6Galb1-4GlcNAcb1-6)Mana1-6)Manb1-4GlcNAcb1- | 6)Mana1-6)Manb1-4GlcNAcb1-4GlcNAc |
| 4GlcNAc | |
| GlcNAcb1-4(NeuGca2-3/6Galb1-4(Fuca1- | NeuAca2-6Galb1-4GlcNAcb1-2(GalNAcb1- |
| 3)GlcNAcb1-2(Fuca1-2Galb1-4(Fuca1-3)GlcNAcb1- | 4(NeuAca2-3)Galb1-4GlcNAcb1-4)Mana1- |
| 4)Mana1-3)(NeuGca2-3/6Galb1-4(Fuca1- | 3(GalNAcb1-4(NeuAca2-3)Galb1-4GlcNAcb1- |
| 3)GlcNAcb1-3Galb1-4GlcNAcb1-2(Galb1-4(Fuca1- | 2(GalNAcb1-4(NeuAca2-3)Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-8NeuAca2-3/6Galb1-4(Fuca1-3)GlcNAcb1- | NeuAca2-8NeuGca2-3/6Galb1-4(Fuca1- |
| 2(NeuGca2-3/6Galb1-4GlcNAcb1-4)Mana1- | 3)GlcNAcb1-2(NeuGca2-3/6Galb1-4GlcNAcb1- |
| 3(NeuAca2-8NeuAca2-3/6Galb1-4GlcNAcb1- | 4)Mana1-3(NeuAca2-3/6Galb1-4GlcNAcb1- |
| 2(Gala1-3Galb1-4GlcNAcb1-6)Mana1-6)Manb1- | 2(NeuAca2-3/6Galb1-4(Fuca1-3)GlcNAcb1- |
| 4GlcNAcb1-4(Fuca1-6)GlcNAc | 6)Mana1-6)Manb1-4GlcNAcb1-4(Fuca1-6)GlcNAc |
| GlcNAcb1-4(Gala1-3Galb1-4GlcNAcb1-2(NeuGca2- | GlcNAcb1-4(NeuGca2-3/6Galb1-4GlcNAcb1- |
| 3/6Galb1-4GlcNAcb1-4)Mana1-3)(NeuAca2- | 2(NeuGca2-3/6Galb1-4GlcNAcb1-4)Mana1- |
| 8NeuGca2-3/6Galb1-4GlcNAcb1-3Galb1- | 3)(NeuGca2-3/6Galb1-4GlcNAcb1-3Galb1- |
| 4GlcNAcb1-2(NeuAca2-3/6Galb1-4GlcNAcb1- | 4GlcNAcb1-2(NeuAca2-3/6Galb1-4GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(Galb1-4GlcNAcb1-4)Mana1- |
| 3)(Galb1-4GlcNAcb1-2(NeuGca2-3/6Galb1- | 3)(NeuGca2-8NeuGca2-3/6Galb1-4GlcNAcb1- |
| 4GlcNAcb1-4)(NeuAca2-3/6Galb1-4GlcNAcb1- | 3Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| Gala1-3Galb1-4(Fuca1-3)GlcNAcb1-2(Galb1- | GlcNAcb1-4(NeuGca2-3/6Galb1-4(Fuca1- |
| 4GlcNAcb1-4)Mana1-3(NeuAca2-8NeuGca2- | 3)GlcNAcb1-2(Galb1-4(Fuca1-3)GlcNAcb1- |
| 3/6Galb1-4(Fuca1-3)GlcNAcb1-2(NeuAca2- | 4)Mana1-3)(NeuGca2-3/6Galb1-4(Fuca1- |
| 8NeuAca2-3/6Galb1-4(Fuca1-3)GlcNAcb1-6)Mana1- | 3)GlcNAcb1-3Galb1-4GlcNAcb1-2(NeuGca2-3/ |
| 6)Manb1-4GlcNAcb1-4(Fuca1-6)GlcNAc | 6Galb1-4GlcNAcb1-6)Mana1-6)Manb1-4GlcNAcb1- |
| | 4GlcNAc |
| GlcNAcb1-4(Fuca1-2Galb1-4(Fuca1-3)GlcNAcb1- | NeuAca2-8NeuGca2-3/6Galb1-4(Fuca1- |
| 2(Gala1-3Galb1-4GlcNAcb1-4)Mana1-3)(NeuGca2- | 3)GlcNAcb1-2(NeuGca2-3/6Galb1-4GlcNAcb1- |
| 3/6Galb1-4(Fuca1-3)GlcNAcb1-3Galb1-4GlcNAcb1- | 4)Mana1-3(NeuAca2-8NeuAca2-3/6Galb1- |
| 2(NeuGca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4GlcNAc | 6)Manb1-4GlcNAcb1-4(Fuca1-6)GlcNAc |
| NeuGca2-8NeuGca2-3/6Galb1-4(Fuca1- | GlcNAcb1-4(NeuGca2-3/6Galb1-4GlcNAcb1- |
| 3)GlcNAcb1-2(NeuGca2-3/6Galb1-4GlcNAcb1- | 2(NeuGca2-3/6Galb1-4GlcNAcb1-4)Mana1- |
| 4)Mana1-3(NeuAca2-3/6Galb1-4GlcNAcb1- | 3)(NeuGca2-3/6Galb1-4GlcNAcb1-3Galb1- |
| 2(NeuAca2-3/6Galb1-4(Fuca1-3)GlcNAcb1- | 4GlcNAcb1-2(NeuGca2-3/6Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(Gala1-3Galb1-4GlcNAcb1-2(NeuGca2- | GlcNAcb1-4(NeuGca2-3/6Galb1-4(Fuca1- |
| 3/6Galb1-4GlcNAcb1-4)Mana1-3)(NeuGca2- | 3)GlcNAcb1-2(Galb1-4GlcNAcb1-4)Mana1- |
| 8NeuGca2-3/6Galb1-4GlcNAcb1-3Galb1- | 3)(NeuGca2-8NeuGca2-3/6Galb1-4GlcNAcb1- |
| 4GlcNAcb1-2(NeuAca2-3/6Galb1-4GlcNAcb1- | 3Galb1-4GlcNAcb1-2(NeuGca2-3/6Galb1- |
| 6)Mana1-6)Manb1-4GlcNAcb1-4GlcNAc | 4GlcNAcb1-6)Mana1-6)Manb1-4GlcNAcb1-4GlcNAc |
| Gala1-3Galb1-4(Fuca1-3)GlcNAcb1-2(Galb1- | GlcNAcb1-4(NeuAca2-8NeuAca2-3/6Galb1-4(Fuca1- |
| 4GlcNAcb1-4)Mana1-3(NeuGca2-8NeuGca2- | 3)GlcNAcb1-2(NeuAca2-3/6Galb1-4GlcNAcb1- |
| 3/6Galb1-4(Fuca1-3)GlcNAcb1-2(NeuAca2- | 4)Mana1-3)(NeuAca2-3/6Galb1-4GlcNAcb1- |
| 8NeuAca2-3/6Galb1-4(Fuca1-3)GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4GlcNAc |
| GlcNAcb1-4(NeuAca2-3/6Galb1-4(Fuca1- | NeuGca2-8NeuGca2-3/6Galb1-4(Fuca1- |
| 3)GlcNAcb1-2(Fuca1-2Galb1-4(Fuca1-3)GlcNAcb1- | 3)GlcNAcb1-2(NeuGca2-3/6Galb1-4GlcNAcb1- |
| 4)Mana1-3)(NeuAca2-3/6Galb1-4(Fuca1- | 4)Mana1-3(NeuGca2-3/6Galb1-4GlcNAcb1- |
| 3)GlcNAcb1-2(NeuAca2-3/6Galb1-4(Fuca1- | 2(NeuAca2-3/6Galb1-4(Fuca1-3)GlcNAcb1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| NeuGca2-8NeuGca2-3/6Galb1-4(Fuca1- | GlcNAcb1-4(Gala1-3Galb1-4GlcNAcb1-2(NeuGca2- |
| 3)GlcNAcb1-2(NeuGca2-3/6Galb1-4GlcNAcb1- | 3/6Galb1-4GlcNAcb1-4)Mana1-3)(NeuGca2- |
| 4)Mana1-3(NeuAca2-8NeuAca2-3/6Galb1- | 8NeuGca2-3/6Galb1-4GlcNAcb1-3Galb1- |
| 4GlcNAcb1-2(Gala1-3Galb1-4GlcNAcb1-6)Mana1- | 4GlcNAcb1-2(NeuGca2-3/6Galb1-4GlcNAcb1- |
| 6)Manb1-4GlcNAcb1-4(Fuca1-6)GlcNAc | 6)Mana1-6)Manb1-4GlcNAcb1-4GlcNAc |
| Gala1-3Galb1-4(Fuca1-3)GlcNAcb1-2(Galb1- | GlcNAcb1-4(NeuAca2-8NeuAca2-3/6Galb1-4(Fuca1- |
| 4GlcNAcb1-4)Mana1-3(NeuGca2-8NeuGca2- | 3)GlcNAcb1-2(NeuGca2-3/6Galb1-4GlcNAcb1- |
| 3/6Galb1-4(Fuca1-3)GlcNAcb1-2(NeuAca2- | 4)Mana1-3)(NeuAca2-3/6Galb1-4GlcNAcb1- |
| 8NeuGca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| NeuAca2-3/6Galb1-4GlcNAcb1-2(NeuAca2- | GlcNAcb1-4(NeuAca2-8NeuAca2-3/6Galb1-4(Fuca1- |
| 3/6Galb1-4GlcNAcb1-4)Mana1-3(NeuAca2- | 3)GlcNAcb1-2(NeuAca2-3/6Galb1-4GlcNAcb1- |
| 8NeuAca2-3/6Galb1-4GlcNAcb1-3Galb1- | 4)Mana1-3)(NeuAca2-8NeuAca2-3/6Galb1- |
| 4GlcNAcb1-2(NeuAca2-3/6Galb1-4GlcNAcb1- | 4GlcNAcb1-2(Gala1-3Galb1-4GlcNAcb1-6)Mana1- |
| 6)Mana1-6)Manb1-4GlcNAcb1-4(Fuca1-6)GlcNAc | 6)Manb1-4GlcNAcb1-4GlcNAc |
| GlcNAcb1-4(Gala1-3Galb1-4(Fuca1-3)GlcNAcb1- | GlcNAcb1-4(Gala1-3Galb1-4(Fuca1-3)GlcNAcb1- |
| 2(Galb1-4GlcNAcb1-4)Mana1-3)(NeuAca2- | 2(NeuAca2-3/6Galb1-4GlcNAcb1-4)Mana1- |
| 8NeuAca2-3/6Galb1-4(Fuca1-3)GlcNAcb1- | 3)(NeuAca2-8NeuAca2-3/6Galb1-4GlcNAcb1- |
| 2(NeuAca2-8NeuAca2-3/6Galb1-4(Fuca1- | 2(NeuAca2-3/6Galb1-4(Fuca1-3)GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1- | GlcNAcb1-4(NeuGca2-3/6Galb1-4(Fuca1- |
| 2(NeuAca2-3/6Galb1-4(Fuca1-3)GlcNAcb1- | 3)GlcNAcb1-2(Fuca1-2Galb1-4(Fuca1-3)GlcNAcb1- |
| 4)Mana1-3(NeuAca2-3/6Galb1-4(Fuca1- | 4)Mana1-3)(NeuAca2-3/6Galb1-4(Fuca1- |
| 3)GlcNAcb1-3Galb1-4GlcNAcb1-2(NeuAca2-3/6 | 3)GlcNAcb1-2(NeuAca2-3/6Galb1-4(Fuca1- |
| Galb1-4GlcNAcb1-6)Mana1-6)Manb1-4GlcNAcb1- | 3)GlcNAcb1-6)Mana1-6)Manb1-4GlcNAcb1- |
| 4GlcNAc | 4(Fuca1-6)GlcNAc |
| NeuGca2-8NeuGca2-3/6Galb1-4(Fuca1- | NeuGca2-8NeuGca2-3/6Galb1-4(Fuca1- |
| 3)GlcNAcb1-2(NeuGca2-3/6Galb1-4GlcNAcb1- | 3)GlcNAcb1-2(NeuGca2-3/6Galb1-4GlcNAcb1- |
| 4)Mana1-3(NeuGca2-3/6Galb1-4GlcNAcb1- | 4)Mana1-3(NeuAca2-8NeuGca2-3/6Galb1- |
| 2(NeuGca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| Gala1-3Galb1-4(Fuca1-3)GlcNAcb1-2(Galb1- | GlcNAcb1-4(NeuAca2-8NeuAca2-3/6Galb1-4(Fuca1- |
| 4GlcNAcb1-4)Mana1-3(NeuGca2-8NeuGca2- | 3)GlcNAcb1-2(NeuGca2-3/6Galb1-4GlcNAcb1- |
| 3/6Galb1-4(Fuca1-3)GlcNAcb1-2(NeuGca2- | 4)Mana1-3)(NeuAca2-8NeuAca2-3/6Galb1- |
| 8NeuGca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4(Fuca1-6)GlcNAc | 6)Manb1-4GlcNAcb1-4GlcNAc |
| GlcNAcb1-4(NeuAca2-8NeuGca2-3/6Galb1- | NeuAca2-3/6Galb1-4GlcNAcb1-2(NeuGca2- |
| 4(Fuca1-3)GlcNAcb1-2(NeuGca2-3/6Galb1- | 3/6Galb1-4GlcNAcb1-4)Mana1-3(NeuAca2- |
| 4GlcNAcb1-4)Mana1-3)(NeuAca2-3/6Galb1- | 8NeuAca2-3/6Galb1-4GlcNAcb1-3Galb1- |
| 4GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1- | GlcNAcb1-4(Gala1-3Galb1-4(Fuca1-3)GlcNAcb1- |
| 2(NeuGca2-3/6Galb1-4(Fuca1-3)GlcNAcb1- | 2(Galb1-4GlcNAcb1-4)Mana1-3)(NeuAca2- |
| 4)Mana1-3(NeuAca2-3/6Galb1-4(Fuca1- | 8NeuGca2-3/6Galb1-4(Fuca1-3)GlcNAcb1- |
| 3)GlcNAcb1-3Galb1-4GlcNAcb1-2(NeuAca2-3/6 | 2(NeuAca2-8NeuAca2-3/6Galb1-4(Fuca1- |
| Galb1-4GlcNAcb1-6)Mana1-6)Manb1-4GlcNAcb1- | 3)GlcNAcb1-6)Mana1-6)Manb1-4GlcNAcb1-4GlcNAc |
| 4GlcNAc | |
| GlcNAcb1-4(Gala1-3Galb1-4(Fuca1-3)GlcNAcb1- | NeuAca2-3/6Galb1-4(Fuca1-3)GlcNAcb1-2(Gala1- |
| 2(NeuGca2-3/6Galb1-4GlcNAcb1-4)Mana1- | 3Galb1-4GlcNAcb1-4)Mana1-3(NeuAca2-8NeuAca2- |
| 3)(NeuAca2-8NeuAca2-3/6Galb1-4GlcNAcb1- | 3/6Galb1-4GlcNAcb1-3Galb1-4GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuAca2-8NeuAca2-3/6Galb1-4(Fuca1- |
| 3)GlcNAcb1-2(Fuca1-2Galb1-4(Fuca1-3)GlcNAcb1- | 3)GlcNAcb1-3Galb1-4(Fuca1-3)GlcNAcb1- |
| 4)Mana1-3)(NeuGca2-3/6Galb1-4(Fuca1- | 2(NeuAca2-3/6Galb1-4(Fuca1-3)GlcNAcb1-3Galb1- |
| 3)GlcNAcb1-2(NeuAca2-3/6Galb1-4(Fuca1- | 4GlcNAcb1-4)Mana1-3)(Mana1-3(Mana1-6)Mana1- |
| 3)GlcNAcb1-6)Mana1-6)Manb1-4GlcNAcb1- | 6)Manb1-4GlcNAcb1-4(Fuca1-6)GlcNAc |
| 4(Fuca1-6)GlcNAc | |
| NeuGca2-8NeuGca2-3/6Galb1-4(Fuca1- | GlcNAcb1-4(NeuAca2-3/6Galb1-4(Fuca1- |
| 3)GlcNAcb1-2(NeuGca2-3/6Galb1-4GlcNAcb1- | 3)GlcNAcb1-2(GalNAcb1-4(Fuca1-3)GlcNAcb1- |
| 4)Mana1-3(NeuGca2-8NeuGca2-3/6Galb1- | 4)Mana1-3)(NeuAca2-3/6Galb1-4(Fuca1- |
| 4GlcNAcb1-2(Gala1-3Galb1-4GlcNAcb1-6)Mana1- | 3)GlcNAcb1-2(NeuAca2-8NeuAca2-3/6Galb1- |
| 6)Manb1-4GlcNAcb1-4(Fuca1-6)GlcNAc | 4GlcNAcb1-6)Mana1-6)Manb1-4GlcNAcb1-4(Fuca1- |
| | 6)GlcNAc |
| GlcNAcb1-4(NeuGca2-8NeuGca2-3/6Galb1- | GlcNAcb1-4(NeuAca2-8NeuGca2-3/6Galb1- |
| 4(Fuca1-3)GlcNAcb1-2(NeuGca2-3/6Galb1- | 4(Fuca1-3)GlcNAcb1-2(NeuGca2-3/6Galb1- |
| 4GlcNAcb1-4)Mana1-3)(NeuAca2-3/6Galb1- | 4GlcNAcb1-4)Mana1-3)(NeuAca2-8NeuAca2- |
| 4GlcNAcb1-2(NeuAca2-3/6Galb1-4(Fuca1- | 3/6Galb1-4GlcNAcb1-2(Gala1-3Galb1-4GlcNAcb1- |
| 3)GlcNAcb1-6)Mana1-6)Manb1-4GlcNAcb1-4GlcNAc | 6)Mana1-6)Manb1-4GlcNAcb1-4GlcNAc |
| NeuGca2-3/6Galb1-4GlcNAcb1-2(NeuGca2- | NeuGca2-3/6Galb1-4(Fuca1-3)GlcNAcb1- |
| 3/6Galb1-4GlcNAcb1-4)Mana1-3(NeuAca2- | 2(NeuGca2-3/6Galb1-4(Fuca1-3)GlcNAcb1- |
| 8NeuAca2-3/6Galb1-4GlcNAcb1-3Galb1- | 4)Mana1-3(NeuAca2-3/6Galb1-4(Fuca1- |
| 4GlcNAcb1-2(NeuAca2-3/6Galb1-4GlcNAcb1- | 3)GlcNAcb1-3Galb1-4GlcNAcb1-2(NeuAca2-3/6 |
| 6)Mana1-6)Manb1-4GlcNAcb1-4(Fuca1-6)GlcNAc | Galb1-4GlcNAcb1-6)Mana1-6)Manb1-4GlcNAcb1- |
| | 4GlcNAc |
| GlcNAcb1-4(Gala1-3Galb1-4(Fuca1-3)GlcNAcb1- | NeuGca2-3/6Galb1-4(Fuca1-3)GlcNAcb1-2(Gala1- |
| 2(Galb1-4GlcNAcb1-4)Mana1-3)(NeuGca2- | 3Galb1-4GlcNAcb1-4)Mana1-3(NeuAca2-8NeuAca2- |
| 8NeuGca2-3/6Galb1-4(Fuca1-3)GlcNAcb1- | 3/6Galb1-4GlcNAcb1-3Galb1-4GlcNAcb1- |
| 2(NeuAca2-8NeuAca2-3/6Galb1-4(Fuca1- | 2(NeuAca2-3/6Galb1-4(Fuca1-3)GlcNAcb1- |
| 3)GlcNAcb1-6)Mana1-6)Manb1-4GlcNAcb1-4GlcNAc | 6)Mana1-6)Manb1-4GlcNAcb1-4GlcNAc |
| GlcNAcb1-4(Gala1-3Galb1-4(Fuca1-3)GlcNAcb1- | GlcNAcb1-4(NeuAca2-8NeuAca2-3/6Galb1-4(Fuca1- |
| 2(NeuGca2-3/6Galb1-4GlcNAcb1-4)Mana1- | 3)GlcNAcb1-3Galb1-4(Fuca1-3)GlcNAcb1- |
| 3)(NeuAca2-8NeuGca2-3/6Galb1-4GlcNAcb1- | 2(NeuGca2-3/6Galb1-4(Fuca1-3)GlcNAcb1-3Galb1- |
| 2(NeuAca2-3/6Galb1-4(Fuca1-3)GlcNAcb1- | 4GlcNAcb1-4)Mana1-3)(Mana1-3(Mana1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Fuca1-2Galb1-4(Fuca1-3)GlcNAcb1- | 3)GlcNAcb1-2(GalNAcb1-4(Fuca1-3)GlcNAcb1- |
| 4)Mana1-3)(NeuGca2-3/6Galb1-4(Fuca1- | 4)Mana1-3)(NeuAca2-3/6Galb1-4(Fuca1- |
| 3)GlcNAcb1-2(NeuGca2-3/6Galb1-4(Fuca1- | 3)GlcNAcb1-2(NeuAca2-8NeuAca2-3/6Galb1- |
| 3)GlcNAcb1-6)Mana1-6)Manb1-4GlcNAcb1- | 4GlcNAcb1-6)Mana1-6)Manb1-4GlcNAcb1-4(Fuca1- |
| 4(Fuca1-6)GlcNAc | 6)GlcNAc |
| GlcNAcb1-4(NeuGca2-8NeuGca2-3/6Galb1- | NeuGca2-3/6Galb1-4GlcNAcb1-2(NeuGca2- |
| 4(Fuca1-3)GlcNAcb1-2(NeuGca2-3/6Galb1- | 3/6Galb1-4GlcNAcb1-4)Mana1-3(NeuAca2- |
| 4GlcNAcb1-4)Mana1-3)(NeuGca2-3/6Galb1- | 8NeuGca2-3/6Galb1-4GlcNAcb1-3Galb1- |
| 4GlcNAcb1-2(NeuAca2-3/6Galb1-4(Fuca1- | 4GlcNAcb1-2(NeuAca2-3/6Galb1-4GlcNAcb1- |
| 3)GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-8NeuGca2-3/6Galb1- | NeuGca2-3/6Galb1-4(Fuca1-3)GlcNAcb1- |
| 4(Fuca1-3)GlcNAcb1-2(NeuGca2-3/6Galb1- | 2(NeuGca2-3/6Galb1-4(Fuca1-3)GlcNAcb1- |
| 4GlcNAcb1-4)Mana1-3)(NeuAca2-8NeuAca2- | 4)Mana1-3(NeuGca2-3/6Galb1-4(Fuca1- |
| 3/6Galb1-4GlcNAcb1-2(Gala1-3Galb1-4GlcNAcb1- | 3)GlcNAcb1-3Galb1-4GlcNAcb1-2(NeuAca2-3/6 |
| 6)Mana1-6)Manb1-4GlcNAcb1-4GlcNAc | Galb1-4GlcNAcb1-6)Mana1-6)Manb1-4GlcNAcb1- |
| | 4GlcNAc |
| NeuGca2-3/6Galb1-4(Fuca1-3)GlcNAcb1-2(Gala1- | GlcNAcb1-4(Gala1-3Galb1-4(Fuca1-3)GlcNAcb1- |
| 3Galb1-4GlcNAcb1-4)Mana1-3(NeuAca2-8NeuGca2- | 2(NeuGca2-3/6Galb1-4GlcNAcb1-4)Mana1- |
| 3/6Galb1-4GlcNAcb1-3Galb1-4GlcNAcb1- | 3)(NeuGca2-8NeuGca2-3/6Galb1-4GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(Gala1-3Galb1-4(Fuca1-3)GlcNAcb1- | GlcNAcb1-4(NeuAca2-8NeuGca2-3/6Galb1- |
| 2(Galb1-4GlcNAcb1-4)Mana1-3)(NeuGca2- | 4(Fuca1-3)GlcNAcb1-3Galb1-4(Fuca1-3)GlcNAcb1- |
| 8NeuGca2-3/6Galb1-4(Fuca1-3)GlcNAcb1- | 2(NeuGca2-3/6Galb1-4(Fuca1-3)GcNAcb1-3Galb1- |
| 2(NeuAca2-8NeuGca2-3/6Galb1-4(Fuca1- | 4GlcNAcb1-4)Mana1-3)(Mana1-3(Mana1-6)Mana1- |
| 3)GlcNAcb1-6)Mana1-6)Manb1-4GlcNAcb1-4GlcNAc | 6)Manb1-4GlcNAcb1-4(Fuca1-6)GlcNAc |
| GlcNAcb1-4(NeuAca2-3/6Galb1-4GlcNAcb1- | GlcNAcb1-4(NeuGca2-3/6Galb1-4(Fuca1- |
| 2(NeuAca2-3/6Galb1-4GlcNAcb1-4)Mana1- | 3)GlcNAcb1-2(GalNAcb1-4(Fuca1-3)GlcNAcb1- |
| 3)(NeuAca2-8NeuAca2-3/6Galb1-4GlcNAcb1- | 4)Mana1-3)(NeuGca2-3/6Galb1-4(Fuca1- |
| 3Galb1-4GlcNAcb1-2(NeuAca2-3/6Galb1- | 3)GlcNAcb1-2(NeuAca2-8NeuAca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Galb1-4GlcNAcb1-4)Mana1- | 3)GlcNAcb1-2(Galb1-4(Fuca1-3)GlcNAcb1- |
| 3)(NeuAca2-8NeuAca2-3/6Galb1-4GlcNAcb1- | 4)Mana1-3)(NeuAca2-3/6Galb1-4(Fuca1- |
| 3Galb1-4GlcNAcb1-2(NeuAca2-3/6Galb1- | 3)GlcNAcb1-3Galb1-4GlcNAcb1-2(NeuAca2-3/ |
| 4GlcNAcb1-6)Mana1-6)Manb1-4GlcNAcb1-4(Fuca1- | 6Galb1-4GlcNAcb1-6)Mana1-6)Manb1-4GlcNAcb1- |
| 6)GlcNAc | 4(Fuca1-6)GlcNAc |
| GlcNAcb1-4(NeuAca2-3/6Galb1-4(Fuca1- | GlcNAcb1-4(NeuGca2-8NeuGca2-3/6Galb1- |
| 3)GlcNAcb1-2(Fuca1-2Galb1-4(Fuca1-3)GlcNAcb1- | 4(Fuca1-3)GlcNAcb1-2(NeuGca2-3/6Galb1- |
| 4)Mana1-3)(NeuAca2-3/6Galb1-4(Fuca1- | 4GlcNAcb1-4)Mana1-3)(NeuGca2-3/6Galb1- |
| 3)GlcNAcb1-3Galb1-4GlcNAcb1-2(Galb1-4(Fuca1- | 4GlcNAcb1-2(NeuGca2-3/6Galb1-4(Fuca1- |
| 3)GlcNAcb1-6)Mana1-6)Manb1-4GlcNAcb1- | 3)GlcNAcb1-6)Mana1-6)Manb1-4GlcNAcb1-4GlcNAc |
| 4(Fuca1-6)GlcNAc | |
| NeuGca2-3/6Galb1-4GlcNAcb1-2(NeuGca2- | GlcNAcb1-4(NeuGca2-8NeuGca2-3/6Galb1- |
| 3/6Galb1-4GlcNAcb1-4)Mana1-3(NeuGca2- | 4(Fuca1-3)GlcNAcb1-2(NeuGca2-3/6Galb1- |
| 8NeuGca2-3/6Galb1-4GlcNAcb1-3Galb1- | 4GlcNAcb1-4)Mana1-3)(NeuAca2-8NeuGca2- |
| 4GlcNAcb1-2(NeuAca2-3/6Galb1-4GlcNAcb1- | 3/6Galb1-4GlcNAcb1-2(Gala1-3Galb1-4GlcNAcb1- |
| 6)Mana1-6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1- | GlcNAcb1-4(Gala1-3Galb1-4(Fuca1-3)GlcNAcb1- |
| 2(NeuGca2-3/6Galb1-4(Fuca1-3)GlcNAcb1- | 2(NeuGca2-3/6Galb1-4GlcNAcb1-4)Mana1- |
| 4)Mana1-3(NeuGca2-3/6Galb1-4(Fuca1- | 3)(NeuGca2-8NeuGca2-3/6Galb1-4GlcNAcb1- |
| 3)GlcNAcb1-3Galb1-4GlcNAcb1-2(NeuGca2-3/6 | 2(NeuGca2-3/6Galb1-4(Fuca1-3)GlcNAcb1- |
| Galb1-4GlcNAcb1-6)Mana1-6)Manb1-4GlcNAcb1- | 6)Mana1-6)Manb1-4GlcNAcb1-4(Fuca1-6)GlcNAc |
| 4GlcNAc | |
| GlcNAcb1-4(Gala1-3Galb1-4(Fuca1-3)GlcNAcb1- | NeuGca2-3/6Galb1-4(Fuca1-3)GlcNAcb1-2(Gala1- |
| 2(Galb1-4GlcNAcb1-4)Mana1-3)(NeuGca2- | 3Galb1-4GlcNAcb1-4)Mana1-3(NeuGca2- |
| 8NeuGca2-3/6Galb1-4(Fuca1-3)GlcNAcb1- | 8NeuGca2-3/6Galb1-4GlcNAcb1-3Galb1- |
| 2(NeuGca2-8NeuGca2-3/6Galb1-4(Fuca1- | 4GlcNAcb1-2(NeuAca2-3/6Galb1-4(Fuca1- |
| 3)GlcNAcb1-6)Mana1-6)Manb1-4GlcNAcb1-4GlcNAc | 3)GlcNAcb1-6)Mana1-6)Manb1-4GlcNAcb1-4GlcNAc |
| GlcNAcb1-4(NeuGca2-8NeuGca2-3/6Galb1- | GlcNAcb1-4(NeuAca2-3/6Galb1-4GlcNAcb1- |
| 4(Fuca1-3)GlcNAcb1-3Galb1-4(Fuca1-3)GlcNAcb1- | 2(NeuGca2-3/6Galb1-4GlcNAcb1-4)Mana1- |
| 2(NeuGca2-3/6Galb1-4(Fuca1-3)GlcNAcb1-3Galb1- | 3)(NeuAca2-8NeuAca2-3/6Galb1-4GlcNAcb1- |
| 4GlcNAcb1-4)Mana1-3)(Mana1-3(Mana1-6)Mana1- | 3Galb1-4GlcNAcb1-2(NeuAca2-3/6Galb1- |
| 6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4GlcNAcb1-4)Mana1- | 3)GlcNAcb1-2(GalNAcb1-4(Fuca1-3)GlcNAcb1- |
| 3)(NeuAca2-8NeuAca2-3/6Galb1-4GlcNAcb1- | 4)Mana1-3)(NeuGca2-3/6Galb1-4(Fuca1- |
| 3Galb1-4GlcNAcb1-2(NeuAca2-3/6Galb1- | 3)GlcNAcb1-2(NeuAca2-8NeuGca2-3/6Galb1- |
| 4GlcNAcb1-6)Mana1-6)Manb1-4GlcNAcb1-4(Fuca1- | 4GlcNAcb1-6)Mana1-6)Manb1-4GlcNAcb1-4(Fuca1- |
| 6)GlcNAc | 6)GlcNAc |
| GlcNAcb1-4(Gala1-3Galb1-4GlcNAcb1-2(NeuAca2- | NeuAca2-3Galb1-4GlcNAcb1-2(NeuAca2-3Galb1- |
| 3/6Galb1-4GlcNAcb1-4)Mana1-3)(NeuAca2- | 4GlcNAcb1-4)Mana1-3(NeuAca2-3Galb1- |
| 8NeuAca2-3/6Galb1-4GlcNAcb1-3Galb1- | 4GlcNAcb1-3Galb1-4GlcNAcb1-2(NeuAca2-3Galb1- |
| 4GlcNAcb1-2(NeuAca2-3/6Galb1-4GlcNAcb1- | 4GlcNAcb1-3Galb1-4GlcNAcb1-6)Mana1-6)Manb1- |
| 6)Mana1-6)Manb1-4GlcNAcb1-4(Fuca1-6)GlcNAc | 4GlcNAcb1-4(Fuca1-6)GlcNAc |
| NeuAca2-3Galb1-4GlcNAcb1-2(NeuAca2-3Galb1- | NeuAca2-3Galb1-4GlcNAcb1-2(NeuAca2-3Galb1- |
| 4GlcNAcb1-4)Mana1-3(NeuAca2-3Galb1- | 4GlcNAcb1-4)Mana1-3(NeuAca2-3Galb1- |
| 4GlcNAcb1-3Galb1-4GlcNAcb1-2(NeuAca2-3Galb1- | 4GlcNAcb1-3Galb1-4(NeuAca2-3Galb1-4GlcNAcb1- |
| 4GlcNAcb1-3Galb1-4GlcNAcb1-6)Mana1-6)Manb1- | 3Galb1-4GlcNAcb1-6)GlcNAcb1-2Mana1-6)Manb1- |
| 4GlcNAcb1-4(Fuca1-6)GlcNAcb | 4GlcNAcb1-4(Fuca1-6)GlcNAc |
| GlcNAcb1-4(NeuGca2-3/6Galb1-4(Fuca1- | GlcNAcb1-4(Fuca1-2Galb1-4(Fuca1-3)GlcNAcb1- |
| 3)GlcNAcb1-2(Galb1-4(Fuca1-3)GlcNAcb1- | 2(Gala1-3Galb1-4GlcNAcb1-4)Mana1-3)(NeuAca2- |
| 4)Mana1-3)(NeuAca2-3/6Galb1-4(Fuca1- | 3/6Galb1-4(Fuca1-3)GlcNAcb1-3Galb1-4GlcNAcb1- |
| 3)GlcNAcb1-3Galb1-4GlcNAcb1-2(NeuAca2-3/ | 2(NeuAca2-3/6Galb1-4(Fuca1-3)GlcNAcb1- |
| 6Galb1-4GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| GlcNAcb1-4(NeuGca2-3/6Galb1-4(Fuca1- | NeuGca2-3/6Galb1-4GlcNAcb1-2(NeuGca2- |
| 3)GlcNAcb1-2(Fuca1-2Galb1-4(Fuca1-3)GlcNAcb1- | 3/6Galb1-4GlcNAcb1-4)Mana1-3(NeuGca2- |
| 4)Mana1-3)(NeuAca2-3/6Galb1-4(Fuca1- | 8NeuGca2-3/6Galb1-4GlcNAcb1-3Galb1- |
| 3)GlcNAcb1-3Galb1-4GlcNAcb1-2(Galb1-4(Fuca1- | 4GlcNAcb1-2(NeuGca2-3/6Galb1-4GlcNAcb1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| GlcNAcb1-4(NeuGca2-8NeuGca2-3/6Galb1- | NeuGca2-3/6Galb1-4(Fuca1-3)GlcNAcb1-2(Gala1- |
| 4(Fuca1-3)GlcNAcb1-2(NeuGca2-3/6Galb1- | 3Galb1-4GlcNAcb1-4)Mana1-3(NeuGca2- |
| 4GlcNAcb1-4)Mana1-3)(NeuGca2-8NeuGca2- | 8NeuGca2-3/6Galb1-4GlcNAcb1-3Galb1- |
| 3/6Galb1-4GlcNAcb1-2(Gala1-3Galb1-4GlcNAcb1- | 4GlcNAcb1-2(NeuGca2-3/6Galb1-4(Fuca1- |
| 6)Mana1-6)Manb1-4GlcNAcb1-4GlcNAc | 3)GlcNAcb1-6)Mana1-6)Manb1-4GlcNAcb1-4GlcNAc |
| GlcNAcb1-4(NeuGca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(GalNAcb1-4(Fuca1-3)GlcNAcb1- |
| 3)(NeuAca2-8NeuAca2-3/6Galb1-4GlcNAcb1- | 4)Mana1-3)(NeuGca2-3/6Galb1-4(Fuca1- |
| 3Galb1-4GlcNAcb1-2(NeuAca2-3/6Galb1- | 3)GlcNAcb1-2(NeuGca2-8NeuGca2-3/6Galb1- |
| 4GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(Gala1-3Galb1-4GlcNAcb1-2(NeuGca2- | GlcNAcb1-4(NeuGca2-3/6Galb1-4(Fuca1- |
| 3/6Galb1-4GlcNAcb1-4)Mana1-3)(NeuAca2- | 3)GlcNAcb1-2(Galb1-4GlcNAcb1-4)Mana1- |
| 8NeuAca2-3/6Galb1-4GlcNAcb1-3Galb1- | 3)(NeuAca2-8NeuGca2-3/6Galb1-4GlcNAcb1- |
| 4GlcNAcb1-2(NeuAca2-3/6Galb1-4GlcNAcb1- | 3Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4(Fuca1- |
| | 6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(Galb1-4(Fuca1-3)GlcNAcb1- | 3)GlcNAcb1-2(Fuca1-2Galb1-4(Fuca1-3)GlcNAcb1- |
| 4)Mana1-3)(NeuGca2-3/6Galb1-4(Fuca1- | 4)Mana1-3)(NeuGca2-3/6Galb1-4(Fuca1- |
| 3)GlcNAcb1-3Galb1-4GlcNAcb1-2(NeuAca2-3/ | 3)GlcNAcb1-3Galb1-4GlcNAcb1-2(Galb1-4(Fuca1- |
| 6Galb1-4GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| GlcNAcb1-4(Fuca1-2Galb1-4(Fuca1-3)GlcNAcb1- | GlcNAcb1-4(NeuGca2-3/6Galb1-4GlcNAcb1- |
| 2(Gala1-3Galb1-4GlcNAcb1-4)Mana1-3)(NeuGca2- | 2(NeuGca2-3/6Galb1-4GlcNAcb1-4)Mana1- |
| 3/6Galb1-4(Fuca1-3)GlcNAcb1-3Galb1-4GlcNAcb1- | 3)(NeuAca2-8NeuGca2-3/6Galb1-4GlcNAcb1- |
| 2(NeuAca2-3/6Galb1-4(Fuca1-3)GlcNAcb1- | 3Galb1-4GlcNAcb1-2(NeuAca2-3/6Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAc |
| GlcNAcb1-4(NeuGca2-3/6Galb1-4(Fuca1- | GlcNAcb1-4(Gala1-3Galb1-4GlcNAcb1-2(NeuGca2- |
| 3)GlcNAcb1-2(Galb1-4GlcNAcb1-4)Mana1- | 3/6Galb1-4GlcNAcb1-4)Mana1-3)(NeuAca2- |
| 3)(NeuGca2-8NeuGca2-3/6Galb1-4GlcNAcb1- | 8NeuGca2-3/6Galb1-4GlcNAcb1-3Galb1- |
| 3Galb1-4GlcNAcb1-2(NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-4(NeuGca2-3/6Galb1-4(Fuca1- | GlcNAcb1-4(Fuca1-2Galb1-4(Fuca1-3)GlcNAcb1- |
| 3)GlcNAcb1-2(Galb1-4(Fuca1-3)GlcNAcb1- | 2(Gala1-3Galb1-4GlcNAcb1-4)Mana1-3)(NeuGca2- |
| 4)Mana1-3)(NeuGca2-3/6Galb1-4(Fuca1- | 3/6Galb1-4(Fuca1-3)GlcNAcb1-3Galb1-4GlcNAcb1- |
| 3)GlcNAcb1-3Galb1-4GlcNAcb1-2(NeuGca2-3/ | 2(NeuGca2-3/6Galb1-4(Fuca1-3)GlcNAcb1- |
| 6Galb1-4GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| GlcNAcb1-4(NeuGca2-3/6Galb1-4GlcNAcb1- | GlcNAcb1-4(Gala1-3Galb1-4GlcNAcb1-2(NeuGca2- |
| 2(NeuGca2-3/6Galb1-4GlcNAcb1-4)Mana1- | 3/6Galb1-4GlcNAcb1-4)Mana1-3)(NeuGca2- |
| 3)(NeuGca2-8NeuGca2-3/6Galb1-4GlcNAcb1- | 8NeuGca2-3/6Galb1-4GlcNAcb1-3Galb1- |
| 3Galb1-4GlcNAcb1-2(NeuAca2-3/6Galb1- | 4GlcNAcb1-2(NeuAca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuGca2-3/6Galb1-4(Fuca1- | GlcNAcb1-4(NeuAca2-8NeuAca2-3/6Galb1-4(Fuca1- |
| 3)GlcNAcb1-2(Galb1-4GlcNAcb1-4)Mana1- | 3)GlcNAcb1-2(NeuAca2-3/6Galb1-4GlcNAcb1- |
| 3)(NeuGca2-8NeuGca2-3/6Galb1-4GlcNAcb1- | 4)Mana1-3)(NeuAca2-3/6Galb1-4GlcNAcb1- |
| 3Galb1-4GlcNAcb1-2(NeuGca2-3/6Galb1- | 2(NeuAca2-3/6Galb1-4(Fuca1-3)GlcNAcb1- |
| 4GlcNAcb1-6)Mana1-6)Manb1-4GlcNAcb1-4(Fuca1- | 6)Mana1-6)Manb1-4GlcNAcb1-4(Fuca1-6)GlcNAc |
| 6)GlcNAc | |
| GlcNAcb1-4(NeuGca2-3/6Galb1-4GlcNAcb1- | GlcNAcb1-4(Gala1-3Galb1-4GlcNAcb1-2(NeuGca2- |
| 2(NeuGca2-3/6Galb1-4GlcNAcb1-4)Mana1- | 3/6Galb1-4GlcNAcb1-4)Mana1-3)(NeuGca2- |
| 3)(NeuGca2-8NeuGca2-3/6Galb1-4GlcNAcb1- | 8NeuGca2-3/6Galb1-4GlcNAcb1-3Galb1- |
| 3Galb1-4GlcNAcb1-2(NeuGca2-3/6Galb1- | 4GlcNAcb1-2(NeuGca2-3/6Galb1-4GlcNAcb1- |
| 4GlcNAcb1-6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-8NeuAca2-3/6Galb1-4(Fuca1- | GlcNAcb1-4(NeuAca2-8NeuAca2-3/6Galb1-4(Fuca1- |
| 3)GlcNAcb1-2(NeuGca2-3/6Galb1-4GlcNAcb1- | 3)GlcNAcb1-2(NeuAca2-3/6Galb1-4GlcNAcb1- |
| 4)Mana1-3)(NeuAca2-3/6Galb1-4GlcNAcb1- | 4)Mana1-3)(NeuAca2-8NeuAca2-3/6Galb1- |
| 2(NeuAca2-3/6Galb1-4(Fuca1-3)GlcNAcb1- | 4GlcNAcb1-2(Gala1-3Galb1-4GlcNAcb1-6)Mana1- |
| 6)Mana1-6)Manb1-4GlcNAcb1-4(Fuca1-6)GlcNAc | 6)Manb1-4GlcNAcb1-4(Fuca1-6)GlcNAc |
| NeuAca2-3/6Galb1-4(Fuca1-3)GlcNAcb1- | GlcNAcb1-4(Gala1-3Galb1-4(Fuca1-3)GlcNAcb1- |
| 2(NeuAca2-3/6Galb1-4(Fuca1-3)GlcNAcb1- | 2(Galb1-4GlcNAcb1-4)Mana1-3)(NeuAca2- |
| 4)Mana1-3(NeuAca2-3/6Galb1-4(Fuca1- | 8NeuAca2-3/6Galb1-4(Fuca1-3)GlcNAcb1- |
| 3)GlcNAcb1-3Galb1-4GlcNAcb1-2(NeuAca2-3/6 | 2(NeuAca2-8NeuAca2-3/6Galb1-4(Fuca1- |
| Galb1-4GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| GalNAcb1-4(NeuAca2-3)Galb1-4GlcNAcb1- | GlcNAcb1-4(NeuAca2-8NeuGca2-3/6Galb1- |
| 2(GalNAcb1-4(NeuAca2-3)Galb1-4GlcNAcb1- | 4(Fuca1-3)GlcNAcb1-2(NeuGca2-3/6Galb1- |
| 4)Mana1-3(GalNAcb1-4(NeuAca2-3)Galb1- | 4GlcNAcb1-4)Mana1-3)(NeuAca2-3/6Galb1- |
| 4GlcNAcb1-2(GalNAcb1-4(NeuAca2-3)Galb1- | 4GlcNAcb1-2(NeuAca2-3/6Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1- |
| 6)GlcNAc | 4(Fuca1-6)GlcNAc |
| GlcNAcb1-4(NeuAca2-8NeuAca2-3/6Galb1-4(Fuca1- | NeuAca2-3/6Galb1-4(Fuca1-3)GlcNAcb1-2(Gala1- |
| 3)GlcNAcb1-2(NeuGca2-3/6Galb1-4GlcNAcb1- | 3Galb1-4GlcNAcb1-4)Mana1-3(NeuAca2-8NeuAca2- |
| 4)Mana1-3)(NeuAca2-8NeuAca2-3/6Galb1- | 3/6Galb1-4GlcNAcb1-3Galb1-4GlcNAcb1- |
| 4GlcNAcb1-2(Gala1-3Galb1-4GlcNAcb1-6)Mana1- | 2(NeuAca2-3/6Galb1-4(Fuca1-3)GlcNAcb1- |
| 6)Manb1-4GlcNAcb1-4(Fuca1-6)GlcNAc | 6)Mana1-6)Manb1-4GlcNAcb1-4(Fuca1-6)GlcNAc |
| NeuAca2-3/6Galb1-4(Fuca1-3)GlcNAcb1- | GlcNAcb1-4(Gala1-3Galb1-4(Fuca1-3)GlcNAcb1- |
| 2(NeuGca2-3/6Galb1-4(Fuca1-3)GlcNAcb1- | 2(Galb1-4GlcNAcb1-4)Mana1-3)(NeuAca2- |
| 4)Mana1-3(NeuAca2-3/6Galb1-4(Fuca1- | 8NeuGca2-3/6Galb1-4(Fuca1-3)GlcNAcb1- |
| 3)GlcNAcb1-3Galb1-4GlcNAcb1-2(NeuAca2-3/6 | 2(NeuAca2-8NeuAca2-3/6Galb1-4(Fuca1- |
| Galb1-4GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| GlcNAcb1-4(NeuAca2-8NeuGca2-3/6Galb1- | GlcNAcb1-4(NeuGca2-8NeuGca2-3/6Galb1- |
| 4(Fuca1-3)GlcNAcb1-2(NeuGca2-3/6Galb1- | 4(Fuca1-3)GlcNAcb1-2(NeuGca2-3/6Galb1- |
| 4GlcNAcb1-4)Mana1-3)(NeuAca2-8NeuAca2- | 4GlcNAcb1-4)Mana1-3)(NeuAca2-3/6Galb1- |
| 3/6Galb1-4GlcNAcb1-2(Gala1-3Galb1-4GlcNAcb1- | 4GlcNAcb1-2(NeuAca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| NeuGca2-3/6Galb1-4(Fuca1-3)GlcNAcb1-2(Gala1- | NeuGca2-3/6Galb1-4(Fuca1-3)GlcNAcb1- |
| 3Galb1-4GlcNAcb1-4)Mana1-3(NeuAca2-8NeuAca2- | 2(NeuGca2-3/6Galb1-4(Fuca1-3)GlcNAcb1- |
| 3/6Galb1-4GlcNAcb1-3Galb1-4GlcNAcb1- | 4)Mana1-3(NeuAca2-3/6Galb1-4(Fuca1- |
| 2(NeuAca2-3/6Galb1-4(Fuca1-3)GlcNAcb1- | 3)GlcNAcb1-3Galb1-4GlcNAcb1-2(NeuAca2-3/6 |
| 6)Mana1-6)Manb1-4GlcNAcb1-4(Fuca1-6)GlcNAc | Galb1-4GlcNAcb1-6)Mana1-6)Manb1-4GlcNAcb1- |
| | 4(Fuca1-6)GlcNAc |
| GlcNAcb1-4(Gala1-3Galb1-4(Fuca1-3)GlcNAcb1- | GlcNAcb1-4(NeuGca2-8NeuGca2-3/6Galb1- |
| 2(Galb1-4GlcNAcb1-4)Mana1-3)(NeuGca2- | 4(Fuca1-3)GlcNAcb1-2(NeuGca2-3/6Galb1- |
| 8NeuGca2-3/6Galb1-4(Fuca1-3)GlcNAcb1- | 4GlcNAcb1-4)Mana1-3)(NeuAca2-8NeuAca2- |
| 2(NeuAca2-8NeuAca2-3/6Galb1-4(Fuca1- | 3/6Galb1-4GlcNAcb1-2(Gala1-3Galb1-4GlcNAcb1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| GlcNAcb1-4(NeuGca2-8NeuGca2-3/6Galb1- | GlcNAcb1-4(Gala1-3Galb1-4(Fuca1-3)GlcNAcb1- |
| 4(Fuca1-3)GlcNAcb1-2(NeuGca2-3/6Galb1- | 2(Galb1-4GlcNAcb1-4)Mana1-3)(NeuGca2- |
| 4GlcNAcb1-4)Mana1-3)(NeuGca2-3/6Galb1- | 8NeuGca2-3/6Galb1-4(Fuca1-3)GlcNAcb1- |
| 4GlcNAcb1-2(NeuAca2-3/6Galb1-4(Fuca1- | 2(NeuAca2-8NeuGca2-3/6Galb1-4(Fuca1- |
| 3)GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| NeuGca2-3/6Galb1-4(Fuca1-3)GlcNAcb1-2(Gala1- | NeuGca2-3/6Galb1-4(Fuca1-3)GlcNAcb1- |
| 3Galb1-4GlcNAcb1-4)Mana1-3(NeuAca2-8NeuGca2- | 2(NeuGca2-3/6Galb1-4(Fuca1-3)GlcNAcb1- |
| 3/6Galb1-4GlcNAcb1-3Galb1-4GlcNAcb1- | 4)Mana1-3(NeuGca2-3/6Galb1-4(Fuca1- |
| 2(NeuAca2-3/6Galb1-4(Fuca1-3)GlcNAcb1- | 3)GlcNAcb1-3Galb1-4GlcNAcb1-2(NeuAca2-3/6 |
| 6)Mana1-6)Manb1-4GlcNAcb1-4(Fuca1-6)GlcNAc | Galb1-4GlcNAcb1-6)Mana1-6)Manb1-4GlcNAcb1- |
| | 4(Fuca1-6)GlcNAc |
| GlcNAcb1-4(NeuAca2-3/6Galb1-4GlcNAcb1- | GlcNAcb1-4(NeuAca2-3/6Galb1-4(Fuca1- |
| 2(NeuAca2-3/6Galb1-4GlcNAcb1-4)Mana1- | 3)GlcNAcb1-2(NeuAca2-3/6Galb1-4(Fuca1- |
| 3)(NeuAca2-8NeuAca2-3/6Galb1-4GlcNAcb1- | 3)GlcNAcb1-4)Mana1-3)(NeuAca2-3/6Galb1- |
| 3Galb1-4GlcNAcb1-2(NeuAca2-3/6Galb1- | 4(Fuca1-3)GlcNAcb1-3Galb1-4GlcNAcb1-2 |
| 4GlcNAcb1-6)Mana1-6)Manb1-4GlcNAcb1-4(Fuca1- | (NeuAca2-3/6Galb1-4GlcNAcb1-6)Mana1-6)Manb1- |
| 6)GlcNAc | 4GlcNAcb1-4GlcNAc |
| GlcNAcb1-4(NeuGca2-8NeuGca2-3/6Galb1- | GlcNAcb1-4(NeuGca2-8NeuGca2-3/6Galb1- |
| 4(Fuca1-3)GlcNAcb1-2(NeuGca2-3/6Galb1- | 4(Fuca1-3)GlcNAcb1-2(NeuGca2-3/6Galb1- |
| 4GlcNAcb1-4)Mana1-3)(NeuGca2-3/6Galb1- | 4GlcNAcb1-4)Mana1-3)(NeuAca2-8NeuGca2- |
| 4GlcNAcb1-2(NeuGca2-3/6Galb1-4(Fuca1- | 3/6Galb1-4GlcNAcb1-2(Gala1-3Galb1-4GlcNAcb1- |
| 3)GlcNAcb1-6)Mana1-6)Manb1-4GlcNAcb1- | 6)Mana1-6)Manb1-4GlcNAcb1-4(Fuca1-6)GlcNAc |
| 4(Fuca1-6)GlcNAc | |
| NeuGca2-3/6Galb1-4(Fuca1-3)GlcNAcb1-2(Gala1- | GlcNAcb1-4(Gala1-3Galb1-4(Fuca1-3)GlcNAcb1- |
| 3Galb1-4GlcNAcb1-4)Mana1-3(NeuGca2- | 2(Galb1-4GlcNAcb1-4)Mana1-3)(NeuGca2- |
| 8NeuGca2-3/6Galb1-4GlcNAcb1-3Galb1- | 8NeuGca2-3/6Galb1-4(Fuca1-3)GlcNAcb1- |
| 4GlcNAcb1-2(NeuAca2-3/6Galb1-4(Fuca1- | 2(NeuGca2-8NeuGca2-3/6Galb1-4(Fuca1- |
| 3)GlcNAcb1-6)Mana1-6)Manb1-4GlcNAcb1- | 3)GlcNAcb1-6)Mana1-6)Manb1-4GlcNAcb1- |
| 4(Fuca1-6)GlcNAc | 4(Fuca1-6)GlcNAc |
| NeuGca2-3/6Galb1-4(Fuca1-3)GlcNAcb1- | GlcNAcb1-4(NeuAca2-3/6Galb1-4GlcNAcb1- |
| 2(NeuGca2-3/6Galb1-4(Fuca1-3)GlcNAcb1- | 2(NeuGca2-3/6Galb1-4GlcNAcb1-4)Mana1- |
| 4)Mana1-3(NeuGca2-3/6Galb1-4(Fuca1- | 3)(NeuAca2-8NeuAca2-3/6Galb1-4GlcNAcb1- |
| 3)GlcNAcb1-3Galb1-4GlcNAcb1-2(NeuGca2-3/6 | 3Galb1-4GlcNAcb1-2(NeuAca2-3/6Galb1- |
| Galb1-4GlcNAcb1-6)Mana1-6)Manb1-4GlcNAcb1- | 4GlcNAcb1-6)Mana1-6)Manb1-4GlcNAcb1-4(Fuca1- |
| 4(Fuca1-6)GlcNAc | 6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(Gala1-3Galb1-4GlcNAcb1-4)Mana1- | 3)GlcNAcb1-2(NeuGca2-3/6Galb1-4(Fuca1- |
| 3)(NeuAca2-8NeuAca2-3/6Galb1-4GlcNAcb1- | 3)GlcNAcb1-4)Mana1-3)(NeuAca2-3/6Galb1- |
| 3Galb1-4GlcNAcb1-2(NeuAca2-3/6Galb1-4(Fuca1- | 4(Fuca1-3)GlcNAcb1-3Galb1-4GlcNAcb1-2 |
| 3)GlcNAcb1-6)Mana1-6)Manb1-4GlcNAcb1-4GlcNAc | (NeuAca2-3/6Galb1-4GlcNAcb1-6)Mana1-6)Manb1- |
| | 4GlcNAcb1-4GlcNAc |
| GlcNAcb1-4(NeuGca2-8NeuGca2-3/6Galb1- | NeuGca2-3/6Galb1-4(Fuca1-3)GlcNAcb1-2(Gala1- |
| 4(Fuca1-3)GlcNAcb1-2(NeuGca2-3/6Galb1- | 3Galb1-4GlcNAcb1-4)Mana1-3(NeuGca2- |
| 4GlcNAcb1-4)Mana1-3)(NeuGca2-8NeuGca2- | 8NeuGca2-3/6Galb1-4GlcNAcb1-3Galb1- |
| 3/6Galb1-4GlcNAcb1-2(Gala1-3Galb1-4GlcNAcb1- | 4GlcNAcb1-2(NeuGca2-3/6Galb1-4(Fuca1- |
| 6)Mana1-6)Manb1-4GlcNAcb1-4(Fuca1-6)GlcNAc | 3)GlcNAcb1-6)Mana1-6)Manb1-4GlcNAcb1- |
| | 4(Fuca1-6)GlcNAc |
| GlcNAcb1-4(NeuGca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(NeuGca2-3/6Galb1-4(Fuca1- |
| 3)(NeuAca2-8NeuAca2-3/6Galb1-4GlcNAcb1- | 3)GlcNAcb1-4)Mana1-3)(NeuAca2-3/6Galb1- |
| 3Galb1-4GlcNAcb1-2(NeuAca2-3/6Galb1- | 4(Fuca1-3)GlcNAcb1-3Galb1-4GlcNAcb1-2 |
| 4GlcNAcb1-6)Mana1-6)Manb1-4GlcNAcb1-4(Fuca1- | (NeuAca2-3/6Galb1-4GlcNAcb1-6)Mana1-6)Manb1- |
| 6)GlcNAc | 4GlcNAcb1-4GlcNAc |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(Gala1-3Galb1-4GlcNAcb1-4)Mana1- | 2(NeuGca2-3/6Galb1-4GlcNAcb1-4)Mana1- |
| 3)(NeuAca2-8NeuAca2-3/6Galb1-4GlcNAcb1- | 3)(NeuAca2-8NeuGca2-3/6Galb1-4GlcNAcb1- |
| 3Galb1-4GlcNAcb1-2(NeuAca2-3/6Galb1-4(Fuca1- | 3Galb1-4GlcNAcb1-2(NeuAca2-3/6Galb1- |
| 3)GlcNAcb1-6)Mana1-6)Manb1-4GlcNAcb1-4GlcNAc | 4GlcNAcb1-6)Mana1-6)Manb1-4GlcNAcb1-4(Fuca1- |
| | 6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(Gala1-3Galb1-4GlcNAcb1-4)Mana1- |
| 3)GlcNAcb1-4)Mana1-3)(NeuGca2-3/6Galb1- | 3)(NeuAca2-8NeuGca2-3/6Galb1-4GlcNAcb1- |
| 4(Fuca1-3)GlcNAcb1-3Galb1-4GlcNAcb1-2 | 3Galb1-4GlcNAcb1-2(NeuAca2-3/6Galb1-4(Fuca1- |
| (NeuAca2-3/6Galb1-4GlcNAcb1-6)Mana1-6)Manb1- | 3)GlcNAcb1-6)Mana1-6)Manb1-4GlcNAcb1-4GlcNAc |
| 4GlcNAcb1-4GlcNAc | |
| GlcNAcb1-4(NeuGca2-3/6Galb1-4GlcNAcb1- | GlcNAcb1-4(NeuGca2-3/6Galb1-4(Fuca1- |
| 2(NeuGca2-3/6Galb1-4GlcNAcb1-4)Mana1- | 3)GlcNAcb1-2(Gala1-3Galb1-4GlcNAcb1-4)Mana1- |
| 3)(NeuGca2-8NeuGca2-3/6Galb1-4GlcNAcb1- | 3)(NeuGca2-8NeuGca2-3/6Galb1-4GlcNAcb1- |
| 3Galb1-4GlcNAcb1-2(NeuAca2-3/6Galb1- | 3Galb1-4GlcNAcb1-2(NeuAca2-3/6Galb1-4(Fuca1- |
| 4GlcNAcb1-6)Mana1-6)Manb1-4GlcNAcb1-4(Fuca1- | 3)GlcNAcb1-6)Mana1-6)Manb1-4GlcNAcb1-4GlcNAc |
| 6)GlcNAc | |
| GlcNAcb1-4(NeuGca2-3/6Galb1-4(Fuca1- | GlcNAcb1-4(NeuGca2-3/6Galb1-4GlcNAcb1- |
| 3)GlcNAcb1-2(NeuGca2-3/6Galb1-4(Fuca1- | 2(NeuGca2-3/6Galb1-4GlcNAcb1-4)Mana1- |
| 3)GlcNAcb1-4)Mana1-3)(NeuGca2-3/6Galb1- | 3)(NeuGca2-8NeuGca2-3/6Galb1-4GlcNAcb1- |
| 4(Fuca1-3)GlcNAcb1-3Galb1-4GlcNAcb1-2 | 3Galb1-4GlcNAcb1-2(NeuGca2-3/6Galb1- |
| (NeuGca2-3/6Galb1-4GlcNAcb1-6)Mana1-6)Manb1- | 4GlcNAcb1-6)Mana1-6)Manb1-4GlcNAcb1-4(Fuca1- |
| 4GlcNAcb1-4GlcNAc | 6)GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(Gala1-3Galb1-4GlcNAcb1-4)Mana1- | 3)GlcNAcb1-2(NeuAca2-3/6Galb1-4(Fuca1- |
| 3)(NeuGca2-8NeuGca2-3/6Galb1-4GlcNAcb1- | 3)GlcNAcb1-4)Mana1-3)(NeuAca2-3/6Galb1- |
| 3Galb1-4GlcNAcb1-2(NeuGca2-3/6Galb1-4(Fuca1- | 4(Fuca1-3)GlcNAcb1-3Galb1-4GlcNAcb1-2 |
| 3)GlcNAcb1-6)Mana1-6)Manb1-4GlcNAcb1-4GlcNAc | (NeuAca2-3/6Galb1-4GlcNAcb1-6)Mana1-6)Manb1- |
| | 4GlcNAcb1-4(Fuca1-6)GlcNAc |
| GlcNAcb1-4(NeuAca2-3/6Galb1-4(Fuca1- | GlcNAcb1-4(NeuAca2-3/6Galb1-4(Fuca1- |
| 3)GlcNAcb1-2(NeuGca2-3/6Galb1-4(Fuca1- | 3)GlcNAcb1-2(Gala1-3Galb1-4GlcNAcb1-4)Mana1- |
| 3)GlcNAcb1-4)Mana1-3)(NeuAca2-3/6Galb1- | 3)(NeuAca2-8NeuAca2-3/6Galb1-4GlcNAcb1- |
| 4(Fuca1-3)GlcNAcb1-3Galb1-4GlcNAcb1-2 | 3Galb1-4GlcNAcb1-2(NeuAca2-3/6Galb1-4(Fuca1- |
| (NeuAca2-3/6Galb1-4GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(Gala1-3Galb1-4GlcNAcb1-4)Mana1- |
| 3)GlcNAcb1-4)Mana1-3)(NeuAca2-3/6Galb1- | 3)(NeuAca2-8NeuAca2-3/6Galb1-4GlcNAcb1- |
| 4(Fuca1-3)GlcNAcb1-3Galb1-4GlcNAcb1-2 | 3Galb1-4GlcNAcb1-2(NeuAca2-3/6Galb1-4(Fuca1- |
| (NeuAca2-3/6Galb1-4GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(Gala1-3Galb1-4GlcNAcb1-4)Mana1- |
| 3)GlcNAcb1-4)Mana1-3)(NeuGca2-3/6Galb1- | 3)(NeuAca2-8NeuGca2-3/6Galb1-4GlcNAcb1- |
| 4(Fuca1-3)GlcNAcb1-3Galb1-4GlcNAcb1-2 | 3Galb1-4GlcNAcb1-2(NeuAca2-3/6Galb1-4(Fuca1- |
| (NeuAca2-3/6Galb1-4GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(Gala1-3Galb1-4GlcNAcb1-4)Mana1- |
| 3)GlcNAcb1-4)Mana1-3)(NeuGca2-3/6Galb1- | 3)(NeuGca2-8NeuGca2-3/6Galb1-4GlcNAcb1- |
| 4(Fuca1-3)GlcNAcb1-3Galb1-4GlcNAcb1-2 | 3Galb1-4GlcNAcb1-2(NeuAca2-3/6Galb1-4(Fuca1- |
| (NeuGca2-3/6Galb1-4GlcNAcb1-6)Mana1-6)Manb1- | 3)GlcNAcb1-6)Mana1-6)Manb1-4GlcNAcb1- |
| 4GlcNAcb1-4(Fuca1-6)GlcNAc | 4(Fuca1-6)GlcNAc |
| GlcNAcb1-4(NeuGca2-3/6Galb1-4(Fuca1- | NeuAca2-3/6Galb1-4(Fuca1-3)GlcNAcb1- |
| 3)GlcNAcb1-2(Gala1-3Galb1-4GlcNAcb1-4)Mana1- | 2(NeuAca2-3/6Galb1-4(Fuca1-3)GlcNAcb1- |
| 3)(NeuGca2-8NeuGca2-3/6Galb1-4GlcNAcb1- | 4)Mana1-3(NeuAca2-8NeuAca2-3/6Galb1- |
| 3Galb1-4GlcNAcb1-2(NeuGca2-3/6Galb1-4(Fuca1- | 4GlcNAcb1-3Galb1-4(Fuca1-3)GlcNAcb1- |
| 3)GlcNAcb1-6)Mana1-6)Manb1-4GlcNAcb1- | 2(NeuAca2-3/6Galb1-4(Fuca1-3)GlcNAcb1- |
| 4(Fuca1-6)GlcNAc | 6)Mana1-6)Manb1-4GlcNAcb1-4GlcNAc |
| NeuAca2-3Galb1-4GlcNAcb1-2(NeuAca2-3Galb1- | NeuAca2-3Galb1-4GlcNAcb1-3Galb1-4GlcNAcb1- |
| 4GlcNAcb1-3Galb1-4GlcNAcb1-4)Mana1- | 2(NeuAca2-3Galb1-4GlcNAcb1-4)Mana1- |
| 3(NeuAca2-3Galb1-4GlcNAcb1-3Galb1-4GlcNAcb1- | 3(NeuAca2-3Galb1-4GlcNAcb1-3Galb1-4GlcNAcb1- |
| 2(NeuAca2-3Galb1-4GlcNAcb1-3Galb1-4GlcNAcb1- | 2(NeuAca2-3Galb1-4GlcNAcb1-3Galb1-4GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAcb |
| NeuAca2-3/6Galb1-4(Fuca1-3)GlcNAcb1- | NeuGca2-3/6Galb1-4(Fuca1-3)GlcNAcb1- |
| 2(NeuGca2-3/6Galb1-4(Fuca1-3)GlcNAcb1- | 2(NeuGca2-3/6Galb1-4(Fuca1-3)GlcNAcb1- |
| 4)Mana1-3(NeuAca2-8NeuAca2-3/6Galb1- | 4)Mana1-3(NeuAca2-8NeuAca2-3/6Galb1- |
| 4GlcNAcb1-3Galb1-4(Fuca1-3)GlcNAcb1- | 4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| NeuGca2-3/6Galb1-4(Fuca1-3)GlcNAcb1- | NeuGca2-3/6Galb1-4(Fuca1-3)GlcNAcb1- |
| 2(NeuGca2-3/6Galb1-4(Fuca1-3)GlcNAcb1- | 2(NeuGca2-3/6Galb1-4(Fuca1-3)GlcNAcb1- |
| 4)Mana1-3(NeuAca2-8NeuGca2-3/6Galb1- | 4)Mana1-3(NeuGca2-8NeuGca2-3/6Galb1- |
| 4GlcNAcb1-3Galb1-4(Fuca1-3)GlcNAcb1- | 4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| NeuGca2-3/6Galb1-4(Fuca1-3)GlcNAcb1- | NeuAca2-3/6Galb1-4(Fuca1-3)GlcNAcb1- |
| 2(NeuGca2-3/6Galb1-4(Fuca1-3)GlcNAcb1- | 2(NeuAca2-3/6Galb1-4(Fuca1-3)GlcNAcb1- |
| 4)Mana1-3(NeuGca2-8NeuGca2-3/6Galb1- | 4)Mana1-3(NeuAca2-8NeuAca2-3/6Galb1- |
| 4GlcNAcb1-3Galb1-4(Fuca1-3)GlcNAcb1- | 4GlcNAcb1-3Galb1-4(Fuca1-3)GlcNAcb1- |
| 2(NeuGca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| NeuAca2-3/6Galb1-4(Fuca1-3)GlcNAcb1- | NeuGca2-3/6Galb1-4(Fuca1-3)GlcNAcb1- |
| 2(NeuGca2-3/6Galb1-4(Fuca1-3)GlcNAcb1- | 2(NeuGca2-3/6Galb1-4(Fuca1-3)GlcNAcb1- |
| 4)Mana1-3(NeuAca2-8NeuAca2-3/6Galb1- | 4)Mana1-3(NeuAca2-8NeuAca2-3/6Galb1- |
| 4GlcNAcb1-3Galb1-4(Fuca1-3)GlcNAcb1- | 4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| NeuGca2-3/6Galb1-4(Fuca1-3)GlcNAcb1- | GlcNAcb1-4(NeuAca2-3/6Galb1-4(Fuca1- |
| 2(NeuGca2-3/6Galb1-4(Fuca1-3)GlcNAcb1- | 3)GlcNAcb1-2(NeuAca2-3/6Galb1-4(Fuca1- |
| 4)Mana1-3(NeuAca2-8NeuGca2-3/6Galb1- | 3)GlcNAcb1-4)Mana1-3)(NeuAca2-8NeuAca2- |
| 4GlcNAcb1-3Galb1-4(Fuca1-3)GlcNAcb1- | 3/6Galb1-4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1- | GlcNAcb1-4(NeuAca2-3/6Galb1-4(Fuca1- |
| 2(NeuGca2-3/6Galb1-4(Fuca1-3)GlcNAcb1- | 3)GlcNAcb1-2(NeuGca2-3/6Galb1-4(Fuca1- |
| 4)Mana1-3(NeuGca2-8NeuGca2-3/6Galb1- | 3)GlcNAcb1-4)Mana1-3)(NeuAca2-8NeuAca2- |
| 4GlcNAcb1-3Galb1-4(Fuca1-3)GlcNAcb1- | 3/6Galb1-4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| NeuGca2-3/6Galb1-4(Fuca1-3)GlcNAcb1- | GlcNAcb1-4(NeuGca2-3/6Galb1-4(Fuca1- |
| 2(NeuGca2-3/6Galb1-4(Fuca1-3)GlcNAcb1- | 3)GlcNAcb1-2(NeuGca2-3/6Galb1-4(Fuca1- |
| 4)Mana1-3(NeuGca2-8NeuGca2-3/6Galb1- | 3)GlcNAcb1-4)Mana1-3)(NeuAca2-8NeuAca2- |
| 4GlcNAcb1-3Galb1-4(Fuca1-3)GlcNAcb1- | 3/6Galb1-4GlcNAcb1-3Galb1-4(Fuca1-3)GlcNAcb1- |
| 2(NeuGca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(NeuGca2-3/6Galb1-4(Fuca1- |
| 3)GlcNAcb1-4)Mana1-3)(NeuAca2-8NeuGca2- | 3)GlcNAcb1-4)Mana1-3)(NeuGca2-8NeuGca2- |
| 3/6Galb1-4GlcNAcb1-3Galb1-4(Fuca1-3)GlcNAcb1- | 3/6Galb1-4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4GlcNAc |
| GlcNAcb1-4(NeuGca2-3/6Galb1-4(Fuca1- | GlcNAcb1-4(NeuAca2-3/6Galb1-4(Fuca1- |
| 3)GlcNAcb1-2(NeuGca2-3/6Galb1-4(Fuca1- | 3)GlcNAcb1-2(NeuAca2-3/6Galb1-4(Fuca1- |
| 3)GlcNAcb1-4)Mana1-3)(NeuGca2-8NeuGca2- | 3)GlcNAcb1-4)Mana1-3)(NeuAca2-8NeuAca2- |
| 3/6Galb1-4GlcNAcb1-3Galb1-4(Fuca1-3)GlcNAcb1- | 3/6Galb1-4GlcNAcb1-3Galb1-4(Fuca1-3)GlcNAcb1- |
| 2(NeuGca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4GlcNAc | 6)Mana1-6)Manb1-4GlcNAcb1-4(Fuca1-6)GlcNAc |
| GlcNAcb1-4(NeuAca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(NeuGca2-3/6Galb1-4(Fuca1- |
| 3)GlcNAcb1-4)Mana1-3)(NeuAca2-8NeuAca2- | 3)GlcNAcb1-4)Mana1-3)(NeuAca2-8NeuAca2- |
| 3/6Galb1-4GlcNAcb1-3Galb1-4(Fuca1-3)GlcNAcb1- | 3/6Galb1-4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuGca2-3/6Galb1-4(Fuca1- | GlcNAcb1-4(NeuGca2-3/6Galb1-4(Fuca1- |
| 3)GlcNAcb1-2(NeuGca2-3/6Galb1-4(Fuca1- | 3)GlcNAcb1-2(NeuGca2-3/6Galb1-4(Fuca1- |
| 3)GlcNAcb1-4)Mana1-3)(NeuAca2-8NeuGca2- | 3)GlcNAcb1-4)Mana1-3)(NeuGca2-8NeuGca2- |
| 3/6Galb1-4GlcNAcb1-3Galb1-4(Fuca1-3)GlcNAcb1- | 3/6Galb1-4GlcNAcb1-3Galb1-4(Fuca1-3)GlcNAcb1- |
| 2(NeuAca2-3/6Galb1-4(Fuca1-3)GlcNAcb1- | 2(NeuAca2-3/6Galb1-4(Fuca1-3)GlcNAcb1- |
| 6)Mana1-6)Manb1-4GlcNAcb1-4(Fuca1-6)GlcNAc | 6)Mana1-6)Manb1-4GlcNAcb1-4(Fuca1-6)GlcNAc |
| GlcNAcb1-4(NeuGca2-3/6Galb1-4(Fuca1- | Fuca1-3GalNAcb1-3Gala1-3Galb1-4GlcNAcb1- |
| 3)GlcNAcb1-2(NeuGca2-3/6Galb1-4(Fuca1- | 2(Fuca1-3GalNAcb1-3Gala1-3Galb1-4GlcNAcb1- |
| 3)GlcNAcb1-4)Mana1-3)(NeuGca2-8NeuGca2- | 4)Mana1-3(Fuca1-3GalNAcb1-3Gala1-3Galb1- |
| 3/6Galb1-4GlcNAcb1-3Galb1-4(Fuca1-3)GlcNAcb1- | 4GlcNAcb1-2(Fuca1-3GalNAcb1-3Gala1-3Galb1- |
| 2(NeuGca2-3/6Galb1-4(Fuca1-3)GlcNAcb1- | 4GlcNAcb1-4)(Fuca1-3GalNAcb1-3Gala1-3Galb1- |
| 6)Mana1-6)Manb1-4GlcNAcb1-4(Fuca1-6)GlcNAc | 4GlcNAcb1-6)Mana1-6)Manb1-4GlcNAcb1-4GlcNAcb |
| Fuca1-3GalNAcb1-3Gala1-3Galb1-4GlcNAcb1- | NeuAca2-6Galb1-4GlcNAcb1-3Galb1-4GlcNAcb1- |
| 2(Fuca1-3GalNAcb1-3Gala1-3Galb1-4GlcNAcb1- | 3Galb1-4GlcNAcb1-2(Galb1-4(Fuca1-3)GlcNAcb1- |
| 4)(Fuca1-3GalNAcb1-3Gala1-3Galb1-4GlcNAcb1- | 3Galb1-4(Fuca1-3)GlcNAcb1-3Galb1-4(Fuca1- |
| 6)Mana1-3(Fuca1-3GalNAcb1-3Gala1-3Galb1- | 3)GlcNAcb1-4)Mana1-3(Galb1-4GlcNAcb1-3Galb1- |
| 4GlcNAcb1-2(Fuca1-3GalNAcb1-3Gala1-3Galb1- | 4GlcNAcb1-3Galb1-4GlcNAcb1-2(Galb1-4(Fuca1- |
| 4GlcNAcb1-4)Mana1-6)Manb1-4GlcNAcb1-4GlcNAcb | 3)GlcNAcb1-3Galb1-4(Fuca1-3)GlcNAcb1-3Galb1- |
| | 4GlcNAcb1-6)Mana1-6)Manb1-4GlcNAcb1-4(Fuca1- |
| | 6)GlcNAcb |
| NeuAca2-6Galb1-4GlcNAcb1-3Galb1-4GlcNAcb1- | NeuAca2-6Galb1-4GlcNAcb1-3Galb1-4GlcNAcb1- |
| 3Galb1-4GlcNAcb1-3(Galb1-4(Fuca1-3)GlcNAcb1- | 3Galb1-4GlcNAcb1-2(Galb1-4(Fuca1-3)GlcNAcb1- |
| 3Galb1-4(Fuca1-3)GlcNAcb1-3Galb1-4(Fuca1- | 3Galb1-4(Fuca1-3)GlcNAcb1-3Galb1-4(Fuca1- |
| 3)GlcNAcb1-4)Mana1-3(Galb1-4GlcNAcb1-3Galb1- | 3)GlcNAcb1-4)Mana1-3(Galb1-4GlcNAcb1-3Galb1- |
| 4GlcNAcb1-3Galb1-4GlcNAcb1-2(NeuAca2-3Galb1- | 4GlcNAcb1-3Galb1-4GlcNAcb1-2(NeuAca2-3Galb1- |
| 4(Fuca1-3)GlcNAcb1-3Galb1-4GlcNAcb1-3Galb1- | 4(Fuca1-3)GlcNAcb1-3Galb1-4(Fuca1-3)GlcNAcb1- |
| 4GlcNAcb1-6)Mana1-6)Manb1-4GlcNAcb1-4(Fuca1- | 3Galb1-4GlcNAcb1-6)Mana1-6)Manb1-4GlcNAcb1- |
| 6)GlcNAcb | 4(Fuca1-6)GlcNAcb |

References
1. Hakomori, S.-I. (2001) in The Molecular Immunology of Complex Carbohydrates-2, ed. Wu, A. M. (Kluwer Academic/Plenum, publishers, pp. 369-402.
2. Taylor, M. E. & Drickamer, K. (2003) Introduction to Glycobiology (Oxford University Press, Oxford).
3. Mrksich, M. (2004) Chem. Biol. 11, 739-40.
4. Feizi, T., Fazio, F., Wengang, C. & Wong, C.-H. (2003) Curr. Opin. Struct. Biol. 13, 637-645.
5. Drickamer, K. & Taylor, M. E. (2002) Genomebiology 3, 1034.1-4.
6. Love, K. R. & Seeberger, P. H. (2002) Angew. Chem. Int. Ed. 41, 3583-3586.
7. Galanina, O. E., Mecklenburg, M., Nifantiev, N. E., Pazynina, G. V. & Bovin, N. V. (2004) Lab Chip 3, 260-5.
8. Guo, Y., Feinberg, H., Conroy, E., Mitchell, D. A., Alvarez, R., Blixt, O., Taylor, M. E., Weis, W. I. & Drickamer, K. (2004) Nat. Struct. Mol. Biol. 11, 591-8.
9. Wang, D., Liu, S., Trummer, B. J., Deng, C. & Wang, A. (2002) Nat. Biotech. 20, 275-281.
10. Fukui, S., Feizi, T., Galustian, C., Lawson, A. M. & Chai, W. (2002) Nat. Biotech. 20, 1011-1017.
11. Willats, W. G. T., Rasmussen, S. E., Kristensen, T., Mikkelsen, J. D. & Knox, J. P. (2002) Proteomics 2, 1666-1671.
12. Fazio, F., Bryan, M. C., Blixt, O., Paulson, J. C. & Wong, C.-H. (2002) J. Am. Chem. Soc. 124, 14397-14402.
13. Nimrichter, L., Gargir, A., Gortler, M., Alstock, R. T., Shtevi, A., Weisshaus, O., Fire, E., Dotan, N. & Schnaar, R. L. (2004) Glycobiology 14, 197-203.
14. Bryan, M. C., Fazio, F., Lee, H. K., Huang, C. Y., Chang, A. Y., Best, M. D., Calarese, D. A., Blixt, O., Paulson, J. C., Burton, D. R., Wilson, I. A. & Wong, C.-H. (2004) J. Am. Chem. Soc. 126, 8640-41.
15. Park, S., Lee, M. R., Pyo, S. J. & Shin, I. (2004) J. Am. Chem. Soc. 126, 4812-9.
16. Ratner, D. M., Adams, E. W., Su, J., O'Keefe, B. R., Mrksich, M. & Seeberger, P. H. (2004) Chembiochem 5, 379-82.
17. Schwarz, M., Spector, L., Gargir, A., Shtevi, A., Gortler, M., Alstock, R. T., Dukler, A. A. & Dotan, N. (2003) Glycobiology 13, 749-754.
18. Houseman, B. T. & Mrksich, M. (2002) Chem. Biol. 9, 443-454.
19. Park, S. & Shin, I. (2002) Angew. Chem. Int. Ed. 41, 3180-3182.
20. Bergh, A., Magnusson, B. G., Ohlsson, J., Wellmar, U. & Nilsson, U. J. (2001) Glycoconj. J. 18, 615-21.
21. Shiyan, S. D. & Bovin, N. V. (1997) Glycoconj. J. 14, 631-8.
22. Pazynina, G. V., Sablina, M. A., Tuzikov, A. B., Chinarev, A. A. & Bovin, N. V. (2003) Mendeleev Commun. 13, 245-248.
23. Pazynina, G. V., Tyrtysh, T. V. & Bovin, N. V. (2002) Mendeleev Commun. 12, 183-184.
24. Pazynina, G. V., Tuzikov, A. B., Chinarev, A. A., Obukhova, P. & Bovin, N. V. (2002) Tet. Lett. 43, 8011-8013.
25. Nifant'ev, N. E., Tsvetkov, Y. E., Shashkov, A. S., Kononov, L. O., Menshov, V. M., Tuzikov, A. B. & Bovin, N. V. (1996) J. Carbohydr. Chem. 15, 939-953.
26. Zemlyanukhina, T. V., Nifant'ev, N. E., Shashkov, A. S., Tsvetkov, Y. E. & Bovin, N. V. (1995) Carbohydr. Lett. 1, 277-284.
27. Lee, H. K., Scanlan, C. N., Huang, C. Y., Chang, A. Y., Calarese, D. A., Dwek, R. A., Rudd, P. M., Burton, D. R., Wilson, I. A. & Wong, C. H. (2004) Angew. Chem. Int. Ed. 43, 1000-1003.
28. van Die, I., van Vliet, S. J., Nyame, A. K., Cummings, R. D., Bank, C. M. C., Appelmelk, B. J., Geijtenbeek, T. B. & Kooyk, Y. (2003) Glycobiology 13, 471-478.
29. Gamblin, S. J., Haire, L. F., Russell, R. J., Stevens, D. J., Xiao, B., Ha, Y., Vasisht, N., Steinhauer, D. A., Daniels, R. S., Elliot, A., Wiley, D. C. & Skehel, J. J. (2004) Science 303, 1838-42.
30. Calarese, D. A., Scanlan, C. N., Zwick, M. B., Deechongkit, S., Mimura, Y., Kunert, R., Zhu, P., Wormald, M. R., Stanfield, R. L., Roux, K. H., Kelly, J. W., Rudd, P. M., Dwek, R. A., Katinger, H., Burton, D. R. & Wilson, I. A. (2003) Science 300, 2065-71.
31. Scanlan, C. N., Pantophlet, R., Wormald, M. R., Ollmann Saphire, E., Stanfield, R., Wilson, I. A., Katinger, H., Dwek, R. A., Rudd, P. M. & Burton, D. R. (2002) J. Virol. 76, 7306-21.
32. Blixt, O., Collins, B. E., van den Nieuwenhof, I. M., Crocker, P. R. & Paulson, J. C. (2003) J. Biol. Chem. 278, 31007-19.
33. Huflejt, M. E., Jordan, E. T., Gitt, M. A., Barondes, S. H. & Leffler, H. (1997) J. Biol. Chem. 272, 14294-303.
34. Ting, C. A., Lee, S.-F. & Wang, K. (2003) BioTechniques 35, 808-810.
35. Blixt, O. & Razi, N. (2004) in Synthesis of Carbohydrates through Biotechnology, eds. Wang, P. G. & Ichikawa, Y. (American Chemical Society, Washington D.C.), Vol. 873, pp. 93-112.
36. Collins, B. E. & Paulson, J. C. (2004) Curr. Opin. Chem. Biol. in press.
37. Gupta, D., Oscarson, S., Raju, T. S., Stanely, P., Toone, E. J. & Brewer, C. F. (1996) Eur. J. Biochem. 242, 320-326.
38. Brewer, F., Bhattacharyya, L., Brown, R. D. & Koenig, S. H. (1985) Biochem. Biophys. Res. Commun. 127, 1066-71.
39. Lis, H. & Sharon, N. (1987) Meth. Enzymol. 138, 544-551.
40. Iglesias, J. L., Lis, H. & Sharon, N. (1982) Eur. J. Biochem. 123, 247-252.
41. Kooyk, Y. & Geijtenbeek, T. B. (2002) Immunol. Rev. 186, 47-56.
42. Adams, E. W., Ratner, D. M., Bokesch, H. R., McMahon, J. B., O'Keefe, B. R. & Seeberger, P. H. (2004) Chem.l Biol. 11, 875-81.
43. Engel, P., Nojima, Y., Rothstein, D., Zhou, L. J., Wilson, G. L., Kehrl, J. H. & Tedder, T. F. (1993) J. Immunol. 150, 4719-4732.
44. Kelm, S., Pelz, A., Schauer, R., Filbin, M. T., Tang, S., de Bellard, M. E., Schnaar, R. L., Mahoney, J. A., Hartnell, A., Bradfield, P. & Crocker, P. R. (1994) Curr. Biol. 4, 965-72.
45. Powell, L. D., Sgroi, D., Sjoberg, E. R., Stamenkovic, I. & Varki, A. (1993) J. Biol. Chem. 268, 7019-7027.
46. Hirabayashi, J., Hashidate, T., Arata, Y., Nishi, N., Nakamura, T., Hirashima, M., Urashima, T., Oka, T., Futai, M., Muller, W. E., Yagi, F. & Kasai, K. (2002) Biochim. Biophys. Acta 1572, 232-54.
47. Huflejt, M. E. & Leffler, H. (2004) Glycoconjugate J. 20, 247-55.
48. Wu, A. M., Wu, J. H., Liu, J. H., Singh, T., Andre, S., Kaltner, H. & Gabius, H. J. (2004) Biochimie 86, 317-26.
49. Oda, Y., Herrmann, J., Gitt, M. A., Turck, C. W., Burlingame, A. L., Barondes, S. H. & Leffler, H. (1993) J. of Biol. Chem. 268, 5929-5939.
50. Sanders, R. W., Venturi, M., Schiffner, L., Kalyanaraman, R., Katinger, H., Lloyd, K. O., Kwong, P. D. & Moore, J. P. (2002) J. Virol. 76, 7293-305.
51. Trkola, A., Purtscher, M., Muster, T., Ballaun, C., Buchacher, A., Sullivan, N., Srinivasan, K., Sodroski, J., Moore, J. P. & Katinger, H. (1996) J. Virol. 70, 1100-8.
52. Bewely, C. A. & Otero-Quintero, S. (2001) J. Am. Chem. Soc. 123, 3892-3902.
53. Connor, R. J., Kawaoka, Y., Webster, R. G. & Paulson, J. C. (1994) Virol. 205, 17-23.
54. Rogers, G. N. & D'Souza, B. L. (1989) Virol. 173, 317-22.
55. Rogers, G. N., Paulson, J. C., Daniels, R. S., Skehel, J. J., Wilson, I. A. & Wiley, D. C. (1983) Nature 304, 76-8.
56. Sauter, N. K., Bednarski, M. D., Wurzburg, B. A., Hanson, J. E., Whitesides, G. M., Skehel, J. J. & Wiley, D. C. (1989) Biochem. 28, 8388-96.
57. Rogers, G. N. & Paulson, J. C. (1983) Virol. 127, 361-73.
58. Vallee, F., Karaveg, K., Herscovics, A., Moremen, K. W., and Howell, P. L. (2000). Structural basis for catalysis and inhibition of N-glycan processing class I alpha 1,2-mannosidases. J. Biol Chem 275, 41287-41298.
59. Tremblay, L. O., and Herscovics, A. (2000). Characterization of a cDNA encoding a novel human Golgi alpha 1,2-mannosidase (IC) involved in N-glycan biosynthesis. J. Biol Chem 275, 31655-31660.
60. Blixt, O., Head, S, Mondala T, Scanlan CN, Huflejt ME, Bovin N, Calarese D, Alvarez R, Stevens J, Bryan MC, Fazio F, Razi N, Cummings R, van Die I, Burton D, Wilson IC, Wong C.-H, and Paulson JC. Printed Covalent Glyean Array for Ligand Profiling of Diverse Carbohydrate Binding Proteins. Manuscript submitted to PNAS.
61. Hakomori S. 2001. Tumor-associated carbohydrate antigens defining tumor malignancy: basis for development of anti-cancer vaccines. Adv Exp Med Biol. 491: 369-402.
62. Hakomori S. 1996. Tumor malignancy defined by aberrant glycosylation and sphingo(glyco)lipid metabolism. Cancer Res.56: 5309-18.
63. Senra Varela, A., Bosco Lopez Saez JJ, and Quintela Sera D. 1997. Serum ceruloplasmin as a diagnostic marker of cancer. Cancer Lett. 121: 139-145.
64. Koenig A, Jain R, Vig R, Norgard-Sumnicht KE, Matta KL, Varki A. 1997. Selectin inhibition: synthesis and evaluation of novel sialylated, sulfated and fucosylated oligosaccharides, including the major capping group of GlyCAM-1. Glycobiology.7:79-93.
65. Sarkar AK, Rostand KS, Jain RK, Matta KL, Esko JD. 1997. Fucosylation of disaccharide precursors of sialyl LewisX inhibit selectin-mediated cell adhesion. J. Biol Chem. 272: 25608-16.
66. Huflejt, M E., and Leffler, H. Galectin-4 in normal tissues and cancer. (2004). Glycoconjugate J, 20: 247-255.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

What is claimed:

1. An array of glycan molecules comprising a solid support and a library of glycan molecules, wherein each glycan molecule is covalently attached to the solid support via amide or amine group.

2. The array of claim 1, wherein each type of glycan molecule in the library is attached to the solid support at a defined glycan probe location.

3. The array of claim 2, wherein each glycan probe location defines a region of the solid support that has multiple copies of one type of similar glycan molecules attached thereto.

4. The array of claim 1, wherein the array is a microarray.

5. The array of claim 1, wherein the solid support is a glass slide.

6. The array of claim 1, wherein the glass slide is coated with a hydrogel.

7. The array of claim 1, wherein the glycan molecules are printed onto the solid support.

8. The array of claim 1, wherein the glycan molecules are printed onto an amino-reactive solid support.

9. The array of claim 1, wherein the glycan molecules are printed onto an N-hydroxysuccinimide (NHS)-derivatized solid support.

10. The array of claim 9, wherein each glycan molecule in the library is attached to the solid support via an amino acid that forms a linkage to the N-hydroxysuccinimide (NHS)-derivatized solid support.

11. The array of claim 1, wherein each glycan is covalently attached to a spacer, which is attached to the solid support by the amide linkage.

12. The array of claim 11, wherein each glycan is covalently attached to a spacer by an ether, an ester, an amide or a combination thereof.

13. The array of claim 11, wherein the spacer is an alkyl, a peptide, an amino acid, a protein or a combination thereof.

14. The array of claim 1, wherein each glycan molecule in the library is attached directly to the solid support.

15. The array of claim 1, comprising 10-100,000 separate, isolated glycans, wherein the glycans are straight or branched chains of allose, altrose, arabinose, glucose, galactose, gulose, fucose, fructose, idose, lyxose, mannose, ribose, talose, or xylose sugar units covalently linked together by alpha (α) or beta (β) covalent linkages; and the sugar units can have N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl substituents that are present instead of, or in addition to, hydroxy (—OH), carboxylic acid (—COOH) and methylenehydroxy (—CH₂—OH) substituents present on the sugar units.

16. The array of claim 1, wherein a portion of the glycans are naturally occurring glycans.

17. The array of claim 1, wherein a portion the glycans are enzymatically synthesized glycans.

18. The array of claim 1, wherein the glycans comprise glycoamino acids, glycopeptides, glycolipids, glycoaminoglycans, glycoproteins, cellular components, glycoconjugates, glycomimetics, glycophospholipids, glycosyl phosphatidylinositol-linked glycoconjugates, bacterial lipopolysaccharides or a combination thereof.

19. The array of claim 1, wherein at least one glycan comprises an alpha-Gal-3 glycan, an alpha-Gal-LeX glycan, a Fucα1-3GlcNAc glycan, a Fucα1-4GlcNAc glycan, a Siaα2-6Galβ1-4GlcNAc glycan, a Neu5Acα2-6Galβ1-4GlcNAc[6Su] glycan, a Lewis^{x} (Galβ1-4[Fucα1-3]GlcNAc) glycan, a Neu5Acα2-3-galactoside, a Neu5Acα2-6-sialoside, a Neu5Acα2-8-sialoside or a combination thereof.

20. The array of claim 1, wherein the library of glycans further comprises at least thirty five glycans selected from Table 3 or Table 9 provided herein.

21. A library comprising 225-7500 separate, isolated glycans, selected from the glycans listed in Table 3 or Table 9 provided herein.

22. The library of claim 21, wherein each glycan in the array is covalently attached to a spacer.

23. The library of claim 21, wherein the spacer is an alkyl, a peptide, an amino acid, a protein or a combination thereof.

24. The library of claim 22, wherein the spacer is an aminoalkyl.

25. The library of claim 21, wherein each glycan is covalently attached to an amino acid.

26. A composition comprising a carrier and an effective amount of at least one glycan molecule, wherein each glycan molecule in the composition binds an antibody found in a patient with a disease, and wherein serum from a patient without the disease has substantially no antibodies that bind any of the glycan molecules in the composition.

27. The composition of claim 26, wherein the disease is a bacterial infection, viral infection, inflammation, cancer, transplant rejection, or an autoimmune disease.

28. The composition of claim 26, which has at least two glycan molecules.

29. The composition of claim 26, which is formulated for immunization of a mammal.

30. The composition of claim 26, which is formulated for local administration to a tissue.

31. The composition of claim 26, which is formulated as a food supplement.

32. The composition of claim 26, wherein the at least one glycan is selected from glycans listed in Table 3 or Table 9 provided herein.

33. A composition comprising a carrier and an effective amount of an alpha-Gal-3 glycan, wherein the composition is formulated for treating or preventing transplant tissue rejection.

34. The composition of claim 33, wherein the alpha-Gal-3 glycan is Gal-alpha3-Gal-beta (structure 33), Gal-alpha3-Gal-beta4-GlcNAc[alpha3-Fucose]-beta (structure 34), Gal-alpha3-Gal-beta4-Glc-beta (structure 35), Gal-alpha3-Gal[alpha2-Fucose]-beta4-GlcNAc-beta (structure 36), Gal-alpha3-Gal-beta4-GalAc-beta (structure 37), Gal-alpha3-GalAc-alpha (structure 38), Gal-alpha3-Gal-beta (structure 39) or a combination thereof.

35. A composition comprising a carrier and an effective amount of at least one glycan molecule, wherein each glycan molecule in the composition binds an antibody found in a healthy person, and wherein serum from a patient with the disease has substantially no antibodies that bind any of the glycan molecules in the composition.

36. A method of testing whether a molecule in a test sample can bind to a glycan comprising, (a) contacting glycans in the array of claim 1 with the test sample, and (b) observing whether a molecule in the test sample binds to a glycan in the array.

37. The method of claim 36, wherein the method further comprises determining which molecule in the test sample binds to the glycan.

38. The method of claim 36, wherein the molecule is an antibody, an enzyme, a viral protein, a cellular receptor, a cell type specific antigen, or a nucleic acid, a cellular component or a tissue component.

39. The method of claim 38, wherein the nucleic acid is RNA.

40. The method of claim 36, wherein the molecule is from a prokaryote, prion, virus, bacterium or eukaryote.

41. A method of testing whether a molecule in a test sample can bind to a glycan comprising, (a) contacting glycans in the library of claim 21 with the test sample and (b) observing whether a molecule in the test sample binds to a glycan in the library.

42. The method of claim 41, wherein the method further comprises determining which molecule in the test sample binds to the glycan.

43. The method of claim 41, wherein the molecule is an antibody, an enzyme, a viral protein, a cellular receptor, a cell type specific antigen, or a nucleic acid, a cellular component or a tissue component.

44. The method of claim 43, wherein the nucleic acid is RNA.

45. The method of claim 41, wherein the molecule is from a prokaryote, prion, virus, bacterium or eukaryote.

46. A method of detecting antibodies in a test sample comprising contacting the test sample with the array of claim 1 and observing whether one or more glycans are bound by an antibody in the test sample.

47. The method of claim 46, wherein the test sample is blood, serum, anti-serum, monoclonal antibody preparation, lymph, plasma, saliva, urine, semen, breast milk, ascites fluid, tissue extract, cell lysate, cell suspension, viral suspension, or a combination thereof.

48. The method of claim 46, which further comprises observing whether antibodies in a control sample bind to the same glycan molecules as are bound by the antibodies in the test sample.

49. A method of detecting antibodies in a serum comprising contacting the serum with the array of claim 1 and observing whether one or more glycans are bound by antibodies.

50. A method of detecting transplant tissue rejection in a transplant recipient comprising contacting a test sample from the transplant recipient with an array of glycans and observing whether one or more glycans are bound by antibodies in the test sample.

51. A method of detecting xenotransplant tissue rejection in a transplant recipient comprising contacting a test sample from the transplant recipient with an array of glycans and observing whether one or more glycans are bound by antibodies in the test sample, wherein the glycans in the array include any one of Gal-alpha3-Gal-beta (structure 33 of FIG. 7), Gal-alpha3-Gal-beta4-GlcNAc[alpha3-Fucose]-beta (structure 34 of FIG. 7), Gal-alpha3-Gal-beta4-Glc-beta (structure 35 of FIG. 7), Gal-alpha3-Gal[alpha2-Fucose]-beta4-GlcNAc-beta (structure 36 of FIG. 7), Gal-alpha3-Gal-beta4-GalAc-beta (structure 37 of FIG. 7), Gal-alpha3-GalAc-alpha (structure 38 of FIG. 7), Gal-alpha3-Gal-beta (structure 39 of FIG. 7), or Gal-beta4-GlcNAc[alpha3-Fucose]-beta (structure 65 in FIG. 7) or a combination thereof.

52. The method of claim 51, wherein the test sample is blood, serum, plasma, saliva, urine, breast milk, ascites fluid or lymph.

53. The method of claim 51, wherein at least one glycan comprises alpha-Gal-LeX (Gal-alpha3-Gal-beta4-GlcNAc[alpha3-Fucose]-beta (structure 34 in FIG. 7), which is not found in humans, but which is present on porcine cells.

54. A method of treating or preventing disease in a mammal that comprises administering to the mammal a composition comprising an effective amount of at least one glycan molecule that binds antibodies detected in a patient with the disease.

55. The method of claim 54, wherein the at least one glycan comprises an alpha-Gal-3 glycan or an alpha-Gal-LeX glycan.

56. An isolated antibody that can bind an alpha-Gal-3 glycan.

57. An isolated antibody that can bind a glycan that comprises Gal-alpha3-Gal-beta (structure 33 of FIG. 7), Gal-alpha3-Gal-beta4-GlcNAc[alpha3-Fucose]-beta (structure 34 of FIG. 7), Gal-alpha3-Gal-beta4-Glc-beta (structure 35 of FIG. 7), Gal-alpha3-Gal[alpha2-Fucose]-beta4-GlcNAc-beta (structure 36 of FIG. 7), Gal-alpha3-Gal-beta4-GalAc-beta (structure 37 of FIG. 7), Gal-alpha3-GalAc-alpha (structure 38 of FIG. 7), Gal-alpha3-Gal-beta (structure 39 of FIG. 7) or a combination thereof.

58. A kit comprising the array of claim 1 and instructions for using the array.

59. A kit comprising the library of glycans of claim 21 and instructions for making an array from the library of glycans.

60. The kit of claim 59, further comprising a solid support for making the array.
